(19) United States
(12) Patent Application Publication
(10) Pub. No.: US 2010/0280705 A1
(43) Pub. Date: Nov. 4, 2010

(54) Awarding standings to a vehicle based upon one or more fuel utilization characteristics

(75) Inventors: Philip A. Eckhoff, Bellevue, WA (US); William Gates, Redmond, WA (US); Peter L. Hagelstein, Carlisle, MA (US); Roderick A. Hyde, Redmond, WA (US); Muriel Y. Ishikawa, Livermore, CA (US); Jordin T. Kare, Seattle, WA (US); Robert Langer, Newton, MA (US); Eric C. Leuthardt, St. Louis, MO (US); Erez Lieberman, Cambridge, MA (US); Stephen L. Malaska, Redmond, WA (US); Nathan P. Myhrvold, Bellevue, WA (US); Michael Schnall-Levin, Cambridge, MA (US); Clarence T. Tegreene, Bellevue, WA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(73) Assignee: Searete LLC, a limited liability corporation of the State of Delaware

(21) Appl. No.: 12/798,908

(22) Filed: Apr. 13, 2010

Related U.S. Application Data
(63) Continuation-in-part of application No. 12/387,331, filed on Apr. 30, 2009.
Application No. 12/387,331 is a continuation-in-part of application No. 12/387,492, filed on May 1, 2009.
Application No. 12/387,492 is a continuation-in-part of application No. 12/387,483, filed on May 1, 2009.
Application No. 12/387,483 is a continuation-in-part of application No. 12/387,482, filed on May 1, 2009.
Application No. 12/387,482 is a continuation-in-part of application No. 12/387,491, filed on May 1, 2009.
Application No. 12/387,491 is a continuation-in-part of application No. 12/387,488, filed on May 1, 2009.
Application No. 12/387,488 is a continuation-in-part of application No. 12/462,935, filed on Aug. 11, 2009.
Application No. 12/462,935 is a continuation-in-part of application No. 12/462,932, filed on Aug. 11, 2009.
Application No. 12/462,932 is a continuation-in-part of application No. 12/583,172, filed on Aug. 11, 2009.
Application No. 12/583,172 is a continuation-in-part of application No. 12/462,934, filed on Aug. 11, 2009.
Application No. 12/462,934 is a continuation-in-part of application No. 12/462,931, filed on Aug. 11, 2009.
Application No. 12/462,931 is a continuation-in-part of application No. 12/462,933, filed on Aug. 11, 2009.

(51) Int. Cl. G06F 7/00

(52) U.S. Cl. 701/33; 903/903; 380/255

(57) ABSTRACT

A method may include, but is not limited to, transmitting to an off-site entity a status indicative of combustible fuel utilization in comparison to electricity utilization from a vehicle.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### Related Applications:

For purposes of the USPTO extra-statutory requirements, the present application constitutes a continuation-in-part of U.S. patent application Ser. No. 12/387,331, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed Apr. 30, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/387,492, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed May 1, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/387,483, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed May 1, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/387,482, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed May 1, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/387,491, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed May 1, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/387,488, entitled AWARDING PRIVILEGES TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Nathan P. Myhrvold; Michael Schnall-Levin; Clarence T. Tegreene; and Lowell L. Wood, Jr. as inventors, filed May 1, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/462,935, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/462,932, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/583,172, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/462,934, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/462,931, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 12/462,933, entitled AWARDING STANDINGS TO A VEHICLE BASED UPON ONE OR MORE FUEL UTILIZATION CHARACTERISTICS, naming Philip Eckhoff; William Gates; Peter L. Hagelstein; Roderick A. Hyde; Muriel Y. Ishikawa; Jordin T. Kare; Robert Langer; Eric C. Leuthardt; Erez Lieberman; Stephen L. Malaska; Nathan P. Myhrvold; Michael Schnall-Levin; Clarence T. Tegreene; and Lowell L. Wood, Jr. as inventors, filed Aug. 11, 2009, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

In one aspect, a method includes but is not limited to transmitting to an off-site entity at least one of a status indicative of combustible fuel utilization or a status indicative of electricity utilization from a hybrid vehicle. In addition to the foregoing, other method aspects are described in the claims, drawings, and text forming a part of the present disclosure.

In one aspect, a method includes but is not limited to transmitting to an off-site entity a status indicative of combustible fuel utilization in comparison to electricity utilization from a vehicle. In addition to the foregoing, other method aspects are described in the claims, drawings, and text forming a part of the present disclosure.

In one aspect, a method includes but is not limited to querying a hybrid vehicle for at least one of a status indicative of combustible fuel utilization or a status indicative of electricity utilization for the vehicle. In addition to the foregoing, other method aspects are described in the claims, drawings, and text forming a part of the present disclosure.

In one aspect, a method includes but is not limited to querying a vehicle for a status indicative of combustible fuel utilization in comparison to electricity utilization for the vehicle. In addition to the foregoing, other method aspects are described in the claims, drawings, and text forming a part of the present disclosure.

In one aspect, a method includes, but is not limited to, receiving at least one of a status indicative of combustible fuel utilization or a status indicative of electricity utilization for a hybrid vehicle and forwarding to an off-site entity the at least one of the status indicative of combustible fuel utilization or the status indicative of electricity utilization for the vehicle. In addition to the foregoing, other method aspects are described in the claims, drawings, and text forming a part of the present disclosure.

In one aspect, a method includes, but is not limited to, receiving a status indicative of combustible fuel utilization in comparison to electricity utilization for a vehicle and forwarding to an off-site entity the status indicative of combustible fuel utilization in comparison to electricity utilization for the vehicle. In addition to the foregoing, other method aspects are described in the claims, drawings, and text forming a part of the present disclosure.

In one aspect, a method includes but is not limited to receiving at least one of a status indicative of combustible fuel utilization or a status indicative of electricity utilization for a hybrid vehicle and conveying a standing, the standing based upon the at least one of the status indicative of combustible fuel utilization or the status indicative of electricity utilization for the vehicle. In addition to the foregoing, other method aspects are described in the claims, drawings, and text forming a part of the present disclosure.

In one aspect, a method includes but is not limited to receiving a status indicative of combustible fuel utilization in comparison to electricity utilization for a vehicle and conveying a standing, the standing based upon the status indicative of combustible fuel utilization in comparison to electricity utilization for the vehicle. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system includes but is not limited to means for transmitting to an off-site entity at least one of a status indicative of combustible fuel utilization or a status indicative of electricity utilization from a hybrid vehicle. In addition to the foregoing, other system aspects are described in the claims, drawings, and text forming a part of the present disclosure.

In one aspect, a system includes but is not limited to means for transmitting to an off-site entity a status indicative of combustible fuel utilization in comparison to electricity utilization from a vehicle. In addition to the foregoing, other system aspects are described in the claims, drawings, and text forming a part of the present disclosure.

In one aspect, a system includes but is not limited to means for querying a hybrid vehicle for at least one of a status indicative of combustible fuel utilization or a status indicative of electricity utilization for the vehicle. In addition to the foregoing, other system aspects are described in the claims, drawings, and text forming a part of the present disclosure.

In one aspect, a system includes but is not limited to means for querying a vehicle for a status indicative of combustible fuel utilization in comparison to electricity utilization for the vehicle. In addition to the foregoing, other system aspects are described in the claims, drawings, and text forming a part of the present disclosure.

In one aspect, a system includes, but is not limited to, means for receiving at least one of a status indicative of combustible fuel utilization or a status indicative of electricity utilization for a hybrid vehicle and means for forwarding to an off-site entity the at least one of the status indicative of combustible fuel utilization or the status indicative of electricity utilization for the vehicle. In addition to the foregoing, other system aspects are described in the claims, drawings, and text forming a part of the present disclosure.

In one aspect, a system includes, but is not limited to, means for receiving a status indicative of combustible fuel utilization in comparison to electricity utilization for a vehicle and means for forwarding to an off-site entity the status indicative of combustible fuel utilization in comparison to electricity utilization for the vehicle. In addition to the foregoing, other system aspects are described in the claims, drawings, and text forming a part of the present disclosure.

In one aspect, a system includes but is not limited to means for receiving at least one of a status indicative of combustible fuel utilization or a status indicative of electricity utilization for a hybrid vehicle and means for conveying a standing, the standing based upon the at least one of the status indicative of combustible fuel utilization or the status indicative of electricity utilization for the vehicle. In addition to the foregoing, other system aspects are described in the claims, drawings, and text forming a part of the present disclosure.

In one aspect, a system includes but is not limited to means for receiving a status indicative of combustible fuel utilization in comparison to electricity utilization for a vehicle and means for conveying a standing, the standing based upon the status indicative of combustible fuel utilization in comparison to electricity utilization for the vehicle. In addition to the foregoing, other system aspects are described in the claims, drawings, and text forming a part of the present disclosure.

In one aspect, a computer program product includes but is not limited to a recordable-type signal bearing medium bearing computer usable code configured for transmitting to an off-site entity at least one of a status indicative of combustible fuel utilization or a status indicative of electricity utilization from a hybrid vehicle. In addition to the foregoing, other program product aspects are described in the claims, drawings, and text forming a part of the present disclosure.

In one aspect, a computer program product includes but is not limited to a recordable-type signal bearing medium bearing computer usable code configured for transmitting to an off-site entity a status indicative of combustible fuel utilization in comparison to electricity utilization from a vehicle. In addition to the foregoing, other program product aspects are described in the claims, drawings, and text forming a part of the present disclosure.

In one aspect, a computer program product includes but is not limited to a recordable-type signal bearing medium bearing computer usable code configured for querying a hybrid vehicle for at least one of a status indicative of combustible fuel utilization or a status indicative of electricity utilization for the vehicle. In addition to the foregoing, other program product aspects are described in the claims, drawings, and text forming a part of the present disclosure.

In one aspect, a computer program product includes but is not limited to a recordable-type signal bearing medium bearing computer usable code configured for querying a vehicle for a status indicative of combustible fuel utilization in comparison to electricity utilization for the vehicle. In addition to the foregoing, other program product aspects are described in the claims, drawings, and text forming a part of the present disclosure.

In one aspect, a computer program product includes, but is not limited to, a recordable-type signal bearing medium bearing computer usable code configured for receiving at least one of a status indicative of combustible fuel utilization or a status indicative of electricity utilization for a hybrid vehicle and a recordable-type signal bearing medium bearing computer usable code configured for forwarding to an off-site entity the at least one of the status indicative of combustible fuel utilization or the status indicative of electricity utilization for the vehicle. In addition to the foregoing, other program product aspects are described in the claims, drawings, and text forming a part of the present disclosure.

In one aspect, a computer program product includes, but is not limited to, a recordable-type signal bearing medium bearing computer usable code configured for receiving a status indicative of combustible fuel utilization in comparison to electricity utilization for a vehicle and a recordable-type signal bearing medium bearing computer usable code configured for forwarding to an off-site entity the status indicative of combustible fuel utilization in comparison to electricity utilization for the vehicle. In addition to the foregoing, other program product aspects are described in the claims, drawings, and text forming a part of the present disclosure.

In one aspect, a computer program product includes but is not limited to a recordable-type signal bearing medium bearing computer usable code configured for receiving at least one of a status indicative of combustible fuel utilization or a status indicative of electricity utilization for a hybrid vehicle and a recordable-type signal bearing medium bearing computer usable code configured for conveying a standing, the standing based upon the at least one of the status indicative of combustible fuel utilization or the status indicative of electricity utilization for the vehicle. In addition to the foregoing, other program product aspects are described in the claims, drawings, and text forming a part of the present disclosure.

In one aspect, a computer program product includes but is not limited to a recordable-type signal bearing medium bearing computer usable code configured for receiving a status indicative of combustible fuel utilization in comparison to electricity utilization for a vehicle and a recordable-type signal bearing medium bearing computer usable code configured for conveying a standing, the standing based upon the status indicative of combustible fuel utilization in comparison to electricity utilization for the vehicle. In addition to the foregoing, other program product aspects are described in the claims, drawings, and text forming a part of the present disclosure.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a schematic of a hybrid vehicle.

FIG. 2 is a schematic of another hybrid vehicle.

FIG. 3 is a schematic of a hybrid vehicle.

FIG. 4 is a schematic of another hybrid vehicle.

FIG. 5 is a schematic of a vehicle, a device, and an off-site entity.

FIG. 6 is a schematic of a wireless signal.

FIG. 7 is a schematic of a connector.

FIG. 8 is a schematic of a physical media.

FIG. 9 is a schematic of a geographic region.

FIG. 10 is a schematic of another geographic region.

FIG. 11 illustrates an operational flow representing example operations related to transmitting to an off-site entity at least one of a status indicative of combustible fuel utilization or a status indicative of electricity utilization from a hybrid vehicle.

FIG. 12 illustrates an operational flow representing example operations related to transmitting to an off-site entity at least one of a status indicative of combustible fuel utilization or a status indicative of electricity utilization from a hybrid vehicle and receiving at least one of a status indicative of combustible fuel utilization or a status indicative of electricity utilization for a hybrid vehicle.

FIG. 13 illustrates an alternative embodiment of the operational flow of FIG. 12.

FIG. 14 illustrates an alternative embodiment of the operational flow of FIG. 12.

FIG. 15 illustrates an alternative embodiment of the operational flow of FIG. 12.

FIG. 16 illustrates an alternative embodiment of the operational flow of FIG. 12.

FIG. 17 illustrates an operational flow representing example operations related to transmitting to an off-site entity at least one of a status indicative of combustible fuel utilization or a status indicative of electricity utilization from a hybrid vehicle and receiving at least one of a hybrid vehicle identification, an operator identification, a time, a location, a direction, or a speed associated with the hybrid vehicle.

FIG. 18 illustrates an alternative embodiment of the operational flow of FIG. 11.

FIG. 19 illustrates an alternative embodiment of the operational flow of FIG. 11.

FIG. 20 illustrates an alternative embodiment of the operational flow of FIG. 11.

FIG. 21 illustrates an alternative embodiment of the operational flow of FIG. 11.

FIG. 22 illustrates an operational flow representing example operations related to transmitting to an off-site entity at least one of a status indicative of combustible fuel utilization or a status indicative of electricity utilization from a hybrid vehicle and calculating a time for transmitting the status.

FIG. 23 illustrates an alternative embodiment of the operational flow of FIG. 11.

FIG. 24 illustrates an operational flow representing example operations related to transmitting to an off-site entity at least one of a status indicative of combustible fuel utilization or a status indicative of electricity utilization from a hybrid vehicle and storing data regarding the status.

FIG. 25 illustrates an operational flow representing example operations related to transmitting to an off-site entity at least one of a status indicative of combustible fuel utilization or a status indicative of electricity utilization from a hybrid vehicle and storing data regarding the transmission of the status.

FIG. 26 illustrates an operational flow representing example operations related to transmitting to an off-site entity at least one of a status indicative of combustible fuel utilization or a status indicative of electricity utilization from a hybrid vehicle and querying for the status.

FIG. 27 illustrates an alternative embodiment of the operational flow of FIG. 26.

FIG. 28 illustrates an alternative embodiment of the operational flow of FIG. 26.

FIG. 29 illustrates an alternative embodiment of the operational flow of FIG. 26.

FIG. 30 illustrates an alternative embodiment of the operational flow of FIG. 26.

FIG. 31 illustrates an alternative embodiment of the operational flow of FIG. 26.

FIG. 32 illustrates an operational flow representing example operations related to transmitting to an off-site entity at least one of a status indicative of combustible fuel utilization or a status indicative of electricity utilization from a hybrid vehicle and allocating a standing based upon the at least one of the status indicative of combustible fuel utilization or the status indicative of electricity utilization for the vehicle.

FIG. 33 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and receiving a selection associated with the hybrid vehicle.

FIG. 34 illustrates an alternative embodiment of the operational flow of FIG. 32.

FIG. 35 illustrates an alternative embodiment of the operational flow of FIG. 32.

FIG. 36 illustrates an alternative embodiment of the operational flow of FIG. 32.

FIG. 37 illustrates an alternative embodiment of the operational flow of FIG. 32.

FIG. 38 illustrates an alternative embodiment of the operational flow of FIG. 32.

FIG. 39 illustrates an alternative embodiment of the operational flow of FIG. 32.

FIG. 40 illustrates an alternative embodiment of the operational flow of FIG. 32.

FIG. 41 illustrates an alternative embodiment of the operational flow of FIG. 32.

FIG. 42 illustrates an alternative embodiment of the operational flow of FIG. 32.

FIG. 43 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and canceling a penalty utilizing the standing.

FIG. 44 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and reducing a penalty utilizing the standing.

FIG. 45 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and selling the standing to a second entity.

FIG. 46 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and transferring the standing to a second entity.

FIG. 47 illustrates an operational flow representing example operations related to transmitting to an off-site entity at least one of a status indicative of combustible fuel utilization or a status indicative of electricity utilization from a hybrid vehicle, allocating a standing based upon the status for the vehicle, and transferring the standing to an individual.

FIG. 48 illustrates an operational flow representing example operations related to transmitting to an off-site entity a status indicative of combustible fuel utilization in comparison to electricity utilization from a vehicle.

FIG. 49 illustrates an operational flow representing example operations related to transmitting to an off-site entity a status indicative of combustible fuel utilization in comparison to electricity utilization from a vehicle and receiving a status indicative of combustible fuel utilization in comparison to electricity utilization for a vehicle.

FIG. 50 illustrates an alternative embodiment of the operational flow of FIG. 49.

FIG. 51 illustrates an alternative embodiment of the operational flow of FIG. 49.

FIG. 52 illustrates an alternative embodiment of the operational flow of FIG. 49.

FIG. 53 illustrates an alternative embodiment of the operational flow of FIG. 49.

FIG. 54 illustrates an operational flow representing example operations related to transmitting to an off-site entity a status indicative of combustible fuel utilization in comparison to electricity utilization from a vehicle and receiving at least one of a vehicle identification, an operator identification, a time, a location, a direction, or a speed associated with the vehicle.

FIG. 55 illustrates an alternative embodiment of the operational flow of FIG. 48.

FIG. 56 illustrates an alternative embodiment of the operational flow of FIG. 48.

FIG. 57 illustrates an alternative embodiment of the operational flow of FIG. 48.

FIG. 58 illustrates an alternative embodiment of the operational flow of FIG. 48.

FIG. 59 illustrates an operational flow representing example operations related to transmitting to an off-site entity a status indicative of combustible fuel utilization in comparison to electricity utilization from a vehicle and calculating a time for transmitting the status.

FIG. 60 illustrates an alternative embodiment of the operational flow of FIG. 48.

FIG. 61 illustrates an operational flow representing example operations related to transmitting to an off-site entity a status indicative of combustible fuel utilization in comparison to electricity utilization from a vehicle and storing data regarding the status.

FIG. 62 illustrates an operational flow representing example operations related to transmitting to an off-site entity a status indicative of combustible fuel utilization in comparison to electricity utilization from a vehicle and storing data regarding the transmission of the status.

FIG. 63 illustrates an operational flow representing example operations related to transmitting to an off-site entity a status indicative of combustible fuel utilization in comparison to electricity utilization from a vehicle and querying for the status.

FIG. 64 illustrates an alternative embodiment of the operational flow of FIG. 63.

FIG. 65 illustrates an alternative embodiment of the operational flow of FIG. 63.

FIG. 66 illustrates an alternative embodiment of the operational flow of FIG. 63.

FIG. 67 illustrates an alternative embodiment of the operational flow of FIG. 63.

FIG. 68 illustrates an alternative embodiment of the operational flow of FIG. 63.

FIG. 69 illustrates an operational flow related to transmitting to an off-site entity a status indicative of combustible fuel utilization in comparison to electricity utilization from a vehicle and allocating a standing based upon the status indicative of combustible fuel utilization in comparison to electricity utilization for the vehicle.

FIG. 70 illustrates an operational flow representing example operations related to transmitting to an off-site entity a status indicative of combustible fuel utilization in comparison to electricity utilization from a vehicle, allocating a standing based upon the status for the vehicle, and receiving a selection associated with the vehicle.

FIG. 71 illustrates an alternative embodiment of the operational flow of FIG. 69.

FIG. 72 illustrates an alternative embodiment of the operational flow of FIG. 69.

FIG. 73 illustrates an alternative embodiment of the operational flow of FIG. 69.

FIG. 74 illustrates an alternative embodiment of the operational flow of FIG. 69.

FIG. 75 illustrates an alternative embodiment of the operational flow of FIG. 69.

FIG. 76 illustrates an alternative embodiment of the operational flow of FIG. 69.

FIG. 77 illustrates an alternative embodiment of the operational flow of FIG. 69.

FIG. 78 illustrates an alternative embodiment of the operational flow of FIG. 69.

FIG. 79 illustrates an alternative embodiment of the operational flow of FIG. 69.

FIG. 80 illustrates an operational flow representing example operations related to transmitting to an off-site entity a status indicative of combustible fuel utilization in comparison to electricity utilization from a vehicle, allocating a standing based upon the status for the vehicle, and canceling a penalty utilizing the standing.

FIG. 81 illustrates an operational flow representing example operations related to transmitting to an off-site entity a status indicative of combustible fuel utilization in comparison to electricity utilization from a vehicle, allocating a standing based upon the status for the vehicle, and reducing a penalty utilizing the standing.

FIG. 82 illustrates an operational flow representing example operations related to transmitting to an off-site entity a status indicative of combustible fuel utilization in comparison to electricity utilization from a vehicle, allocating a standing based upon the status for the vehicle, and selling the standing to a second entity.

FIG. 83 illustrates an operational flow representing example operations related to transmitting to an off-site entity a status indicative of combustible fuel utilization in comparison to electricity utilization from a vehicle, allocating a standing based upon the status for the vehicle, and transferring the standing to a second entity.

FIG. 84 illustrates an operational flow representing example operations related to transmitting to an off-site entity a status indicative of combustible fuel utilization in comparison to electricity utilization from a vehicle, allocating a standing based upon the status for the vehicle, and transferring the standing to an individual.

FIG. 85 illustrates a computer program product related to receiving at least one of a status indicative of combustible fuel utilization or a status indicative of electricity utilization for a hybrid vehicle.

FIG. 86 illustrates a computer program product related to receiving a status indicative of combustible fuel utilization in comparison to electricity utilization for a vehicle.

FIG. 87 illustrates an operational flow representing example operations related to querying a hybrid vehicle for at least one of a status indicative of combustible fuel utilization or a status indicative of electricity utilization for the vehicle.

FIG. 88 illustrates an operational flow representing example operations related to querying a hybrid vehicle for at least one of a status indicative of combustible fuel utilization or a status indicative of electricity utilization for the vehicle and receiving at least one of a status indicative of combustible fuel utilization or a status indicative of electricity utilization for a hybrid vehicle.

FIG. 89 illustrates an alternative embodiment of the operational flow of FIG. 88.

FIG. 90 illustrates an alternative embodiment of the operational flow of FIG. 88.

FIG. 91 illustrates an alternative embodiment of the operational flow of FIG. 88.

FIG. 92 illustrates an alternative embodiment of the operational flow of FIG. 88.

FIG. 93 illustrates an operational flow representing example operations related to querying a hybrid vehicle for at least one of a status indicative of combustible fuel utilization or a status indicative of electricity utilization for the vehicle and receiving at least one of a hybrid vehicle identification, an operator identification, a time, a location, a direction, or a speed associated with the hybrid vehicle.

FIG. 94 illustrates an operational flow representing example operations related to querying a hybrid vehicle for at least one of a status indicative of combustible fuel utilization or a status indicative of electricity utilization for the vehicle and transmitting to an off-site entity the at least one of the status indicative of combustible fuel utilization or the status indicative of electricity utilization for the hybrid vehicle.

FIG. 95 illustrates an alternative embodiment of the operational flow of FIG. 94.

FIG. 96 illustrates an alternative embodiment of the operational flow of FIG. 94.

FIG. 97 illustrates an alternative embodiment of the operational flow of FIG. 94.

FIG. 98 illustrates an operational flow representing example operations related to querying a hybrid vehicle for at least one of a status indicative of combustible fuel utilization or a status indicative of electricity utilization for the vehicle, transmitting to an off-site entity the at least one of the status indicative of combustible fuel utilization or the status indicative of electricity utilization for the hybrid vehicle, and calculating a time for transmitting the status.

FIG. 99 illustrates an alternative embodiment of the operational flow of FIG. 94.

FIG. 100 illustrates an operational flow representing example operations related to querying a hybrid vehicle for at least one of a status indicative of combustible fuel utilization or a status indicative of electricity utilization for the vehicle and storing data regarding the status.

FIG. 101 illustrates an operational flow representing example operations related to querying a hybrid vehicle for at least one of a status indicative of combustible fuel utilization or a status indicative of electricity utilization for the vehicle and storing data regarding the transmission of the status.

FIG. 102 illustrates an alternative embodiment of the operational flow of FIG. 87.

FIG. 103 illustrates an alternative embodiment of the operational flow of FIG. 87.

FIG. 104 illustrates an alternative embodiment of the operational flow of FIG. 87.

FIG. 105 illustrates an alternative embodiment of the operational flow of FIG. 87.

FIG. 106 illustrates an alternative embodiment of the operational flow of FIG. 87.

FIG. 107 illustrates an alternative embodiment of the operational flow of FIG. 87.

FIG. 108 illustrates an operational flow representing example operations related to querying a hybrid vehicle for at least one of a status indicative of combustible fuel utilization or a status indicative of electricity utilization for the vehicle and allocating a standing based upon the at least one of the status indicative of combustible fuel utilization or the status indicative of electricity utilization for the vehicle.

FIG. 109 illustrates an operational flow representing example operations related to querying a hybrid vehicle for at least one of a status indicative of combustible fuel utilization or a status indicative of electricity utilization for the vehicle, allocating a standing based upon the status for the vehicle, and receiving a selection associated with the hybrid vehicle.

FIG. 110 illustrates an alternative embodiment of the operational flow of FIG. 108.

FIG. 111 illustrates an alternative embodiment of the operational flow of FIG. 108.

FIG. 112 illustrates an alternative embodiment of the operational flow of FIG. 108.

FIG. 113 illustrates an alternative embodiment of the operational flow of FIG. 108.

FIG. 114 illustrates an alternative embodiment of the operational flow of FIG. 108.

FIG. 115 illustrates an alternative embodiment of the operational flow of FIG. 108.

FIG. 116 illustrates an alternative embodiment of the operational flow of FIG. 108.

FIG. 117 illustrates an alternative embodiment of the operational flow of FIG. 108.

FIG. 118 illustrates an alternative embodiment of the operational flow of FIG. 108.

FIG. 119 illustrates an operational flow representing example operations related to querying a hybrid vehicle for at least one of a status indicative of combustible fuel utilization or a status indicative of electricity utilization for the vehicle, allocating a standing based upon the status for the vehicle, and canceling a penalty utilizing the standing.

FIG. 120 illustrates an operational flow representing example operations related to querying a hybrid vehicle for at least one of a status indicative of combustible fuel utilization or a status indicative of electricity utilization for the vehicle, allocating a standing based upon the status for the vehicle, and reducing a penalty utilizing the standing.

FIG. 121 illustrates an operational flow representing example operations related to querying a hybrid vehicle for at least one of a status indicative of combustible fuel utilization or a status indicative of electricity utilization for the vehicle, allocating a standing based upon the status for the vehicle, and selling the standing to a second entity.

FIG. 122 illustrates an operational flow representing example operations related to querying a hybrid vehicle for at least one of a status indicative of combustible fuel utilization or a status indicative of electricity utilization for the vehicle, allocating a standing based upon the status for the vehicle, and transferring the standing to a second entity.

FIG. 123 illustrates an operational flow representing example operations related to querying a hybrid vehicle for at least one of a status indicative of combustible fuel utilization or a status indicative of electricity utilization for the vehicle, allocating a standing based upon the status for the vehicle, and transferring the standing to an individual.

FIG. 124 illustrates an operational flow representing example operations related to querying a vehicle for a status indicative of combustible fuel utilization in comparison to electricity utilization for the vehicle.

FIG. 125 illustrates an operational flow representing example operations related to querying a vehicle for a status indicative of combustible fuel utilization in comparison to electricity utilization for the vehicle and receiving a status indicative of combustible fuel utilization in comparison to electricity utilization for a vehicle.

FIG. 126 illustrates an alternative embodiment of the operational flow of FIG. 125.

FIG. 127 illustrates an alternative embodiment of the operational flow of FIG. 125.

FIG. 128 illustrates an alternative embodiment of the operational flow of FIG. 125.

FIG. 129 illustrates an alternative embodiment of the operational flow of FIG. 125.

FIG. 130 illustrates an operational flow representing example operations related to querying a vehicle for a status indicative of combustible fuel utilization in comparison to electricity utilization for the vehicle and receiving at least one of a vehicle identification, an operator identification, a time, a location, a direction, or a speed associated with the vehicle.

FIG. 131 illustrates an operational flow representing example operations related to querying a vehicle for a status indicative of combustible fuel utilization in comparison to electricity utilization for the vehicle and transmitting to an off-site entity the status indicative of combustible fuel utilization in comparison to electricity utilization for the vehicle.

FIG. 132 illustrates an alternative embodiment of the operational flow of FIG. 131.

FIG. 133 illustrates an alternative embodiment of the operational flow of FIG. 131.

FIG. 134 illustrates an alternative embodiment of the operational flow of FIG. 131.

FIG. 135 illustrates an operational flow representing example operations related to querying a vehicle for a status indicative of combustible fuel utilization in comparison to electricity utilization for the vehicle, transmitting to an off-site entity the status indicative of combustible fuel utilization in comparison to electricity utilization for the vehicle, and calculating a time for transmitting the status.

FIG. 136 illustrates an alternative embodiment of the operational flow of FIG. 131.

FIG. 137 illustrates an operational flow representing example operations related to querying a vehicle for a status indicative of combustible fuel utilization in comparison to electricity utilization for the vehicle and storing data regarding the status.

FIG. 138 illustrates an operational flow representing example operations related to querying a vehicle for a status indicative of combustible fuel utilization in comparison to electricity utilization for the vehicle and storing data regarding the transmission of the status.

FIG. 139 illustrates an alternative embodiment of the operational flow of FIG. 124.

FIG. 140 illustrates an alternative embodiment of the operational flow of FIG. 124.

FIG. 141 illustrates an alternative embodiment of the operational flow of FIG. 124.

FIG. 142 illustrates an alternative embodiment of the operational flow of FIG. 124.

FIG. 143 illustrates an alternative embodiment of the operational flow of FIG. 124.

FIG. 144 illustrates an alternative embodiment of the operational flow of FIG. 124.

FIG. 145 illustrates an operational flow related to querying a vehicle for a status indicative of combustible fuel utilization in comparison to electricity utilization for the vehicle and allocating a standing based upon the status indicative of combustible fuel utilization in comparison to electricity utilization for the vehicle.

FIG. 146 illustrates an operational flow representing example operations related to querying a vehicle for a status indicative of combustible fuel utilization in comparison to electricity utilization for the vehicle, allocating a standing based upon the status for the vehicle, and receiving a selection associated with the vehicle.

FIG. 147 illustrates an alternative embodiment of the operational flow of FIG. 145.

FIG. 148 illustrates an alternative embodiment of the operational flow of FIG. 145.

FIG. 149 illustrates an alternative embodiment of the operational flow of FIG. 145.

FIG. 150 illustrates an alternative embodiment of the operational flow of FIG. 145.

FIG. 151 illustrates an alternative embodiment of the operational flow of FIG. 145.

FIG. 152 illustrates an alternative embodiment of the operational flow of FIG. 145.

FIG. 153 illustrates an alternative embodiment of the operational flow of FIG. 145.

FIG. 154 illustrates an alternative embodiment of the operational flow of FIG. 145.

FIG. 155 illustrates an alternative embodiment of the operational flow of FIG. 145.

FIG. 156 illustrates an operational flow representing example operations related to querying a vehicle for a status indicative of combustible fuel utilization in comparison to electricity utilization for the vehicle, allocating a standing based upon the status for the vehicle, and canceling a penalty utilizing the standing.

FIG. 157 illustrates an operational flow representing example operations related to querying a vehicle for a status indicative of combustible fuel utilization in comparison to electricity utilization for the vehicle, allocating a standing based upon the status for the vehicle, and reducing a penalty utilizing the standing.

FIG. 158 illustrates an operational flow representing example operations related to querying a vehicle for a status indicative of combustible fuel utilization in comparison to electricity utilization for the vehicle, allocating a standing based upon the status for the vehicle, and selling the standing to a second entity.

FIG. 159 illustrates an operational flow representing example operations related to querying a vehicle for a status indicative of combustible fuel utilization in comparison to electricity utilization for the vehicle, allocating a standing based upon the status for the vehicle, and transferring the standing to a second entity.

FIG. 160 illustrates an operational flow representing example operations related to querying a vehicle for a status indicative of combustible fuel utilization in comparison to electricity utilization for the vehicle, allocating a standing based upon the status for the vehicle, and transferring the standing to an individual.

FIG. 161 illustrates a computer program product related to querying a hybrid vehicle for at least one of a status indicative of combustible fuel utilization or a status indicative of electricity utilization for the vehicle.

FIG. 162 illustrates a computer program product related to querying a vehicle for a status indicative of combustible fuel utilization in comparison to electricity utilization for the vehicle.

FIG. 163 illustrates an operational flow representing example operations related to receiving at least one of a status indicative of combustible fuel utilization or a status indicative of electricity utilization for a hybrid vehicle and forwarding to an off-site entity the at least one of the status indicative of combustible fuel utilization or the status indicative of electricity utilization for the vehicle.

FIG. 164 illustrates an alternative embodiment of the operational flow of FIG. 163.

FIG. 165 illustrates an alternative embodiment of the operational flow of FIG. 163.

FIG. 166 illustrates an alternative embodiment of the operational flow of FIG. 163.

FIG. 167 illustrates an alternative embodiment of the operational flow of FIG. 163.

FIG. 168 illustrates an alternative embodiment of the operational flow of FIG. 163.

FIG. 169 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and receiving at least one of a hybrid vehicle identification, an operator identification, a time, a location, a direction, or a speed associated with the hybrid vehicle.

FIG. 170 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and transmitting to an off-site entity the at least one of the status indicative of combustible fuel utilization or the status indicative of electricity utilization for the hybrid vehicle.

FIG. 171 illustrates an alternative embodiment of the operational flow of FIG. 170.

FIG. 172 illustrates an alternative embodiment of the operational flow of FIG. 170.

FIG. 173 illustrates an alternative embodiment of the operational flow of FIG. 170.

FIG. 174 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, transmitting to an off-site entity the at least one of the status indicative of combustible fuel utilization or the status indicative of electricity utilization for the hybrid vehicle, and calculating a time for transmitting the status.

FIG. 175 illustrates an alternative embodiment of the operational flow of FIG. 170.

FIG. 176 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and storing data regarding the status.

FIG. 177 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and storing data regarding the transmission of the status.

FIG. 178 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and querying for the status.

FIG. 179 illustrates an alternative embodiment of the operational flow of FIG. 178.

FIG. 180 illustrates an alternative embodiment of the operational flow of FIG. 178.

FIG. 181 illustrates an alternative embodiment of the operational flow of FIG. 178.

FIG. 182 illustrates an alternative embodiment of the operational flow of FIG. 178.

FIG. 183 illustrates an alternative embodiment of the operational flow of FIG. 178.

FIG. 184 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and allocating a standing based upon the at least one of the status indicative of combustible fuel utilization or the status indicative of electricity utilization for the vehicle.

FIG. 185 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and receiving a selection associated with the hybrid vehicle.

FIG. 186 illustrates an alternative embodiment of the operational flow of FIG. 184.

FIG. 187 illustrates an alternative embodiment of the operational flow of FIG. 184.

FIG. 188 illustrates an alternative embodiment of the operational flow of FIG. 184.

FIG. 189 illustrates an alternative embodiment of the operational flow of FIG. 184.

FIG. 190 illustrates an alternative embodiment of the operational flow of FIG. 184.

FIG. 191 illustrates an alternative embodiment of the operational flow of FIG. 184.

FIG. 192 illustrates an alternative embodiment of the operational flow of FIG. 184.

FIG. 193 illustrates an alternative embodiment of the operational flow of FIG. 184.

FIG. 194 illustrates an alternative embodiment of the operational flow of FIG. 184.

FIG. 195 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and canceling a penalty utilizing the standing.

FIG. 196 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and reducing a penalty utilizing the standing.

FIG. 197 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and selling the standing to a second entity.

FIG. 198 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and transferring the standing to a second entity.

FIG. 199 illustrates an operational flow representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and transferring the standing to an individual.

FIG. 200 illustrates an operational flow representing example operations related to receiving a status indicative of combustible fuel utilization in comparison to electricity utilization for a vehicle and forwarding to an off-site entity the status indicative of combustible fuel utilization in comparison to electricity utilization for the vehicle.

FIG. 201 illustrates an alternative embodiment of the operational flow of FIG. 200.

FIG. 202 illustrates an alternative embodiment of the operational flow of FIG. 200.

FIG. 203 illustrates an alternative embodiment of the operational flow of FIG. 200.

FIG. 204 illustrates an alternative embodiment of the operational flow of FIG. 200.

FIG. 205 illustrates an alternative embodiment of the operational flow of FIG. 200.

FIG. 206 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and receiving at least one of a vehicle identification, an operator identification, a time, a location, a direction, or a speed associated with the vehicle.

FIG. 207 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and transmitting to an off-site entity the status indicative of combustible fuel utilization in comparison to electricity utilization for the vehicle.

FIG. 208 illustrates an alternative embodiment of the operational flow of FIG. 207.

FIG. 209 illustrates an alternative embodiment of the operational flow of FIG. 207.

FIG. 210 illustrates an alternative embodiment of the operational flow of FIG. 207.

FIG. 211 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, transmitting to an off-site entity the status indicative of combustible fuel utilization in comparison to electricity utilization for the vehicle, and calculating a time for transmitting the status.

FIG. 212 illustrates an alternative embodiment of the operational flow of FIG. 207.

FIG. 213 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and storing data regarding the status.

FIG. 214 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and storing data regarding the transmission of the status.

FIG. 215 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and querying for the status.

FIG. 216 illustrates an alternative embodiment of the operational flow of FIG. 215.

FIG. 217 illustrates an alternative embodiment of the operational flow of FIG. 215.

FIG. 218 illustrates an alternative embodiment of the operational flow of FIG. 215.

FIG. 219 illustrates an alternative embodiment of the operational flow of FIG. 215.

FIG. 220 illustrates an alternative embodiment of the operational flow of FIG. 215.

FIG. 221 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, and allocating a standing based upon the status indicative of combustible fuel utilization in comparison to electricity utilization for the vehicle.

FIG. 222 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and receiving a selection associated with the vehicle.

FIG. 223 illustrates an alternative embodiment of the operational flow of FIG. 221.

FIG. 224 illustrates an alternative embodiment of the operational flow of FIG. 221.

FIG. 225 illustrates an alternative embodiment of the operational flow of FIG. 221.

FIG. 226 illustrates an alternative embodiment of the operational flow of FIG. 221.

FIG. 227 illustrates an alternative embodiment of the operational flow of FIG. 221.

FIG. 228 illustrates an alternative embodiment of the operational flow of FIG. 221.

FIG. 229 illustrates an alternative embodiment of the operational flow of FIG. 221.

FIG. 230 illustrates an alternative embodiment of the operational flow of FIG. 221.

FIG. 231 illustrates an alternative embodiment of the operational flow of FIG. 221.

FIG. 232 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and canceling a penalty utilizing the standing.

FIG. 233 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and reducing a penalty utilizing the standing.

FIG. 234 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and selling the standing to a second entity.

FIG. 235 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and transferring the standing to a second entity.

FIG. 236 illustrates an operational flow representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and transferring the standing to an individual.

FIG. 237 illustrates a computer program product related to receiving at least one of a status indicative of combustible fuel utilization or a status indicative of electricity utilization for a hybrid vehicle and forwarding to an off-site entity the at least one of the status indicative of combustible fuel utilization or the status indicative of electricity utilization for the vehicle.

FIG. 238 illustrates a computer program product related to receiving a status indicative of combustible fuel utilization in comparison to electricity utilization for a vehicle and forwarding to an off-site entity the status indicative of combustible fuel utilization in comparison to electricity utilization for the vehicle.

FIG. 239 illustrates an operational flow representing example operations related to receiving at least one of a status indicative of combustible fuel utilization or a status indicative of electricity utilization for a hybrid vehicle and conveying a standing, the standing based upon the at least one of the status indicative of combustible fuel utilization or the status indicative of electricity utilization for the vehicle.

FIG. 240 illustrates an alternative embodiment of the operational flow of FIG. 239.

FIG. 241 illustrates an alternative embodiment of the operational flow of FIG. 239.

FIG. 242 illustrates an alternative embodiment of the operational flow of FIG. 239.

FIG. 243 illustrates an alternative embodiment of the operational flow of FIG. 239.

FIG. 244 illustrates an alternative embodiment of the operational flow of FIG. 239.

FIG. 245 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and receiving at least one of a hybrid vehicle identification, an operator identification, a time, a location, a direction, or a speed associated with the hybrid vehicle.

FIG. 246 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and transmitting to an off-site entity the at least one of the status indicative of combustible fuel utilization or the status indicative of electricity utilization for the hybrid vehicle.

FIG. 247 illustrates an alternative embodiment of the operational flow of FIG. 246.

FIG. 248 illustrates an alternative embodiment of the operational flow of FIG. 246.

FIG. 249 illustrates an alternative embodiment of the operational flow of FIG. 246.

FIG. 250 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, transmitting to an off-site entity the at least one of the status indicative of combustible fuel utilization or the status indicative of electricity utilization for the hybrid vehicle, and calculating a time for transmitting the status.

FIG. 251 illustrates an alternative embodiment of the operational flow of FIG. 246.

FIG. 252 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and storing data regarding the status.

FIG. 253 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and storing data regarding the transmission of the status.

FIG. 254 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and querying for the status.

FIG. 255 illustrates an alternative embodiment of the operational flow of FIG. 246.

FIG. 256 illustrates an alternative embodiment of the operational flow of FIG. 246.

FIG. 257 illustrates an alternative embodiment of the operational flow of FIG. 246.

FIG. 258 illustrates an alternative embodiment of the operational flow of FIG. 246.

FIG. 259 illustrates an alternative embodiment of the operational flow of FIG. 246.

FIG. 260 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and allocating a standing based upon the at least one of the status indicative of combustible fuel utilization or the status indicative of electricity utilization for the vehicle.

FIG. 261 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and receiving a selection associated with the hybrid vehicle.

FIG. 262 illustrates an alternative embodiment of the operational flow of FIG. 260.

FIG. 263 illustrates an alternative embodiment of the operational flow of FIG. 260.

FIG. 264 illustrates an alternative embodiment of the operational flow of FIG. 260.

FIG. 265 illustrates an alternative embodiment of the operational flow of FIG. 260.

FIG. 266 illustrates an alternative embodiment of the operational flow of FIG. 260.

FIG. 267 illustrates an alternative embodiment of the operational flow of FIG. 260.

FIG. 268 illustrates an alternative embodiment of the operational flow of FIG. 260.

FIG. 269 illustrates an alternative embodiment of the operational flow of FIG. 260.

FIG. 270 illustrates an alternative embodiment of the operational flow of FIG. 260.

FIG. 271 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and canceling a penalty utilizing the standing.

FIG. 272 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and reducing a penalty utilizing the standing.

FIG. 273 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and selling the standing to a second entity.

FIG. 274 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and transferring the standing to a second entity.

FIG. 275 illustrates an operational flow representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and transferring the standing to an individual.

FIG. 276 illustrates an operational flow representing example operations related to receiving a status indicative of combustible fuel utilization in comparison to electricity utilization for a vehicle and conveying a standing, the standing based upon the status indicative of combustible fuel utilization in comparison to electricity utilization for the vehicle.

FIG. 277 illustrates an alternative embodiment of the operational flow of FIG. 276.

FIG. 278 illustrates an alternative embodiment of the operational flow of FIG. 276.

FIG. 279 illustrates an alternative embodiment of the operational flow of FIG. 276.

FIG. 280 illustrates an alternative embodiment of the operational flow of FIG. 276.

FIG. 281 illustrates an alternative embodiment of the operational flow of FIG. 276.

FIG. 282 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and receiving at least one of a vehicle identification, an operator identification, a time, a location, a direction, or a speed associated with the vehicle.

FIG. 283 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and transmitting to an off-site entity the status indicative of combustible fuel utilization in comparison to electricity utilization for the vehicle.

FIG. 284 illustrates an alternative embodiment of the operational flow of FIG. 283.

FIG. 285 illustrates an alternative embodiment of the operational flow of FIG. 283.

FIG. 286 illustrates an alternative embodiment of the operational flow of FIG. 283.

FIG. 287 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, transmitting to an off-site entity the status indicative of combustible fuel utilization in comparison to electricity utilization for the vehicle, and calculating a time for transmitting the status.

FIG. 288 illustrates an alternative embodiment of the operational flow of FIG. 283.

FIG. 289 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and storing data regarding the status.

FIG. 290 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and storing data regarding the transmission of the status.

FIG. 291 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and querying for the status.

FIG. 292 illustrates an alternative embodiment of the operational flow of FIG. 291.

FIG. 293 illustrates an alternative embodiment of the operational flow of FIG. 291.

FIG. 294 illustrates an alternative embodiment of the operational flow of FIG. 291.

FIG. 295 illustrates an alternative embodiment of the operational flow of FIG. 291.

FIG. 296 illustrates an alternative embodiment of the operational flow of FIG. 291.

FIG. 297 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and allocating a standing based upon the status indicative of combustible fuel utilization in comparison to electricity utilization for the vehicle.

FIG. 298 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and receiving a selection associated with the vehicle.

FIG. 299 illustrates an alternative embodiment of the operational flow of FIG. 297.

FIG. 300 illustrates an alternative embodiment of the operational flow of FIG. 297.

FIG. 301 illustrates an alternative embodiment of the operational flow of FIG. 297.

FIG. 302 illustrates an alternative embodiment of the operational flow of FIG. 297.

FIG. 303 illustrates an alternative embodiment of the operational flow of FIG. 297.

FIG. 304 illustrates an alternative embodiment of the operational flow of FIG. 297.

FIG. 305 illustrates an alternative embodiment of the operational flow of FIG. 297.

FIG. 306 illustrates an alternative embodiment of the operational flow of FIG. 297.

FIG. 307 illustrates an alternative embodiment of the operational flow of FIG. 297.

FIG. 308 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and canceling a penalty utilizing the standing.

FIG. 309 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and reducing a penalty utilizing the standing.

FIG. 310 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and selling the standing to a second entity.

FIG. 311 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and transferring the standing to a second entity.

FIG. 312 illustrates an operational flow representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and transferring the standing to an individual.

FIG. 313 illustrates a computer program product related to receiving at least one of a status indicative of combustible fuel utilization or a status indicative of electricity utilization for a hybrid vehicle and conveying a standing, the standing based upon the at least one of the status indicative of combustible fuel utilization or the status indicative of electricity utilization for the vehicle.

FIG. 314 illustrates a computer program product related to receiving a status indicative of combustible fuel utilization in comparison to electricity utilization for a vehicle and conveying a standing, the standing based upon the status indicative of combustible fuel utilization in comparison to electricity utilization for the vehicle.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

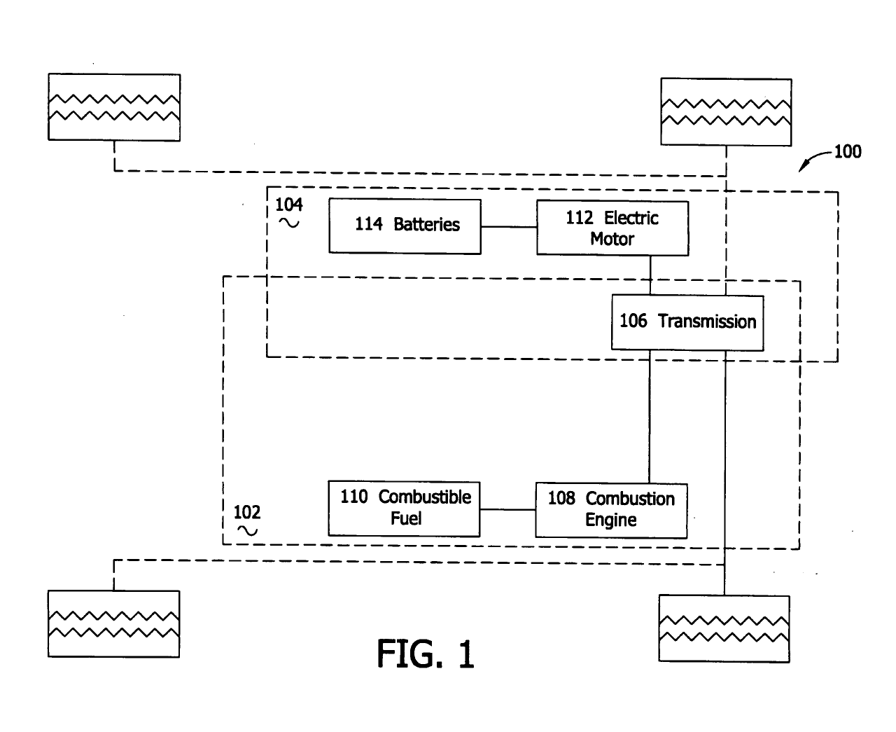

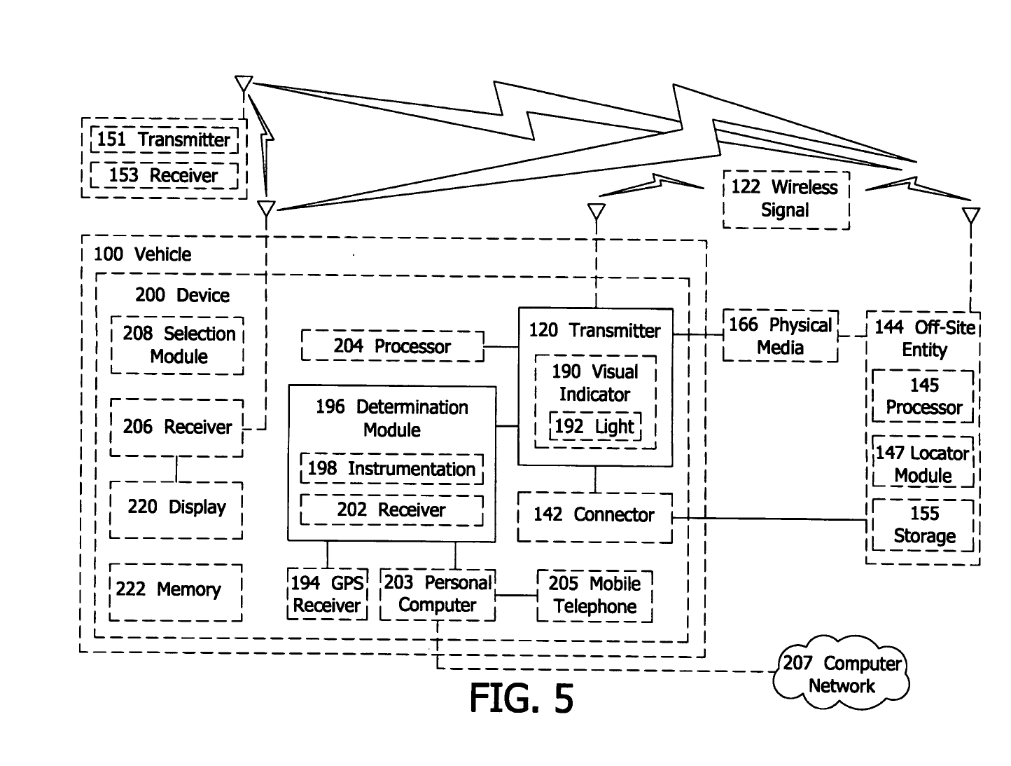

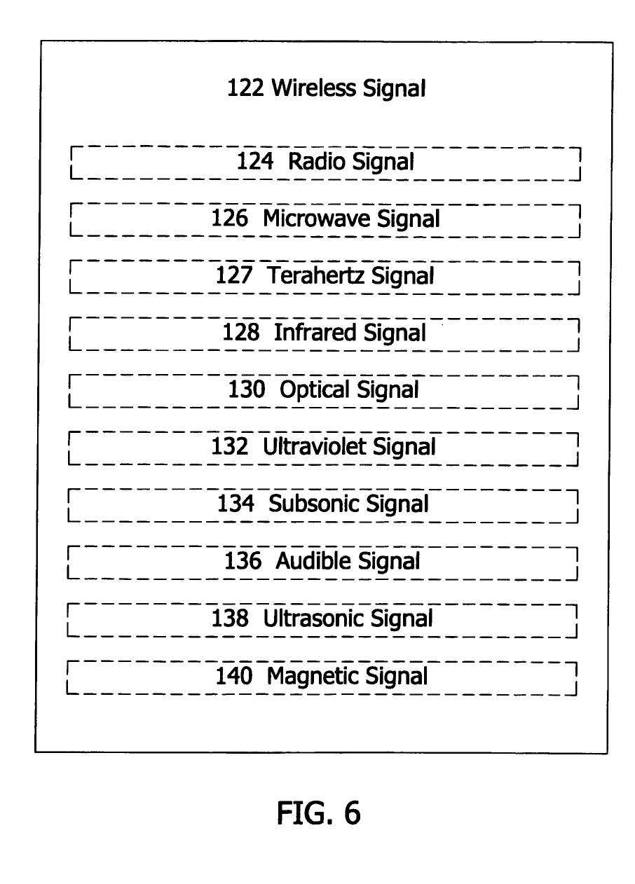

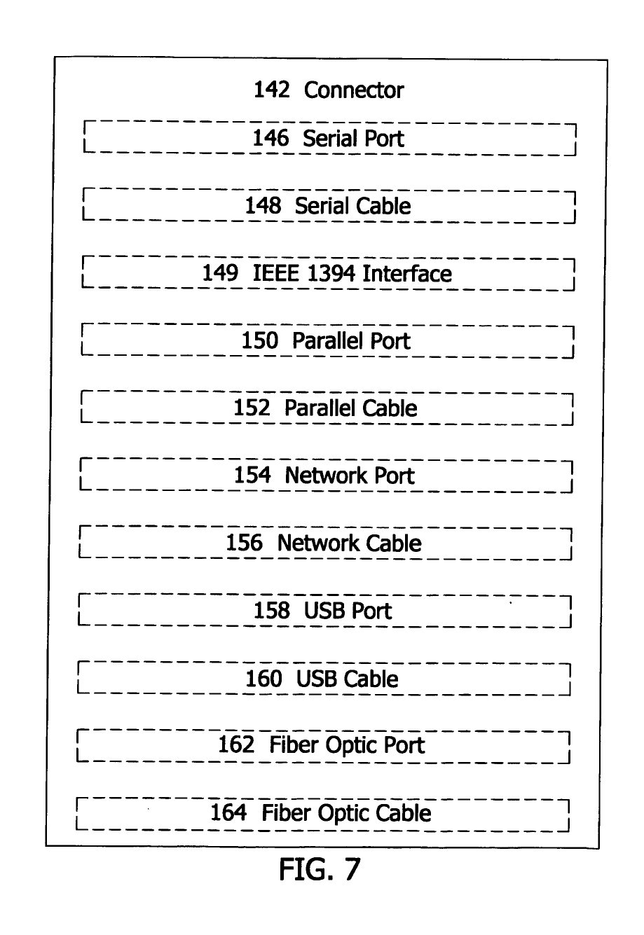

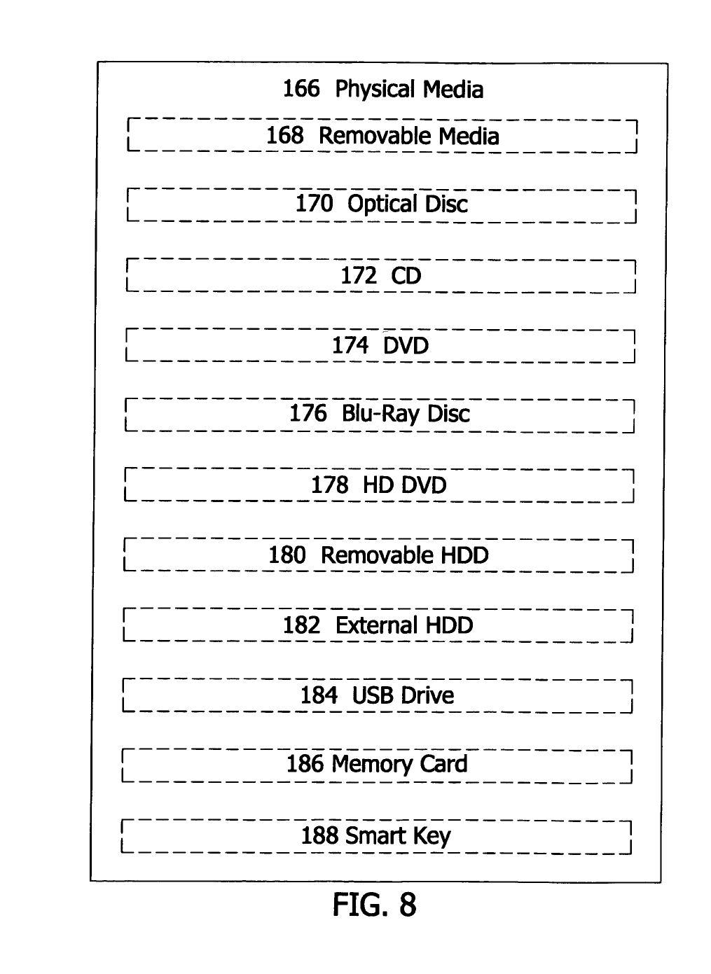

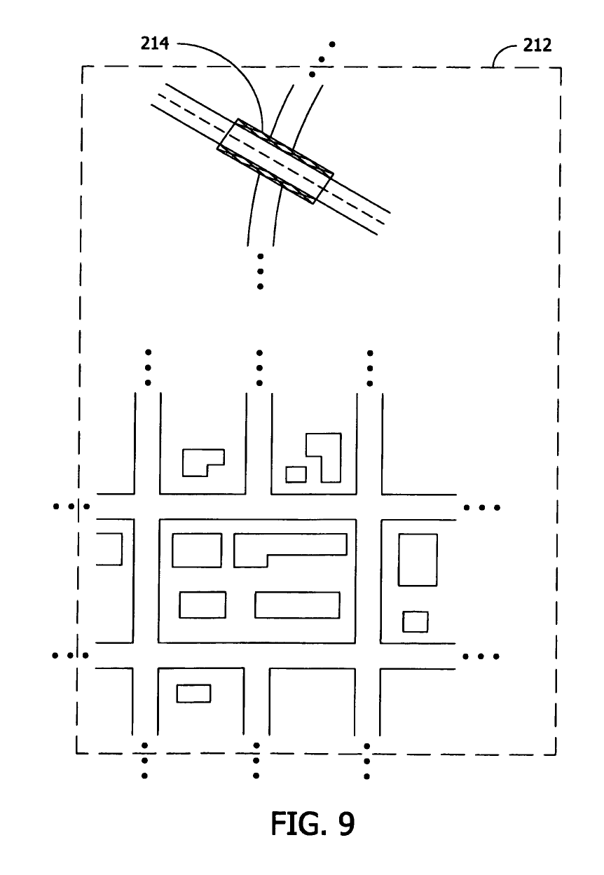

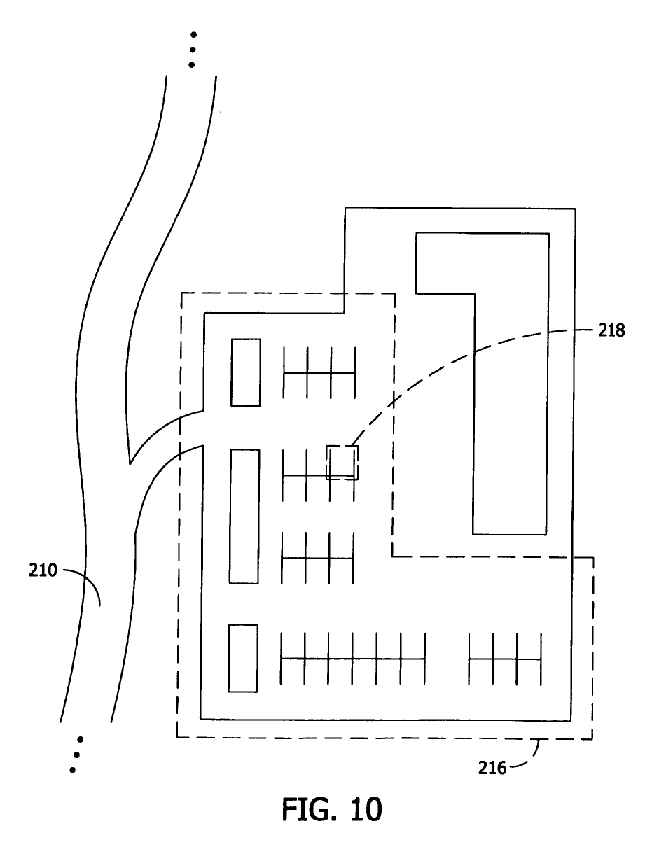

Referring now to FIGS. 1 through 10, a vehicle 100 is described in accordance with the present disclosure. The vehicle 100 may be propelled utilizing one or more of a combustible fuel and electricity. For instance, the vehicle 100 may be a hybrid vehicle that utilizes both a first drive train 102 powered by combustible fuel for driving (propelling) the vehicle 100 and a second drive train 104 powered by electricity for driving (propelling) the vehicle 100.

In an embodiment, one or more rewards or privileges is provided to the vehicle 100 (or to its owner, driver or one or more passengers), based upon driving characteristics that provide some benefit to the surroundings. A reward or privilege may include access to an otherwise prohibited route, such as, for example, a Heavily Occupied Vehicle (HOV) lane, or access to a lower-burden route, such as a toll-free lane. A benefit to the surroundings may include, for example, a decrease in emissions (e.g., where emissions include the exhaust from a combustion engine powered by combustible fuel) or lower fuel consumption. Thus, in a case where the first drive train 102 includes a combustion engine, and the second drive train 104 includes a battery, utilization of the second drive train 104 may be preferable over the first drive train 102 from an environmental standpoint and may qualify the vehicle 100 for one or more privileges or rewards. Alternatively, one or more penalties is provided to the vehicle 100 (or to its owner, driver or one or more passengers), based upon driving characteristics that provide some negative impact to the surroundings (e.g., utilizing the first drive train 102 instead of the second drive train 104). A penalty may include, among other things, a tax, a fee, an increase in recharging costs, an increase in refueling costs, an elimination of a privilege, a revocation of a privilege, or a partial reduction in a privilege. Within the context of the present disclosure, rewards, privileges, penalties, and the like are broadly defined as “standings,” a term encompassing positive, negative, and possible neutral status.

A combustible fuel may include any fuel capable of reacting with an oxidizing element to produce heat (and possibly reaction products). Organic-based fuels are one type of combustible fuel. Organic-based fuels may include, but are not limited to, alcohols (i.e., compounds having a hydroxyl group bound to a carbon atom of an alkyl or substituted alkyl group), such as ethyl alcohol (ethanol), methyl alcohol (methanol), and isopropyl alcohol, etc.; ketones (i.e., compounds having a carbonyl group bonded to two other carbon atoms), such as acetone, acetophenone, and methyl ethyl ketone, etc.; and hydrocarbon-based fuels.

Hydrocarbon-based fuels may include, but are not limited to, gasoline (also referred to as gas or petrol) derived from petroleum and containing a mixture of hydrocarbons including hexane, heptane, or octane (gasoline may be enhanced with iso-octane or toluene or benzene); diesel (also known as petroleum diesel); natural gas or Liquid Petroleum Gas (LPG), mixtures of gaseous hydrocarbons associated with petroleum deposits (natural gas may include methane combined with ethane, propane, or butane); kerosene; naphtha (a petroleum fraction which may be further processed); and various oils and bio-fuels, i.e., mineral, vegetable, or synthetic substances or animal or vegetable fats. It is further contemplated that hydrocarbon-based fuels may include fuel additives, such as hybrid compound blends (e.g., polymerization agents for increased fuel ignition surface area, stabilizers, catalysts, or detergents); alcohols (e.g., methanol, ethanol, or isopropyl alcohol); ethers; antioxidants; antiknock agents; lead scavengers; or fuel dyes and the like.

It is contemplated that a combustible fuel may include hydrogen. Further, a combustible fuel may include any fuel capable of chemical combustion (e.g., sodium or magnesium in the presence of water).

Electricity utilization may include electricity drawn from a public power grid to magnetize sections of a rail planted below a roadway, where the vehicle 100 includes rare earth magnets (or electromagnets) that propel the vehicle by crossing through alternating magnetic fields along the magnetized rail. Further, it will be appreciated that electricity utilization for the vehicle 100 may include any utilization of electrical power for generating one or more magnetic fields, either externally to the vehicle 100, or proximal to the vehicle itself.

In an embodiment, illustrated in FIG. 1, the vehicle 100 includes a first drive train 102 comprising a transmission 106 coupled with a combustion device (e.g., combustion engine 108) powered by combustible fuel 110. The vehicle 100 also includes a second drive train 104 comprising the transmission 106 coupled with an electric motor 112 powered by one or more batteries 114. Both the combustion engine 108 and the electric motor 112 are configured to supply power to the transmission 106 (either together or separately) for turning one or more wheels and driving, or propelling, the vehicle 100.

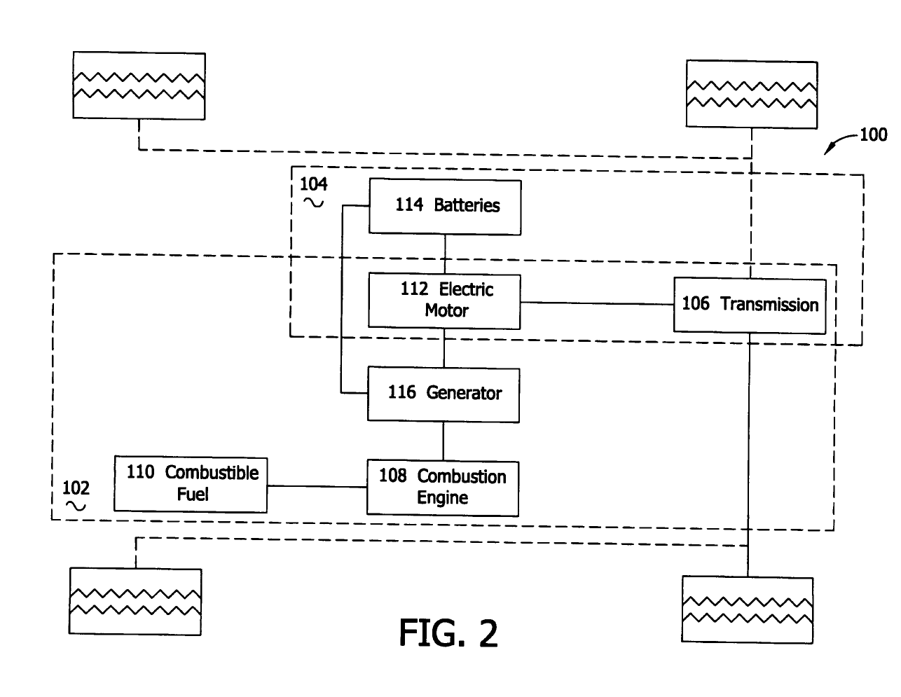

In an embodiment, illustrated in FIG. 2, the vehicle 100 includes a first drive train 102 comprising a transmission 106 coupled with an electric motor 112 powered by a generator 116 coupled with a combustion engine 108 powered by combustible fuel 110. The vehicle 100 also includes a second drive train 104 comprising the transmission 106 coupled with the electric motor 112, which is powered by one or more batteries 114. The generator 116 is also connected to the batteries 114. The generator 116 is configured for either charging the batteries 114, or powering the electric motor 112 to supply power to the transmission 106 for turning one or more wheels and driving the vehicle 100. It will be appreciated that even though the combustion engine 108 is not directly connected to the transmission 106 (in this embodiment), the combustible fuel 110 is still utilized to propel the vehicle 100 via the first drive train 102, by powering the electric motor 112 via the generator 116.

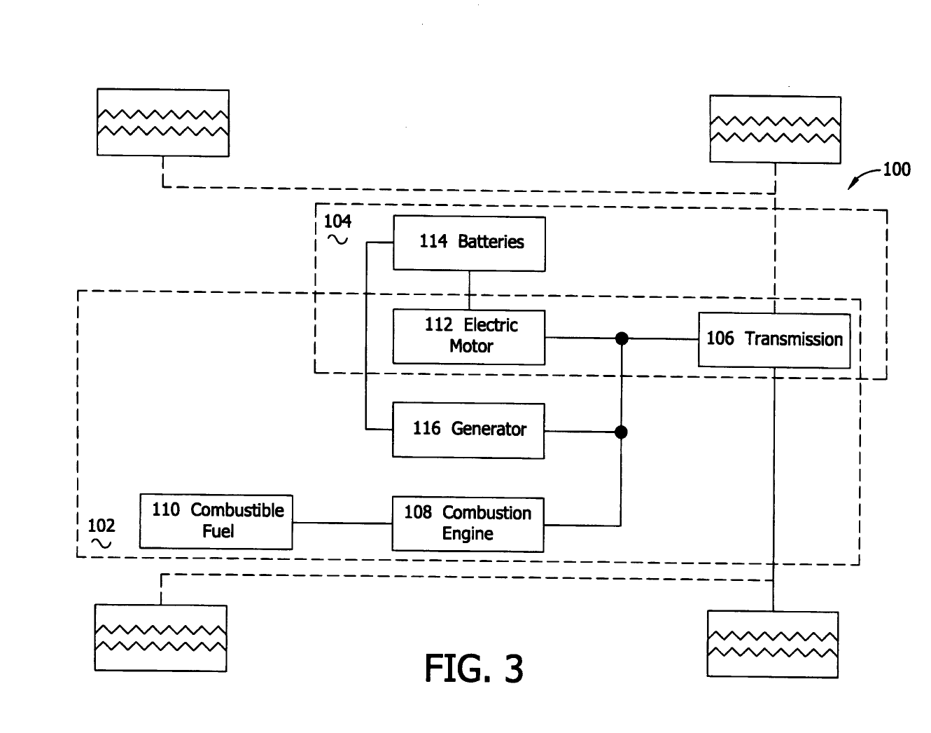

In an embodiment, illustrated in FIG. 3, the vehicle 100 includes a first drive train 102 comprising a transmission 106 coupled with an electric motor 112, a generator 116, and a combustion engine 108 powered by combustible fuel 110. The vehicle 100 also includes a second drive train 104 comprising the transmission 106 coupled with the electric motor 112, which is powered by one or more batteries 114. The generator 116 is connected to the batteries 114 for charging the batteries 114. In this embodiment, both the combustion engine 108 and the electric motor 112 are configured to supply power to the transmission 106 (either together or separately) for turning one or more wheels and driving the vehicle 100. For instance, at lower speeds, the electric motor 112 and the batteries 114 may be utilized to power the vehicle 100. At higher speeds, the combustion engine 108 may be utilized with the generator 116 for powering the vehicle 100.

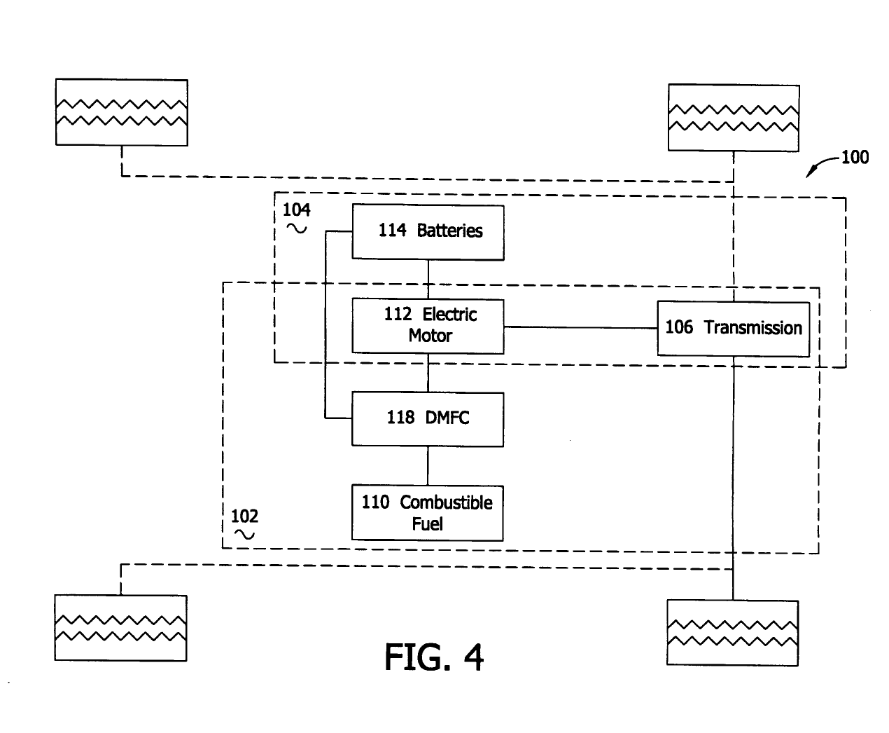

It should be noted that combustible fuel may be utilized to propel the vehicle 100 without combustion actually taking place. For example, in the embodiment illustrated in FIG. 4, the vehicle 100 may be propelled utilizing one or more Direct Methanol Fuel Cells (DMFC) 118 powered by combustible fuel 110 and an electric motor 112 powered by the fuel cells 118 or one or more batteries 114. The vehicle 100 includes a first drive train 102 comprising a transmission 106 coupled with the electric motor 112 and powered by the DMFC 118. The vehicle 100 also includes a second drive train 104 comprising the transmission 106 coupled with the electric motor 112 and powered by the batteries 114. The fuel cells 118 are also connected to the batteries 114 and are configured for either charging the batteries 114, or powering the electric motor 112 to supply power to the transmission 106 for turning one or more wheels and driving the vehicle 100. In an embodiment, the vehicle 100 is supplied with the combustible fuel 110 methanol, which is fed directly to the DMFC 118 where it is utilized to produce electricity in the presence of a catalyst (i.e., the catalyst draws hydrogen directly from the liquid methanol). The electricity is then utilized to propel the vehicle (or stored by the one or more batteries 114). In this configuration, the fuel cells 118 may produce carbon dioxide and water as reaction products.

For the purposes of the present disclosure, propelling the vehicle 100 or charging one or more batteries 114 to propel the vehicle 100 while drawing hydrogen from methanol is considered as utilizing a combustible fuel, just as combusting the fuel to propel the vehicle 100 or to charge one or more batteries 114 to propel the vehicle 100 would be in the case of a combustion engine 108. Further, propelling the vehicle by utilizing energy stored in the batteries 114 while not utilizing the combustible fuel 110 is defined as utilizing electricity. It is also contemplated that the combustible fuel 110 may be utilized to produce electricity for propelling the vehicle 100 while the vehicle 100 also utilizes electrical energy stored in the batteries 114 for propulsion; alternatively, the combustible fuel 110 may be utilized to produce electricity for propelling the vehicle 100 while storing electrical energy in the batteries 114. Combustible fuel utilization may be compared to electricity utilization in any of these configurations. Alternatively, a rate of consumption for either combustible fuel or electricity may be compared against a theoretical or practical limit (e.g., to determine how efficiently one type of energy source or another is being consumed).

The vehicle 100 may include a transmitter 120 for transmitting a status indicative of, for example, one or more of combustible fuel utilization, electricity utilization, and combustible fuel utilization in comparison to electricity utilization for the vehicle 100. The transmitter 120 may transmit the status for the vehicle 100 via a wireless signal 122. For example, the transmitter 120 may transmit the status for the vehicle 100 via one or more of a radio signal 124, a microwave signal 126, a terahertz signal 127, an infrared signal 128, an optical signal 130, an ultraviolet signal 132, a subsonic signal 134, an audible signal 136, an ultrasonic signal 138, or a magnetic signal 140. Alternatively, the transmitter 120 may be coupled with a connector 142 for connecting to an off-site entity 144 and transmitting a status indicative of one or more of combustible fuel utilization, electricity utilization, and combustible fuel utilization in comparison to electricity utilization for the vehicle 100. For instance, the connector 142 may include one or more of a serial port 146, a serial cable 148, an IEEE 1394 interface 149, a parallel port 150, a parallel cable 152, a network port 154, a network cable 156, a Universal Serial Bus (USB) port 158, a USB cable 160, a fiber optic port 162, or a fiber optic cable 164. The off-site entity 144 may include, for example, a municipality, a road authority, a receiver or transceiver maintained by a road authority, a police department, or another entity having a degree of authority over road utilization.

In an embodiment, the transmitter 120 may be included with hardware for communicating with an off-site entity 144 such as a monitoring service (e.g., a monitoring service maintained by a car company or a subsidiary thereof). The monitoring service may provide one or more of in-vehicle security, hands free calling, navigation, and remote diagnostics. In an embodiment, the transmitter 120 may be the transmitter utilized for communicating with a call center maintained by the monitoring service/off-site entity 144. The status of the vehicle 100 may be sent to the off-site entity 144 as a separate communications packet, or it may be added to another communications packet provided to the call center as part of the normal communications process. The call center/monitoring service may then forward the status to a municipality, a road authority, a receiver or transceiver maintained by a road authority, a police department, or another entity having a degree of authority over road utilization. Alternatively, the monitoring service may store the status for later examination or dissemination to an appropriate entity.

The transmitter 120 may also be utilized for transmitting a status indicative of one or more of combustible fuel utilization, electricity utilization, and combustible fuel utilization in comparison to electricity utilization for the vehicle 100 via a physical media 166. For example, the transmitter 120 may be configured to transfer a status for the vehicle 100 via one or more of a removable media 168, an optical disc 170, a Compact Disc (CD) 172 (e.g., a CD-ROM, a CD-R, or a CD-RW), a Digital Versatile Disc (DVD) 174 (e.g., a DVD-ROM, a DVD-R, a DVD+R, a DVD-RAM, a DVD-RW, or a DVD+RW), a Blu-ray Disc (BD) 176, a High-Definition DVD (HD DVD) 178, a removable Hard Disk Drive (HDD) 180, an external HDD 182, a Universal Serial Bus (USB) drive 184, a memory card 186, or a smart key 188 (e.g., a Valeo key, or the like). In an embodiment, the transmitter 120 may include a visual indicator 190 on the vehicle 100 for transmitting a status indicative of one or more of combustible fuel utilization, electricity utilization, and combustible fuel utilization in comparison to electricity utilization for the vehicle 100. For example, the vehicle 100 may include a light 192 positioned on one or more of a dashboard, a rear window ledge, or an exterior of the vehicle 100.

In an embodiment, the status may represent a driving mode. For instance, the status may indicate that the vehicle 100 is utilizing electricity for propulsion. Alternatively, the status may indicate that the vehicle 100 is utilizing combustible fuel for propulsion. In an embodiment, the status may be related to a utilization of propulsion resources. For instance, the status may indicate a rate at which the vehicle 100 is utilizing electricity for propulsion. Alternatively, the status may indicate an amount of combustible fuel utilized by the vehicle 100. In an embodiment, the status may be indicative of an instantaneous status (e.g., real-time utilization of combustible fuel or electricity), such as an instantaneous measurement representing the utilization of combustible fuel (e.g., the utilization of combustible fuel over the smallest period of time for which a measured difference is determinable). Alternatively, a rate of change of combustible fuel utilization over time (e.g., a derivative measurement) may constitute an instantaneous measurement. In an embodiment, the status may be indicative of average fuel utilization over a time period (e.g., utilization of combustible fuel or electricity based on time-averaged data). In an embodiment, the status may be indicative of cumulative fuel utilization for a time period, such as the total utilization of combustible fuel over a number of days. In an embodiment, the status may be indicative of cumulative fuel or average fuel economy used over a traversed area; e.g., during traversal through a municipality, or through a state. In an embodiment, the status may be associated with cumulative fuel utilization for a geographic region (e.g., a geographic region identified by a GPS receiver 194), such as the total utilization of combustible fuel while driving on an interstate highway.

In an embodiment, the geographic region may include a regulatory region, such as a region designated by a government. For example, one region may be designated as a class 1 region and another region may be designated as a class 2 region. The class 1 region may be subject to different regulations than the class 2 region. For instance, the government may designate the class 1 region as a region in which only the utilization of electrical power is desirable or permissible. Alternatively, the government may designate the class 2 region as a region in which either power from combustible fuel or electrical power is permissable. Further, the designation of a region may change with time. For instance, the class 1 region may become a class 2 region at certain times of a day, a week, a month, or a year. Additionally, the boundaries of a region may change depending on a time of day, a volume of traffic, or dependent upon other conditions.

The transmitter 120 may be coupled with a determination module 196 for determining the status for the vehicle 100. In one embodiment, the determination module 196 may be instrumentation 198 included with the vehicle 100, such as power-selection instrumentation for selectively enabling one or more of the combustible fuel utilization and the electricity utilization. Alternatively, the instrumentation 198 may be instrumentation included with the vehicle 100 for monitoring the fuel consumption of the vehicle 100, such as a fuel gauge, or the like. In embodiments where the instrumentation 198 is included with the vehicle 100, the transmitter 120 may be added to the vehicle (e.g., where the transmitter 120 is included with an aftermarket part) or selectively coupled with the vehicle (e.g., where the transmitter 120 is included with one or more of the Internet, a personal communication device, a personal computer, a laptop computer, a palmtop computer, a Personal Digital Assistant (PDA), a portable media player, or a mobile telephone). In an embodiment, the transmitter 120 and the instrumentation 198 may be provided as a single unit, such as a device 200. In this configuration, the instrumentation 198 may be capable of monitoring the status of the vehicle 100 by measuring sound emitted by the vehicle, measuring emissions from the vehicle, or capturing images or movements of the vehicle 100 or its various parts, such as movement of a drive train, or the like. In a still further embodiment, the determination module 196 of the device 200 may include a receiver 202 for receiving the status of the vehicle 100, such as a receiver 202 communicatively coupled with power-selection instrumentation, a fuel gauge, or the like. In a further embodiment, the determination module 196 may be coupled with a personal computer 203 for transmitting the status (as determined by the determination module 196, for instance) to the off-site entity 144. Further, the personal computer 203 may be connected to a mobile telephone 205 for transmitting the status to the off-site entity 144. It is also contemplated that the personal computer 203 may be connected to a computer network 207 for transmitting the status to the off-site entity 144.

The transmitter 120 may transmit the status of the vehicle 100 at different times and upon different conditions. In an embodiment, the transmitter 120 may transmit the status of the vehicle 100 based upon a schedule (e.g., daily, hourly, or the like). In an embodiment, the transmitter may be coupled with a processor 204 for scheduling transmission of the status. The off-site entity 144 may include a processor 145 for calculating a time for receiving the status transmitted by the transmitter 120. In an embodiment, the transmitter 120 may transmit the status of the vehicle 100 based upon a location, such as the location of the vehicle 100 (e.g., when the vehicle crosses from one area into another, such as from a highway authority to a city authority). In an embodiment, the transmitter 120 may transmit the status of the vehicle 100 based upon a change in driving mode. For example, the status may be transmitted when the vehicle switches from electrical power to utilizing the combustible fuel. Further, the status for the vehicle 100 may be transmitted in an encrypted data format (e.g., utilizing a public-key/private-key encryption scheme or the like).

The vehicle 100 may include a receiver 206 for receiving data indicative of a standing allocated upon receipt of the transmitted status. For example, propelling the vehicle 100 with electricity (e.g., by utilizing batteries 114 included with the vehicle 100) may be rewarded by the allocation of a privilege to the vehicle 100. It should be noted that the receiver 202 may comprise the receiver 206. Alternatively, the receiver 206 may be provided separately from the receiver 202. It is contemplated that the vehicle 100 may include a selection module 208 for allowing the vehicle to selectively utilize one or more standings based upon the transmitted status. For instance, the selection module 208 may allow the vehicle to opt in or opt out of receiving standings. In an embodiment, the standing may be allocated by an off-site entity 144 who receives the transmitted status from the vehicle 100, such as a road authority, or the like. For instance, the road authority may query the vehicle 100 for its status. In an embodiment, the off-site entity 144 may broadcast a query to multiple vehicles. In an embodiment, the query may be directed to a specific or pre-designated vehicle. For instance, a vehicle may be selected for a query based upon an occupant of the vehicle.

It is contemplated that the query received from the off-site entity 144 may be transmitted based upon a schedule. Alternatively, the query received from the off-site entity 144 may be transmitted based upon a location (e.g., a location of the vehicle 100 with respect to the off-site entity 144 or to a landmark, such as a highway, a communications tower, or the like). In an embodiment, the query received from the off-site entity 144 may be transmitted based upon a change in driving mode (e.g., when the vehicle 100 switches from utilizing the second drive train 104 to utilizing the first drive train 102). Further, the query received from the off-site entity 144 may be transmitted before entering at least one of a pre-designated roadway, a region, a pre-designated bridge, a pre-designated parking lot, a pre-designated parking spot, or a queue for refueling the combustible fuel or recharging the batteries. In an alternative embodiment, the query received from the off-site entity 144 may be transmitted based upon a past behavior of the vehicle (e.g., a past utilization of the combustible fuel 110 by the vehicle 100).

In an embodiment, the standing may include permission for the vehicle 100 to utilize a pre-designated roadway 210. In an embodiment, the standing may include permission for the vehicle 100 to drive into a region 212. In an embodiment, the standing may include permission for the vehicle 100 to cross a pre-designated bridge 214. In an embodiment, the standing may include permission for the vehicle 100 to utilize a pre-designated parking lot 216. In an embodiment, the standing may include permission for the vehicle 100 to utilize a pre-designated parking spot 218. It is also contemplated that the vehicle 100 may be queried for its status to verify the vehicle's compliance with utilization restrictions, such as fuel utilization requirements for a geographical area. In an embodiment, the standing may include an advanced position in a queue for refueling the combustible fuel 110 or recharging the batteries 114. Further, the vehicle 100 may be queried for its status to determine a qualification for one or more of a tax benefit, an insurance benefit, or a reduction in fees.

It should be noted that the standing may be reduced or eliminated when the benefit of choosing one driving mode over another (e.g., choosing the second drive train 104 over the first drive train 102) may be outweighed by another behavior. For example, in an embodiment, the standing may be reduced when an alternate route for the driver or passengers of the vehicle 100 including public transportation is available. In an embodiment, the standing may be eliminated based upon a number of passengers in the vehicle 100, such as only a driver. Alternatively, the standing may be increased based upon a number of passengers in the vehicle 100. For instance, a tax benefit may be increased based upon more than one passenger in the vehicle 100.

In an embodiment, the standing allocated by the off-site entity 144 upon receipt of the status for the vehicle 100 may be accumulated with another standing (e.g., a standing allocated from another agency, such as another road authority, or the like). Further, the standing allocated by the off-site entity 144 upon receipt of the status for the vehicle 100 and one or more other standings allocated by another agency may be exchanged for a second set of standings including (at least) a third standing. For instance, a standing including permission to utilize a pre-designated roadway and a standing including permission to utilize a pre-designated parking spot may be exchanged for a standing including permission to drive within a pre-designated region.

The vehicle 100 may include a display 220 coupled with the receiver 206 for displaying information associated with the standing allocated upon receipt of the transmitted status. For example, the receiver 206 may receive a standing, such as permission to cross a pre-designated bridge 214. The standing may then be displayed by the display 220. In one embodiment, the display 220 may comprise an audio display, such as a speaker. In this embodiment, for instance, the standing may be communicated to the driver via an audible announcement, a tone, a musical selection, a simulated voice, or a series of tones. In another embodiment, the display 220 may comprise a visual display, such as a Liquid Crystal Display (LCD), one or more Light Emitting Diodes (LED's), one or more Organic LED's (OLED's), or a Cathode Ray Tube (CRT). In an embodiment, the display 220 is positioned in the vehicle, where it may be easily viewed by the driver or one or more passengers, such as on a dashboard, on a console, on a rearview mirror, or the like. Further, the display 220 may utilize text-based messages, symbols, indicia, or other identifiable visual characters, symbols, or lights to communicate one or more standings to the driver or the passengers of the vehicle 100.

It is further contemplated that the vehicle 100 or the device 200 may include a second transmitter (in an embodiment, the transmitter 120 comprises this second transmitter) for transmitting information associated with the standing allocated upon receipt of the transmitted status to an off-site entity. In an embodiment, the off-site entity 144 may be equipped with a billboard for displaying a message to the vehicle 100 regarding a standing. Alternatively, another off-site entity, such as a billboard or an electronic sign, may be provided separately from the off-site entity 144, and the transmitter 120 may communicate an assigned standing to the other off-site entity for display to the driver of the vehicle 100, or to one or more passengers. The off-site entity may comprise a visual display, as previously described, or alternatively, may comprise an audio display, such as a horn, a whistle, or a siren. Further, the off-site entity may comprise a database.

The vehicle 100 may include a memory 222 for storing data regarding the status of the vehicle 100, i.e., data indicative of one or more of combustible fuel utilization, electricity utilization, and combustible fuel utilization in comparison to electricity utilization. For instance, the memory 222 may store data regarding how long the vehicle 100 was operated in a combustible fuel utilization mode versus how long the vehicle 100 was operated in an electricity utilization mode. Further, the vehicle 100 may include a memory 222 for storing data regarding the transmission of the status of the vehicle 100, i.e., data indicative of when one or more of combustible fuel utilization information, electricity utilization information, and combustible fuel utilization in comparison to electricity utilization information was transmitted by the transmitter 120. It will be appreciated that the memory 222 may store such information in an encrypted format. Further, it will be appreciated that the transmitter 120 may transmit the status of the vehicle 100 in an encrypted format.

In addition to transmitting the status of the vehicle 100, the transmitter 120 may transmit additional information which may be of interest to a receiver of the information, such as the road authority, or the like. For instance, the transmitter 120 may transmit information including vehicle identification (e.g., a Vehicle Identification Number (190)), operator identification (e.g., a driver's license number), a time (e.g., the time of the transmission), a location (e.g., the location of the transmission), a direction (e.g., a cardinal direction such as north or south), or a speed (e.g., the speed of the vehicle 100).

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

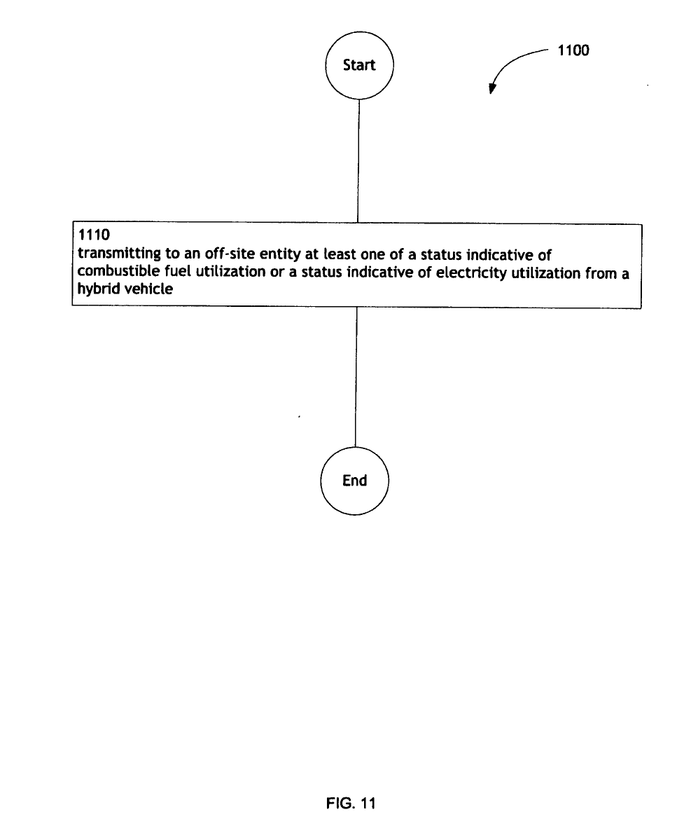

FIG. 11 illustrates an operational flow 1100 representing example operations related to transmitting to an off-site entity at least one of a status indicative of combustible fuel utilization or a status indicative of electricity utilization from a hybrid vehicle. In FIG. 11 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 1100 moves to an operation 1110. Operation 1110 depicts transmitting to an off-site entity at least one of a status indicative of combustible fuel utilization or a status indicative of electricity utilization from a hybrid vehicle. For example, as shown in FIGS. 1 through 10, the vehicle 100 may transmit (e.g., utilizing the transmitter 120) a status indicative of, for example, one or more of combustible fuel utilization and electricity utilization for the vehicle 100. In an embodiment, the off-site entity 144 may receive the status transmitted by the vehicle 100.

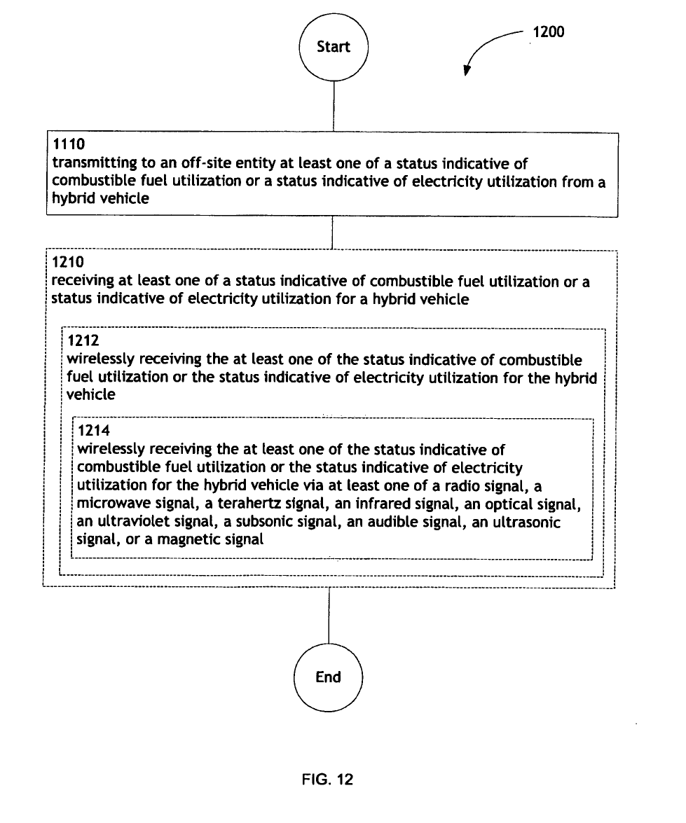

FIG. 12 illustrates an operational flow 1200 representing example operations related to transmitting to an off-site entity at least one of a status indicative of combustible fuel utilization or a status indicative of electricity utilization from a hybrid vehicle and receiving at least one of a status indicative of combustible fuel utilization or a status indicative of electricity utilization for a hybrid vehicle. FIG. 12 illustrates an example embodiment where the example operational flow 1100 of FIG. 11 may include at least one additional operation. Additional operations may include an operation 1210, an operation 1212, and/or an operation 1214.

After a start operation and an operation 1110, the operational flow 1200 moves to an operation 1210. Operation 1210 illustrates receiving at least one of a status indicative of combustible fuel utilization or a status indicative of electricity utilization for a hybrid vehicle. For example, as shown in FIGS. 1 through 10, the vehicle 100 may utilize the transmitter 120 to transmit a status indicative of, for example, one or more of combustible fuel utilization and electricity utilization for the vehicle 100. In an embodiment, the off-site entity 144 may receive the status transmitted by the vehicle 100.

The operation 1212 illustrates wirelessly receiving the at least one of the status indicative of combustible fuel utilization or the status indicative of electricity utilization for the hybrid vehicle. For example, as shown in FIGS. 1 through 10, the transmitter 120 may transmit the status for the vehicle 100 via the wireless signal 122, which may be received by off-site entity 144. Further, the operation 1214 illustrates wirelessly receiving the at least one of the status indicative of combustible fuel utilization or the status indicative of electricity utilization for the hybrid vehicle via at least one of a radio signal, a microwave signal, a terahertz signal, an infrared signal, an optical signal, an ultraviolet signal, a subsonic signal, an audible signal, an ultrasonic signal, or a magnetic signal. For example, as shown in FIGS. 1 through 10, the transmitter 120 may transmit the status for the vehicle 100 via an optical (i.e., visible to a human eye) signal, which may be received by the off-site entity 144.

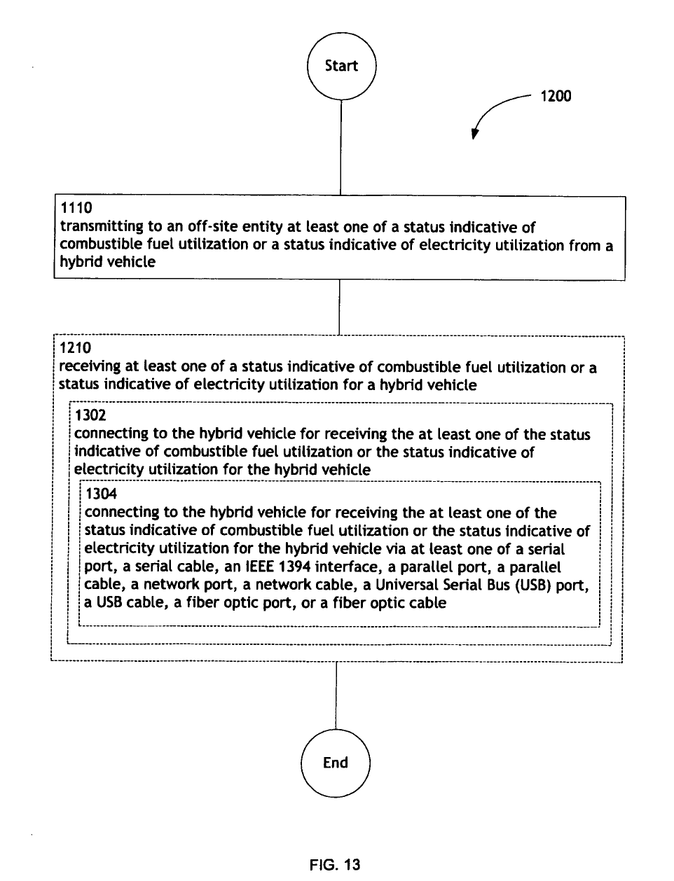

FIG. 13 illustrates alternative embodiments of the example operational flow 1200 of FIG. 12. FIG. 13 illustrates example embodiments where the operation 1210 may include at least one additional operation. Additional operations may include an operation 1302, and/or an operation 1304.

The operation 1302 illustrates connecting to the hybrid vehicle for receiving the at least one of the status indicative of combustible fuel utilization or the status indicative of electricity utilization for the hybrid vehicle. For example, as shown in FIGS. 1 through 10, the transmitter 120 can be coupled with a connector 142 for connecting to the off-site entity 144. The off-site entity 144 can then receive the status of the vehicle. Further, the operation 1304 illustrates connecting to the hybrid vehicle for receiving the at least one of the status indicative of combustible fuel utilization or the status indicative of electricity utilization for the hybrid vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable. For example, as shown in FIGS. 1 through 10, the status of the vehicle 100 may be received by the off-site entity 144 via an IEEE 1394 interface connection 149.

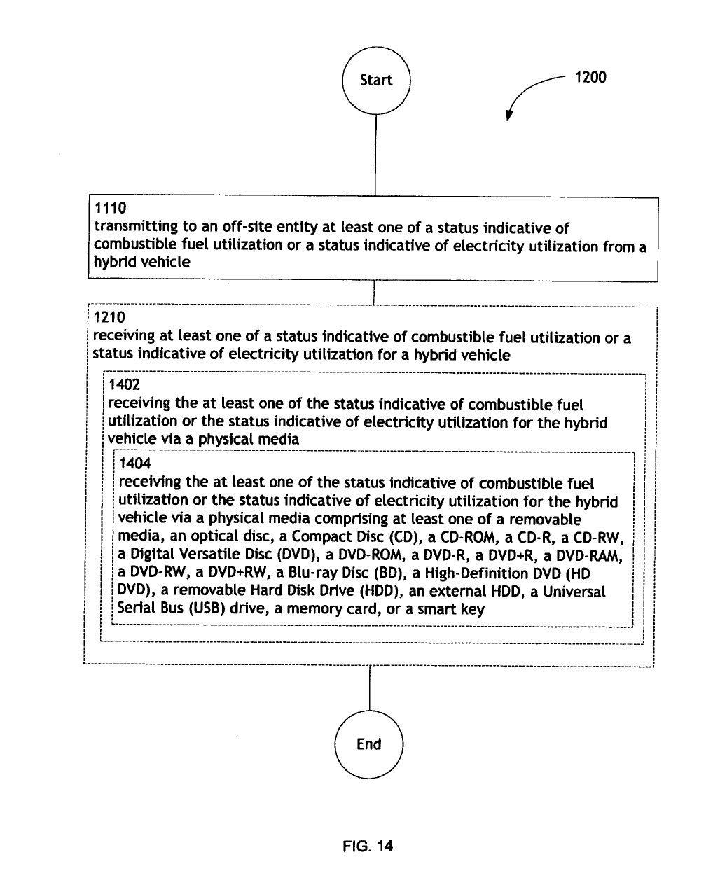

FIG. 14 illustrates alternative embodiments of the example operational flow 1200 of FIG. 12. FIG. 14 illustrates example embodiments where the operation 1210 may include at least one additional operation. Additional operations may include an operation 1402, and/or an operation 1404.

The operation 1402 illustrates receiving the at least one of the status indicative of combustible fuel utilization or the status indicative of electricity utilization for the hybrid vehicle via a physical media. For example, as shown in FIGS. 1 through 10, the transmitter 120 may also be utilized to transmit the status for the vehicle 100 via the physical media 166. In an embodiment, the physical media 166 is provided to the off-site entity 144. Further, the operation 1404 illustrates receiving the at least one of the status indicative of combustible fuel utilization or the status indicative of electricity utilization for the hybrid vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key. For example, as shown in FIGS. 1 through 10, the status of the vehicle 100 may be received by the off-site entity 144 via a removable Hard Disk Drive (HDD) 180 from the vehicle 100.

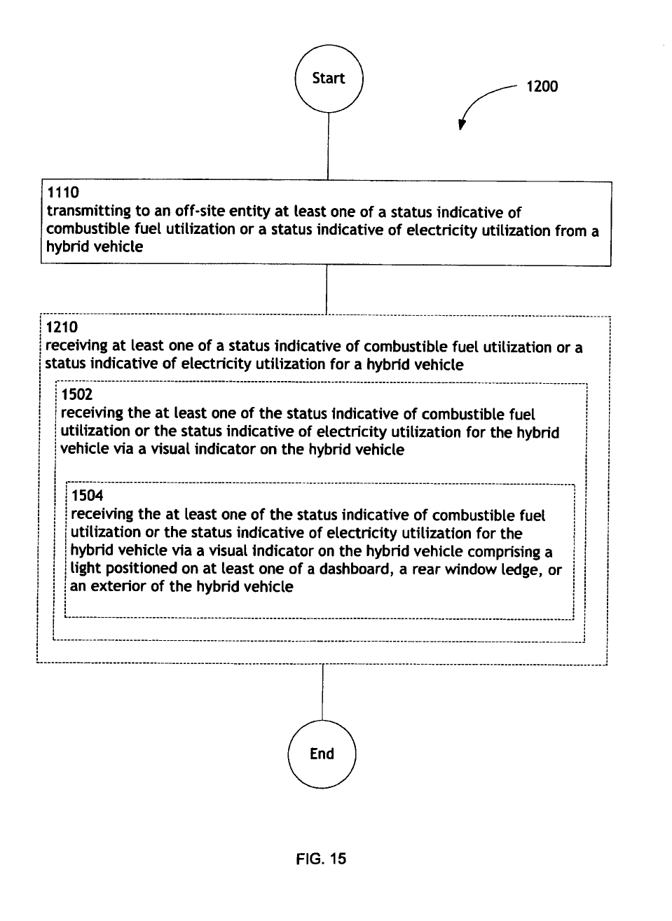

FIG. 15 illustrates alternative embodiments of the example operational flow 1200 of FIG. 12. FIG. 15 illustrates example embodiments where the operation 1210 may include at least one additional operation. Additional operations may include an operation 1502, and/or an operation 1504.

The operation 1502 illustrates receiving the at least one of the status indicative of combustible fuel utilization or the status indicative of electricity utilization for the hybrid vehicle via a visual indicator on the hybrid vehicle. For example, as shown in FIGS. 1 through 10, the status of the vehicle 100 may be transmitted to the off-site entity 144 via a visual indicator 190 positioned on the vehicle 100. Further, the operation 1504 illustrates receiving the at least one of the status indicative of combustible fuel utilization or the status indicative of electricity utilization for the hybrid vehicle via a visual indicator on the hybrid vehicle comprising a light positioned on at least one of a dashboard, a rear window ledge, or an exterior of the hybrid vehicle. For example, as shown in FIGS. 1 through 10, the status of the vehicle 100 may be received by the off-site entity 144 from a light 192 positioned on a rear window ledge of the vehicle 100.

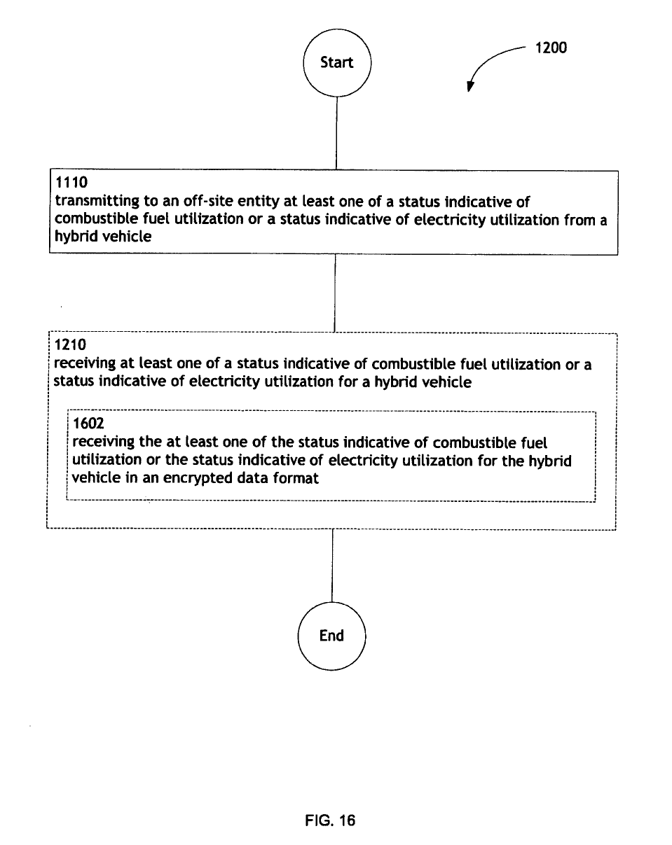

FIG. 16 illustrates alternative embodiments of the example operational flow 1200 of FIG. 12. FIG. 16 illustrates example embodiments where the operation 1210 may include at least one additional operation. Additional operations may include an operation 1602.

The operation 1602 illustrates receiving the at least one of the status indicative of combustible fuel utilization or the status indicative of electricity utilization for the hybrid vehicle in an encrypted data format. For example, as shown in FIGS. 1 through 10, the transmitter 120 may transmit the status of the vehicle 100 in an encrypted data format for receipt by the off-site entity 144. In an embodiment, the transmitter 120 may transmit the status utilizing a public-key/private-key encryption scheme. However, it is contemplated that a variety of other encryption schemes may be utilized as well.

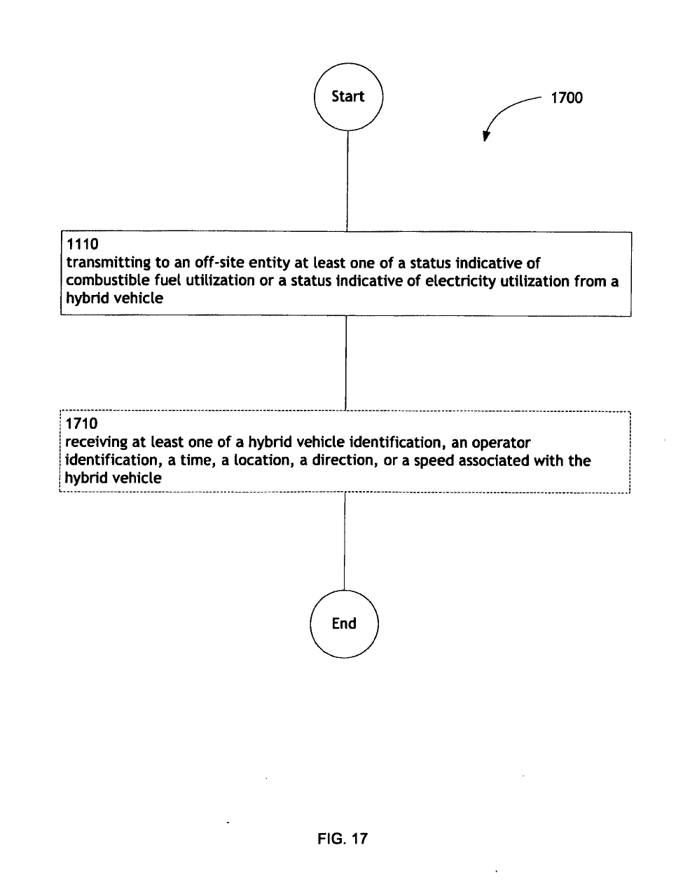

FIG. 17 illustrates an operational flow 1700 representing example operations related to transmitting to an off-site entity at least one of a status indicative of combustible fuel utilization or a status indicative of electricity utilization from a hybrid vehicle and receiving at least one of a hybrid vehicle identification, an operator identification, a time, a location, a direction, or a speed associated with the hybrid vehicle. FIG. 17 illustrates an example embodiment where the example operational flow 1100 of FIG. 11 may include at least one additional operation. Additional operations may include an operation 1710.

After a start operation and an operation 1110, the operational flow 1700 moves to an operation 1710. Operation 1710 illustrates receiving at least one of a hybrid vehicle identification, an operator identification, a time, a location, a direction, or a speed associated with the hybrid vehicle. For example, as shown in FIGS. 1 through 10, the transmitter 120 may transmit an identification for the vehicle 100 for receipt by the off-site entity 144.

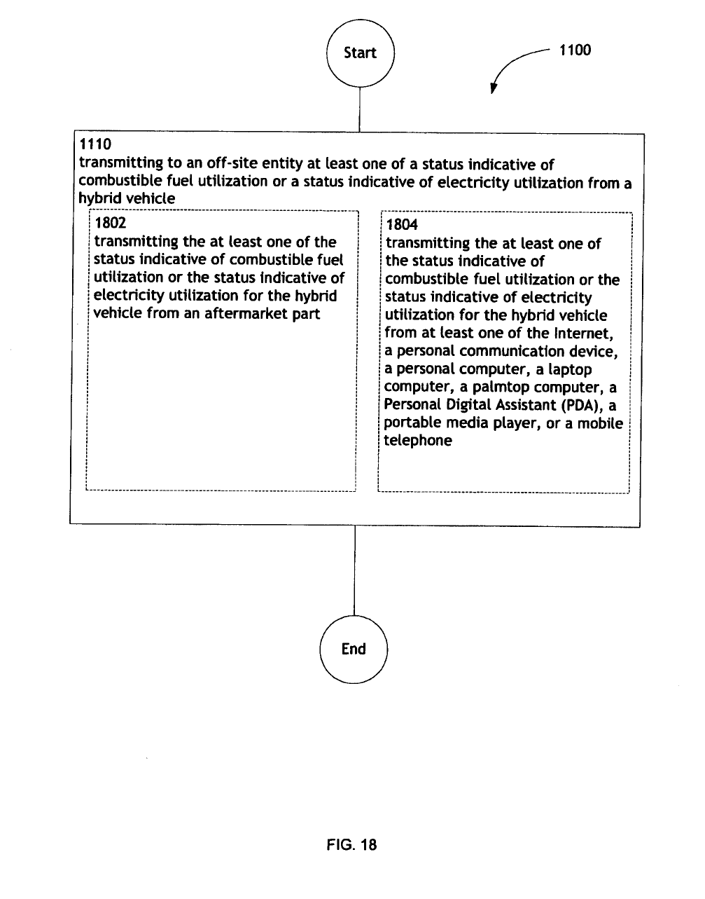

FIG. 18 illustrates alternative embodiments of the example operational flow 1100 of FIG. 11. FIG. 18 illustrates example embodiments where the operation 1110 may include at least one additional operation. Additional operations may include an operation 1802, and/or an operation 1804.

The operation 1802 illustrates transmitting the at least one of the status indicative of combustible fuel utilization or the status indicative of electricity utilization for the hybrid vehicle from an aftermarket part. For example, as shown in FIGS. 1 through 10, the status may be transmitted to the off-site entity 144 by a transmitter 120 included with an aftermarket part.

The operation 1804 illustrates transmitting the at least one of the status indicative of combustible fuel utilization or the status indicative of electricity utilization for the hybrid vehicle from at least one of the Internet, a personal communication device, a personal computer, a laptop computer, a palmtop computer, a Personal Digital Assistant (PDA), a portable media player, or a mobile telephone. For example, as shown in FIGS. 1 through 10, the status may be transmitted by a personal computer coupled with the transmitter 120. In an embodiment, the personal computer may be selectively coupled with the vehicle 100, such as via a wireless network communications link, or the like.

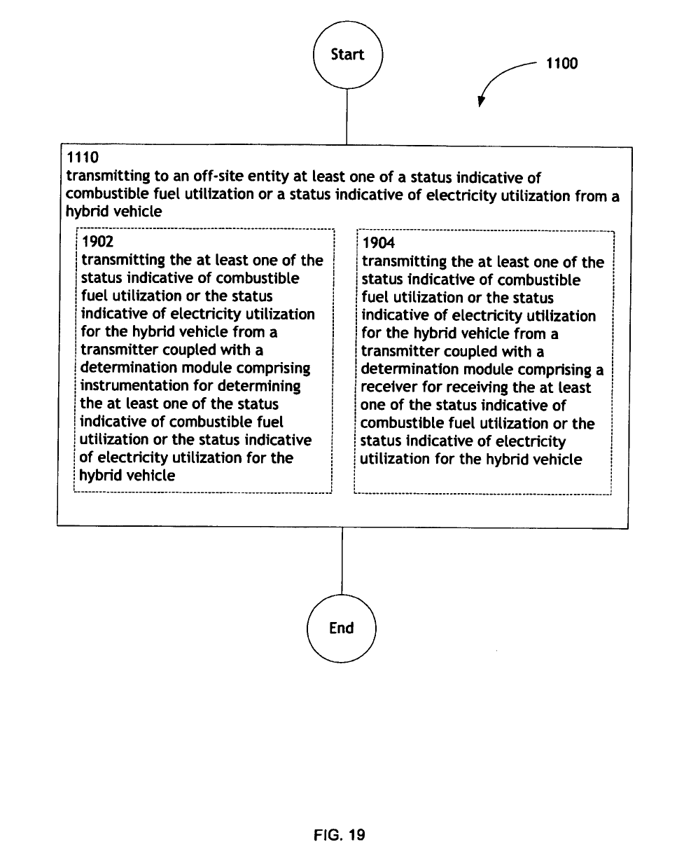

FIG. 19 illustrates alternative embodiments of the example operational flow 1100 of FIG. 11. FIG. 19 illustrates example embodiments where the operation 1110 may include at least one additional operation. Additional operations may include an operation 1902, and/or an operation 1904.

The operation 1902 illustrates transmitting the at least one of the status indicative of combustible fuel utilization or the status indicative of electricity utilization for the hybrid vehicle from a transmitter coupled with a determination module comprising instrumentation for determining the at least one of the status indicative of combustible fuel utilization or the status indicative of electricity utilization for the hybrid vehicle. For example, as shown in FIGS. 1 through 10, the transmitter 120 may be coupled with the determination module 196 for determining the status for the vehicle 100 and then transmitting the status for receipt by the off-site entity 144.

The operation 1904 illustrates transmitting the at least one of the status indicative of combustible fuel utilization or the status indicative of electricity utilization for the hybrid vehicle from a transmitter coupled with a determination module comprising a receiver for receiving the at least one of the status indicative of combustible fuel utilization or the status indicative of electricity utilization for the hybrid vehicle. For example, as shown in FIGS. 1 through 10, the transmitter 120 may be coupled with the determination module 196 in a configuration where the determination module 196 includes a receiver 202. The receiver 202 is configured to receive the status for the vehicle 100 (e.g., from power-selection instrumentation), and the transmitter 120 is configured to transmit the status for receipt by the off-site entity 144.

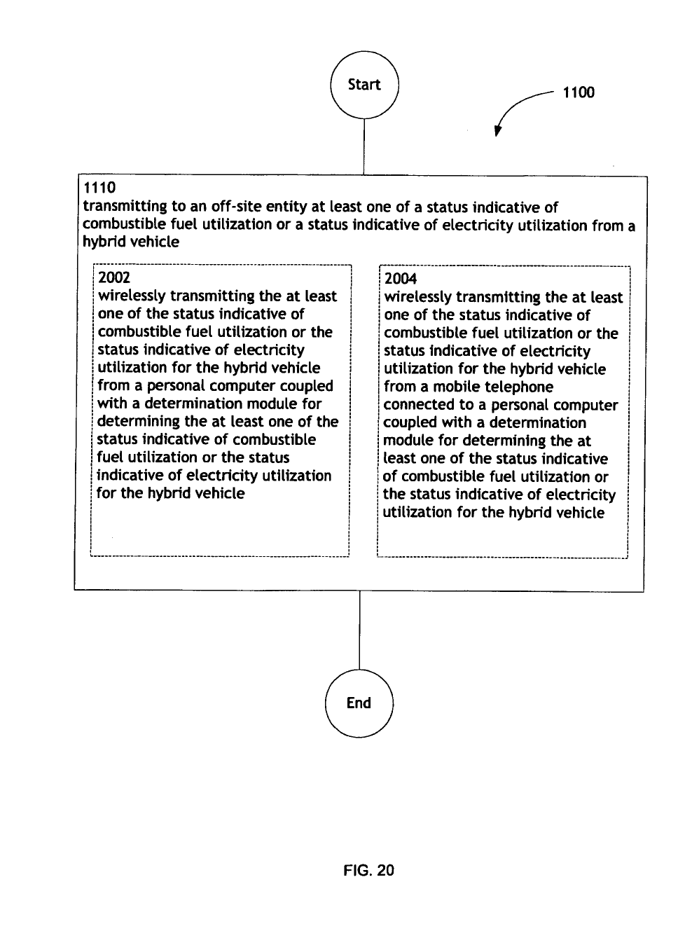

FIG. 20 illustrates alternative embodiments of the example operational flow 1100 of FIG. 11. FIG. 20 illustrates example embodiments where the operation 1110 may include at least one additional operation. Additional operations may include an operation 2002, and/or an operation 2004.

The operation 2002 illustrates wirelessly transmitting the at least one of the status indicative of combustible fuel utilization or the status indicative of electricity utilization for the hybrid vehicle from a personal computer coupled with a determination module for determining the at least one of the status indicative of combustible fuel utilization or the status indicative of electricity utilization for the hybrid vehicle. For example, as shown in FIGS. 1 through 10, the status for the vehicle may be wirelessly transmitted to the off-site entity 144 by a personal computer 203 coupled with the determination module 196.

The operation 2004 illustrates wirelessly transmitting the at least one of the status indicative of combustible fuel utilization or the status indicative of electricity utilization for the hybrid vehicle from a mobile telephone connected to a personal computer coupled with a determination module for determining the at least one of the status indicative of combustible fuel utilization or the status indicative of electricity utilization for the hybrid vehicle. For example, as shown in FIGS. 1 through 10, the status for the vehicle may be wirelessly transmitted to the off-site entity 144 by a mobile telephone 205 connected to the personal computer 203, where the personal computer 203 is coupled with the determination module 196. In an embodiment, the mobile telephone 205 may be connected to the personal computer via a USB link, a network link (e.g., via a network cable), an IEEEE 1394 interface, a Bluetooth link, or via another connection scheme as desired.

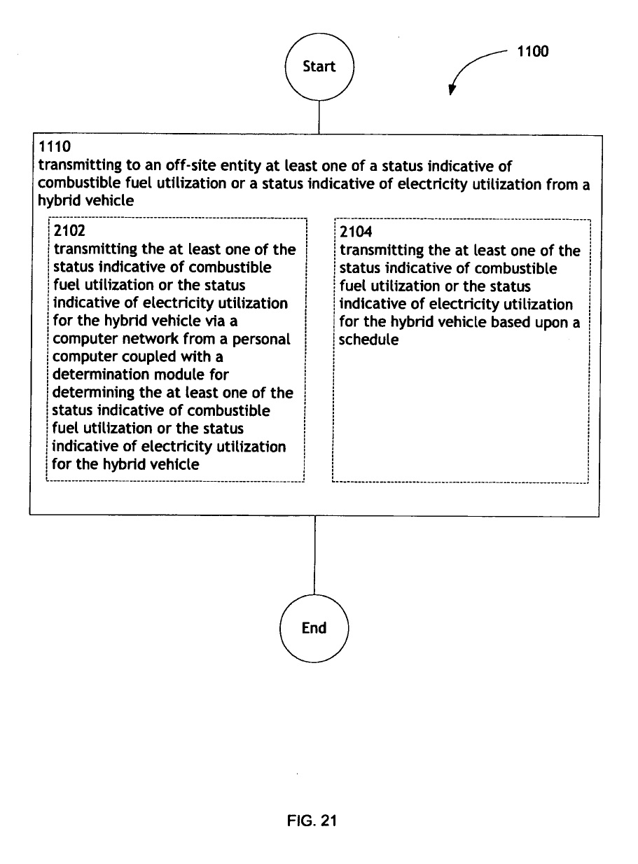

FIG. 21 illustrates alternative embodiments of the example operational flow 1100 of FIG. 11. FIG. 21 illustrates example embodiments where the operation 1110 may include at least one additional operation. Additional operations may include an operation 2102, and/or an operation 2104.

The operation 2102 illustrates transmitting the at least one of the status indicative of combustible fuel utilization or the status indicative of electricity utilization for the hybrid vehicle via a computer network from a personal computer coupled with a determination module for determining the at least one of the status indicative of combustible fuel utilization or the status indicative of electricity utilization for the hybrid vehicle. For example, as shown in FIGS. 1 through 10, the status for the vehicle may be transmitted to the off-site entity 144 by the personal computer 203 coupled with the determination module 196, where the personal computer 203 transmits the status via a computer network 207, (e.g., the Internet).

The operation 2104 illustrates transmitting the at least one of the status indicative of combustible fuel utilization or the status indicative of electricity utilization for the hybrid vehicle based upon a schedule. For example, as shown in FIGS. 1 through 10, the status for the vehicle 100 may be transmitted by the transmitter 120 for receipt by the off-site entity 144 based upon a daily schedule.

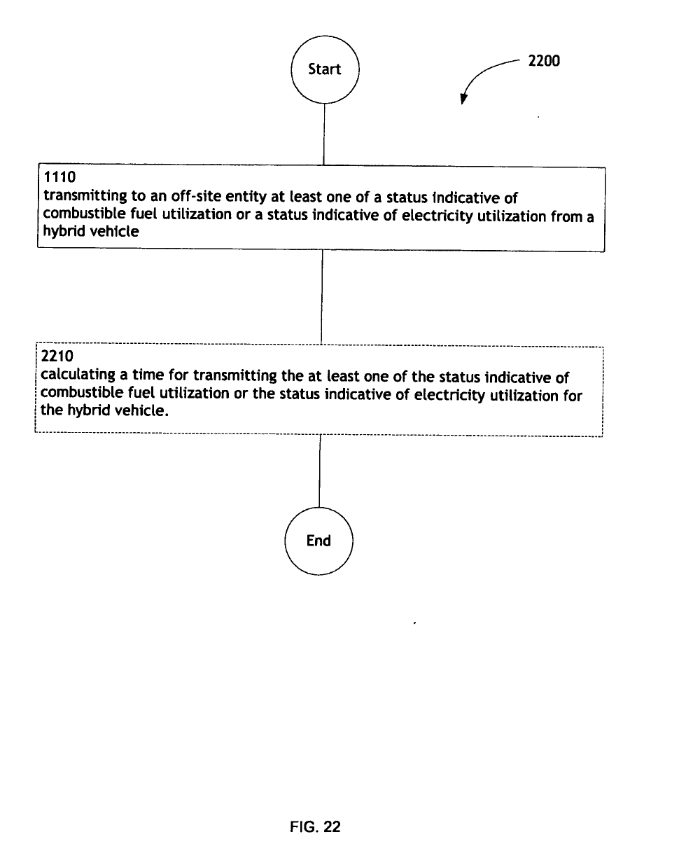

FIG. 22 illustrates an operational flow 2200 representing example operations related to transmitting to an off-site entity at least one of a status indicative of combustible fuel utilization or a status indicative of electricity utilization from a hybrid vehicle and calculating a time for transmitting the status. FIG. 22 illustrates an example embodiment where the example operational flow 1100 of FIG. 11 may include at least one additional operation. Additional operations may include an operation 2210.

After a start operation and an operation 1110, the operational flow 2200 moves to an operation 2210. Operation 2210 illustrates calculating a time for transmitting the at least one of the status indicative of combustible fuel utilization or the status indicative of electricity utilization for the hybrid vehicle. For example, as shown in FIGS. 1 through 10, the transmitter 120 may utilize a processor 104 for scheduling a time to transmit the status of the vehicle 100. Further, the off-site entity may include a processor 145 for calculating a time to receive the status transmitted by the transmitter 120.

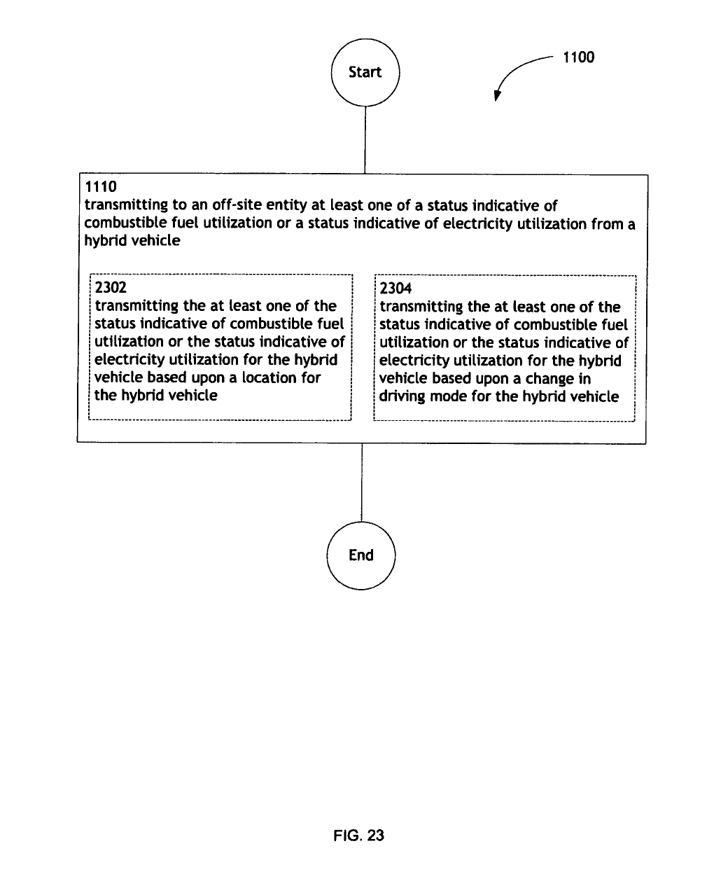

FIG. 23 illustrates alternative embodiments of the example operational flow 1100 of FIG. 11. FIG. 23 illustrates example embodiments where the operation 1110 may include at least one additional operation. Additional operations may include an operation 2302, and/or an operation 2304.

The operation 2302 illustrates transmitting the at least one of the status indicative of combustible fuel utilization or the status indicative of electricity utilization for the hybrid vehicle based upon a location for the hybrid vehicle. For example, as shown in FIGS. 1 through 10, the transmitter 120 may transmit the status of the vehicle 100 based upon a location, such as when the vehicle 100 crosses from one region into another. Alternatively, the status may be transmitted based on the proximity of the vehicle 100 to the off-site entity 144. The off-site entity 144 may then receive the status based upon the location for the vehicle 100.

The operation 2304 illustrates transmitting the at least one of the status indicative of combustible fuel utilization or the status indicative of electricity utilization for the hybrid vehicle based upon a change in driving mode for the hybrid vehicle. For example, as shown in FIGS. 1 through 10, the transmitter 120 may transmit the status of the vehicle 100 based upon a change in driving mode, such as when the vehicle 100 switches from one fuel source to another. The off-site entity 144 may then receive the status based upon the change in driving mode.

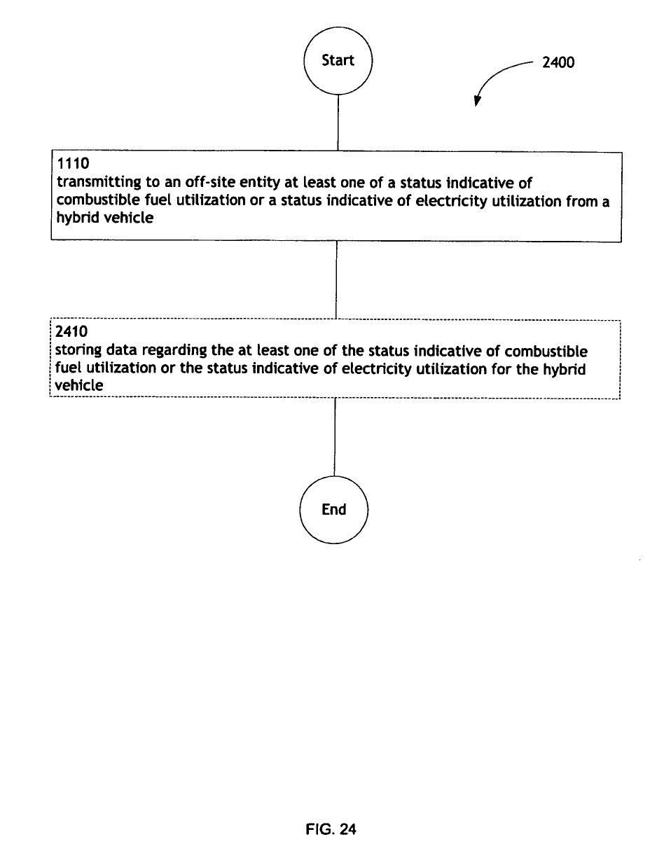

FIG. 24 illustrates an operational flow 2400 representing example operations related to transmitting to an off-site entity at least one of a status indicative of combustible fuel utilization or a status indicative of electricity utilization from a hybrid vehicle and storing data regarding the status. FIG. 24 illustrates an example embodiment where the example operational flow 1100 of FIG. 11 may include at least one additional operation. Additional operations may include an operation 2410.

After a start operation and an operation 1110, the operational flow 2400 moves to an operation 2410. Operation 2410 illustrates storing data regarding the at least one of the status indicative of combustible fuel utilization or the status indicative of electricity utilization for the hybrid vehicle. For example, as shown in FIGS. 1 through 10, the off-site entity 144 may store data regarding the status for the vehicle 100. In one embodiment, the off-site entity 144 may store the status associated with the vehicle 100 in storage 155. Further, the off-site entity 144 may store the data in storage 155 in an encrypted format (e.g., utilizing a public-key/private-key encryption scheme or the like).

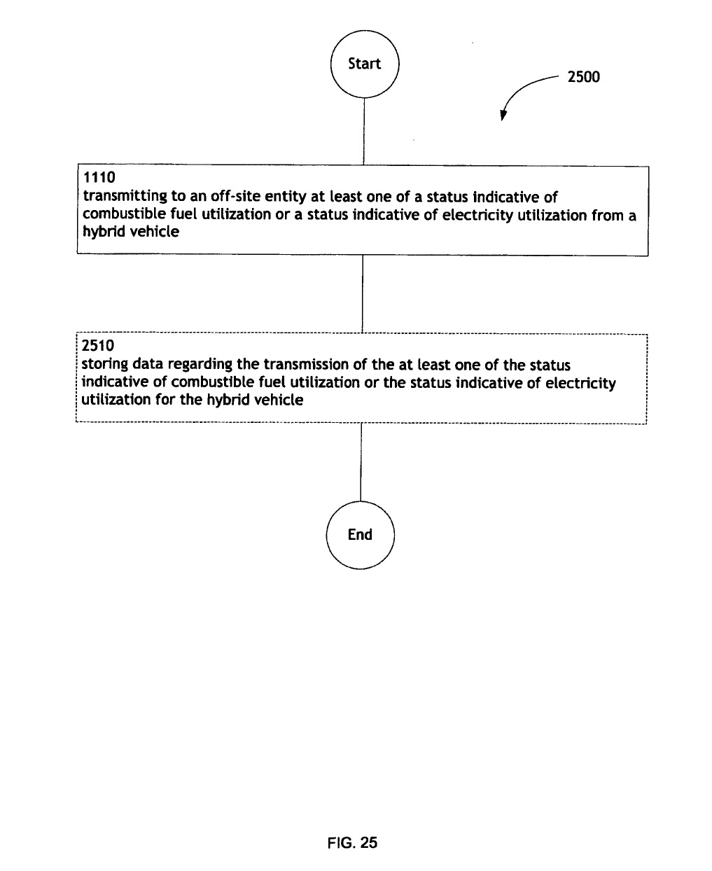

FIG. 25 illustrates an operational flow 2500 representing example operations related to transmitting to an off-site entity at least one of a status indicative of combustible fuel utilization or a status indicative of electricity utilization from a hybrid vehicle and storing data regarding the transmission of the status. FIG. 25 illustrates an example embodiment where the example operational flow 1100 of FIG. 11 may include at least one additional operation. Additional operations may include an operation 2510.

After a start operation and an operation 1110, the operational flow 2500 moves to an operation 2510. Operation 2510 illustrates storing data regarding the transmission of the at least one of the status indicative of combustible fuel utilization or the status indicative of electricity utilization for the hybrid vehicle. For example, as shown in FIGS. 1 through 10, the off-site entity 144 may store data regarding the transmission of the status for the vehicle 100. In one embodiment, the off-site entity 144 may store the data associated with the status in storage 155, as previously described. Further, the off-site entity 144 may store the data in storage 155 in an encrypted format (e.g., utilizing a public-key/private-key encryption scheme or the like).

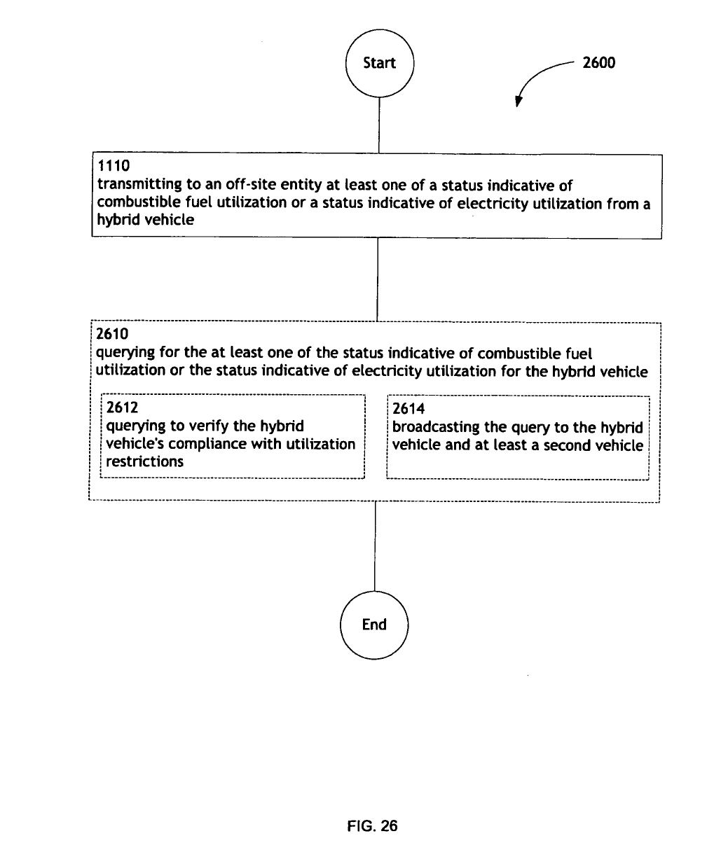

FIG. 26 illustrates an operational flow 2600 representing example operations related to transmitting to an off-site entity at least one of a status indicative of combustible fuel utilization or a status indicative of electricity utilization from a hybrid vehicle and querying for the status. FIG. 26 illustrates an example embodiment where the example operational flow 1100 of FIG. 11 may include at least one additional operation. Additional operations may include an operation 2610, an operation 2612, and/or an operation 2614.

After a start operation and an operation 1110, the operational flow 2600 moves to an operation 2610. Operation 2610 illustrates querying for the at least one of the status indicative of combustible fuel utilization or the status indicative of electricity utilization for the hybrid vehicle. For example, as shown in FIGS. 1 through 10, the road authority may query the vehicle 100 for its status.

The operation 2612 illustrates querying to verify the hybrid vehicle's compliance with utilization restrictions. For example, as shown in FIGS. 1 through 10, the off-site entity 144 may query the vehicle 100 for its status to verify the vehicle's compliance with fuel utilization requirements for geographical region.

The operation 2614 illustrates broadcasting the query to the hybrid vehicle and at least a second vehicle. For example, as shown in FIGS. 1 through 10, the off-site entity 144 may broadcast the query to multiple vehicles.

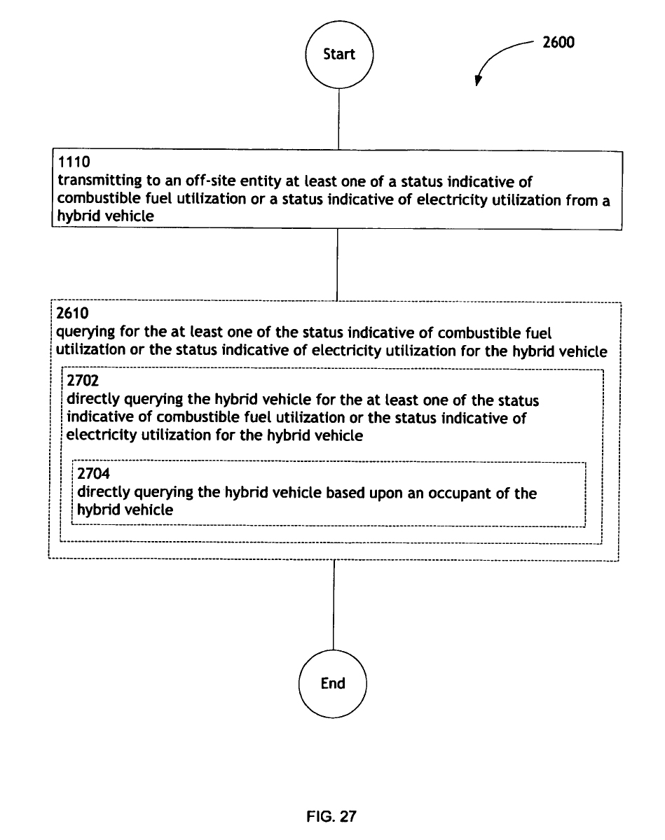

FIG. 27 illustrates alternative embodiments of the example operational flow 2600 of FIG. 26. FIG. 27 illustrates example embodiments where the operation 2610 may include at least one additional operation. Additional operations may include an operation 2702, and/or an operation 2704.

The operation 2702 illustrates directly querying the hybrid vehicle for the at least one of the status indicative of combustible fuel utilization or the status indicative of electricity utilization for the hybrid vehicle. For example, as shown in FIGS. 1 through 10, the off-site entity 144 may transmit the query directly to the vehicle 100, such as utilizing a line-of-sight transmission (e.g., a laser beam) or the like. Further, the operation 2704 illustrates directly querying the hybrid vehicle based upon an occupant of the hybrid vehicle. For example, as shown in FIGS. 1 through 10, the off-site entity 144 may transmit the query directly (e.g., utilizing a line-of-sight transmission) to the vehicle 100 based upon an identified occupant of the vehicle. The occupant may be identified utilizing an image capture device (e.g., a digital camera) and facial recognition software configured to execute on the processor 145, for instance. In an embodiment, the occupant may be identified based on a characteristic of the occupant, such as a facial characteristic, a demographic, a gender, an age, or a race. For example, an image capture device may capture an image of the occupant and a processor may utilize an algorithm to examine one or more facial characteristics for the occupant. In an embodiment, facial characteristics may be utilized to calculate an actual or approximate age for the occupant. Facial characteristics may include the size or placement of facial features, wrinkles, or an amount of hair.

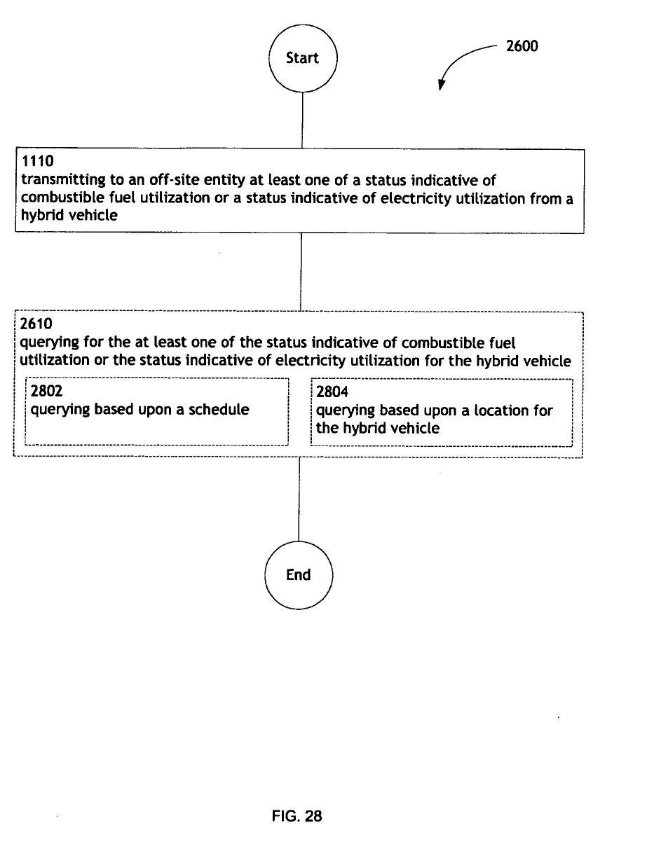

FIG. 28 illustrates alternative embodiments of the example operational flow 2600 of FIG. 26. FIG. 28 illustrates example embodiments where the operation 2610 may include at least one additional operation. Additional operations may include an operation 2802, and/or an operation 2804.

The operation 2802 illustrates querying based upon a schedule. For example, as shown in FIGS. 1 through 10, the off-site entity 144 may transmit a query to the vehicle 100 based upon a schedule. The processor 145 may be utilized to calculate the schedule.

The operation 2804 illustrates querying based upon a location for the hybrid vehicle. For example, as shown in FIGS. 1 through 10, the off-site entity 144 may transmit a query to the vehicle 100 based upon a location for the vehicle 100. The location may be determined by a locator module 147, which may include vehicle location hardware or software, connections to one or more traffic cameras, or access to satellite tracking information, among other techniques for tracking the vehicle 100.

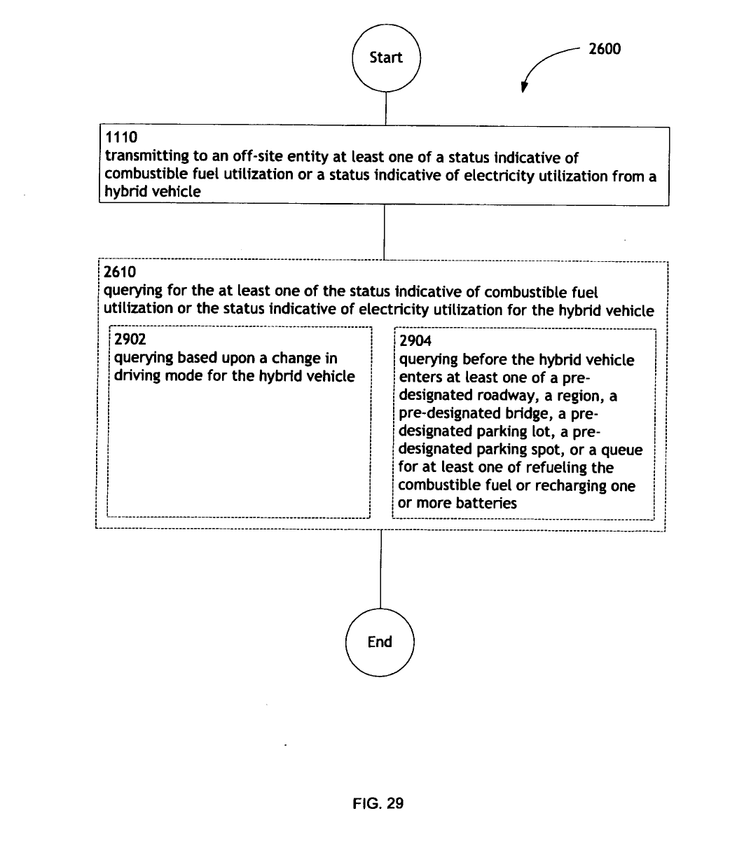

FIG. 29 illustrates alternative embodiments of the example operational flow 2600 of FIG. 26. FIG. 29 illustrates example embodiments where the operation 2610 may include at least one additional operation. Additional operations may include an operation 2902, and/or an operation 2904.

The operation 2902 illustrates querying based upon a change in driving mode for the hybrid vehicle. For example, as shown in FIGS. 1 through 10, the off-site entity 144 may transmit a query to the vehicle based upon a change in driving mode, such as a switch from utilizing the second drive train 104 to utilizing the first drive train 102.

The operation 2904 illustrates querying before the hybrid vehicle enters at least one of a pre-designated roadway, a region, a pre-designated bridge, a pre-designated parking lot, a pre-designated parking spot, or a queue for at least one of refueling the combustible fuel or recharging one or more batteries. For example, as shown in FIGS. 1 through 10, the off-site entity 144 may transmit a query to the vehicle before the vehicle enters a pre-designated roadway (e.g., as determined by the locator module 147).

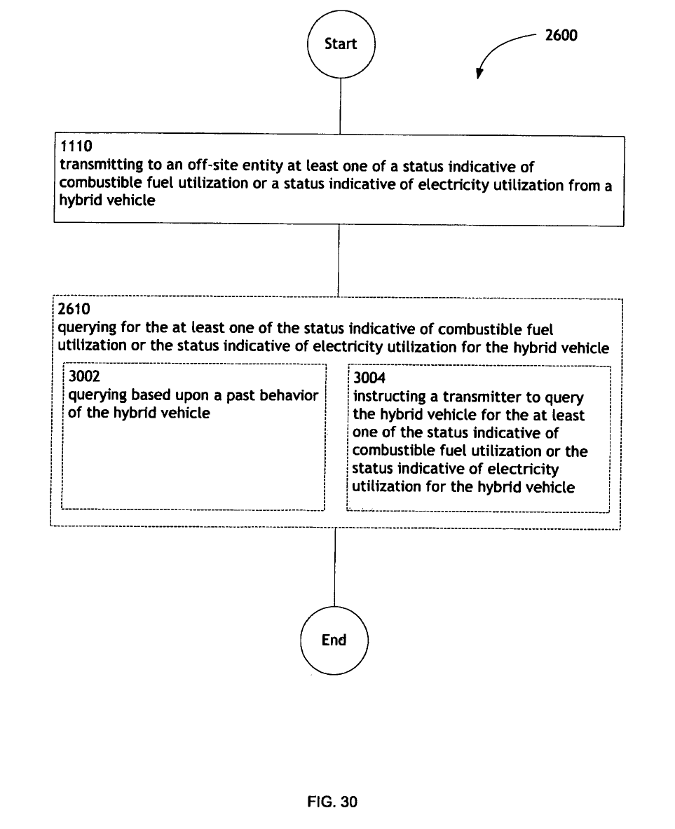

FIG. 30 illustrates alternative embodiments of the example operational flow 2600 of FIG. 26. FIG. 30 illustrates example embodiments where the operation 2610 may include at least one additional operation. Additional operations may include an operation 3002, and/or an operation 3004.

The operation 3002 illustrates querying based upon a past behavior of the hybrid vehicle. For example, as shown in FIGS. 1 through 10, the off-site entity 144 may transmit a query to the vehicle based upon a past behavior of the vehicle, such as a past utilization of combustible fuel by the vehicle 100.

The operation 3004 illustrates instructing a transmitter to query the hybrid vehicle for the at least one of the status indicative of combustible fuel utilization or the status indicative of electricity utilization for the hybrid vehicle. For example, as shown in FIGS. 1 through 10, the off-site entity 144 may instruct another entity, such as a transmitter 151, to query the vehicle 100 for its status.

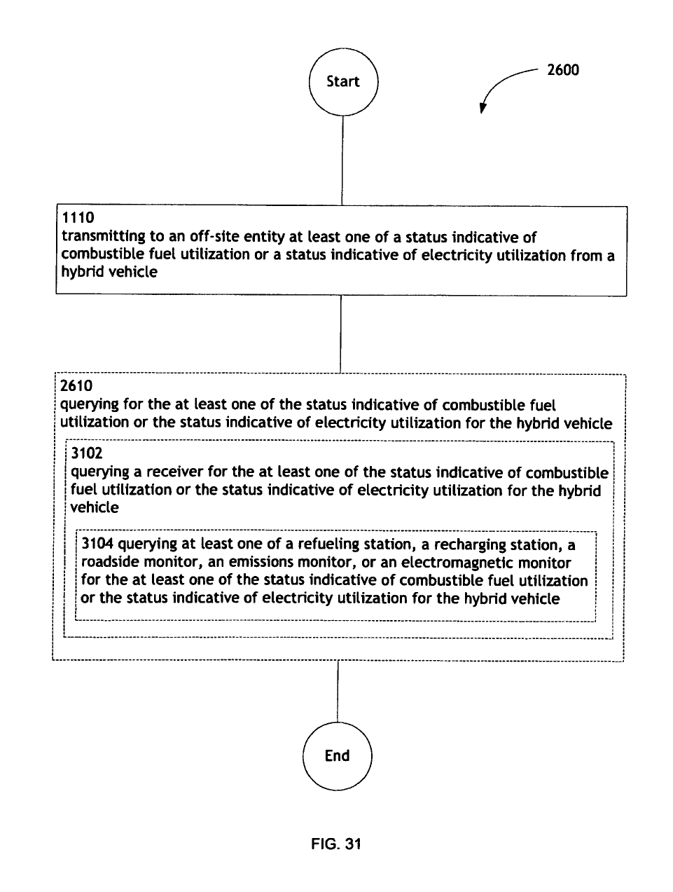

FIG. 31 illustrates alternative embodiments of the example operational flow 2600 of FIG. 26. FIG. 31 illustrates example embodiments where the operation 2610 may include at least one additional operation. Additional operations may include an operation 3102, and/or an operation 3104.

The operation 3102 illustrates querying a receiver for the at least one of the status indicative of combustible fuel utilization or the status indicative of electricity utilization for the hybrid vehicle. For example, as shown in FIGS. 1 through 10, the status of the vehicle may be received by another entity, (i.e., an entity other than the off-site entity 144), such as a receiver 153. In an embodiment, the off-site entity 144 may query the receiver 153 for the status, which may be transmitted to the off-site entity 144 (e.g., via transmitter 151). Further, the operation 3104 illustrates querying at least one of a refueling station, a recharging station, a roadside monitor, an emissions monitor, or an electromagnetic monitor for the at least one of the status indicative of combustible fuel utilization or the status indicative of electricity utilization for the hybrid vehicle. For example, as shown in FIGS. 1 through 10, the receiver 153 may comprise a refueling station (e.g., for refueling the vehicle 100 with combustible fuel) or a recharging station (e.g., for recharging one or more batteries included with the vehicle 100). The vehicle 100 may provide the refueling station with its status (e.g., via the connector 142, the physical media 166, or the like). The refueling station is queried by the off-site entity 144 and transmits the status obtained from the vehicle 100 to the off-site entity 144 (e.g., via the transmitter 151). Alternatively, the receiver 153 may be a monitor positioned proximal to a roadway, such as a roadside monitor, or the like. The roadside monitor may utilize a microphone, or a like device, to determine a noise output for the vehicle 100 as it drives along the roadway. The noise output of the vehicle 100 may be utilized to determine a status for the vehicle 100. The transmitter 151 may be utilized to transmit the status for the vehicle 100 to the off-site entity 144. In an embodiment, the receiver 153 may include an emissions monitor for determining a status for the vehicle 100 based upon a combustion-product (or byproduct) emission, which may be created as the vehicle 100 expends combustible fuel for propulsion. In another embodiment, the receiver 153 may include an electromagnetic monitor for determining a status for the vehicle 100 based upon an electromagnetic emission, such as an electromagnetic field created by a motor for propelling the vehicle 100 when utilizing one or more batteries. It will be appreciated that other monitors may be positioned proximal to a path of the vehicle 100 for determining the status of the vehicle 100.

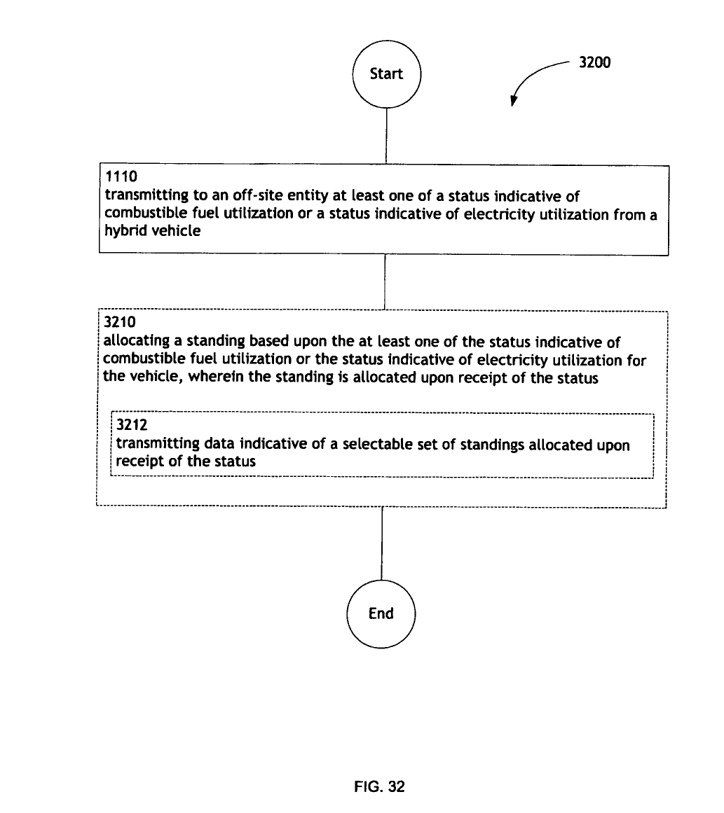

FIG. 32 illustrates an operational flow 3200 representing example operations related to transmitting to an off-site entity at least one of a status indicative of combustible fuel utilization or a status indicative of electricity utilization from a hybrid vehicle and allocating a standing based upon the at least one of the status indicative of combustible fuel utilization or the status indicative of electricity utilization for the vehicle, wherein the standing is allocated upon receipt of the status. FIG. 32 illustrates an example embodiment where the example operational flow 1100 of FIG. 11 may include at least one additional operation. Additional operations may include an operation 3210, and/or an operation 3212.

After a start operation and an operation 1110, the operational flow 3200 moves to an operation 3210. Operation 3210 illustrates allocating a standing based upon the at least one of the status indicative of combustible fuel utilization or the status indicative of electricity utilization for the vehicle, wherein the standing is allocated upon receipt of the status. For example, as shown in FIGS. 1 through 10, the standing may be allocated by the off-site entity 144 upon receipt of the status of the vehicle 100. In an embodiment, the off-site entity 144 may include a road authority, or the like.

The operation 3212 illustrates transmitting data indicative of a selectable set of standings allocated upon receipt of the status. For example, as shown in FIGS. 1 through 10, the off-site entity 144 may allocate more than one standing (e.g., a selectable set of standings) to the vehicle 100. For example, in an embodiment, the driver of the vehicle 100 may be presented with a selection of standings from which to choose. After choosing one or more of the standings, the unselected standings may be saved, transferred, eliminated, or even exchanged for another set of one or more standings.

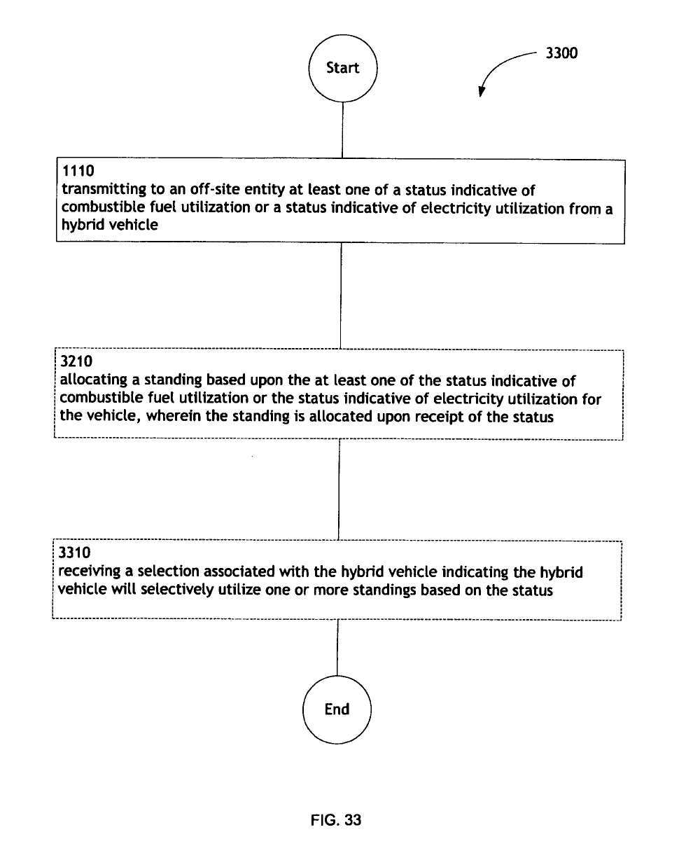

FIG. 33 illustrates an operational flow 3300 representing example operations related to transmitting to an off-site entity at least one of a status indicative of combustible fuel utilization or a status indicative of electricity utilization from a hybrid vehicle, allocating a standing based upon the status for the vehicle, and receiving a selection associated with the hybrid vehicle. FIG. 33 illustrates an example embodiment where the example operational flow 1100 of FIG. 11 may include at least one additional operation. Additional operations may include an operation 3310.

After a start operation, an operation 1110, and an operation 3210, the operational flow 3300 moves to an operation 3310. Operation 3310 illustrates receiving a selection associated with the hybrid vehicle indicating the hybrid vehicle will selectively utilize one or more standings based on the status. For example, as shown in FIGS. 1 through 10, the operator of the vehicle 100 may utilize the selection module 208 to selectively utilize one or more standings. The selection of the one or more standings may be transmitted to the off-site entity 144 via the transmitter 120.

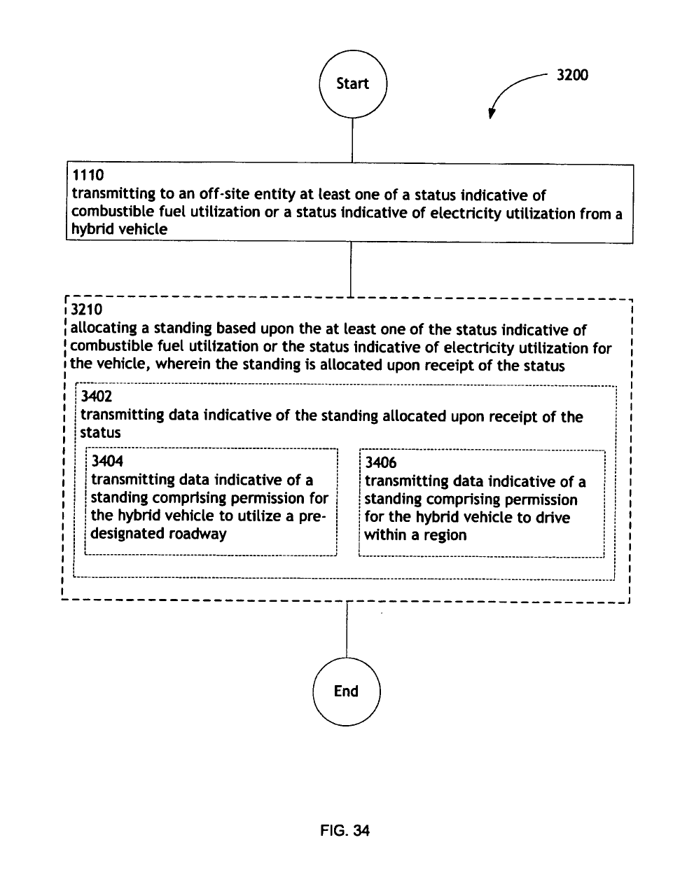

FIG. 34 illustrates alternative embodiments of the example operational flow 3200 of FIG. 32. FIG. 34 illustrates example embodiments where the operation 3210 may include at least one additional operation. Additional operations may include an operation 3402, an operation 3404, and/or an operation 3406.

The operation 3402 illustrates transmitting data indicative of the standing allocated upon receipt of the status. For example, as shown in FIGS. 1 through 10, the off-site entity 144 may transmit data indicative of the standing of the vehicle 100 upon receipt of the vehicle's status. For example, propelling the vehicle 100 with electricity (e.g., by utilizing batteries 114) may be rewarded by the allocation of a privilege to the vehicle 100. In an embodiment, data indicative of the standing of the vehicle may include a message, a set of characters, a code, a numerical designation, or a variety of other information which may be meaningfully interpreted by the driver or an occupant of the vehicle 100, or by the display 220 (or associated hardware or software) for presentation to the driver or an occupant. Further, the operation 3404 illustrates transmitting data indicative of a standing comprising permission for the hybrid vehicle to utilize a pre-designated roadway. For example, as shown in FIGS. 1 through 10, the standing may comprise a privilege such as permission for the vehicle 100 to utilize the pre-designated roadway 210. Further, the operation 3406 illustrates transmitting data indicative of a standing comprising permission for the hybrid vehicle to drive within a region. For example, as shown in FIGS. 1 through 10, the standing may comprise a privilege such as permission for the vehicle 100 to drive within the region 212.

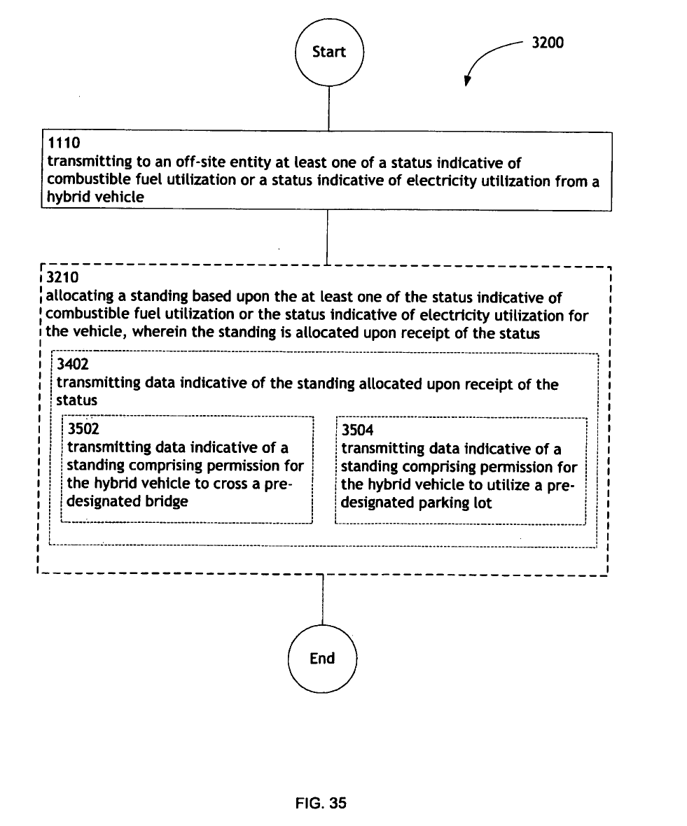

FIG. 35 illustrates alternative embodiments of the example operational flow 3200 of FIG. 32. FIG. 35 illustrates example embodiments where the operation 3210 may include at least one additional operation. Additional operations may include an operation 3502, and/or an operation 3504. Further, the operation 3502 illustrates transmitting data indicative of a standing comprising permission for the hybrid vehicle to cross a pre-designated bridge. For example, as shown in FIGS. 1 through 10, the standing may comprise a privilege such as permission for the vehicle 100 to cross the pre-designated bridge 214. Further, the operation 3504 illustrates transmitting data indicative of a standing comprising permission for the hybrid vehicle to utilize a pre-designated parking lot. For example, as shown in FIGS. 1 through 10, the standing may comprise a privilege such as permission for the vehicle 100 to utilize the pre-designated parking lot 216.

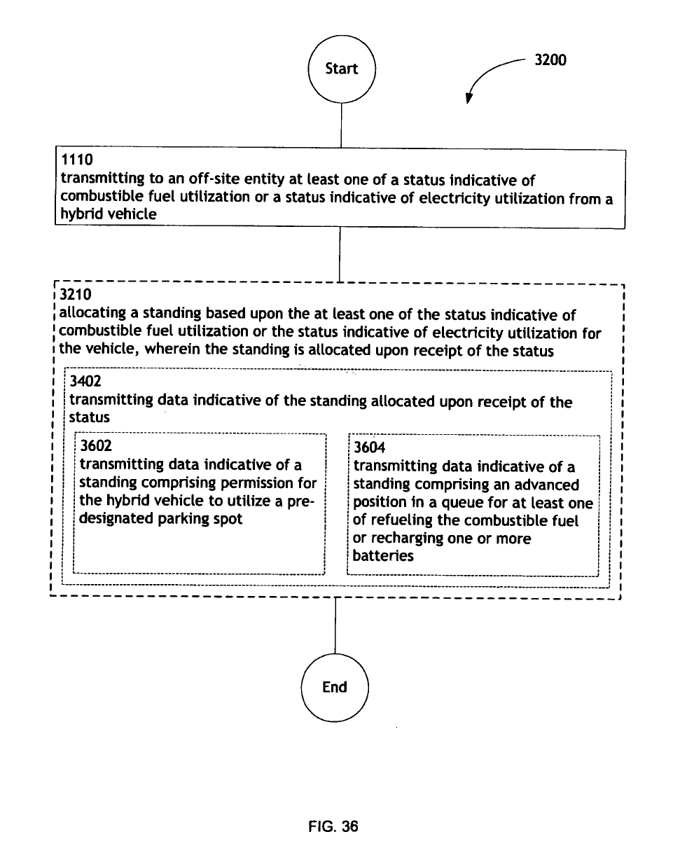

FIG. 36 illustrates alternative embodiments of the example operational flow 3200 of FIG. 32. FIG. 36 illustrates example embodiments where the operation 3210 may include at least one additional operation. Additional operations may include an operation 3602, and/or an operation 3604. Further, the operation 3602 illustrates transmitting data indicative of a standing comprising permission for the hybrid vehicle to utilize a pre-designated parking spot. For example, as shown in FIGS. 1 through 10, the standing may comprise a privilege such as permission for the vehicle 100 to utilize the pre-designated parking spot 218. Further, the operation 3604 illustrates transmitting data indicative of a standing comprising an advanced position in a queue for at least one of refueling the combustible fuel or recharging one or more batteries. For example, as shown in FIGS. 1 through 10, the standing may comprise a privilege such as an advanced position in a queue for the vehicle 100 to recharge one or more batteries.

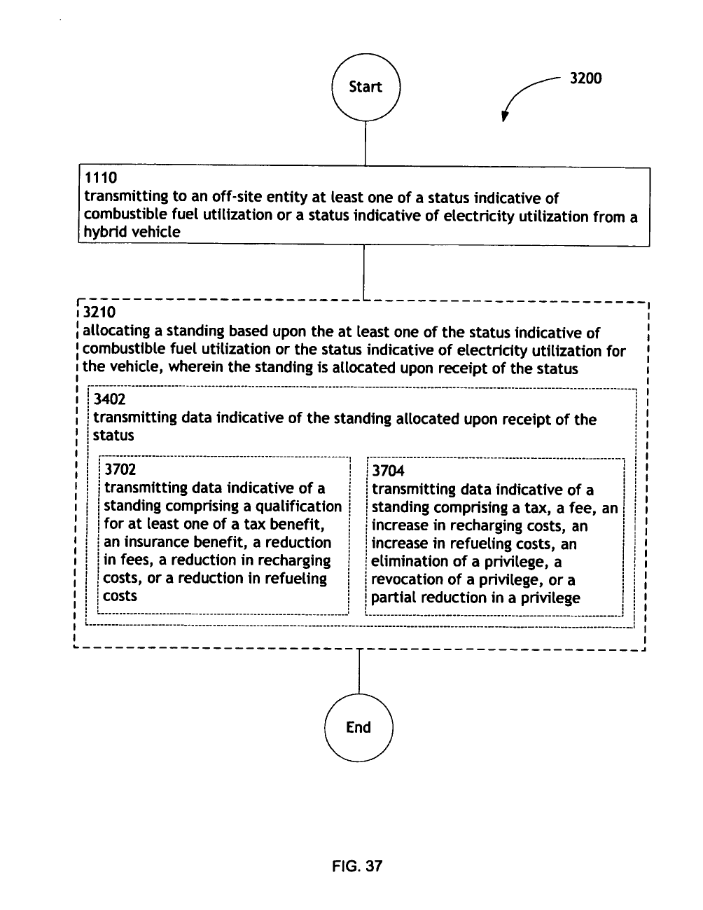

FIG. 37 illustrates alternative embodiments of the example operational flow 3200 of FIG. 32. FIG. 37 illustrates example embodiments where the operation 3210 may include at least one additional operation. Additional operations may include an operation 3702, and/or an operation 3704. Further, the operation 3702 illustrates transmitting data indicative of a standing comprising a qualification for at least one of a tax benefit, an insurance benefit, a reduction in fees, a reduction in recharging costs, or a reduction in refueling costs. For example, as shown in FIGS. 1 through 10, the standing may comprise a privilege such as a qualification for the driver of the vehicle 100 to receive a reduction in fueling costs. Further, the operation 3704 illustrates transmitting data indicative of a standing comprising a tax, a fee, an increase in recharging costs, an increase in refueling costs, an elimination of a privilege, a revocation of a privilege, or a partial reduction in a privilege. For example, as shown in FIGS. 1 through 10, the standing may comprise a penalty, such as the elimination of a privilege. For example, in an embodiment, the elimination of a privilege may include not being able to utilize the pre-designated parking lot 216.

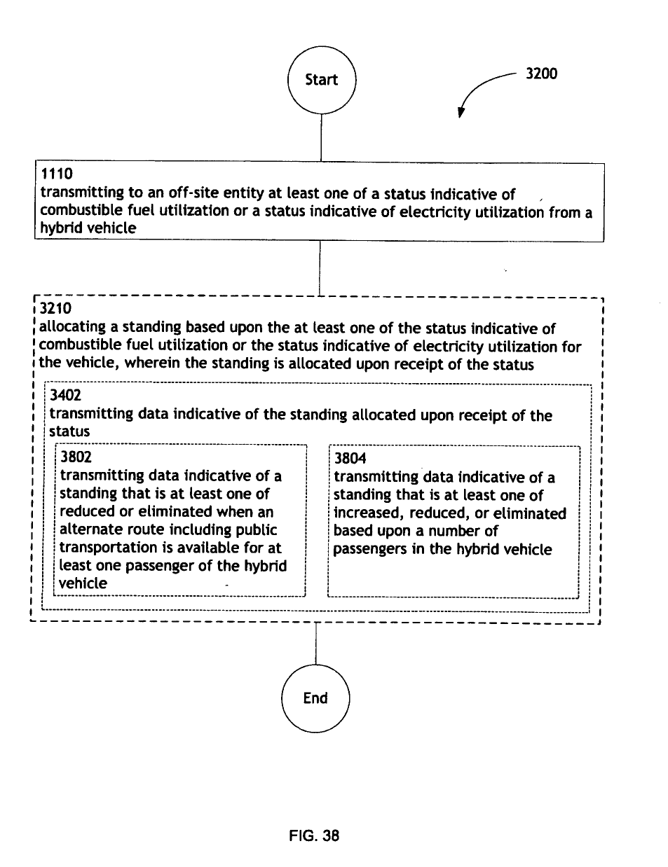

FIG. 38 illustrates alternative embodiments of the example operational flow 3200 of FIG. 32. FIG. 38 illustrates example embodiments where the operation 3210 may include at least one additional operation. Additional operations may include an operation 3802, and/or an operation 3804. Further, the operation 3802 illustrates transmitting data indicative of a standing that is at least one of reduced or eliminated when an alternate route including public transportation is available for at least one passenger of the hybrid vehicle. For example, as shown in FIGS. 1 through 10, the standing of the vehicle 100 may be reduced or eliminated when an alternate route including public transportation was available for a driver or a passenger of the vehicle 100. Further, the operation 3804 illustrates transmitting data indicative of a standing that is at least one of increased, reduced, or eliminated based upon a number of passengers in the hybrid vehicle. For example, as shown in FIGS. 1 through 10, the standing of the vehicle 100 may be eliminated based upon a number of passengers in the vehicle 100, such as only the driver.

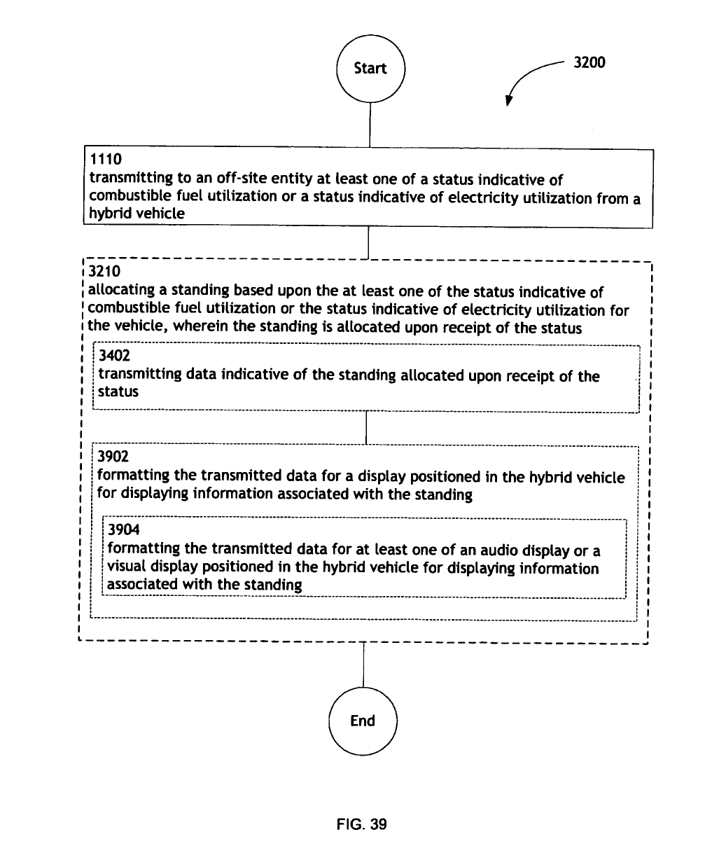

FIG. 39 illustrates alternative embodiments of the example operational flow 3200 of FIG. 32. FIG. 39 illustrates example embodiments where the operation 3210 may include at least one additional operation. Additional operations may include an operation 3902, and/or an operation 3904. Further, the operation 3902 illustrates formatting the transmitted data for a display positioned in the hybrid vehicle for displaying information associated with the standing. For example, as shown in FIGS. 1 through 10, the standing of the vehicle 100 may be transmitted to the vehicle 100 and formatted for the display 220. Further, the operation 3904 illustrates formatting the transmitted data for at least one of an audio display or a visual display positioned in the hybrid vehicle for displaying information associated with the standing. For example, as shown in FIGS. 1 through 10, the standing of the vehicle 100 may be transmitted to the vehicle 100 and formatted for a visual display, such as encoded with graphical picture element (pixel) information.

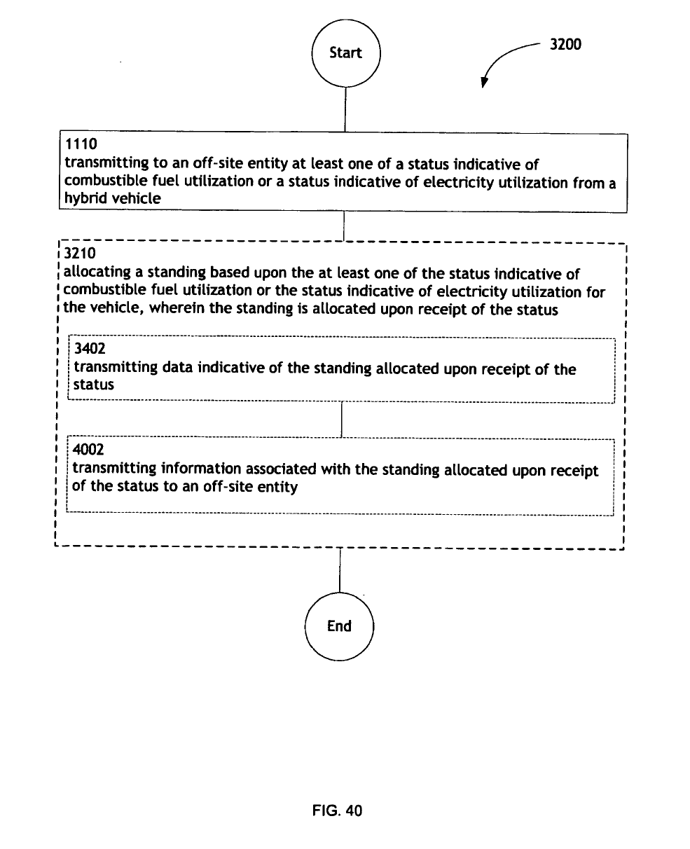

FIG. 40 illustrates alternative embodiments of the example operational flow 3200 of FIG. 32. FIG. 40 illustrates example embodiments where the operation 3210 may include at least one additional operation. Additional operations may include an operation 4002. Further, the operation 4002 illustrates transmitting information associated with the standing allocated upon receipt of the status to an off-site entity. For example, as shown in FIGS. 1 through 10, the standing allocated to the vehicle 100 may be transmitted to the receiver 153. The receiver 153 may then forward the standing to the vehicle 100. Further, the receiver 153 may include a database for storing the standing. In an embodiment, the receiver 153 may include one or more of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, or a memory card for storing information associated with the standing for the vehicle 100.

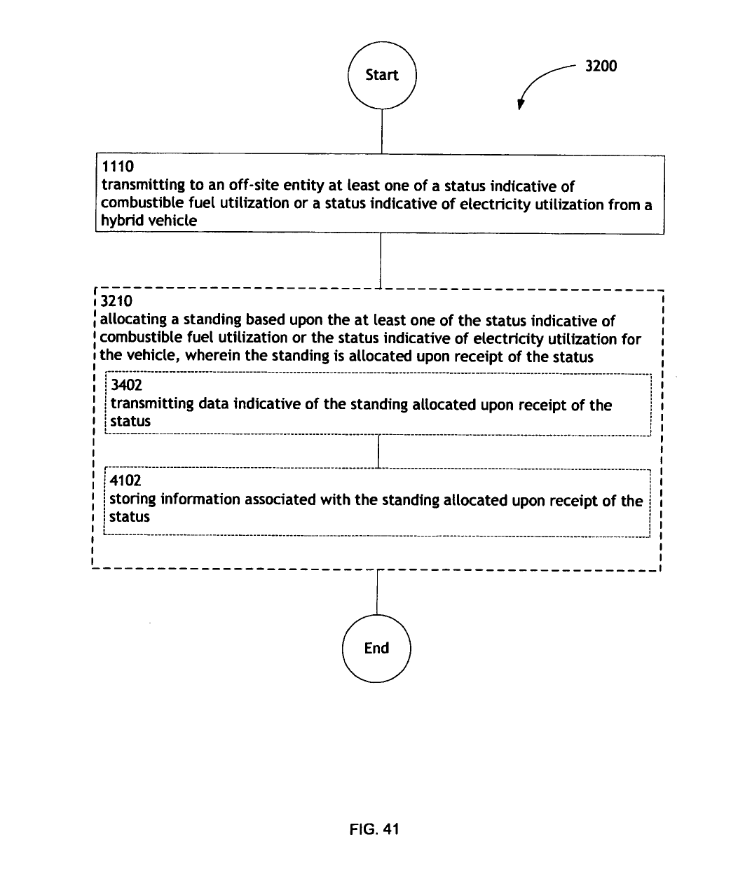

FIG. 41 illustrates alternative embodiments of the example operational flow 3200 of FIG. 32. FIG. 41 illustrates example embodiments where the operation 3210 may include at least one additional operation. Additional operations may include an operation 4102. Further, the operation 4102 illustrates storing information associated with the standing allocated upon receipt of the status. For example, as shown in FIGS. 1 through 10, the off-site entity 144 may store information associated with the standing for the vehicle 100. In one embodiment, the off-site entity 144 may store the information associated with the standing in storage 155 (e.g., a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, or a memory card). Further, the off-site entity 144 may store the information in storage 155 in an encrypted format (e.g., utilizing a public-key/private-key encryption scheme or the like).

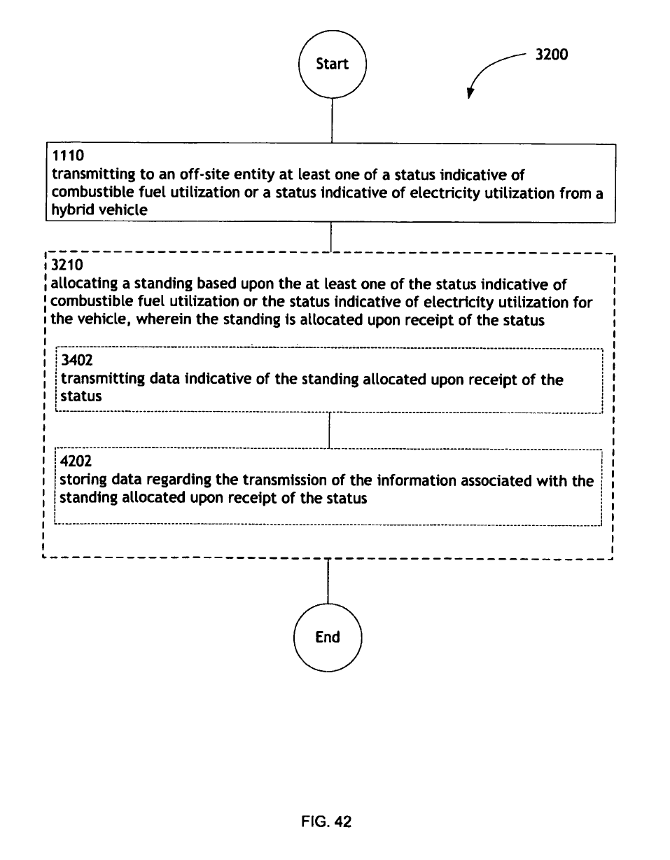

FIG. 42 illustrates alternative embodiments of the example operational flow 3200 of FIG. 32. FIG. 42 illustrates example embodiments where the operation 3210 may include at least one additional operation. Additional operations may include an operation 4202. Further, the operation 4202 illustrates storing data regarding the transmission of the information associated with the standing allocated upon receipt of the status. For example, as shown in FIGS. 1 through 10, the off-site entity 144 may store data regarding the transmission of the information associated with the standing for the vehicle 100. In one embodiment, the off-site entity 144 may store the information associated with the standing in storage 155, as previously described. Further, the off-site entity 144 may store the data in storage 155 in an encrypted format (e.g., utilizing a public-key/private-key encryption scheme or the like).

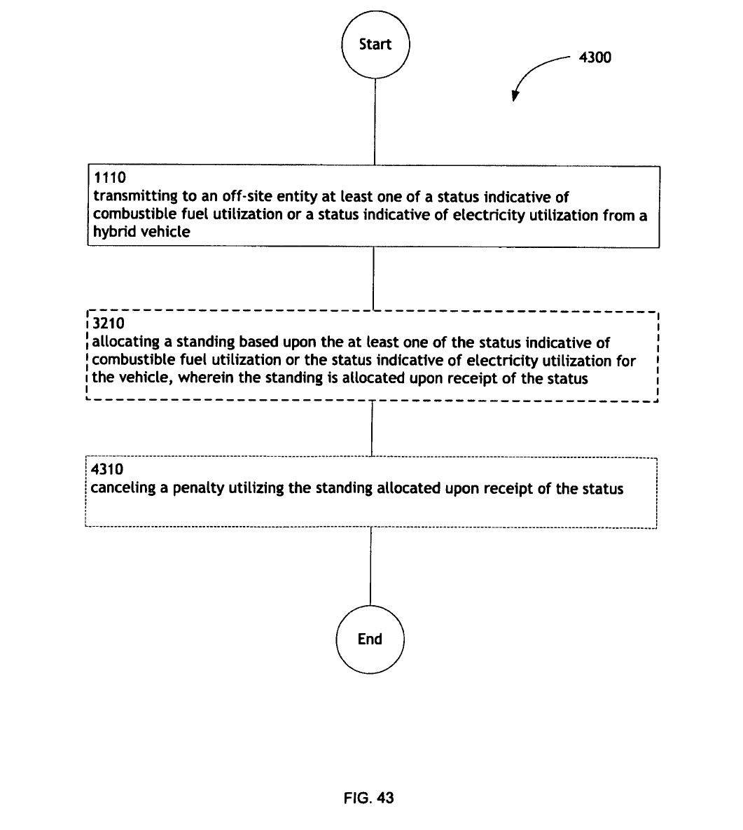

FIG. 43 illustrates an operational flow 4300 representing example operations related to transmitting to an off-site entity at least one of a status indicative of combustible fuel utilization or a status indicative of electricity utilization from a hybrid vehicle, allocating a standing based upon the status for the vehicle, and canceling a penalty utilizing the standing. FIG. 43 illustrates an example embodiment where the example operational flow 1100 of FIG. 11 may include at least one additional operation. Additional operations may include an operation 4310.

After a start operation, an operation 1110, and an operation 3210, the operational flow 4300 moves to an operation 4310. Operation 4310 illustrates canceling a penalty utilizing the standing allocated upon receipt of the status. For example, as shown in FIGS. 1 through 10, the standing allocated by the off-site entity 144 upon receipt of the status for the vehicle 100 may be utilized to cancel a penalty. For example, a standing including permission to utilize a pre-designated roadway may be utilized instead to cancel a tax levied against the vehicle 100 as a penalty.

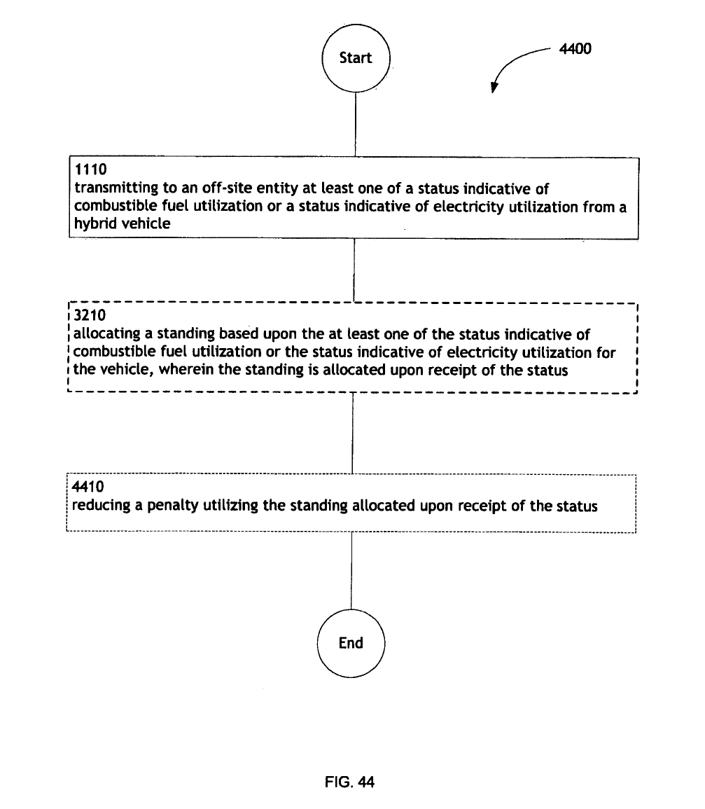

FIG. 44 illustrates an operational flow 4400 representing example operations related to transmitting to an off-site entity at least one of a status indicative of combustible fuel utilization or a status indicative of electricity utilization from a hybrid vehicle, allocating a standing based upon the status for the vehicle, and reducing a penalty utilizing the standing. FIG. 44 illustrates an example embodiment where the example operational flow 1100 of FIG. 11 may include at least one additional operation. Additional operations may include an operation 4410.

After a start operation, an operation 1110, and an operation 3210, the operational flow 4400 moves to an operation 4410. Operation 4410 illustrates reducing a penalty utilizing the standing allocated upon receipt of the status. For example, as shown in FIGS. 1 through 10, the standing allocated by the off-site entity 144 upon receipt of the status for the vehicle 100 may be utilized to reduce a penalty. For example, a standing including permission to utilize a pre-designated parking spot may be utilized instead to reduce a tax levied against the vehicle 100 as a penalty.

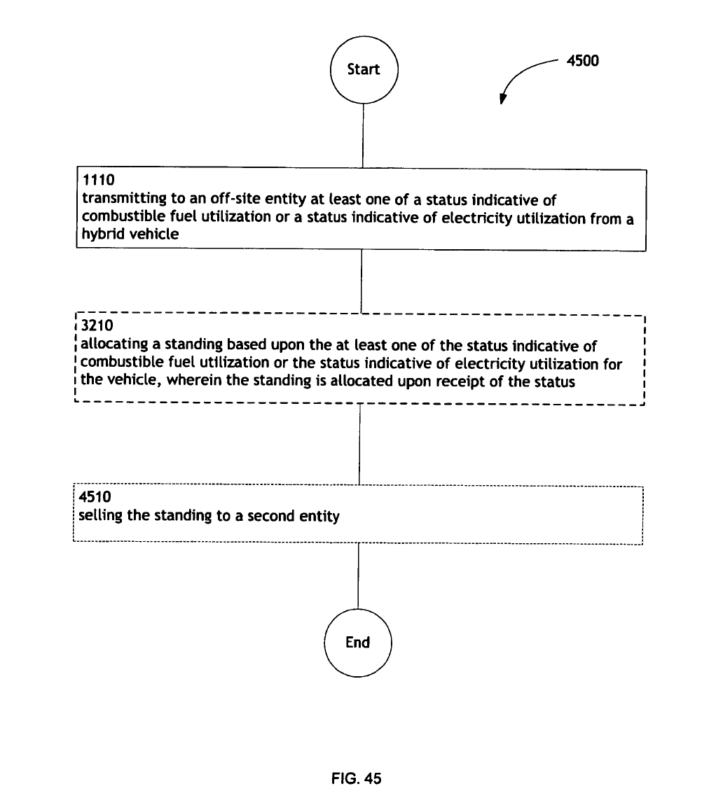

FIG. 45 illustrates an operational flow 4500 representing example operations related to transmitting to an off-site entity at least one of a status indicative of combustible fuel utilization or a status indicative of electricity utilization from a hybrid vehicle, allocating a standing based upon the status for the vehicle, and selling the standing to a second entity. FIG. 45 illustrates an example embodiment where the example operational flow 1100 of FIG. 11 may include at least one additional operation. Additional operations may include an operation 4510.

After a start operation, an operation 1110, and an operation 3210, the operational flow 4500 moves to an operation 4510. Operation 4510 illustrates selling the standing to a second entity. For example, as shown in FIGS. 1 through 10, the standing may be sold to another vehicle. Alternatively, the standing may be sold to an individual. For example, the driver may purchase the standing for transfer to another vehicle. Further, the standing may be sold to an authority, such as a local government, a state government, or a federal government.

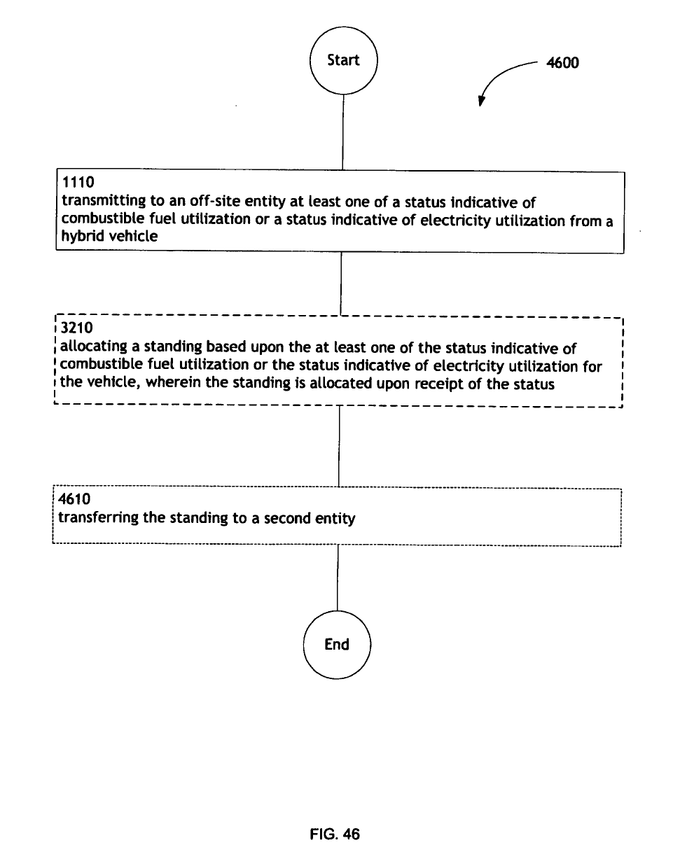

FIG. 46 illustrates an operational flow 4600 representing example operations related to transmitting to an off-site entity at least one of a status indicative of combustible fuel utilization or a status indicative of electricity utilization from a hybrid vehicle, allocating a standing based upon the status for the vehicle, and transferring the standing to a second entity. FIG. 46 illustrates an example embodiment where the example operational flow 1100 of FIG. 11 may include at least one additional operation. Additional operations may include an operation 4610.

After a start operation, an operation 1110, and an operation 3210, the operational flow 4600 moves to an operation 4610. Operation 4610 illustrates transferring the standing to a second entity. For example, as shown in FIGS. 1 through 10, the standing may be transferred to another vehicle. Alternatively, the standing may be transferred to an individual. For example, the driver may acquire the standing for transfer to another vehicle. Further, the standing may be transferred to an authority, such as a local government, a state government, or a federal government.

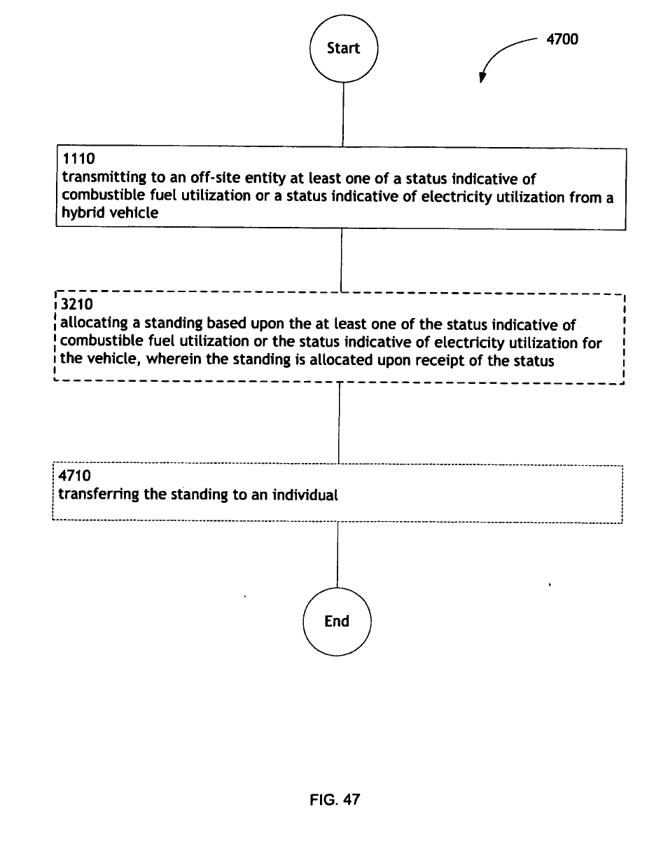

FIG. 47 illustrates an operational flow 4700 representing example operations related to transmitting to an off-site entity at least one of a status indicative of combustible fuel utilization or a status indicative of electricity utilization from a hybrid vehicle, allocating a standing based upon the status for the vehicle, and transferring the standing to an individual. FIG. 47 illustrates an example embodiment where the example operational flow 1100 of FIG. 11 may include at least one additional operation. Additional operations may include an operation 4710.

After a start operation, an operation 1110, and an operation 3210, the operational flow 4700 moves to an operation 4710. Operation 4710 illustrates transferring the standing to an individual. For example, as shown in FIGS. 1 through 10, the standing allocated by the off-site entity 144 upon receipt of the status for the vehicle 100 may be transferred to an individual. For example, a standing associated with the vehicle 100 may be transferred to the driver of the vehicle or one or more occupants thereof.

Further, the standing may be dependent upon at least one of a driver of the hybrid vehicle, an occupant of the hybrid vehicle, an identification for the hybrid vehicle, a time of day, a driving history for the hybrid vehicle, a history of standings for the hybrid vehicle, a number of standings accumulated for the hybrid vehicle, a user selection from a list of acceptable standings, an expiration of a standing, a time period during which a standing is valid, or a geographical region in which a standing is valid. In an embodiment, the standing allocated by the off-site entity 144 upon receipt of the status for the vehicle 100 may be dependent upon the driver of the hybrid vehicle. For example, the standing may include permission to utilize a pre-designated parking spot in a parking lot proximal to a place of employment for the driver of the vehicle 100.

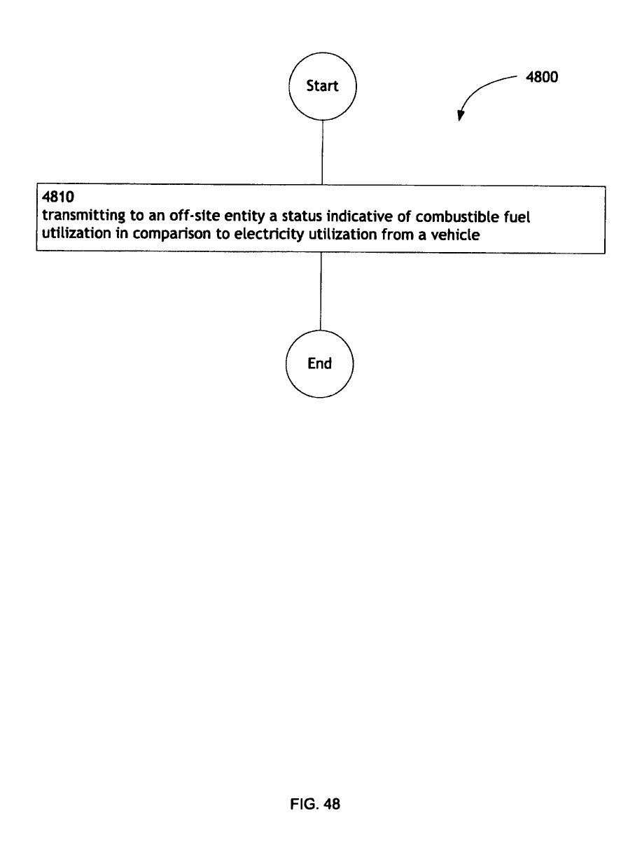

FIG. 48 illustrates an operational flow 4800 representing example operations related to transmitting to an off-site entity a status indicative of combustible fuel utilization in comparison to electricity utilization from a vehicle. In FIG. 48 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 4800 moves to an operation 4810. Operation 4810 depicts transmitting to an off-site entity a status indicative of combustible fuel utilization in comparison to electricity utilization from a vehicle. For example, as shown in FIGS. 1 through 10, the vehicle 100 may transmit (e.g., utilizing the transmitter 120) a status indicative of, for example, combustible fuel utilization in comparison to electricity utilization for the vehicle 100. In an embodiment, the off-site entity 144 may receive the status transmitted by the vehicle 100.

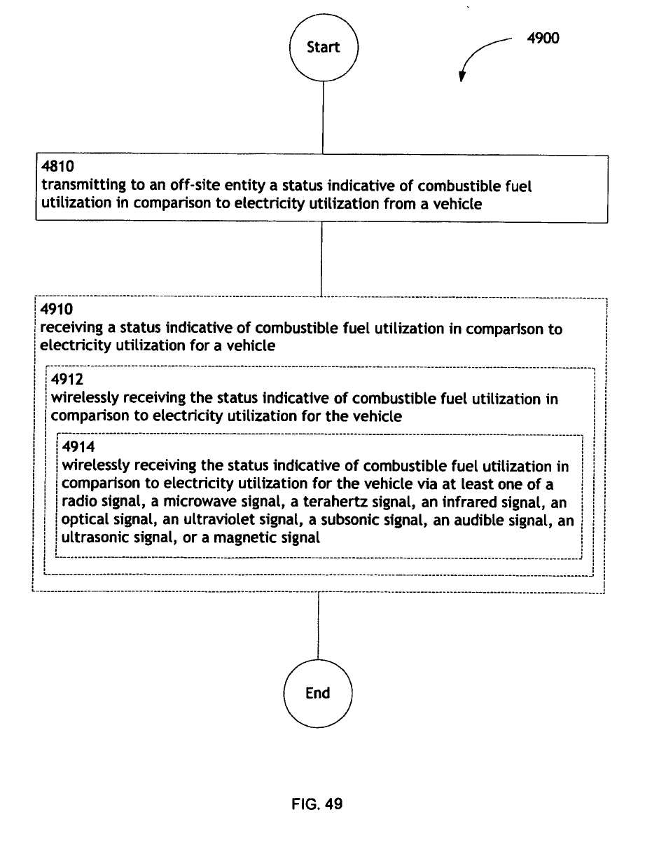

FIG. 49 illustrates an operational flow 4900 representing example operations related to transmitting to an off-site entity a status indicative of combustible fuel utilization in comparison to electricity utilization from a vehicle and receiving a status indicative of combustible fuel utilization in comparison to electricity utilization for a vehicle. FIG. 49 illustrates an example embodiment where the example operational flow 4800 of FIG. 48 may include at least one additional operation. Additional operations may include an operation 4910, an operation 4912, and/or an operation 4914.

After a start operation and an operation 4810, the operational flow 4900 moves to an operation 4910. Operation 4910 illustrates receiving a status indicative of combustible fuel utilization in comparison to electricity utilization for a vehicle. For example, as shown in FIGS. 1 through 10, the vehicle 100 may utilize the transmitter 120 to transmit a status indicative of, for example, combustible fuel utilization in comparison to electricity utilization for the vehicle 100. In an embodiment, the off-site entity 144 may receive the status transmitted by the vehicle 100.

The operation 4912 illustrates wirelessly receiving the status indicative of combustible fuel utilization in comparison to electricity utilization for the vehicle. For example, as shown in FIGS. 1 through 10, the transmitter 120 may transmit the status for the vehicle 100 via the wireless signal 122, which may be received by off-site entity 144. Further, the operation 4914 illustrates wirelessly receiving the status indicative of combustible fuel utilization in comparison to electricity utilization for the vehicle via at least one of a radio signal, a microwave signal, a terahertz signal, an infrared signal, an optical signal, an ultraviolet signal, a subsonic signal, an audible signal, an ultrasonic signal, or a magnetic signal. For example, as shown in FIGS. 1 through 10, the transmitter 120 may transmit the status for the vehicle 100 via an optical (i.e., visible to a human eye) signal, which may be received by the off-site entity 144.

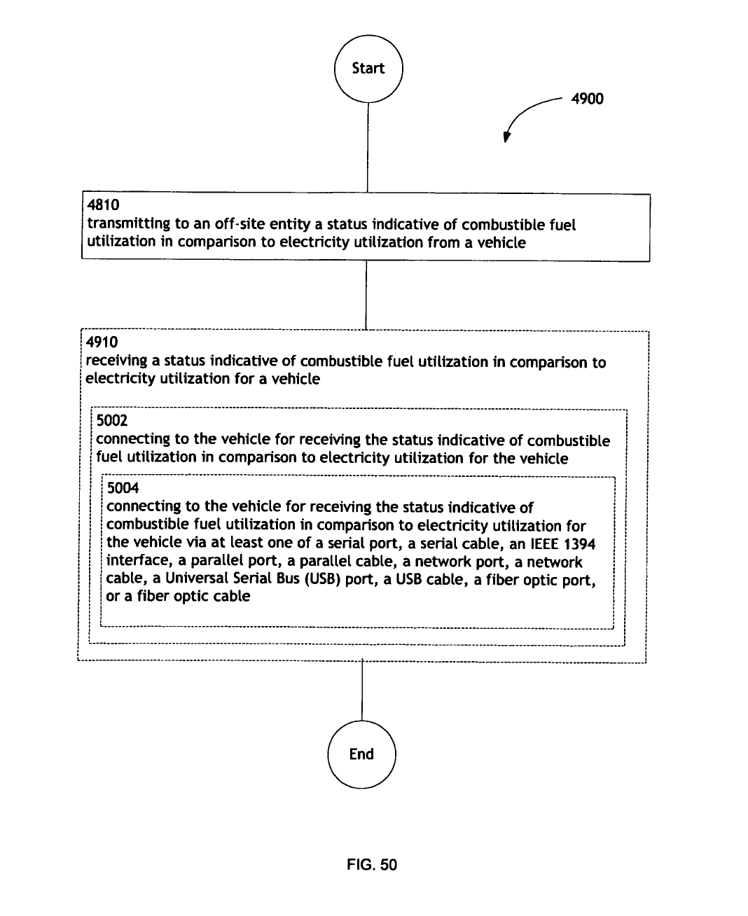

FIG. 50 illustrates alternative embodiments of the example operational flow 4900 of FIG. 49. FIG. 50 illustrates example embodiments where the operation 4910 may include at least one additional operation. Additional operations may include an operation 5002, and/or an operation 5004.

The operation 5002 illustrates connecting to the vehicle for receiving the status indicative of combustible fuel utilization in comparison to electricity utilization for the vehicle. For example, as shown in FIGS. 1 through 10, the transmitter 120 can be coupled with a connector 142 for connecting to the off-site entity 144. The off-site entity 144 can then receive the status of the vehicle. Further, the operation 5004 illustrates connecting to the vehicle for receiving the status indicative of combustible fuel utilization in comparison to electricity utilization for the vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable. For example, as shown in FIGS. 1 through 10, the status of the vehicle 100 may be received by the off-site entity 144 via an IEEE 1394 interface connection 149.

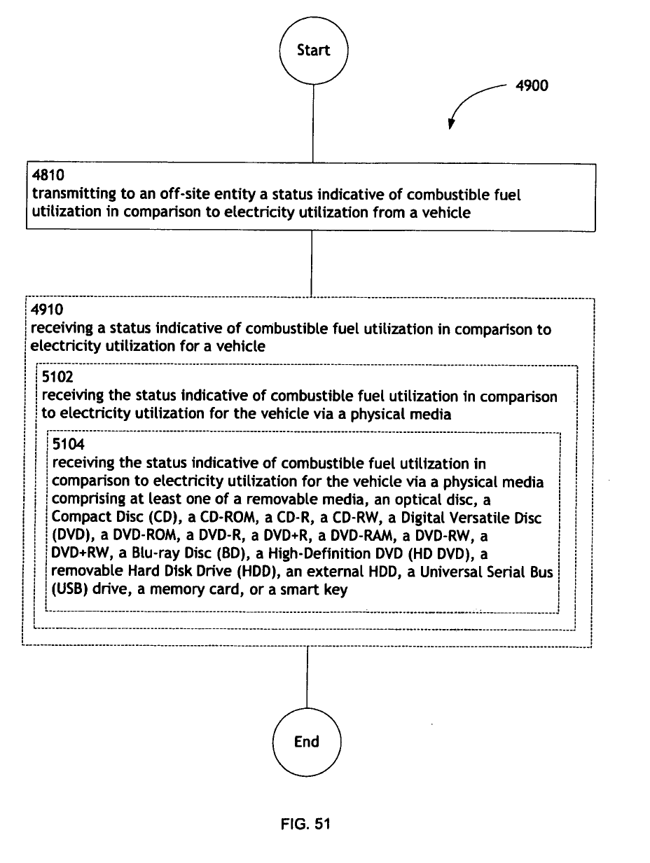

FIG. 51 illustrates alternative embodiments of the example operational flow 4900 of FIG. 49. FIG. 51 illustrates example embodiments where the operation 4910 may include at least one additional operation. Additional operations may include an operation 5102, and/or an operation 5104.

The operation 5102 illustrates receiving the status indicative of combustible fuel utilization in comparison to electricity utilization for the vehicle via a physical media. For example, as shown in FIGS. 1 through 10, the transmitter 120 may also be utilized to transmit the status for the vehicle 100 via the physical media 166. In an embodiment, the physical media 166 is provided to the off-site entity 144. Further, the operation 5104 illustrates receiving the status indicative of combustible fuel utilization in comparison to electricity utilization for the vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key. For example, as shown in FIGS. 1 through 10, the status of the vehicle 100 may be received by the off-site entity 144 via a removable Hard Disk Drive (HDD) 180 from the vehicle 100.

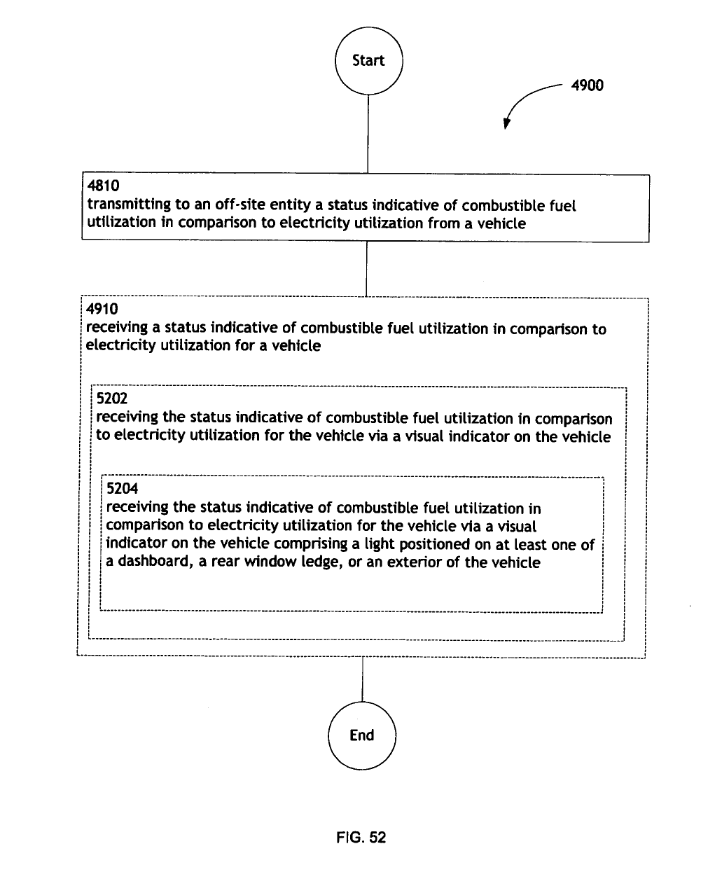

FIG. 52 illustrates alternative embodiments of the example operational flow 4900 of FIG. 49. FIG. 52 illustrates example embodiments where the operation 4910 may include at least one additional operation. Additional operations may include an operation 5202, and/or an operation 5204.

The operation 5202 illustrates receiving the status indicative of combustible fuel utilization in comparison to electricity utilization for the vehicle via a visual indicator on the vehicle. For example, as shown in FIGS. 1 through 10, the status of the vehicle 100 may be transmitted to the off-site entity 144 via a visual indicator 190 positioned on the vehicle 100. Further, the operation 5204 illustrates receiving the status indicative of combustible fuel utilization in comparison to electricity utilization for the vehicle via a visual indicator on the vehicle comprising a light positioned on at least one of a dashboard, a rear window ledge, or an exterior of the vehicle. For example, as shown in FIGS. 1 through 10, the status of the vehicle 100 may be received by the off-site entity 144 from a light 192 positioned on a rear window ledge of the vehicle 100.

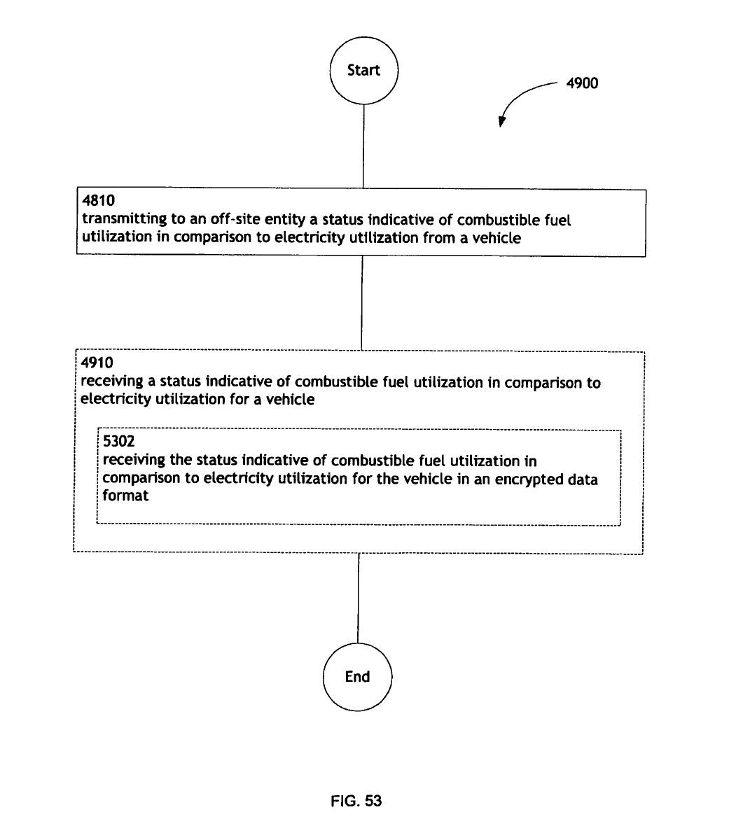

FIG. 53 illustrates alternative embodiments of the example operational flow 4900 of FIG. 49. FIG. 53 illustrates example embodiments where the operation 4910 may include at least one additional operation. Additional operations may include an operation 5302.

The operation 5302 illustrates receiving the status indicative of combustible fuel utilization in comparison to electricity utilization for the vehicle in an encrypted data format. For example, as shown in FIGS. 1 through 10, the transmitter 120 may transmit the status of the vehicle 100 in an encrypted data format for receipt by the off-site entity 144. In an embodiment, the transmitter 120 may transmit the status utilizing a public-key/private-key encryption scheme. However, it is contemplated that a variety of other encryption schemes may be utilized as well.

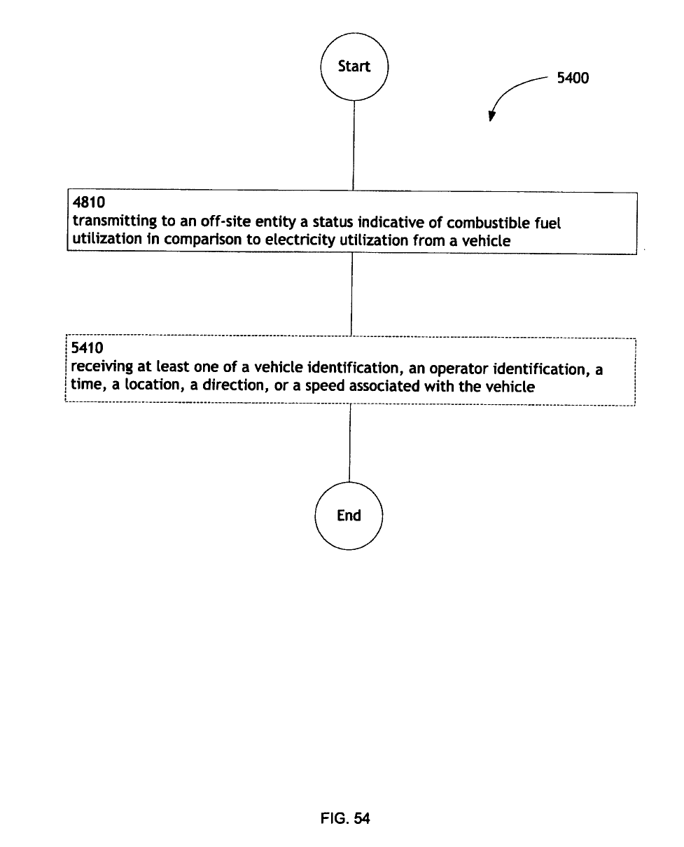

FIG. 54 illustrates an operational flow 5400 representing example operations related to transmitting to an off-site entity a status indicative of combustible fuel utilization in comparison to electricity utilization from a vehicle and receiving at least one of a vehicle identification, an operator identification, a time, a location, a direction, or a speed associated with the vehicle. FIG. 54 illustrates an example embodiment where the example operational flow 4800 of FIG. 48 may include at least one additional operation. Additional operations may include an operation 5410.

After a start operation and an operation 4810, the operational flow 5400 moves to an operation 5410. Operation 5410 illustrates receiving at least one of a vehicle identification, an operator identification, a time, a location, a direction, or a speed associated with the vehicle. For example, as shown in FIGS. 1 through 10, the transmitter 120 may transmit an identification for the vehicle 100 for receipt by the off-site entity 144.

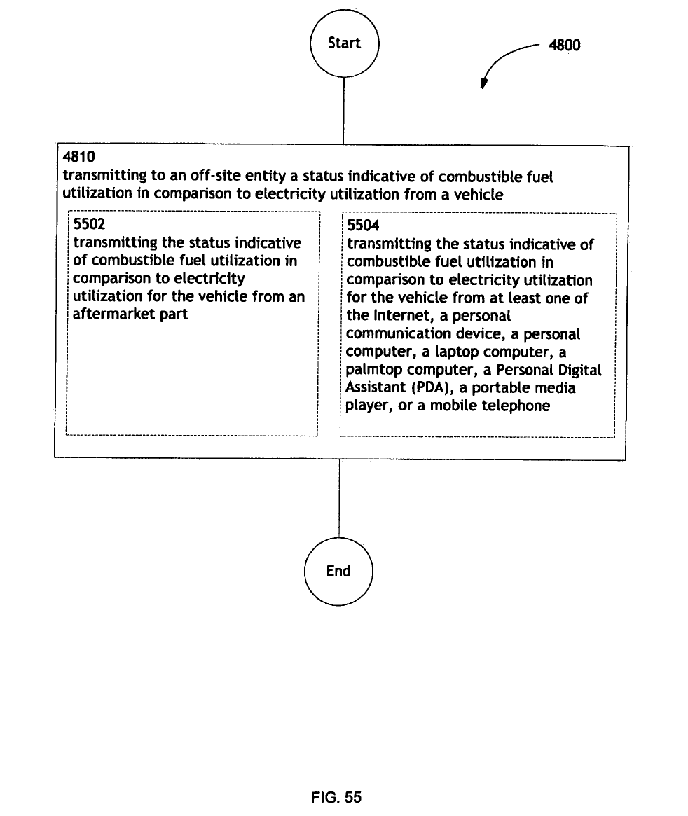

FIG. 55 illustrates alternative embodiments of the example operational flow 4800 of FIG. 48. FIG. 55 illustrates example embodiments where the operation 4810 may include at least one additional operation. Additional operations may include an operation 5502, and/or an operation 5504.

The operation 5502 illustrates transmitting the status indicative of combustible fuel utilization in comparison to electricity utilization for the vehicle from an aftermarket part. For example, as shown in FIGS. 1 through 10, the status may be transmitted to the off-site entity 144 by a transmitter 120 included with an aftermarket part.

The operation 5504 illustrates transmitting the status indicative of combustible fuel utilization in comparison to electricity utilization for the vehicle from at least one of the Internet, a personal communication device, a personal computer, a laptop computer, a palmtop computer, a Personal Digital Assistant (PDA), a portable media player, or a mobile telephone. For example, as shown in FIGS. 1 through 10, the status may be transmitted by a personal computer coupled with the transmitter 120. In an embodiment, the personal computer may be selectively coupled with the vehicle 100, such as via a wireless network communications link, or the like.

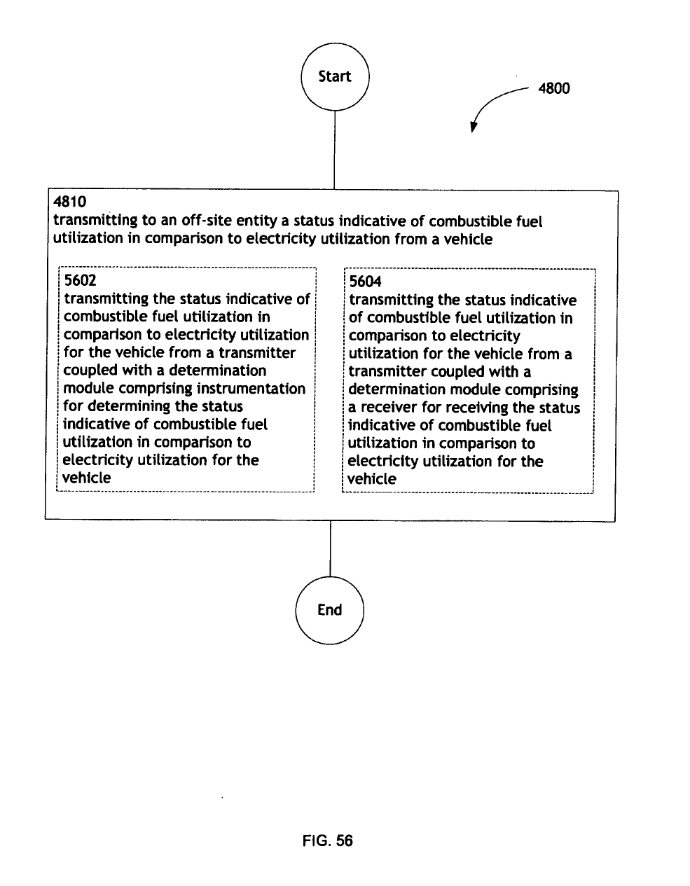

FIG. 56 illustrates alternative embodiments of the example operational flow 4800 of FIG. 48. FIG. 56 illustrates example embodiments where the operation 4810 may include at least one additional operation. Additional operations may include an operation 5602, and/or an operation 5604.

The operation 5602 illustrates transmitting the status indicative of combustible fuel utilization in comparison to electricity utilization for the vehicle from a transmitter coupled with a determination module comprising instrumentation for determining the status indicative of combustible fuel utilization in comparison to electricity utilization for the vehicle. For example, as shown in FIGS. 1 through 10, the transmitter 120 may be coupled with the determination module 196 for determining the status for the vehicle 100 and then transmitting the status for receipt by the off-site entity 144.

The operation 5604 illustrates transmitting the status indicative of combustible fuel utilization in comparison to electricity utilization for the vehicle from a transmitter coupled with a determination module comprising a receiver for receiving the status indicative of combustible fuel utilization in comparison to electricity utilization for the vehicle. For example, as shown in FIGS. 1 through 10, the transmitter 120 may be coupled with the determination module 196 in a configuration where the determination module 196 includes a receiver 202. The receiver 202 is configured to receive the status for the vehicle 100 (e.g., from power-selection instrumentation), and the transmitter 120 is configured to transmit the status for receipt by the off-site entity 144.

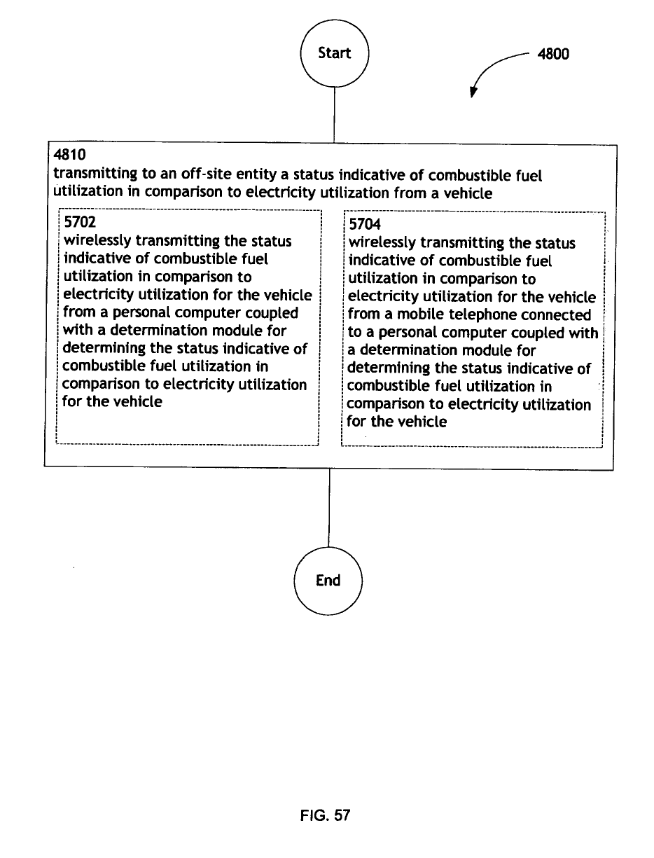

FIG. 57 illustrates alternative embodiments of the example operational flow 4800 of FIG. 48. FIG. 57 illustrates example embodiments where the operation 4810 may include at least one additional operation. Additional operations may include an operation 5702, and/or an operation 5704.

The operation 5702 illustrates wirelessly transmitting the status indicative of combustible fuel utilization in comparison to electricity utilization for the vehicle from a personal computer coupled with a determination module for determining the status indicative of combustible fuel utilization in comparison to electricity utilization for the vehicle. For example, as shown in FIGS. 1 through 10, the status for the vehicle may be wirelessly transmitted to the off-site entity 144 by a personal computer 203 coupled with the determination module 196.

The operation 5704 illustrates wirelessly transmitting the status indicative of combustible fuel utilization in comparison to electricity utilization for the vehicle from a mobile telephone connected to a personal computer coupled with a determination module for determining the status indicative of combustible fuel utilization in comparison to electricity utilization for the vehicle. For example, as shown in FIGS. 1 through 10, the status for the vehicle may be wirelessly transmitted to the off-site entity 144 by a mobile telephone 205 connected to the personal computer 203, where the personal computer 203 is coupled with the determination module 196. In an embodiment, the mobile telephone 205 may be connected to the personal computer via a USB link, a network link (e.g., via a network cable), an IEEEE 1394 interface, a Bluetooth link, or via another connection scheme as desired.

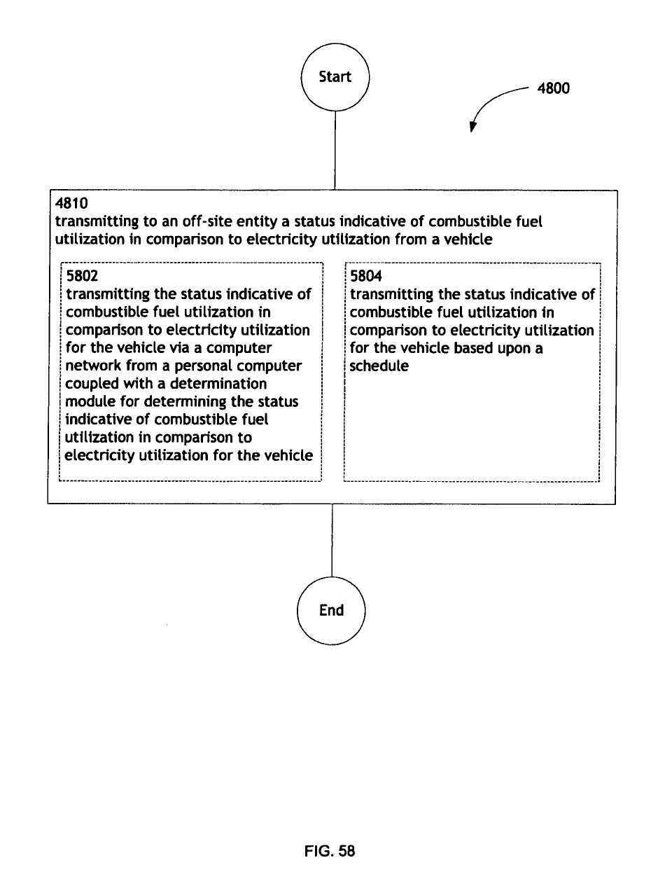

FIG. 58 illustrates alternative embodiments of the example operational flow 4800 of FIG. 48. FIG. 58 illustrates example embodiments where the operation 4810 may include at least one additional operation. Additional operations may include an operation 5802, and/or an operation 5804.

The operation 5802 illustrates transmitting the status indicative of combustible fuel utilization in comparison to electricity utilization for the vehicle via a computer network from a personal computer coupled with a determination module for determining the status indicative of combustible fuel utilization in comparison to electricity utilization for the vehicle. For example, as shown in FIGS. 1 through 10, the status for the vehicle may be transmitted to the off-site entity 144 by the personal computer 203 coupled with the determination module 196, where the personal computer 203 transmits the status via a computer network 207, (e.g., the Internet).

The operation 5804 illustrates transmitting the status indicative of combustible fuel utilization in comparison to electricity utilization for the vehicle based upon a schedule. For example, as shown in FIGS. 1 through 10, the status for the vehicle 100 may be transmitted by the transmitter 120 for receipt by the off-site entity 144 based upon a daily schedule.

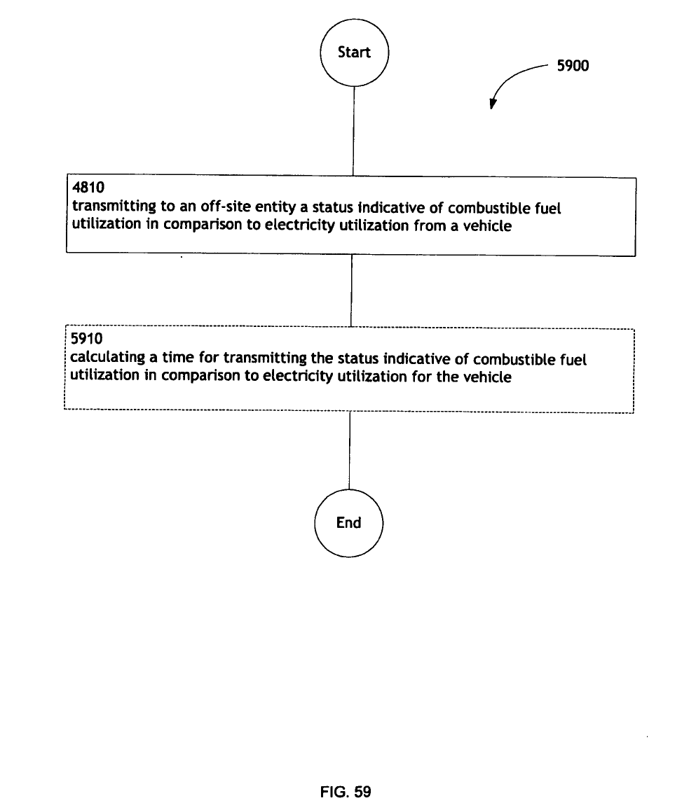

FIG. 59 illustrates an operational flow 5900 representing example operations related to transmitting to an off-site entity a status indicative of combustible fuel utilization in comparison to electricity utilization from a vehicle and calculating a time for transmitting the status. FIG. 59 illustrates an example embodiment where the example operational flow 4800 of FIG. 48 may include at least one additional operation. Additional operations may include an operation 5910.

After a start operation and an operation 4810, the operational flow 5900 moves to an operation 5910. Operation 5910 illustrates calculating a time for transmitting the status indicative of combustible fuel utilization in comparison to electricity utilization for the vehicle. For example, as shown in FIGS. 1 through 10, the transmitter 120 may utilize a processor 104 for scheduling a time to transmit the status of the vehicle 100. Further, the off-site entity may include a processor 145 for calculating a time to receive the status transmitted by the transmitter 120.

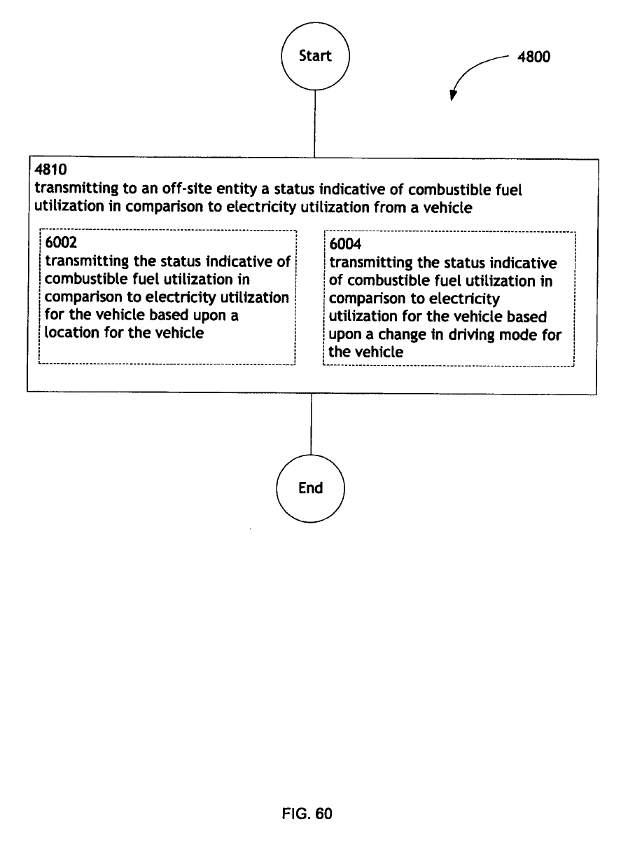

FIG. 60 illustrates alternative embodiments of the example operational flow 4800 of FIG. 48. FIG. 60 illustrates example embodiments where the operation 4810 may include at least one additional operation. Additional operations may include an operation 6002, and/or an operation 6004.

The operation 6002 illustrates transmitting the status indicative of combustible fuel utilization in comparison to electricity utilization for the vehicle based upon a location for the vehicle. For example, as shown in FIGS. 1 through 10, the transmitter 120 may transmit the status of the vehicle 100 based upon a location, such as when the vehicle 100 crosses from one region into another. The off-site entity 144 may then receive the status based upon the location for the vehicle 100.

The operation 6004 illustrates transmitting the status indicative of combustible fuel utilization in comparison to electricity utilization for the vehicle based upon a change in driving mode for the vehicle. For example, as shown in FIGS. 1 through 10, the transmitter 120 may transmit the status of the vehicle 100 based upon a change in driving mode, such as when the vehicle 100 switches from one fuel source to another. The off-site entity 144 may then receive the status based upon the change in driving mode.

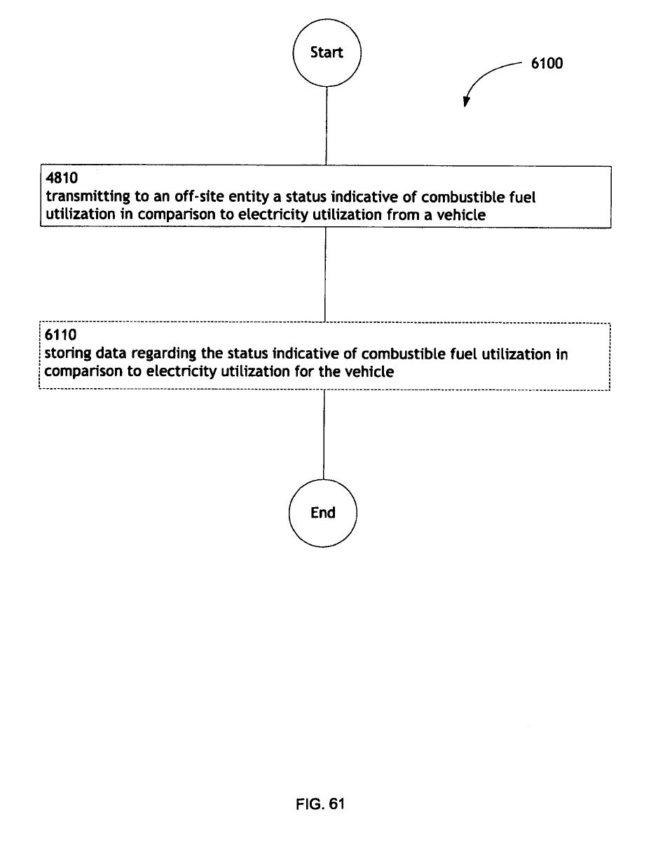

FIG. 61 illustrates an operational flow 6100 representing example operations related to transmitting to an off-site entity a status indicative of combustible fuel utilization in comparison to electricity utilization from a vehicle and storing data regarding the status. FIG. 61 illustrates an example embodiment where the example operational flow 4800 of FIG. 48 may include at least one additional operation. Additional operations may include an operation 6110.

After a start operation and an operation 4810, the operational flow 6100 moves to an operation 6110. Operation 6110 illustrates storing data regarding the status indicative of combustible fuel utilization in comparison to electricity utilization for the vehicle. For example, as shown in FIGS. 1 through 10, the off-site entity 144 may store data regarding the status for the vehicle 100. In one embodiment, the off-site entity 144 may store the status associated with the vehicle 100 in storage 155. Further, the off-site entity 144 may store the data in storage 155 in an encrypted format (e.g., utilizing a public-key/private-key encryption scheme or the like).

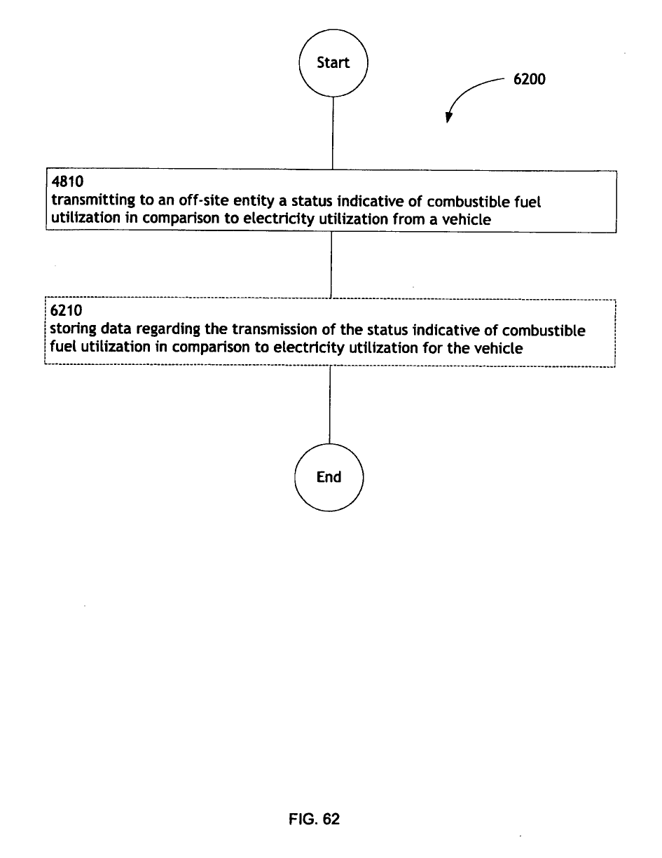

FIG. 62 illustrates an operational flow 6200 representing example operations related to transmitting to an off-site entity a status indicative of combustible fuel utilization in comparison to electricity utilization from a vehicle and storing data regarding the transmission of the status. FIG. 62 illustrates an example embodiment where the example operational flow 4800 of FIG. 48 may include at least one additional operation. Additional operations may include an operation 6210.

After a start operation and an operation 4810, the operational flow 6200 moves to an operation 6210. Operation 6210 illustrates storing data regarding the transmission of the status indicative of combustible fuel utilization in comparison to electricity utilization for the vehicle. For example, as shown in FIGS. 1 through 10, the off-site entity 144 may store data regarding the transmission of the status for the vehicle 100. In one embodiment, the off-site entity 144 may store the data associated with the status in storage 155, as previously described. Further, the off-site entity 144 may store the data in storage 155 in an encrypted format (e.g., utilizing a public-key/private-key encryption scheme or the like).

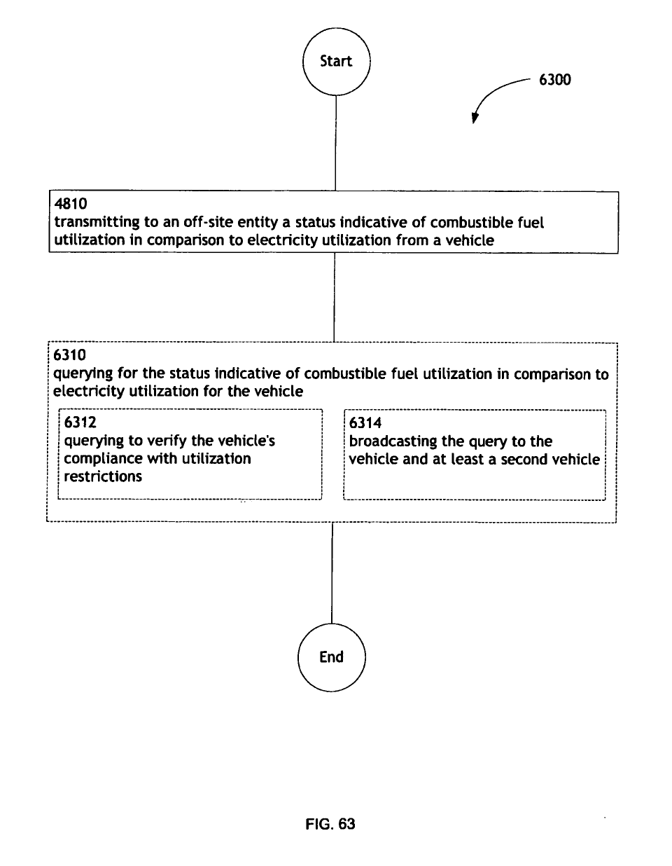

FIG. 63 illustrates an operational flow 6300 representing example operations related to transmitting to an off-site entity a status indicative of combustible fuel utilization in comparison to electricity utilization from a vehicle and querying for the status. FIG. 63 illustrates an example embodiment where the example operational flow 4800 of FIG. 48 may include at least one additional operation. Additional operations may include an operation 6310, an operation 6312, and/or an operation 6314.

After a start operation and an operation 4810, the operational flow 6300 moves to an operation 6310. Operation 6310 illustrates querying for the status indicative of combustible fuel utilization in comparison to electricity utilization for the vehicle. For example, as shown in FIGS. 1 through 10, the road authority may query the vehicle 100 for its status.

The operation 6312 illustrates querying to verify the vehicle's compliance with utilization restrictions. For example, as shown in FIGS. 1 through 10, the off-site entity 144 may query the vehicle 100 for its status to verify the vehicle's compliance with fuel utilization requirements for geographical region.

The operation 6314 illustrates broadcasting the query to the vehicle and at least a second vehicle. For example, as shown in FIGS. 1 through 10, the off-site entity 144 may broadcast the query to multiple vehicles.

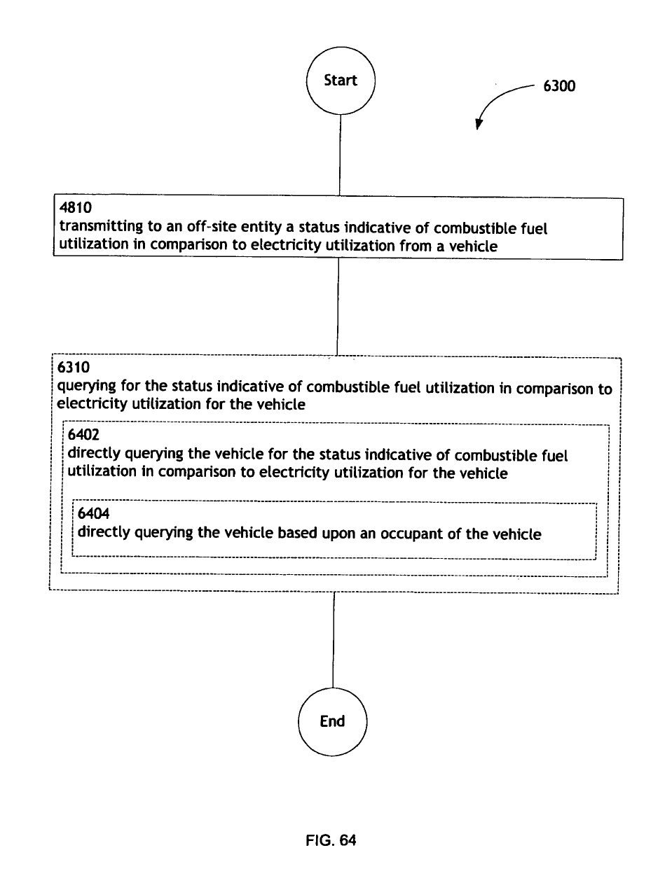

FIG. 64 illustrates alternative embodiments of the example operational flow 6300 of FIG. 63. FIG. 64 illustrates example embodiments where the operation 6310 may include at least one additional operation. Additional operations may include an operation 6402, and/or an operation 6404.

The operation 6402 illustrates directly querying the vehicle for the status indicative of combustible fuel utilization in comparison to electricity utilization for the vehicle. For example, as shown in FIGS. 1 through 10, the off-site entity 144 may transmit the query directly to the vehicle 100, such as utilizing a line-of-sight transmission (e.g., a laser beam) or the like. Further, the operation 6404 illustrates directly querying the vehicle based upon an occupant of the vehicle. For example, as shown in FIGS. 1 through 10, the off-site entity 144 may transmit the query directly (e.g., utilizing a line-of-sight transmission) to the vehicle 100 based upon an identified occupant of the vehicle. The occupant may be identified utilizing an image capture device (e.g., a digital camera) and facial recognition software configured to execute on the processor 145, for instance.

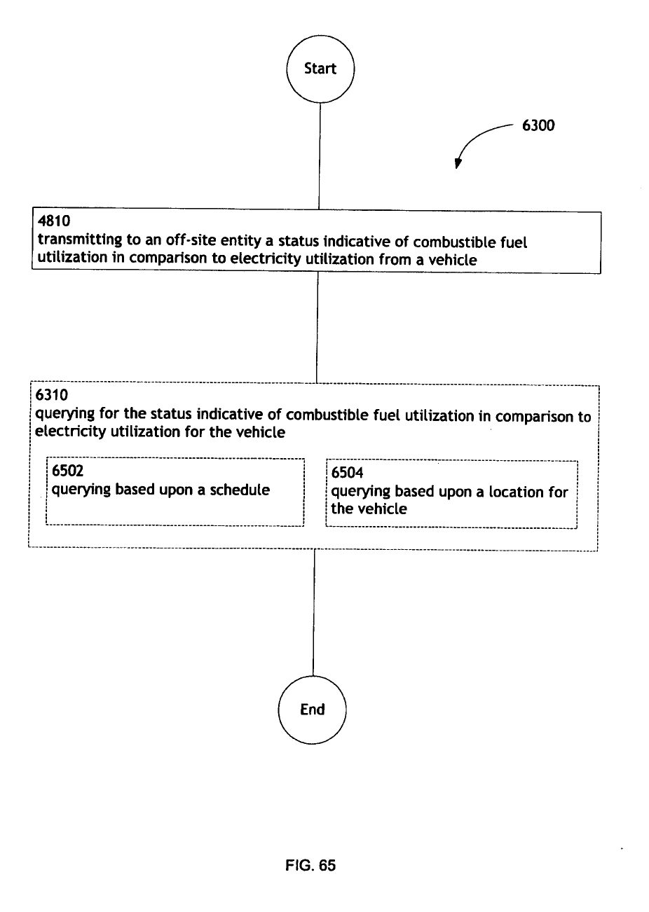

FIG. 65 illustrates alternative embodiments of the example operational flow 6300 of FIG. 63. FIG. 65 illustrates example embodiments where the operation 6310 may include at least one additional operation. Additional operations may include an operation 6502, and/or an operation 6504.

The operation 6502 illustrates querying based upon a schedule. For example, as shown in FIGS. 1 through 10, the off-site entity 144 may transmit a query to the vehicle 100 based upon a schedule. The processor 145 may be utilized to calculate the schedule.

The operation 6504 illustrates querying based upon a location for the vehicle. For example, as shown in FIGS. 1 through 10, the off-site entity 144 may transmit a query to the vehicle 100 based upon a location for the vehicle 100. The location may be determined by a locator module 147, which may include vehicle location hardware or software, connections to one or more traffic cameras, or access to satellite tracking information, among other techniques for tracking the vehicle 100.

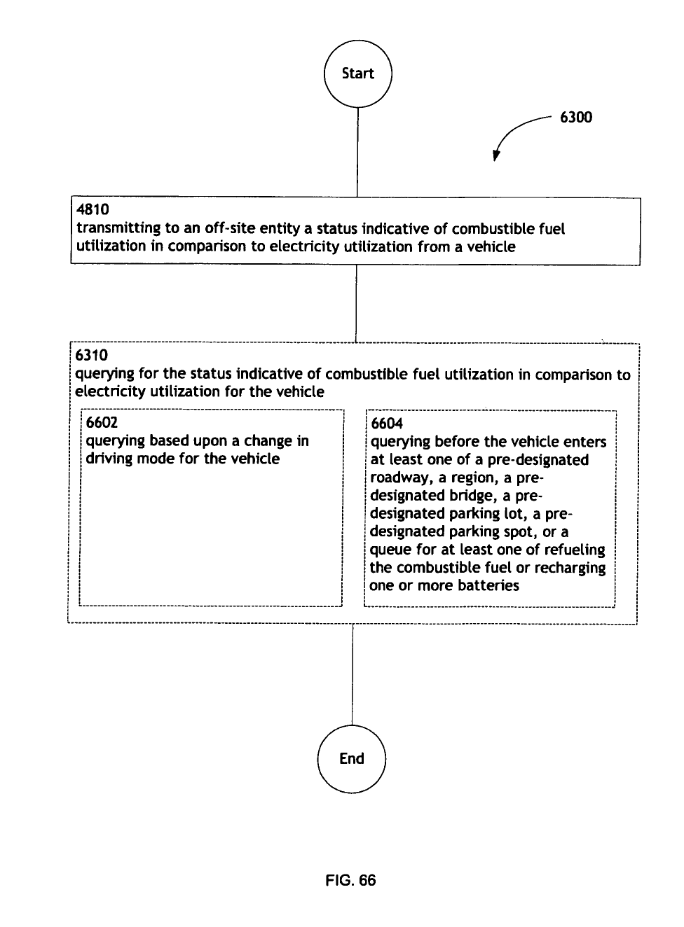

FIG. 66 illustrates alternative embodiments of the example operational flow 6300 of FIG. 63. FIG. 66 illustrates example embodiments where the operation 6310 may include at least one additional operation. Additional operations may include an operation 6602, and/or an operation 6604.

The operation 6602 illustrates querying based upon a change in driving mode for the vehicle. For example, as shown in FIGS. 1 through 10, the off-site entity 144 may transmit a query to the vehicle based upon a change in driving mode, such as a switch from utilizing the second drive train 104 to utilizing the first drive train 102.

The operation 6604 illustrates querying before the vehicle enters at least one of a pre-designated roadway, a region, a pre-designated bridge, a pre-designated parking lot, a pre-designated parking spot, or a queue for at least one of refueling the combustible fuel or recharging one or more batteries. For example, as shown in FIGS. 1 through 10, the off-site entity 144 may transmit a query to the vehicle before the vehicle enters a pre-designated roadway (e.g., as determined by the locator module 147).

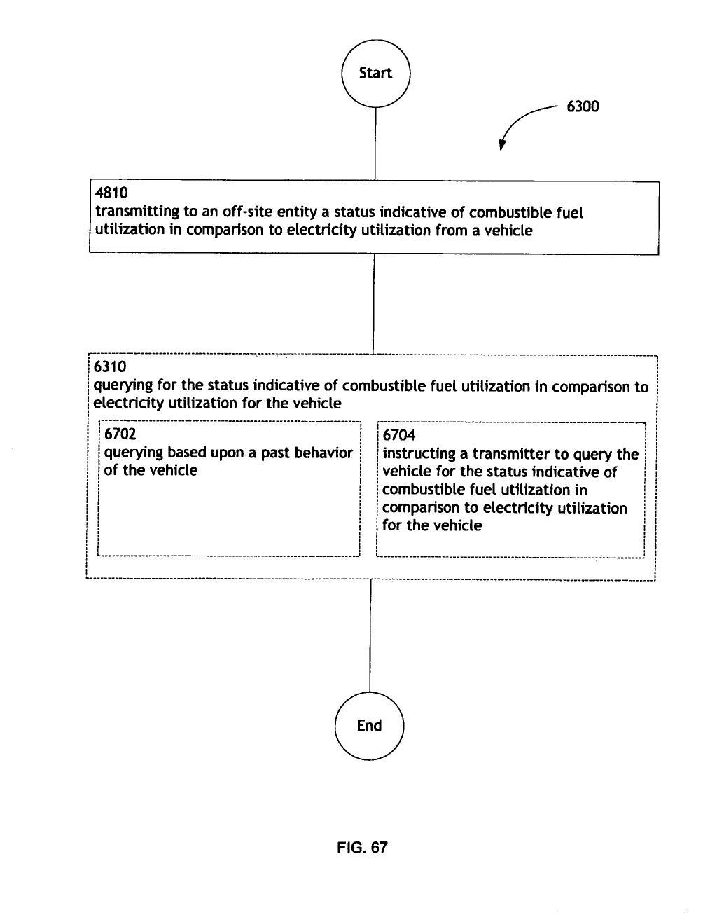

FIG. 67 illustrates alternative embodiments of the example operational flow 6300 of FIG. 63. FIG. 67 illustrates example embodiments where the operation 6310 may include at least one additional operation. Additional operations may include an operation 6702, and/or an operation 6704.

The operation 6702 illustrates querying based upon a past behavior of the vehicle. For example, as shown in FIGS. 1 through 10, the off-site entity 144 may transmit a query to the vehicle based upon a past behavior of the vehicle, such as a past utilization of combustible fuel by the vehicle 100.

The operation 6704 illustrates instructing a transmitter to query the vehicle for the status indicative of combustible fuel utilization in comparison to electricity utilization for the vehicle. For example, as shown in FIGS. 1 through 10, the off-site entity 144 may instruct another entity, such as a transmitter 151, to query the vehicle 100 for its status.

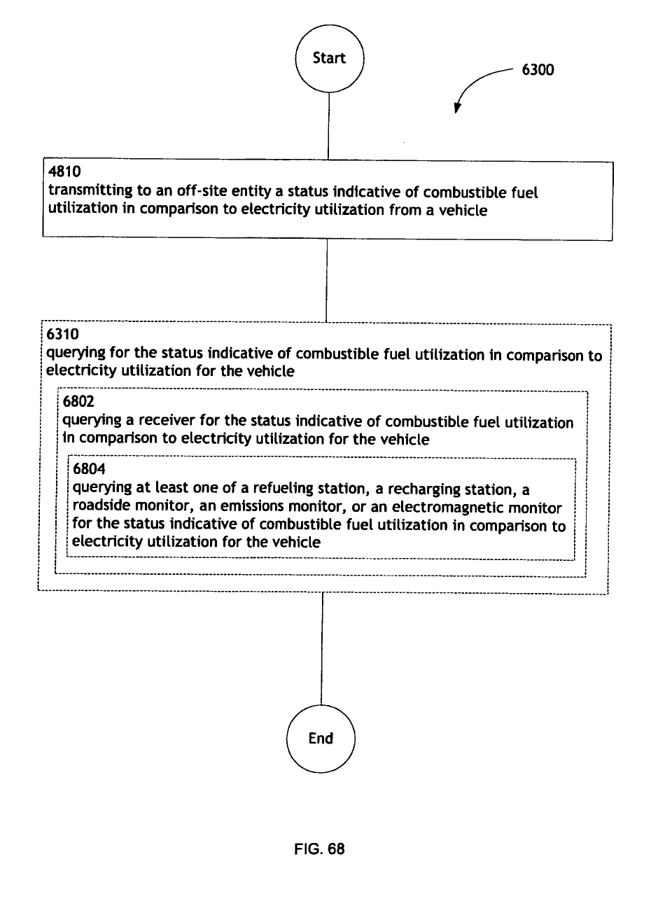

FIG. 68 illustrates alternative embodiments of the example operational flow 6300 of FIG. 63. FIG. 68 illustrates example embodiments where the operation 6310 may include at least one additional operation. Additional operations may include an operation 6802, and/or an operation 6804.

The operation 6802 illustrates querying a receiver for the status indicative of combustible fuel utilization in comparison to electricity utilization for the vehicle. For example, as shown in FIGS. 1 through 10, the status of the vehicle may be received by another entity, (i.e., an entity other than the off-site entity 144), such as a receiver 153. In an embodiment, the off-site entity 144 may query the receiver 153 for the status, which may be transmitted to the off-site entity 144 (e.g., via transmitter 151). Further, the operation 6804 illustrates querying at least one of a refueling station, a recharging station, a roadside monitor, an emissions monitor, or an electromagnetic monitor for the status indicative of combustible fuel utilization in comparison to electricity utilization for the vehicle. For example, as shown in FIGS. 1 through 10, the receiver 153 may comprise a refueling station (e.g., for refueling the vehicle 100 with combustible fuel) or a recharging station (e.g., for recharging one or more batteries included with the vehicle 100). The vehicle 100 may provide the refueling station with its status (e.g., via the connector 142, the physical media 166, or the like). The refueling station is queried by the off-site entity 144 and transmits the status obtained from the vehicle 100 to the off-site entity 144 (e.g., via the transmitter 151). Alternatively, the receiver 153 may be a monitor positioned proximal to a roadway, such as a roadside monitor, or the like. The roadside monitor may utilize a microphone, or a like device, to determine a noise output for the vehicle 100 as it drives along the roadway. The noise output of the vehicle 100 may be utilized to determine a status for the vehicle 100. The transmitter 151 may be utilized to transmit the status for the vehicle 100 to the off-site entity 144. In an embodiment, the receiver 153 may include an emissions monitor for determining a status for the vehicle 100 based upon a combustion-product (or byproduct) emission, which may be created as the vehicle 100 expends combustible fuel for propulsion. In another embodiment, the receiver 153 may include an electromagnetic monitor for determining a status for the vehicle 100 based upon an electromagnetic emission, such as an electromagnetic field created by a motor for propelling the vehicle 100 when utilizing one or more batteries. It will be appreciated that other monitors may be positioned proximal to a path of the vehicle 100 for determining the status of the vehicle 100.

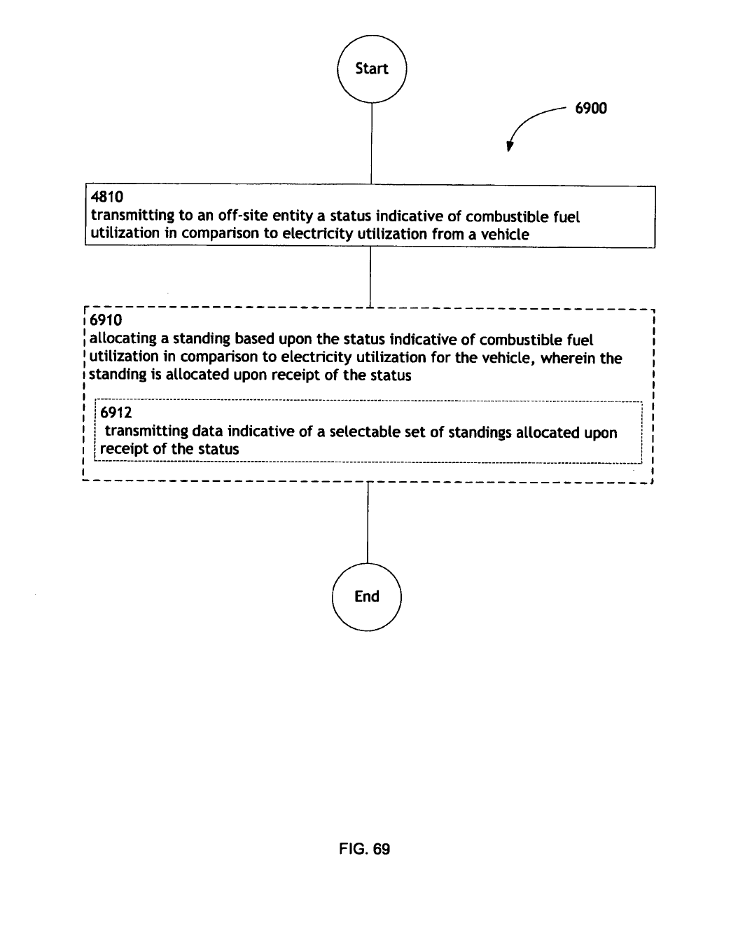

FIG. 69 illustrates an operational flow 6900 representing example operations related to transmitting to an off-site entity a status indicative of combustible fuel utilization in comparison to electricity utilization from a vehicle and allocating a standing based upon the status indicative of combustible fuel utilization in comparison to electricity utilization for the vehicle, wherein the standing is allocated upon receipt of the status. FIG. 69 illustrates an example embodiment where the example operational flow 4800 of FIG. 48 may include at least one additional operation. Additional operations may include an operation 6910, and/or an operation 6912.

After a start operation and an operation 4810, the operational flow 6900 moves to an operation 6910. Operation 6910 illustrates allocating a standing based upon the status indicative of combustible fuel utilization in comparison to electricity utilization for the vehicle, wherein the standing is allocated upon receipt of the status. For example, as shown in FIGS. 1 through 10, the standing may be allocated by the off-site entity 144 upon receipt of the status of the vehicle 100. In an embodiment, the off-site entity 144 may include a road authority, or the like.

The operation 6912 illustrates transmitting data indicative of a selectable set of standings allocated upon receipt of the status. For example, as shown in FIGS. 1 through 10, the off-site entity 144 may allocate more than one standing (e.g., a selectable set of standings) to the vehicle 100. For example, in an embodiment, the driver of the vehicle 100 may be presented with a selection of standings from which to choose. After choosing one or more of the standings, the unselected standings may be saved, transferred, eliminated, or even exchanged for another set of one or more standings.

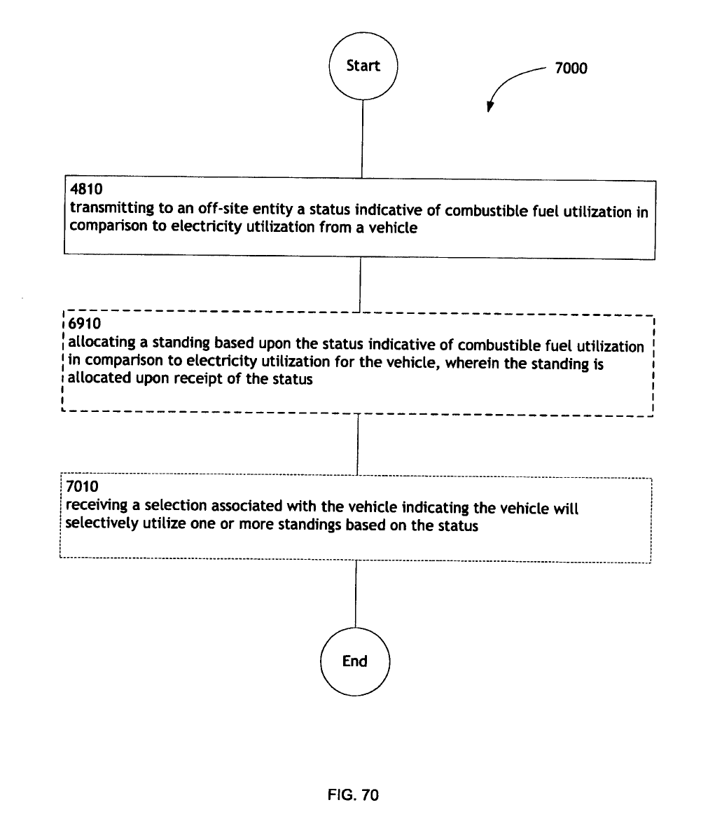

FIG. 70 illustrates an operational flow 7000 representing example operations related to transmitting to an off-site entity a status indicative of combustible fuel utilization in comparison to electricity utilization from a vehicle, allocating a standing based upon the status for the vehicle, and receiving a selection associated with the vehicle. FIG. 70 illustrates an example embodiment where the example operational flow 4800 of FIG. 48 may include at least one additional operation. Additional operations may include an operation 7010.

After a start operation, an operation 4810, and an operation 6910, the operational flow 7000 moves to an operation 7010. Operation 7010 illustrates receiving a selection associated with the vehicle indicating the vehicle will selectively utilize one or more standings based on the status. For example, as shown in FIGS. 1 through 10, the operator of the vehicle 100 may utilize the selection module 208 to selectively utilize one or more standings. The selection of the one or more standings may be transmitted to the off-site entity 144 via the transmitter 120.

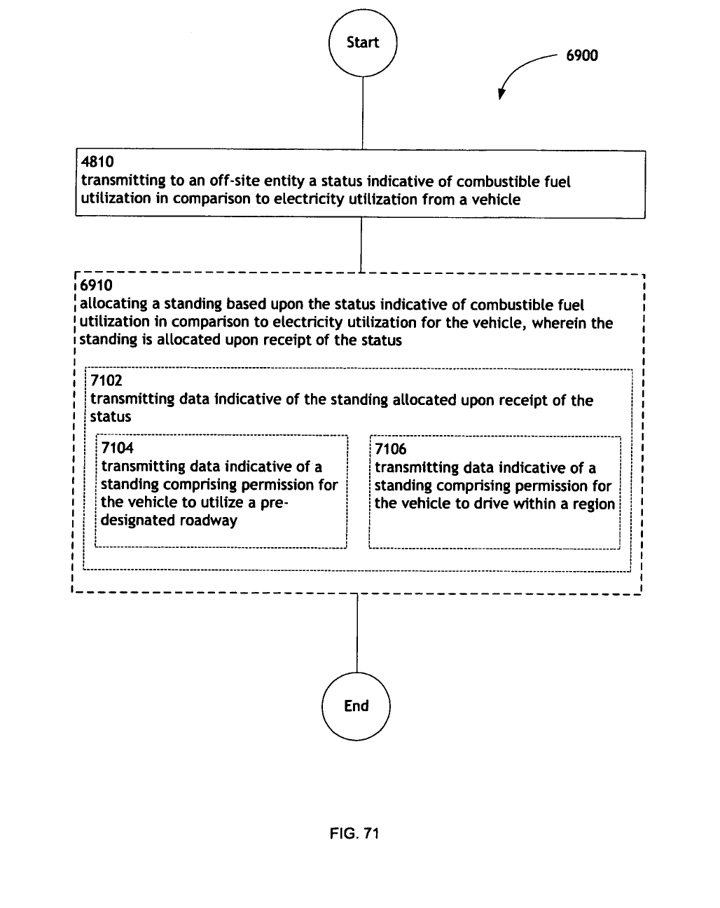

FIG. 71 illustrates alternative embodiments of the example operational flow 6900 of FIG. 69. FIG. 71 illustrates example embodiments where the operation 6910 may include at least one additional operation. Additional operations may include an operation 7102, an operation 7104, and/or an operation 7106.

The operation 7102 illustrates transmitting data indicative of the standing allocated upon receipt of the status. For example, as shown in FIGS. 1 through 10, the off-site entity 144 may transmit data indicative of the standing of the vehicle 100 upon receipt of the vehicle's status. For example, propelling the vehicle 100 with electricity (e.g., by utilizing batteries 114) may be rewarded by the allocation of a privilege to the vehicle 100. In an embodiment, data indicative of the standing of the vehicle may include a message, a set of characters, a code, a numerical designation, or a variety of other information which may be meaningfully interpreted by the driver or an occupant of the vehicle 100, or by the display 220 (or associated hardware or software) for presentation to the driver or an occupant. Further, the operation 7104 illustrates transmitting data indicative of a standing comprising permission for the vehicle to utilize a pre-designated roadway. For example, as shown in FIGS. 1 through 10, the standing may comprise a privilege such as permission for the vehicle 100 to utilize the pre-designated roadway 210. Further, the operation 7106 illustrates transmitting data indicative of a standing comprising permission for the vehicle to drive within a region. For example, as shown in FIGS. 1 through 10, the standing may comprise a privilege such as permission for the vehicle 100 to drive within the region 212.

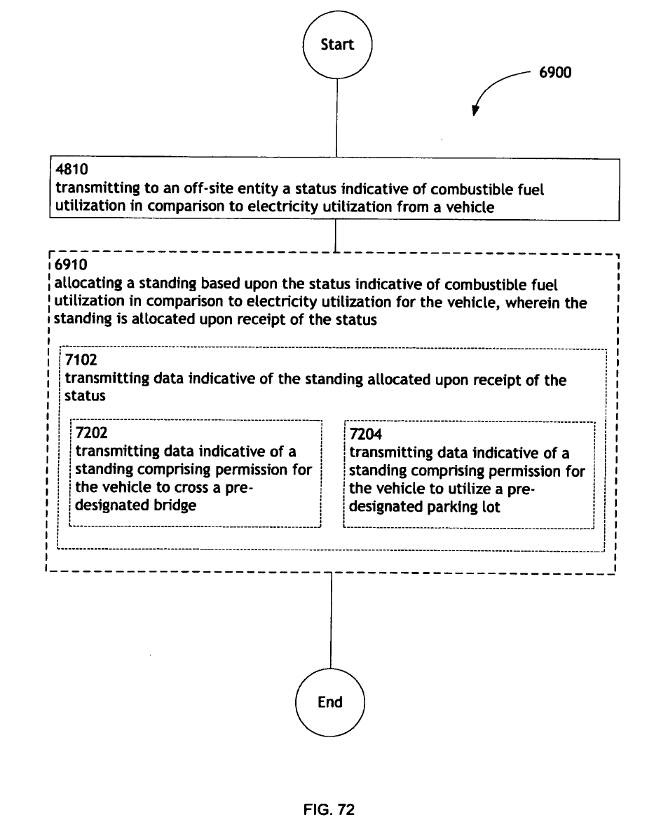

FIG. 72 illustrates alternative embodiments of the example operational flow 6900 of FIG. 69. FIG. 72 illustrates example embodiments where the operation 6910 may include at least one additional operation. Additional operations may include an operation 7202, and/or an operation 7204. Further, the operation 7202 illustrates transmitting data indicative of a standing comprising permission for the vehicle to cross a pre-designated bridge. For example, as shown in FIGS. 1 through 10, the standing may comprise a privilege such as permission for the vehicle 100 to cross the pre-designated bridge 214. Further, the operation 7204 illustrates transmitting data indicative of a standing comprising permission for the vehicle to utilize a pre-designated parking lot. For example, as shown in FIGS. 1 through 10, the standing may comprise a privilege such as permission for the vehicle 100 to utilize the pre-designated parking lot 216.

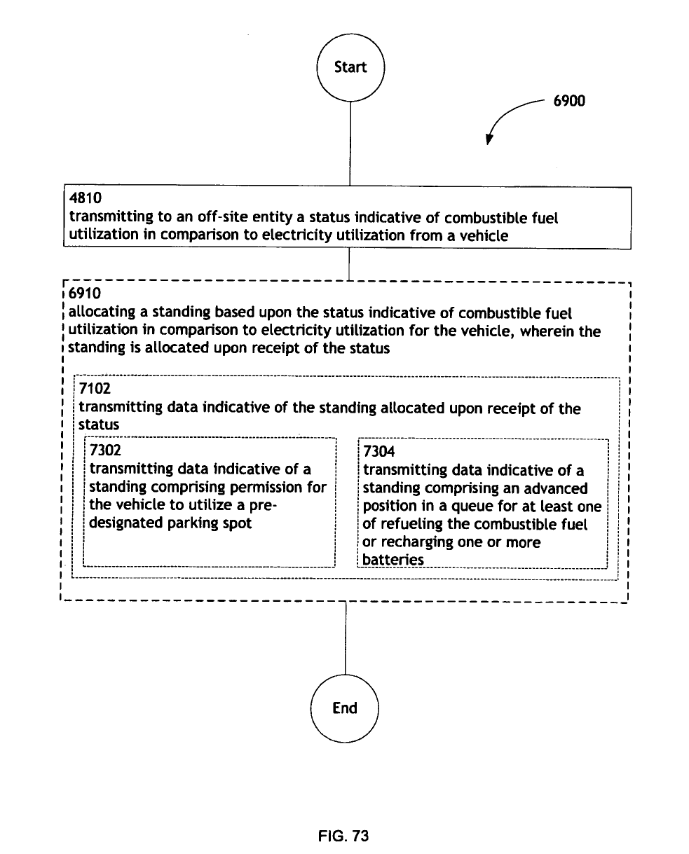

FIG. 73 illustrates alternative embodiments of the example operational flow 6900 of FIG. 69. FIG. 73 illustrates example embodiments where the operation 6910 may include at least one additional operation. Additional operations may include an operation 7302, and/or an operation 7304. Further, the operation 7302 illustrates transmitting data indicative of a standing comprising permission for the vehicle to utilize a pre-designated parking spot. For example, as shown in FIGS. 1 through 10, the standing may comprise a privilege such as permission for the vehicle 100 to utilize the pre-designated parking spot 218. Further, the operation 7304 illustrates transmitting data indicative of a standing comprising an advanced position in a queue for at least one of refueling the combustible fuel or recharging one or more batteries. For example, as shown in FIGS. 1 through 10, the standing may comprise a privilege such as an advanced position in a queue for the vehicle 100 to recharge one or more batteries.

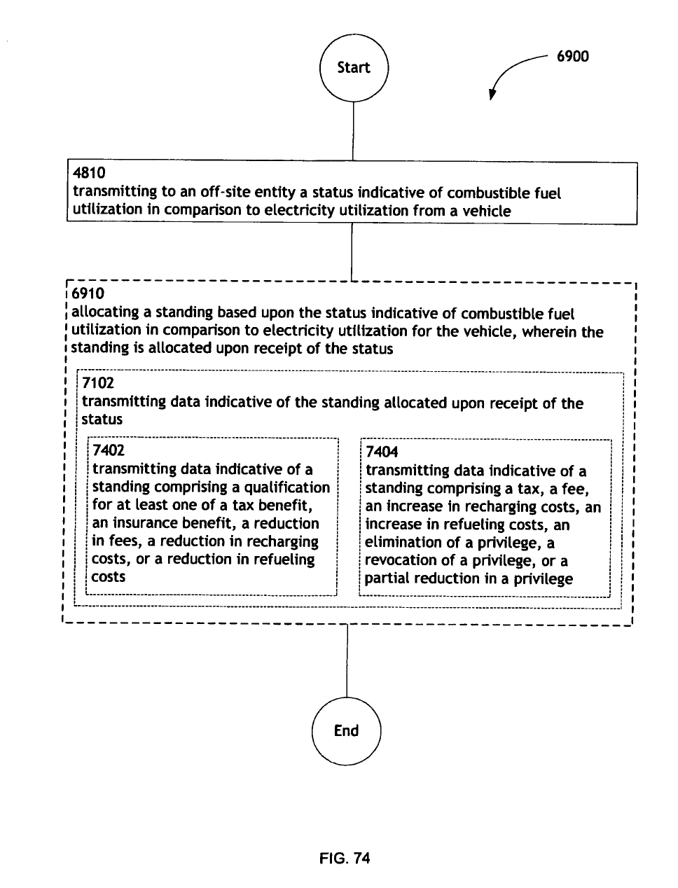

FIG. 74 illustrates alternative embodiments of the example operational flow 6900 of FIG. 69. FIG. 74 illustrates example embodiments where the operation 6910 may include at least one additional operation. Additional operations may include an operation 7402, and/or an operation 7404. Further, the operation 7402 illustrates transmitting data indicative of a standing comprising a qualification for at least one of a tax benefit, an insurance benefit, a reduction in fees, a reduction in recharging costs, or a reduction in refueling costs. For example, as shown in FIGS. 1 through 10, the standing may comprise a privilege such as a qualification for the driver of the vehicle 100 to receive a reduction in fueling costs. Further, the operation 7404 illustrates transmitting data indicative of a standing comprising a tax, a fee, an increase in recharging costs, an increase in refueling costs, an elimination of a privilege, a revocation of a privilege, or a partial reduction in a privilege. For example, as shown in FIGS. 1 through 10, the standing may comprise a penalty, such as the elimination of a privilege. For example, in an embodiment, the elimination of a privilege may include not being able to utilize the pre-designated parking lot 216.

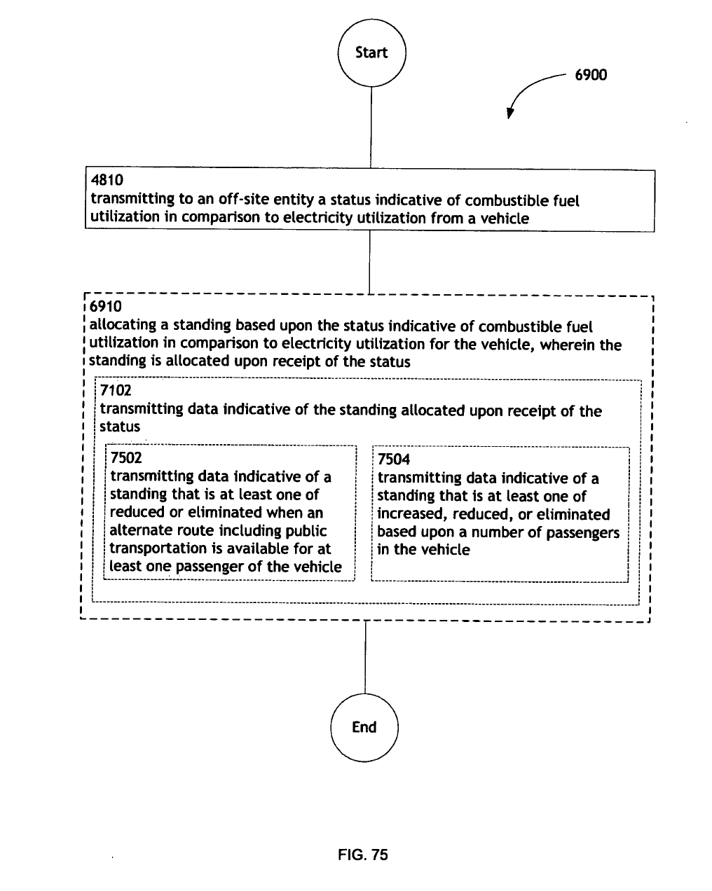

FIG. 75 illustrates alternative embodiments of the example operational flow 6900 of FIG. 69. FIG. 75 illustrates example embodiments where the operation 6910 may include at least one additional operation. Additional operations may include an operation 7502, and/or an operation 7504. Further, the operation 7502 illustrates transmitting data indicative of a standing that is at least one of reduced or eliminated when an alternate route including public transportation is available for at least one passenger of the vehicle. For example, as shown in FIGS. 1 through 10, the standing of the vehicle 100 may be reduced or eliminated when an alternate route including public transportation was available for a driver or a passenger of the vehicle 100. Further, the operation 7504 illustrates transmitting data indicative of a standing that is at least one of increased, reduced, or eliminated based upon a number of passengers in the vehicle. For example, as shown in FIGS. 1 through 10, the standing of the vehicle 100 may be eliminated based upon a number of passengers in the vehicle 100, such as only the driver.

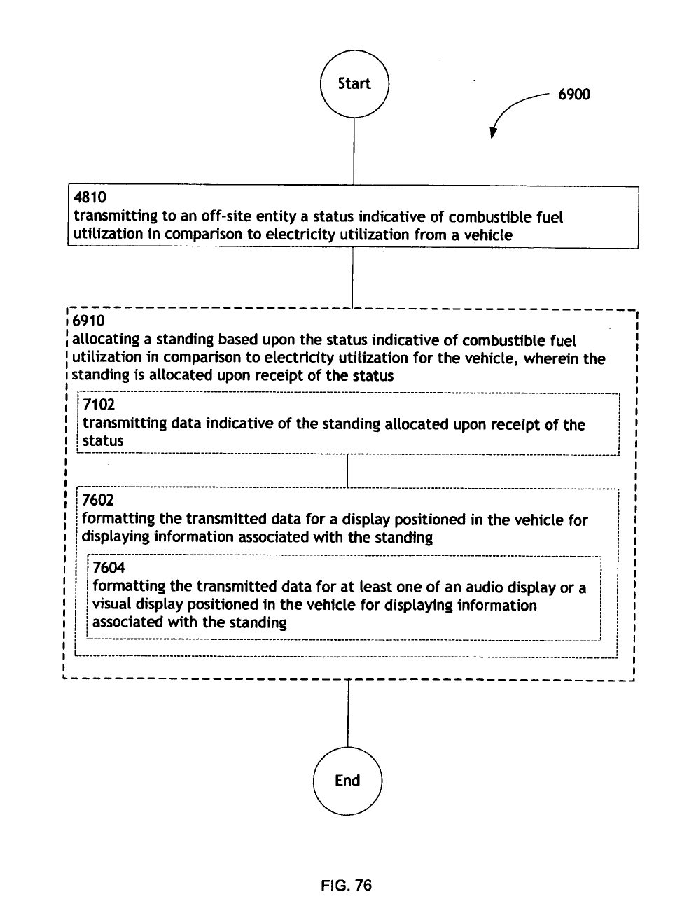

FIG. 76 illustrates alternative embodiments of the example operational flow 6900 of FIG. 69. FIG. 76 illustrates example embodiments where the operation 6910 may include at least one additional operation. Additional operations may include an operation 7602, and/or an operation 7604. Further, the operation 7602 illustrates formatting the transmitted data for a display positioned in the vehicle for displaying information associated with the standing. For example, as shown in FIGS. 1 through 10, the standing of the vehicle 100 may be transmitted to the vehicle 100 and formatted for the display 220. Further, the operation 7604 illustrates formatting the transmitted data for at least one of an audio display or a visual display positioned in the vehicle for displaying information associated with the standing. For example, as shown in FIGS. 1 through 10, the standing of the vehicle 100 may be transmitted to the vehicle 100 and formatted for a visual display, such as encoded with graphical picture element (pixel) information.

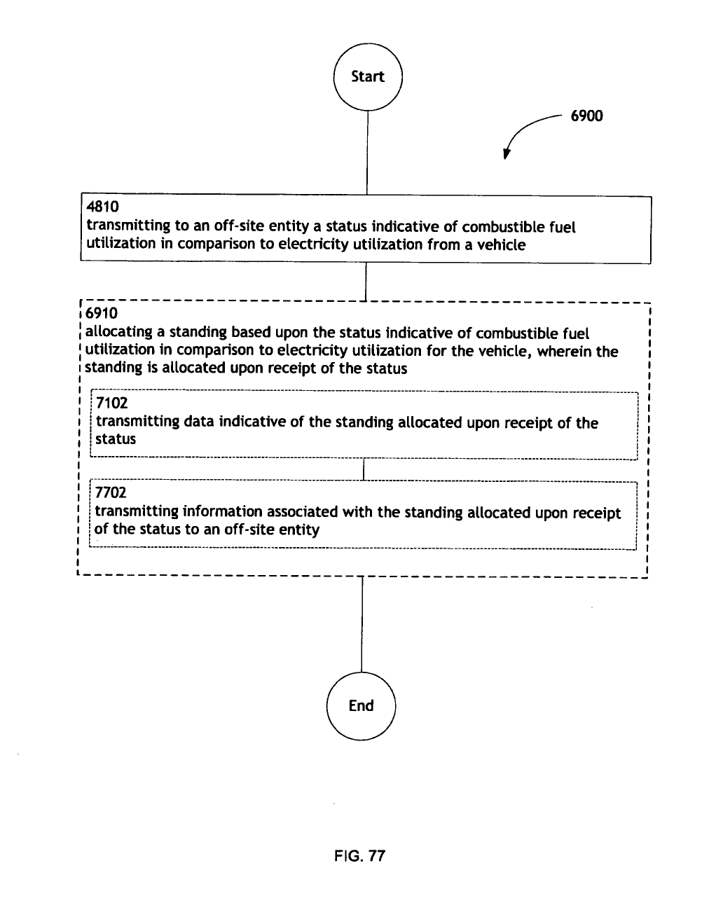

FIG. 77 illustrates alternative embodiments of the example operational flow 6900 of FIG. 69. FIG. 77 illustrates example embodiments where the operation 6910 may include at least one additional operation. Additional operations may include an operation 7702. Further, the operation 7702 illustrates transmitting information associated with the standing allocated upon receipt of the status to an off-site entity. For example, as shown in FIGS. 1 through 10, the standing allocated to the vehicle 100 may be transmitted to the receiver 153. The receiver 153 may then forward the standing to the vehicle 100. Further, the receiver 153 may include a database for storing the standing. In an embodiment, the receiver 153 may include one or more of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, or a memory card for storing information associated with the standing for the vehicle 100.

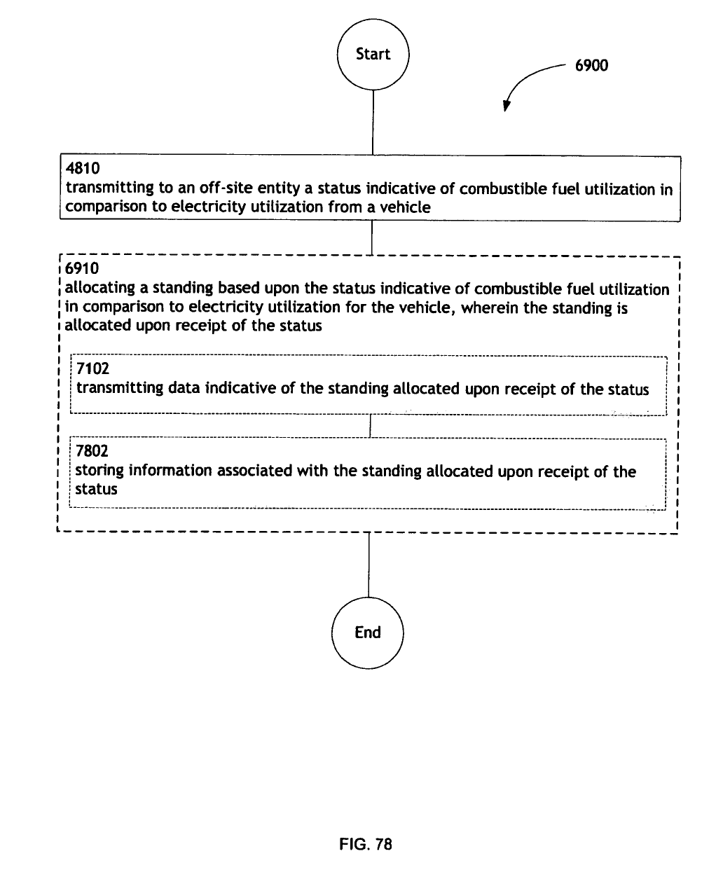

FIG. 78 illustrates alternative embodiments of the example operational flow 6900 of FIG. 69. FIG. 78 illustrates example embodiments where the operation 6910 may include at least one additional operation. Additional operations may include an operation 7802. Further, the operation 7802 illustrates storing information associated with the standing allocated upon receipt of the status. For example, as shown in FIGS. 1 through 10, the off-site entity 144 may store information associated with the standing for the vehicle 100. In one embodiment, the off-site entity 144 may store the information associated with the standing in storage 155 (e.g., a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, or a memory card). Further, the off-site entity 144 may store the information in storage 155 in an encrypted format (e.g., utilizing a public-key/private-key encryption scheme or the like).

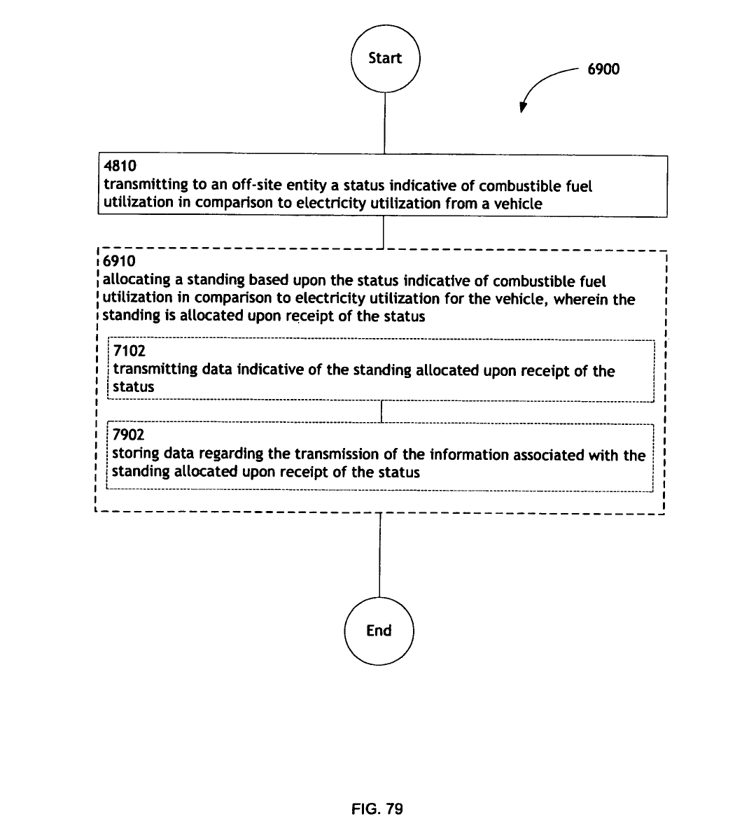

FIG. 79 illustrates alternative embodiments of the example operational flow 6900 of FIG. 69. FIG. 79 illustrates example embodiments where the operation 6910 may include at least one additional operation. Additional operations may include an operation 7902. Further, the operation 7902 illustrates storing data regarding the transmission of the information associated with the standing allocated upon receipt of the status. For example, as shown in FIGS. 1 through 10, the off-site entity 144 may store data regarding the transmission of the information associated with the standing for the vehicle 100. In one embodiment, the off-site entity 144 may store the information associated with the standing in storage 155, as previously described. Further, the off-site entity 144 may store the data in storage 155 in an encrypted format (e.g., utilizing a public-key/private-key encryption scheme or the like).

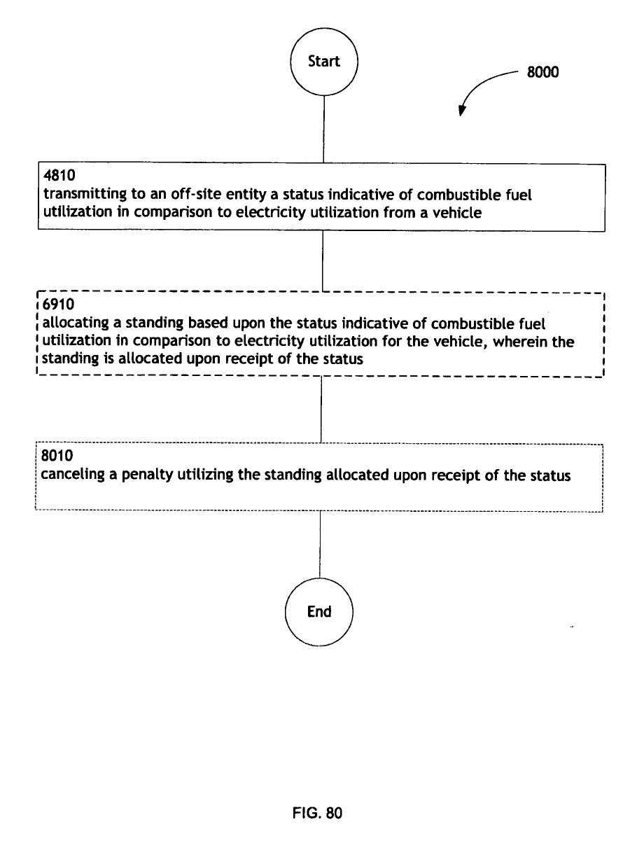

FIG. 80 illustrates an operational flow 8000 representing example operations related to transmitting to an off-site entity a status indicative of combustible fuel utilization in comparison to electricity utilization from a vehicle, allocating a standing based upon the status for the vehicle, and canceling a penalty utilizing the standing. FIG. 80 illustrates an example embodiment where the example operational flow 4800 of FIG. 48 may include at least one additional operation. Additional operations may include an operation 8010.

After a start operation, an operation 4810, and an operation 6910, the operational flow 8000 moves to an operation 8010. Operation 8010 illustrates canceling a penalty utilizing the standing allocated upon receipt of the status. For example, as shown in FIGS. 1 through 10, the standing allocated by the off-site entity 144 upon receipt of the status for the vehicle 100 may be utilized to cancel a penalty. For example, a standing including permission to utilize a pre-designated roadway may be utilized instead to cancel a tax levied against the vehicle 100 as a penalty.

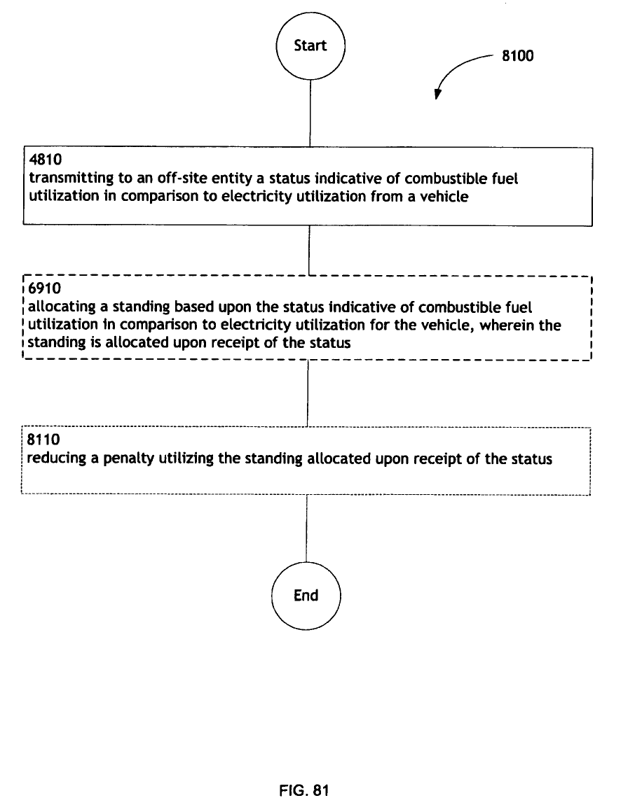

FIG. 81 illustrates an operational flow 8100 representing example operations related to transmitting to an off-site entity a status indicative of combustible fuel utilization in comparison to electricity utilization from a vehicle, allocating a standing based upon the status for the vehicle, and reducing a penalty utilizing the standing. FIG. 81 illustrates an example embodiment where the example operational flow 4800 of FIG. 48 may include at least one additional operation. Additional operations may include an operation 8110.

After a start operation, an operation 4810, and an operation 6910, the operational flow 8100 moves to an operation 8110. Operation 8110 illustrates reducing a penalty utilizing the standing allocated upon receipt of the status. For example, as shown in FIGS. 1 through 10, the standing allocated by the off-site entity 144 upon receipt of the status for the vehicle 100 may be utilized to reduce a penalty. For example, a standing including permission to utilize a pre-designated parking spot may be utilized instead to reduce a tax levied against the vehicle 100 as a penalty.

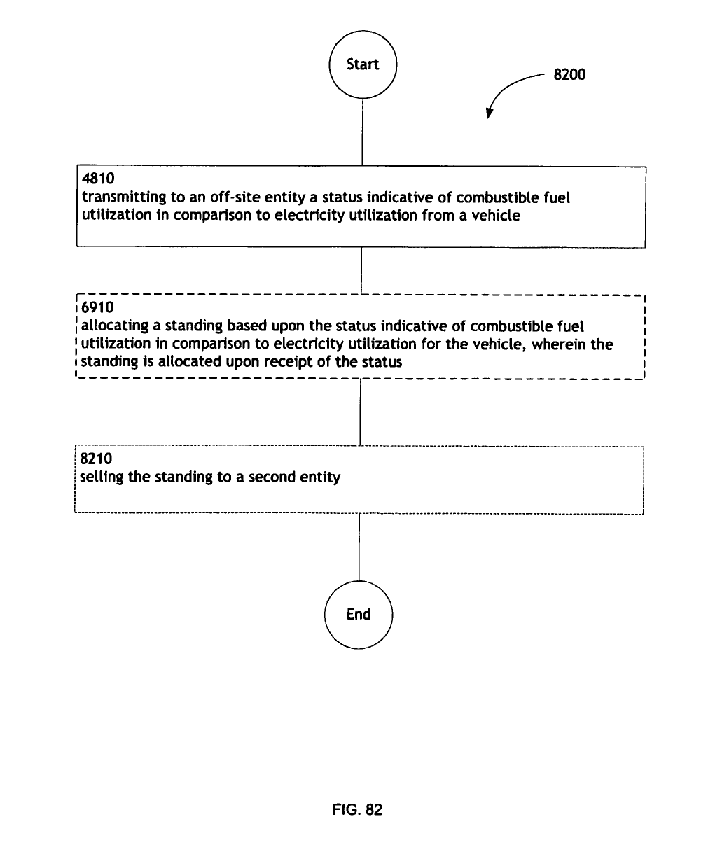

FIG. 82 illustrates an operational flow 8200 representing example operations related to transmitting to an off-site entity a status indicative of combustible fuel utilization in comparison to electricity utilization from a vehicle, allocating a standing based upon the status for the vehicle, and selling the standing to a second entity. FIG. 82 illustrates an example embodiment where the example operational flow 4800 of FIG. 48 may include at least one additional operation. Additional operations may include an operation 8210.

After a start operation, an operation 4810, and an operation 6910, the operational flow 8200 moves to an operation 8210. Operation 8210 illustrates selling the standing to a second entity. For example, as shown in FIGS. 1 through 10, the standing may be sold to another vehicle. Alternatively, the standing may be sold to an individual. For example, the driver may purchase the standing for transfer to another vehicle. Further, the standing may be sold to an authority, such as a local government, a state government, or a federal government.

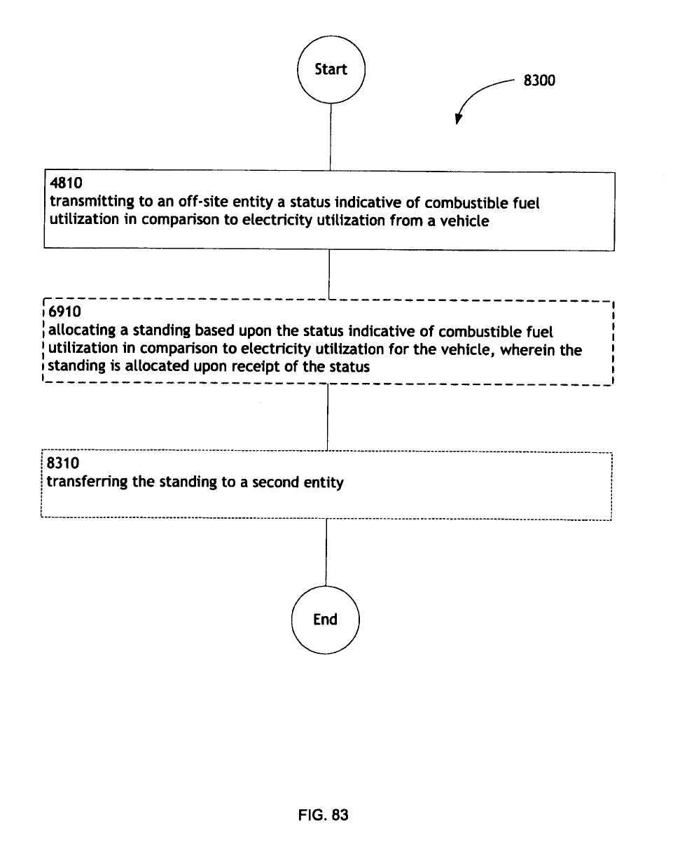

FIG. 83 illustrates an operational flow 8300 representing example operations related to transmitting to an off-site entity a status indicative of combustible fuel utilization in comparison to electricity utilization from a vehicle, allocating a standing based upon the status for the vehicle, and transferring the standing to a second entity. FIG. 83 illustrates an example embodiment where the example operational flow 4800 of FIG. 48 may include at least one additional operation. Additional operations may include an operation 8310.

After a start operation, an operation 4810, and an operation 6910, the operational flow 8300 moves to an operation 8310. Operation 8310 illustrates transferring the standing to a second entity. For example, as shown in FIGS. 1 through 10, the standing may be transferred to another vehicle. Alternatively, the standing may be transferred to an individual. For example, the driver may acquire the standing for transfer to another vehicle. Further, the standing may be transferred to an authority, such as a local government, a state government, or a federal government.

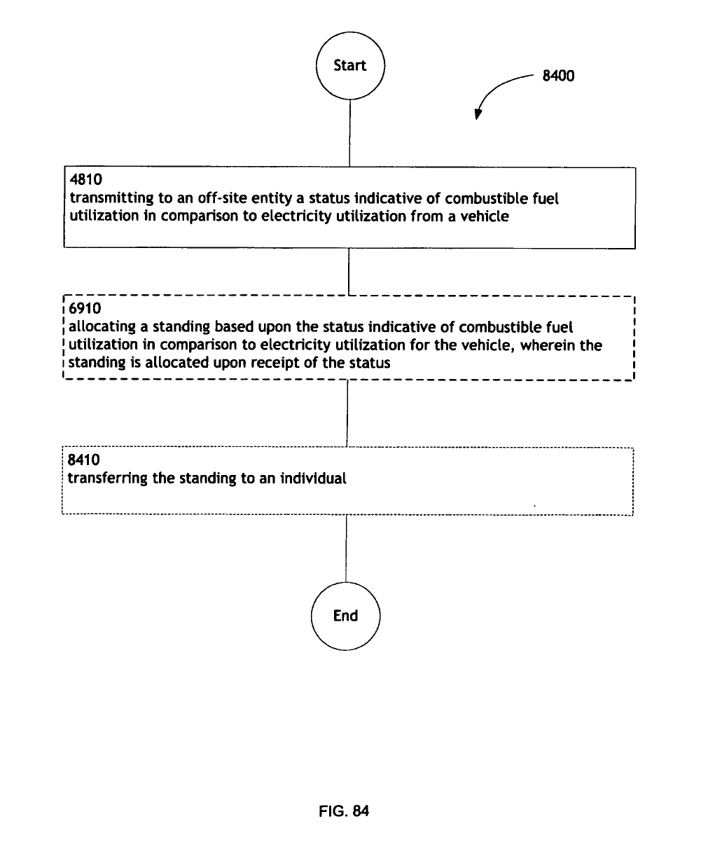

FIG. 84 illustrates an operational flow 8400 representing example operations related to transmitting to an off-site entity a status indicative of combustible fuel utilization in comparison to electricity utilization from a vehicle, allocating a standing based upon the status for the vehicle, and transferring the standing to an individual. FIG. 84 illustrates an example embodiment where the example operational flow 4800 of FIG. 48 may include at least one additional operation. Additional operations may include an operation 8410.

After a start operation, an operation 4810, and an operation 6910, the operational flow 8400 moves to an operation 8410. Operation 8410 illustrates transferring the standing to an individual. For example, as shown in FIGS. 1 through 10, the standing allocated by the off-site entity 144 upon receipt of the status for the vehicle 100 may be transferred to an individual. For example, a standing associated with the vehicle 100 may be transferred to the driver of the vehicle or one or more occupants thereof.

Further, the standing may be dependent upon at least one of a driver of the vehicle, an occupant of the vehicle, an identification for the vehicle, a time of day, a driving history for the vehicle, a history of standings for the vehicle, a number of standings accumulated for the vehicle, a user selection from a list of acceptable standings, an expiration of a standing, a time period during which a standing is valid, or a geographical region in which a standing is valid. In an embodiment, the standing allocated by the off-site entity 144 upon receipt of the status for the vehicle 100 may be dependent upon the driver of the vehicle. For example, the standing may include permission to utilize a pre-designated parking spot in a parking lot proximal to a place of employment for the driver of the vehicle 100.

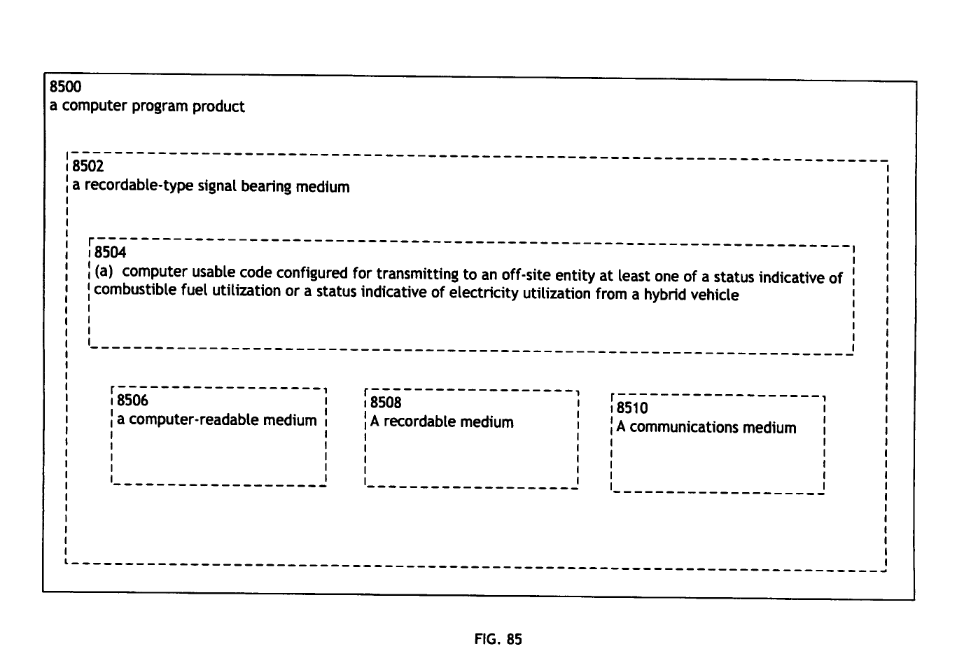

FIG. 85 illustrates a partial view of an example computer program product 8500 that includes a computer program 8504 for executing a computer process on a computing device. An embodiment of the example computer program product 8500 is provided using a recordable-type signal bearing medium 8502, and may include computer usable code configured for transmitting to an off-site entity at least one of a status indicative of combustible fuel utilization or a status indicative of electricity utilization from a hybrid vehicle. The computer usable code may be, for example, computer executable and/or logic-implemented instructions. In one implementation, the signal-bearing medium 8502 may include a computer-readable medium 8506. In one implementation, the signal bearing medium 8502 may include a recordable medium 8508. In one implementation, the signal bearing medium 8502 may include a communications medium 8510. In an embodiment, allocating the standing based upon the at least one of the status indicative of combustible fuel utilization or the status indicative of electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

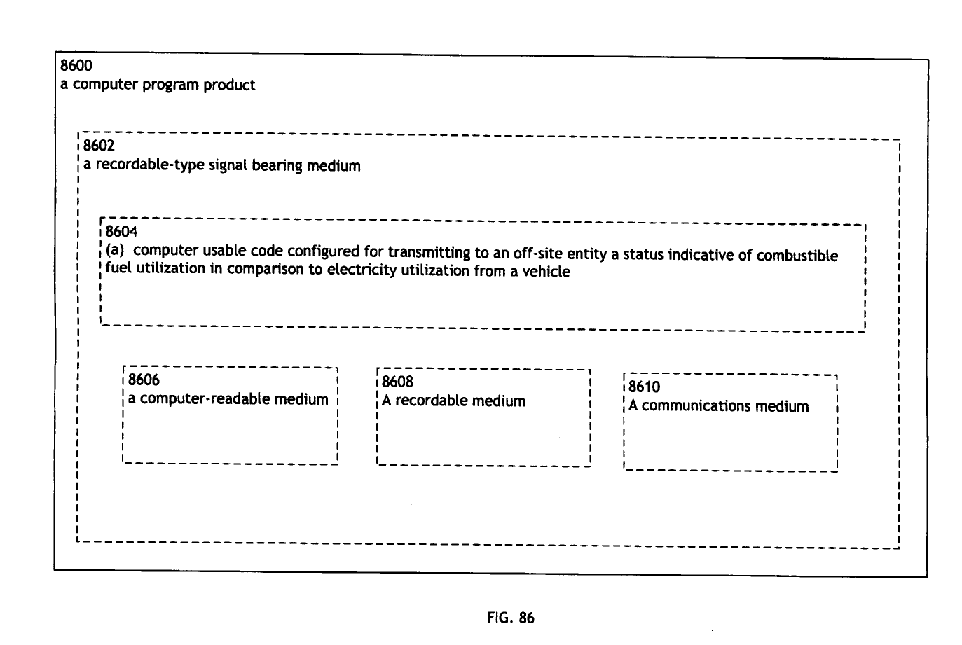

FIG. 86 illustrates a partial view of an example computer program product 8600 that includes a computer program 8604 for executing a computer process on a computing device. An embodiment of the example computer program product 8600 is provided using a recordable-type signal bearing medium 8602, and may include computer usable code configured for transmitting to an off-site entity a status indicative of combustible fuel utilization in comparison to electricity utilization from a vehicle. The computer usable code may be, for example, computer executable and/or logic-implemented instructions. In one implementation, the signal-bearing medium 8602 may include a computer-readable medium 8606. In one implementation, the signal bearing medium 8602 may include a recordable medium 8608. In one implementation, the signal bearing medium 8602 may include a communications medium 8610. In an embodiment, allocating the standing based upon the status indicative of combustible fuel utilization in comparison to electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

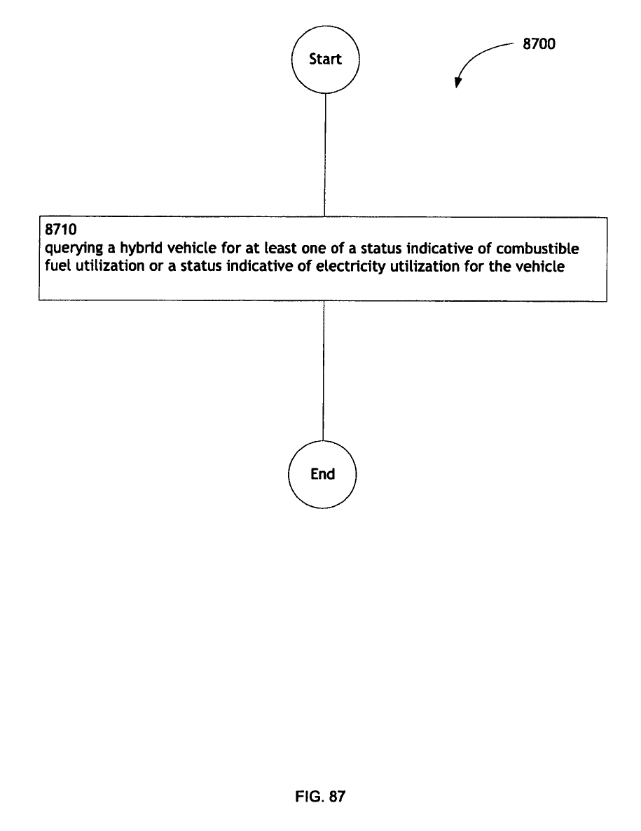

FIG. 87 illustrates an operational flow 8700 representing example operations related to querying a hybrid vehicle for at least one of a status indicative of combustible fuel utilization or a status indicative of electricity utilization for the vehicle. In FIG. 87 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 8700 moves to an operation 8710. Operation 8710 depicts querying a hybrid vehicle for at least one of a status indicative of combustible fuel utilization or a status indicative of electricity utilization for the vehicle. For example, as shown in FIGS. 1 through 10, the road authority may query the vehicle 100 for its status.

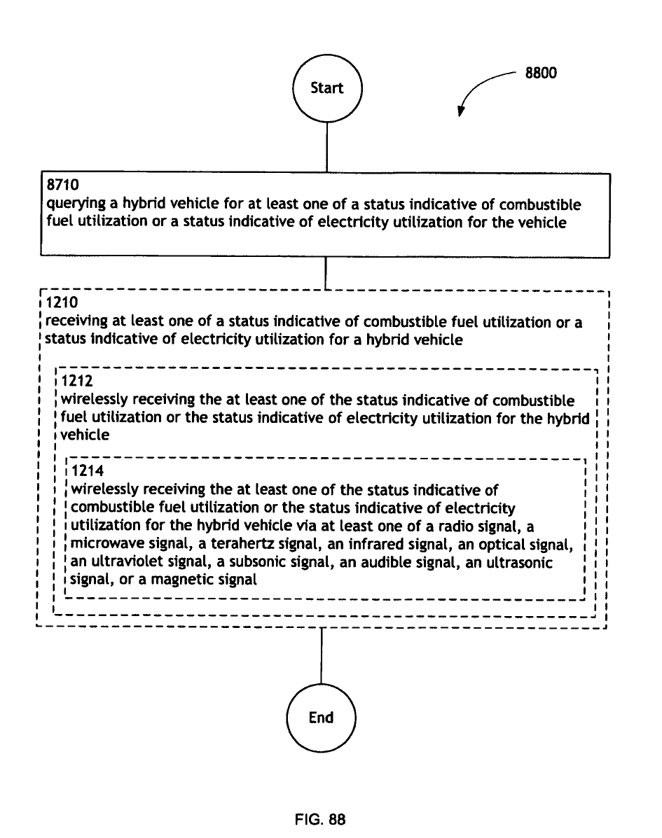

FIG. 88 illustrates an operational flow 8800 representing example operations related to querying a hybrid vehicle for at least one of a status indicative of combustible fuel utilization or a status indicative of electricity utilization for the vehicle and receiving at least one of a status indicative of combustible fuel utilization or a status indicative of electricity utilization for a hybrid vehicle. FIG. 88 illustrates an example embodiment where the example operational flow 8700 of FIG. 87 may include at least one additional operation. Additional operations may include an operation 1210, an operation 1212, and/or an operation 1214.

After a start operation and an operation 8710, the operational flow 8800 moves to an operation 1210. Operation 1210 illustrates receiving at least one of a status indicative of combustible fuel utilization or a status indicative of electricity utilization for a hybrid vehicle.

The operation 1212 illustrates wirelessly receiving the at least one of the status indicative of combustible fuel utilization or the status indicative of electricity utilization for the hybrid vehicle. Further, the operation 1214 illustrates wirelessly receiving the at least one of the status indicative of combustible fuel utilization or the status indicative of electricity utilization for the hybrid vehicle via at least one of a radio signal, a microwave signal, a terahertz signal, an infrared signal, an optical signal, an ultraviolet signal, a subsonic signal, an audible signal, an ultrasonic signal, or a magnetic signal.

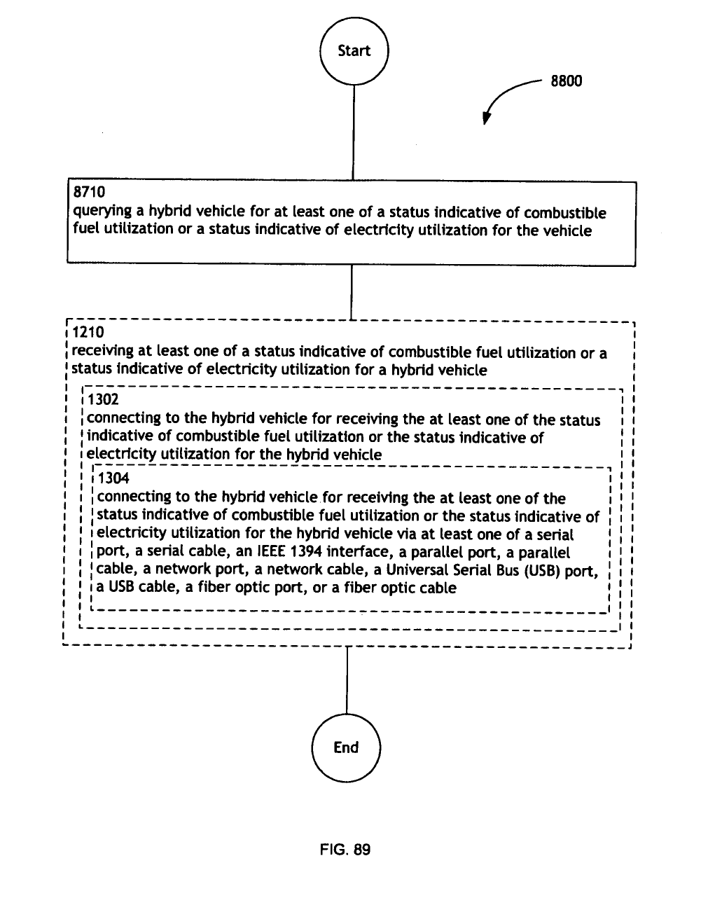

FIG. 89 illustrates alternative embodiments of the example operational flow 8800 of FIG. 88. FIG. 89 illustrates example embodiments where the operation 1210 may include at least one additional operation. Additional operations may include an operation 1302, and/or an operation 1304.

The operation 1302 illustrates connecting to the hybrid vehicle for receiving the at least one of the status indicative of combustible fuel utilization or the status indicative of electricity utilization for the hybrid vehicle. Further, the operation 1304 illustrates connecting to the hybrid vehicle for receiving the at least one of the status indicative of combustible fuel utilization or the status indicative of electricity utilization for the hybrid vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

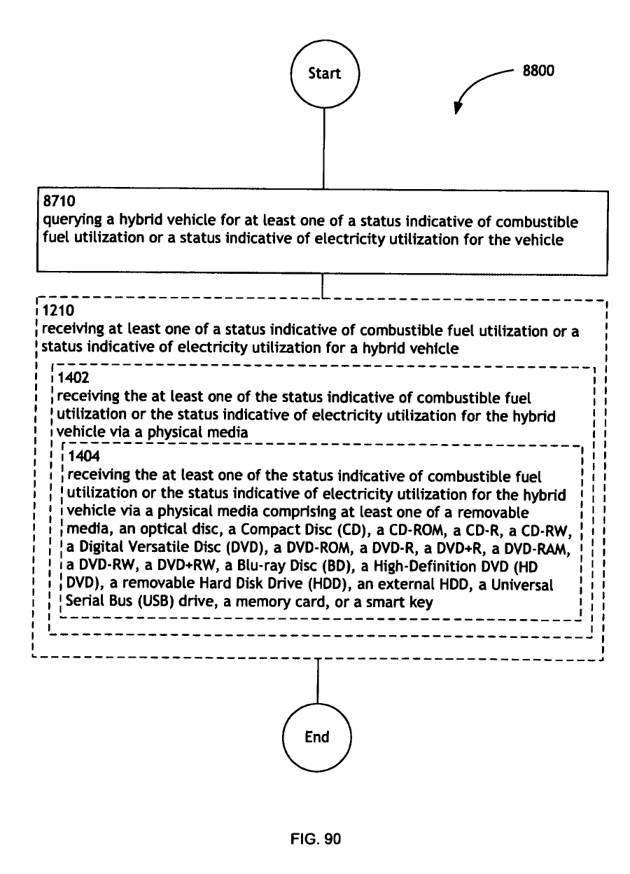

FIG. 90 illustrates alternative embodiments of the example operational flow 8800 of FIG. 88. FIG. 90 illustrates example embodiments where the operation 1210 may include at least one additional operation. Additional operations may include an operation 1402, and/or an operation 1404.

The operation 1402 illustrates receiving the at least one of the status indicative of combustible fuel utilization or the status indicative of electricity utilization for the hybrid vehicle via a physical media. Further, the operation 1404 illustrates receiving the at least one of the status indicative of combustible fuel utilization or the status indicative of electricity utilization for the hybrid vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

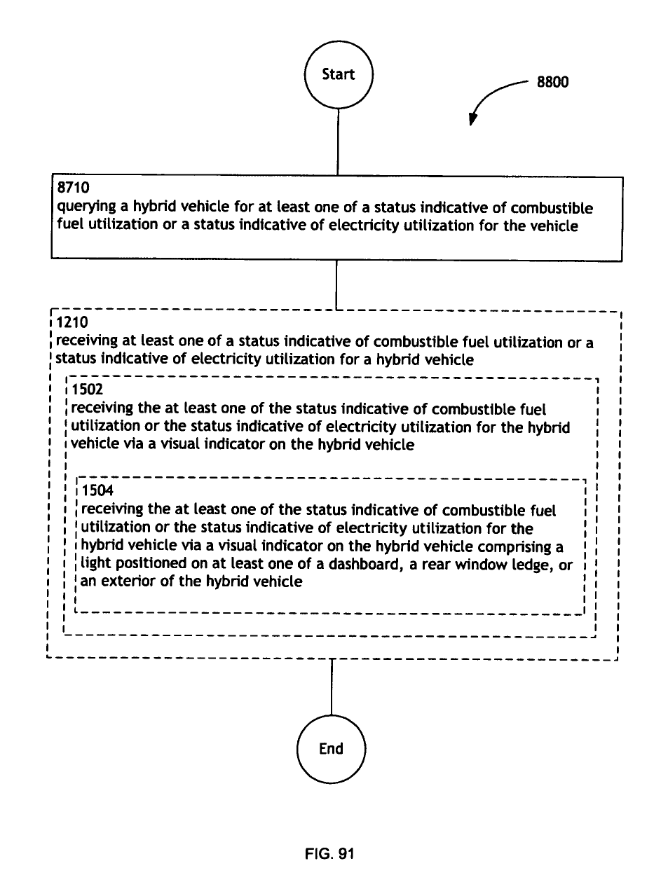

FIG. 91 illustrates alternative embodiments of the example operational flow 8800 of FIG. 88. FIG. 91 illustrates example embodiments where the operation 1210 may include at least one additional operation. Additional operations may include an operation 1502, and/or an operation 1504.

The operation 1502 illustrates receiving the at least one of the status indicative of combustible fuel utilization or the status indicative of electricity utilization for the hybrid vehicle via a visual indicator on the hybrid vehicle. Further, the operation 1504 illustrates receiving the at least one of the status indicative of combustible fuel utilization or the status indicative of electricity utilization for the hybrid vehicle via a visual indicator on the hybrid vehicle comprising a light positioned on at least one of a dashboard, a rear window ledge, or an exterior of the hybrid vehicle.

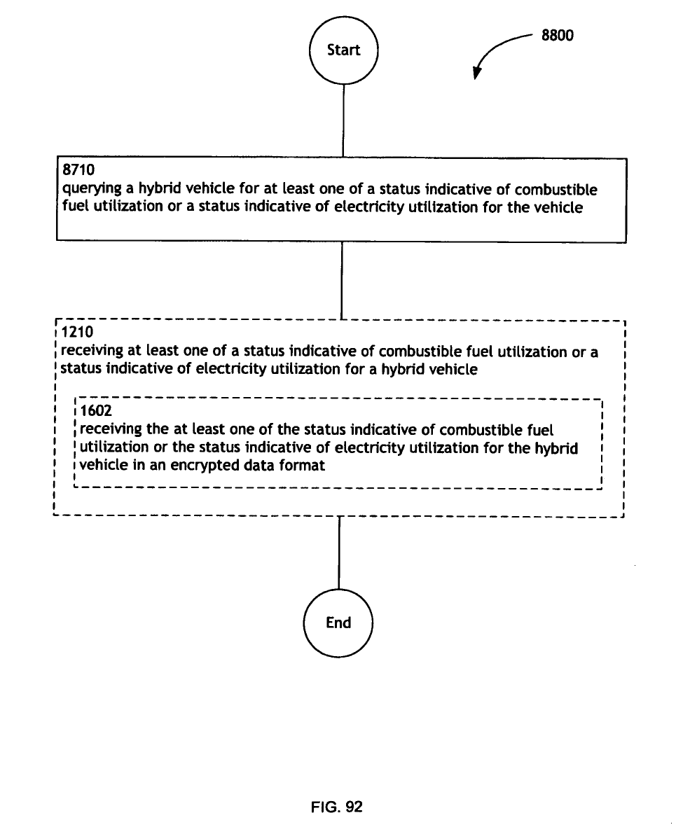

FIG. 92 illustrates alternative embodiments of the example operational flow 8800 of FIG. 88. FIG. 92 illustrates example embodiments where the operation 1210 may include at least one additional operation. Additional operations may include an operation 1602.

The operation 1602 illustrates receiving the at least one of the status indicative of combustible fuel utilization or the status indicative of electricity utilization for the hybrid vehicle in an encrypted data format.

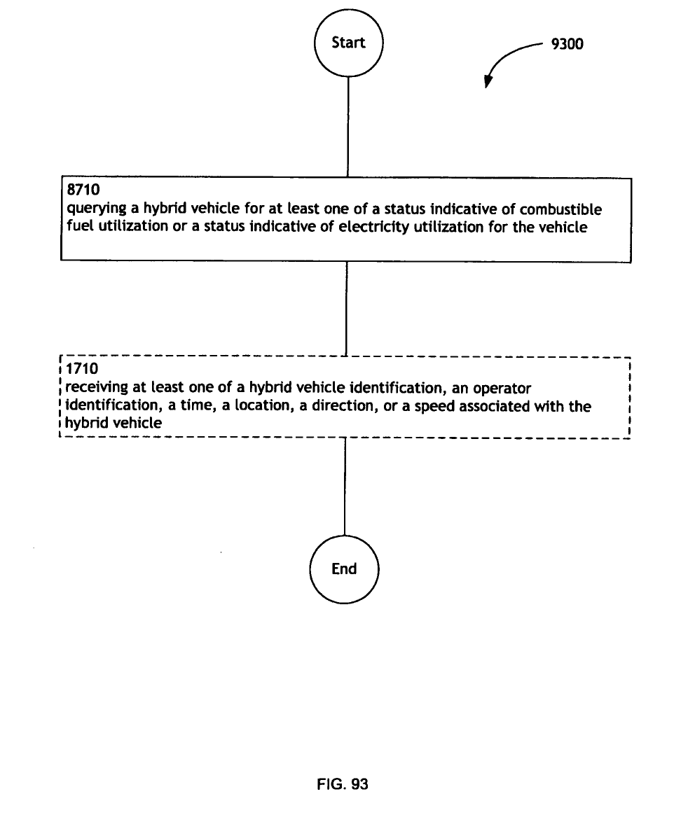

FIG. 93 illustrates an operational flow 9300 representing example operations related to querying a hybrid vehicle for at least one of a status indicative of combustible fuel utilization or a status indicative of electricity utilization for the vehicle and receiving at least one of a hybrid vehicle identification, an operator identification, a time, a location, a direction, or a speed associated with the hybrid vehicle. FIG. 93 illustrates an example embodiment where the example operational flow 8700 of FIG. 87 may include at least one additional operation. Additional operations may include an operation 1710.

After a start operation and an operation 8710, the operational flow 9300 moves to an operation 1710. Operation 1710 illustrates receiving at least one of a hybrid vehicle identification, an operator identification, a time, a location, a direction, or a speed associated with the hybrid vehicle.

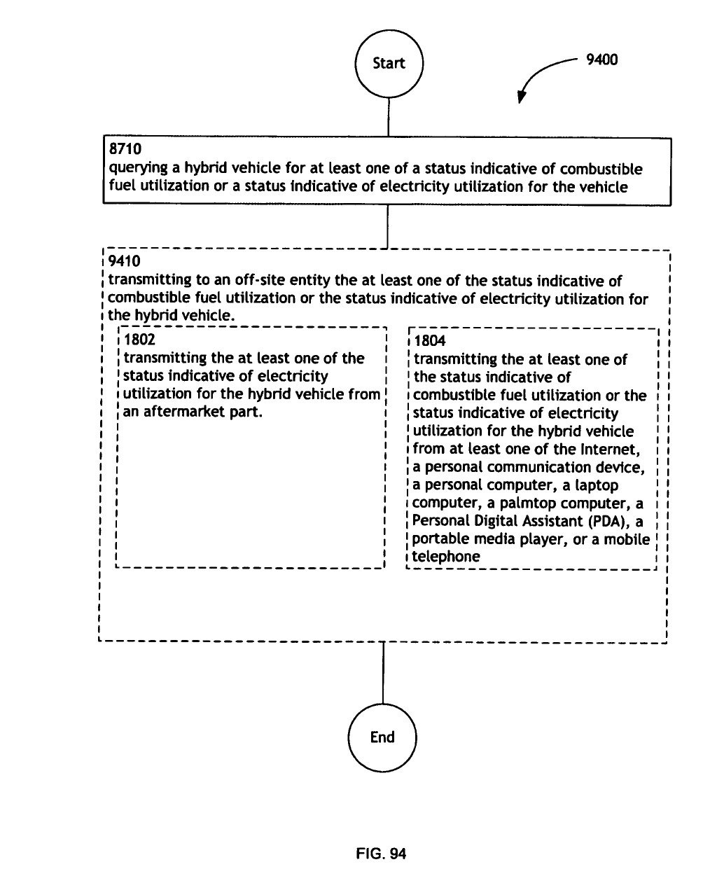

FIG. 94 illustrates an operational flow 9400 representing example operations related to querying a hybrid vehicle for at least one of a status indicative of combustible fuel utilization or a status indicative of electricity utilization for the vehicle and transmitting to an off-site entity the at least one of the status indicative of combustible fuel utilization or the status indicative of electricity utilization for the hybrid vehicle. FIG. 94 illustrates an example embodiment where the example operational flow 8700 of FIG. 87 may include at least one additional operation. Additional operations may include an operation 9410, an operation 1802, and/or an operation 1804.

After a start operation and an operation 8710, the operational flow 9400 moves to an operation 9410. Operation 9410 illustrates transmitting to an off-site entity the at least one of the status indicative of combustible fuel utilization or the status indicative of electricity utilization for the hybrid vehicle. For example, as shown in FIGS. 1 through 10, the vehicle 100 may transmit (e.g., utilizing the transmitter 120) a status indicative of, for example, one or more of combustible fuel utilization and electricity utilization for the vehicle 100. In an embodiment, the off-site entity 144 may receive the status transmitted by the vehicle 100.

The operation 1802 illustrates transmitting the at least one of the status indicative of combustible fuel utilization or the status indicative of electricity utilization for the hybrid vehicle from an aftermarket part.

The operation 1804 illustrates transmitting the at least one of the status indicative of combustible fuel utilization or the status indicative of electricity utilization for the hybrid vehicle from at least one of the Internet, a personal communication device, a personal computer, a laptop computer, a palmtop computer, a Personal Digital Assistant (PDA), a portable media player, or a mobile telephone.

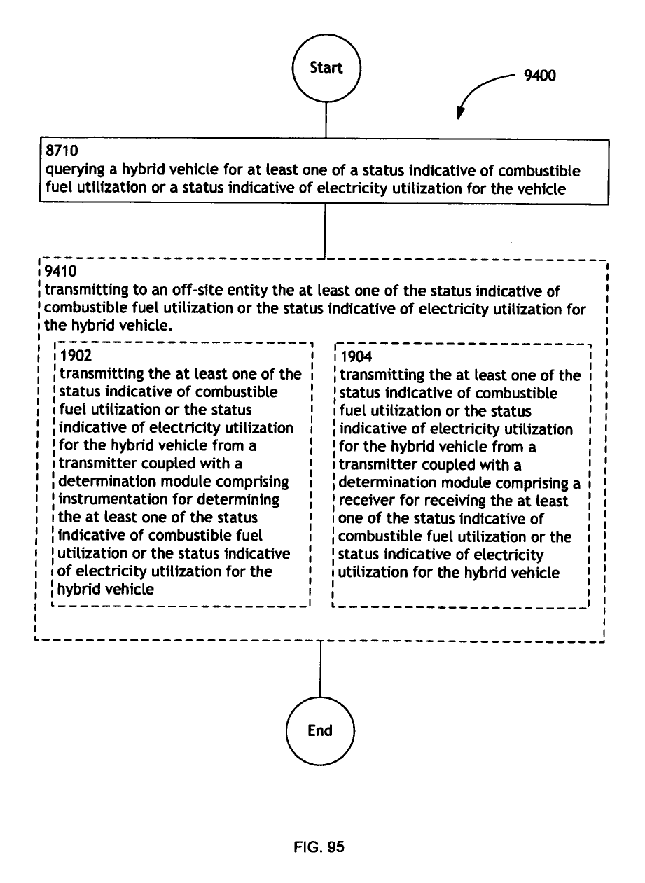

FIG. 95 illustrates alternative embodiments of the example operational flow 9400 of FIG. 94. FIG. 95 illustrates example embodiments where the operation 9410 may include at least one additional operation. Additional operations may include an operation 1902, and/or an operation 1904.

The operation 1902 illustrates transmitting the at least one of the status indicative of combustible fuel utilization or the status indicative of electricity utilization for the hybrid vehicle from a transmitter coupled with a determination module comprising instrumentation for determining the at least one of the status indicative of combustible fuel utilization or the status indicative of electricity utilization for the hybrid vehicle.

The operation 1904 illustrates transmitting the at least one of the status indicative of combustible fuel utilization or the status indicative of electricity utilization for the hybrid vehicle from a transmitter coupled with a determination module comprising a receiver for receiving the at least one of the status indicative of combustible fuel utilization or the status indicative of electricity utilization for the hybrid vehicle.

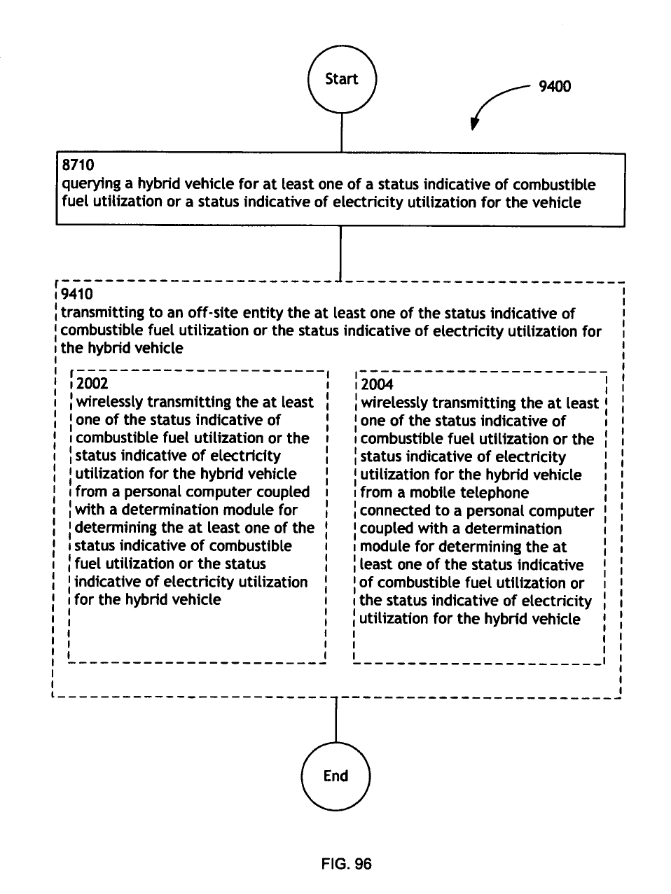

FIG. 96 illustrates alternative embodiments of the example operational flow 9400 of FIG. 94. FIG. 96 illustrates example embodiments where the operation 9410 may include at least one additional operation. Additional operations may include an operation 2002, and/or an operation 2004.

The operation 2002 illustrates wirelessly transmitting the at least one of the status indicative of combustible fuel utilization or the status indicative of electricity utilization for the hybrid vehicle from a personal computer coupled with a determination module for determining the at least one of the status indicative of combustible fuel utilization or the status indicative of electricity utilization for the hybrid vehicle.

The operation 2004 illustrates wirelessly transmitting the at least one of the status indicative of combustible fuel utilization or the status indicative of electricity utilization for the hybrid vehicle from a mobile telephone connected to a personal computer coupled with a determination module for determining the at least one of the status indicative of combustible fuel utilization or the status indicative of electricity utilization for the hybrid vehicle.

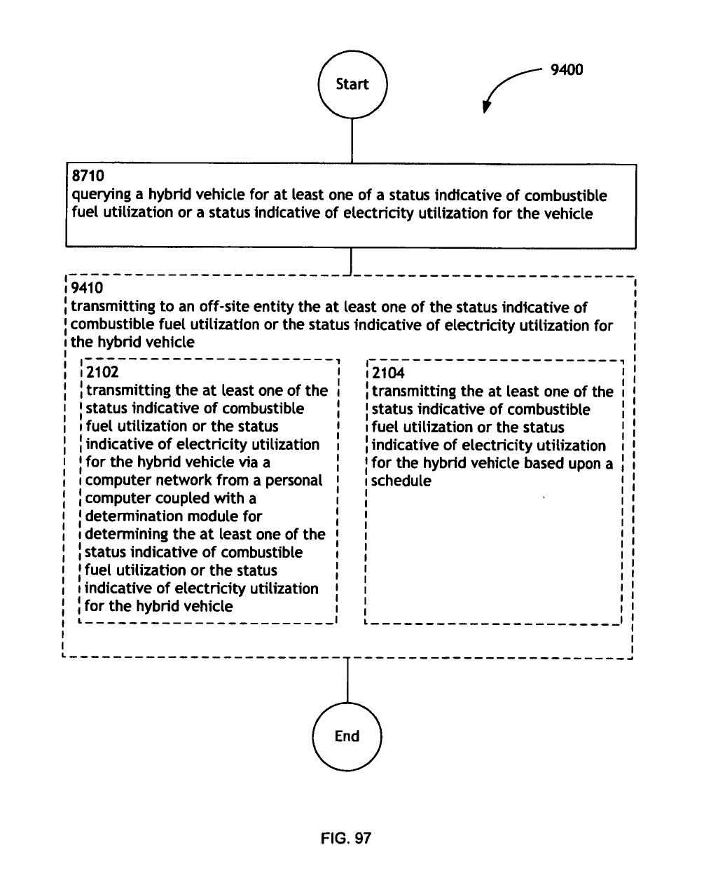

FIG. 97 illustrates alternative embodiments of the example operational flow 9400 of FIG. 94. FIG. 97 illustrates example embodiments where the operation 9410 may include at least one additional operation. Additional operations may include an operation 2102, and/or an operation 2104.

The operation 2102 illustrates transmitting the at least one of the status indicative of combustible fuel utilization or the status indicative of electricity utilization for the hybrid vehicle via a computer network from a personal computer coupled with a determination module for determining the at least one of the status indicative of combustible fuel utilization or the status indicative of electricity utilization for the hybrid vehicle.

The operation 2104 illustrates transmitting the at least one of the status indicative of combustible fuel utilization or the status indicative of electricity utilization for the hybrid vehicle based upon a schedule.

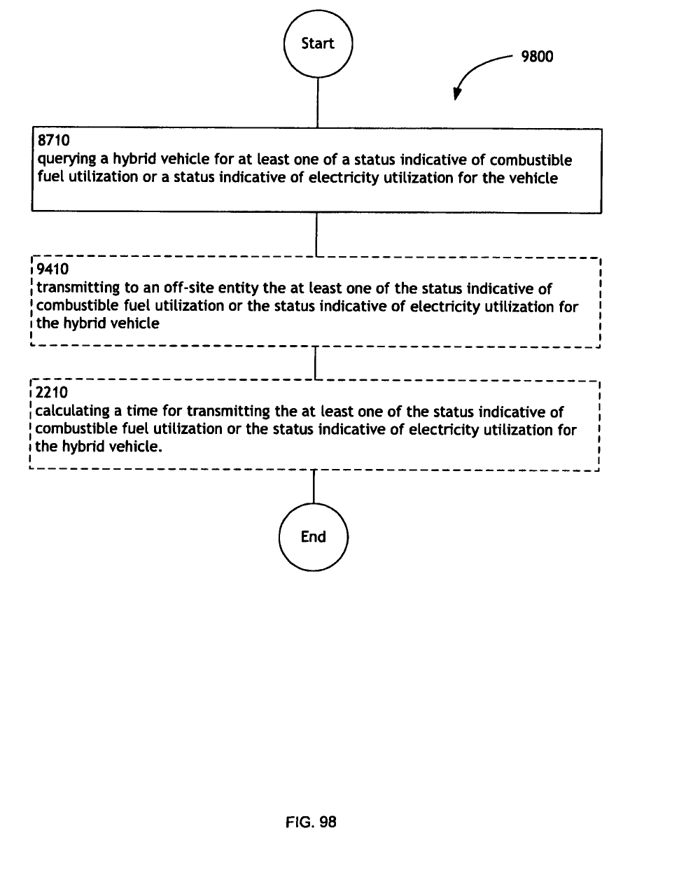

FIG. 98 illustrates an operational flow 9800 representing example operations related to querying a hybrid vehicle for at least one of a status indicative of combustible fuel utilization or a status indicative of electricity utilization for the vehicle, transmitting to an off-site entity the at least one of the status indicative of combustible fuel utilization or the status indicative of electricity utilization for the hybrid vehicle, and calculating a time for transmitting the status. FIG. 98 illustrates an example embodiment where the example operational flow 9400 of FIG. 94 may include at least one additional operation. Additional operations may include an operation 2210.

After a start operation, an operation 8710, and an operation 9410, the operational flow 2200 moves to an operation 2210. Operation 2210 illustrates calculating a time for transmitting the at least one of the status indicative of combustible fuel utilization or the status indicative of electricity utilization for the hybrid vehicle.

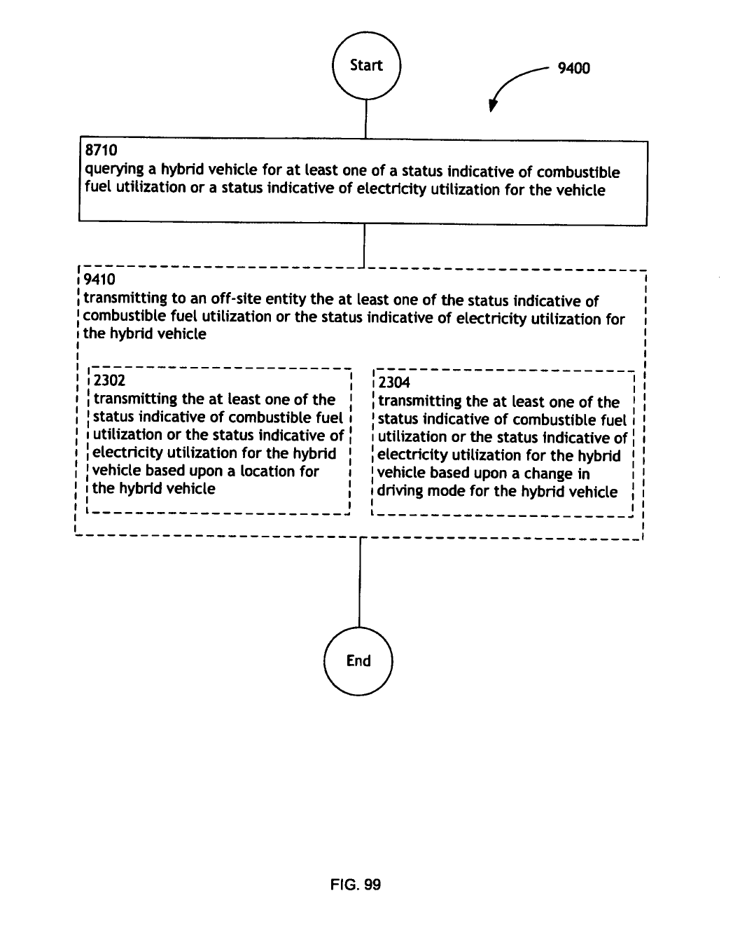

FIG. 99 illustrates alternative embodiments of the example operational flow 9400 of FIG. 94. FIG. 99 illustrates example embodiments where the operation 9410 may include at least one additional operation. Additional operations may include an operation 2302, and/or an operation 2304.

The operation 2302 illustrates transmitting the at least one of the status indicative of combustible fuel utilization or the status indicative of electricity utilization for the hybrid vehicle based upon a location for the hybrid vehicle.

The operation 2304 illustrates transmitting the at least one of the status indicative of combustible fuel utilization or the status indicative of electricity utilization for the hybrid vehicle based upon a change in driving mode for the hybrid vehicle.

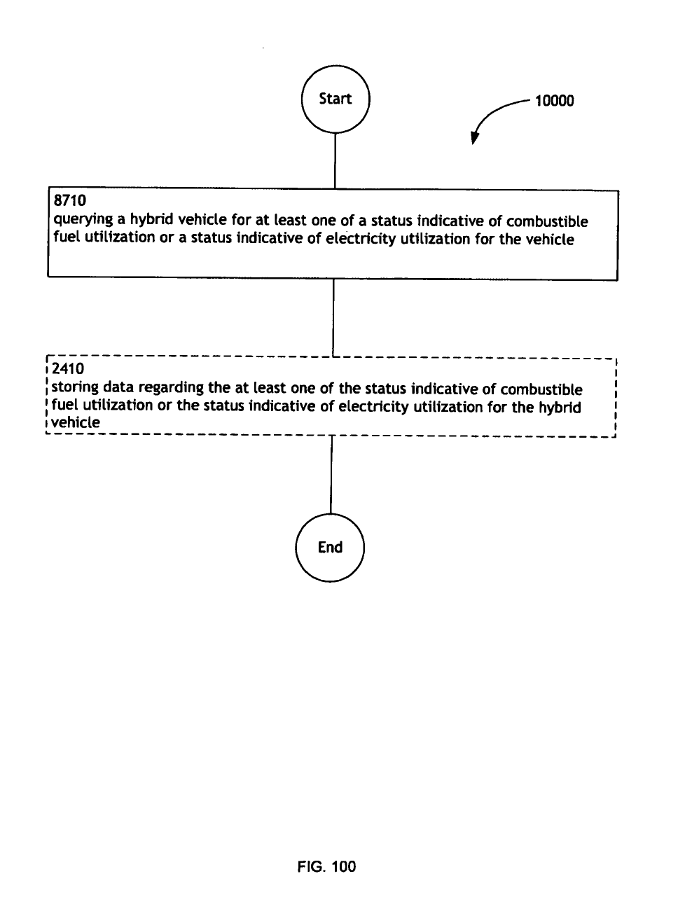

FIG. 100 illustrates an operational flow 10000 representing example operations related to querying a hybrid vehicle for at least one of a status indicative of combustible fuel utilization or a status indicative of electricity utilization for the vehicle and storing data regarding the status. FIG. 100 illustrates an example embodiment where the example operational flow 8700 of FIG. 87 may include at least one additional operation. Additional operations may include an operation 2410.

After a start operation and an operation 8710, the operational flow 10000 moves to an operation 2410. Operation 2410 illustrates storing data regarding the at least one of the status indicative of combustible fuel utilization or the status indicative of electricity utilization for the hybrid vehicle.

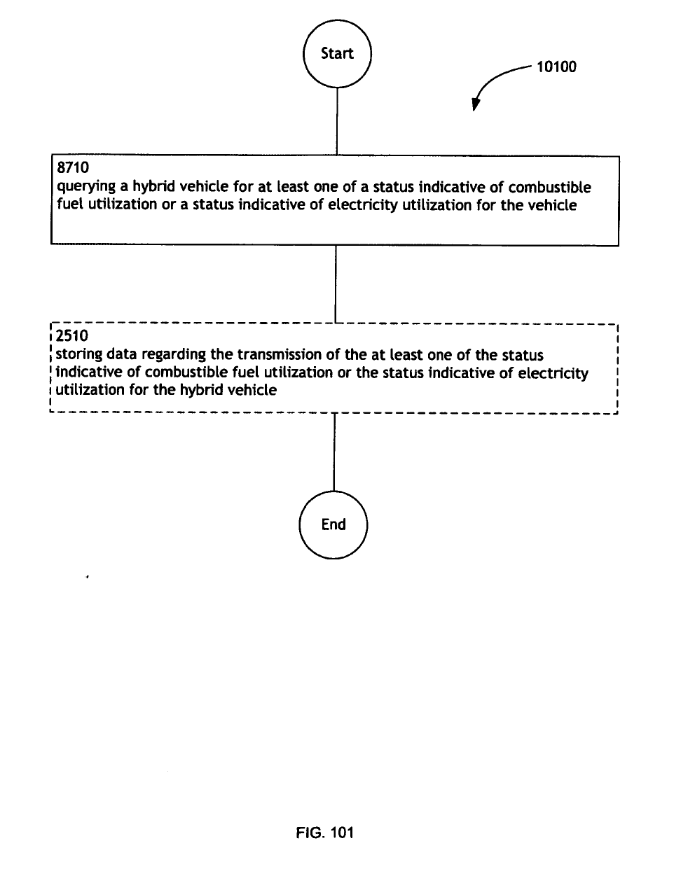

FIG. 101 illustrates an operational flow 10100 representing example operations related to querying a hybrid vehicle for at least one of a status indicative of combustible fuel utilization or a status indicative of electricity utilization for the vehicle and storing data regarding the transmission of the status. FIG. 101 illustrates an example embodiment where the example operational flow 8700 of FIG. 87 may include at least one additional operation. Additional operations may include an operation 2510.

After a start operation and an operation 8710, the operational flow 10100 moves to an operation 2510. Operation 2510 illustrates storing data regarding the transmission of the at least one of the status indicative of combustible fuel utilization or the status indicative of electricity utilization for the hybrid vehicle.

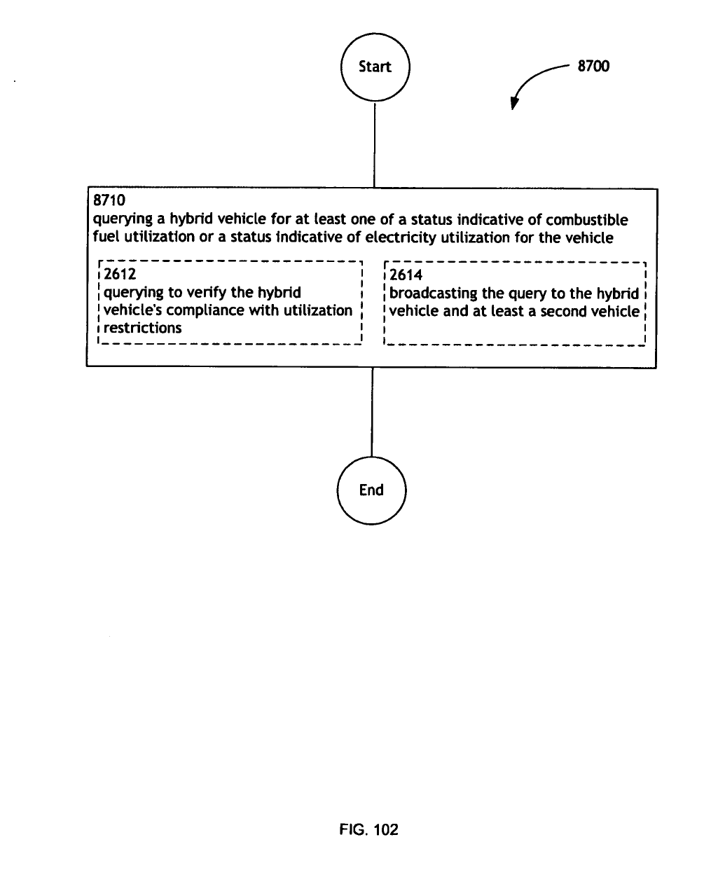

FIG. 102 illustrates alternative embodiments of the example operational flow 8700 of FIG. 87. FIG. 102 illustrates example embodiments where the operation 8710 may include at least one additional operation. Additional operations may include an operation 2612, and/or an operation 2614.

The operation 2612 illustrates querying to verify the hybrid vehicle's compliance with utilization restrictions.

The operation 2614 illustrates broadcasting the query to the hybrid vehicle and at least a second vehicle.

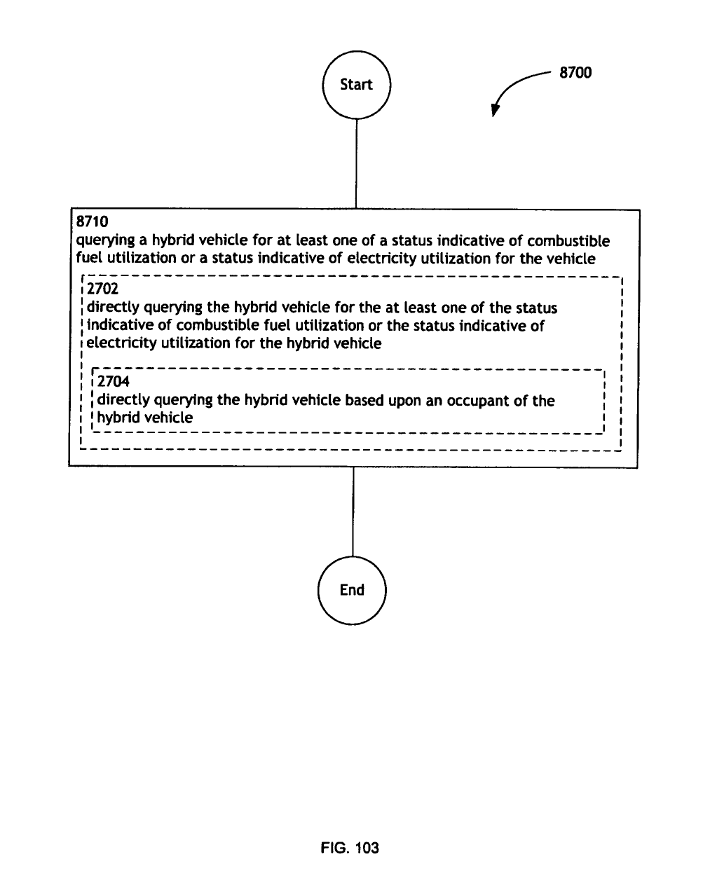

FIG. 103 illustrates alternative embodiments of the example operational flow 8700 of FIG. 87. FIG. 103 illustrates example embodiments where the operation 8710 may include at least one additional operation. Additional operations may include an operation 2702, and/or an operation 2704.

The operation 2702 illustrates directly querying the hybrid vehicle for the at least one of the status indicative of combustible fuel utilization or the status indicative of electricity utilization for the hybrid vehicle. Further, the operation 2704 illustrates directly querying the hybrid vehicle based upon an occupant of the hybrid vehicle.

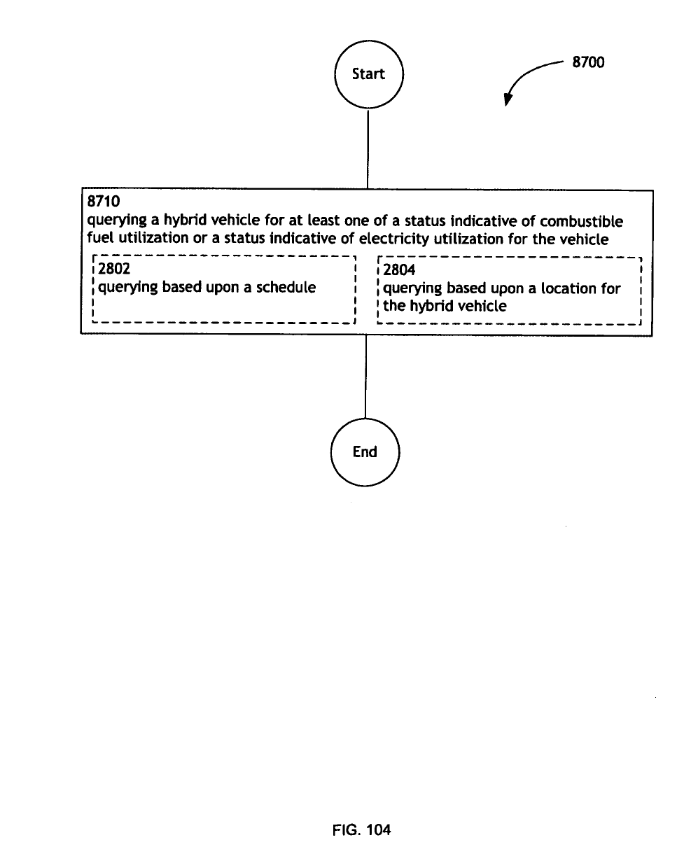

FIG. 104 illustrates alternative embodiments of the example operational flow 8700 of FIG. 87. FIG. 104 illustrates example embodiments where the operation 8710 may include at least one additional operation. Additional operations may include an operation 2802, and/or an operation 2804.

The operation 2802 illustrates querying based upon a schedule.

The operation 2804 illustrates querying based upon a location for the hybrid vehicle.

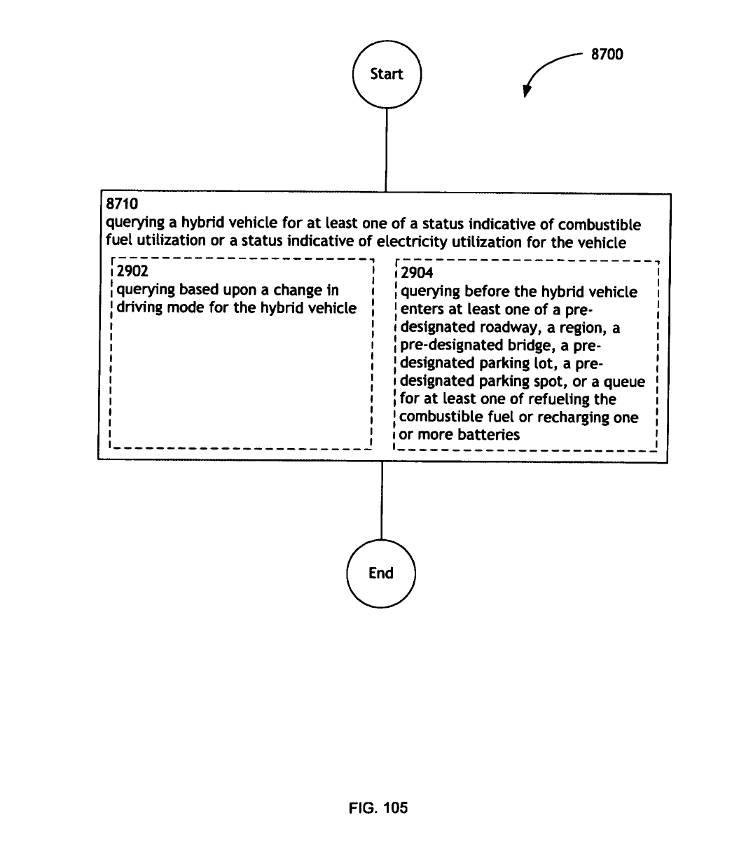

FIG. 105 illustrates alternative embodiments of the example operational flow 8700 of FIG. 87. FIG. 105 illustrates example embodiments where the operation 8710 may include at least one additional operation. Additional operations may include an operation 2902, and/or an operation 2904.

The operation 2902 illustrates querying based upon a change in driving mode for the hybrid vehicle.

The operation 2904 illustrates querying before the hybrid vehicle enters at least one of a pre-designated roadway, a region, a pre-designated bridge, a pre-designated parking lot, a pre-designated parking spot, or a queue for at least one of refueling the combustible fuel or recharging one or more batteries.

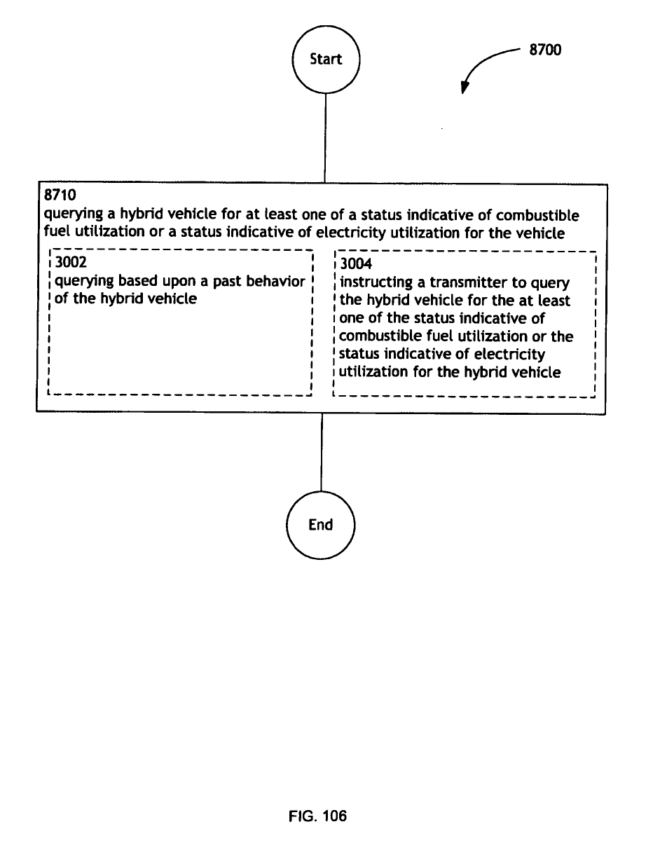

FIG. 106 illustrates alternative embodiments of the example operational flow 8700 of FIG. 87. FIG. 106 illustrates example embodiments where the operation 8710 may include at least one additional operation. Additional operations may include an operation 3002, and/or an operation 3004.

The operation 3002 illustrates querying based upon a past behavior of the hybrid vehicle.

The operation 3004 illustrates instructing a transmitter to query the hybrid vehicle for the at least one of the status indicative of combustible fuel utilization or the status indicative of electricity utilization for the hybrid vehicle.

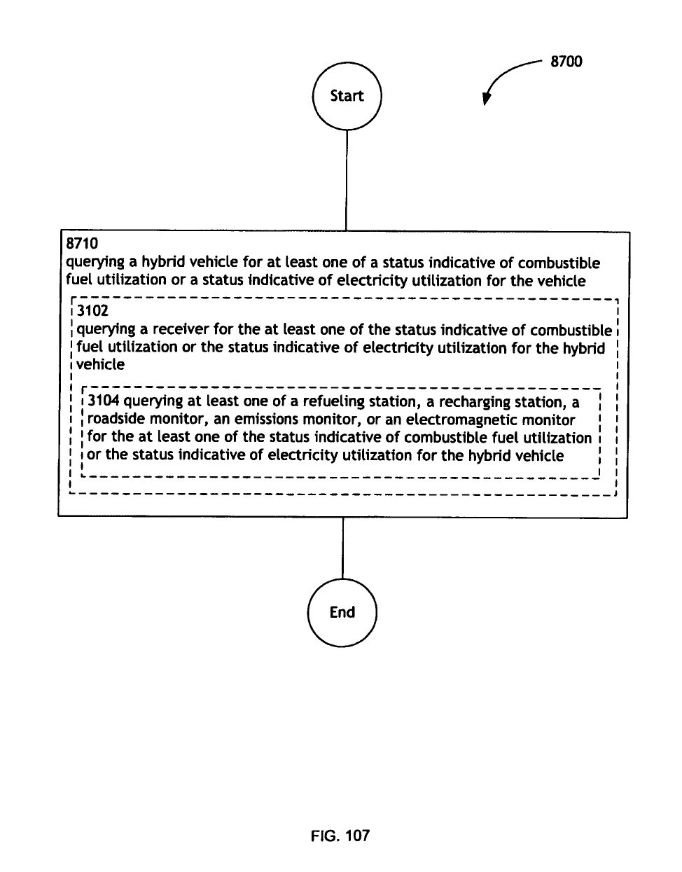

FIG. 107 illustrates alternative embodiments of the example operational flow 8700 of FIG. 87. FIG. 107 illustrates example embodiments where the operation 8710 may include at least one additional operation. Additional operations may include an operation 3102, and/or an operation 3104.

The operation 3102 illustrates querying a receiver for the at least one of the status indicative of combustible fuel utilization or the status indicative of electricity utilization for the hybrid vehicle. Further, the operation 3104 illustrates querying at least one of a refueling station, a recharging station, a roadside monitor, an emissions monitor, or an electromagnetic monitor for the at least one of the status indicative of combustible fuel utilization or the status indicative of electricity utilization for the hybrid vehicle.

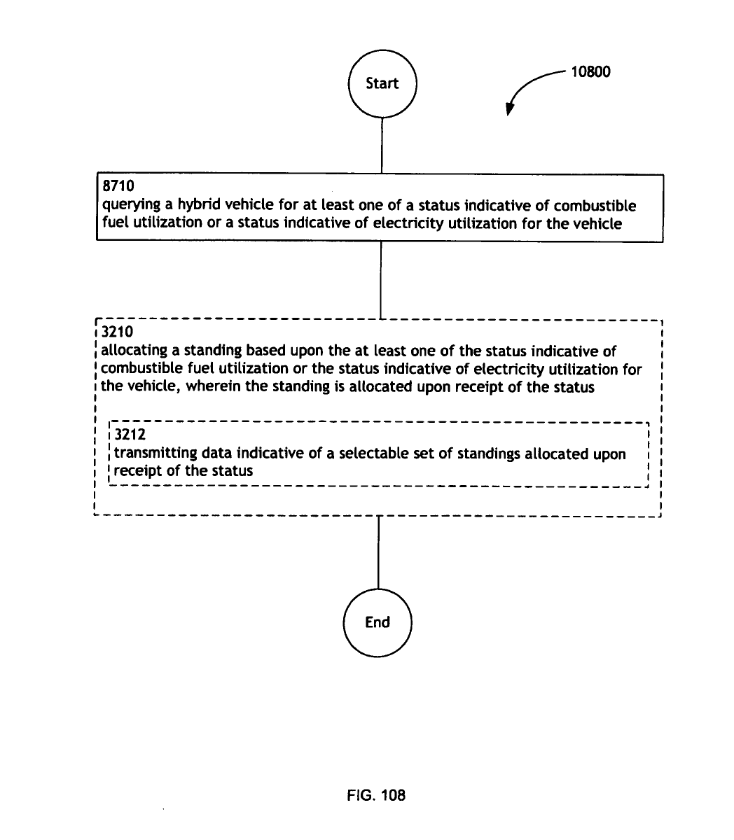

FIG. 108 illustrates an operational flow 10800 representing example operations related to querying a hybrid vehicle for at least one of a status indicative of combustible fuel utilization or a status indicative of electricity utilization for the vehicle and allocating a standing based upon the at least one of the status indicative of combustible fuel utilization or the status indicative of electricity utilization for the vehicle, wherein the standing is allocated upon receipt of the status. FIG. 108 illustrates an example embodiment where the example operational flow 8700 of FIG. 87 may include at least one additional operation. Additional operations may include an operation 3210, and/or an operation 3212.

After a start operation and an operation 8710, the operational flow 10800 moves to an operation 3210. Operation 3210 illustrates allocating a standing based upon the at least one of the status indicative of combustible fuel utilization or the status indicative of electricity utilization for the vehicle, wherein the standing is allocated upon receipt of the status.

The operation 3212 illustrates transmitting data indicative of a selectable set of standings allocated upon receipt of the status.

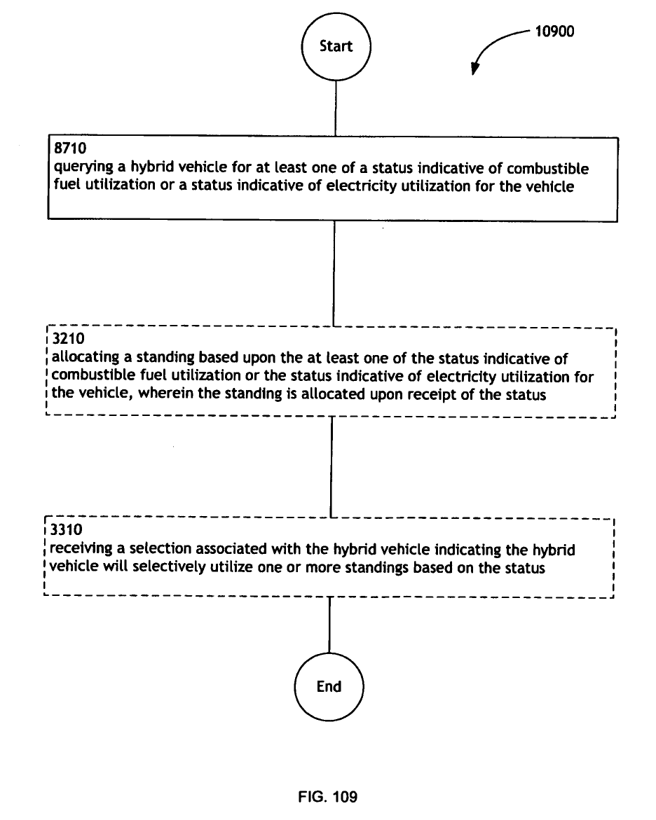

FIG. 109 illustrates an operational flow 10900 representing example operations related to querying a hybrid vehicle for at least one of a status indicative of combustible fuel utilization or a status indicative of electricity utilization for the vehicle, allocating a standing based upon the status for the vehicle, and receiving a selection associated with the hybrid vehicle. FIG. 109 illustrates an example embodiment where the example operational flow 10800 of FIG. 108 may include at least one additional operation. Additional operations may include an operation 3310.

After a start operation, an operation 8710, and an operation 3210, the operational flow 10900 moves to an operation 3310. Operation 3310 illustrates receiving a selection associated with the hybrid vehicle indicating the hybrid vehicle will selectively utilize one or more standings based on the status.

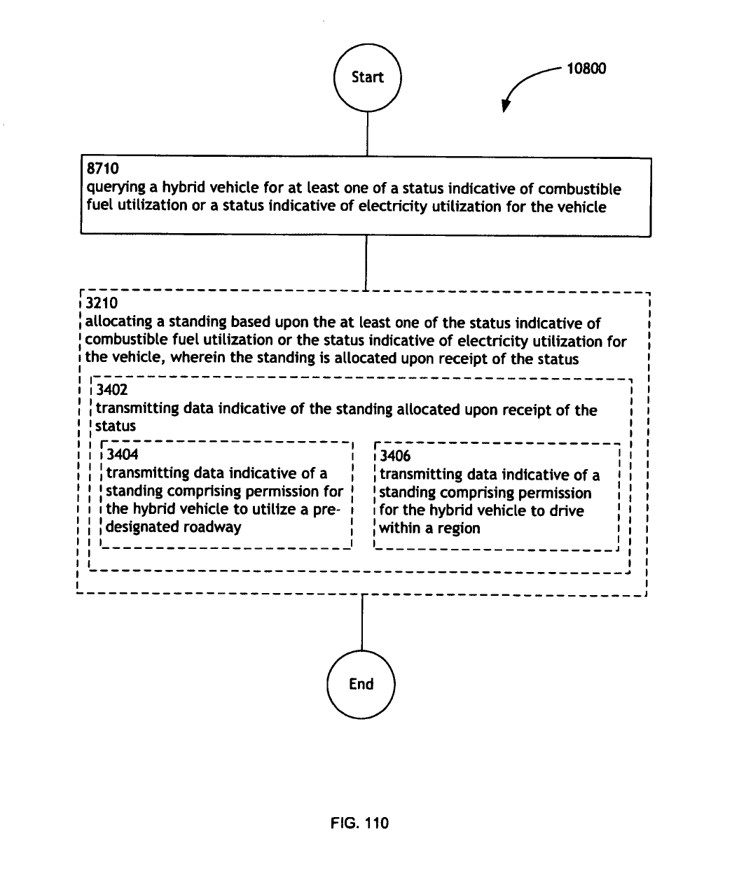

FIG. 110 illustrates alternative embodiments of the example operational flow 10800 of FIG. 108. FIG. 110 illustrates example embodiments where the operation 3210 may include at least one additional operation. Additional operations may include an operation 3402, an operation 3404, and/or an operation 3406.

The operation 3402 illustrates transmitting data indicative of the standing allocated upon receipt of the status. Further, the operation 3404 illustrates transmitting data indicative of a standing comprising permission for the hybrid vehicle to utilize a pre-designated roadway. Further, the operation 3406 illustrates transmitting data indicative of a standing comprising permission for the hybrid vehicle to drive within a region.

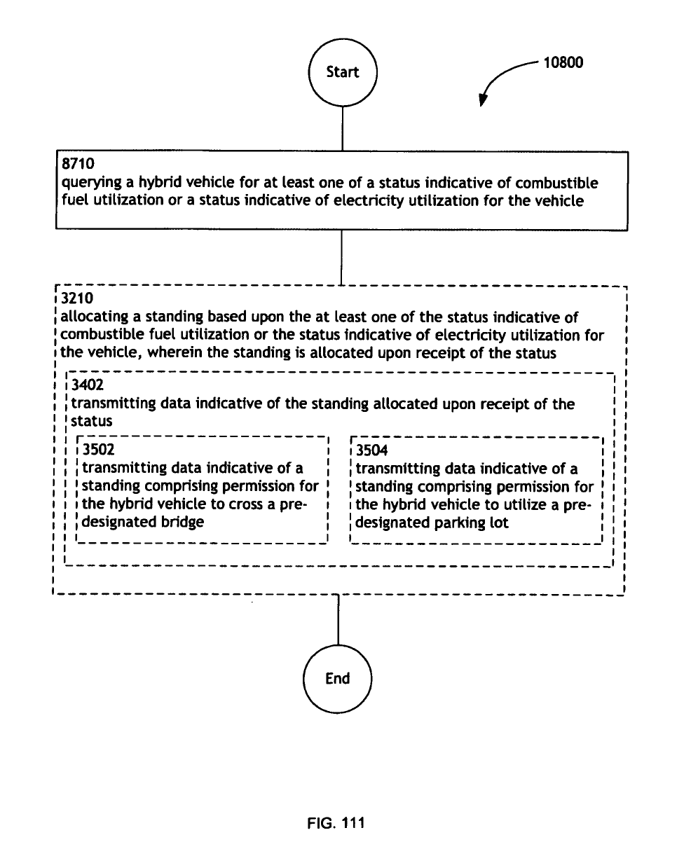

FIG. 111 illustrates alternative embodiments of the example operational flow 10800 of FIG. 108. FIG. 111 illustrates example embodiments where the operation 3210 may include at least one additional operation. Additional operations may include an operation 3502, and/or an operation 3504. Further, the operation 3502 illustrates transmitting data indicative of a standing comprising permission for the hybrid vehicle to cross a pre-designated bridge. Further, the operation 3504 illustrates transmitting data indicative of a standing comprising permission for the hybrid vehicle to utilize a pre-designated parking lot.

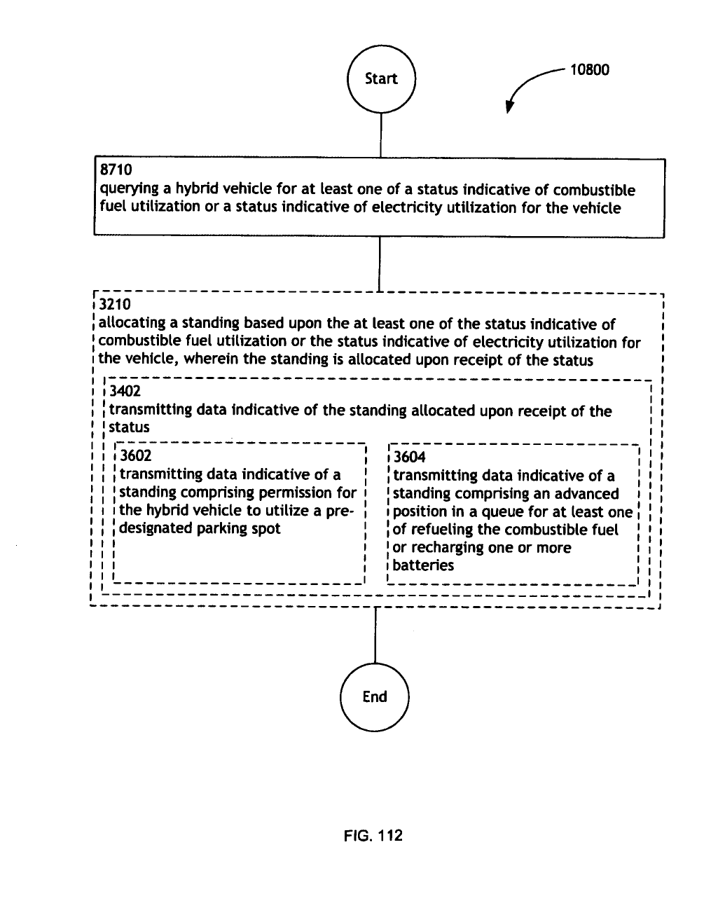

FIG. 112 illustrates alternative embodiments of the example operational flow 10800 of FIG. 108. FIG. 112 illustrates example embodiments where the operation 3210 may include at least one additional operation. Additional operations may include an operation 3602, and/or an operation 3604. Further, the operation 3602 illustrates transmitting data indicative of a standing comprising permission for the hybrid vehicle to utilize a pre-designated parking spot. Further, the operation 3604 illustrates transmitting data indicative of a standing comprising an advanced position in a queue for at least one of refueling the combustible fuel or recharging one or more batteries.

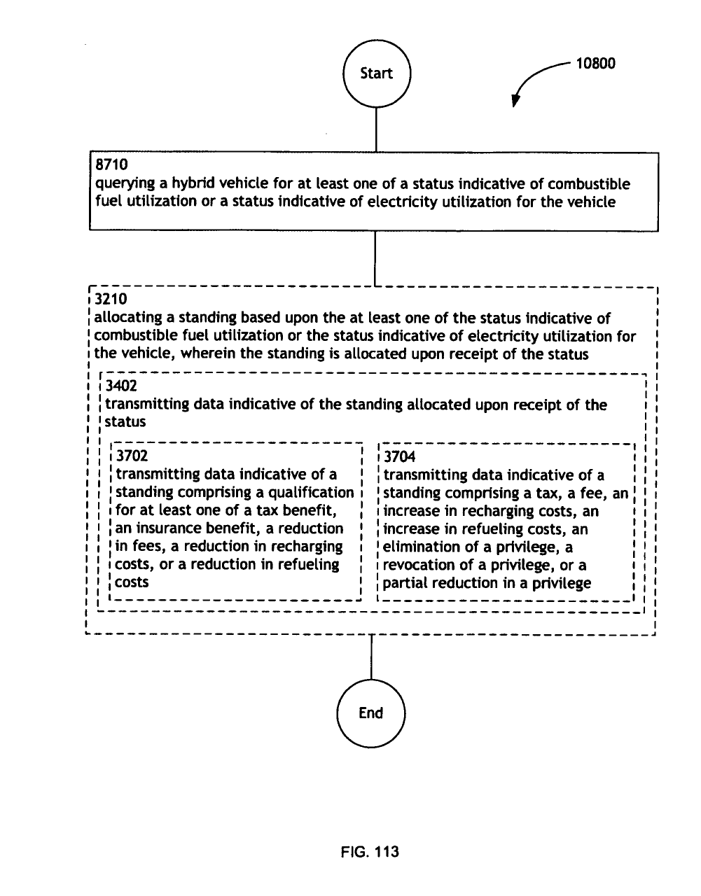

FIG. 113 illustrates alternative embodiments of the example operational flow 10800 of FIG. 108. FIG. 113 illustrates example embodiments where the operation 3210 may include at least one additional operation. Additional operations may include an operation 3702, and/or an operation 3704. Further, the operation 3702 illustrates transmitting data indicative of a standing comprising a qualification for at least one of a tax benefit, an insurance benefit, a reduction in fees, a reduction in recharging costs, or a reduction in refueling costs. Further, the operation 3704 illustrates transmitting data indicative of a standing comprising a tax, a fee, an increase in recharging costs, an increase in refueling costs, an elimination of a privilege, a revocation of a privilege, or a partial reduction in a privilege.

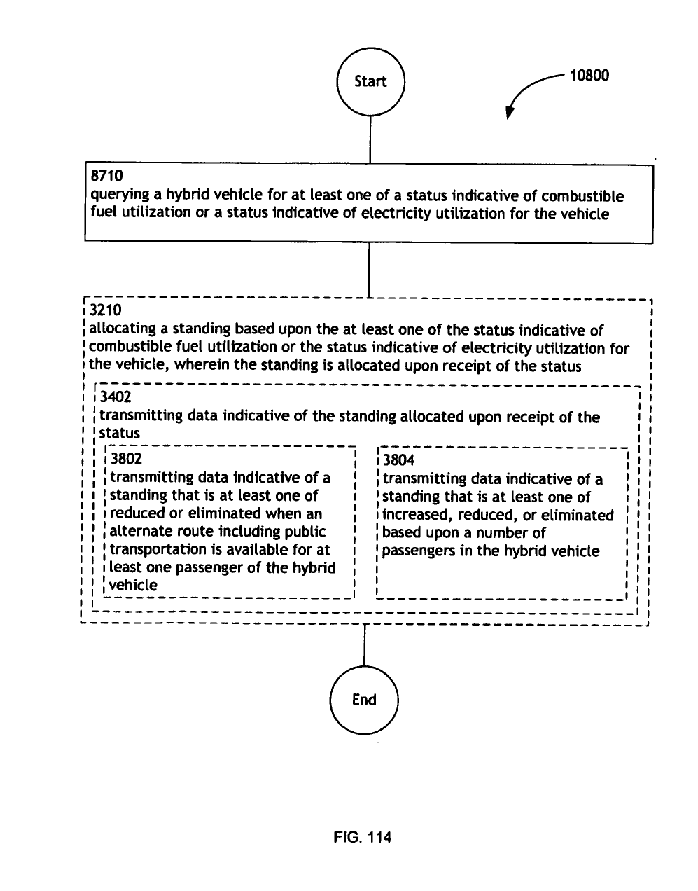

FIG. 114 illustrates alternative embodiments of the example operational flow 10800 of FIG. 108. FIG. 114 illustrates example embodiments where the operation 3210 may include at least one additional operation. Additional operations may include an operation 3802, and/or an operation 3804. Further, the operation 3802 illustrates transmitting data indicative of a standing that is at least one of reduced or eliminated when an alternate route including public transportation is available for at least one passenger of the hybrid vehicle. Further, the operation 3804 illustrates transmitting data indicative of a standing that is at least one of increased, reduced, or eliminated based upon a number of passengers in the hybrid vehicle.

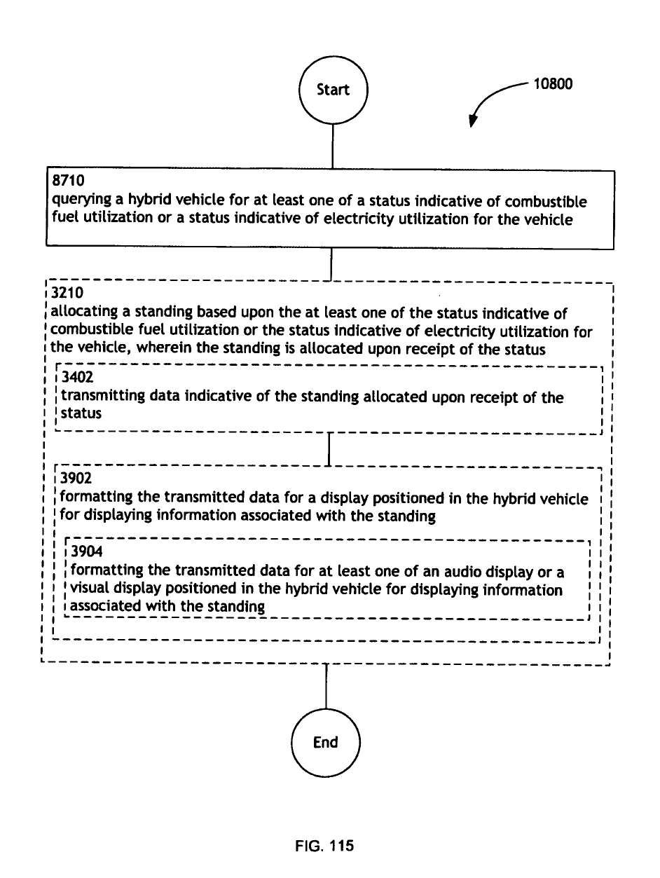

FIG. 115 illustrates alternative embodiments of the example operational flow 10800 of FIG. 108. FIG. 115 illustrates example embodiments where the operation 3210 may include at least one additional operation. Additional operations may include an operation 3902, and/or an operation 3904. Further, the operation 3902 illustrates formatting the transmitted data for a display positioned in the hybrid vehicle for displaying information associated with the standing. Further, the operation 3904 illustrates formatting the transmitted data for at least one of an audio display or a visual display positioned in the hybrid vehicle for displaying information associated with the standing.

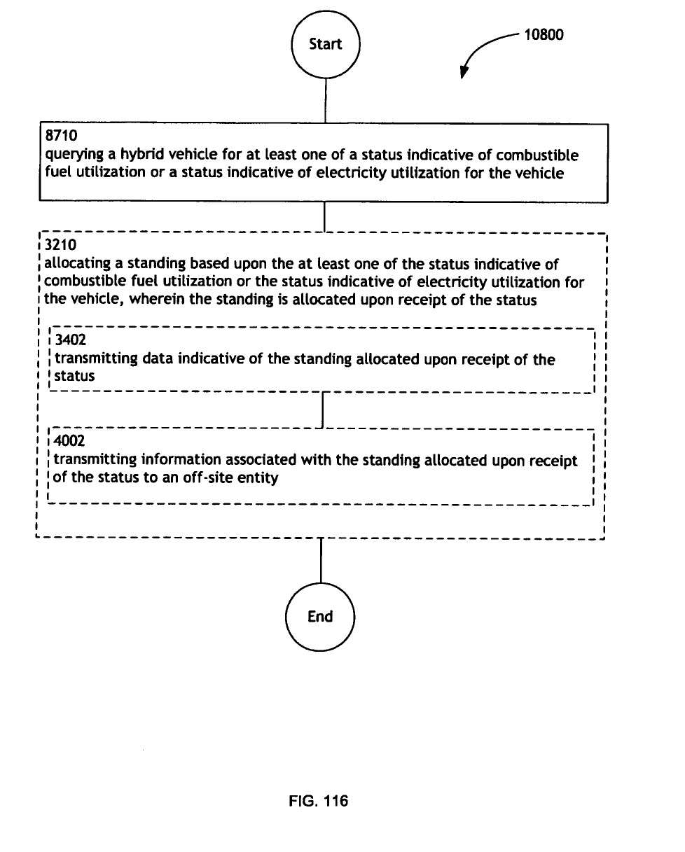

FIG. 116 illustrates alternative embodiments of the example operational flow 10800 of FIG. 108. FIG. 116 illustrates example embodiments where the operation 3210 may include at least one additional operation. Additional operations may include an operation 4002. Further, the operation 4002 illustrates transmitting information associated with the standing allocated upon receipt of the status to an off-site entity.

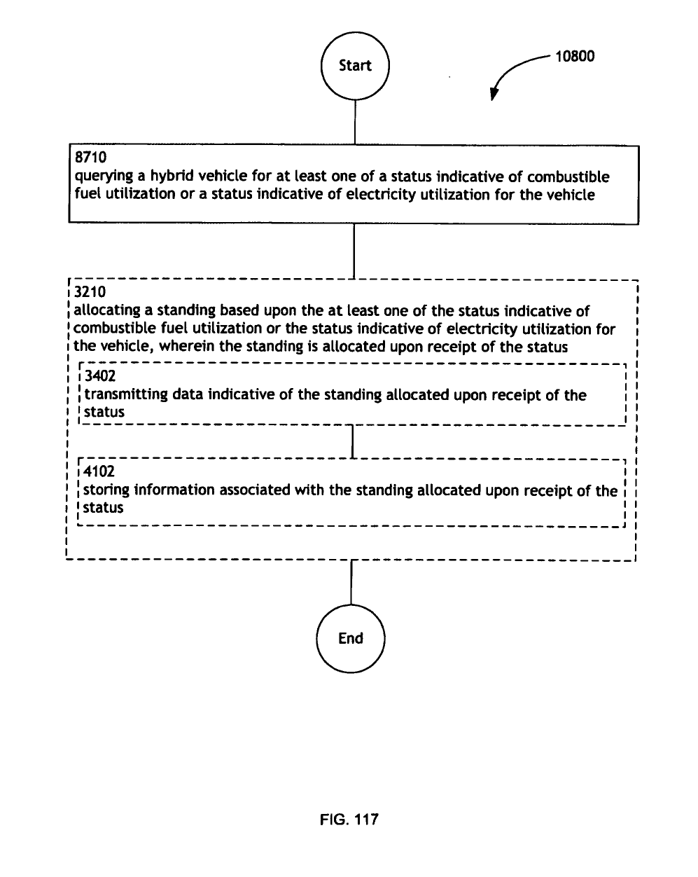

FIG. 117 illustrates alternative embodiments of the example operational flow 10800 of FIG. 108. FIG. 117 illustrates example embodiments where the operation 3210 may include at least one additional operation. Additional operations may include an operation 4102. Further, the operation 4102 illustrates storing information associated with the standing allocated upon receipt of the status.

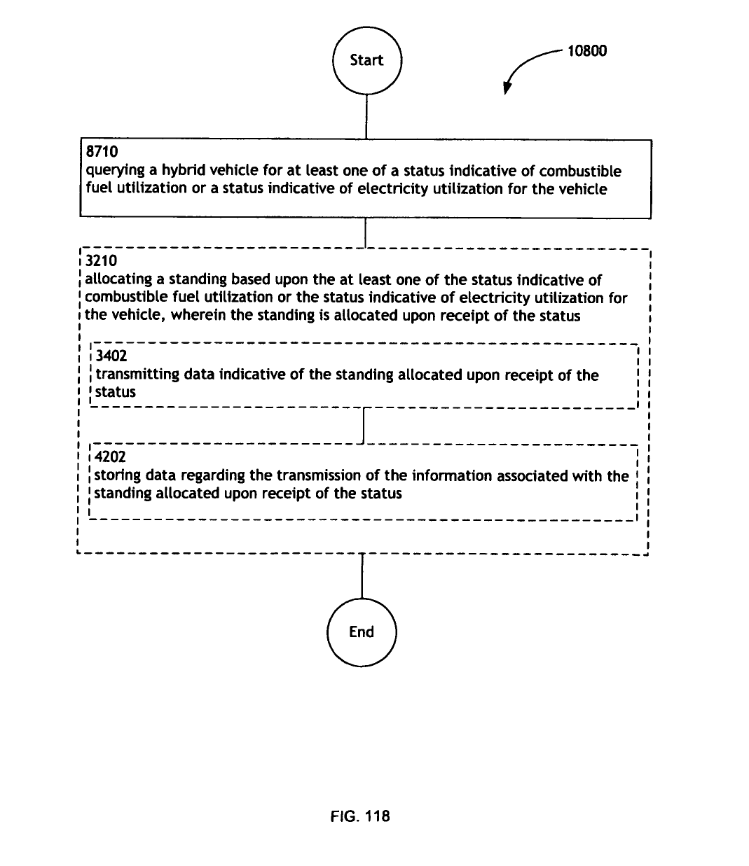

FIG. 118 illustrates alternative embodiments of the example operational flow 10800 of FIG. 108. FIG. 118 illustrates example embodiments where the operation 3210 may include at least one additional operation. Additional operations may include an operation 4202. Further, the operation 4202 illustrates storing data regarding the transmission of the information associated with the standing allocated upon receipt of the status.

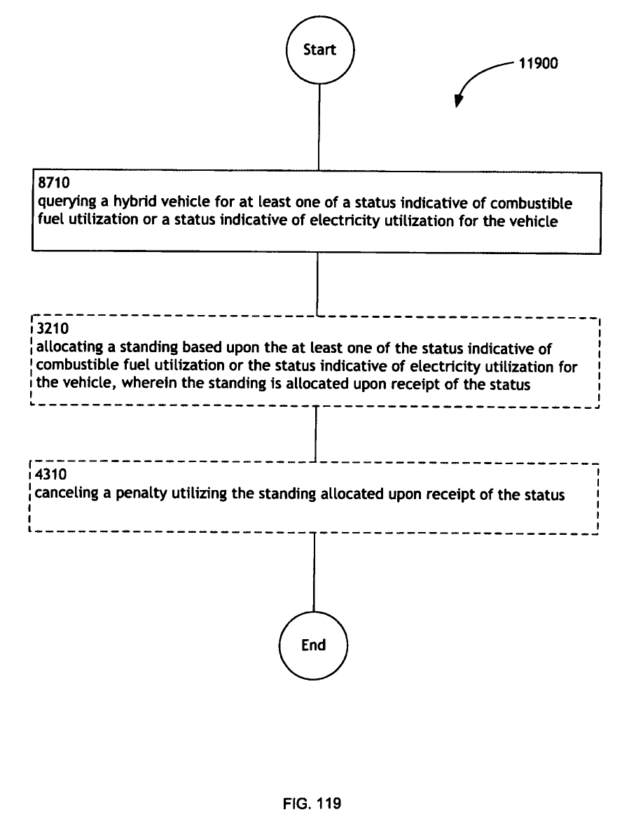

FIG. 119 illustrates an operational flow 11900 representing example operations related to querying a hybrid vehicle for at least one of a status indicative of combustible fuel utilization or a status indicative of electricity utilization for the vehicle, allocating a standing based upon the status for the vehicle, and canceling a penalty utilizing the standing. FIG. 119 illustrates an example embodiment where the example operational flow 10800 of FIG. 108 may include at least one additional operation. Additional, operations may include an operation 4310.

After a start operation, an operation 8710, and an operation 3210, the operational flow 11900 moves to an operation 4310. Operation 4310 illustrates canceling a penalty utilizing the standing allocated upon receipt of the status.

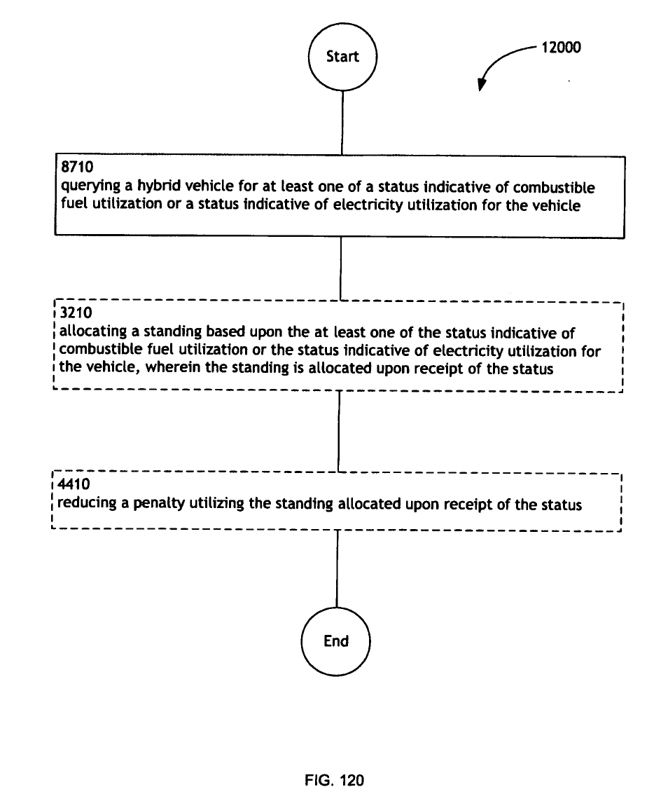

FIG. 120 illustrates an operational flow 12000 representing example operations related to querying a hybrid vehicle for at least one of a status indicative of combustible fuel utilization or a status indicative of electricity utilization for the vehicle, allocating a standing based upon the status for the vehicle, and reducing a penalty utilizing the standing. FIG. 120 illustrates an example embodiment where the example operational flow 10800 of FIG. 108 may include at least one additional operation. Additional operations may include an operation 4410.

After a start operation, an operation 8710, and an operation 3210, the operational flow 12000 moves to an operation 4410. Operation 4410 illustrates reducing a penalty utilizing the standing allocated upon receipt of the status.

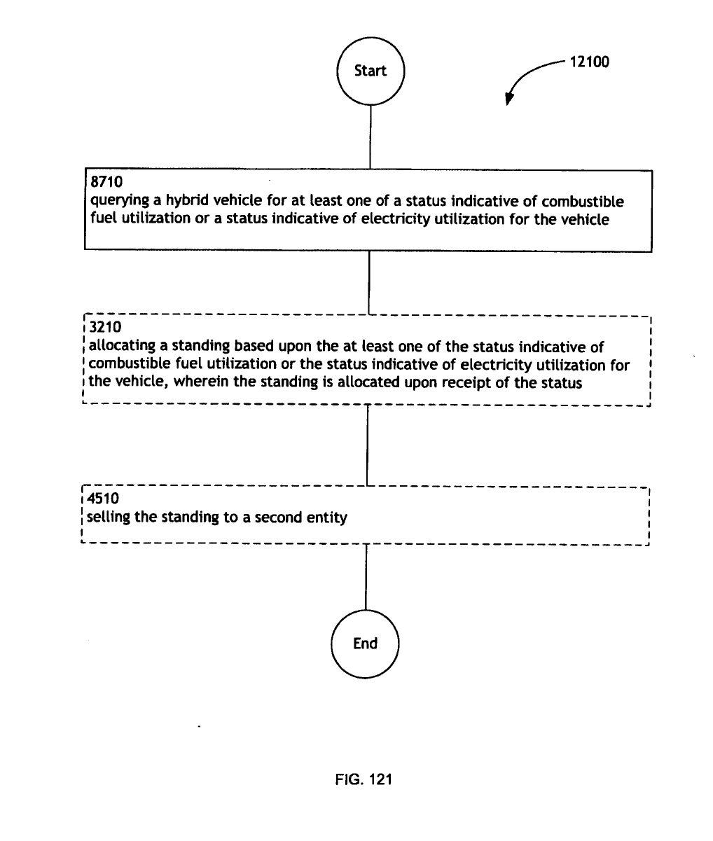

FIG. 121 illustrates an operational flow 12100 representing example operations related to querying a hybrid vehicle for at least one of a status indicative of combustible fuel utilization or a status indicative of electricity utilization for the vehicle, allocating a standing based upon the status for the vehicle, and selling the standing to a second entity. FIG. 121 illustrates an example embodiment where the example operational flow 10800 of FIG. 108 may include at least one additional operation. Additional operations may include an operation 4510.

After a start operation, an operation 8710, and an operation 3210, the operational flow 12100 moves to an operation 4510. Operation 4510 illustrates selling the standing to a second entity.

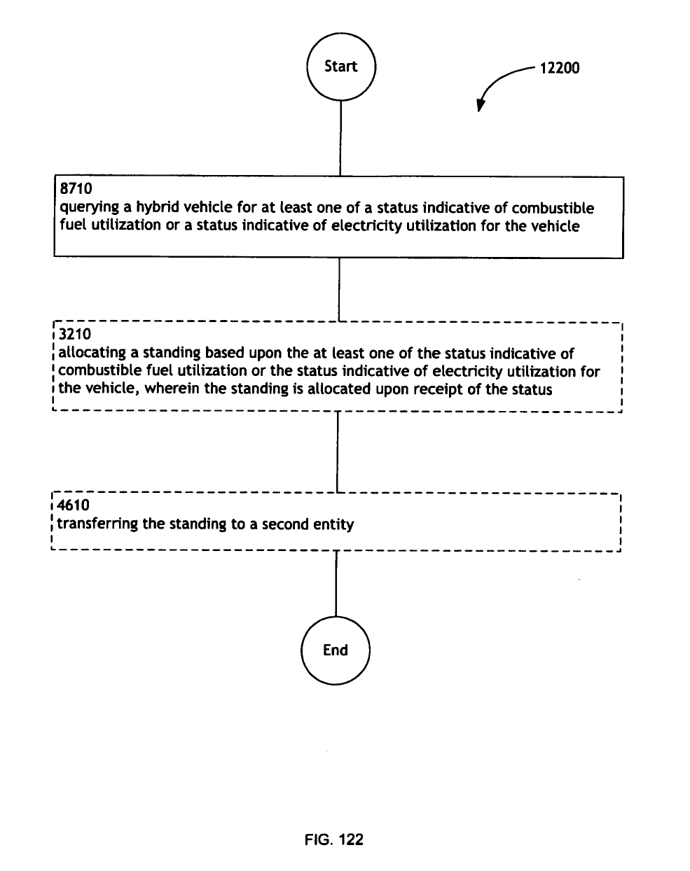

FIG. 122 illustrates an operational flow 12200 representing example operations related to querying a hybrid vehicle for at least one of a status indicative of combustible fuel utilization or a status indicative of electricity utilization for the vehicle, allocating a standing based upon the status for the vehicle, and transferring the standing to a second entity. FIG. 122 illustrates an example embodiment where the example operational flow 10800 of FIG. 108 may include at least one additional operation. Additional operations may include an operation 4610.

After a start operation, an operation 8710, and an operation 3210, the operational flow 12200 moves to an operation 4610. Operation 4610 illustrates transferring the standing to a second entity.

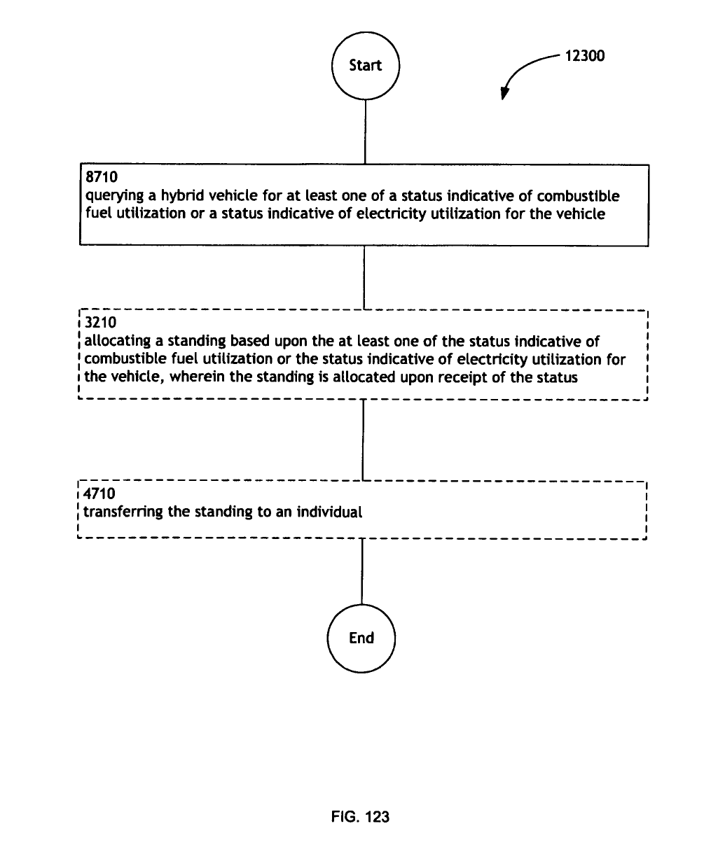

FIG. 123 illustrates an operational flow 12300 representing example operations related to querying a hybrid vehicle for at least one of a status indicative of combustible fuel utilization or a status indicative of electricity utilization for the vehicle, allocating a standing based upon the status for the vehicle, and transferring the standing to an individual. FIG. 123 illustrates an example embodiment where the example operational flow 10800 of FIG. 108 may include at least one additional operation. Additional operations may include an operation 4710.

After a start operation, an operation 8710, and an operation 3210, the operational flow 12300 moves to an operation 4710. Operation 4710 illustrates transferring the standing to an individual.

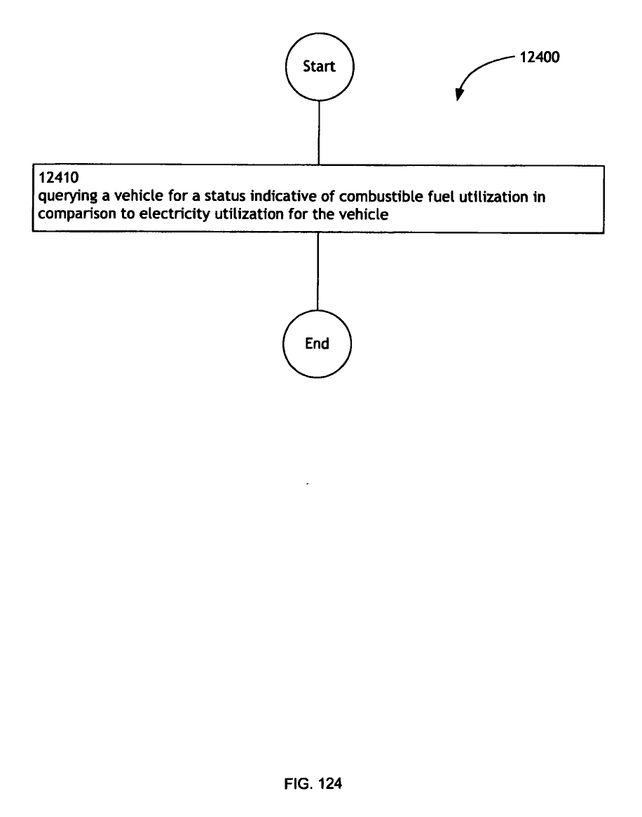

FIG. 124 illustrates an operational flow 12400 representing example operations related to querying a vehicle for a status indicative of combustible fuel utilization in comparison to electricity utilization for the vehicle. In FIG. 124 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 12400 moves to an operation 12410. Operation 12410 depicts querying a vehicle for a status indicative of combustible fuel utilization in comparison to electricity utilization for the vehicle. For example, as shown in FIGS. 1 through 10, the road authority may query the vehicle 100 for its status.

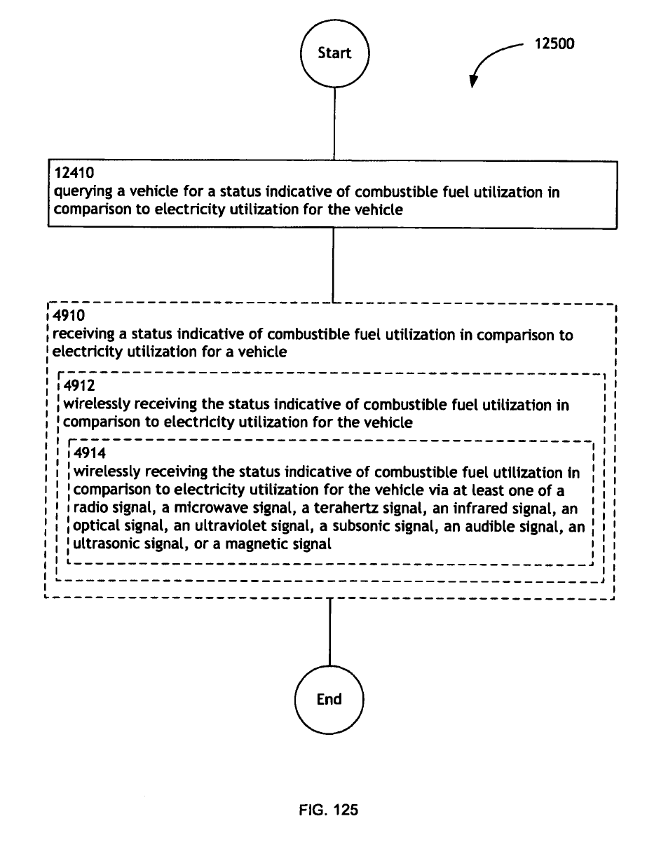

FIG. 125 illustrates an operational flow 12500 representing example operations related to querying a vehicle for a status indicative of combustible fuel utilization in comparison to electricity utilization for the vehicle and receiving a status indicative of combustible fuel utilization in comparison to electricity utilization for a vehicle. FIG. 125 illustrates an example embodiment where the example operational flow 12400 of FIG. 124 may include at least one additional operation. Additional operations may include an operation 4910, an operation 4912, and/or an operation 4914.

After a start operation and an operation 12410, the operational flow 12500 moves to an operation 4910. Operation 4910 illustrates receiving a status indicative of combustible fuel utilization in comparison to electricity utilization for a vehicle.

The operation 4912 illustrates wirelessly receiving the status indicative of combustible fuel utilization in comparison to electricity utilization for the vehicle. Further, the operation 4914 illustrates wirelessly receiving the status indicative of combustible fuel utilization in comparison to electricity utilization for the vehicle via at least one of a radio signal, a microwave signal, a terahertz signal, an infrared signal, an optical signal, an ultraviolet signal, a subsonic signal, an audible signal, an ultrasonic signal, or a magnetic signal.

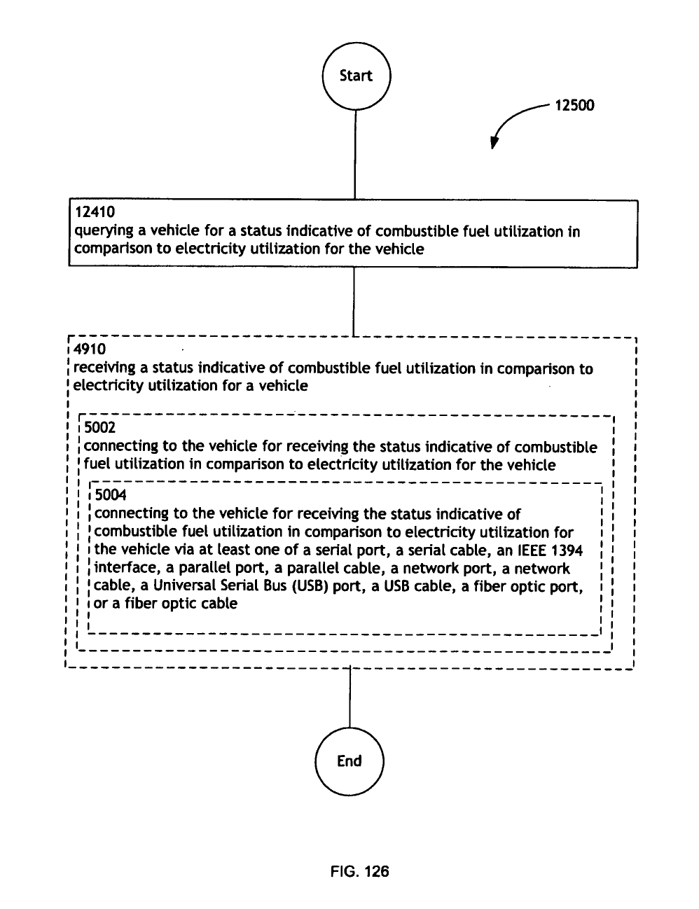

FIG. 126 illustrates alternative embodiments of the example operational flow 12500 of FIG. 125. FIG. 126 illustrates example embodiments where the operation 4910 may include at least one additional operation. Additional operations may include an operation 5002, and/or an operation 5004.

The operation 5002 illustrates connecting to the vehicle for receiving the status indicative of combustible fuel utilization in comparison to electricity utilization for the vehicle. Further, the operation 5004 illustrates connecting to the vehicle for receiving the status indicative of combustible fuel utilization in comparison to electricity utilization for the vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

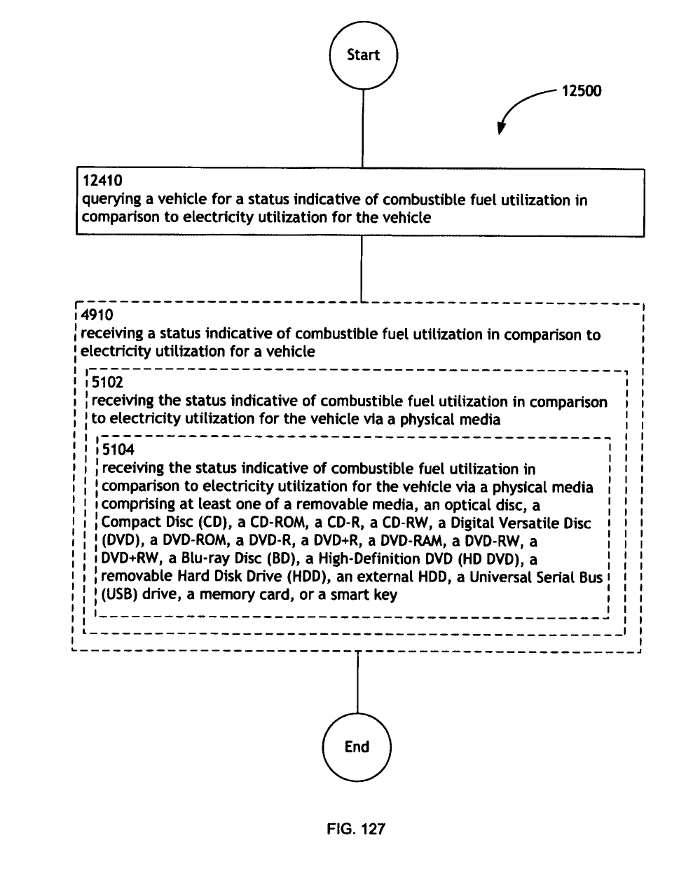

FIG. 127 illustrates alternative embodiments of the example operational flow 12500 of FIG. 125. FIG. 127 illustrates example embodiments where the operation 4910 may include at least one additional operation. Additional operations may include an operation 5102, and/or an operation 5104.

The operation 5102 illustrates receiving the status indicative of combustible fuel utilization in comparison to electricity utilization for the vehicle via a physical media. Further, the operation 5104 illustrates receiving the status indicative of combustible fuel utilization in comparison to electricity utilization for the vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

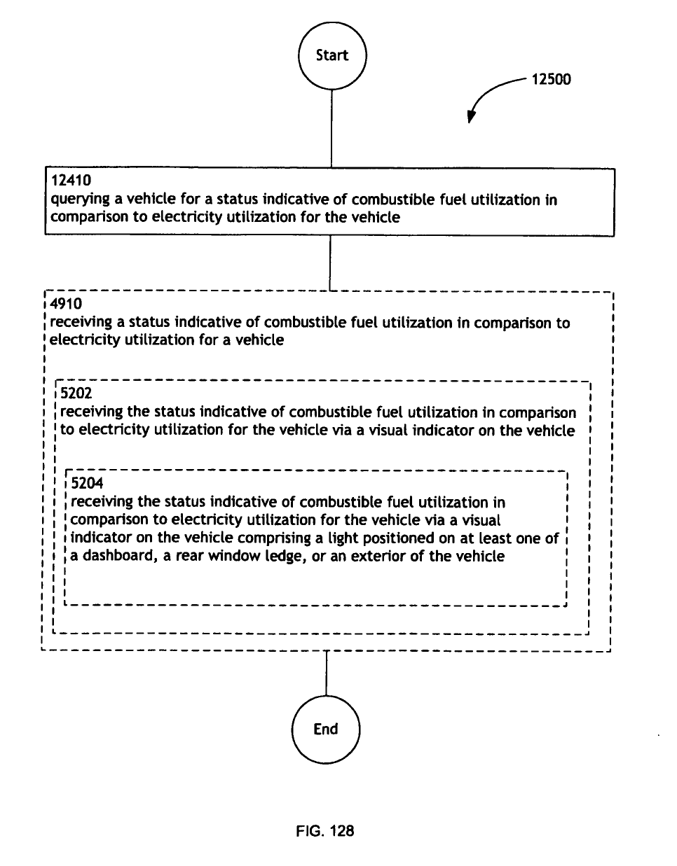

FIG. 128 illustrates alternative embodiments of the example operational flow 12500 of FIG. 125. FIG. 128 illustrates example embodiments where the operation 4910 may include at least one additional operation. Additional operations may include an operation 5202, and/or an operation 5204.

The operation 5202 illustrates receiving the status indicative of combustible fuel utilization in comparison to electricity utilization for the vehicle via a visual indicator on the vehicle. Further, the operation 5204 illustrates receiving the status indicative of combustible fuel utilization in comparison to electricity utilization for the vehicle via a visual indicator on the vehicle comprising a light positioned on at least one of a dashboard, a rear window ledge, or an exterior of the vehicle.

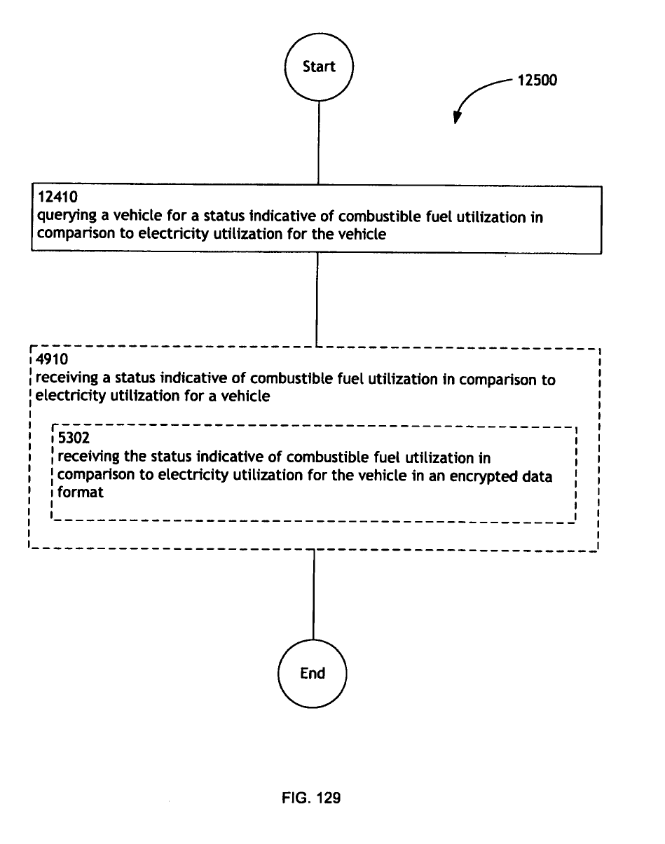

FIG. 129 illustrates alternative embodiments of the example operational flow 12500 of FIG. 125. FIG. 129 illustrates example embodiments where the operation 4910 may include at least one additional operation. Additional operations may include an operation 5302.

The operation 5302 illustrates receiving the status indicative of combustible fuel utilization in comparison to electricity utilization for the vehicle in an encrypted data format.

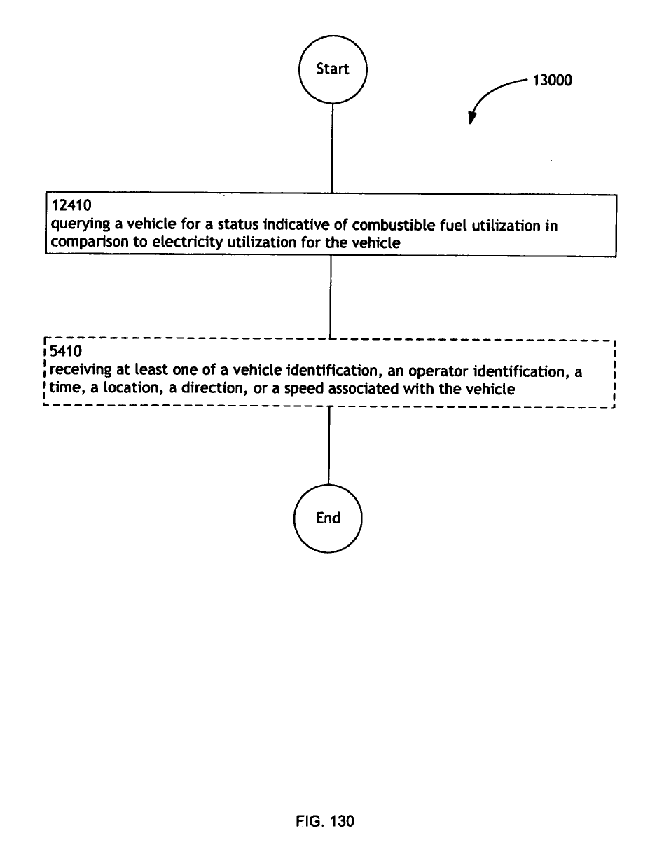

FIG. 130 illustrates an operational flow 13000 representing example operations related to querying a vehicle for a status indicative of combustible fuel utilization in comparison to electricity utilization for the vehicle and receiving at least one of a vehicle identification, an operator identification, a time, a location, a direction, or a speed associated with the vehicle. FIG. 130 illustrates an example embodiment where the example operational flow 12400 of FIG. 124 may include at least one additional operation. Additional operations may include an operation 5410.

After a start operation and an operation 12410, the operational flow 13000 moves to an operation 5410. Operation 5410 illustrates receiving at least one of a vehicle identification, an operator identification, a time, a location, a direction, or a speed associated with the vehicle.

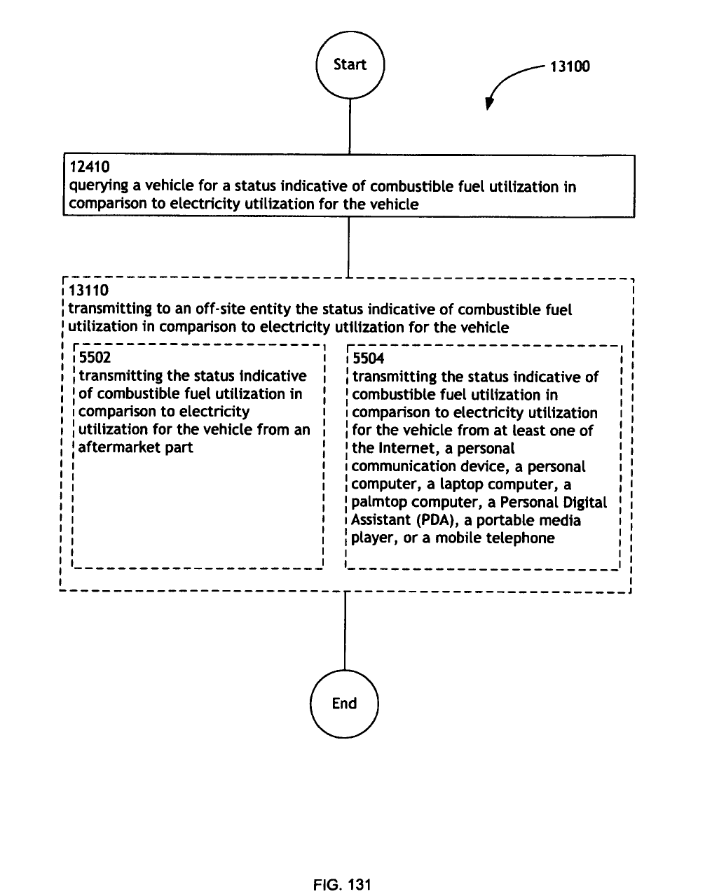

FIG. 131 illustrates an operational flow 13100 representing example operations related to querying a vehicle for a status indicative of combustible fuel utilization in comparison to electricity utilization for the vehicle and transmitting to an off-site entity the status indicative of combustible fuel utilization in comparison to electricity utilization for the vehicle. FIG. 131 illustrates an example embodiment where the example operational flow 12400 of FIG. 124 may include at least one additional operation. Additional operations may include an operation 13100, an operation 5502, and/or an operation 5504.

After a start operation and an operation 12410, the operational flow 13100 moves to an operation 13110. Operation 13110 illustrates transmitting to an off-site entity the status indicative of combustible fuel utilization in comparison to electricity utilization for the vehicle. For example, as shown in FIGS. 1 through 10, the vehicle 100 may transmit (e.g., utilizing the transmitter 120) a status indicative of, for example, combustible fuel utilization in comparison to electricity utilization for the vehicle 100. In an embodiment, the off-site entity 144 may receive the status transmitted by the vehicle 100.

The operation 5502 illustrates transmitting the status indicative of combustible fuel utilization in comparison to electricity utilization for the vehicle from an aftermarket part.

The operation 5504 illustrates transmitting the status indicative of combustible fuel utilization in comparison to electricity utilization for the vehicle from at least one of the Internet, a personal communication device, a personal computer, a laptop computer, a palmtop computer, a Personal Digital Assistant (PDA), a portable media player, or a mobile telephone.

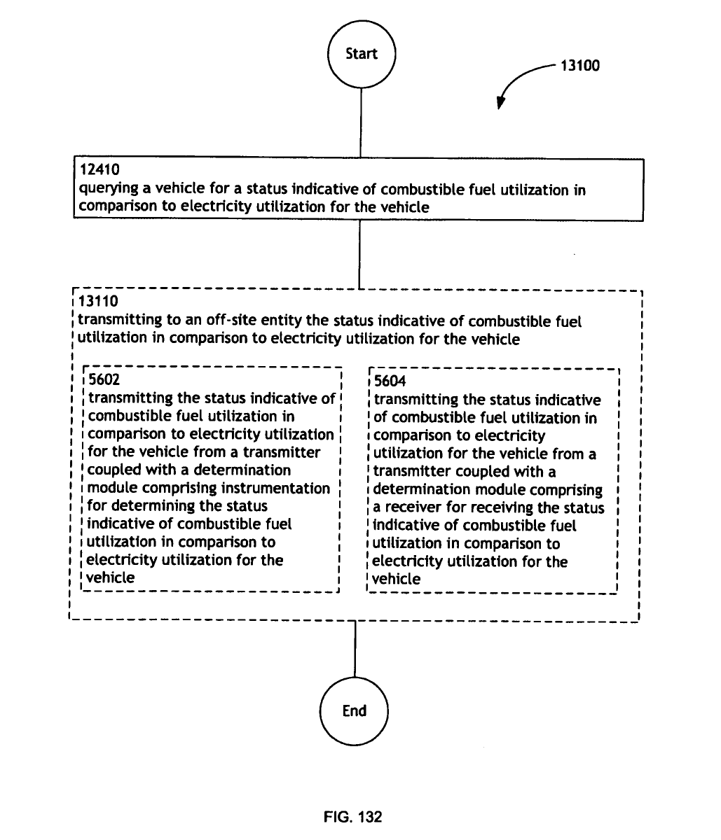

FIG. 132 illustrates alternative embodiments of the example operational flow 13100 of FIG. 131. FIG. 132 illustrates example embodiments where the operation 13110 may include at least one additional operation. Additional operations may include an operation 5602, and/or an operation 5604.

The operation 5602 illustrates transmitting the status indicative of combustible fuel utilization in comparison to electricity utilization for the vehicle from a transmitter coupled with a determination module comprising instrumentation for determining the status indicative of combustible fuel utilization in comparison to electricity utilization for the vehicle.

The operation 5604 illustrates transmitting the status indicative of combustible fuel utilization in comparison to electricity utilization for the vehicle from a transmitter coupled with a determination module comprising a receiver for receiving the status indicative of combustible fuel utilization in comparison to electricity utilization for the vehicle.

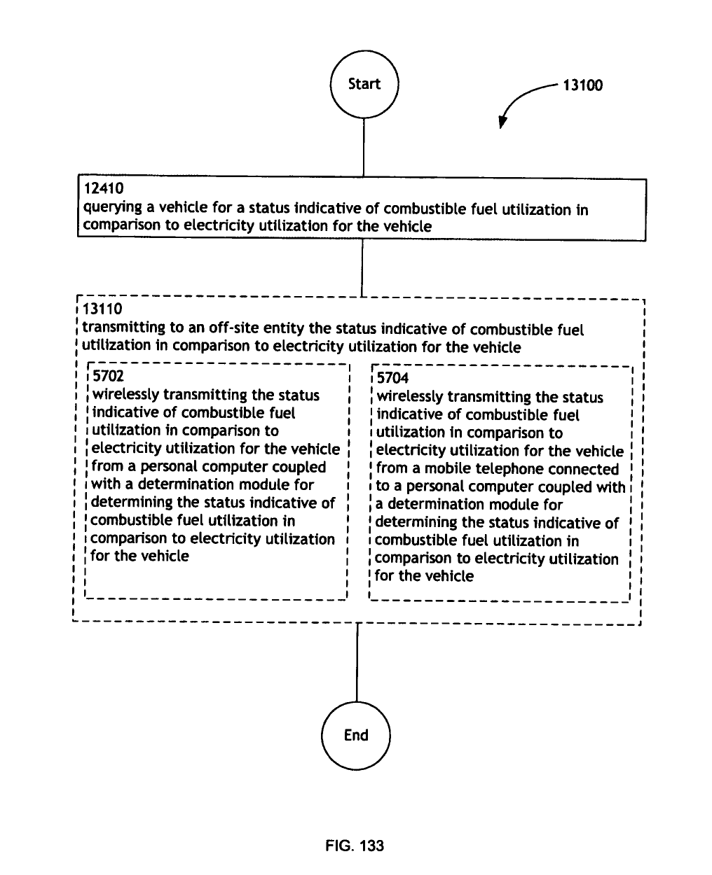

FIG. 133 illustrates alternative embodiments of the example operational flow 13100 of FIG. 131. FIG. 133 illustrates example embodiments where the operation 13110 may include at least one additional operation. Additional operations may include an operation 5702, and/or an operation 5704.

The operation 5702 illustrates wirelessly transmitting the status indicative of combustible fuel utilization in comparison to electricity utilization for the vehicle from a personal computer coupled with a determination module for determining the status indicative of combustible fuel utilization in comparison to electricity utilization for the vehicle.

The operation 5704 illustrates wirelessly transmitting the status indicative of combustible fuel utilization in comparison to electricity utilization for the vehicle from a mobile telephone connected to a personal computer coupled with a determination module for determining the status indicative of combustible fuel utilization in comparison to electricity utilization for the vehicle.

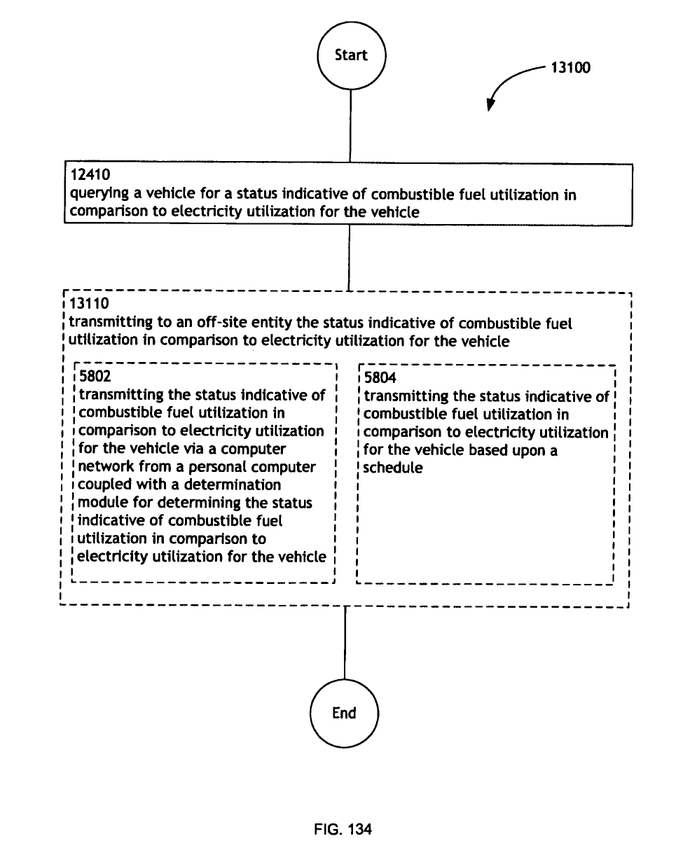

FIG. 134 illustrates alternative embodiments of the example operational flow 13100 of FIG. 131. FIG. 134 illustrates example embodiments where the operation 13110 may include at least one additional operation. Additional operations may include an operation 5802, and/or an operation 5804.

The operation 5802 illustrates transmitting the status indicative of combustible fuel utilization in comparison to electricity utilization for the vehicle via a computer network from a personal computer coupled with a determination module for determining the status indicative of combustible fuel utilization in comparison to electricity utilization for the vehicle.

The operation 5804 illustrates transmitting the status indicative of combustible fuel utilization in comparison to electricity utilization for the vehicle based upon a schedule.

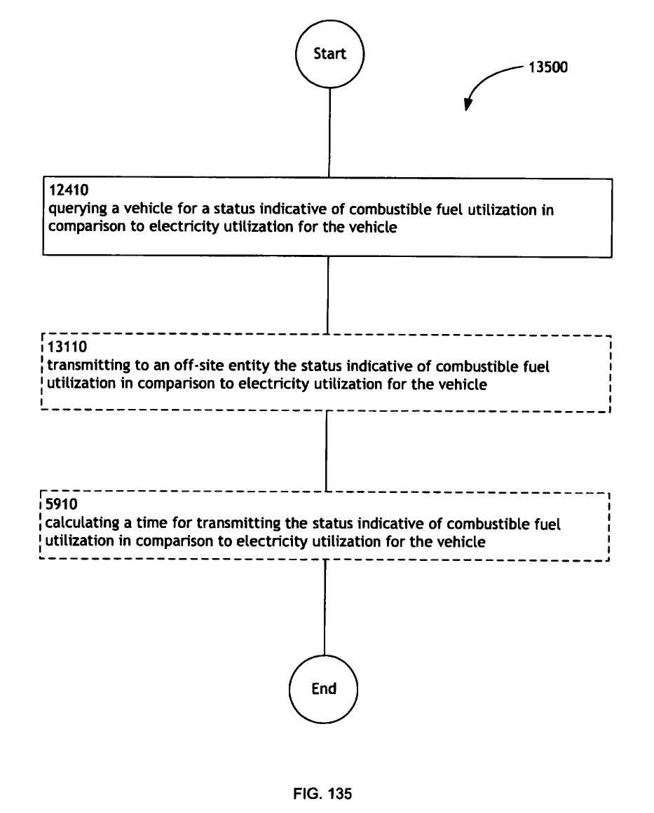

FIG. 135 illustrates an operational flow 13500 representing example operations related to querying a vehicle for a status indicative of combustible fuel utilization in comparison to electricity utilization for the vehicle, transmitting to an off-site entity the status indicative of combustible fuel utilization in comparison to electricity utilization for the vehicle, and calculating a time for transmitting the status. FIG. 135 illustrates an example embodiment where the example operational flow 13100 of FIG. 131 may include at least one additional operation. Additional operations may include an operation 5910.

After a start operation, an operation 12410, and an operation 13110, the operational flow 5900 moves to an operation 5910. Operation 5910 illustrates calculating a time for transmitting the status indicative of combustible fuel utilization in comparison to electricity utilization for the vehicle.

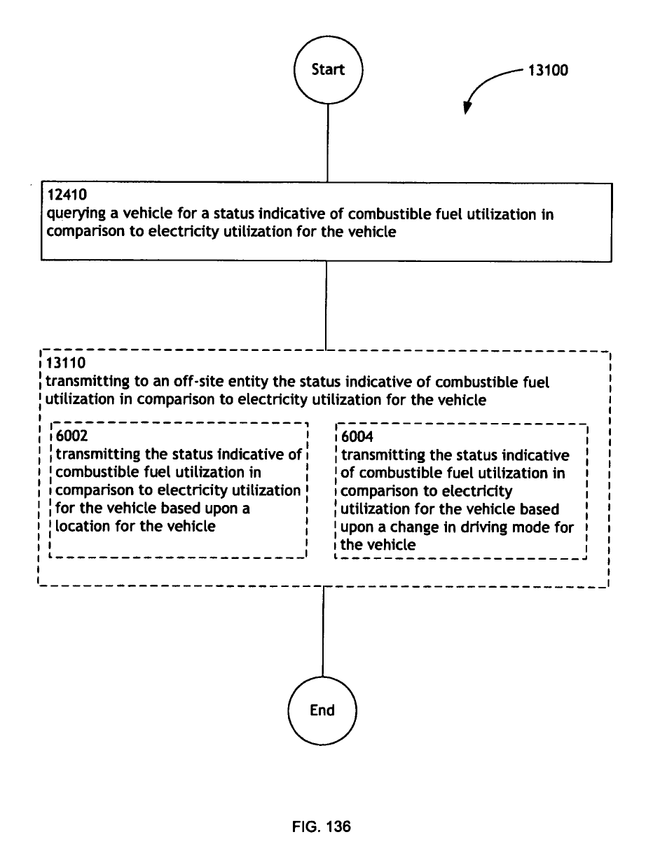

FIG. 136 illustrates alternative embodiments of the example operational flow 13100 of FIG. 131. FIG. 136 illustrates example embodiments where the operation 13110 may include at least one additional operation. Additional operations may include an operation 6002, and/or an operation 6004.

The operation 6002 illustrates transmitting the status indicative of combustible fuel utilization in comparison to electricity utilization for the vehicle based upon a location for the vehicle.

The operation 6004 illustrates transmitting the status indicative of combustible fuel utilization in comparison to electricity utilization for the vehicle based upon a change in driving mode for the vehicle.

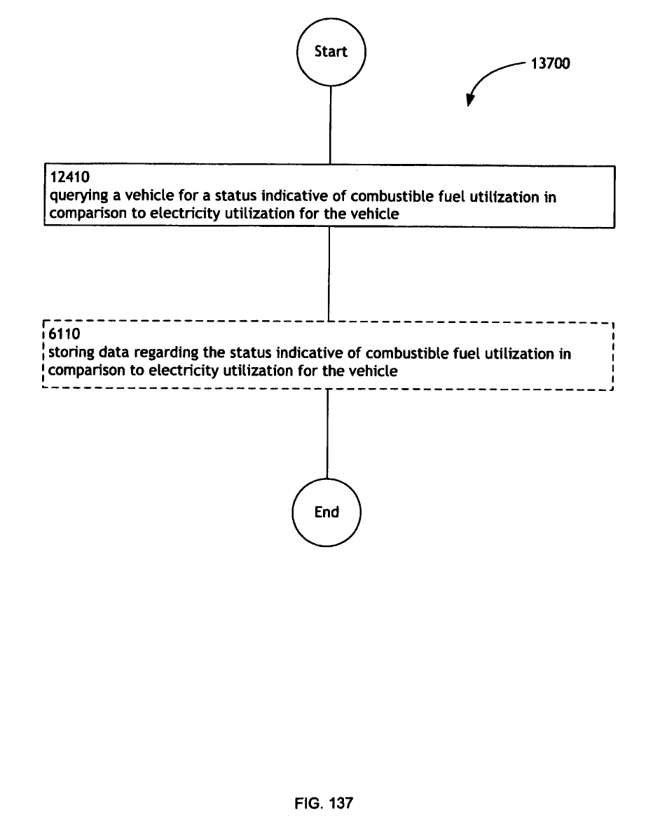

FIG. 137 illustrates an operational flow 13700 representing example operations related to querying a vehicle for a status indicative of combustible fuel utilization in comparison to electricity utilization for the vehicle and storing data regarding the status. FIG. 137 illustrates an example embodiment where the example operational flow 12400 of FIG. 124 may include at least one additional operation. Additional operations may include an operation 6110.

After a start operation and an operation 12410, the operational flow 13700 moves to an operation 6110. Operation 6110 illustrates storing data regarding the status indicative of combustible fuel utilization in comparison to electricity utilization for the vehicle.

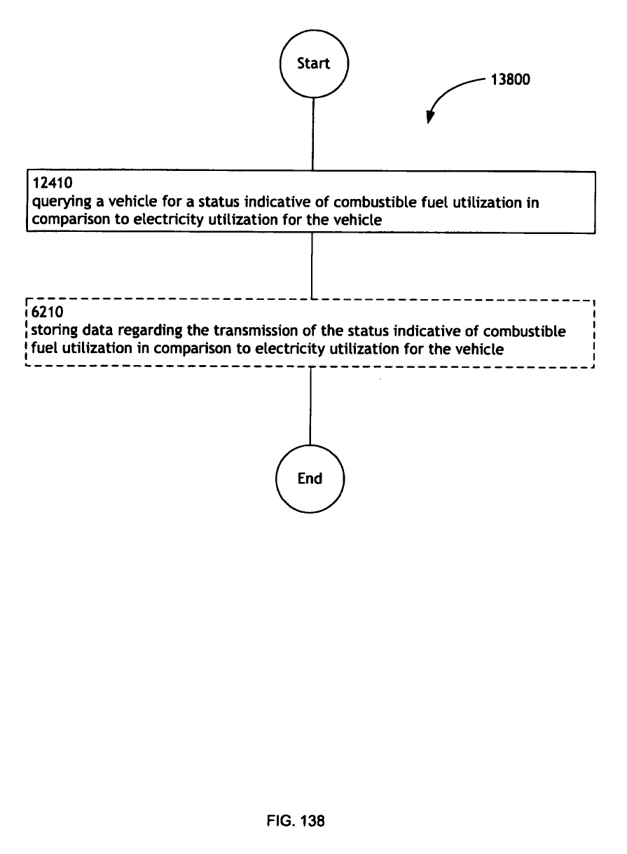

FIG. 138 illustrates an operational flow 13800 representing example operations related to querying a vehicle for a status indicative of combustible fuel utilization in comparison to electricity utilization for the vehicle and storing data regarding the transmission of the status. FIG. 138 illustrates an example embodiment where the example operational flow 12400 of FIG. 124 may include at least one additional operation. Additional operations may include an operation 6210.

After a start operation and an operation 12410, the operational flow 13800 moves to an operation 6210. Operation 6210 illustrates storing data regarding the transmission of the status indicative of combustible fuel utilization in comparison to electricity utilization for the vehicle.

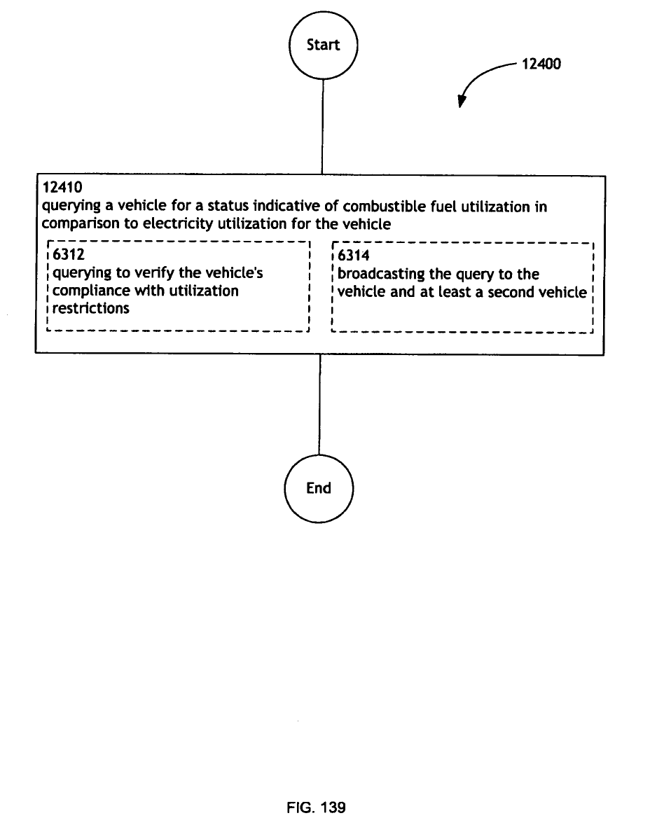

FIG. 139 illustrates alternative embodiments of the example operational flow 12400 of FIG. 124. FIG. 139 illustrates example embodiments where the operation 12410 may include at least one additional operation. Additional operations may include an operation 6312, and/or an operation 6314.

The operation 6312 illustrates querying to verify the vehicle's compliance with utilization restrictions.

The operation 6314 illustrates broadcasting the query to the vehicle and at least a second vehicle.

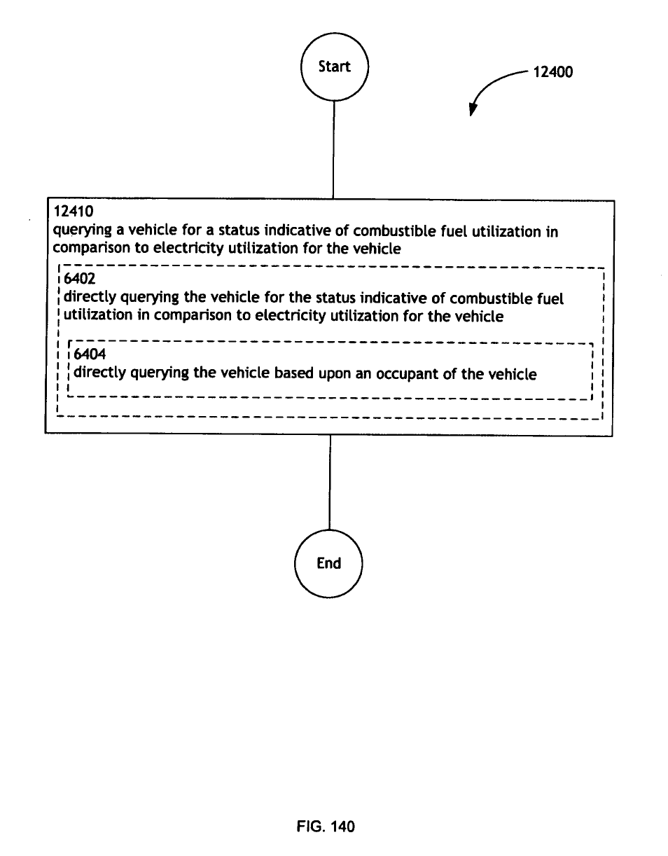

FIG. 140 illustrates alternative embodiments of the example operational flow 12400 of FIG. 124. FIG. 140 illustrates example embodiments where the operation 12410 may include at least one additional operation. Additional operations may include an operation 6402, and/or an operation 6404.

The operation 6402 illustrates directly querying the vehicle for the status indicative of combustible fuel utilization in comparison to electricity utilization for the vehicle. Further, the operation 6404 illustrates directly querying the vehicle based upon an occupant of the vehicle.

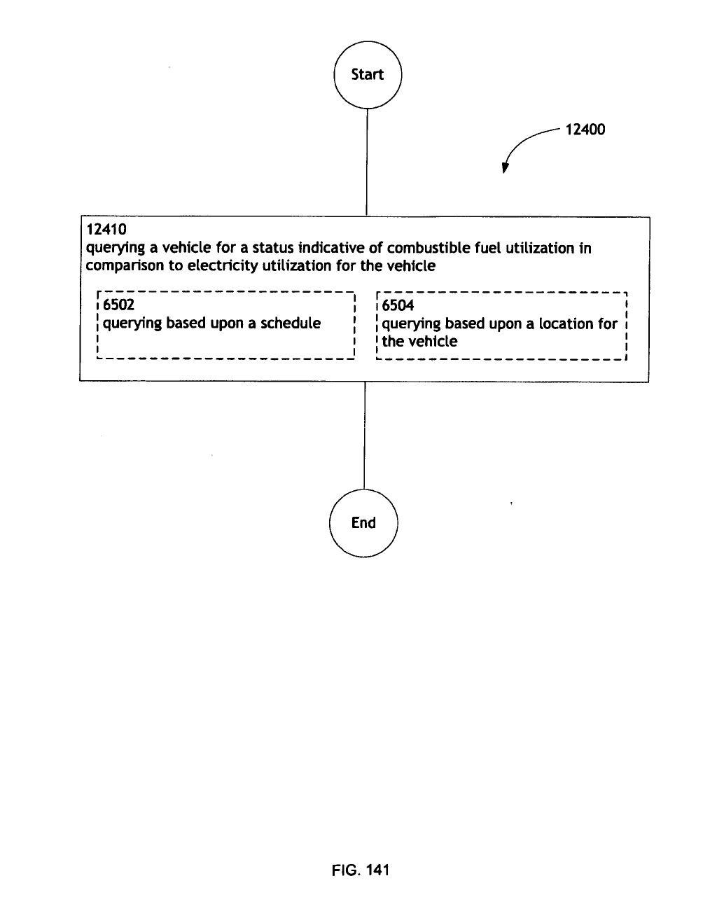

FIG. 141 illustrates alternative embodiments of the example operational flow 12400 of FIG. 124. FIG. 141 illustrates example embodiments where the operation 12410 may include at least one additional operation. Additional operations may include an operation 6502, and/or an operation 6504.

The operation 6502 illustrates querying based upon a schedule.

The operation 6504 illustrates querying based upon a location for the vehicle.

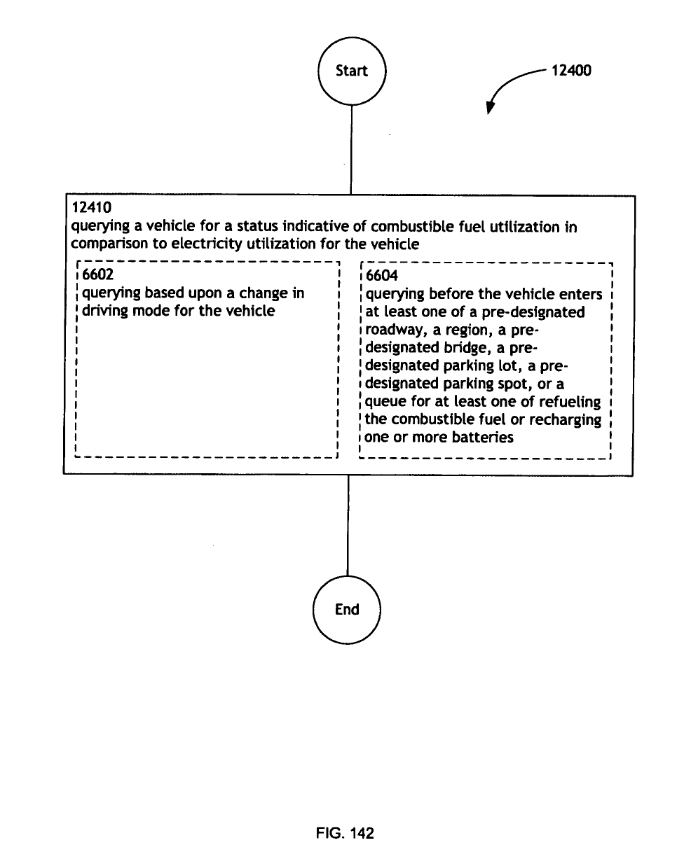

FIG. 142 illustrates alternative embodiments of the example operational flow 12400 of FIG. 124. FIG. 142 illustrates example embodiments where the operation 12410 may include at least one additional operation. Additional operations may include an operation 6602, and/or an operation 6604.

The operation 6602 illustrates querying based upon a change in driving mode for the vehicle.

The operation 6604 illustrates querying before the vehicle enters at least one of a pre-designated roadway, a region, a pre-designated bridge, a pre-designated parking lot, a pre-designated parking spot, or a queue for at least one of refueling the combustible fuel or recharging one or more batteries.

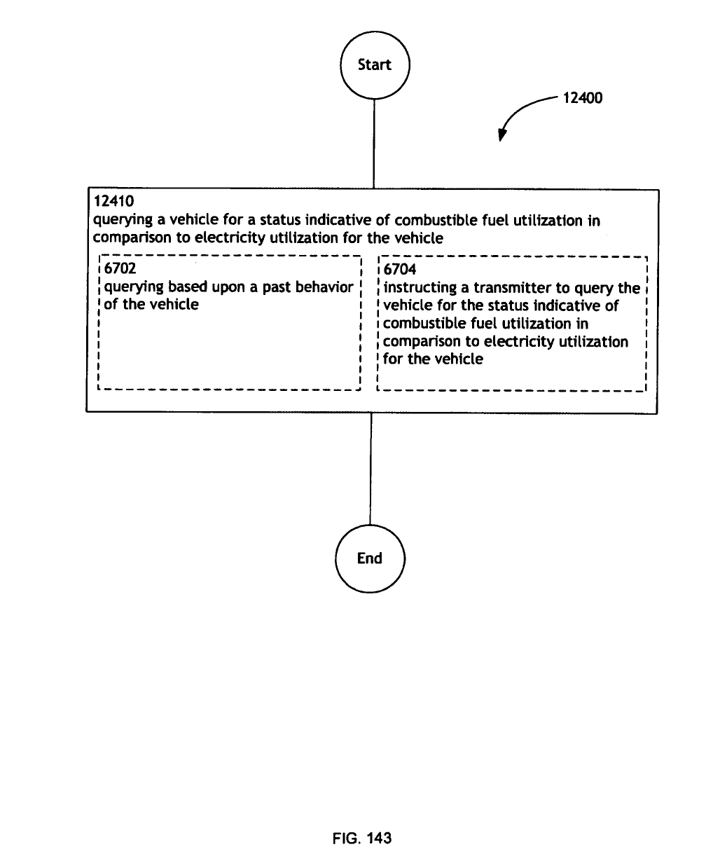

FIG. 143 illustrates alternative embodiments of the example operational flow 12400 of FIG. 124. FIG. 143 illustrates example embodiments where the operation 12410 may include at least one additional operation. Additional operations may include an operation 6702, and/or an operation 6704.

The operation 6702 illustrates querying based upon a past behavior of the vehicle.

The operation 6704 illustrates instructing a transmitter to query the vehicle for the status indicative of combustible fuel utilization in comparison to electricity utilization for the vehicle.

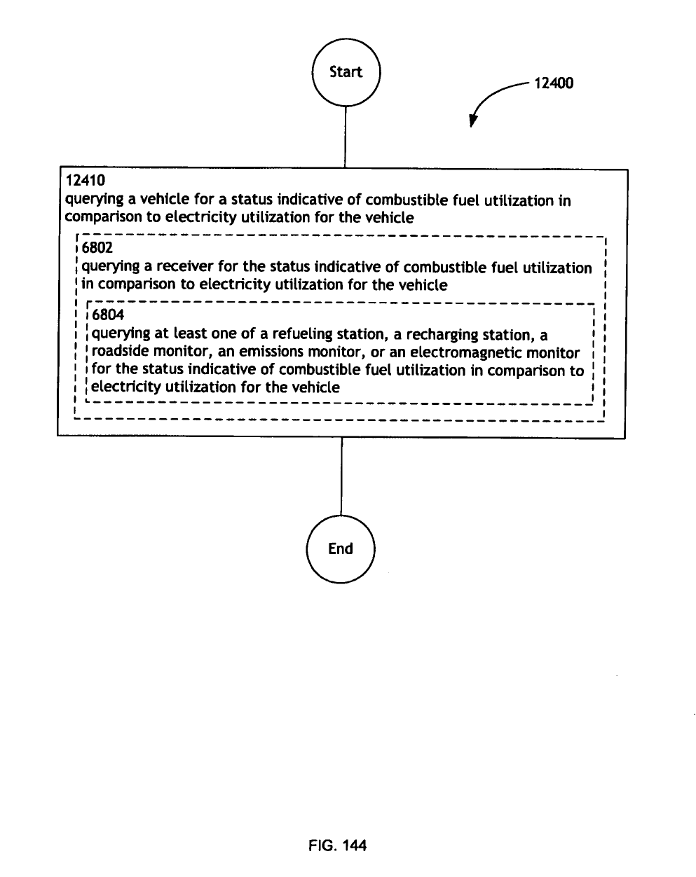

FIG. 144 illustrates alternative embodiments of the example operational flow 12400 of FIG. 124. FIG. 144 illustrates example embodiments where the operation 6310 may include at least one additional operation. Additional operations may include an operation 6802, and/or an operation 6804.

The operation 6802 illustrates querying a receiver for the status indicative of combustible fuel utilization in comparison to electricity utilization for the vehicle. Further, the operation 6804 illustrates querying at least one of a refueling station, a recharging station, a roadside monitor, an emissions monitor, or an electromagnetic monitor for the status indicative of combustible fuel utilization in comparison to electricity utilization for the vehicle.

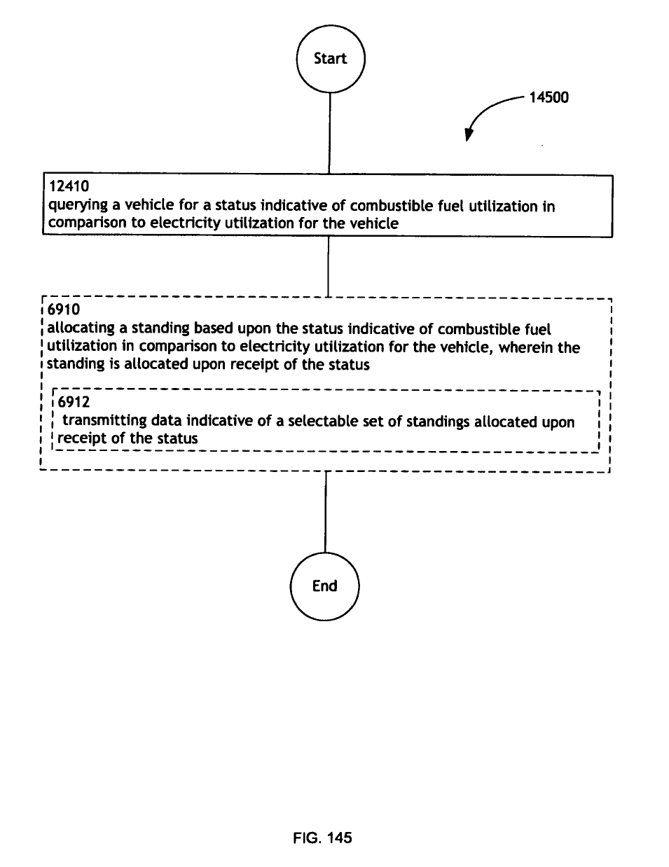

FIG. 145 illustrates an operational flow 14500 representing example operations related to querying a vehicle for a status indicative of combustible fuel utilization in comparison to electricity utilization for the vehicle and allocating a standing based upon the status indicative of combustible fuel utilization in comparison to electricity utilization for the vehicle, wherein the standing is allocated upon receipt of the status. FIG. 145 illustrates an example embodiment where the example operational flow 12400 of FIG. 124 may include at least one additional operation. Additional operations may include an operation 6910, and/or an operation 6912.

After a start operation and an operation 12410, the operational flow 14500 moves to an operation 6910. Operation 6910 illustrates allocating a standing based upon the status indicative of combustible fuel utilization in comparison to electricity utilization for the vehicle, wherein the standing is allocated upon receipt of the status.

The operation 6912 illustrates transmitting data indicative of a selectable set of standings allocated upon receipt of the status.

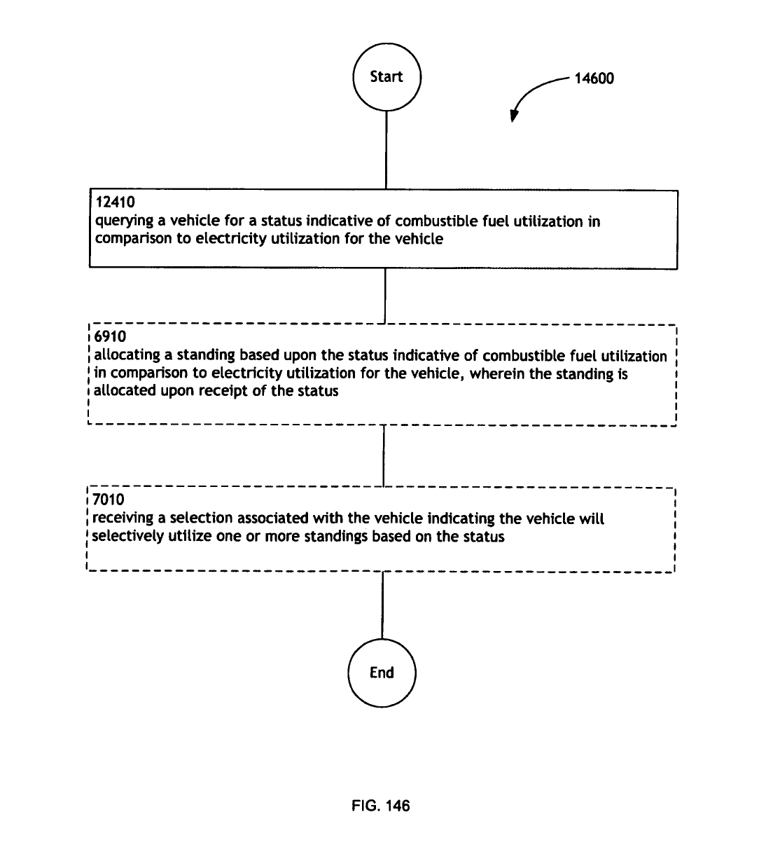

FIG. 146 illustrates an operational flow 14600 representing example operations related to querying a vehicle for a status indicative of combustible fuel utilization in comparison to electricity utilization for the vehicle, allocating a standing based upon the status for the vehicle, and receiving a selection associated with the vehicle. FIG. 146 illustrates an example embodiment where the example operational flow 14500 of FIG. 145 may include at least one additional operation. Additional operations may include an operation 7010.

After a start operation, an operation 12410, and an operation 6910, the operational flow 14600 moves to an operation 7010. Operation 7010 illustrates receiving a selection associated with the vehicle indicating the vehicle will selectively utilize one or more standings based on the status.

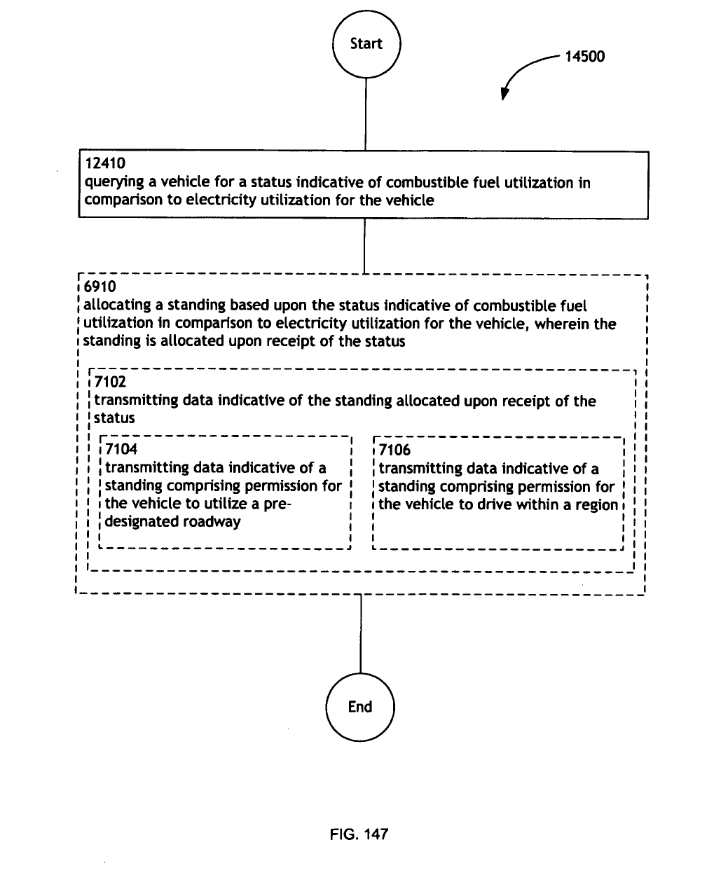

FIG. 147 illustrates alternative embodiments of the example operational flow 14500 of FIG. 145. FIG. 147 illustrates example embodiments where the operation 6910 may include at least one additional operation. Additional operations may include an operation 7102, an operation 7104, and/or an operation 7106.

The operation 7102 illustrates transmitting data indicative of the standing allocated upon receipt of the status. Further, the operation 7104 illustrates transmitting data indicative of a standing comprising permission for the vehicle to utilize a pre-designated roadway. Further, the operation 7106 illustrates transmitting data indicative of a standing comprising permission for the vehicle to drive within a region.

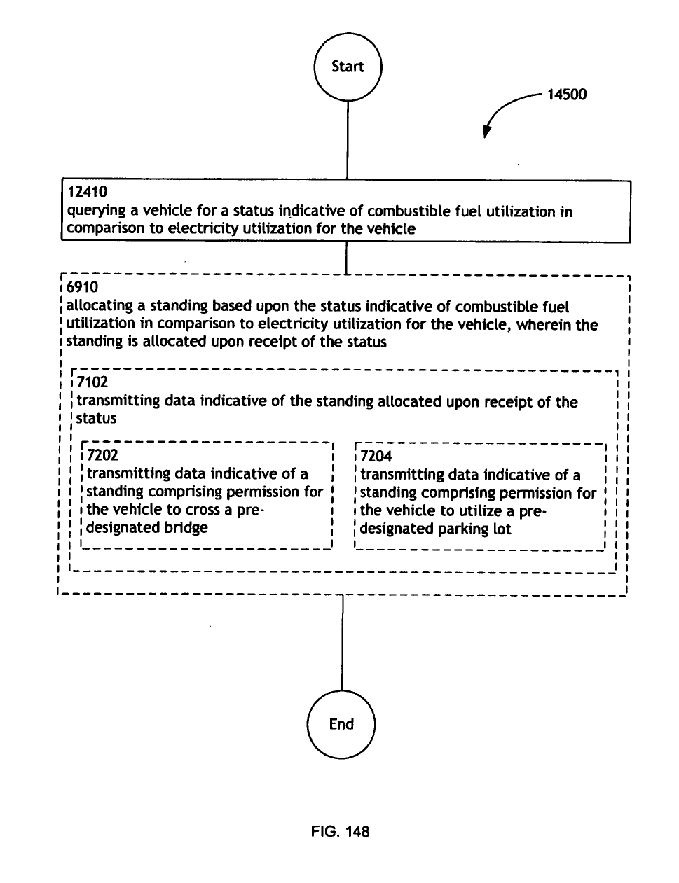

FIG. 148 illustrates alternative embodiments of the example operational flow 14500 of FIG. 145. FIG. 148 illustrates example embodiments where the operation 6910 may include at least one additional operation. Additional operations may include an operation 7202, and/or an operation 7204. Further, the operation 7202 illustrates transmitting data indicative of a standing comprising permission for the vehicle to cross a pre-designated bridge. Further, the operation 7204 illustrates transmitting data indicative of a standing comprising permission for the vehicle to utilize a pre-designated parking lot.

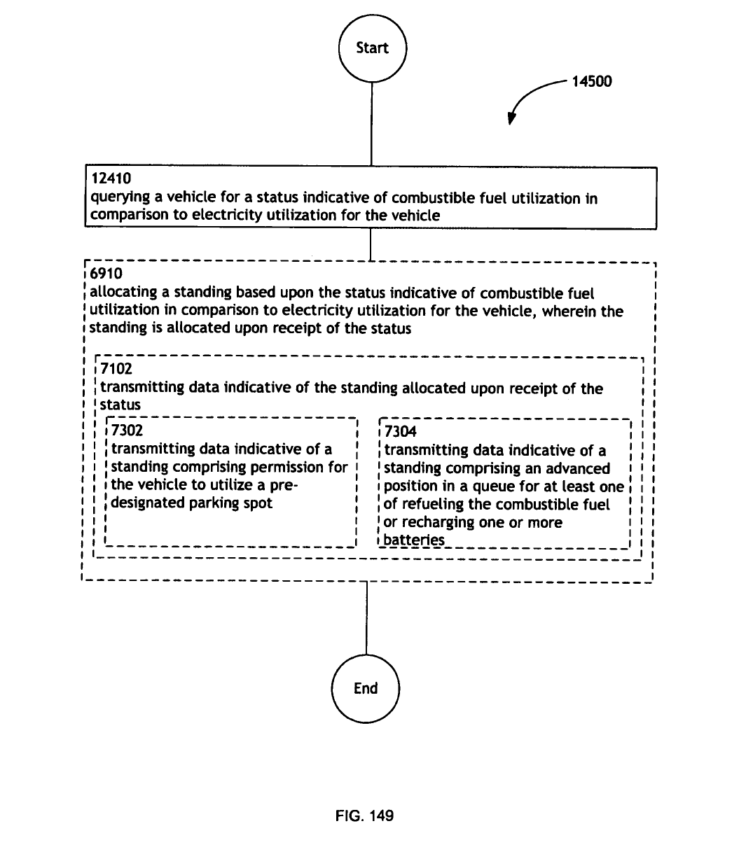

FIG. 149 illustrates alternative embodiments of the example operational flow 14500 of FIG. 145. FIG. 149 illustrates example embodiments where the operation 6910 may include at least one additional operation. Additional operations may include an operation 7302, and/or an operation 7304. Further, the operation 7302 illustrates transmitting data indicative of a standing comprising permission for the vehicle to utilize a pre-designated parking spot. Further, the operation 7304 illustrates transmitting data indicative of a standing comprising an advanced position in a queue for at least one of refueling the combustible fuel or recharging one or more batteries.

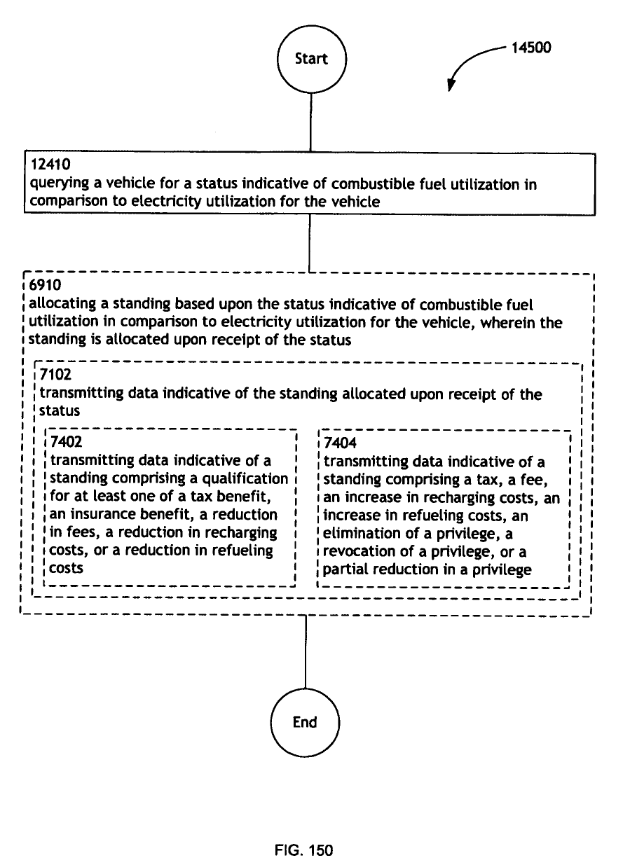

FIG. 150 illustrates alternative embodiments of the example operational flow 14500 of FIG. 145. FIG. 150 illustrates example embodiments where the operation 6910 may include at least one additional operation. Additional operations may include an operation 7402, and/or an operation 7404. Further, the operation 7402 illustrates transmitting data indicative of a standing comprising a qualification for at least one of a tax benefit, an insurance benefit, a reduction in fees, a reduction in recharging costs, or a reduction in refueling costs. Further, the operation 7404 illustrates transmitting data indicative of a standing comprising a tax, a fee, an increase in recharging costs, an increase in refueling costs, an elimination of a privilege, a revocation of a privilege, or a partial reduction in a privilege.

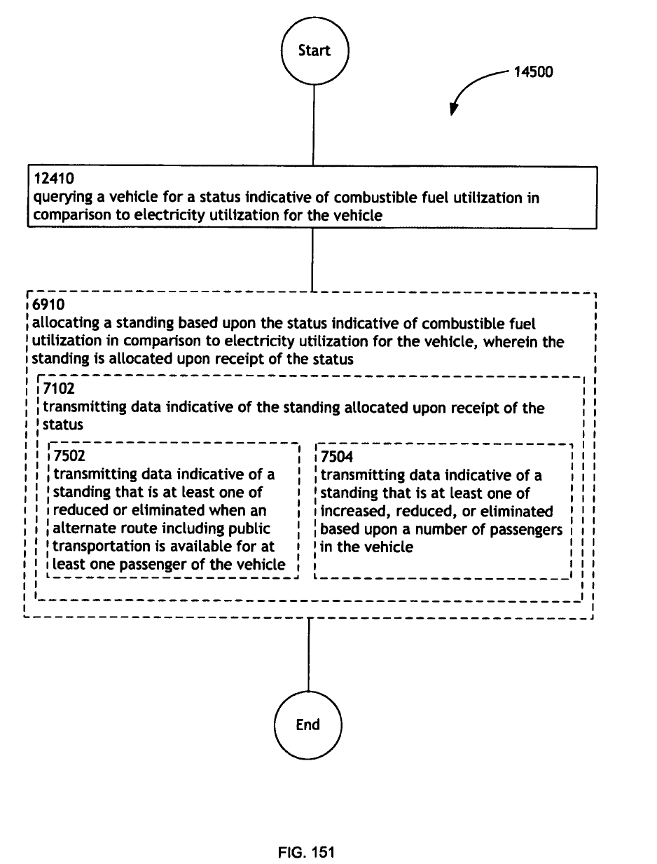

FIG. 151 illustrates alternative embodiments of the example operational flow 14500 of FIG. 145. FIG. 151 illustrates example embodiments where the operation 6910 may include at least one additional operation. Additional operations may include an operation 7502, and/or an operation 7504. Further, the operation 7502 illustrates transmitting data indicative of a standing that is at least one of reduced or eliminated when an alternate route including public transportation is available for at least one passenger of the vehicle. Further, the operation 7504 illustrates transmitting data indicative of a standing that is at least one of increased, reduced, or eliminated based upon a number of passengers in the vehicle.

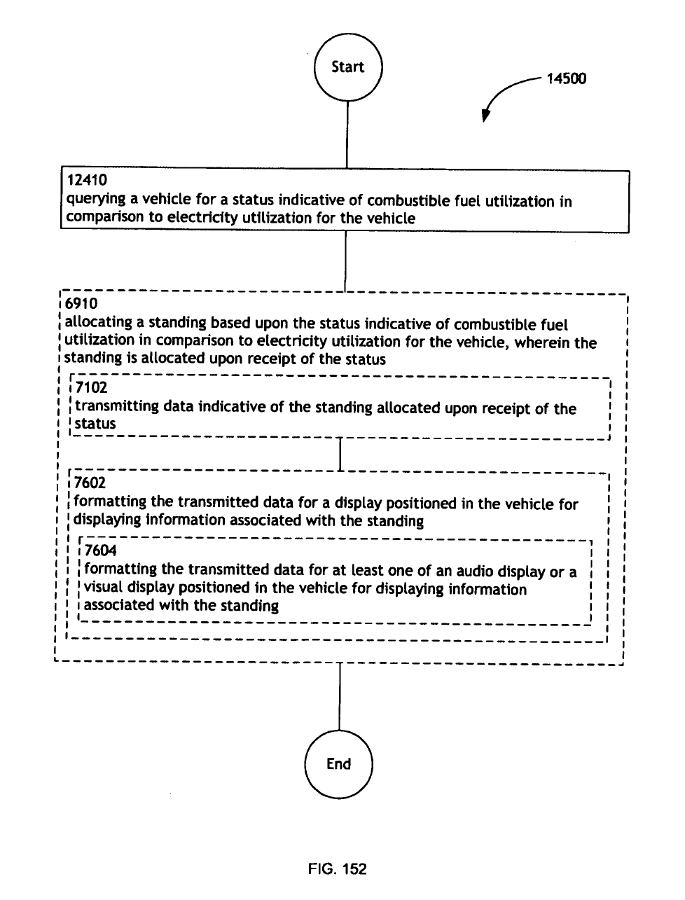

FIG. 152 illustrates alternative embodiments of the example operational flow 14500 of FIG. 145. FIG. 152 illustrates example embodiments where the operation 6910 may include at least one additional operation. Additional operations may include an operation 7602, and/or an operation 7604. Further, the operation 7602 illustrates formatting the transmitted data for a display positioned in the vehicle for displaying information associated with the standing. Further, the operation 7604 illustrates formatting the transmitted data for at least one of an audio display or a visual display positioned in the vehicle for displaying information associated with the standing.

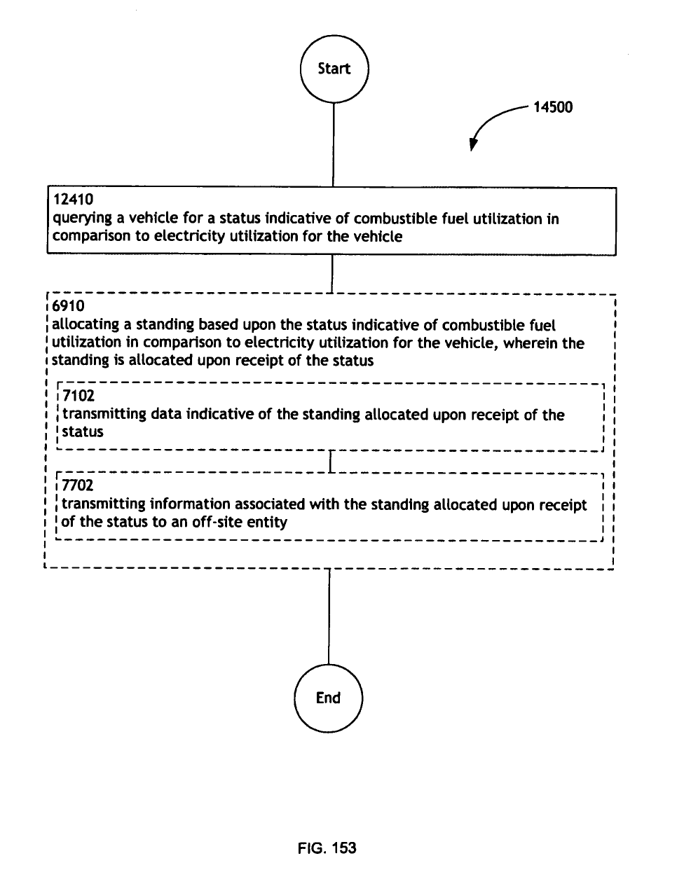

FIG. 153 illustrates alternative embodiments of the example operational flow 14500 of FIG. 145. FIG. 153 illustrates example embodiments where the operation 6910 may include at least one additional operation. Additional operations may include an operation 7702. Further, the operation 7702 illustrates transmitting information associated with the standing allocated upon receipt of the status to an off-site entity.

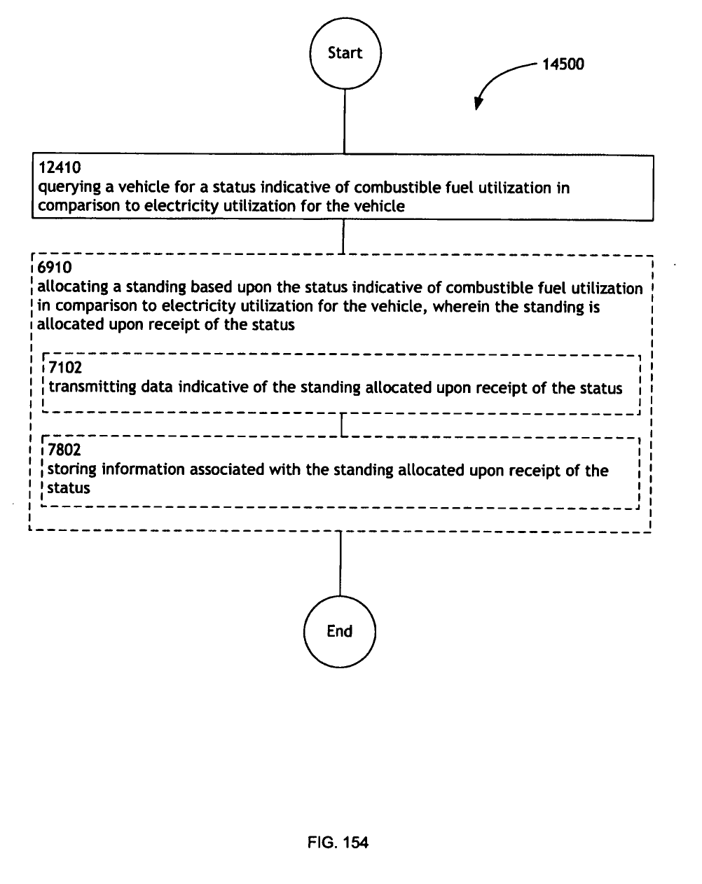

FIG. 154 illustrates alternative embodiments of the example operational flow 14500 of FIG. 145. FIG. 154 illustrates example embodiments where the operation 6910 may include at least one additional operation. Additional operations may include an operation 7802. Further, the operation 7802 illustrates storing information associated with the standing allocated upon receipt of the status.

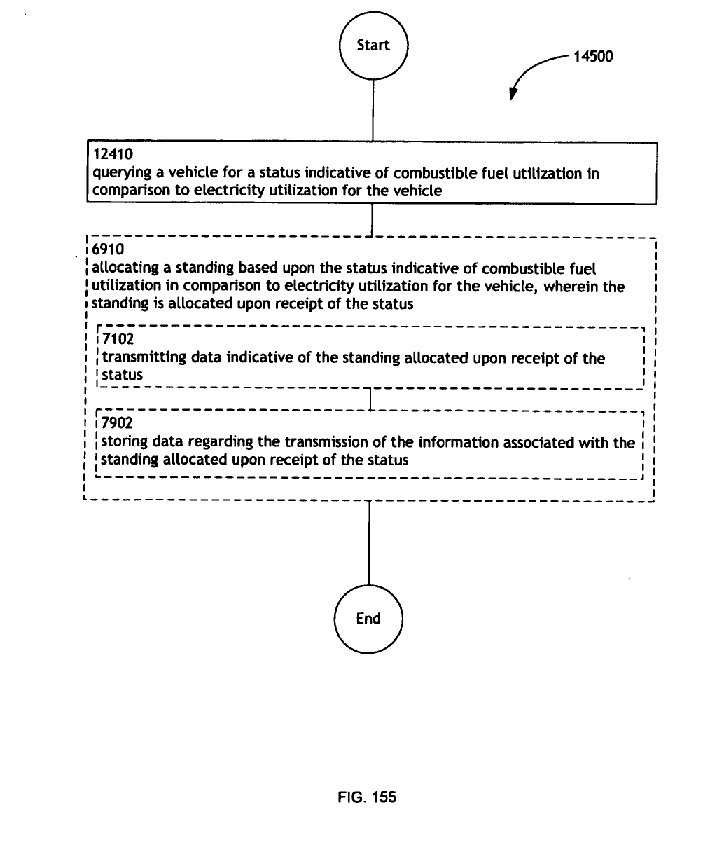

FIG. 155 illustrates alternative embodiments of the example operational flow 14500 of FIG. 145. FIG. 155 illustrates example embodiments where the operation 6910 may include at least one additional operation. Additional operations may include an operation 7902. Further, the operation 7902 illustrates storing data regarding the transmission of the information associated with the standing allocated upon receipt of the status.

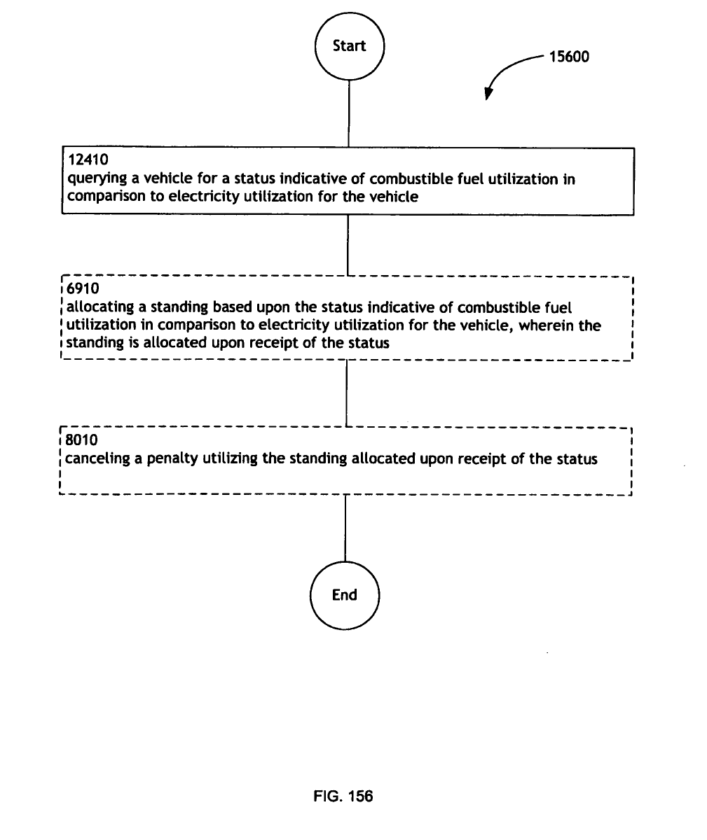

FIG. 156 illustrates an operational flow 15600 representing example operations related to querying a vehicle for a status indicative of combustible fuel utilization in comparison to electricity utilization for the vehicle, allocating a standing based upon the status for the vehicle, and canceling a penalty utilizing the standing. FIG. 156 illustrates an example embodiment where the example operational flow 14500 of FIG. 145 may include at least one additional operation. Additional operations may include an operation 8010.

After a start operation, an operation 12410, and an operation 6910, the operational flow 15600 moves to an operation 8010. Operation 8010 illustrates canceling a penalty utilizing the standing allocated upon receipt of the status.

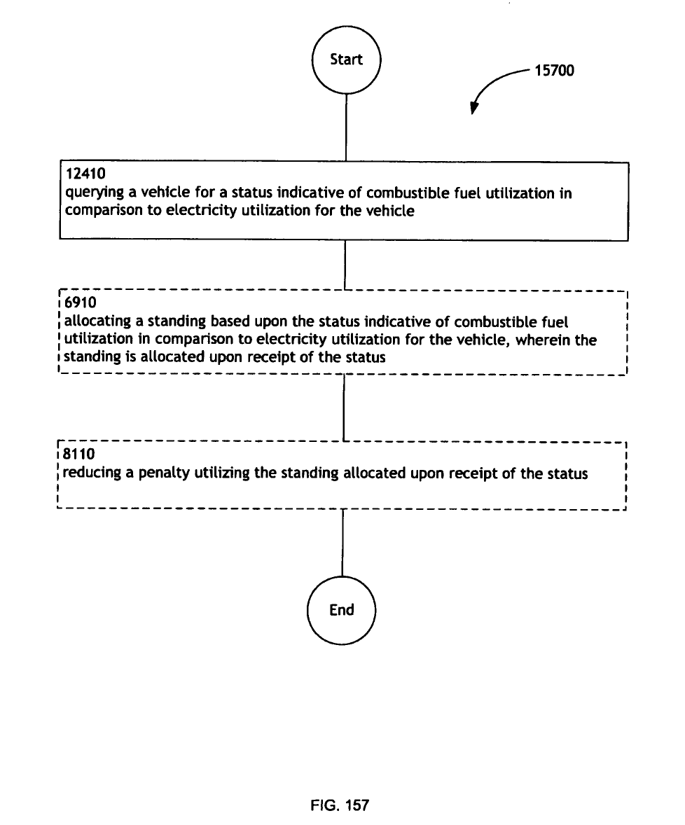

FIG. 157 illustrates an operational flow 15700 representing example operations related to querying a vehicle for a status indicative of combustible fuel utilization in comparison to electricity utilization for the vehicle, allocating a standing based upon the status for the vehicle, and reducing a penalty utilizing the standing. FIG. 157 illustrates an example embodiment where the example operational flow 14500 of FIG. 145 may include at least one additional operation. Additional operations may include an operation 8110.

After a start operation, an operation 12410, and an operation 6910, the operational flow 15700 moves to an operation 8110. Operation 8110 illustrates reducing a penalty utilizing the standing allocated upon receipt of the status.

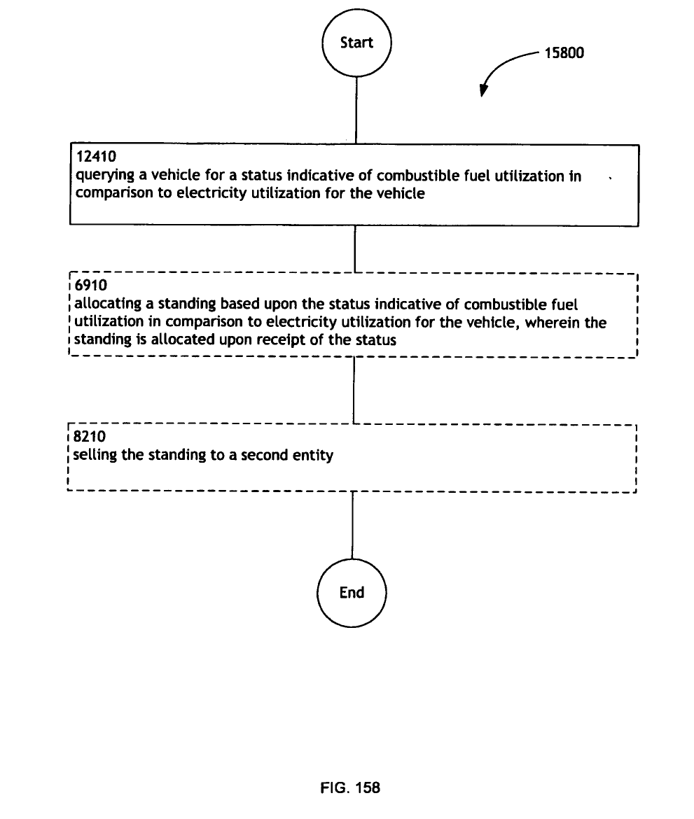

FIG. 158 illustrates an operational flow 15800 representing example operations related to querying a vehicle for a status indicative of combustible fuel utilization in comparison to electricity utilization for the vehicle, allocating a standing based upon the status for the vehicle, and selling the standing to a second entity. FIG. 158 illustrates an example embodiment where the example operational flow 14500 of FIG. 145 may include at least one additional operation. Additional operations may include an operation 8210.

After a start operation, an operation 12410, and an operation 6910, the operational flow 15800 moves to an operation 8210. Operation 8210 illustrates selling the standing to a second entity.

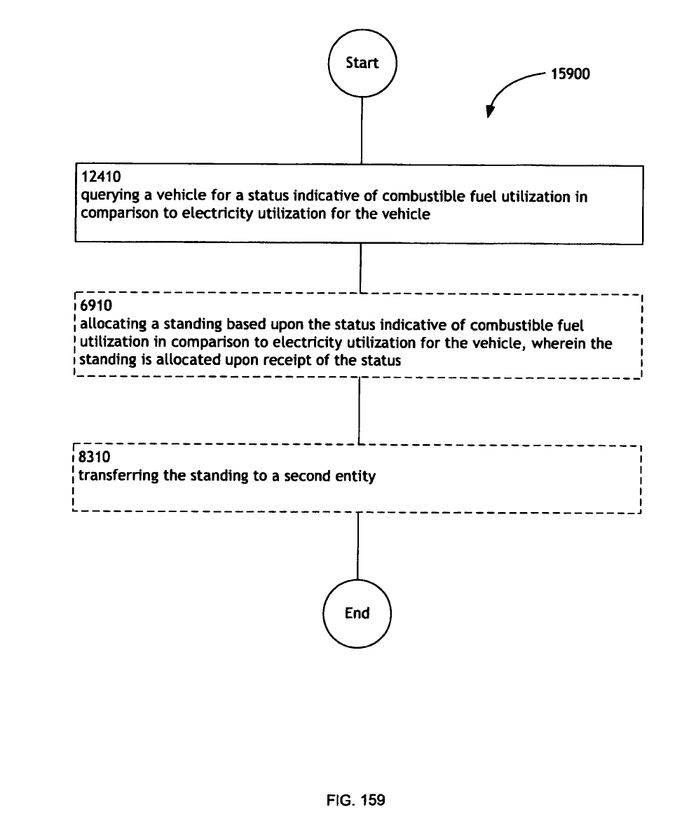

FIG. 159 illustrates an operational flow 15900 representing example operations related to querying a vehicle for a status indicative of combustible fuel utilization in comparison to electricity utilization for the vehicle, allocating a standing based upon the status for the vehicle, and transferring the standing to a second entity. FIG. 159 illustrates an example embodiment where the example operational flow 14500 of FIG. 145 may include at least one additional operation. Additional operations may include an operation 8310.

After a start operation, an operation 12410, and an operation 6910, the operational flow 15900 moves to an operation 8310. Operation 8310 illustrates transferring the standing to a second entity.

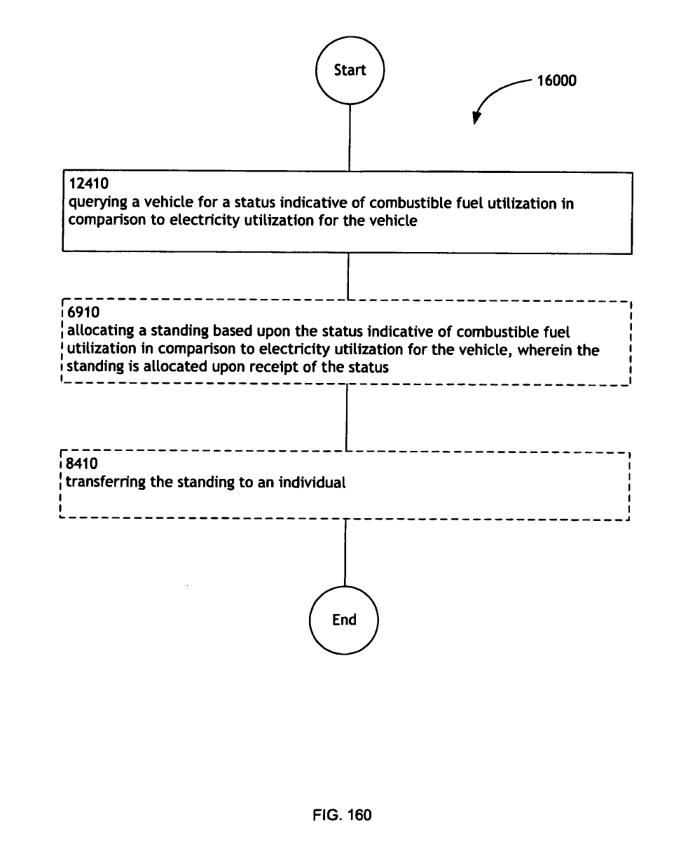

FIG. 160 illustrates an operational flow 16000 representing example operations related to querying a vehicle for a status indicative of combustible fuel utilization in comparison to electricity utilization for the vehicle, allocating a standing based upon the status for the vehicle, and transferring the standing to an individual. FIG. 160 illustrates an example embodiment where the example operational flow 14500 of FIG. 145 may include at least one additional operation. Additional operations may include an operation 8410.

After a start operation, an operation 12410, and an operation 6910, the operational flow 16000 moves to an operation 8410. Operation 8410 illustrates transferring the standing to an individual.

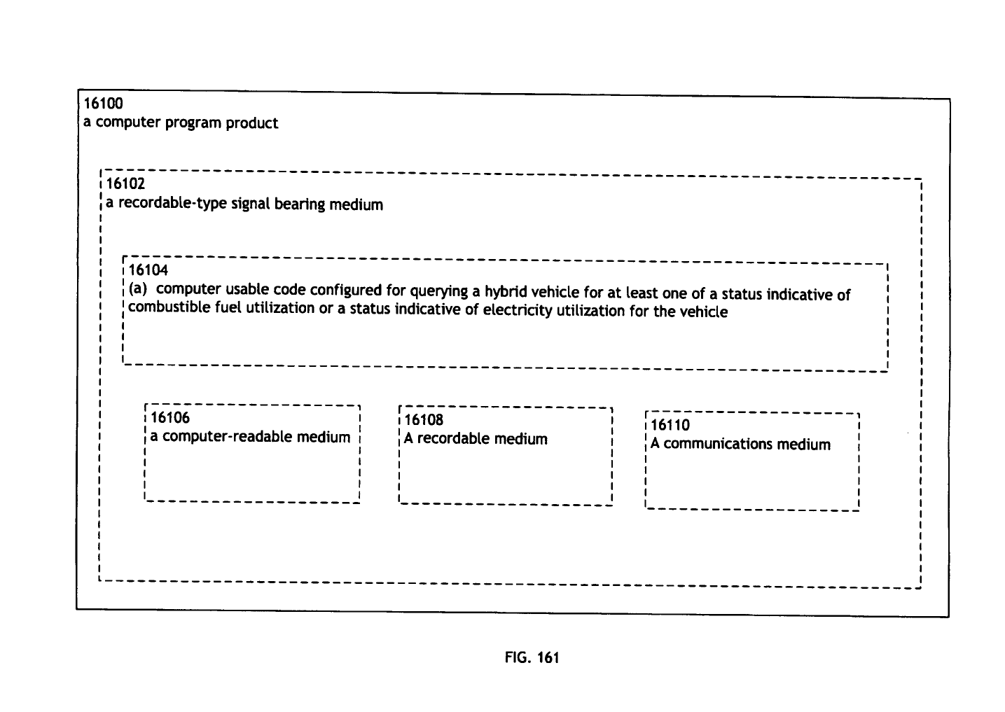

FIG. 161 illustrates a partial view of an example computer program product 16100 that includes a computer program 16104 for executing a computer process on a computing device. An embodiment of the example computer program product 16100 is provided using a recordable-type signal bearing medium 16102, and may include computer usable code configured for querying a hybrid vehicle for at least one of a status indicative of combustible fuel utilization or a status indicative of electricity utilization for the vehicle. The computer usable code may be, for example, computer executable and/or logic-implemented instructions. In one implementation, the signal-bearing medium 16102 may include a computer-readable medium 16106. In one implementation, the signal bearing medium 16102 may include a recordable medium 16108. In one implementation, the signal bearing medium 16102 may include a communications medium 16110. In an embodiment, allocating the standing based upon the at least one of the status indicative of combustible fuel utilization or the status indicative of electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

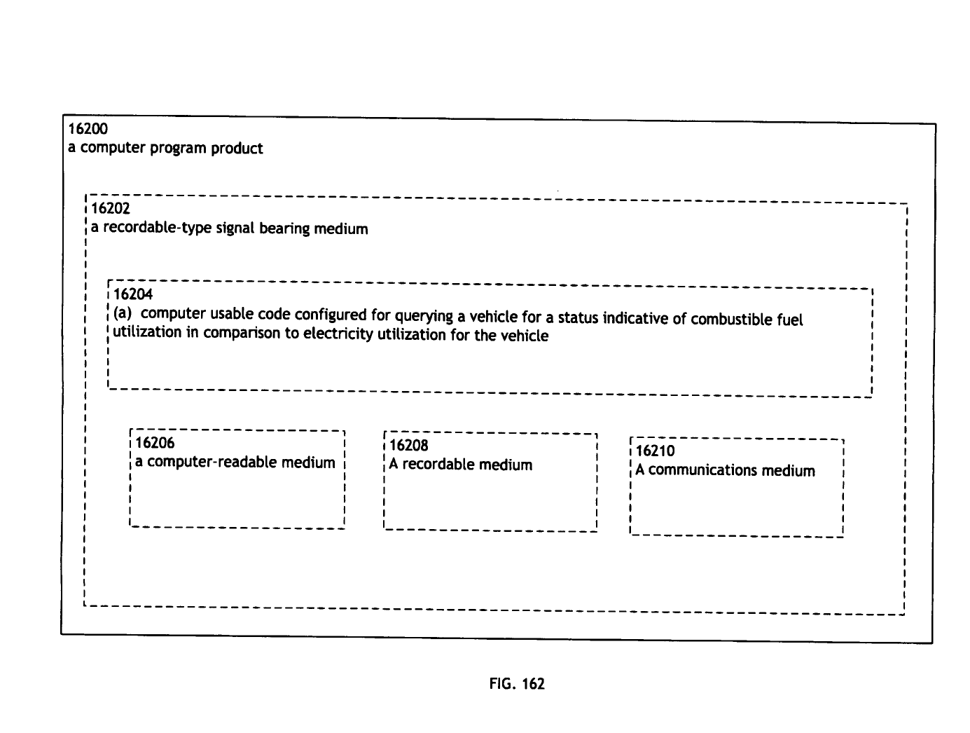

FIG. 162 illustrates a partial view of an example computer program product 16200 that includes a computer program 16204 for executing a computer process on a computing device. An embodiment of the example computer program product 16200 is provided using a recordable-type signal bearing medium 16202, and may include computer usable code configured for querying a vehicle for a status indicative of combustible fuel utilization in comparison to electricity utilization for the vehicle. The computer usable code may be, for example, computer executable and/or logic-implemented instructions. In one implementation, the signal-bearing medium 16202 may include a computer-readable medium 16206. In one implementation, the signal bearing medium 16202 may include a recordable medium 16208. In one implementation, the signal bearing medium 16202 may include a communications medium 16210. In an embodiment, allocating the standing based upon the status indicative of combustible fuel utilization in comparison to electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

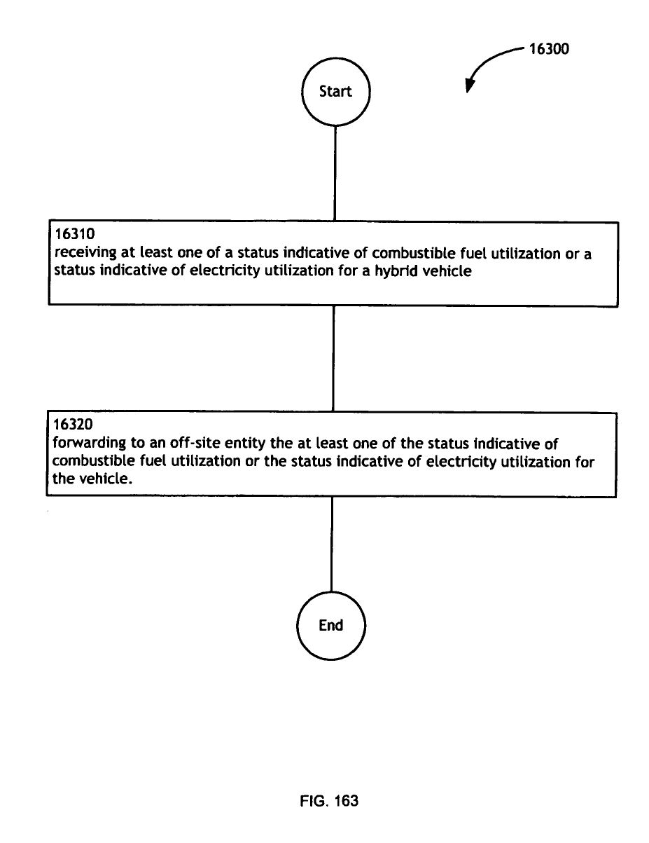

FIG. 163 illustrates an operational flow 16300 representing example operations related to receiving at least one of a status indicative of combustible fuel utilization or a status indicative of electricity utilization for a hybrid vehicle and forwarding to an off-site entity the at least one of the status indicative of combustible fuel utilization or the status indicative of electricity utilization for the vehicle. In FIG. 163 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 16300 moves to an operation 16310. Operation 16310 depicts receiving at least one of a status indicative of combustible fuel utilization or a status indicative of electricity utilization for a hybrid vehicle. For example, as shown in FIGS. 1 through 10, the vehicle 100 may utilize the transmitter 120 to transmit a status indicative of, for example, one or more of combustible fuel utilization and electricity utilization for the vehicle 100. In an embodiment, the off-site entity 144 or a repeater/retransmitting device may receive the status transmitted by the vehicle 100.

Then, operation 16320 depicts forwarding to an off-site entity the at least one of the status indicative of combustible fuel utilization or the status indicative of electricity utilization for the vehicle. For example, as shown in FIGS. 1 through 10, the vehicle 100 or the repeater/retransmitting device may forward (e.g., utilizing the transmitter 120) a status indicative of, for example, one or more of combustible fuel utilization and electricity utilization for the vehicle 100. In an embodiment, the off-site entity 144 may receive the status transmitted by the vehicle 100 or the repeater/retransmitting device.

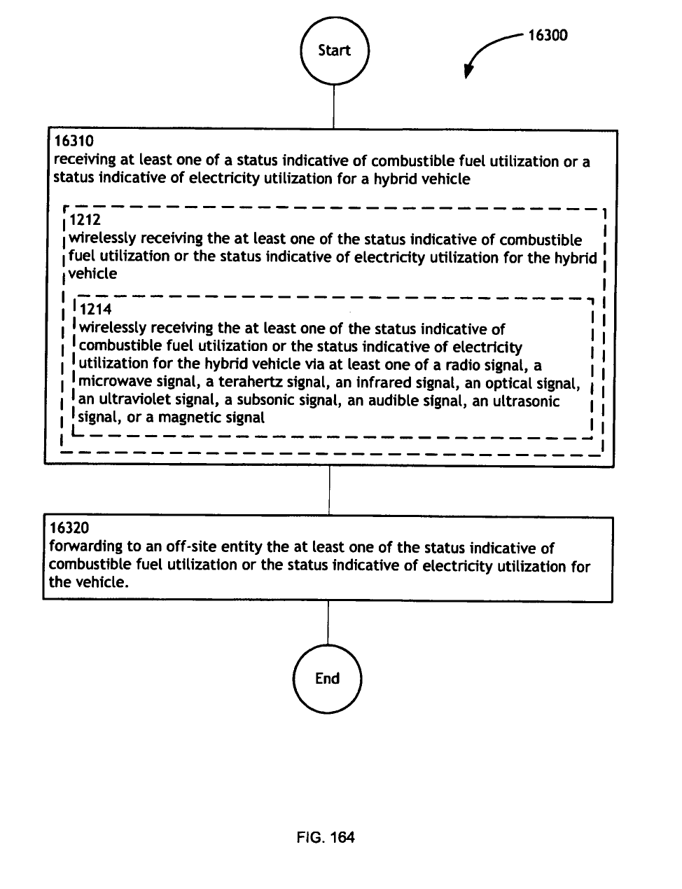

FIG. 164 illustrates alternative embodiments of the example operational flow 16300 of FIG. 163. FIG. 164 illustrates example embodiments where the operation 16310 may include at least one additional operation. Additional operations may include an operation 1212, and/or an operation 1214.

The operation 1212 illustrates wirelessly receiving the at least one of the status indicative of combustible fuel utilization or the status indicative of electricity utilization for the hybrid vehicle. Further, the operation 1214 illustrates wirelessly receiving the at least one of the status indicative of combustible fuel utilization or the status indicative of electricity utilization for the hybrid vehicle via at least one of a radio signal, a microwave signal, a terahertz signal, an infrared signal, an optical signal, an ultraviolet signal, a subsonic signal, an audible signal, an ultrasonic signal, or a magnetic signal.

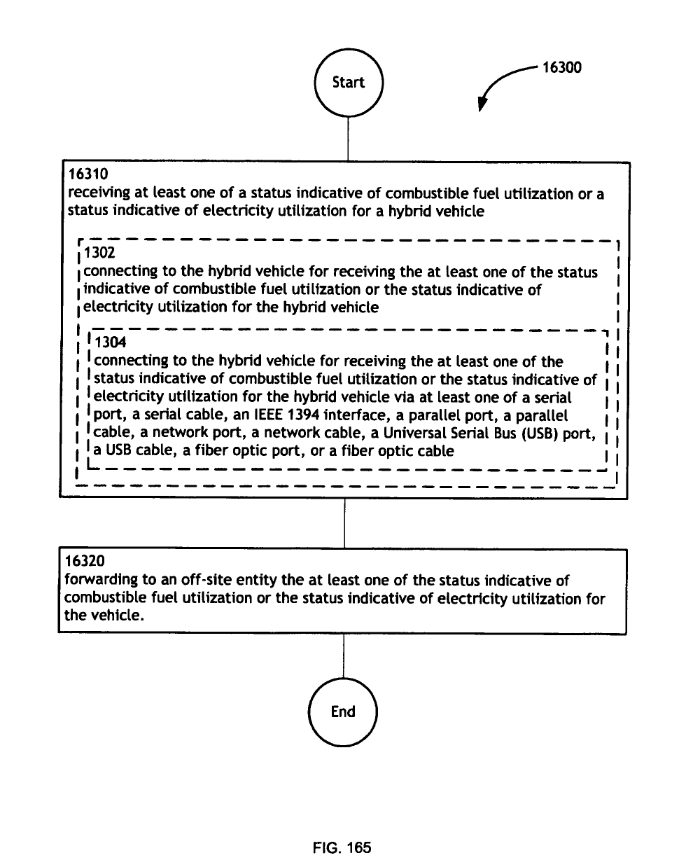

FIG. 165 illustrates alternative embodiments of the example operational flow 16300 of FIG. 163. FIG. 165 illustrates example embodiments where the operation 16310 may include at least one additional operation. Additional operations may include an operation 1302, and/or an operation 1304.

The operation 1302 illustrates connecting to the hybrid vehicle for receiving the at least one of the status indicative of combustible fuel utilization or the status indicative of electricity utilization for the hybrid vehicle. Further, the operation 1304 illustrates connecting to the hybrid vehicle for receiving the at least one of the status indicative of combustible fuel utilization or the status indicative of electricity utilization for the hybrid vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

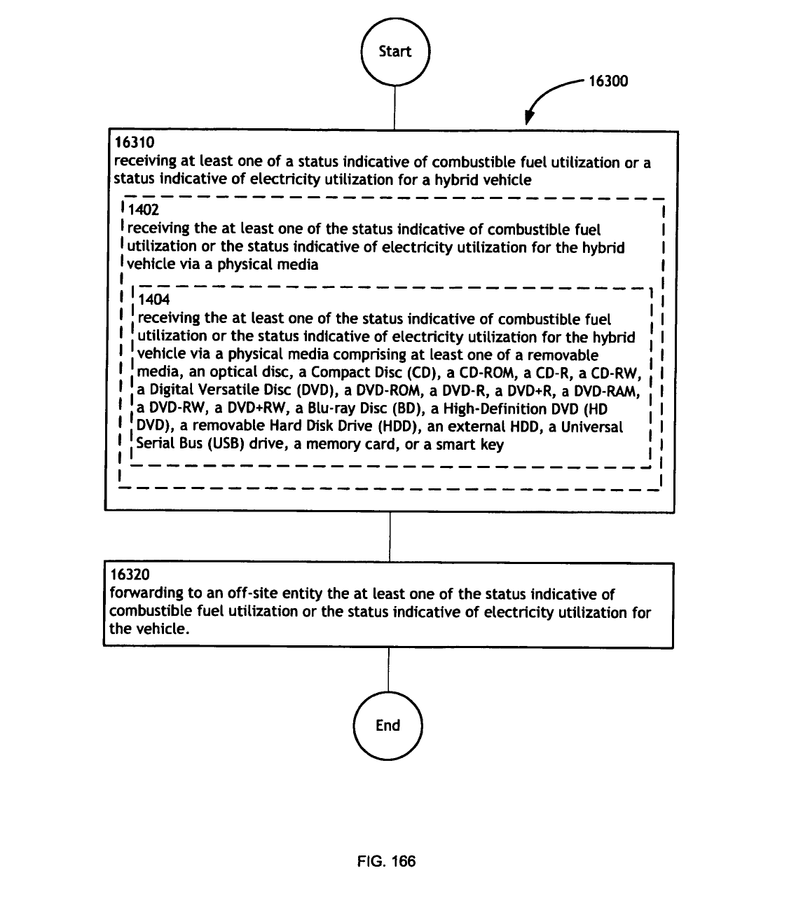

FIG. 166 illustrates alternative embodiments of the example operational flow 16300 of FIG. 163. FIG. 166 illustrates example embodiments where the operation 16310 may include at least one additional operation. Additional operations may include an operation 1402, and/or an operation 1404.

The operation 1402 illustrates receiving the at least one of the status indicative of combustible fuel utilization or the status indicative of electricity utilization for the hybrid vehicle via a physical media. Further, the operation 1404 illustrates receiving the at least one of the status indicative of combustible fuel utilization or the status indicative of electricity utilization for the hybrid vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

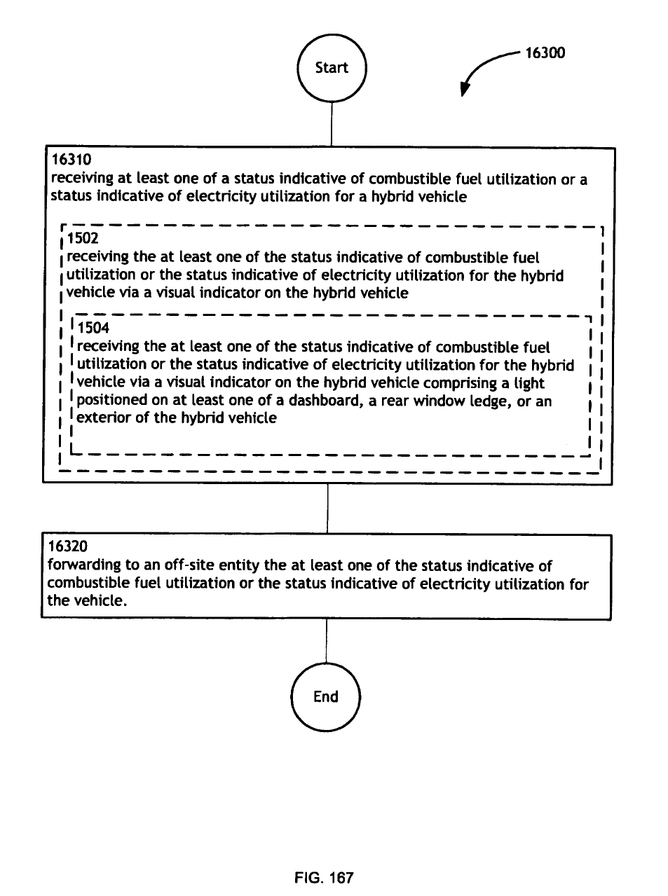

FIG. 167 illustrates alternative embodiments of the example operational flow 16300 of FIG. 163. FIG. 167 illustrates example embodiments where the operation 16310 may include at least one additional operation. Additional operations may include an operation 1502, and/or an operation 1504.

The operation 1502 illustrates receiving the at least one of the status indicative of combustible fuel utilization or the status indicative of electricity utilization for the hybrid vehicle via a visual indicator on the hybrid vehicle. Further, the operation 1504 illustrates receiving the at least one of the status indicative of combustible fuel utilization or the status indicative of electricity utilization for the hybrid vehicle via a visual indicator on the hybrid vehicle comprising a light positioned on at least one of a dashboard, a rear window ledge, or an exterior of the hybrid vehicle.

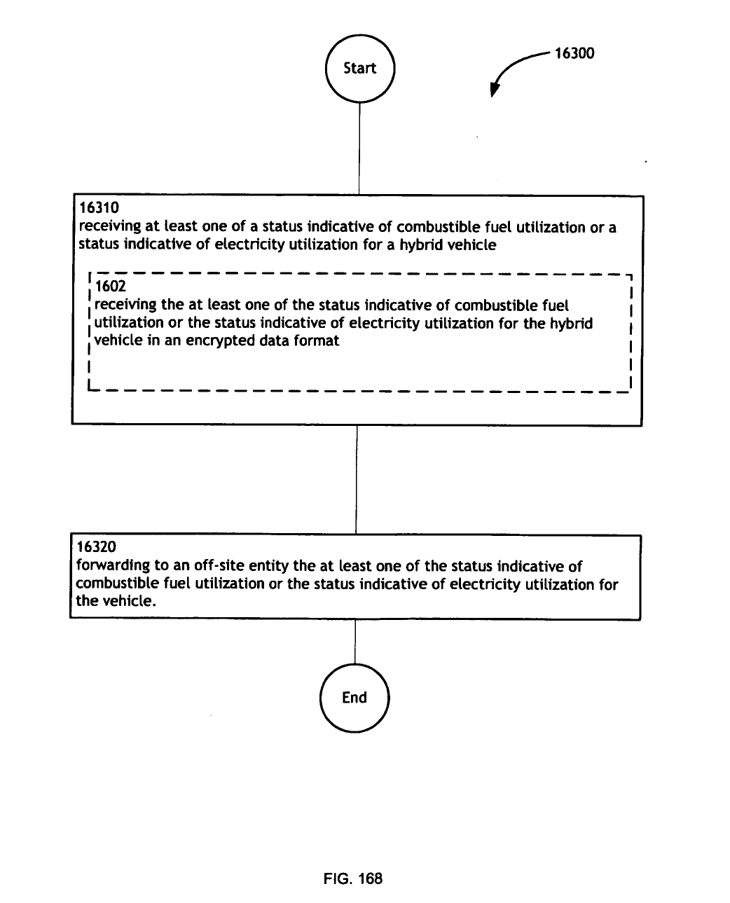

FIG. 168 illustrates alternative embodiments of the example operational flow 16300 of FIG. 163. FIG. 168 illustrates example embodiments where the operation 16310 may include at least one additional operation. Additional operations may include an operation 1602.

The operation 1602 illustrates receiving the at least one of the status indicative of combustible fuel utilization or the status indicative of electricity utilization for the hybrid vehicle in an encrypted data format.

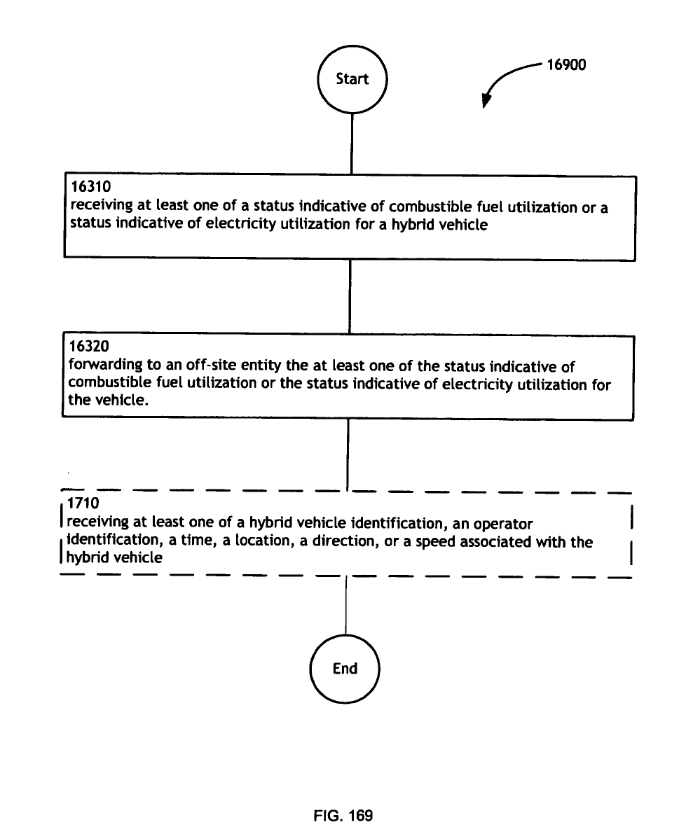

FIG. 169 illustrates an operational flow 16900 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and receiving at least one of a hybrid vehicle identification, an operator identification, a time, a location, a direction, or a speed associated with the hybrid vehicle. FIG. 169 illustrates an example embodiment where the example operational flow 16300 of FIG. 163 may include at least one additional operation. Additional operations may include an operation 1710.

After a start operation, an operation 16310, and an operation 16320, the operational flow 16900 moves to an operation 1710. Operation 1710 illustrates receiving at least one of a hybrid vehicle identification, an operator identification, a time, a location, a direction, or a speed associated with the hybrid vehicle.

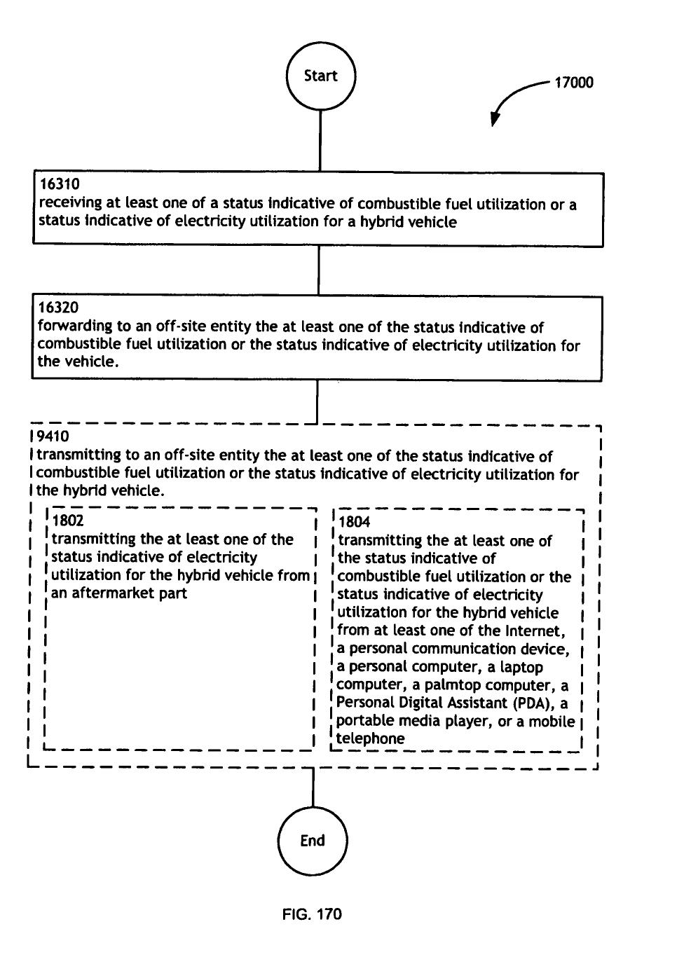

FIG. 170 illustrates an operational flow 17000 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and transmitting to an off-site entity the at least one of the status indicative of combustible fuel utilization or the status indicative of electricity utilization for the hybrid vehicle. FIG. 170 illustrates an example embodiment where the example operational flow 16300 of FIG. 163 may include at least one additional operation. Additional operations may include an operation 9410, an operation 1802, and/or an operation 1804.

After a start operation, an operation 16310, and an operation 16320, the operational flow 17000 moves to an operation 9410. Operation 9410 illustrates transmitting to an off-site entity the at least one of the status indicative of combustible fuel utilization or the status indicative of electricity utilization for the hybrid vehicle.

The operation 1802 illustrates transmitting the at least one of the status indicative of combustible fuel utilization or the status indicative of electricity utilization for the hybrid vehicle from an aftermarket part.

The operation 1804 illustrates transmitting the at least one of the status indicative of combustible fuel utilization or the status indicative of electricity utilization for the hybrid vehicle from at least one of the Internet, a personal communication device, a personal computer, a laptop computer, a palmtop computer, a Personal Digital Assistant (PDA), a portable media player, or a mobile telephone.

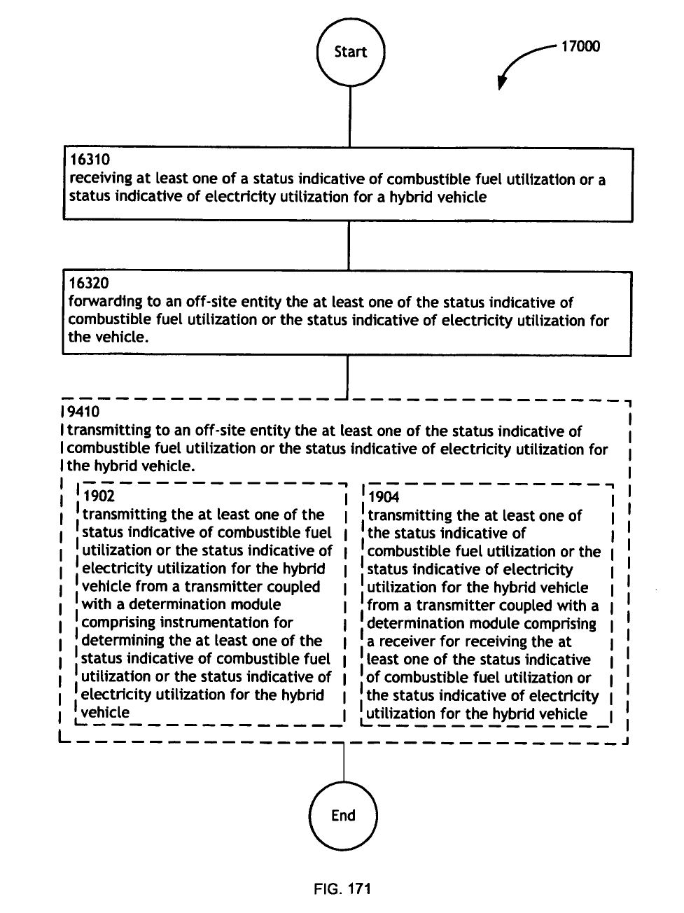

FIG. 171 illustrates alternative embodiments of the example operational flow 17000 of FIG. 170. FIG. 171 illustrates example embodiments where the operation 9410 may include at least one additional operation. Additional operations may include an operation 1902, and/or an operation 1904.

The operation 1902 illustrates transmitting the at least one of the status indicative of combustible fuel utilization or the status indicative of electricity utilization for the hybrid vehicle from a transmitter coupled with a determination module comprising instrumentation for determining the at least one of the status indicative of combustible fuel utilization or the status indicative of electricity utilization for the hybrid vehicle.

The operation 1904 illustrates transmitting the at least one of the status indicative of combustible fuel utilization or the status indicative of electricity utilization for the hybrid vehicle from a transmitter coupled with a determination module comprising a receiver for receiving the at least one of the status indicative of combustible fuel utilization or the status indicative of electricity utilization for the hybrid vehicle.

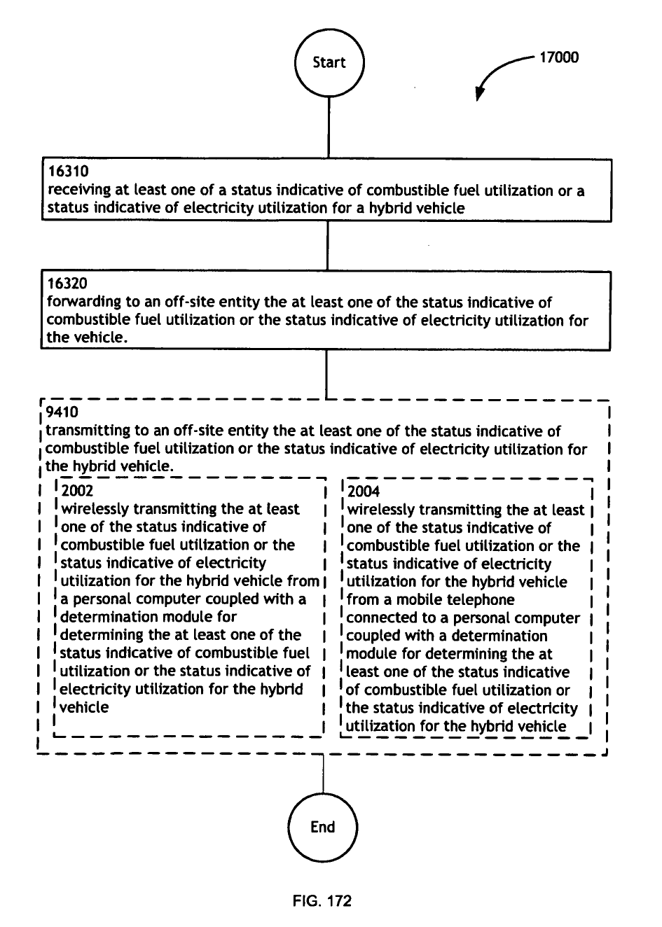

FIG. 172 illustrates alternative embodiments of the example operational flow 17000 of FIG. 170. FIG. 172 illustrates example embodiments where the operation 9410 may include at least one additional operation. Additional operations may include an operation 2002, and/or an operation 2004.

The operation 2002 illustrates wirelessly transmitting the at least one of the status indicative of combustible fuel utilization or the status indicative of electricity utilization for the hybrid vehicle from a personal computer coupled with a determination module for determining the at least one of the status indicative of combustible fuel utilization or the status indicative of electricity utilization for the hybrid vehicle.

The operation 2004 illustrates wirelessly transmitting the at least one of the status indicative of combustible fuel utilization or the status indicative of electricity utilization for the hybrid vehicle from a mobile telephone connected to a personal computer coupled with a determination module for determining the at least one of the status indicative of combustible fuel utilization or the status indicative of electricity utilization for the hybrid vehicle.

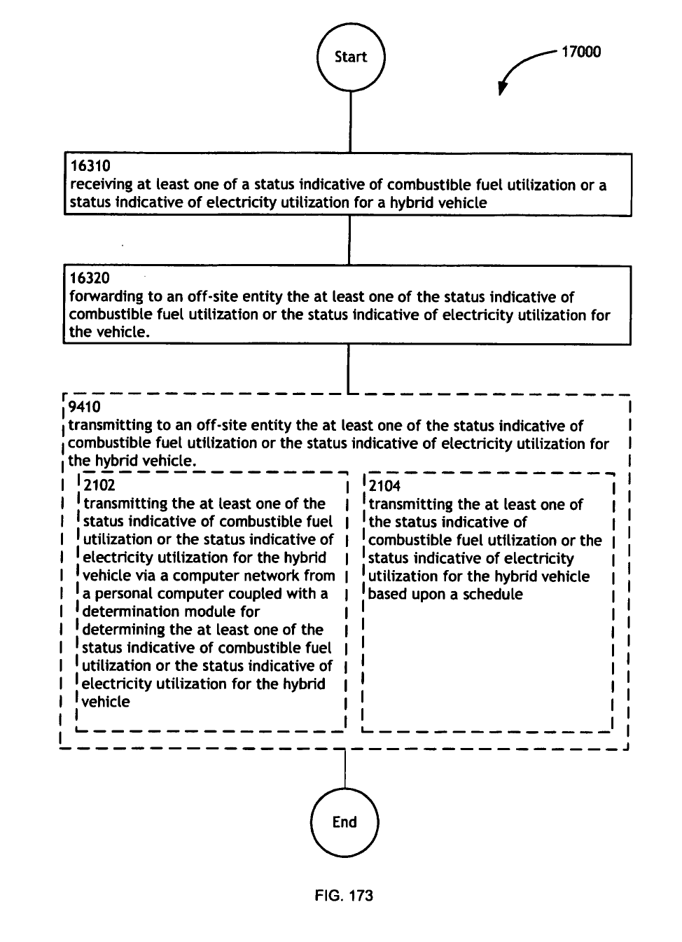

FIG. 173 illustrates alternative embodiments of the example operational flow 17000 of FIG. 170. FIG. 173 illustrates example embodiments where the operation 9410 may include at least one additional operation. Additional operations may include an operation 2102, and/or an operation 2104.

The operation 2102 illustrates transmitting the at least one of the status indicative of combustible fuel utilization or the status indicative of electricity utilization for the hybrid vehicle via a computer network from a personal computer coupled with a determination module for determining the at least one of the status indicative of combustible fuel utilization or the status indicative of electricity utilization for the hybrid vehicle.

The operation 2104 illustrates transmitting the at least one of the status indicative of combustible fuel utilization or the status indicative of electricity utilization for the hybrid vehicle based upon a schedule.

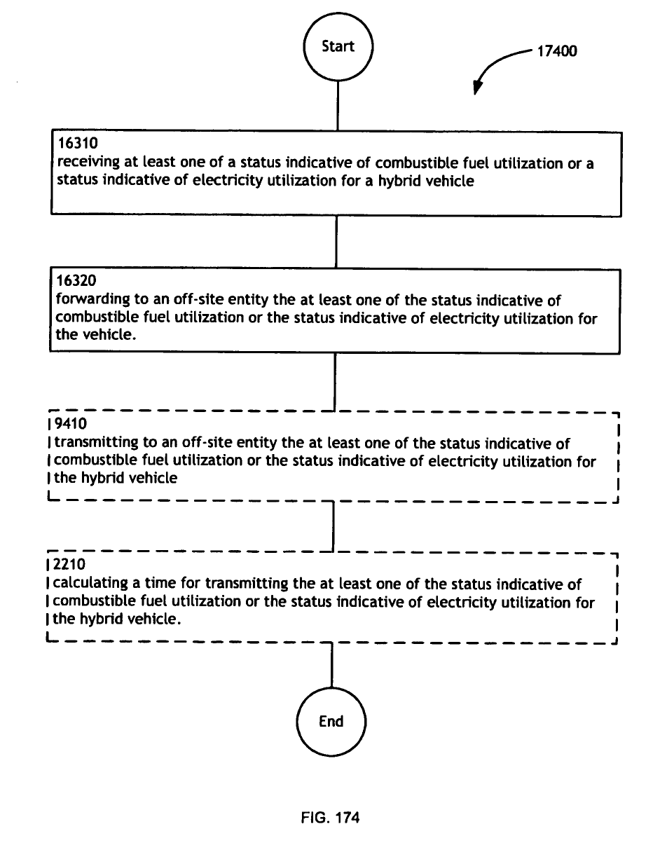

FIG. 174 illustrates an operational flow 17400 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, transmitting to an off-site entity the at least one of the status indicative of combustible fuel utilization or the status indicative of electricity utilization for the hybrid vehicle, and calculating a time for transmitting the status. FIG. 174 illustrates an example embodiment where the example operational flow 17000 of FIG. 170 may include at least one additional operation. Additional operations may include an operation 2210.

After a start operation, an operation 16310, an operation 16320, and an operation 9410, the operational flow 17400 moves to an operation 2210. Operation 2210 illustrates calculating a time for transmitting the at least one of the status indicative of combustible fuel utilization or the status indicative of electricity utilization for the hybrid vehicle.

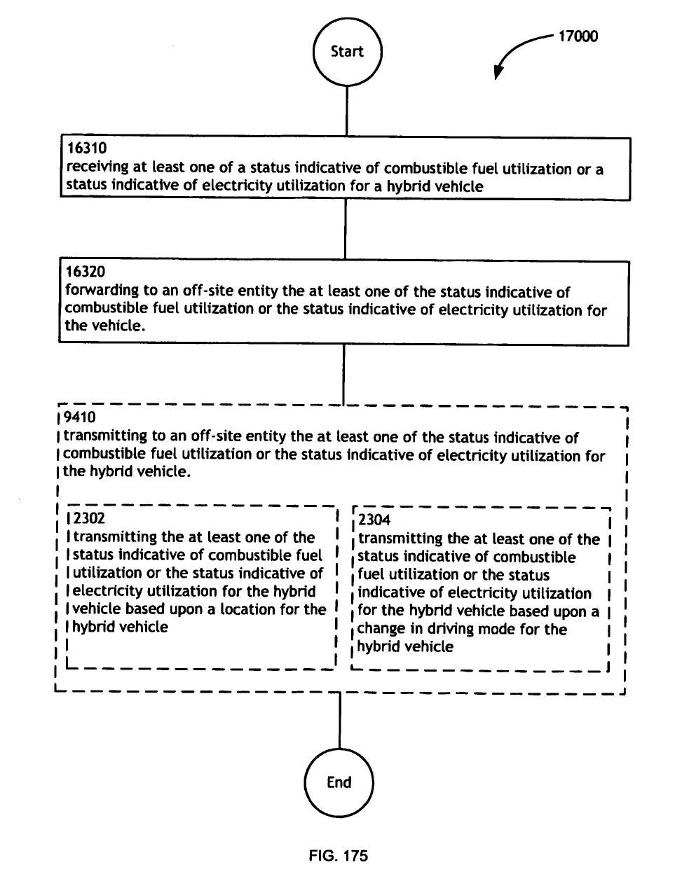

FIG. 175 illustrates alternative embodiments of the example operational flow 17000 of FIG. 170. FIG. 175 illustrates example embodiments where the operation 9410 may include at least one additional operation. Additional operations may include an operation 2302, and/or an operation 2304.

The operation 2302 illustrates transmitting the at least one of the status indicative of combustible fuel utilization or the status indicative of electricity utilization for the hybrid vehicle based upon a location for the hybrid vehicle.

The operation 2304 illustrates transmitting the at least one of the status indicative of combustible fuel utilization or the status indicative of electricity utilization for the hybrid vehicle based upon a change in driving mode for the hybrid vehicle.

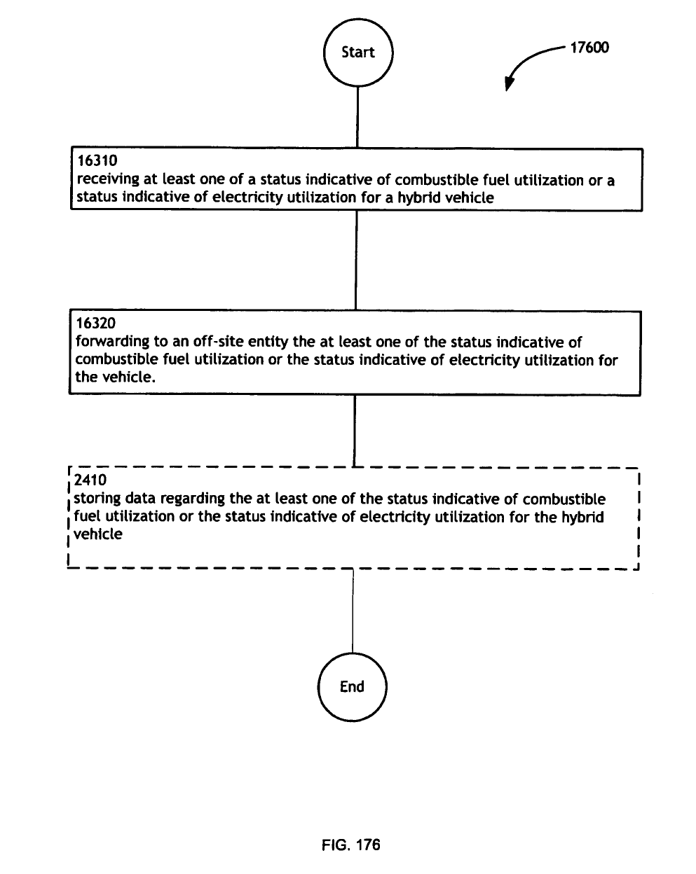

FIG. 176 illustrates an operational flow 17600 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and storing data regarding the status. FIG. 176 illustrates an example embodiment where the example operational flow 16300 of FIG. 163 may include at least one additional operation. Additional operations may include an operation 2410.

After a start operation, an operation 16310, and an operation 16320, the operational flow 17600 moves to an operation 2410. Operation 2410 illustrates storing data regarding the at least one of the status indicative of combustible fuel utilization or the status indicative of electricity utilization for the hybrid vehicle.

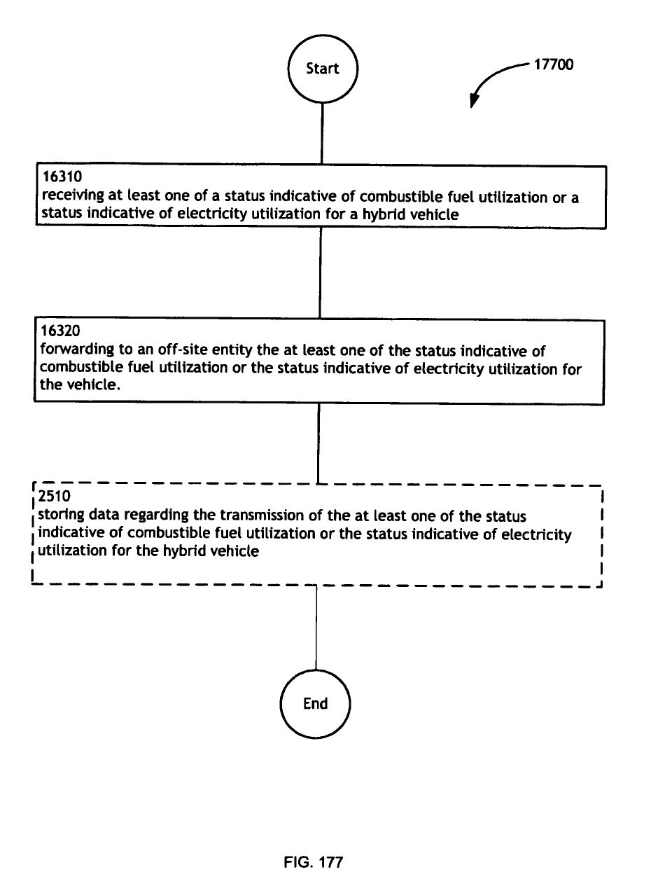

FIG. 177 illustrates an operational flow 17700 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and storing data regarding the transmission of the status. FIG. 177 illustrates an example embodiment where the example operational flow 16300 of FIG. 163 may include at least one additional operation. Additional operations may include an operation 2510.

After a start operation, an operation 16310, and an operation 16320, the operational flow 17700 moves to an operation 2510. Operation 2510 illustrates storing data regarding the transmission of the at least one of the status indicative of combustible fuel utilization or the status indicative of electricity utilization for the hybrid vehicle.

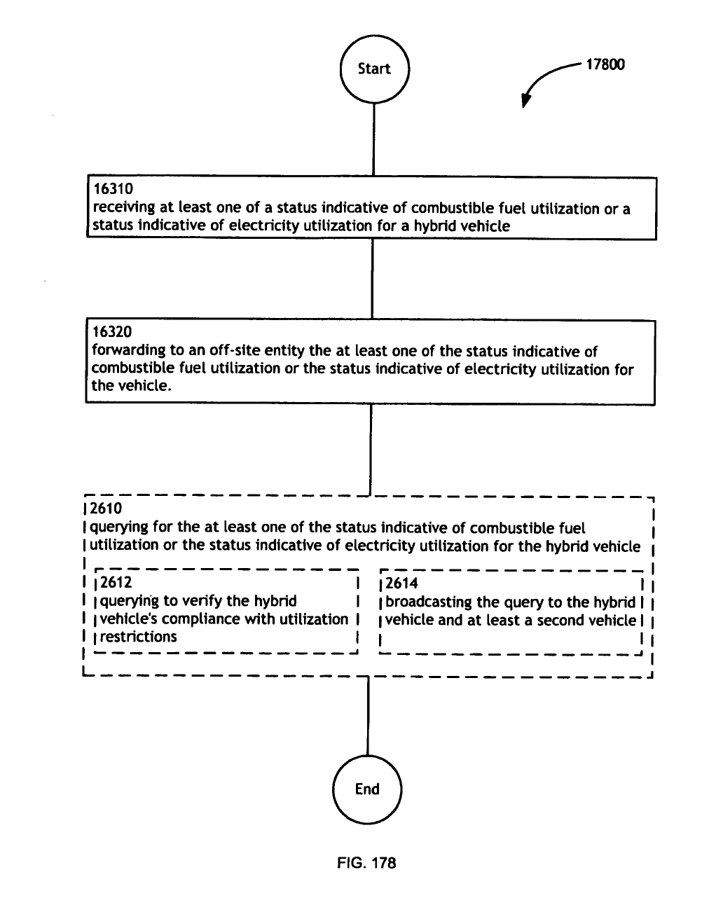

FIG. 178 illustrates an operational flow 17800 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and querying for the status. FIG. 178 illustrates an example embodiment where the example operational flow 16300 of FIG. 163 may include at least one additional operation. Additional operations may include an operation 2610, an operation 2612, and/or an operation 2614.

After a start operation, an operation 16310, and an operation 16320, the operational flow 17800 moves to an operation 2610. Operation 2610 illustrates querying for the at least one of the status indicative of combustible fuel utilization or the status indicative of electricity utilization for the hybrid vehicle.

The operation 2612 illustrates querying to verify the hybrid vehicle's compliance with utilization restrictions.

The operation 2614 illustrates broadcasting the query to the hybrid vehicle and at least a second vehicle.

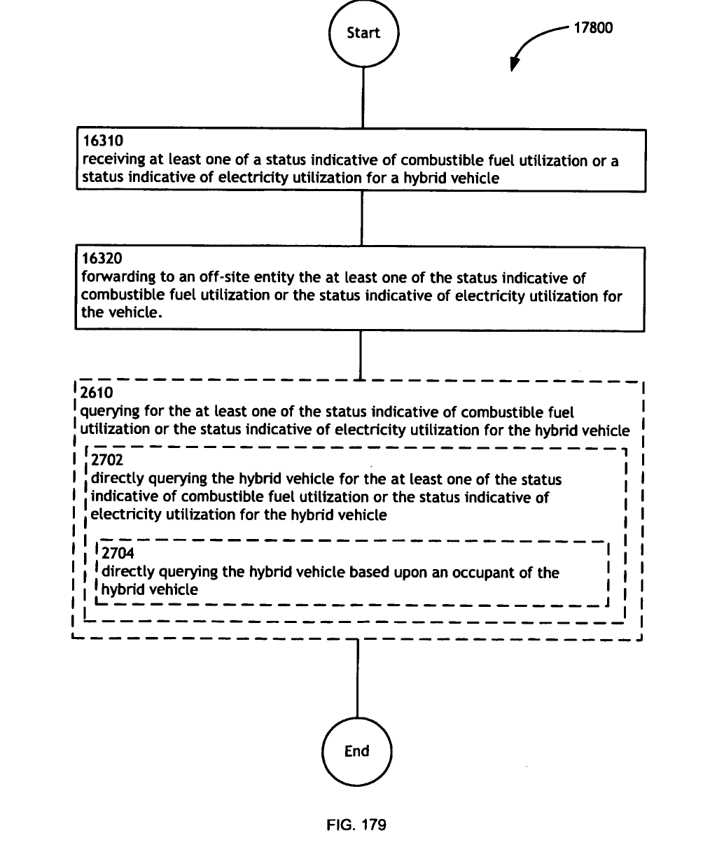

FIG. 179 illustrates alternative embodiments of the example operational flow 17800 of FIG. 178. FIG. 179 illustrates example embodiments where the operation 2610 may include at least one additional operation. Additional operations may include an operation 2702, and/or an operation 2704.

The operation 2702 illustrates directly querying the hybrid vehicle for the at least one of the status indicative of combustible fuel utilization or the status indicative of electricity utilization for the hybrid vehicle. Further, the operation 2704 illustrates directly querying the hybrid vehicle based upon an occupant of the hybrid vehicle.

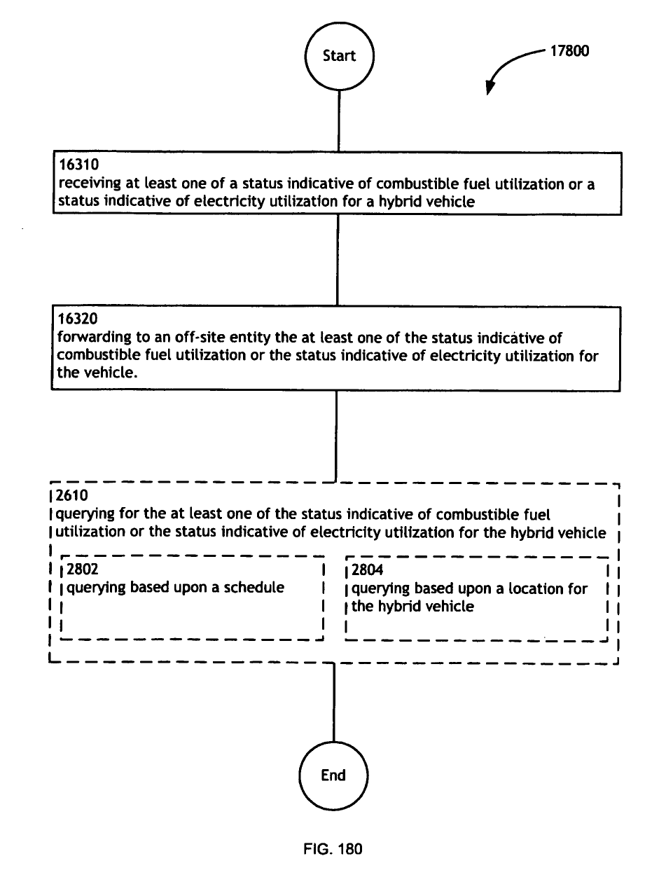

FIG. 180 illustrates alternative embodiments of the example operational flow 17800 of FIG. 178. FIG. 180 illustrates example embodiments where the operation 2610 may include at least one additional operation. Additional operations may include an operation 2802, and/or an operation 2804.

The operation 2802 illustrates querying based upon a schedule.

The operation 2804 illustrates querying based upon a location for the hybrid vehicle.

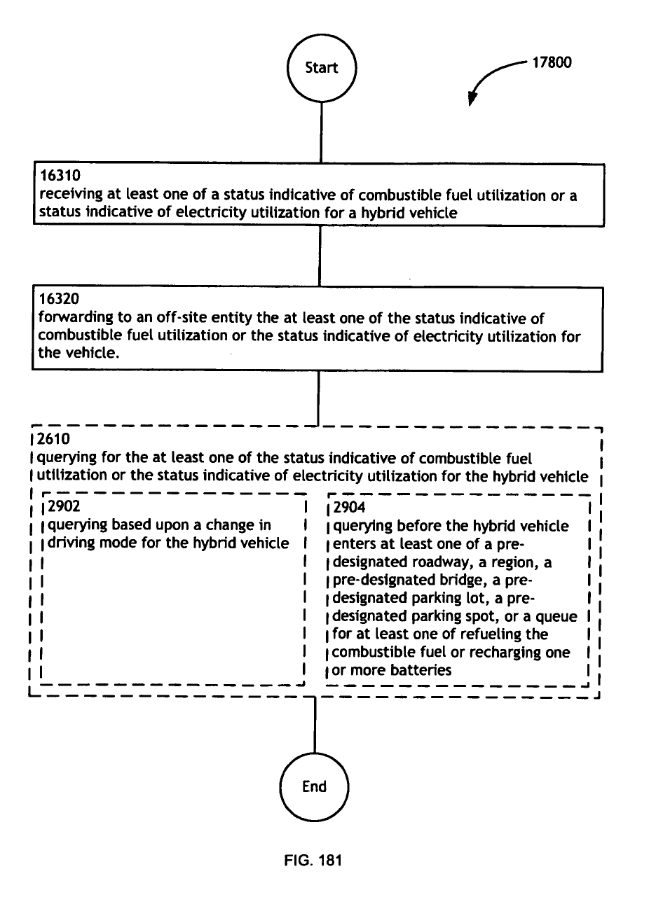

FIG. 181 illustrates alternative embodiments of the example operational flow 17800 of FIG. 178. FIG. 181 illustrates example embodiments where the operation 2610 may include at least one additional operation. Additional operations may include an operation 2902, and/or an operation 2904.

The operation 2902 illustrates querying based upon a change in driving mode for the hybrid vehicle.

The operation 2904 illustrates querying before the hybrid vehicle enters at least one of a pre-designated roadway, a region, a pre-designated bridge, a pre-designated parking lot, a pre-designated parking spot, or a queue for at least one of refueling the combustible fuel or recharging one or more batteries.

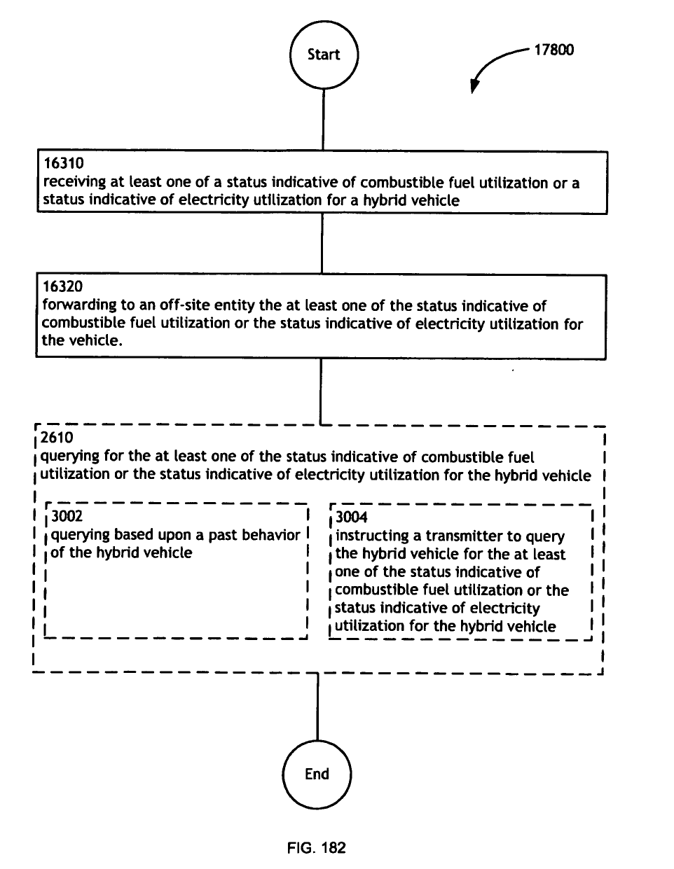

FIG. 182 illustrates alternative embodiments of the example operational flow 17800 of FIG. 178. FIG. 182 illustrates example embodiments where the operation 2610 may include at least one additional operation. Additional operations may include an operation 3002, and/or an operation 3004.

The operation 3002 illustrates querying based upon a past behavior of the hybrid vehicle.

The operation 3004 illustrates instructing a transmitter to query the hybrid vehicle for the at least one of the status indicative of combustible fuel utilization or the status indicative of electricity utilization for the hybrid vehicle.

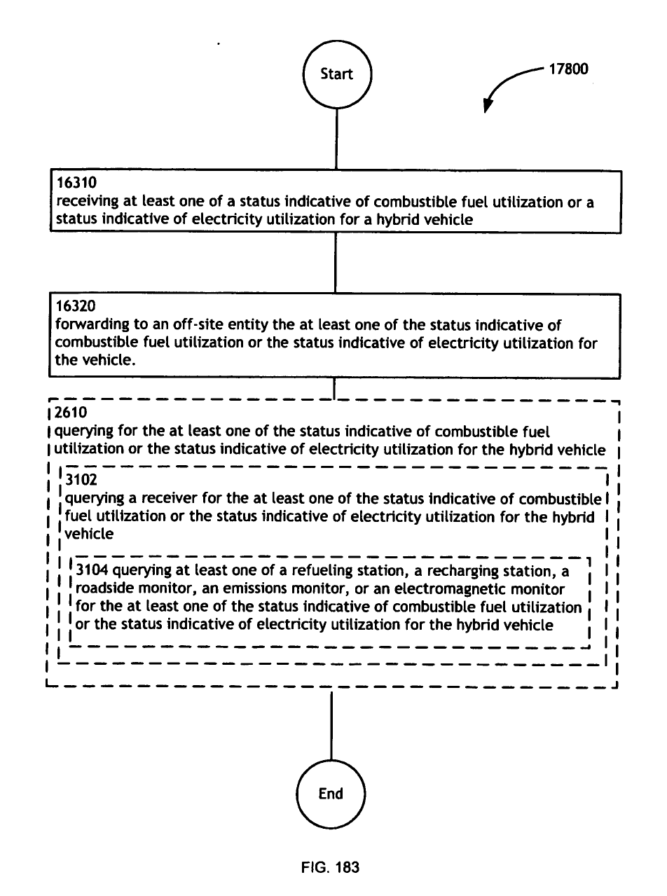

FIG. 183 illustrates alternative embodiments of the example operational flow 17800 of FIG. 178. FIG. 183 illustrates example embodiments where the operation 2610 may include at least one additional operation. Additional operations may include an operation 3102, and/or an operation 3104.

The operation 3102 illustrates querying a receiver for the at least one of the status indicative of combustible fuel utilization or the status indicative of electricity utilization for the hybrid vehicle. Further, the operation 3104 illustrates querying at least one of a refueling station, a recharging station, a roadside monitor, an emissions monitor, or an electromagnetic monitor for the at least one of the status indicative of combustible fuel utilization or the status indicative of electricity utilization for the hybrid vehicle.

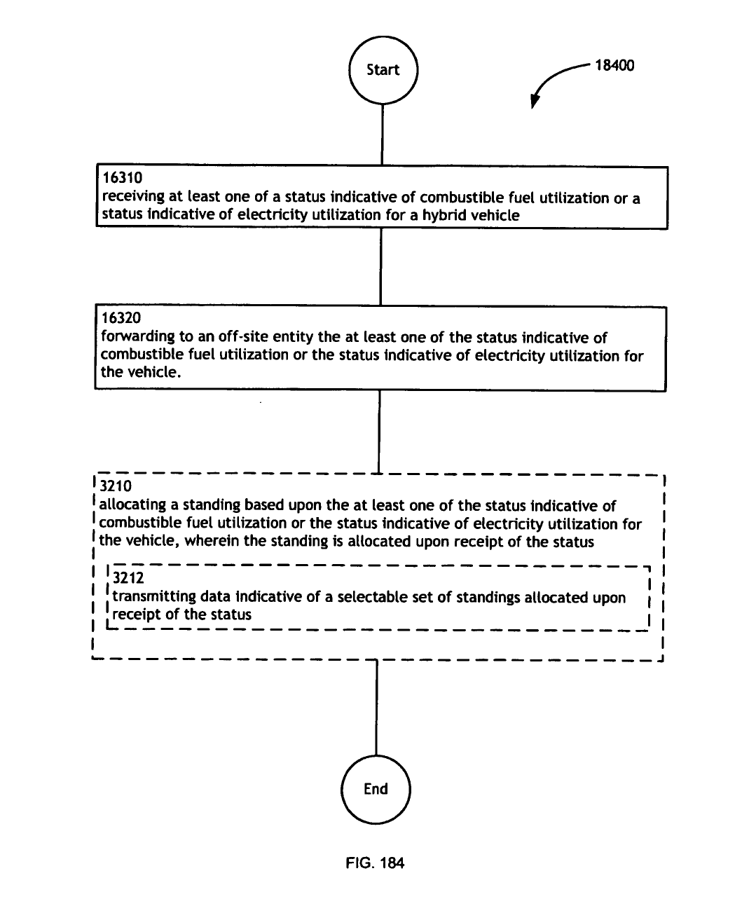

FIG. 184 illustrates an operational flow 18400 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, and allocating a standing based upon the at least one of the status indicative of combustible fuel utilization or the status indicative of electricity utilization for the vehicle. FIG. 184 illustrates an example embodiment where the example operational flow 16300 of FIG. 163 may include at least one additional operation. Additional operations may include an operation 3210, and/or an operation 3212.

After a start operation, an operation 16310, and an operation 16320, the operational flow 18400 moves to an operation 3210. Operation 3210 illustrates allocating a standing based upon the at least one of the status indicative of combustible fuel utilization or the status indicative of electricity utilization for the vehicle, wherein the standing is allocated upon receipt of the status.

The operation 3212 illustrates transmitting data indicative of a selectable set of standings allocated upon receipt of the status.

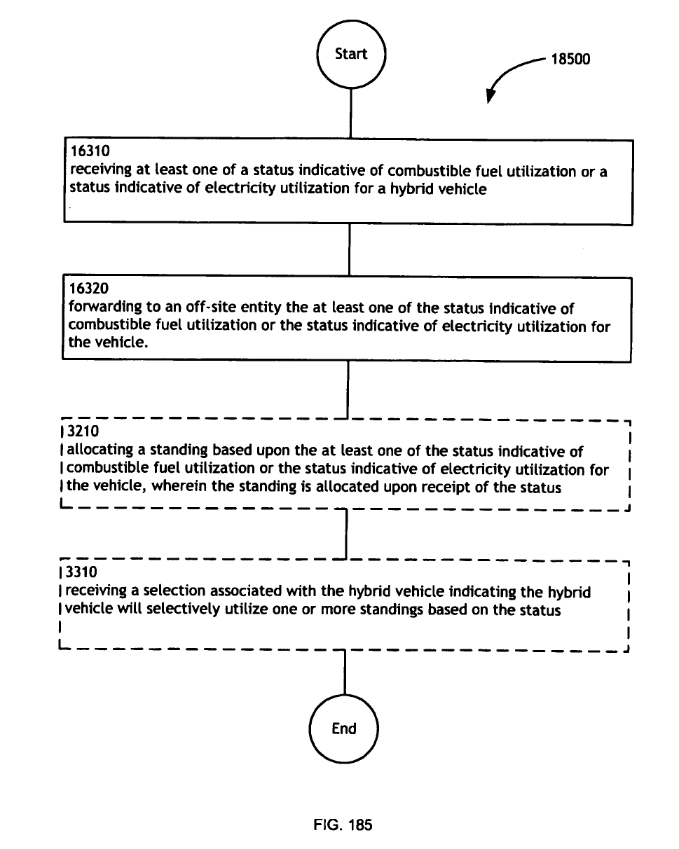

FIG. 185 illustrates an operational flow 18500 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and receiving a selection associated with the hybrid vehicle. FIG. 185 illustrates an example embodiment where the example operational flow 18400 of FIG. 184 may include at least one additional operation. Additional operations may include an operation 3310.

After a start operation, an operation 16310, an operation 16320, and an operation 3210, the operational flow 3300 moves to an operation 3310. Operation 3310 illustrates receiving a selection associated with the hybrid vehicle indicating the hybrid vehicle will selectively utilize one or more standings based on the status.

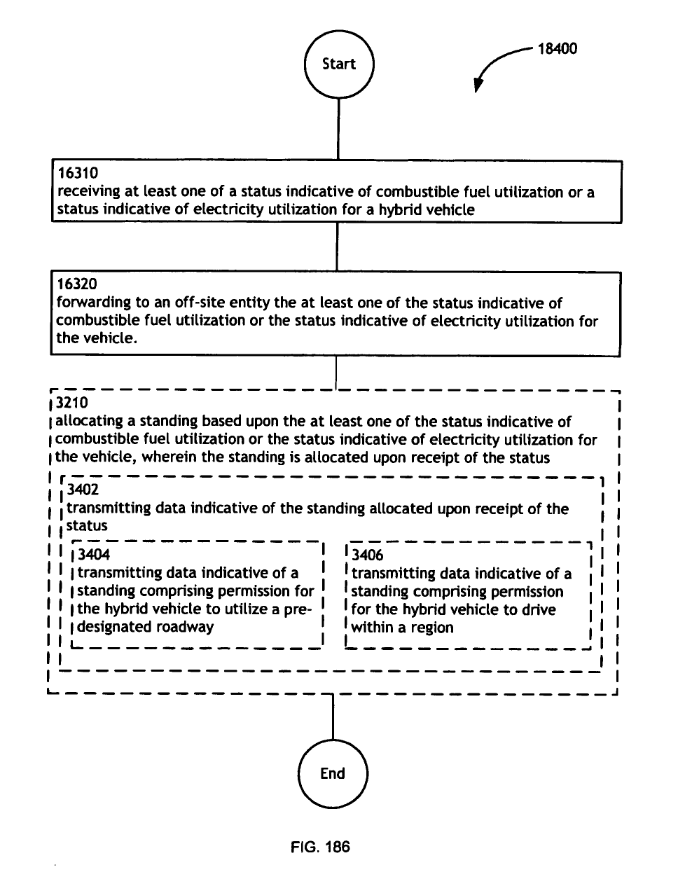

FIG. 186 illustrates alternative embodiments of the example operational flow 18400 of FIG. 184. FIG. 186 illustrates example embodiments where the operation 3210 may include at least one additional operation. Additional operations may include an operation 3402, an operation 3404, and/or an operation 3406.

The operation 3402 illustrates transmitting data indicative of the standing allocated upon receipt of the status. Further, the operation 3404 illustrates transmitting data indicative of a standing comprising permission for the hybrid vehicle to utilize a pre-designated roadway. Further, the operation 3406 illustrates transmitting data indicative of a standing comprising permission for the hybrid vehicle to drive within a region.

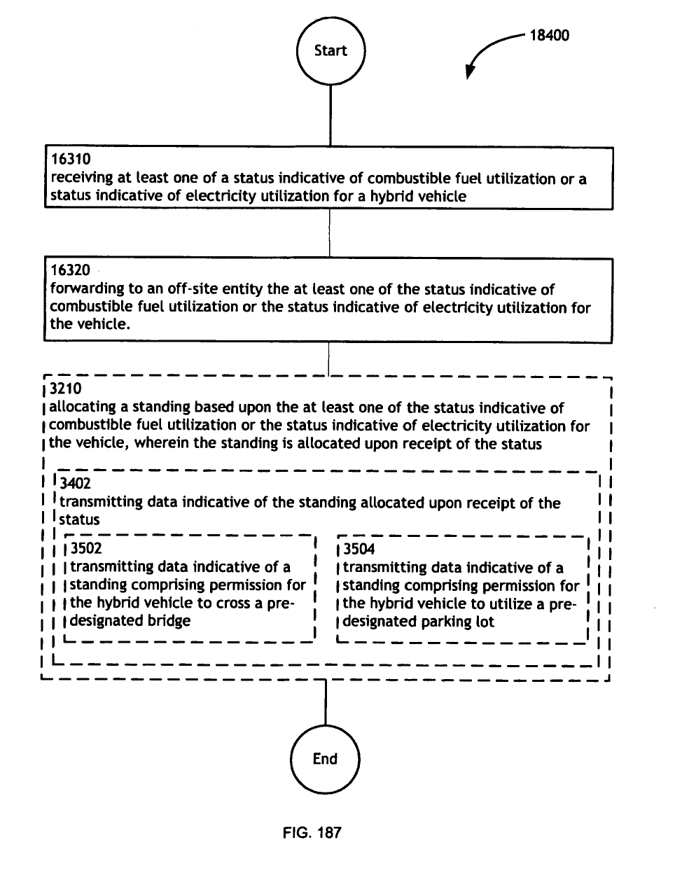

FIG. 187 illustrates alternative embodiments of the example operational flow 18400 of FIG. 184. FIG. 187 illustrates example embodiments where the operation 3210 may include at least one additional operation. Additional operations may include an operation 3502, and/or an operation 3504. Further, the operation 3502 illustrates transmitting data indicative of a standing comprising permission for the hybrid vehicle to cross a pre-designated bridge. Further, the operation 3504 illustrates transmitting data indicative of a standing comprising permission for the hybrid vehicle to utilize a pre-designated parking lot.

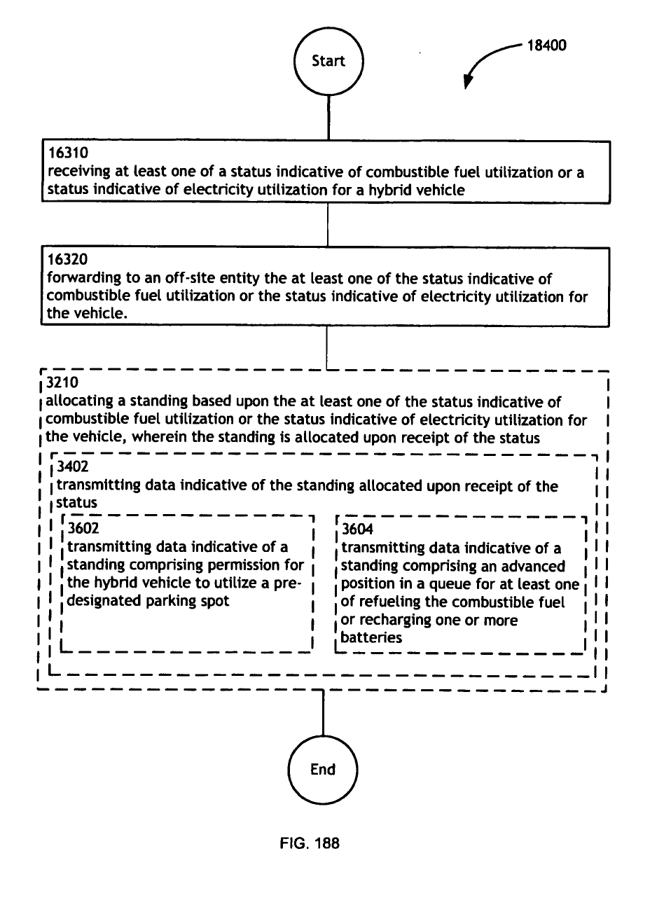

FIG. 188 illustrates alternative embodiments of the example operational flow 18400 of FIG. 184. FIG. 188 illustrates example embodiments where the operation 3210 may include at least one additional operation. Additional operations may include an operation 3602, and/or an operation 3604. Further, the operation 3602 illustrates transmitting data indicative of a standing comprising permission for the hybrid vehicle to utilize a pre-designated parking spot. Further, the operation 3604 illustrates transmitting data indicative of a standing comprising an advanced position in a queue for at least one of refueling the combustible fuel or recharging one or more batteries.

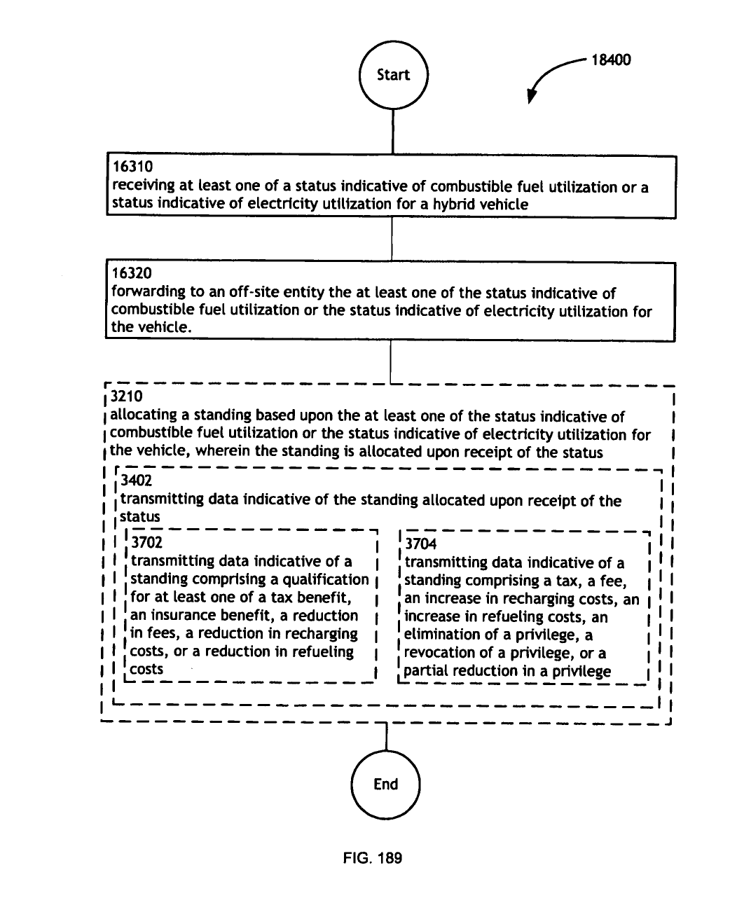

FIG. 189 illustrates alternative embodiments of the example operational flow 18400 of FIG. 184. FIG. 189 illustrates example embodiments where the operation 3210 may include at least one additional operation. Additional operations may include an operation 3702, and/or an operation 3704. Further, the operation 3702 illustrates transmitting data indicative of a standing comprising a qualification for at least one of a tax benefit, an insurance benefit, a reduction in fees, a reduction in recharging costs, or a reduction in refueling costs. Further, the operation 3704 illustrates transmitting data indicative of a standing comprising a tax, a fee, an increase in recharging costs, an increase in refueling costs, an elimination of a privilege, a revocation of a privilege, or a partial reduction in a privilege.

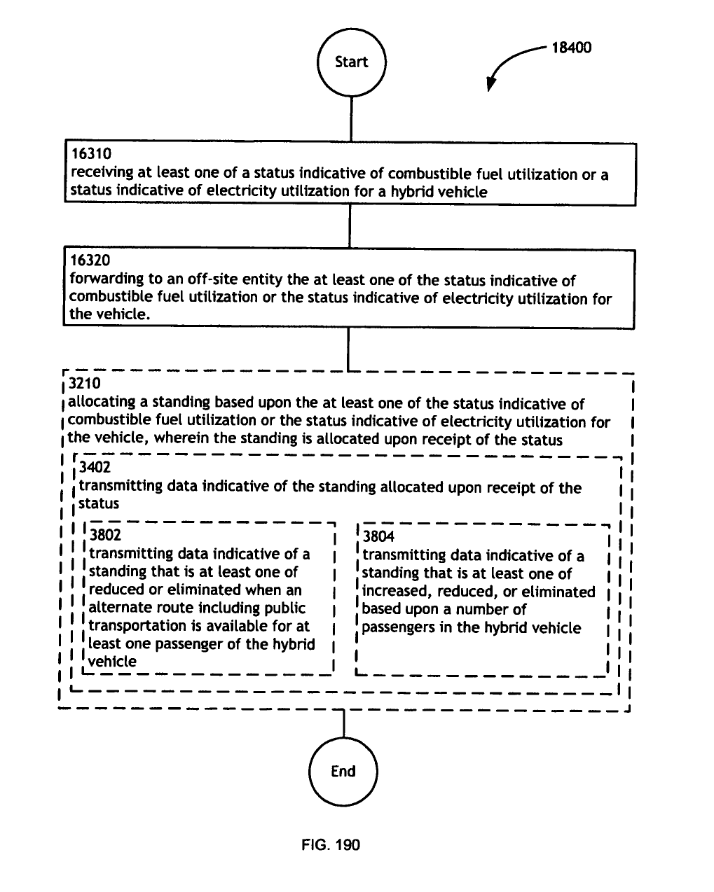

FIG. 190 illustrates alternative embodiments of the example operational flow 18400 of FIG. 184. FIG. 190 illustrates example embodiments where the operation 3210 may include at least one additional operation. Additional operations may include an operation 3802, and/or an operation 3804. Further, the operation 3802 illustrates transmitting data indicative of a standing that is at least one of reduced or eliminated when an alternate route including public transportation is available for at least one passenger of the hybrid vehicle. Further, the operation 3804 illustrates transmitting data indicative of a standing that is at least one of increased, reduced, or eliminated based upon a number of passengers in the hybrid vehicle.

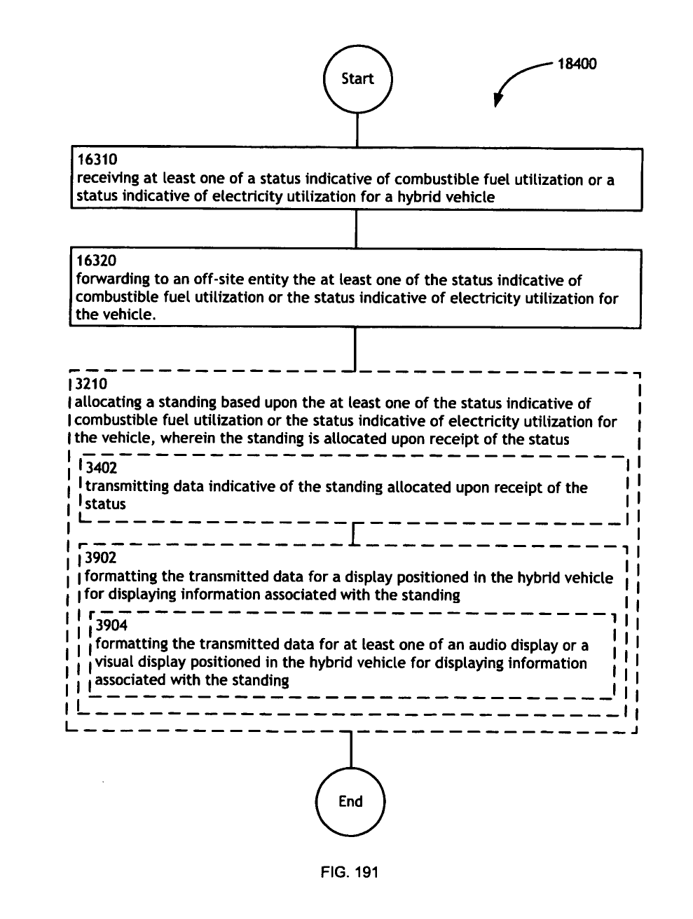

FIG. 191 illustrates alternative embodiments of the example operational flow 18400 of FIG. 184. FIG. 191 illustrates example embodiments where the operation 3210 may include at least one additional operation. Additional operations may include an operation 3902, and/or an operation 3904. Further, the operation 3902 illustrates formatting the transmitted data for a display positioned in the hybrid vehicle for displaying information associated with the standing. Further, the operation 3904 illustrates formatting the transmitted data for at least one of an audio display or a visual display positioned in the hybrid vehicle for displaying information associated with the standing.

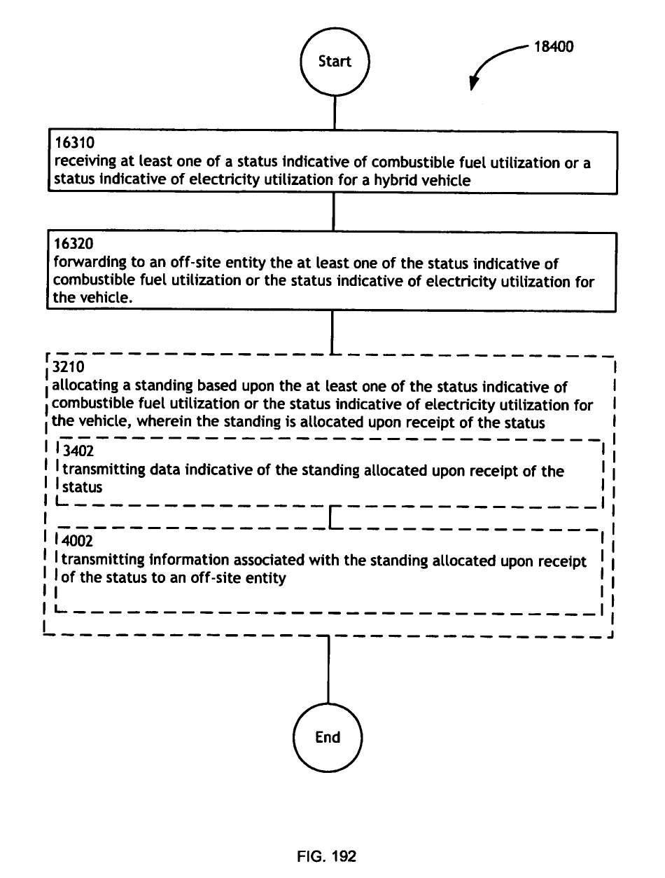

FIG. 192 illustrates alternative embodiments of the example operational flow 18400 of FIG. 184. FIG. 192 illustrates example embodiments where the operation 3210 may include at least one additional operation. Additional operations may include an operation 4002. Further, the operation 4002 illustrates transmitting information associated with the standing allocated upon receipt of the status to an off-site entity.

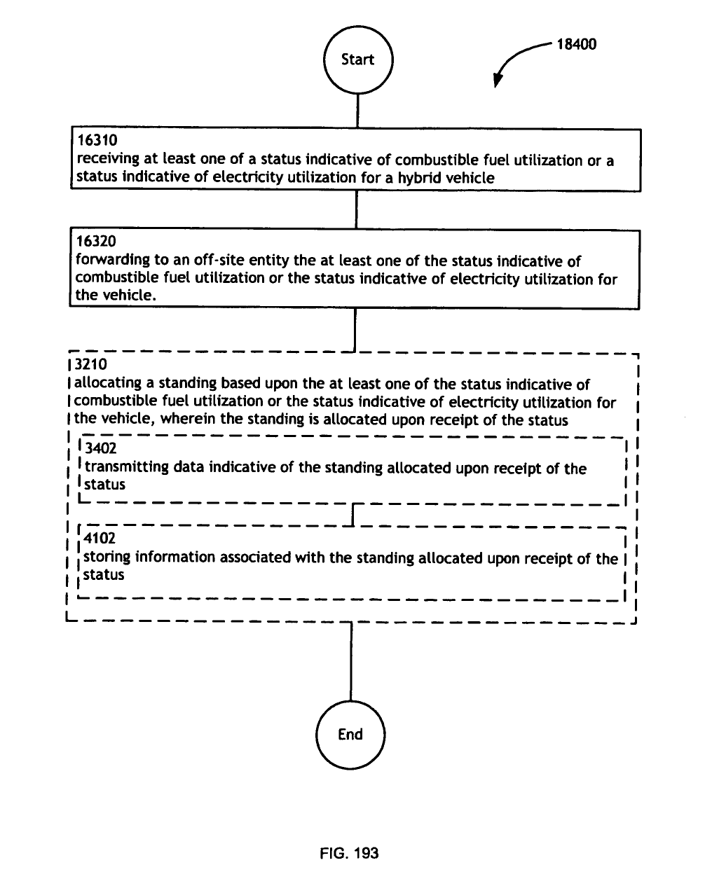

FIG. 193 illustrates alternative embodiments of the example operational flow 18400 of FIG. 184. FIG. 193 illustrates example embodiments where the operation 3210 may include at least one additional operation. Additional operations may include an operation 4102. Further, the operation 4102 illustrates storing information associated with the standing allocated upon receipt of the status.

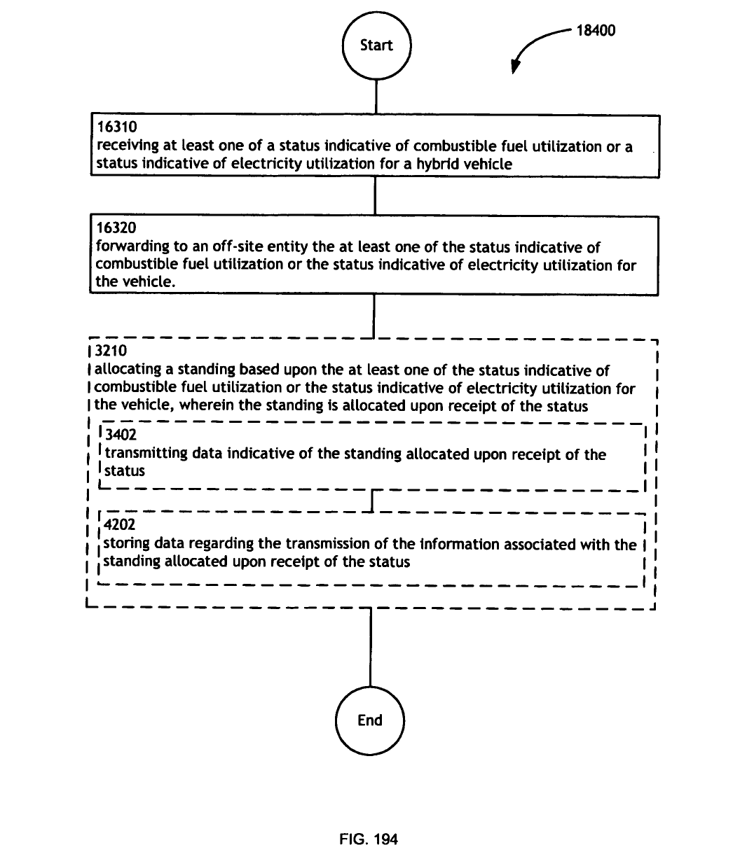

FIG. 194 illustrates alternative embodiments of the example operational flow 18400 of FIG. 184. FIG. 194 illustrates example embodiments where the operation 3210 may include at least one additional operation. Additional operations may include an operation 4202. Further, the operation 4202 illustrates storing data regarding the transmission of the information associated with the standing allocated upon receipt of the status.

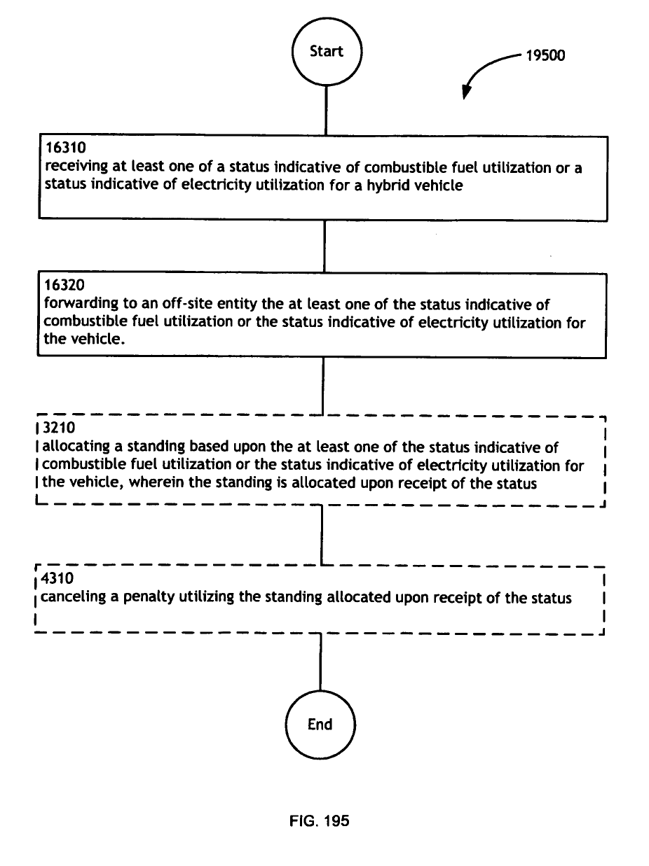

FIG. 195 illustrates an operational flow 19500 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and canceling a penalty utilizing the standing. FIG. 195 illustrates an example embodiment where the example operational flow 18400 of FIG. 184 may include at least one additional operation. Additional operations may include an operation 4310.

After a start operation, an operation 16310, an operation 16320, and an operation 3210, the operational flow 19500 moves to an operation 4310. Operation 4310 illustrates canceling a penalty utilizing the standing allocated upon receipt of the status.

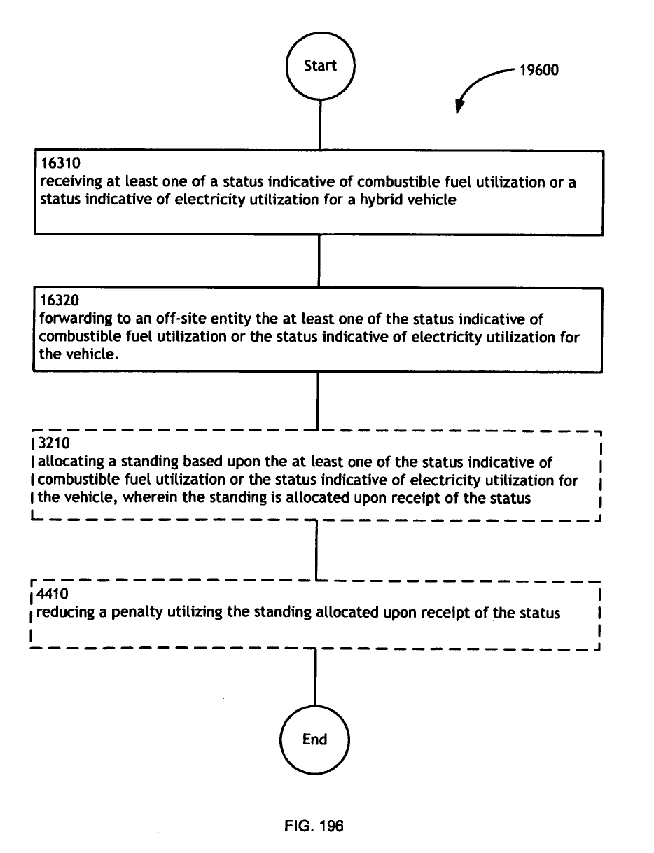

FIG. 196 illustrates an operational flow 19600 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and reducing a penalty utilizing the standing. FIG. 196 illustrates an example embodiment where the example operational flow 18400 of FIG. 184 may include at least one additional operation. Additional operations may include an operation 4410.

After a start operation, an operation 16310, an operation 16320, and an operation 3210, the operational flow 19600 moves to an operation 4410. Operation 4410 illustrates reducing a penalty utilizing the standing allocated upon receipt of the status.

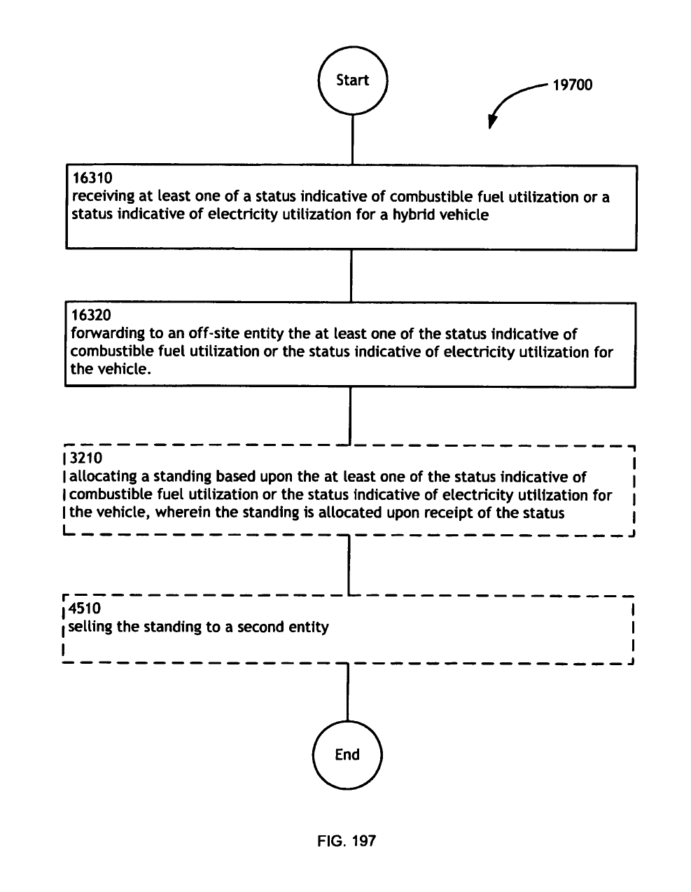

FIG. 197 illustrates an operational flow 19700 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and selling the standing to a second entity. FIG. 197 illustrates an example embodiment where the example operational flow 18400 of FIG. 184 may include at least one additional operation. Additional operations may include an operation 4510.

After a start operation, an operation 16310, an operation 16320, and an operation 3210, the operational flow 19700 moves to an operation 4510. Operation 4510 illustrates selling the standing to a second entity.

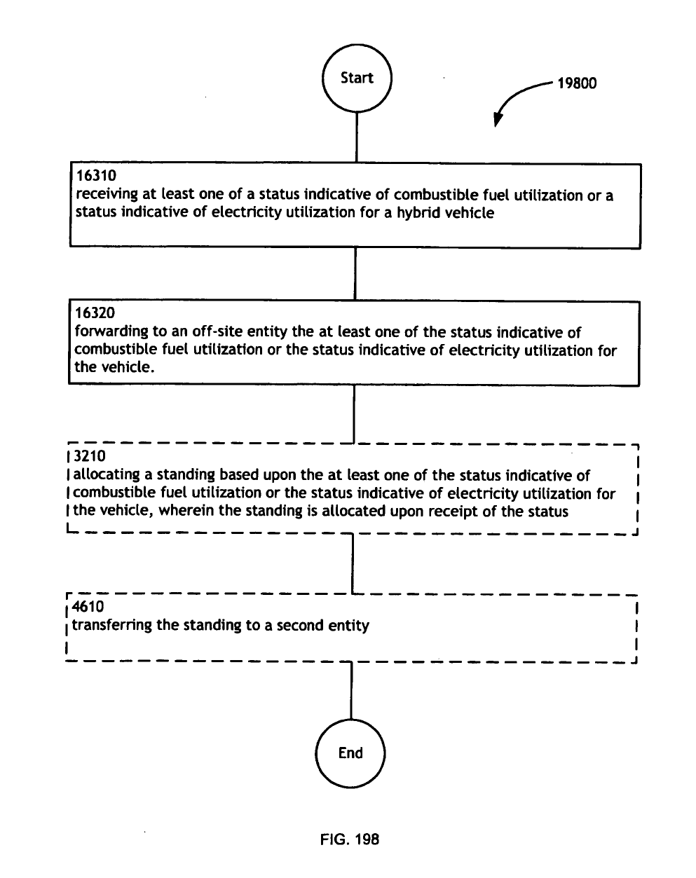

FIG. 198 illustrates an operational flow 19800 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and transferring the standing to a second entity. FIG. 198 illustrates an example embodiment where the example operational flow 18400 of FIG. 184 may include at least one additional operation. Additional operations may include an operation 4610.

After a start operation, an operation 16310, an operation 16320, and an operation 3210, the operational flow 19800 moves to an operation 4610. Operation 4610 illustrates transferring the standing to a second entity.

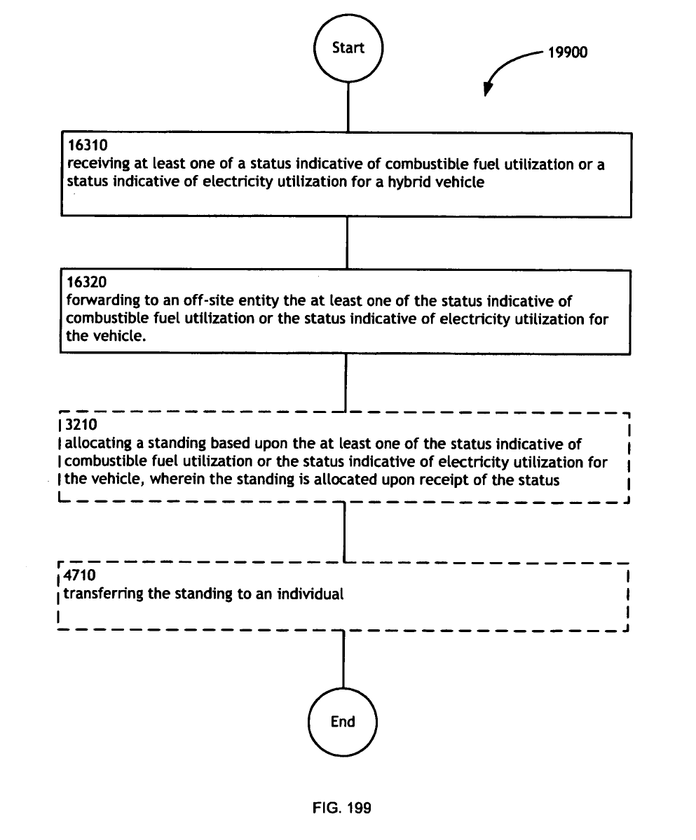

FIG. 199 illustrates an operational flow 19900 representing example operations related to receiving at least one of a status indicative of combustible fuel utilization or a status indicative of electricity utilization for a hybrid vehicle, forwarding to an off-site entity the at least one of the status indicative of combustible fuel utilization or the status indicative of electricity utilization for the vehicle, allocating a standing based upon the status for the vehicle, and transferring the standing to an individual. FIG. 199 illustrates an example embodiment where the example operational flow 18400 of FIG. 184 may include at least one additional operation. Additional operations may include an operation 4710.

After a start operation, an operation 16310, an operation 16320, and an operation 3210, the operational flow 19900 moves to an operation 4710. Operation 4710 illustrates transferring the standing to an individual.

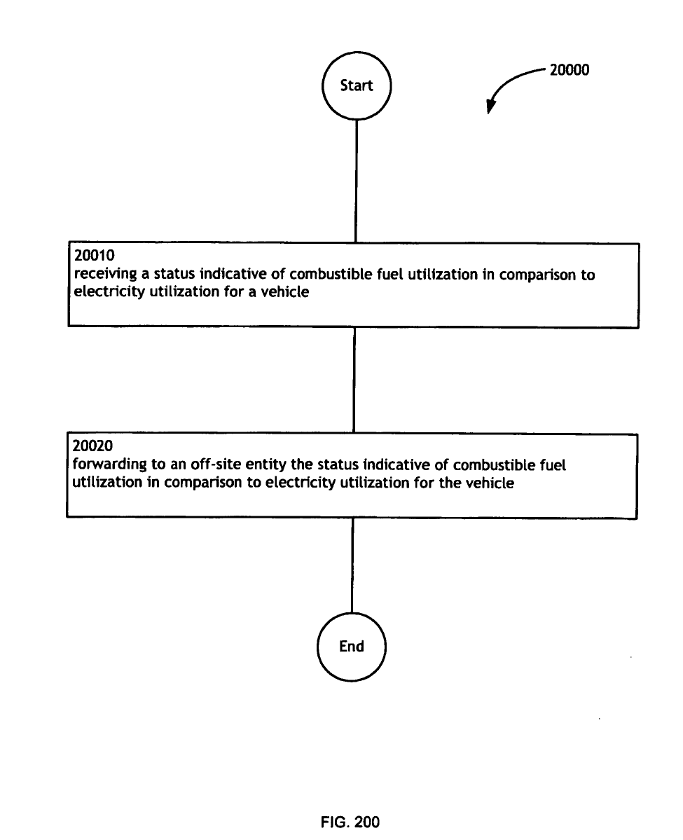

FIG. 200 illustrates an operational flow 20000 representing example operations related to receiving a status indicative of combustible fuel utilization in comparison to electricity utilization for a vehicle and forwarding to an off-site entity the status indicative of combustible fuel utilization in comparison to electricity utilization for the vehicle. In FIG. 200 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 20000 moves to an operation 20010. Operation 20010 depicts receiving a status indicative of combustible fuel utilization in comparison to electricity utilization for a vehicle. For example, as shown in FIGS. 1 through 10, the vehicle 100 may utilize the transmitter 120 to transmit a status indicative of, for example, combustible fuel utilization in comparison to electricity utilization for the vehicle 100. In an embodiment, the off-site entity 144 or a repeater/retransmitting device may receive the status transmitted by the vehicle 100.

Then, operation 20020 depicts forwarding to an off-site entity the status indicative of combustible fuel utilization in comparison to electricity utilization for the vehicle. For example, as shown in FIGS. 1 through 10, the vehicle 100 or the repeater/retransmitting device may forward (e.g., utilizing the transmitter 120) a status indicative of, for example, combustible fuel utilization in comparison to electricity utilization for the vehicle 100. In an embodiment, the off-site entity 144 may receive the status transmitted by the vehicle 100 or the repeater/retransmitting device.

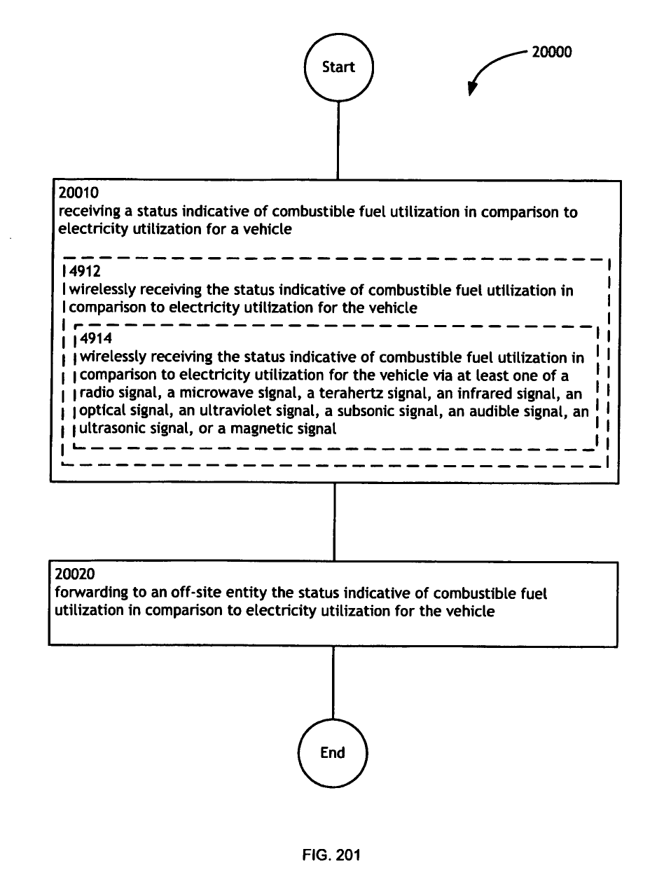

FIG. 201 illustrates alternative embodiments of the example operational flow 20000 of FIG. 200. FIG. 201 illustrates example embodiments where the operation 20010 may include at least one additional operation. Additional operations may include an operation 4912, and/or an operation 4914.

The operation 4912 illustrates wirelessly receiving the status indicative of combustible fuel utilization in comparison to electricity utilization for the vehicle. Further, the operation 4914 illustrates wirelessly receiving the status indicative of combustible fuel utilization in comparison to electricity utilization for the vehicle via at least one of a radio signal, a microwave signal, a terahertz signal, an infrared signal, an optical signal, an ultraviolet signal, a subsonic signal, an audible signal, an ultrasonic signal, or a magnetic signal.

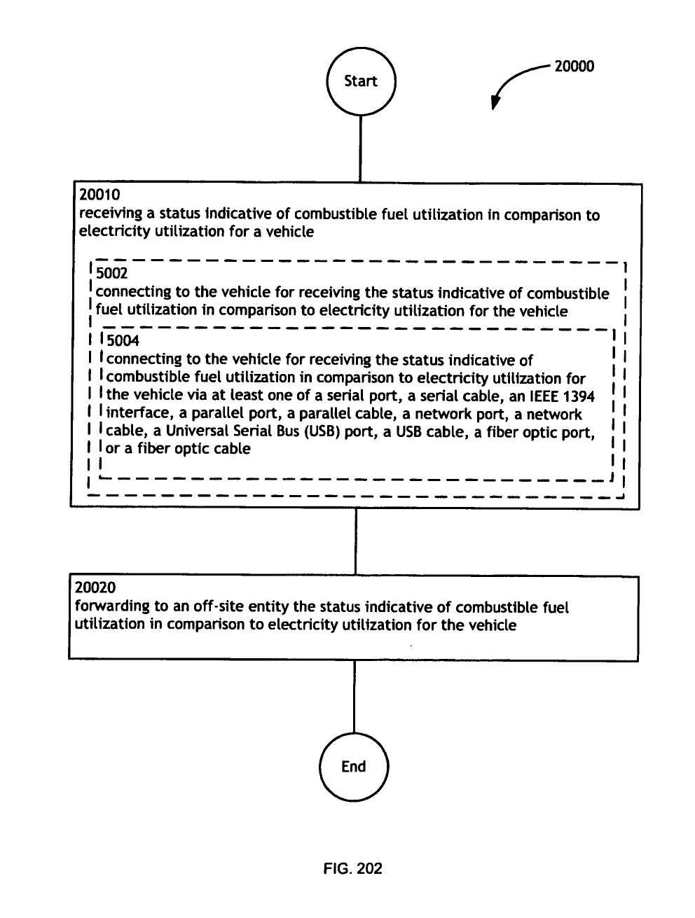

FIG. 202 illustrates alternative embodiments of the example operational flow 20000 of FIG. 200. FIG. 202 illustrates example embodiments where the operation 20010 may include at least one additional operation. Additional operations may include an operation 5002, and/or an operation 5004.

The operation 5002 illustrates connecting to the vehicle for receiving the status indicative of combustible fuel utilization in comparison to electricity utilization for the vehicle. Further, the operation 5004 illustrates connecting to the vehicle for receiving the status indicative of combustible fuel utilization in comparison to electricity utilization for the vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

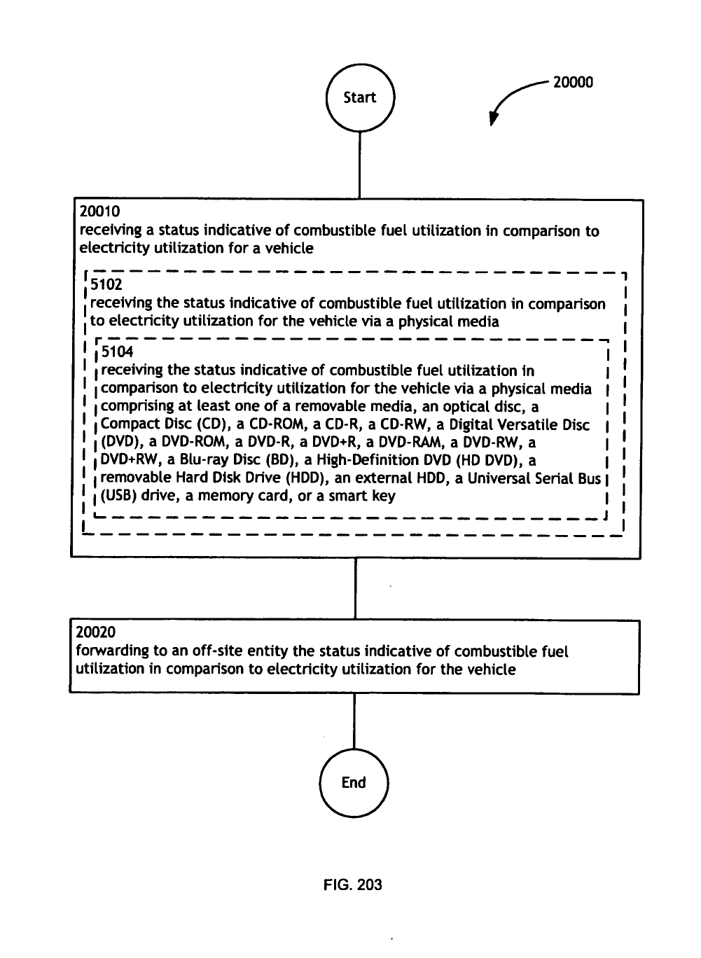

FIG. 203 illustrates alternative embodiments of the example operational flow 20000 of FIG. 200. FIG. 203 illustrates example embodiments where the operation 20010 may include at least one additional operation. Additional operations may include an operation 5102, and/or an operation 5104.

The operation 5102 illustrates receiving the status indicative of combustible fuel utilization in comparison to electricity utilization for the vehicle via a physical media. Further, the operation 5104 illustrates receiving the status indicative of combustible fuel utilization in comparison to electricity utilization for the vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

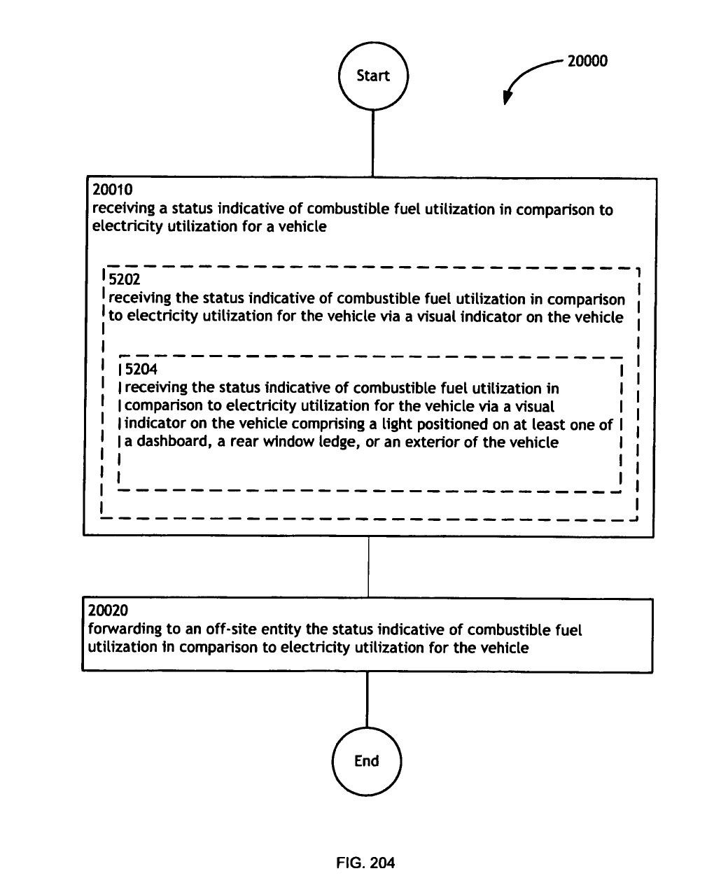

FIG. 204 illustrates alternative embodiments of the example operational flow 20000 of FIG. 200. FIG. 204 illustrates example embodiments where the operation 20010 may include at least one additional operation. Additional operations may include an operation 5202, and/or an operation 5204.

The operation 5202 illustrates receiving the status indicative of combustible fuel utilization in comparison to electricity utilization for the vehicle via a visual indicator on the vehicle. Further, the operation 5204 illustrates receiving the status indicative of combustible fuel utilization in comparison to electricity utilization for the vehicle via a visual indicator on the vehicle comprising a light positioned on at least one of a dashboard, a rear window ledge, or an exterior of the vehicle.

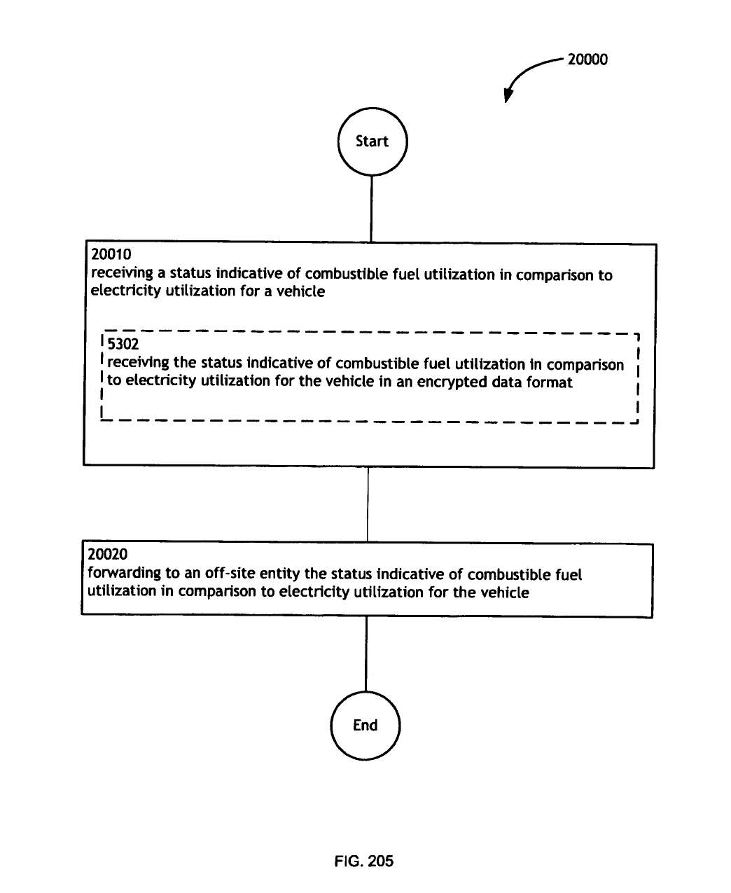

FIG. 205 illustrates alternative embodiments of the example operational flow 20000 of FIG. 200. FIG. 205 illustrates example embodiments where the operation 20010 may include at least one additional operation. Additional operations may include an operation 5302.

The operation 5302 illustrates receiving the status indicative of combustible fuel utilization in comparison to electricity utilization for the vehicle in an encrypted data format.

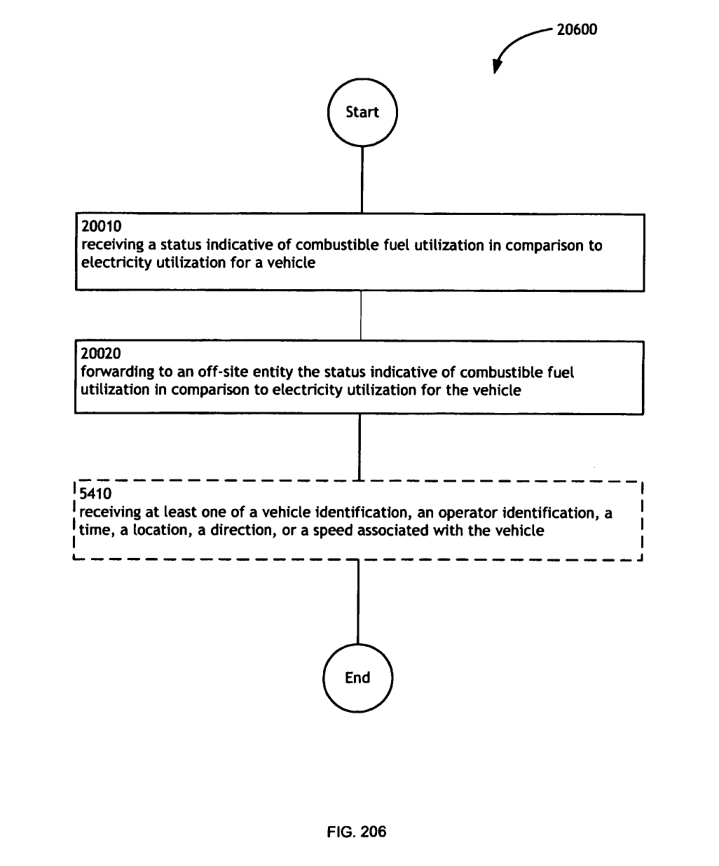

FIG. 206 illustrates an operational flow 20600 representing example operations related to receiving a status indicative of combustible fuel utilization in comparison to electricity utilization for a vehicle, forwarding to an off-site entity the status indicative of combustible fuel utilization in comparison to electricity utilization for the vehicle, and receiving at least one of a vehicle identification, an operator identification, a time, a location, a direction, or a speed associated with the vehicle. FIG. 206 illustrates an example embodiment where the example operational flow 20000 of FIG. 200 may include at least one additional operation. Additional operations may include an operation 5410.

After a start operation, an operation 20010, and an operation 20020, the operational flow 20600 moves to an operation 5410. Operation 5410 illustrates receiving at least one of a vehicle identification, an operator identification, a time, a location, a direction, or a speed associated with the vehicle.

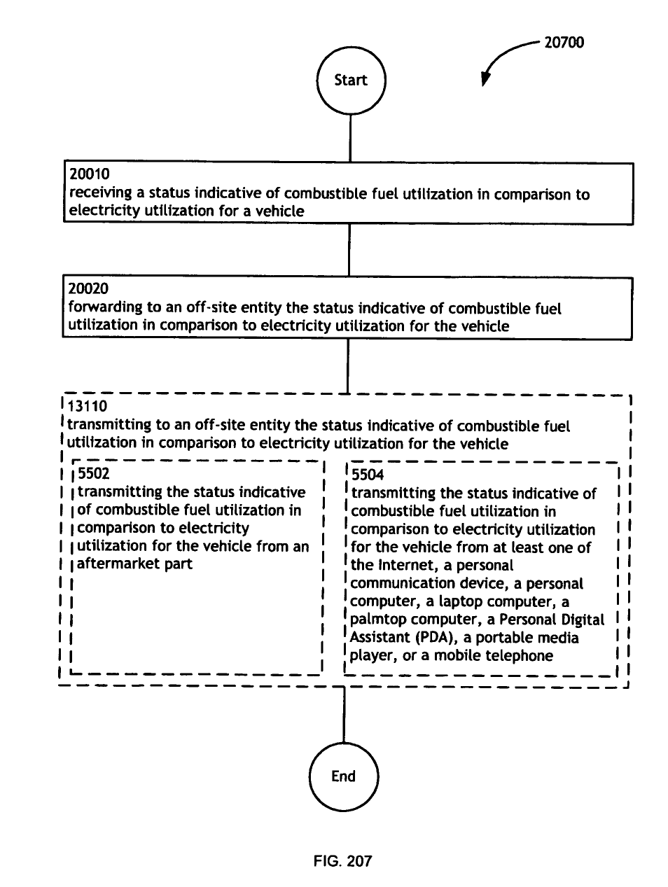

FIG. 207 illustrates an operational flow 20700 representing example operations related to receiving a status indicative of combustible fuel utilization in comparison to electricity utilization for a vehicle, forwarding to an off-site entity the status indicative of combustible fuel utilization in comparison to electricity utilization for the vehicle, and transmitting to an off-site entity the status indicative of combustible fuel utilization in comparison to electricity utilization for the vehicle. FIG. 207 illustrates an example embodiment where the example operational flow 20000 of FIG. 200 may include at least one additional operation. Additional operations may include an operation 13110, an operation 5502, and/or an operation 5504.

After a start operation, an operation 20010, and an operation 20020, the operational flow 20700 moves to an operation 13110. Operation 13110 illustrates transmitting to an off-site entity the status indicative of combustible fuel utilization in comparison to electricity utilization for the vehicle.

The operation 5502 illustrates transmitting the status indicative of combustible fuel utilization in comparison to electricity utilization for the vehicle from an aftermarket part.

The operation 5504 illustrates transmitting the status indicative of combustible fuel utilization in comparison to electricity utilization for the vehicle from at least one of the Internet, a personal communication device, a personal computer, a laptop computer, a palmtop computer, a Personal Digital Assistant (PDA), a portable media player, or a mobile telephone.

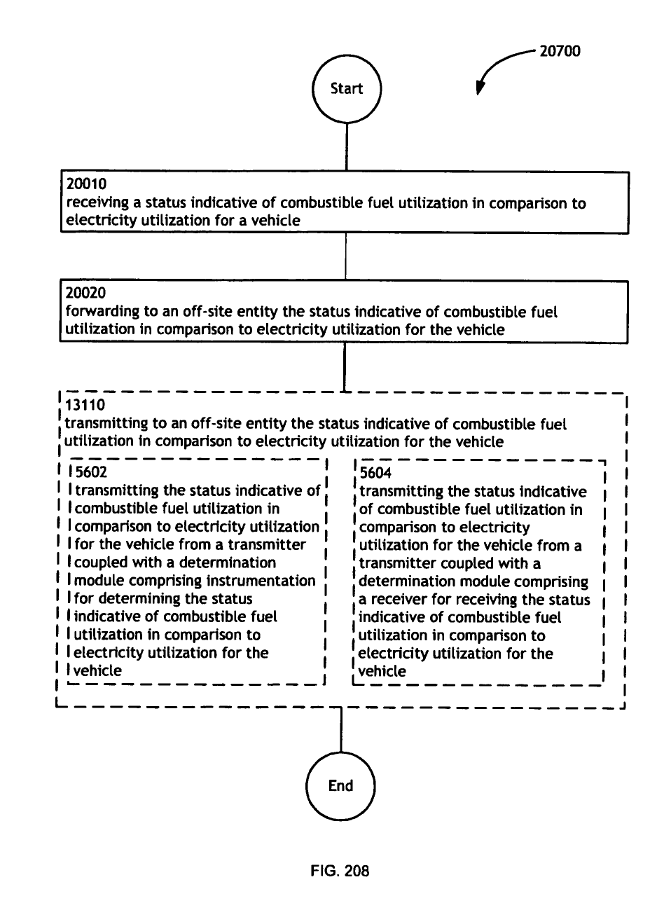

FIG. 208 illustrates alternative embodiments of the example operational flow 20700 of FIG. 207. FIG. 208 illustrates example embodiments where the operation 13110 may include at least one additional operation. Additional operations may include an operation 5602, and/or an operation 5604.

The operation 5602 illustrates transmitting the status indicative of combustible fuel utilization in comparison to electricity utilization for the vehicle from a transmitter coupled with a determination module comprising instrumentation for determining the status indicative of combustible fuel utilization in comparison to electricity utilization for the vehicle.

The operation 5604 illustrates transmitting the status indicative of combustible fuel utilization in comparison to electricity utilization for the vehicle from a transmitter coupled with a determination module comprising a receiver for receiving the status indicative of combustible fuel utilization in comparison to electricity utilization for the vehicle.

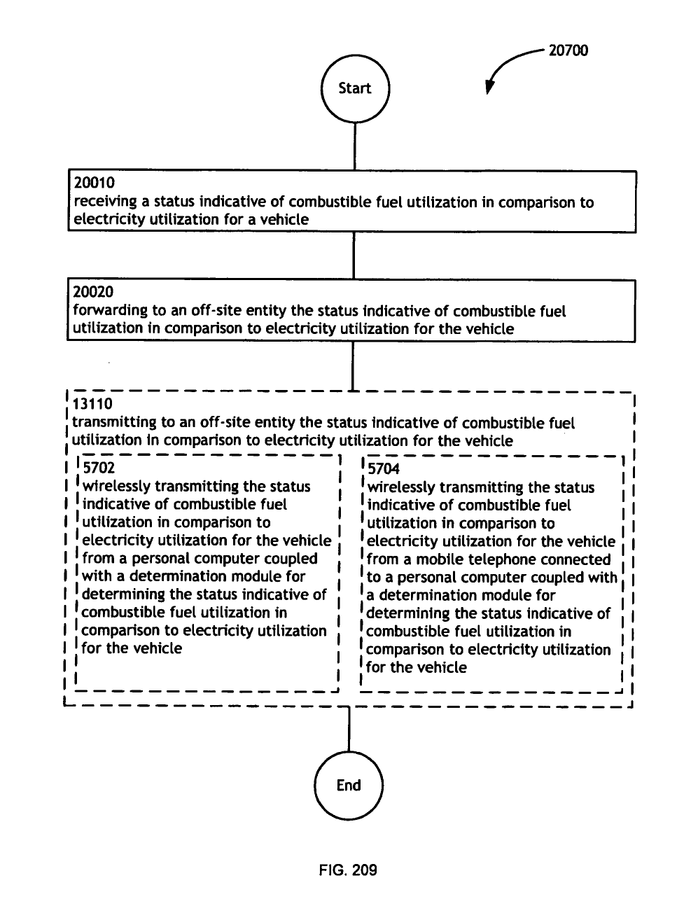

FIG. 209 illustrates alternative embodiments of the example operational flow 20700 of FIG. 207. FIG. 209 illustrates example embodiments where the operation 13110 may include at least one additional operation. Additional operations may include an operation 5702, and/or an operation 5704.

The operation 5702 illustrates wirelessly transmitting the status indicative of combustible fuel utilization in comparison to electricity utilization for the vehicle from a personal computer coupled with a determination module for determining the status indicative of combustible fuel utilization in comparison to electricity utilization for the vehicle.

The operation 5704 illustrates wirelessly transmitting the status indicative of combustible fuel utilization in comparison to electricity utilization for the vehicle from a mobile telephone connected to a personal computer coupled with a determination module for determining the status indicative of combustible fuel utilization in comparison to electricity utilization for the vehicle.

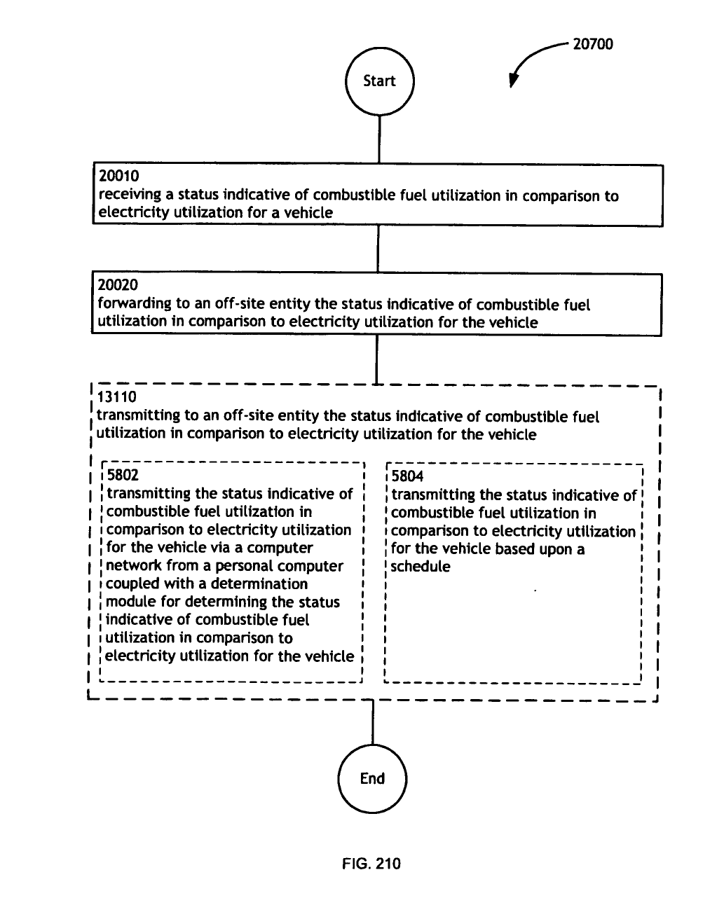

FIG. 210 illustrates alternative embodiments of the example operational flow 20700 of FIG. 207. FIG. 210 illustrates example embodiments where the operation 13110 may include at least one additional operation. Additional operations may include an operation 5802, and/or an operation 5804.

The operation 5802 illustrates transmitting the status indicative of combustible fuel utilization in comparison to electricity utilization for the vehicle via a computer network from a personal computer coupled with a determination module for determining the status indicative of combustible fuel utilization in comparison to electricity utilization for the vehicle.

The operation 5804 illustrates transmitting the status indicative of combustible fuel utilization in comparison to electricity utilization for the vehicle based upon a schedule.

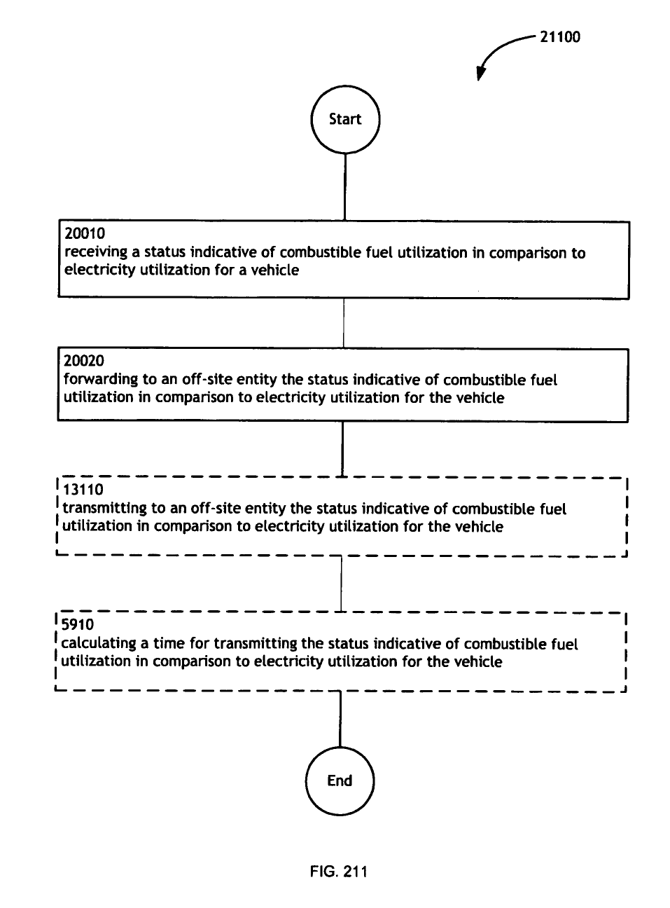

FIG. 211 illustrates an operational flow 21100 representing example operations related to receiving a status indicative of combustible fuel utilization in comparison to electricity utilization for a vehicle, forwarding to an off-site entity the status indicative of combustible fuel utilization in comparison to electricity utilization for the vehicle, transmitting to an off-site entity the status indicative of combustible fuel utilization in comparison to electricity utilization for the vehicle, and calculating a time for transmitting the status. FIG. 211 illustrates an example embodiment where the example operational flow 20700 of FIG. 207 may include at least one additional operation. Additional operations may include an operation 5910.

After a start operation, an operation 20010, an operation 20020, and an operation 13110, the operational flow 21100 moves to an operation 5910. Operation 5910 illustrates calculating a time for transmitting the status indicative of combustible fuel utilization in comparison to electricity utilization for the vehicle.

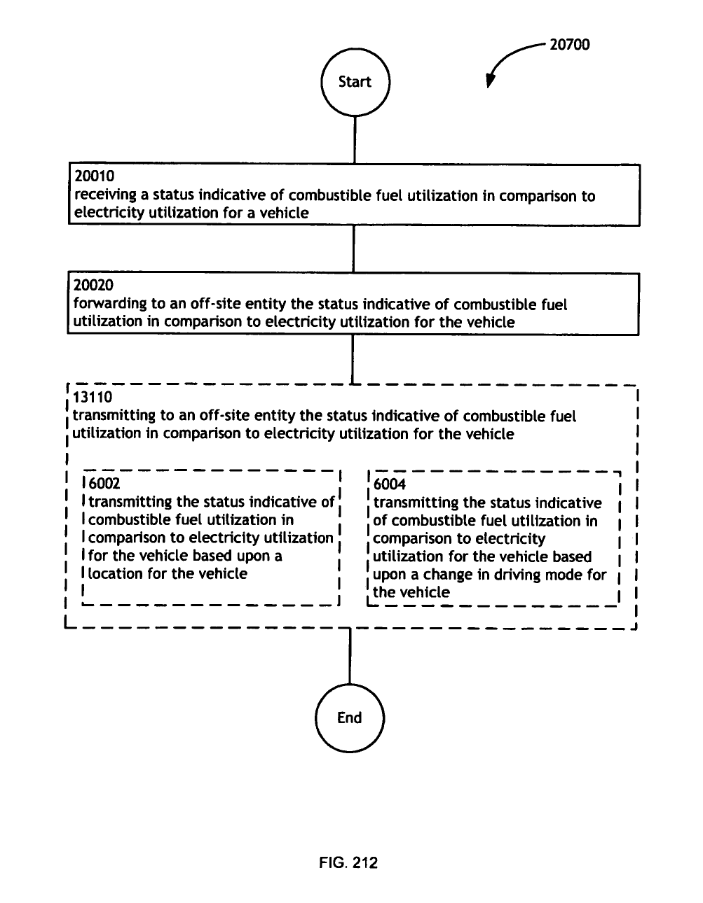

FIG. 212 illustrates alternative embodiments of the example operational flow 20700 of FIG. 207. FIG. 212 illustrates example embodiments where the operation 13110 may include at least one additional operation. Additional operations may include an operation 6002, and/or an operation 6004.

The operation 6002 illustrates transmitting the status indicative of combustible fuel utilization in comparison to electricity utilization for the vehicle based upon a location for the vehicle.

The operation 6004 illustrates transmitting the status indicative of combustible fuel utilization in comparison to electricity utilization for the vehicle based upon a change in driving mode for the vehicle.

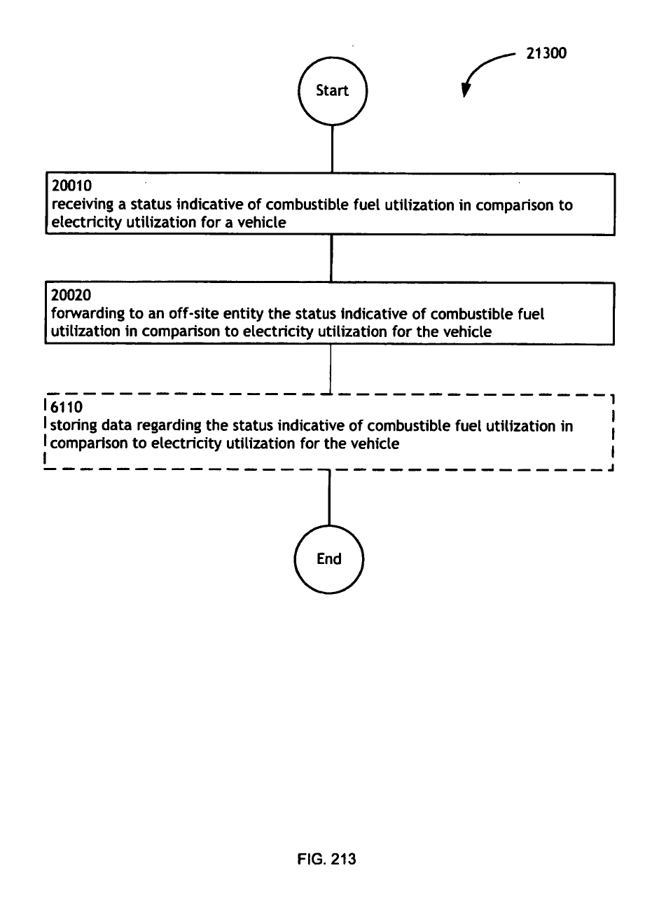

FIG. 213 illustrates an operational flow 21300 representing example operations related to receiving a status indicative of combustible fuel utilization in comparison to electricity utilization for a vehicle, forwarding to an off-site entity the status indicative of combustible fuel utilization in comparison to electricity utilization for the vehicle, and storing data regarding the status. FIG. 213 illustrates an example embodiment where the example operational flow 20000 of FIG. 200 may include at least one additional operation. Additional operations may include an operation 6110.

After a start operation, an operation 20010, and an operation 20020, the operational flow 21300 moves to an operation 6110. Operation 6110 illustrates storing data regarding the status indicative of combustible fuel utilization in comparison to electricity utilization for the vehicle.

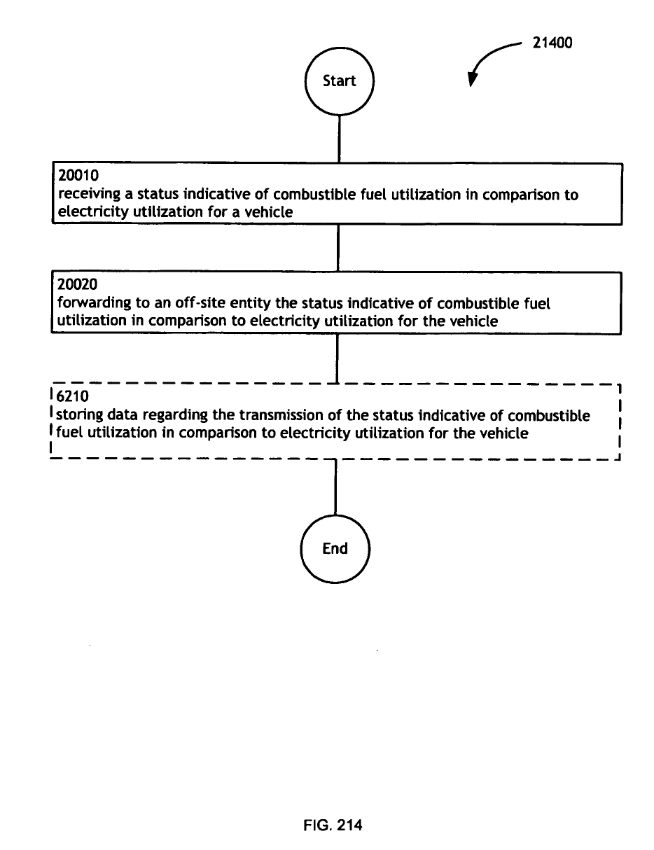

FIG. 214 illustrates an operational flow 21400 representing example operations related to receiving a status indicative of combustible fuel utilization in comparison to electricity utilization for a vehicle, forwarding to an off-site entity the status indicative of combustible fuel utilization in comparison to electricity utilization for the vehicle, and storing data regarding the transmission of the status. FIG. 214 illustrates an example embodiment where the example operational flow 20000 of FIG. 200 may include at least one additional operation. Additional operations may include an operation 6210.

After a start operation, an operation 20010, and an operation 20020, the operational flow 21400 moves to an operation 6210. Operation 6210 illustrates storing data regarding the transmission of the status indicative of combustible fuel utilization in comparison to electricity utilization for the vehicle.

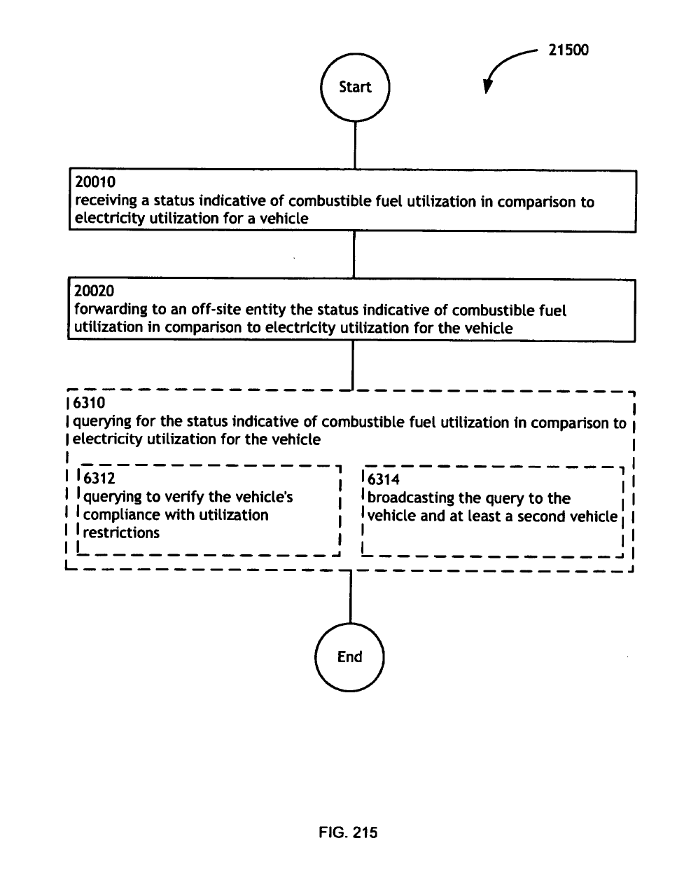

FIG. 215 illustrates an operational flow 21500 representing example operations related to receiving a status indicative of combustible fuel utilization in comparison to electricity utilization for a vehicle, forwarding to an off-site entity the status indicative of combustible fuel utilization in comparison to electricity utilization for the vehicle, and querying for the status. FIG. 215 illustrates an example embodiment where the example operational flow 20000 of FIG. 200 may include at least one additional operation. Additional operations may include an operation 6310, an operation 6312, and/or an operation 6314.

After a start operation, an operation 20010, and an operation 20020, the operational flow 21500 moves to an operation 6310. Operation 6310 illustrates querying for the status indicative of combustible fuel utilization in comparison to electricity utilization for the vehicle.

The operation 6312 illustrates querying to verify the vehicle's compliance with utilization restrictions.

The operation 6314 illustrates broadcasting the query to the vehicle and at least a second vehicle.

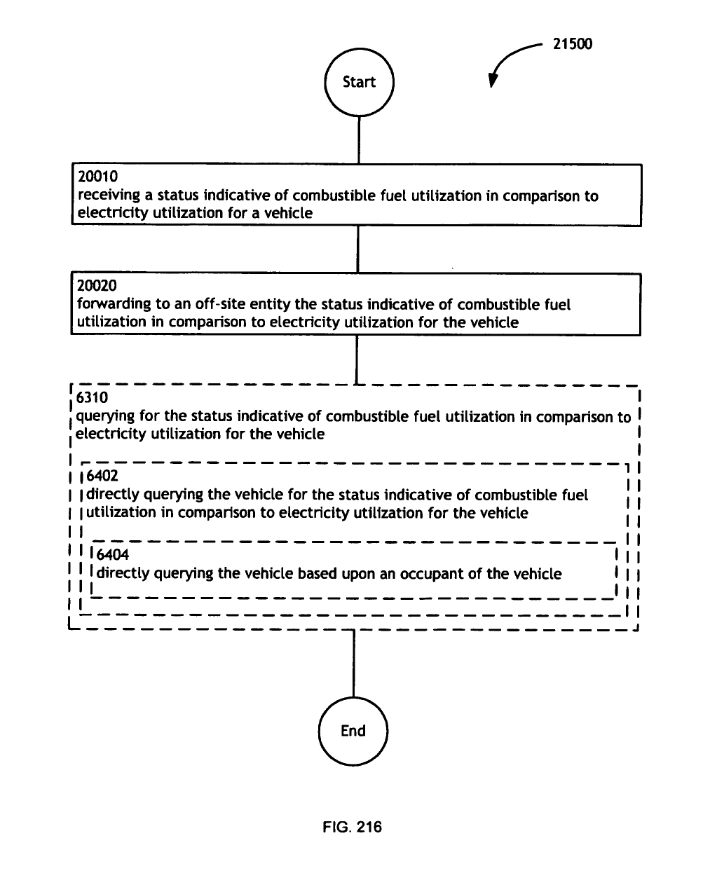

FIG. 216 illustrates alternative embodiments of the example operational flow 21500 of FIG. 215. FIG. 216 illustrates example embodiments where the operation 6310 may include at least one additional operation. Additional operations may include an operation 6402, and/or an operation 6404.

The operation 6402 illustrates directly querying the vehicle for the status indicative of combustible fuel utilization in comparison to electricity utilization for the vehicle. Further, the operation 6404 illustrates directly querying the vehicle based upon an occupant of the vehicle.

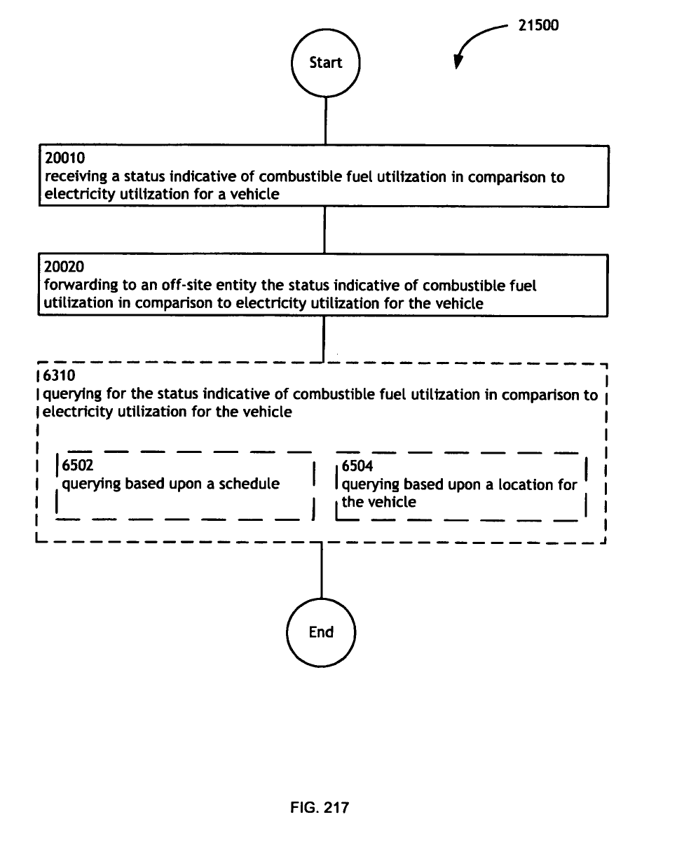

FIG. 217 illustrates alternative embodiments of the example operational flow 21500 of FIG. 215. FIG. 217 illustrates example embodiments where the operation 6310 may include at least one additional operation. Additional operations may include an operation 6502, and/or an operation 6504.

The operation 6502 illustrates querying based upon a schedule.

The operation 6504 illustrates querying based upon a location for the vehicle.

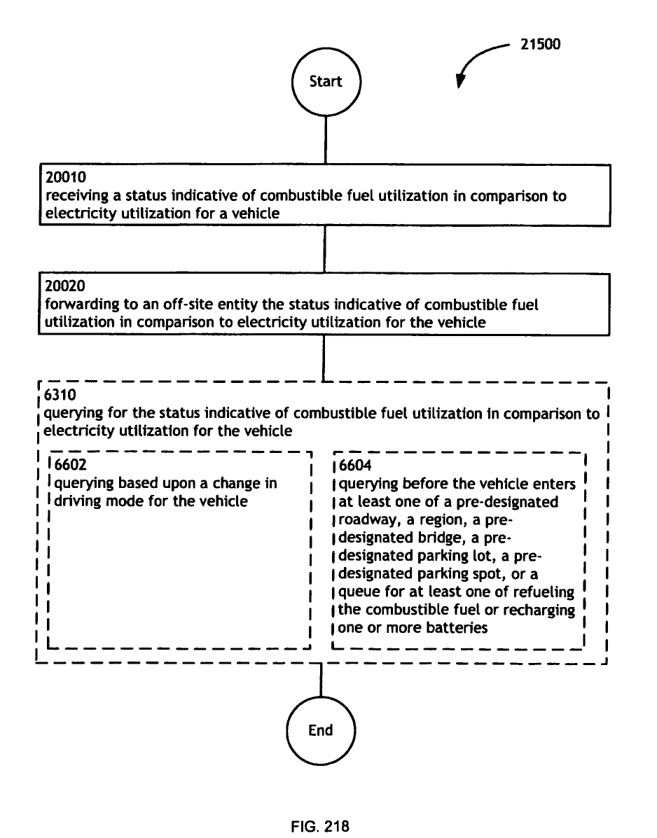

FIG. 218 illustrates alternative embodiments of the example operational flow 21500 of FIG. 215. FIG. 218 illustrates example embodiments where the operation 6310 may include at least one additional operation. Additional operations may include an operation 6602, and/or an operation 6604.

The operation 6602 illustrates querying based upon a change in driving mode for the vehicle.

The operation 6604 illustrates querying before the vehicle enters at least one of a pre-designated roadway, a region, a pre-designated bridge, a pre-designated parking lot, a pre-designated parking spot, or a queue for at least one of refueling the combustible fuel or recharging one or more batteries.

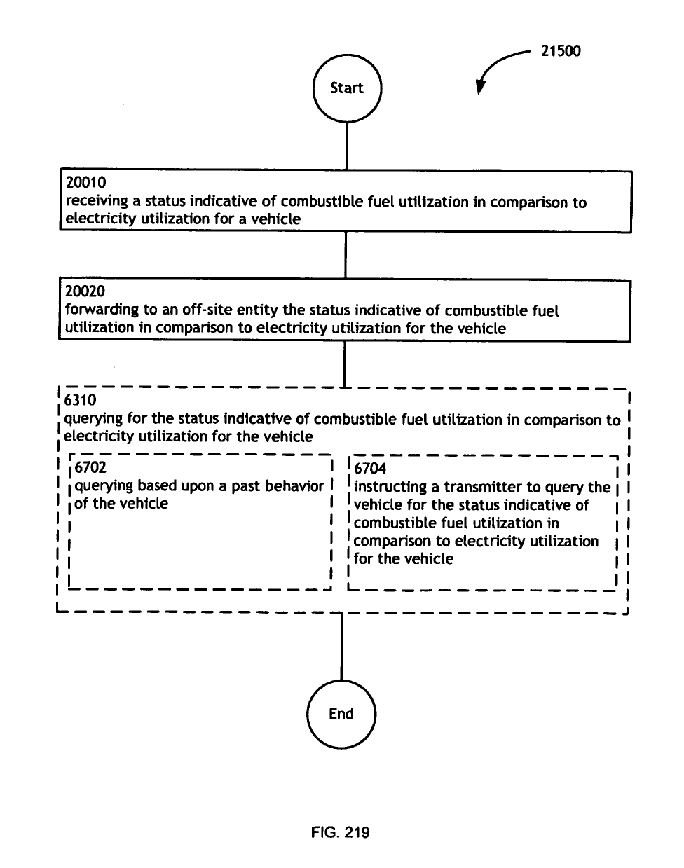

FIG. 219 illustrates alternative embodiments of the example operational flow 21500 of FIG. 215. FIG. 219 illustrates example embodiments where the operation 6310 may include at least one additional operation. Additional operations may include an operation 6702, and/or an operation 6704.

The operation 6702 illustrates querying based upon a past behavior of the vehicle.

The operation 6704 illustrates instructing a transmitter to query the vehicle for the status indicative of combustible fuel utilization in comparison to electricity utilization for the vehicle.

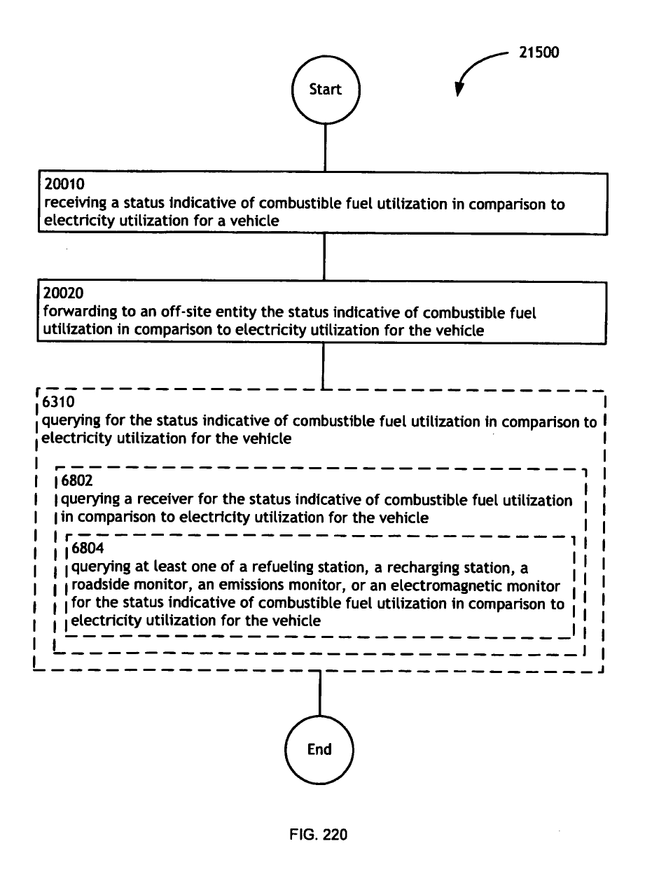

FIG. 220 illustrates alternative embodiments of the example operational flow 21500 of FIG. 215. FIG. 220 illustrates example embodiments where the operation 6310 may include at least one additional operation. Additional operations may include an operation 6802, and/or an operation 6804.

The operation 6802 illustrates querying a receiver for the status indicative of combustible fuel utilization in comparison to electricity utilization for the vehicle. Further, the operation 6804 illustrates querying at least one of a refueling station, a recharging station, a roadside monitor, an emissions monitor, or an electromagnetic monitor for the status indicative of combustible fuel utilization in comparison to electricity utilization for the vehicle.

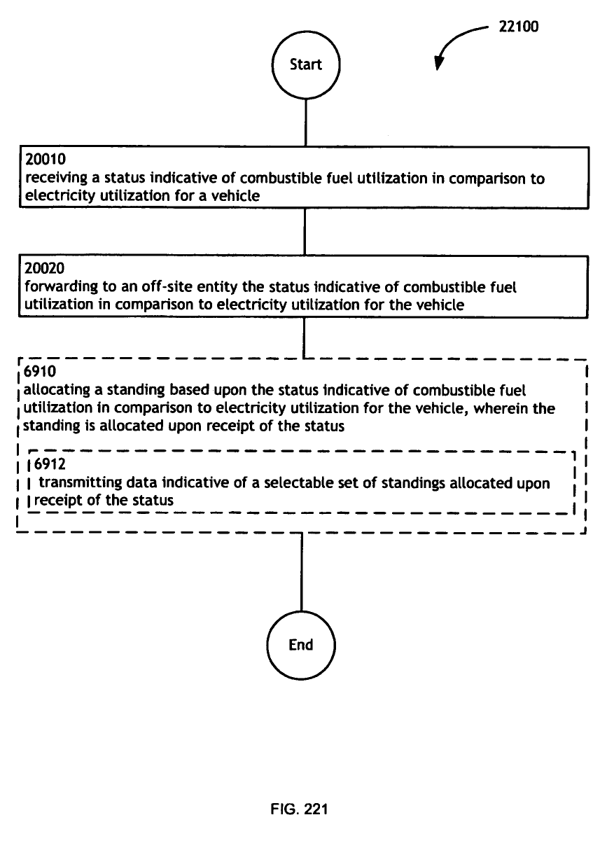

FIG. 221 illustrates an operational flow 22100 representing example operations related to receiving a status indicative of combustible fuel utilization in comparison to electricity utilization for a vehicle, forwarding to an off-site entity the status indicative of combustible fuel utilization in comparison to electricity utilization for the vehicle, and allocating a standing based upon the status indicative of combustible fuel utilization in comparison to electricity utilization for the vehicle. FIG. 221 illustrates an example embodiment where the example operational flow 20000 of FIG. 200 may include at least one additional operation. Additional operations may include an operation 6910, and/or an operation 6912.

After a start operation, an operation 20010, and an operation 20020, the operational flow 22100 moves to an operation 6910. Operation 6910 illustrates allocating a standing based upon the status indicative of combustible fuel utilization in comparison to electricity utilization for the vehicle, wherein the standing is allocated upon receipt of the status.

The operation 6912 illustrates transmitting data indicative of a selectable set of standings allocated upon receipt of the status.

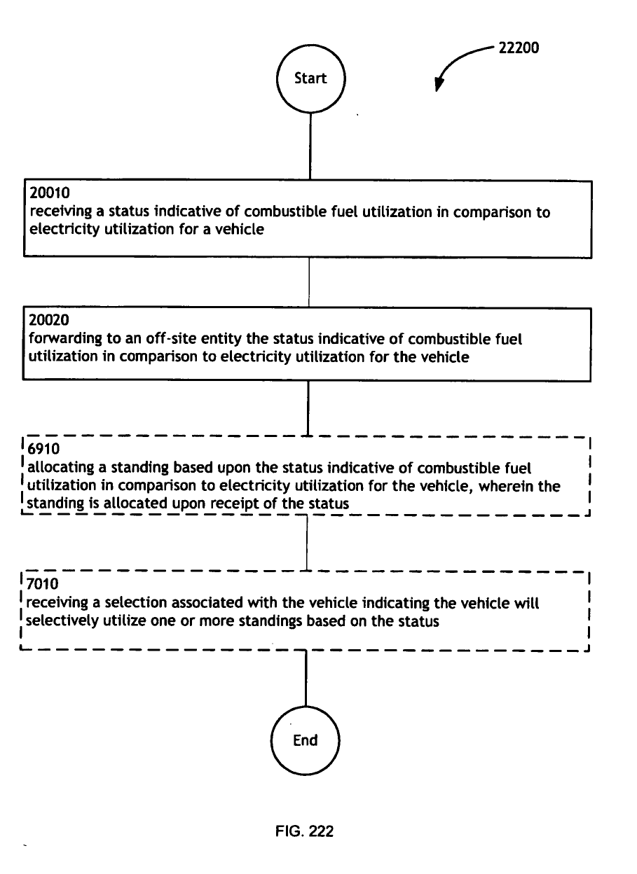

FIG. 222 illustrates an operational flow 22200 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and receiving a selection associated with the vehicle. FIG. 222 illustrates an example embodiment where the example operational flow 22100 of FIG. 221 may include at least one additional operation. Additional operations may include an operation 7010.

After a start operation, an operation 20010, an operation 20020, and an operation 6910, the operational flow 22200 moves to an operation 7010. Operation 7010 illustrates receiving a selection associated with the vehicle indicating the vehicle will selectively utilize one or more standings based on the status.

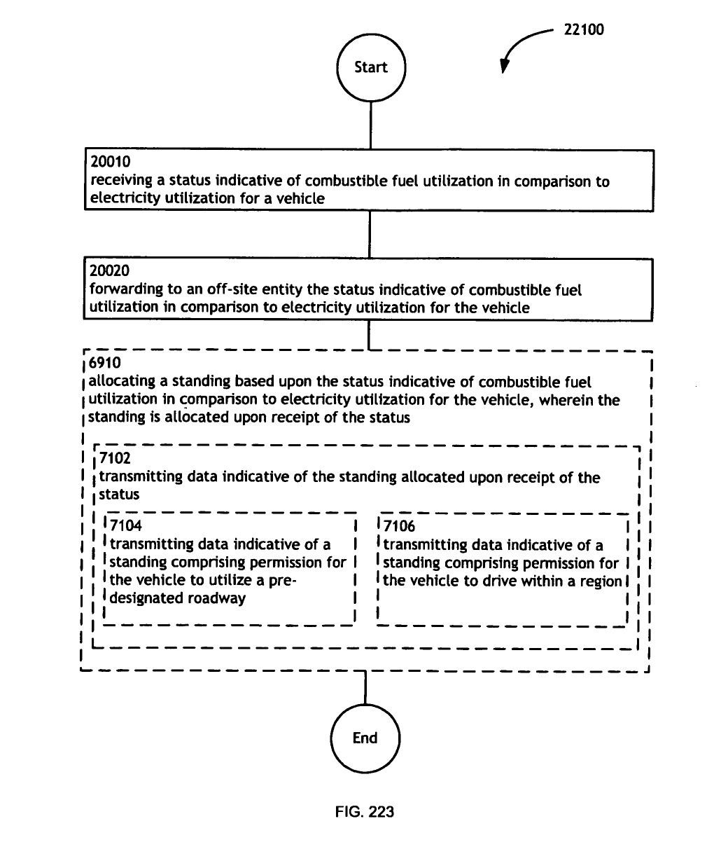

FIG. 223 illustrates alternative embodiments of the example operational flow 22100 of FIG. 221. FIG. 223 illustrates example embodiments where the operation 6910 may include at least one additional operation. Additional operations may include an operation 7102, an operation 7104, and/or an operation 7106.

The operation 7102 illustrates transmitting data indicative of the standing allocated upon receipt of the status. Further, the operation 7104 illustrates transmitting data indicative of a standing comprising permission for the vehicle to utilize a pre-designated roadway. Further, the operation 7106 illustrates transmitting data indicative of a standing comprising permission for the vehicle to drive within a region.

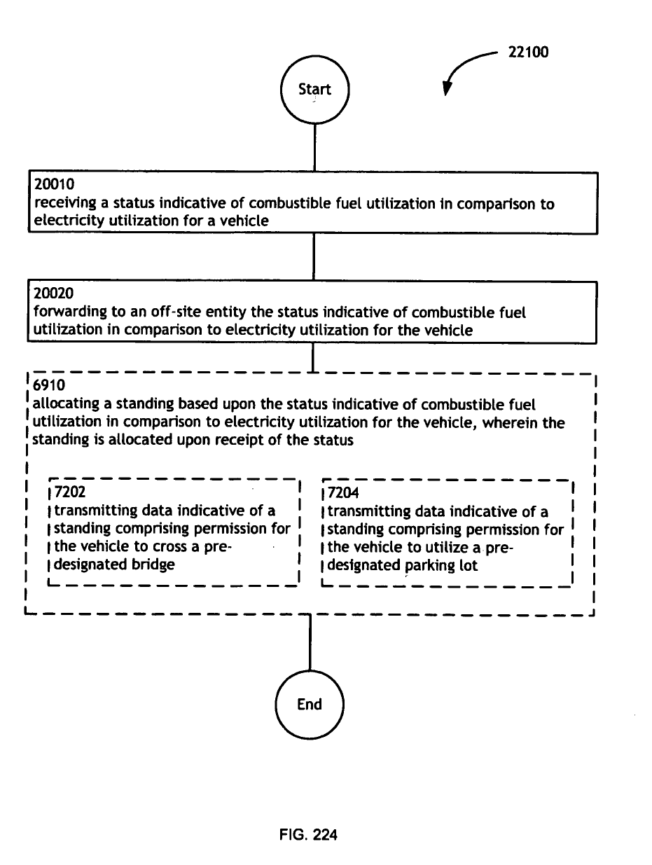

FIG. 224 illustrates alternative embodiments of the example operational flow 22100 of FIG. 221. FIG. 224 illustrates example embodiments where the operation 6910 may include at least one additional operation. Additional operations may include an operation 7202, and/or an operation 7204. Further, the operation 7202 illustrates transmitting data indicative of a standing comprising permission for the vehicle to cross a pre-designated bridge. Further, the operation 7204 illustrates transmitting data indicative of a standing comprising permission for the vehicle to utilize a pre-designated parking lot.

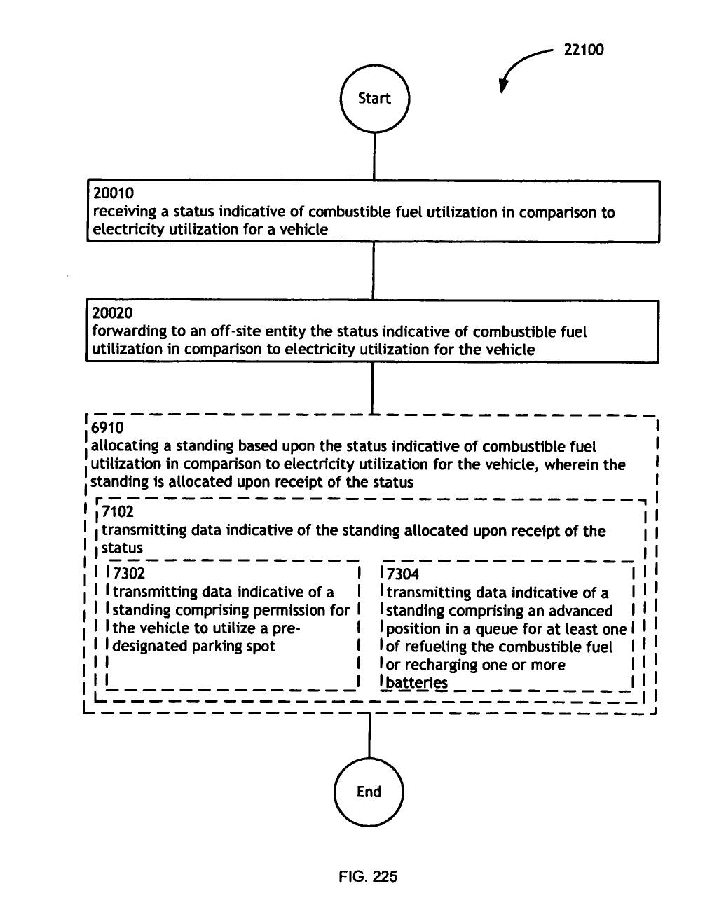

FIG. 225 illustrates alternative embodiments of the example operational flow 22100 of FIG. 221. FIG. 225 illustrates example embodiments where the operation 6910 may include at least one additional operation. Additional operations may include an operation 7302, and/or an operation 7304. Further, the operation 7302 illustrates transmitting data indicative of a standing comprising permission for the vehicle to utilize a pre-designated parking spot. Further, the operation 7304 illustrates transmitting data indicative of a standing comprising an advanced position in a queue for at least one of refueling the combustible fuel or recharging one or more batteries.

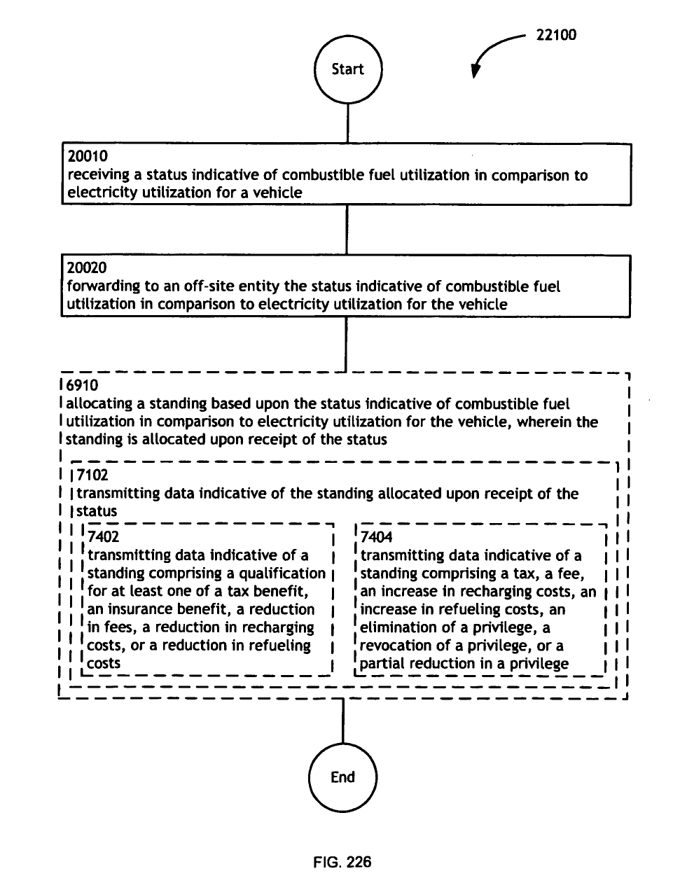

FIG. 226 illustrates alternative embodiments of the example operational flow 22100 of FIG. 221. FIG. 226 illustrates example embodiments where the operation 6910 may include at least one additional operation. Additional operations may include an operation 7402, and/or an operation 7404. Further, the operation 7402 illustrates transmitting data indicative of a standing comprising a qualification for at least one of a tax benefit, an insurance benefit, a reduction in fees, a reduction in recharging costs, or a reduction in refueling costs. Further, the operation 7404 illustrates transmitting data indicative of a standing comprising a tax, a fee, an increase in recharging costs, an increase in refueling costs, an elimination of a privilege, a revocation of a privilege, or a partial reduction in a privilege.

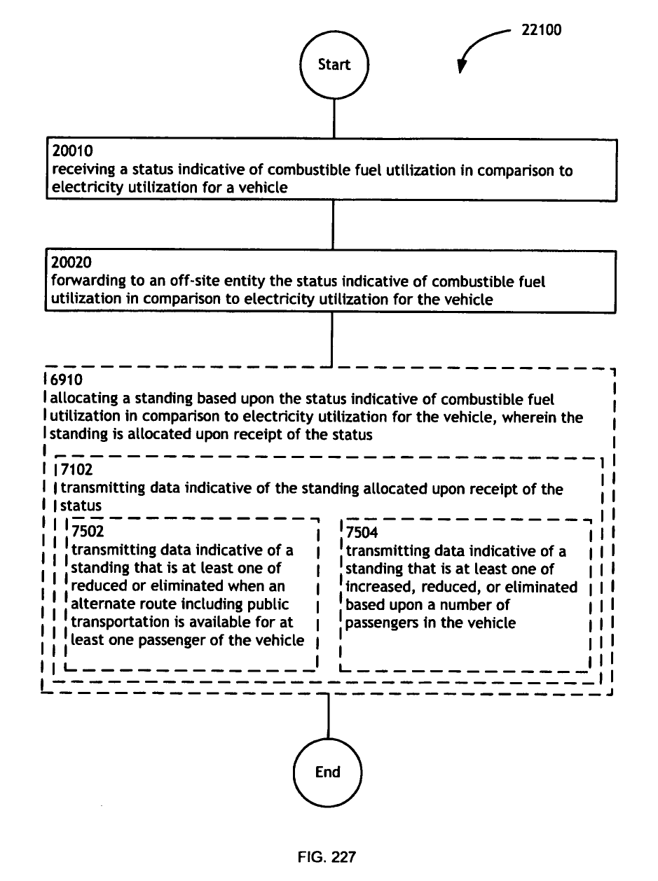

FIG. 227 illustrates alternative embodiments of the example operational flow 22100 of FIG. 221. FIG. 227 illustrates example embodiments where the operation 6910 may include at least one additional operation. Additional operations may include an operation 7502, and/or an operation 7504. Further, the operation 7502 illustrates transmitting data indicative of a standing that is at least one of reduced or eliminated when an alternate route including public transportation is available for at least one passenger of the vehicle. Further, the operation 7504 illustrates transmitting data indicative of a standing that is at least one of increased, reduced, or eliminated based upon a number of passengers in the vehicle.

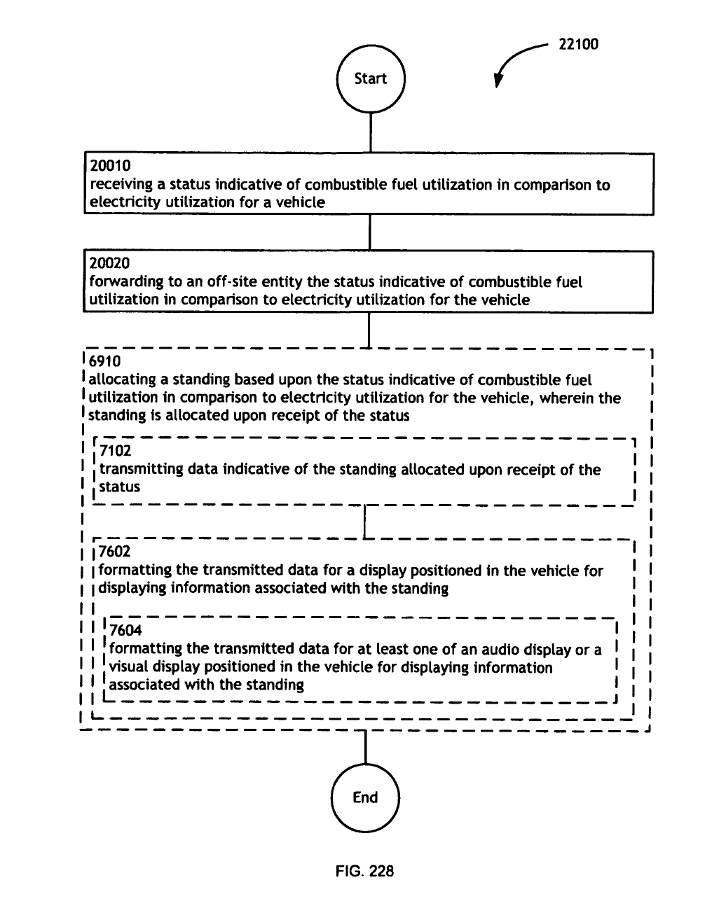

FIG. 228 illustrates alternative embodiments of the example operational flow 22100 of FIG. 221. FIG. 228 illustrates example embodiments where the operation 6910 may include at least one additional operation. Additional operations may include an operation 7602, and/or an operation 7604. Further, the operation 7602 illustrates formatting the transmitted data for a display positioned in the vehicle for displaying information associated with the standing. Further, the operation 7604 illustrates formatting the transmitted data for at least one of an audio display or a visual display positioned in the vehicle for displaying information associated with the standing.

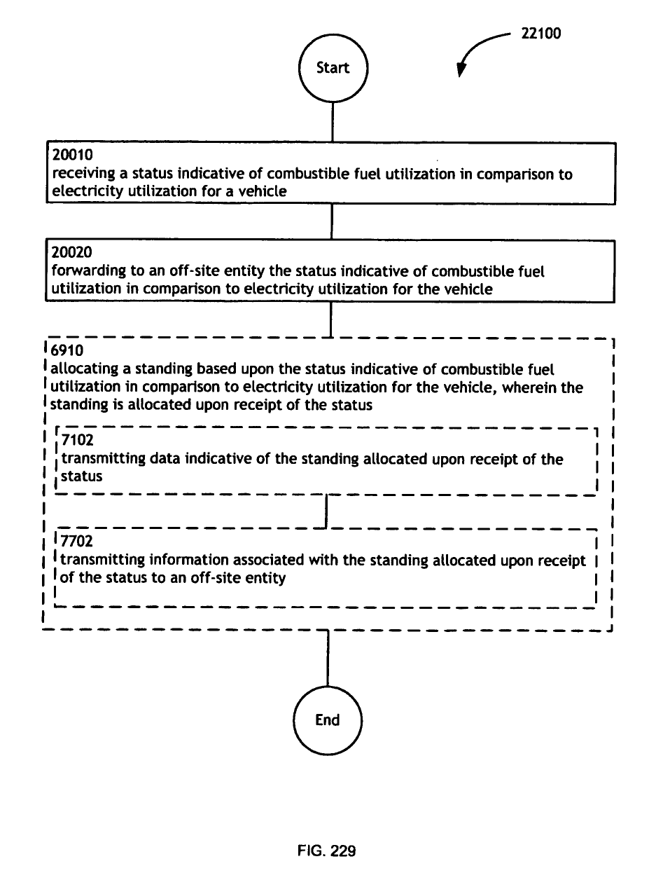

FIG. 229 illustrates alternative embodiments of the example operational flow 22100 of FIG. 221. FIG. 229 illustrates example embodiments where the operation 6910 may include at least one additional operation. Additional operations may include an operation 7702. Further, the operation 7702 illustrates transmitting information associated with the standing allocated upon receipt of the status to an off-site entity.

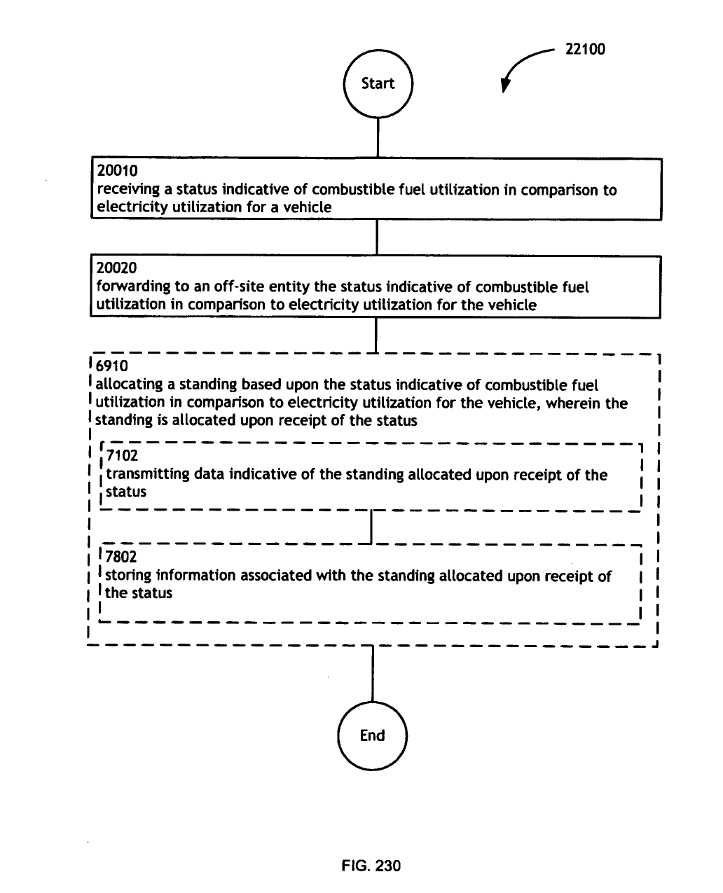

FIG. 230 illustrates alternative embodiments of the example operational flow 22100 of FIG. 221. FIG. 230 illustrates example embodiments where the operation 6910 may include at least one additional operation. Additional operations may include an operation 7802. Further, the operation 7802 illustrates storing information associated with the standing allocated upon receipt of the status.

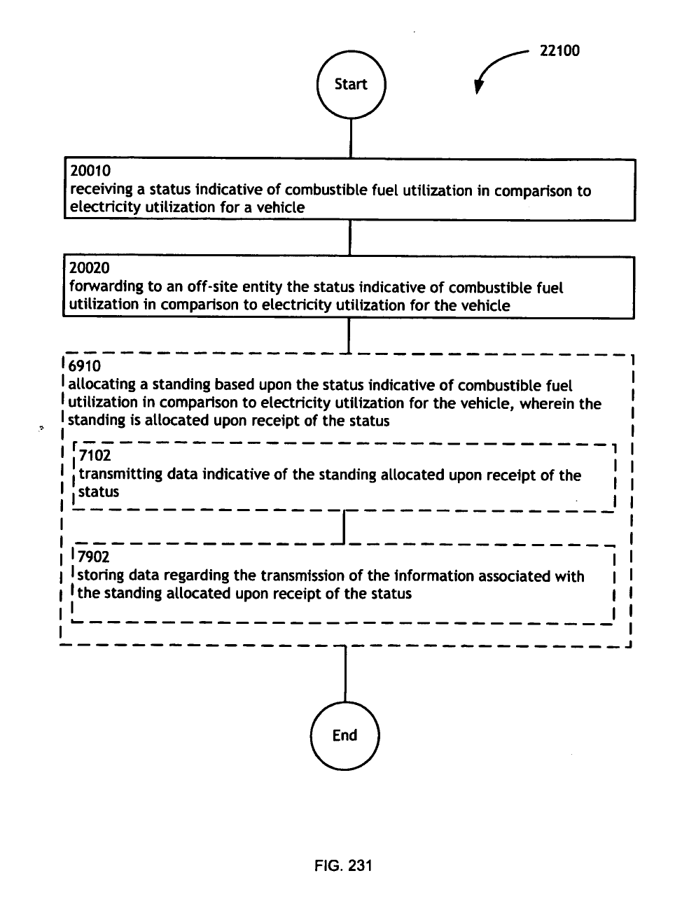

FIG. 231 illustrates alternative embodiments of the example operational flow 22100 of FIG. 221. FIG. 231 illustrates example embodiments where the operation 6910 may include at least one additional operation. Additional operations may include an operation 7902. Further, the operation 7902 illustrates storing data regarding the transmission of the information associated with the standing allocated upon receipt of the status.

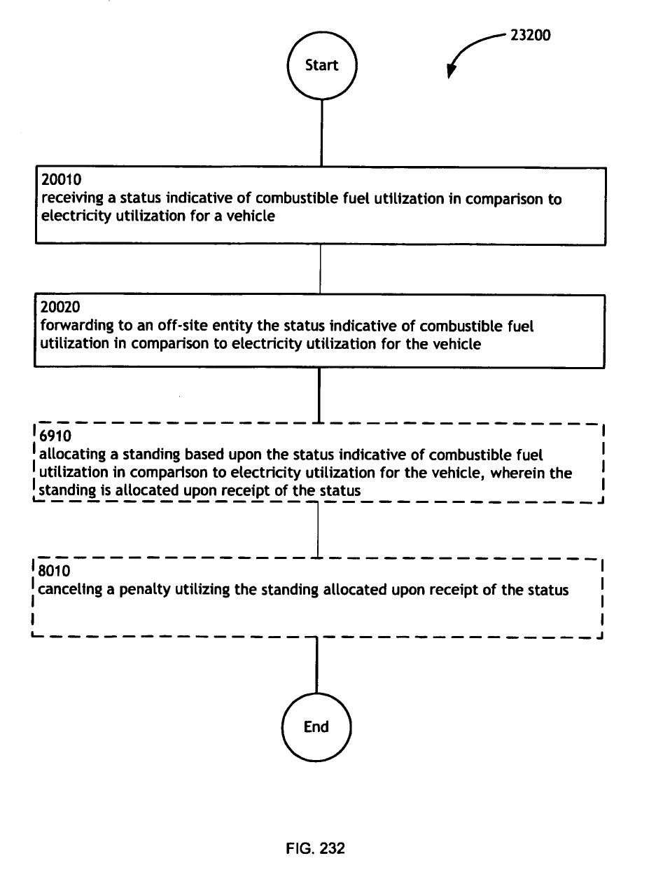

FIG. 232 illustrates an operational flow 23200 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and canceling a penalty utilizing the standing. FIG. 232 illustrates an example embodiment where the example operational flow 22100 of FIG. 221 may include at least one additional operation. Additional operations may include an operation 8010.

After a start operation, an operation 20010, an operation 20020, and an operation 6910, the operational flow 23200 moves to an operation 8010. Operation 8010 illustrates canceling a penalty utilizing the standing allocated upon receipt of the status.

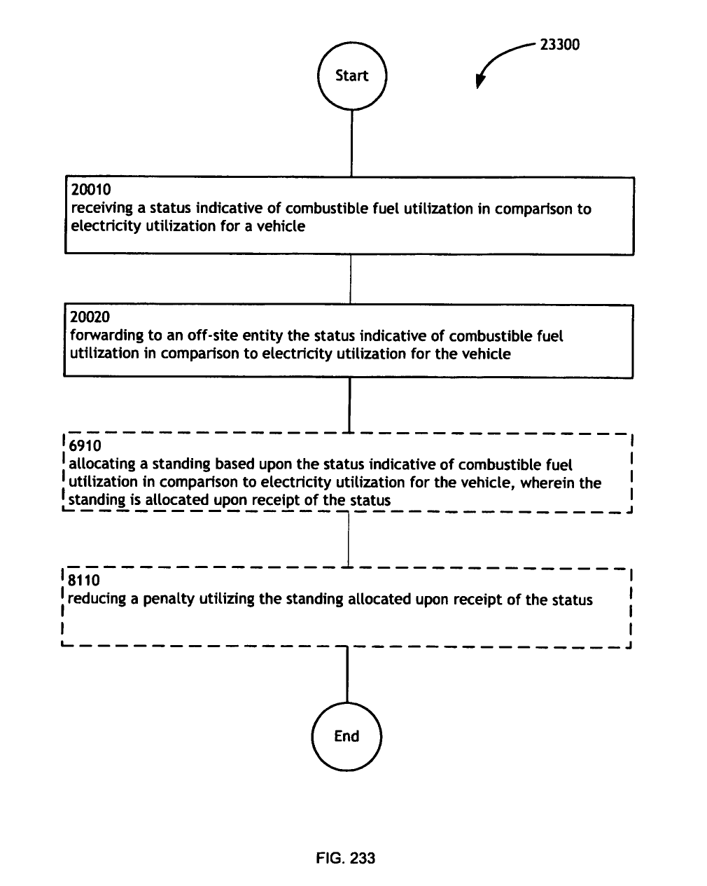

FIG. 233 illustrates an operational flow 23300 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and reducing a penalty utilizing the standing. FIG. 233 illustrates an example embodiment where the example operational flow 22100 of FIG. 221 may include at least one additional operation. Additional operations may include an operation 8110.

After a start operation, an operation 20010, an operation 20020, and an operation 6910, the operational flow 23300 moves to an operation 8110. Operation 8110 illustrates reducing a penalty utilizing the standing allocated upon receipt of the status.

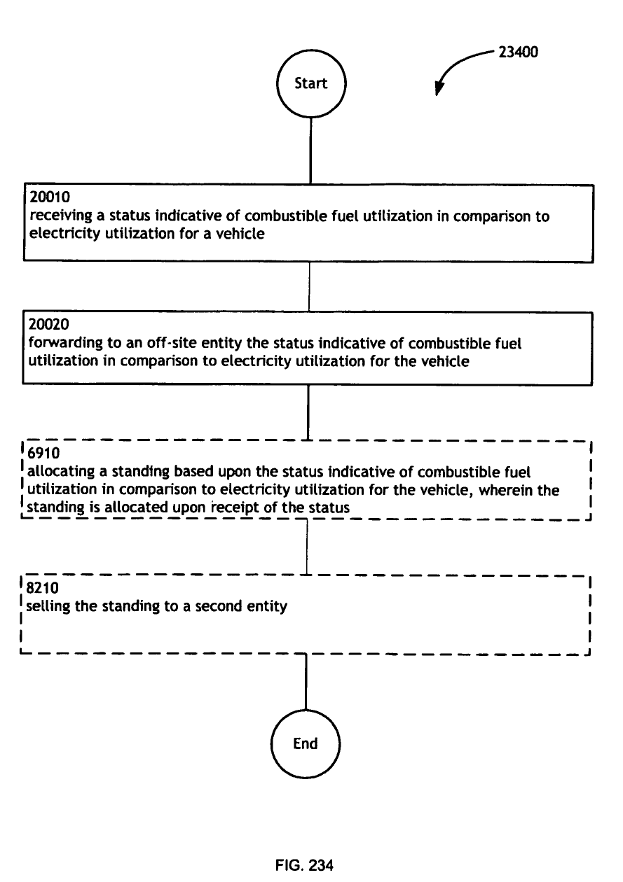

FIG. 234 illustrates an operational flow 23400 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and selling the standing to a second entity. FIG. 234 illustrates an example embodiment where the example operational flow 22100 of FIG. 221 may include at least one additional operation. Additional operations may include an operation 8210.

After a start operation, an operation 20010, an operation 20020, and an operation 6910, the operational flow 23400 moves to an operation 8210. Operation 8210 illustrates selling the standing to a second entity.

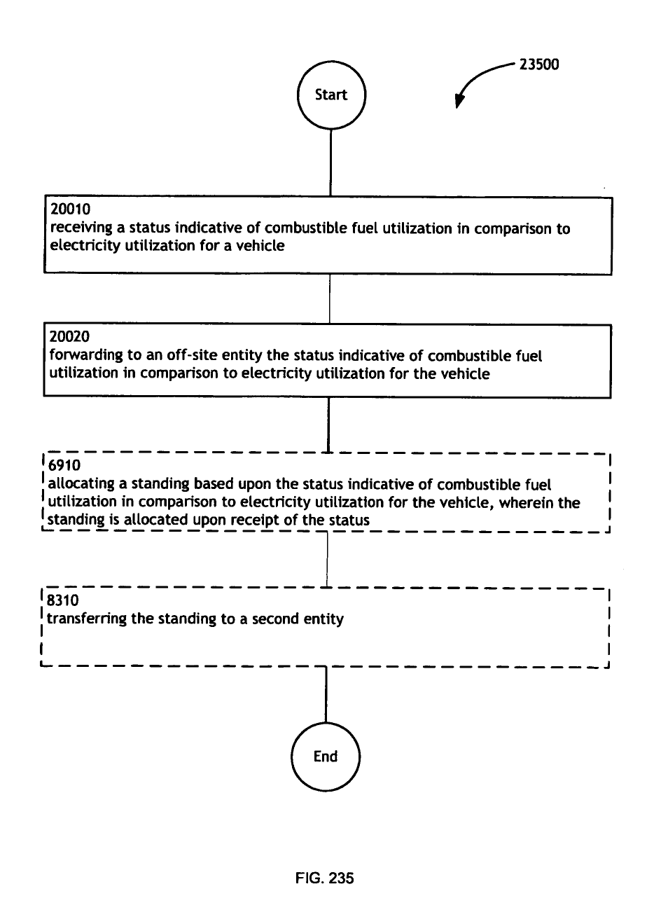

FIG. 235 illustrates an operational flow 23500 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and transferring the standing to a second entity. FIG. 235 illustrates an example embodiment where the example operational flow 22100 of FIG. 221 may include at least one additional operation. Additional operations may include an operation 8310.

After a start operation, an operation 20010, an operation 20020, and an operation 6910, the operational flow 23500 moves to an operation 8310. Operation 8310 illustrates transferring the standing to a second entity.

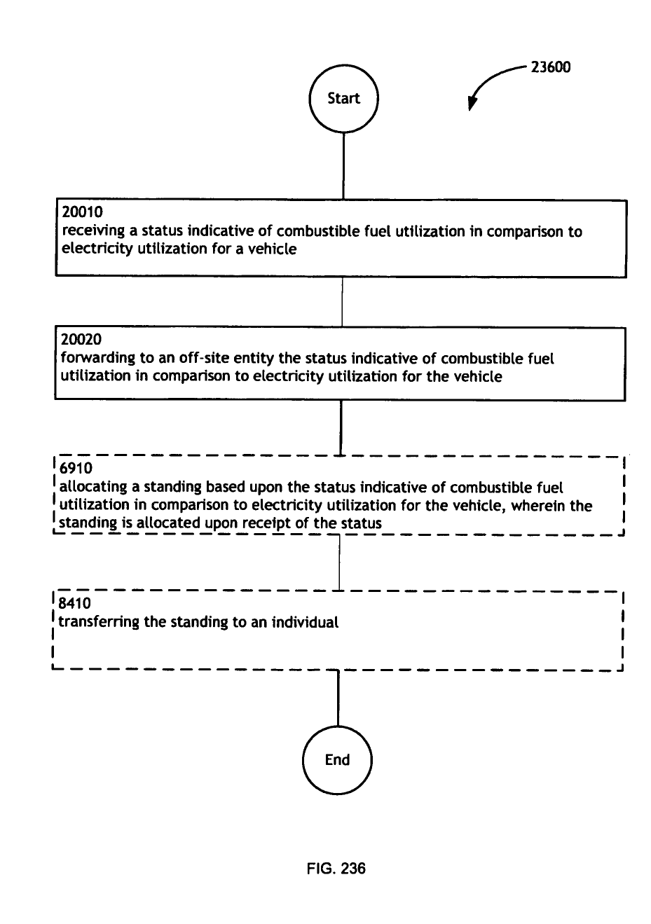

FIG. 236 illustrates an operational flow 23600 representing example operations related to receiving a status indicative of combustible fuel utilization in comparison to electricity utilization for a vehicle, forwarding to an off-site entity the status indicative of combustible fuel utilization in comparison to electricity utilization for the vehicle, allocating a standing based upon the status for the vehicle, and transferring the standing to an individual. FIG. 236 illustrates an example embodiment where the example operational flow 22100 of FIG. 221 may include at least one additional operation. Additional operations may include an operation 8410.

After a start operation, an operation 20010, an operation 20020, and an operation 6910, the operational flow 23600 moves to an operation 8410. Operation 8410 illustrates transferring the standing to an individual.

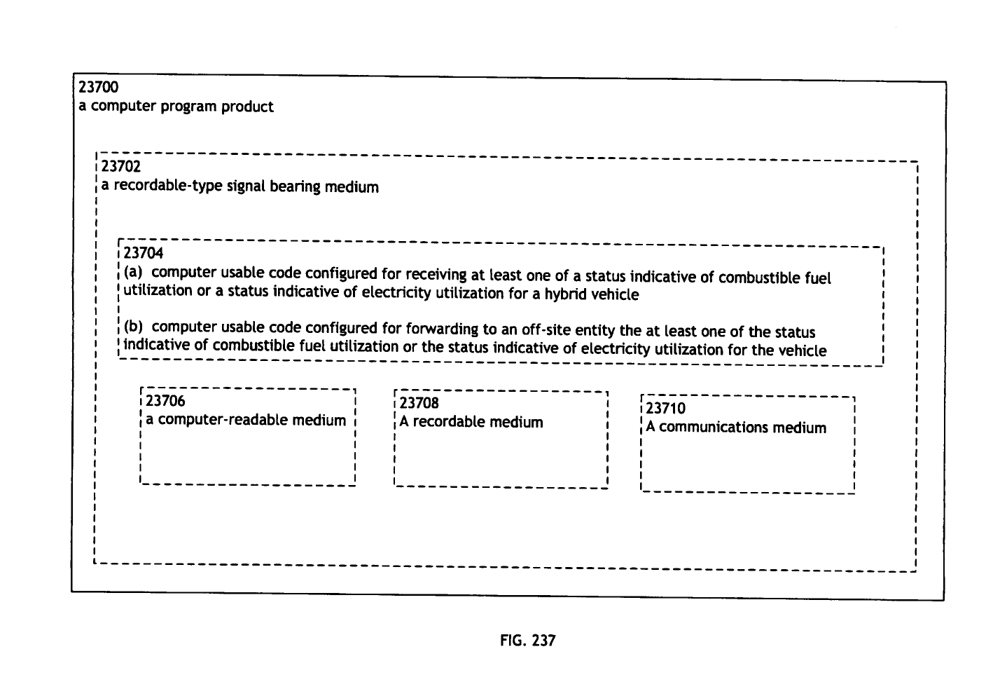

FIG. 237 illustrates a partial view of an example computer program product 23700 that includes a computer program 23704 for executing a computer process on a computing device. An embodiment of the example computer program product 23700 is provided using a recordable-type signal bearing medium 23702, and may include computer usable code configured for receiving at least one of a status indicative of combustible fuel utilization or a status indicative of electricity utilization for a hybrid vehicle and forwarding to an off-site entity the at least one of the status indicative of combustible fuel utilization or the status indicative of electricity utilization for the vehicle. The computer usable code may be, for example, computer executable and/or logic-implemented instructions. In one implementation, the signal-bearing medium 23702 may include a computer-readable medium 23706. In one implementation, the signal bearing medium 23702 may include a recordable medium 23708. In one implementation, the signal bearing medium 23702 may include a communications medium 23710. In an embodiment, allocating the standing based upon the at least one of the status indicative of combustible fuel utilization or the status indicative of electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

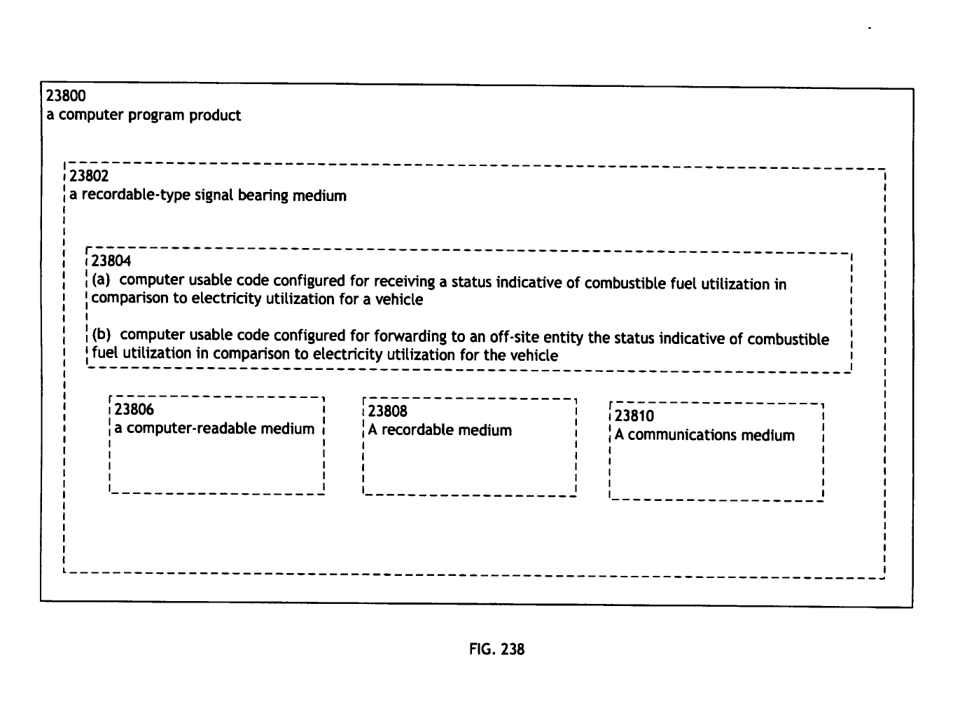

FIG. 238 illustrates a partial view of an example computer program product 23800 that includes a computer program 23804 for executing a computer process on a computing device. An embodiment of the example computer program product 23800 is provided using a recordable-type signal bearing medium 23802, and may include computer usable code configured for receiving a status indicative of combustible fuel utilization in comparison to electricity utilization for a vehicle and forwarding to an off-site entity the status indicative of combustible fuel utilization in comparison to electricity utilization for the vehicle. The computer usable code may be, for example, computer executable and/or logic-implemented instructions. In one implementation, the signal-bearing medium 23802 may include a computer-readable medium 23806. In one implementation, the signal bearing medium 23802 may include a recordable medium 23808. In one implementation, the signal bearing medium 23802 may include a communications medium 23810. In an embodiment, allocating the standing based upon the status indicative of combustible fuel utilization in comparison to electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

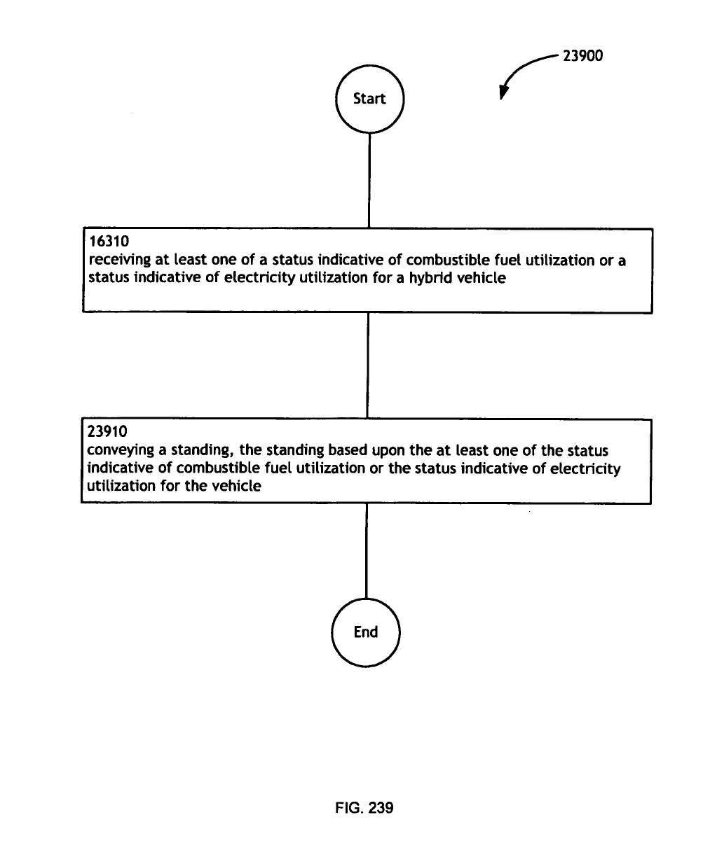

FIG. 239 illustrates an operational flow 23900 representing example operations related to receiving at least one of a status indicative of combustible fuel utilization or a status indicative of electricity utilization for a hybrid vehicle and conveying a standing, the standing based upon the at least one of the status indicative of combustible fuel utilization or the status indicative of electricity utilization for the vehicle. In FIG. 239 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 23900 moves to an operation 16310. Operation 16310 depicts receiving at least one of a status indicative of combustible fuel utilization or a status indicative of electricity utilization for a hybrid vehicle.

Then, operation 23910 depicts conveying a standing, the standing based upon the at least one of the status indicative of combustible fuel utilization or the status indicative of electricity utilization for the vehicle. For example, as shown in FIGS. 1 through 10, the standing may be conveyed to another vehicle. Alternatively, the standing may be conveyed to an individual. For example, the driver may acquire the standing for transfer to another vehicle. Further, the standing may be conveyed to an authority, such as a local government, a state government, or a federal government. In an embodiment, the driver may receive some consideration for the standing (e.g., monetary consideration). In another embodiment, the driver may receive no consideration for the standing.

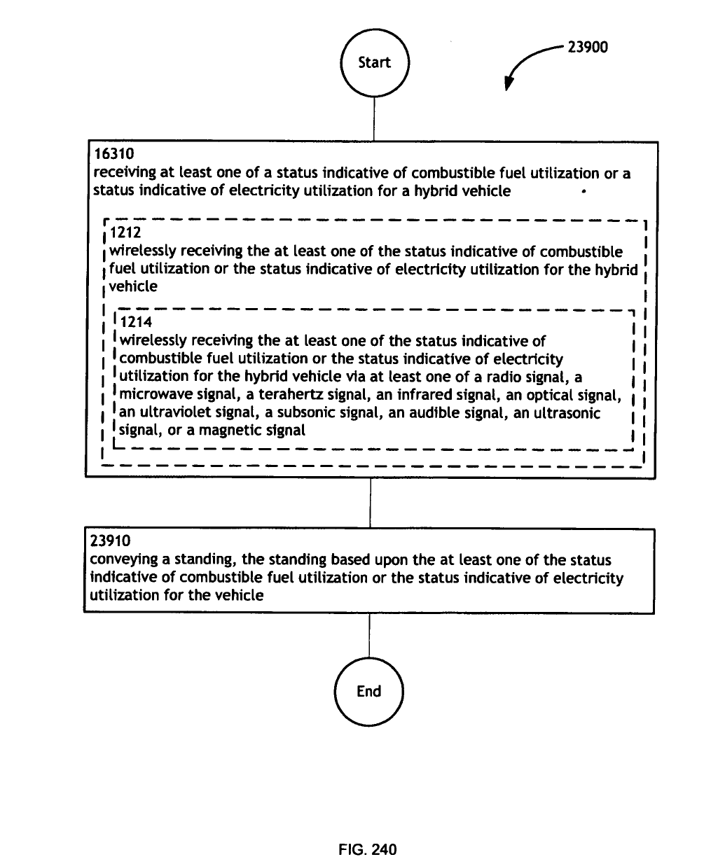

FIG. 240 illustrates alternative embodiments of the example operational flow 23900 of FIG. 239. FIG. 240 illustrates example embodiments where the operation 16310 may include at least one additional operation. Additional operations may include an operation 1212, and/or an operation 1214.

The operation 1212 illustrates wirelessly receiving the at least one of the status indicative of combustible fuel utilization or the status indicative of electricity utilization for the hybrid vehicle. Further, the operation 1214 illustrates wirelessly receiving the at least one of the status indicative of combustible fuel utilization or the status indicative of electricity utilization for the hybrid vehicle via at least one of a radio signal, a microwave signal, a terahertz signal, an infrared signal, an optical signal, an ultraviolet signal, a subsonic signal, an audible signal, an ultrasonic signal, or a magnetic signal.

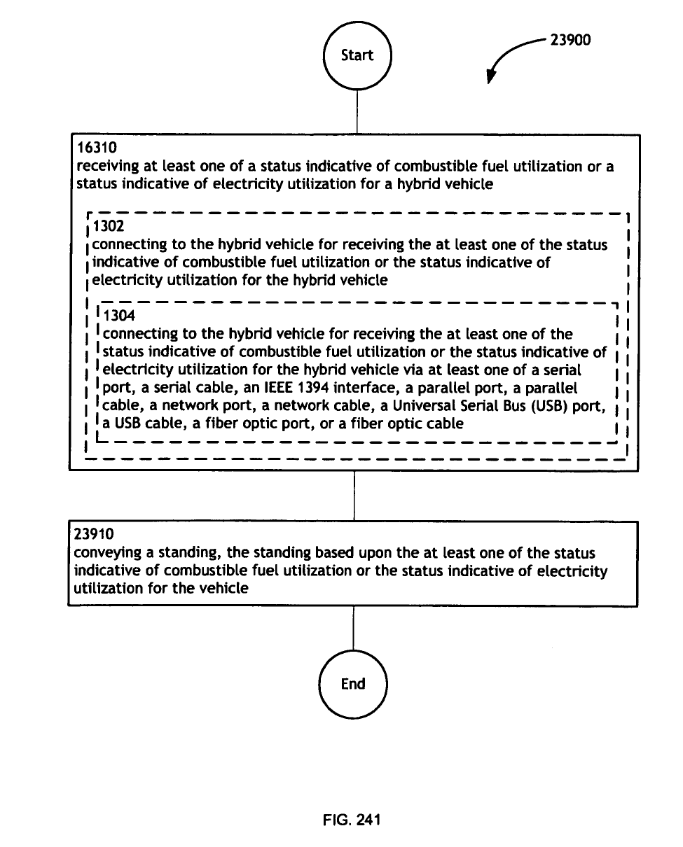

FIG. 241 illustrates alternative embodiments of the example operational flow 23900 of FIG. 239. FIG. 241 illustrates example embodiments where the operation 16310 may include at least one additional operation. Additional operations may include an operation 1302, and/or an operation 1304.

The operation 1302 illustrates connecting to the hybrid vehicle for receiving the at least one of the status indicative of combustible fuel utilization or the status indicative of electricity utilization for the hybrid vehicle. Further, the operation 1304 illustrates connecting to the hybrid vehicle for receiving the at least one of the status indicative of combustible fuel utilization or the status indicative of electricity utilization for the hybrid vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

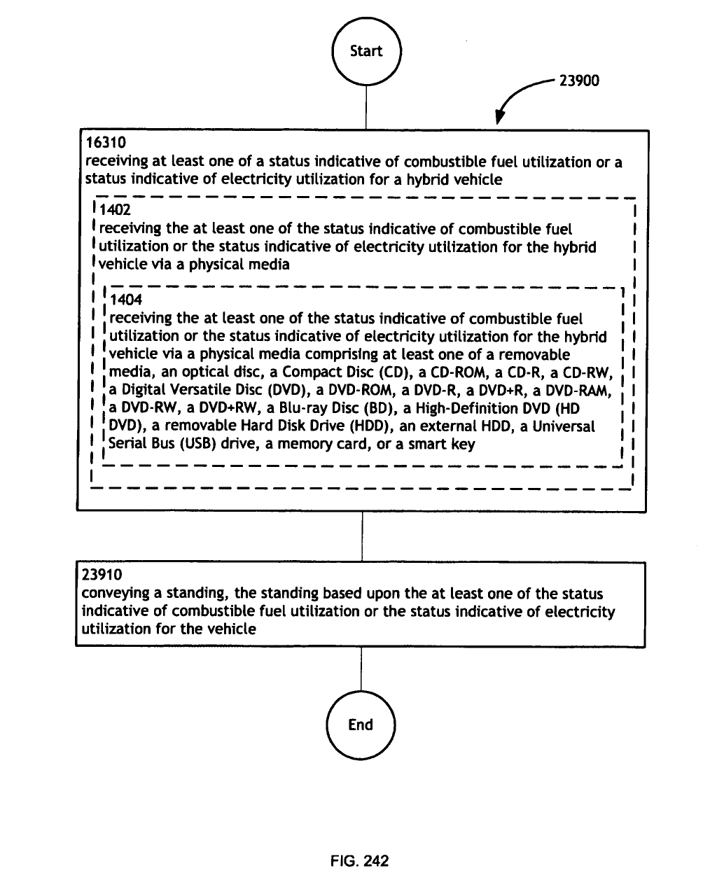

FIG. 242 illustrates alternative embodiments of the example operational flow 23900 of FIG. 239. FIG. 242 illustrates example embodiments where the operation 16310 may include at least one additional operation. Additional operations may include an operation 1402, and/or an operation 1404.

The operation 1402 illustrates receiving the at least one of the status indicative of combustible fuel utilization or the status indicative of electricity utilization for the hybrid vehicle via a physical media. Further, the operation 1404 illustrates receiving the at least one of the status indicative of combustible fuel utilization or the status indicative of electricity utilization for the hybrid vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

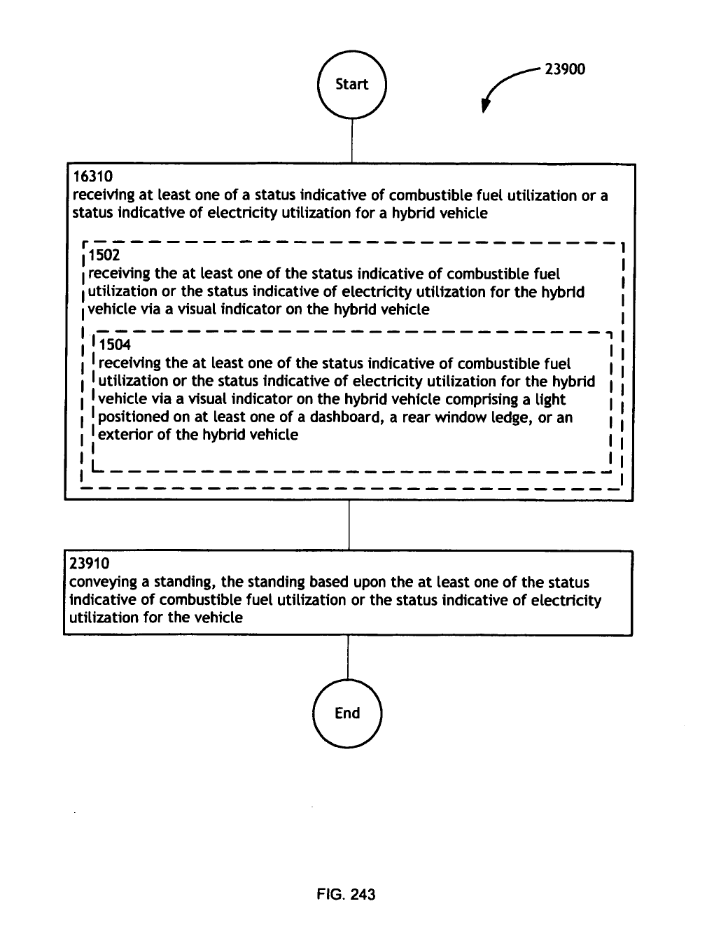

FIG. 243 illustrates alternative embodiments of the example operational flow 23900 of FIG. 239. FIG. 243 illustrates example embodiments where the operation 16310 may include at least one additional operation. Additional operations may include an operation 1502, and/or an operation 1504.

The operation 1502 illustrates receiving the at least one of the status indicative of combustible fuel utilization or the status indicative of electricity utilization for the hybrid vehicle via a visual indicator on the hybrid vehicle. Further, the operation 1504 illustrates receiving the at least one of the status indicative of combustible fuel utilization or the status indicative of electricity utilization for the hybrid vehicle via a visual indicator on the hybrid vehicle comprising a light positioned on at least one of a dashboard, a rear window ledge, or an exterior of the hybrid vehicle.

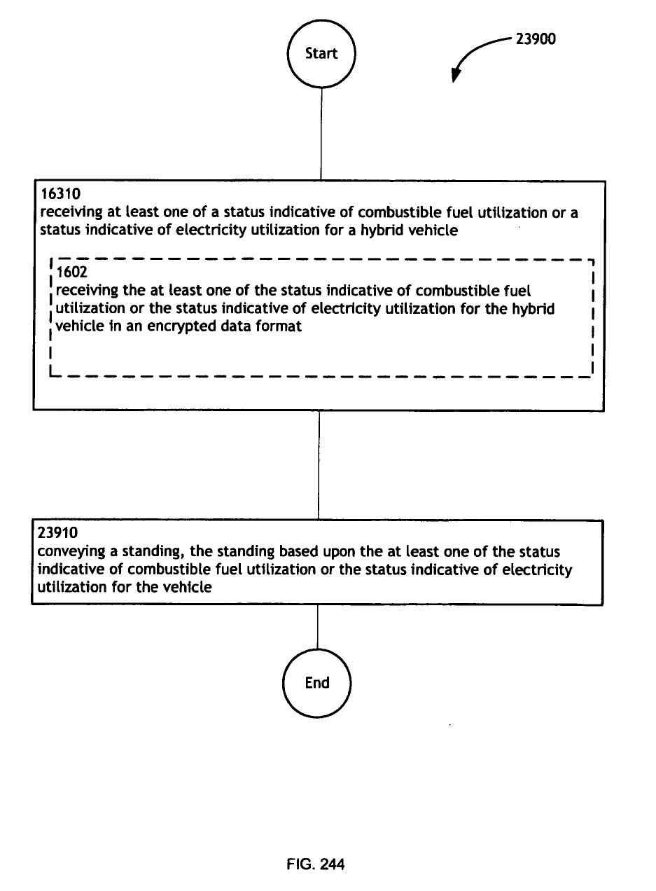

FIG. 244 illustrates alternative embodiments of the example operational flow 23900 of FIG. 239. FIG. 244 illustrates example embodiments where the operation 16310 may include at least one additional operation. Additional operations may include an operation 1602.

The operation 1602 illustrates receiving the at least one of the status indicative of combustible fuel utilization or the status indicative of electricity utilization for the hybrid vehicle in an encrypted data format.

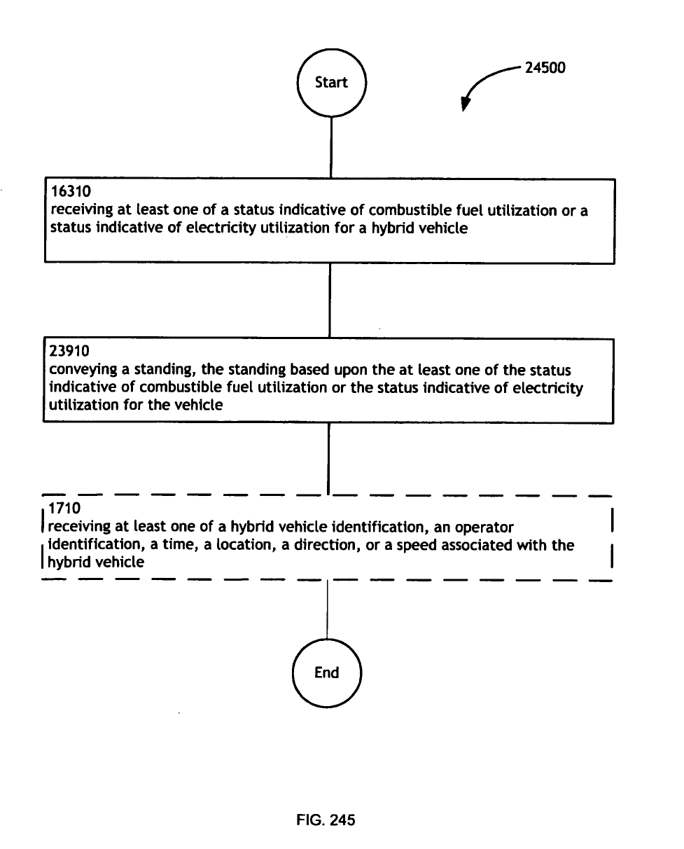

FIG. 245 illustrates an operational flow 24500 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and receiving at least one of a hybrid vehicle identification, an operator identification, a time, a location, a direction, or a speed associated with the hybrid vehicle. FIG. 245 illustrates an example embodiment where the example operational flow 23900 of FIG. 239 may include at least one additional operation. Additional operations may include an operation 1710.

After a start operation, an operation 16310, and an operation 23910, the operational flow 24500 moves to an operation 1710. Operation 1710 illustrates receiving at least one of a hybrid vehicle identification, an operator identification, a time, a location, a direction, or a speed associated with the hybrid vehicle.

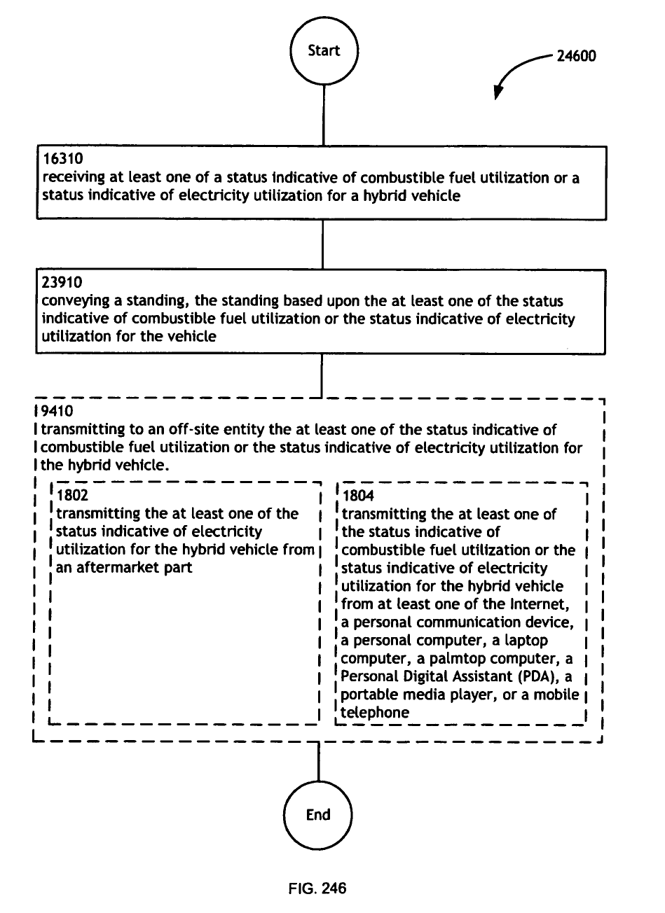

FIG. 246 illustrates an operational flow 24600 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and transmitting to an off-site entity the at least one of the status indicative of combustible fuel utilization or the status indicative of electricity utilization for the hybrid vehicle. FIG. 246 illustrates an example embodiment where the example operational flow 23900 of FIG. 239 may include at least one additional operation. Additional operations may include an operation 9410, an operation 1802, and/or an operation 1804.

After a start operation, an operation 16310, and an operation 23910, the operational flow 24600 moves to an operation 9410. Operation 9410 illustrates transmitting to an off-site entity the at least one of the status indicative of combustible fuel utilization or the status indicative of electricity utilization for the hybrid vehicle.

The operation 1802 illustrates transmitting the at least one of the status indicative of combustible fuel utilization or the status indicative of electricity utilization for the hybrid vehicle from an aftermarket part.

The operation 1804 illustrates transmitting the at least one of the status indicative of combustible fuel utilization or the status indicative of electricity utilization for the hybrid vehicle from at least one of the Internet, a personal communication device, a personal computer, a laptop computer, a palmtop computer, a Personal Digital Assistant (PDA), a portable media player, or a mobile telephone.

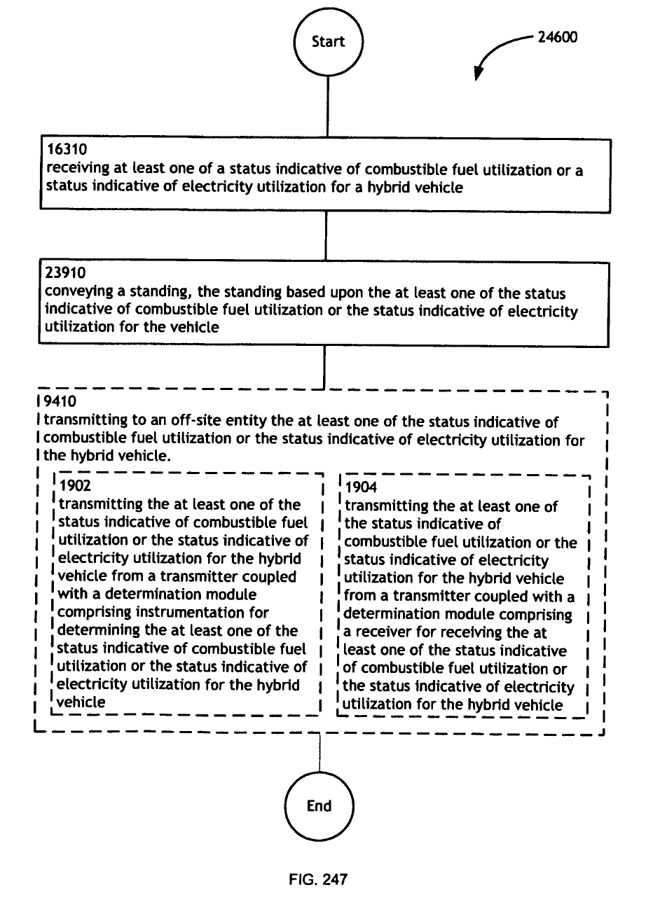

FIG. 247 illustrates alternative embodiments of the example operational flow 24600 of FIG. 246. FIG. 247 illustrates example embodiments where the operation 9410 may include at least one additional operation. Additional operations may include an operation 1902, and/or an operation 1904.

The operation 1902 illustrates transmitting the at least one of the status indicative of combustible fuel utilization or the status indicative of electricity utilization for the hybrid vehicle from a transmitter coupled with a determination module comprising instrumentation for determining the at least one of the status indicative of combustible fuel utilization or the status indicative of electricity utilization for the hybrid vehicle.

The operation 1904 illustrates transmitting the at least one of the status indicative of combustible fuel utilization or the status indicative of electricity utilization for the hybrid vehicle from a transmitter coupled with a determination module comprising a receiver for receiving the at least one of the status indicative of combustible fuel utilization or the status indicative of electricity utilization for the hybrid vehicle.

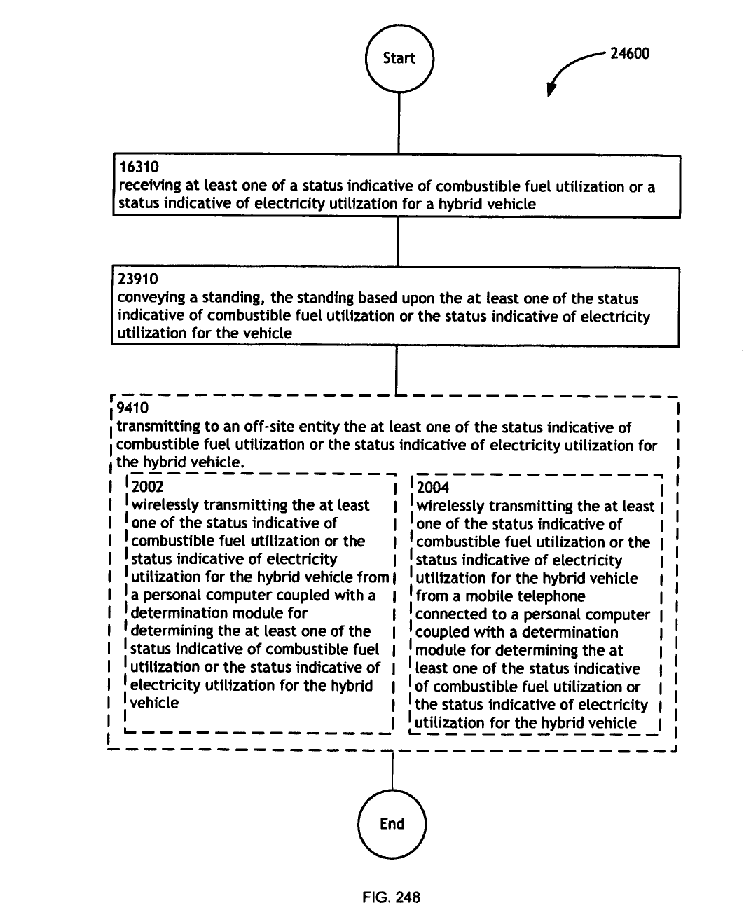

FIG. 248 illustrates alternative embodiments of the example operational flow 24600 of FIG. 246. FIG. 248 illustrates example embodiments where the operation 9410 may include at least one additional operation. Additional operations may include an operation 2002, and/or an operation 2004.

The operation 2002 illustrates wirelessly transmitting the at least one of the status indicative of combustible fuel utilization or the status indicative of electricity utilization for the hybrid vehicle from a personal computer coupled with a determination module for determining the at least one of the status indicative of combustible fuel utilization or the status indicative of electricity utilization for the hybrid vehicle.

The operation 2004 illustrates wirelessly transmitting the at least one of the status indicative of combustible fuel utilization or the status indicative of electricity utilization for the hybrid vehicle from a mobile telephone connected to a personal computer coupled with a determination module for determining the at least one of the status indicative of combustible fuel utilization or the status indicative of electricity utilization for the hybrid vehicle.

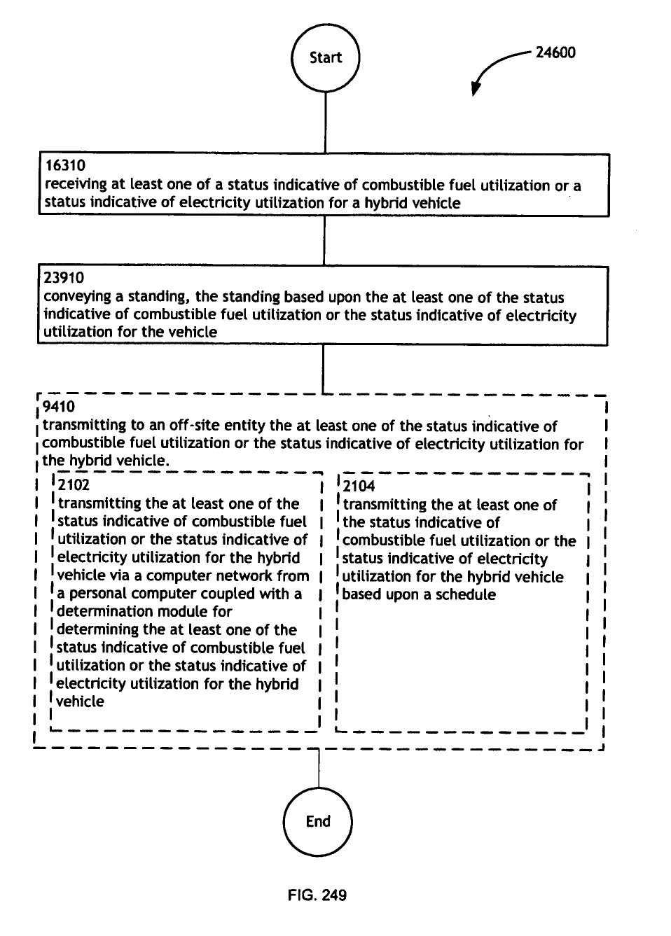

FIG. 249 illustrates alternative embodiments of the example operational flow 24600 of FIG. 246. FIG. 249 illustrates example embodiments where the operation 9410 may include at least one additional operation. Additional operations may include an operation 2102, and/or an operation 2104.

The operation 2102 illustrates transmitting the at least one of the status indicative of combustible fuel utilization or the status indicative of electricity utilization for the hybrid vehicle via a computer network from a personal computer coupled with a determination module for determining the at least one of the status indicative of combustible fuel utilization or the status indicative of electricity utilization for the hybrid vehicle.

The operation 2104 illustrates transmitting the at least one of the status indicative of combustible fuel utilization or the status indicative of electricity utilization for the hybrid vehicle based upon a schedule.

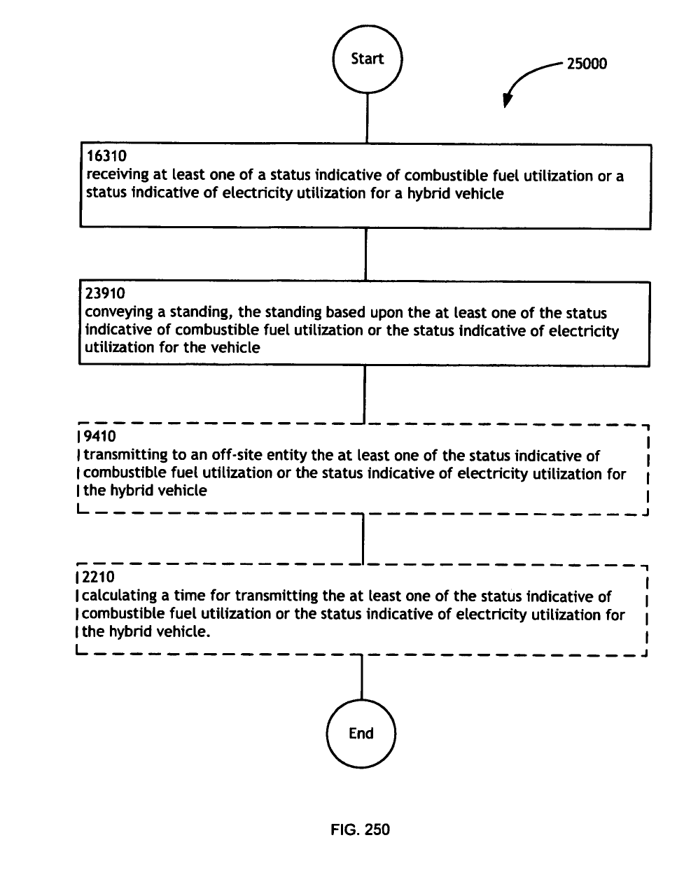

FIG. 250 illustrates an operational flow 25000 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, transmitting to an off-site entity the at least one of the status indicative of combustible fuel utilization or the status indicative of electricity utilization for the hybrid vehicle, and calculating a time for transmitting the status. FIG. 250 illustrates an example embodiment where the example operational flow 24600 of FIG. 246 may include at least one additional operation. Additional operations may include an operation 2210.

After a start operation, an operation 16310, an operation 23910, and an operation 9410, the operational flow 25000 moves to an operation 2210. Operation 2210 illustrates calculating a time for transmitting the at least one of the status indicative of combustible fuel utilization or the status indicative of electricity utilization for the hybrid vehicle.

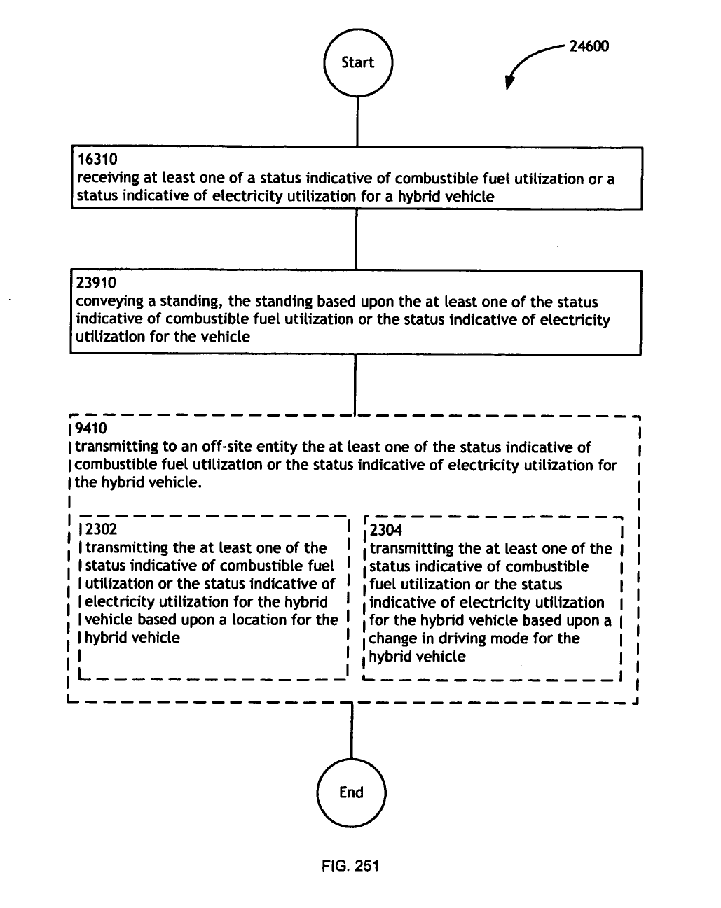

FIG. 251 illustrates alternative embodiments of the example operational flow 24600 of FIG. 246. FIG. 251 illustrates example embodiments where the operation 9410 may include at least one additional operation. Additional operations may include an operation 2302, and/or an operation 2304.

The operation 2302 illustrates transmitting the at least one of the status indicative of combustible fuel utilization or the status indicative of electricity utilization for the hybrid vehicle based upon a location for the hybrid vehicle.

The operation 2304 illustrates transmitting the at least one of the status indicative of combustible fuel utilization or the status indicative of electricity utilization for the hybrid vehicle based upon a change in driving mode for the hybrid vehicle.

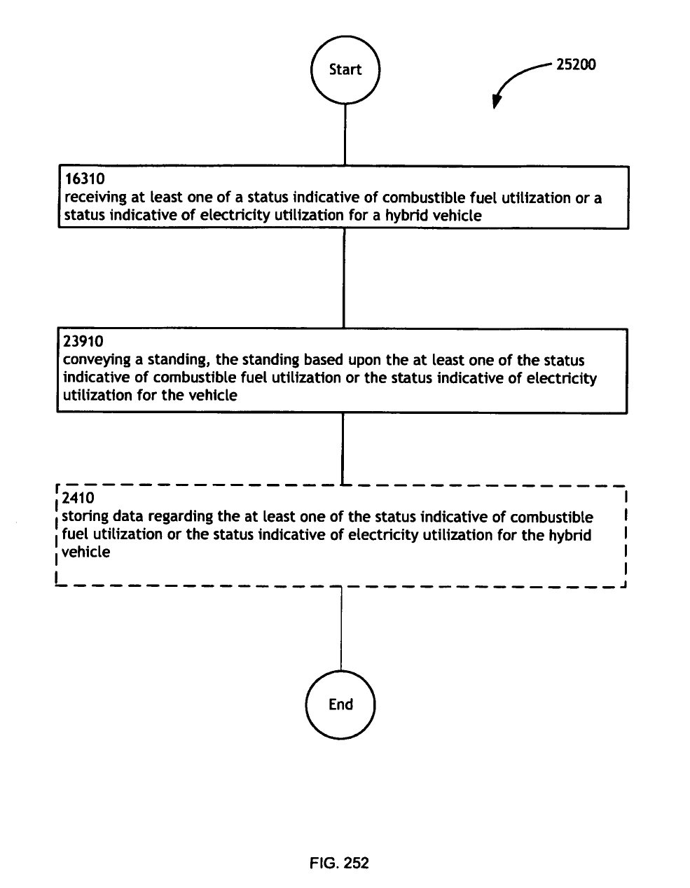

FIG. 252 illustrates an operational flow 25200 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and storing data regarding the status. FIG. 252 illustrates an example embodiment where the example operational flow 23900 of FIG. 239 may include at least one additional operation. Additional operations may include an operation 2410.

After a start operation, an operation 16310, and an operation 23910, the operational flow 25200 moves to an operation 2410. Operation 2410 illustrates storing data regarding the at least one of the status indicative of combustible fuel utilization or the status indicative of electricity utilization for the hybrid vehicle.

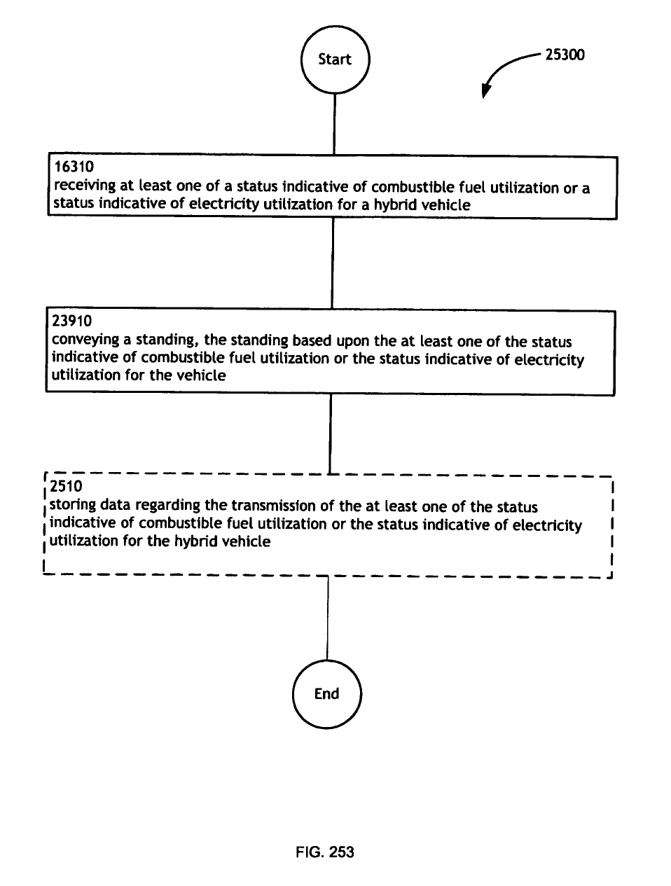

FIG. 253 illustrates an operational flow 25300 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and storing data regarding the transmission of the status. FIG. 253 illustrates an example embodiment where the example operational flow 23900 of FIG. 239 may include at least one additional operation. Additional operations may include an operation 2510.

After a start operation, an operation 16310, and an operation 23910, the operational flow 25300 moves to an operation 2510. Operation 2510 illustrates storing data regarding the transmission of the at least one of the status indicative of combustible fuel utilization or the status indicative of electricity utilization for the hybrid vehicle.

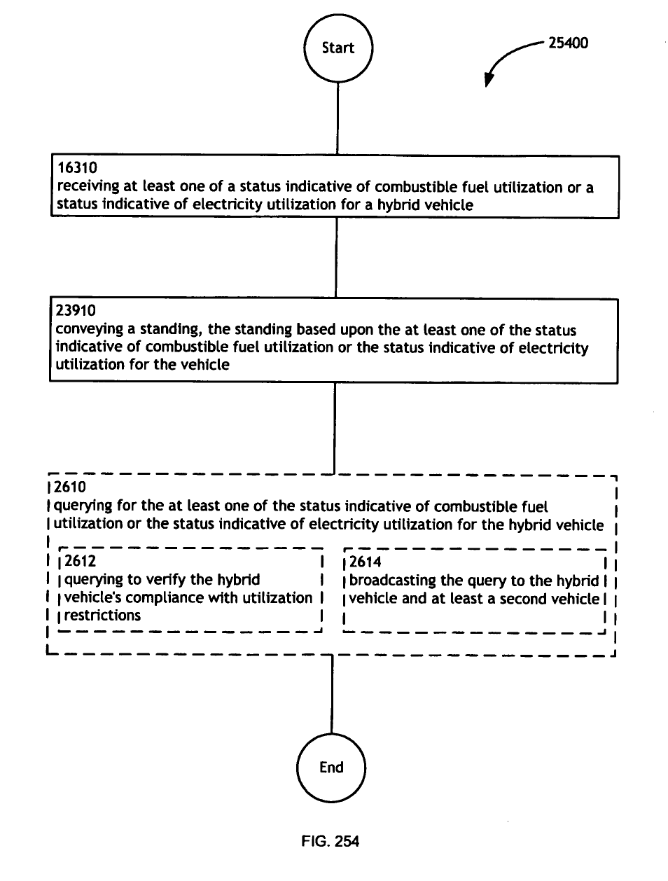

FIG. 254 illustrates an operational flow 25400 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and querying for the status. FIG. 254 illustrates an example embodiment where the example operational flow 23900 of FIG. 239 may include at least one additional operation. Additional operations may include an operation 2610, an operation 2612, and/or an operation 2614.

After a start operation, an operation 16310, and an operation 23910, the operational flow 25400 moves to an operation 2610. Operation 2610 illustrates querying for the at least one of the status indicative of combustible fuel utilization or the status indicative of electricity utilization for the hybrid vehicle.

The operation 2612 illustrates querying to verify the hybrid vehicle's compliance with utilization restrictions.

The operation 2614 illustrates broadcasting the query to the hybrid vehicle and at least a second vehicle.

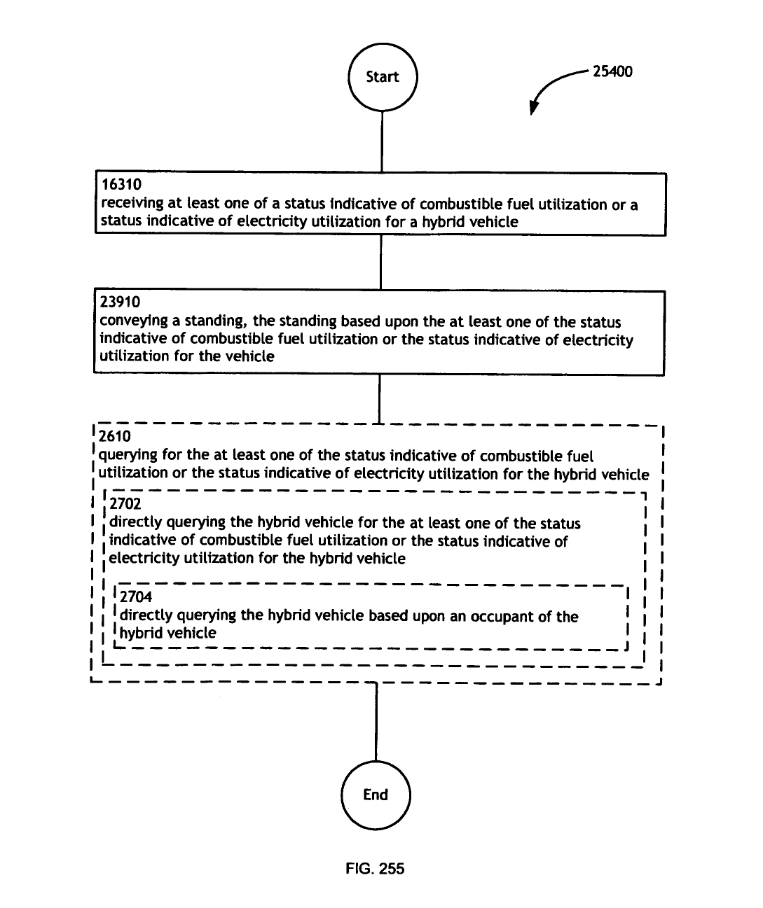

FIG. 255 illustrates alternative embodiments of the example operational flow 25400 of FIG. 254. FIG. 255 illustrates example embodiments where the operation 2610 may include at least one additional operation. Additional operations may include an operation 2702, and/or an operation 2704.

The operation 2702 illustrates directly querying the hybrid vehicle for the at least one of the status indicative of combustible fuel utilization or the status indicative of electricity utilization for the hybrid vehicle. Further, the operation 2704 illustrates directly querying the hybrid vehicle based upon an occupant of the hybrid vehicle.

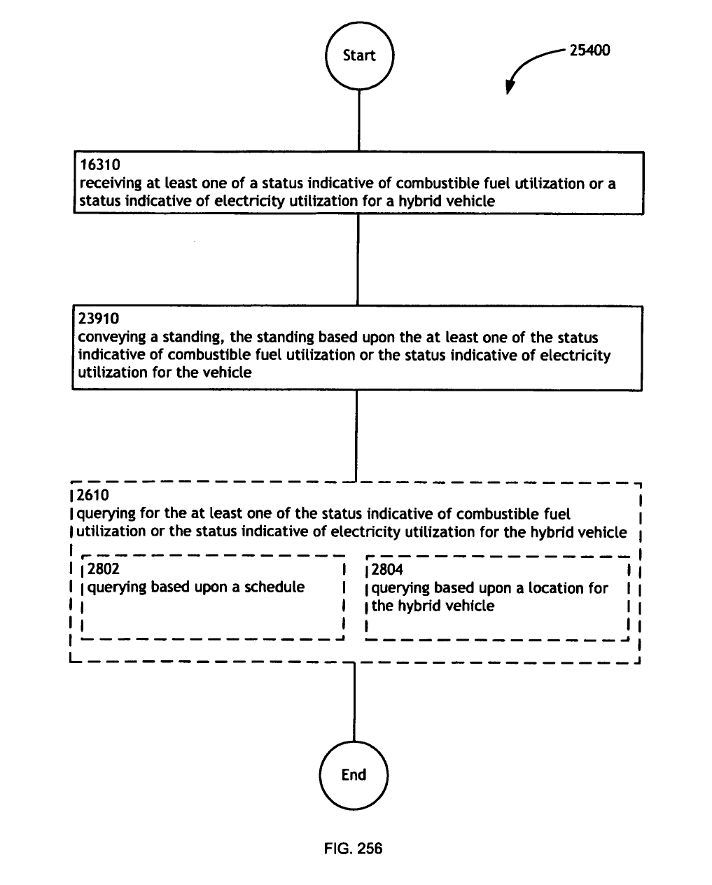

FIG. 256 illustrates alternative embodiments of the example operational flow 25400 of FIG. 254. FIG. 256 illustrates example embodiments where the operation 2610 may include at least one additional operation. Additional operations may include an operation 2802, and/or an operation 2804.

The operation 2802 illustrates querying based upon a schedule.

The operation 2804 illustrates querying based upon a location for the hybrid vehicle.

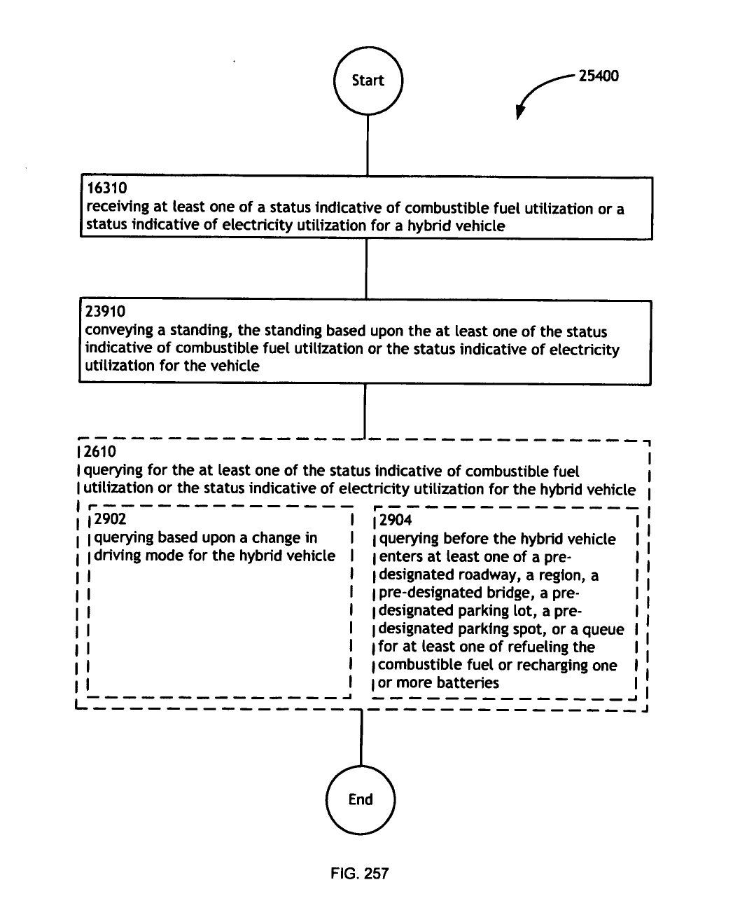

FIG. 257 illustrates alternative embodiments of the example operational flow 25400 of FIG. 254. FIG. 257 illustrates example embodiments where the operation 2610 may include at least one additional operation. Additional operations may include an operation 2902, and/or an operation 2904.

The operation 2902 illustrates querying based upon a change in driving mode for the hybrid vehicle.

The operation 2904 illustrates querying before the hybrid vehicle enters at least one of a pre-designated roadway, a region, a pre-designated bridge, a pre-designated parking lot, a pre-designated parking spot, or a queue for at least one of refueling the combustible fuel or recharging one or more batteries.

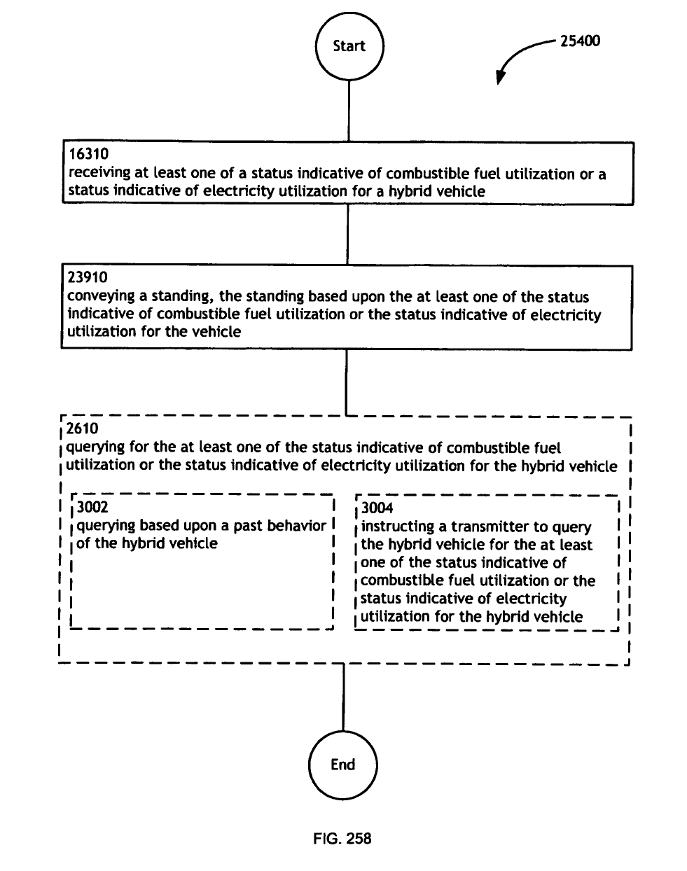

FIG. 258 illustrates alternative embodiments of the example operational flow 25400 of FIG. 254. FIG. 258 illustrates example embodiments where the operation 2610 may include at least one additional operation. Additional operations may include an operation 3002, and/or an operation 3004.

The operation 3002 illustrates querying based upon a past behavior of the hybrid vehicle.

The operation 3004 illustrates instructing a transmitter to query the hybrid vehicle for the at least one of the status indicative of combustible fuel utilization or the status indicative of electricity utilization for the hybrid vehicle.

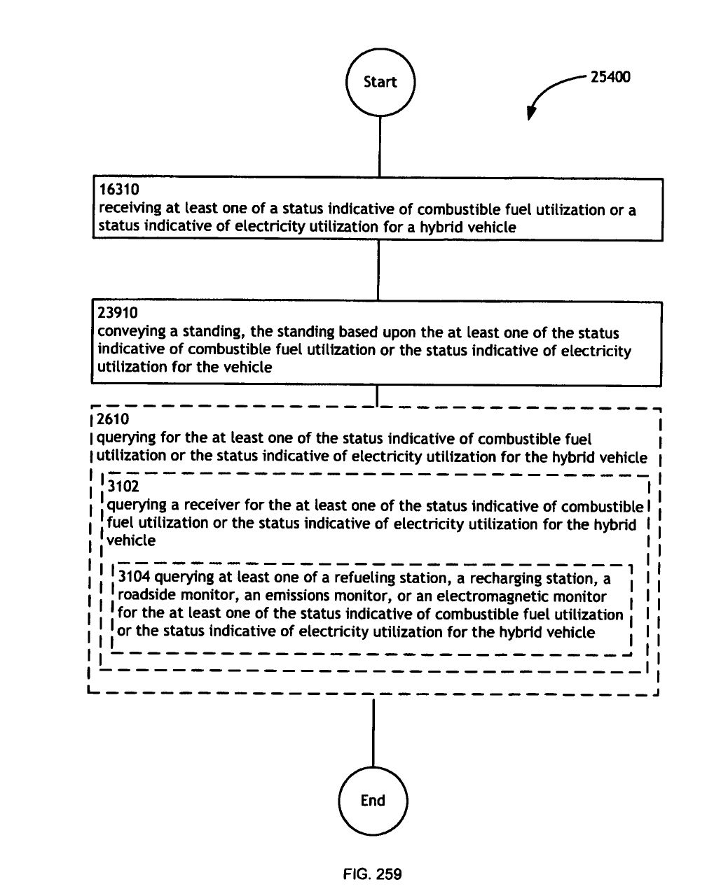

FIG. 259 illustrates alternative embodiments of the example operational flow 25400 of FIG. 254. FIG. 259 illustrates example embodiments where the operation 2610 may include at least one additional operation. Additional operations may include an operation 3102, and/or an operation 3104.

The operation 3102 illustrates querying a receiver for the at least one of the status indicative of combustible fuel utilization or the status indicative of electricity utilization for the hybrid vehicle. Further, the operation 3104 illustrates querying at least one of a refueling station, a recharging station, a roadside monitor, an emissions monitor, or an electromagnetic monitor for the at least one of the status indicative of combustible fuel utilization or the status indicative of electricity utilization for the hybrid vehicle.

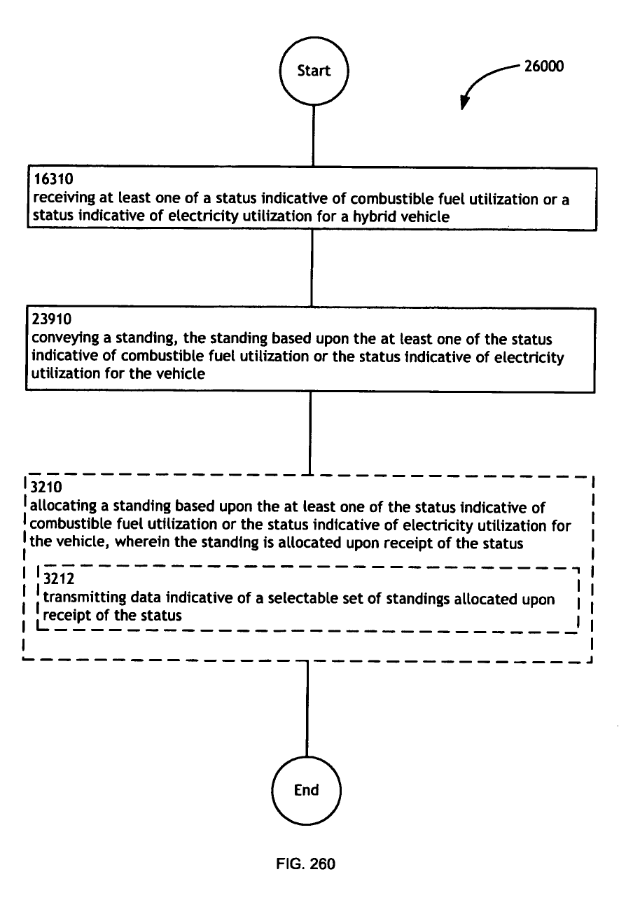

FIG. 260 illustrates an operational flow 26000 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, and allocating a standing based upon the at least one of the status indicative of combustible fuel utilization or the status indicative of electricity utilization for the vehicle. FIG. 260 illustrates an example embodiment where the example operational flow 23900 of FIG. 239 may include at least one additional operation. Additional operations may include an operation 3210, and/or an operation 3212.

After a start operation, an operation 16310, and an operation 23910, the operational flow 26000 moves to an operation 3210. Operation 3210 illustrates allocating a standing based upon the at least one of the status indicative of combustible fuel utilization or the status indicative of electricity utilization for the vehicle, wherein the standing is allocated upon receipt of the status.

The operation 3212 illustrates transmitting data indicative of a selectable set of standings allocated upon receipt of the status.

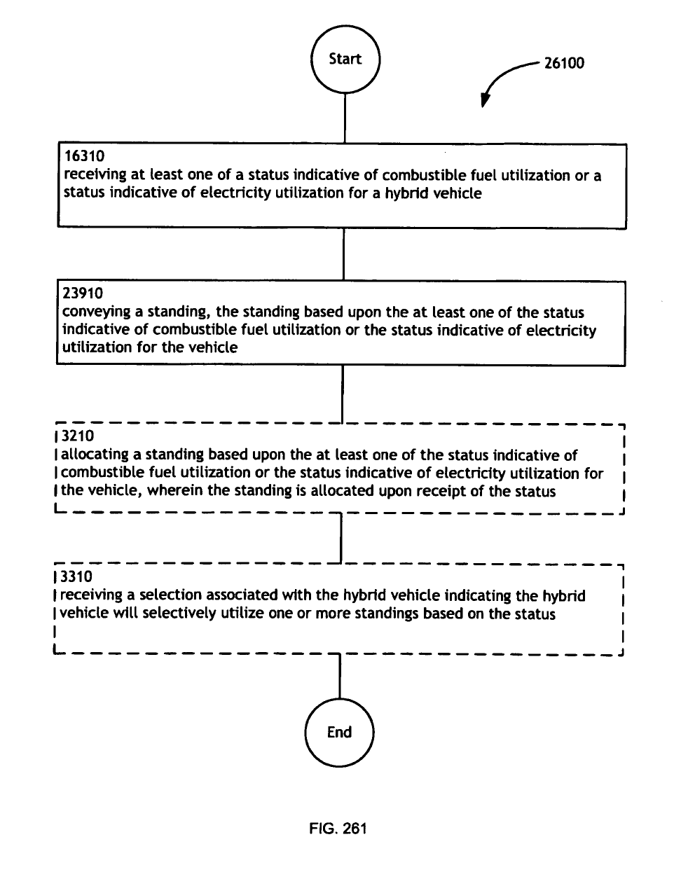

FIG. 261 illustrates an operational flow 26100 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and receiving a selection associated with the hybrid vehicle. FIG. 261 illustrates an example embodiment where the example operational flow 26000 of FIG. 260 may include at least one additional operation. Additional operations may include an operation 3310.

After a start operation, an operation 16310, an operation 23910, and an operation 3210, the operational flow 3300 moves to an operation 3310. Operation 3310 illustrates receiving a selection associated with the hybrid vehicle indicating the hybrid vehicle will selectively utilize one or more standings based on the status.

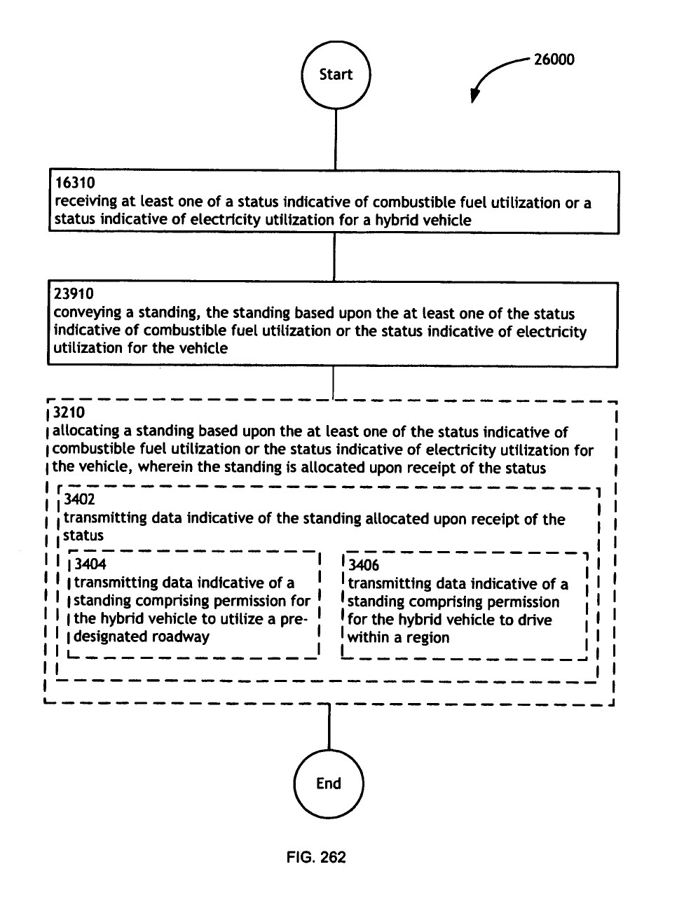

FIG. 262 illustrates alternative embodiments of the example operational flow 26000 of FIG. 260. FIG. 262 illustrates example embodiments where the operation 3210 may include at least one additional operation. Additional operations may include an operation 3402, an operation 3404, and/or an operation 3406.

The operation 3402 illustrates transmitting data indicative of the standing allocated upon receipt of the status. Further, the operation 3404 illustrates transmitting data indicative of a standing comprising permission for the hybrid vehicle to utilize a pre-designated roadway. Further, the operation 3406 illustrates transmitting data indicative of a standing comprising permission for the hybrid vehicle to drive within a region.

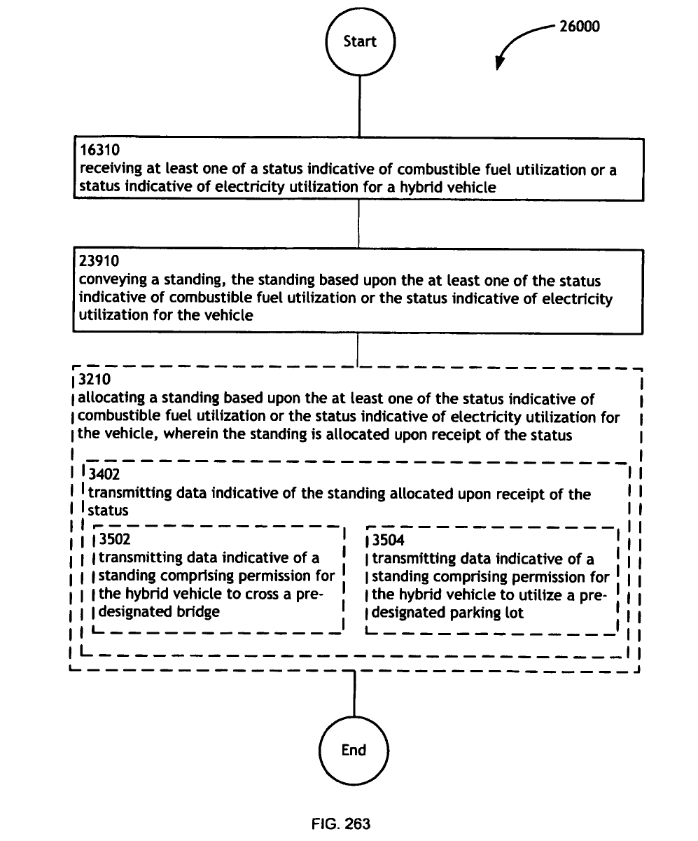

FIG. 263 illustrates alternative embodiments of the example operational flow 26000 of FIG. 260. FIG. 263 illustrates example embodiments where the operation 3210 may include at least one additional operation. Additional operations may include an operation 3502, and/or an operation 3504. Further, the operation 3502 illustrates transmitting data indicative of a standing comprising permission for the hybrid vehicle to cross a pre-designated bridge. Further, the operation 3504 illustrates transmitting data indicative of a standing comprising permission for the hybrid vehicle to utilize a pre-designated parking lot.

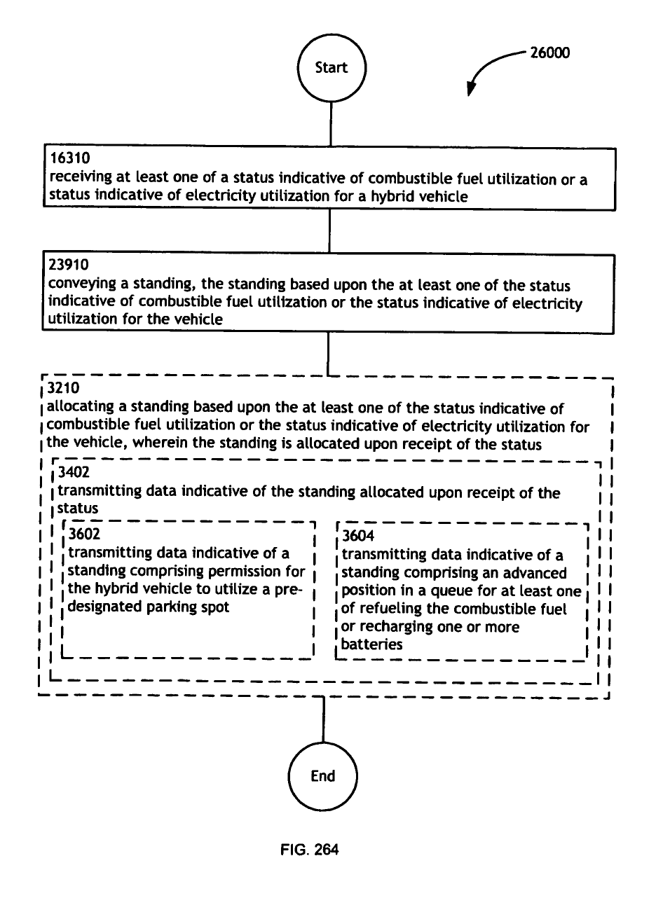

FIG. 264 illustrates alternative embodiments of the example operational flow 26000 of FIG. 260. FIG. 264 illustrates example embodiments where the operation 3210 may include at least one additional operation. Additional operations may include an operation 3602, and/or an operation 3604. Further, the operation 3602 illustrates transmitting data indicative of a standing comprising permission for the hybrid vehicle to utilize a pre-designated parking spot. Further, the operation 3604 illustrates transmitting data indicative of a standing comprising an advanced position in a queue for at least one of refueling the combustible fuel or recharging one or more batteries.

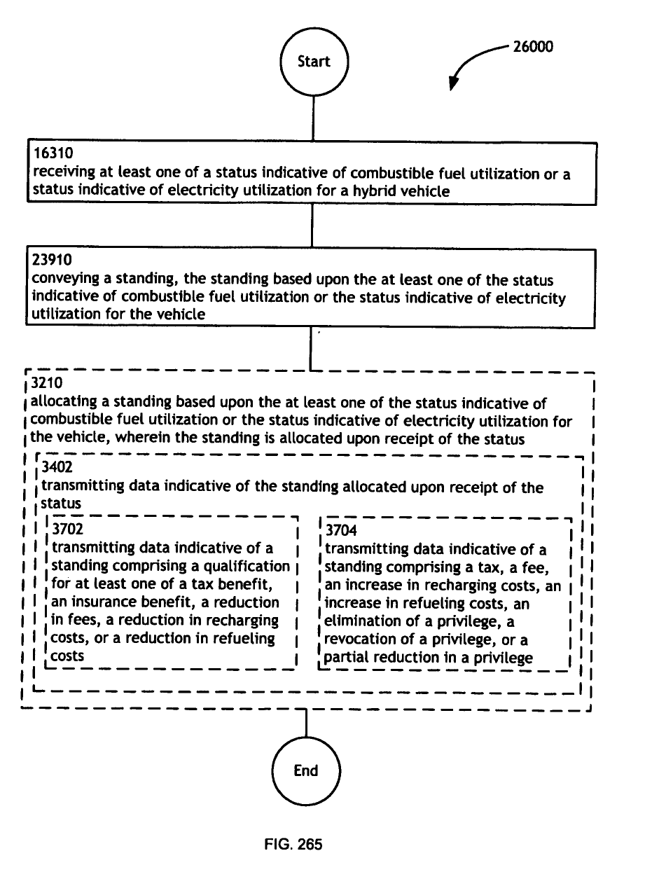

FIG. 265 illustrates alternative embodiments of the example operational flow 26000 of FIG. 260. FIG. 265 illustrates example embodiments where the operation 3210 may include at least one additional operation. Additional operations may include an operation 3702, and/or an operation 3704. Further, the operation 3702 illustrates transmitting data indicative of a standing comprising a qualification for at least one of a tax benefit, an insurance benefit, a reduction in fees, a reduction in recharging costs, or a reduction in refueling costs. Further, the operation 3704 illustrates transmitting data indicative of a standing comprising a tax, a fee, an increase in recharging costs, an increase in refueling costs, an elimination of a privilege, a revocation of a privilege, or a partial reduction in a privilege.

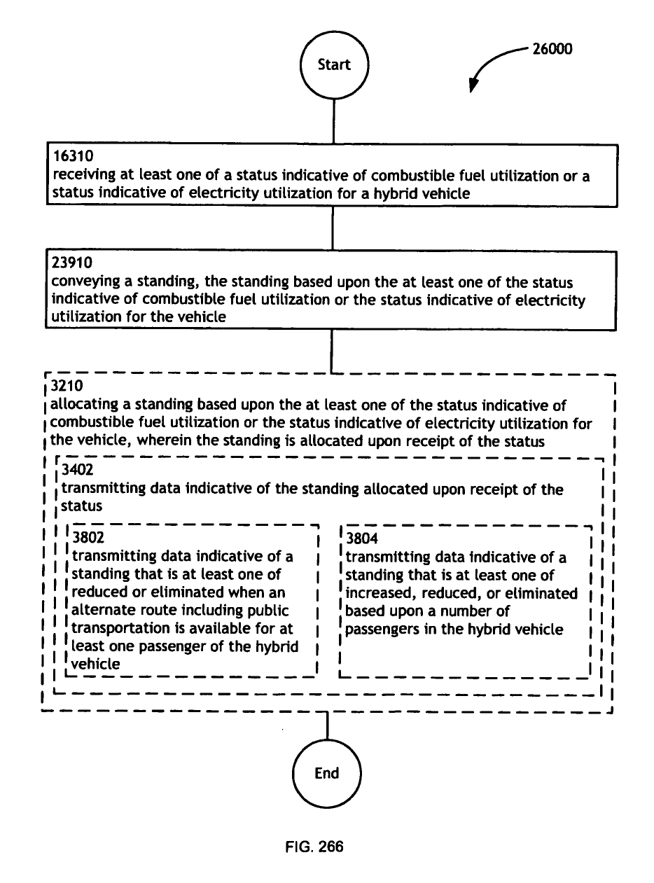

FIG. 266 illustrates alternative embodiments of the example operational flow 26000 of FIG. 260. FIG. 266 illustrates example embodiments where the operation 3210 may include at least one additional operation. Additional operations may include an operation 3802, and/or an operation 3804. Further, the operation 3802 illustrates transmitting data indicative of a standing that is at least one of reduced or eliminated when an alternate route including public transportation is available for at least one passenger of the hybrid vehicle. Further, the operation 3804 illustrates transmitting data indicative of a standing that is at least one of increased, reduced, or eliminated based upon a number of passengers in the hybrid vehicle.

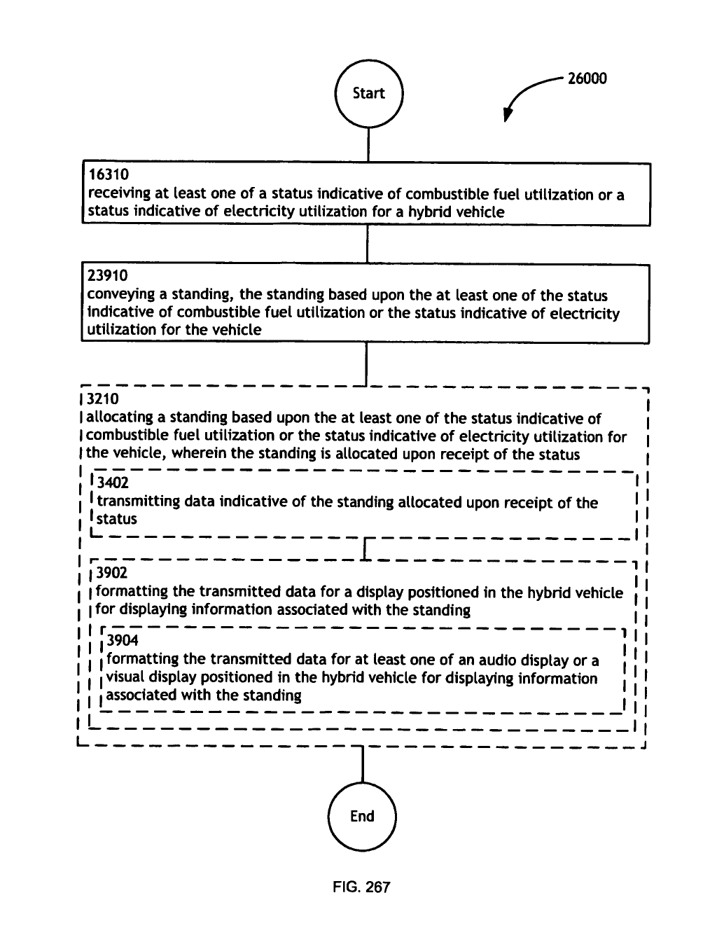

FIG. 267 illustrates alternative embodiments of the example operational flow 26000 of FIG. 260. FIG. 267 illustrates example embodiments where the operation 3210 may include at least one additional operation. Additional operations may include an operation 3902, and/or an operation 3904. Further, the operation 3902 illustrates formatting the transmitted data for a display positioned in the hybrid vehicle for displaying information associated with the standing. Further, the operation 3904 illustrates formatting the transmitted data for at least one of an audio display or a visual display positioned in the hybrid vehicle for displaying information associated with the standing.

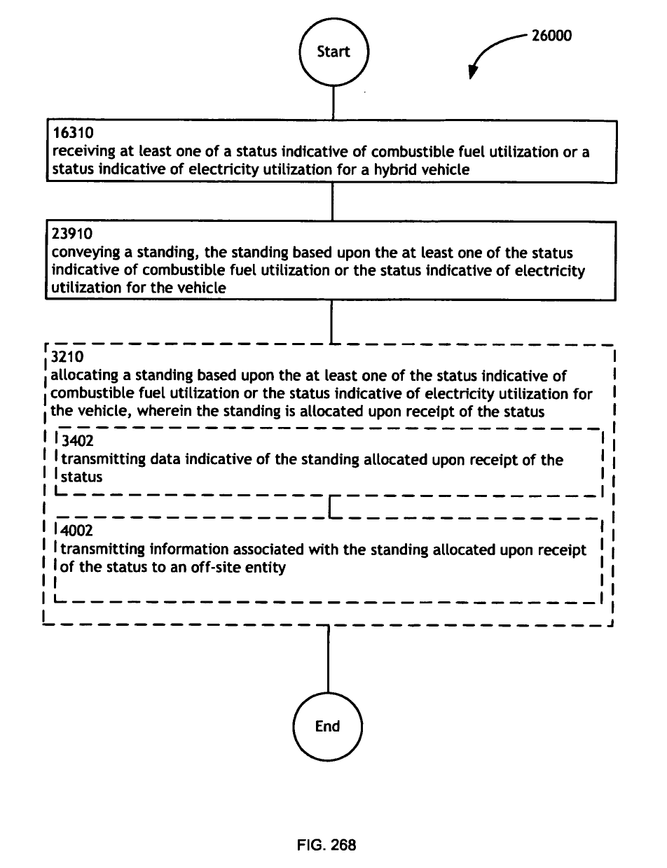

FIG. 268 illustrates alternative embodiments of the example operational flow 26000 of FIG. 260. FIG. 268 illustrates example embodiments where the operation 3210 may include at least one additional operation. Additional operations may include an operation 4002. Further, the operation 4002 illustrates transmitting information associated with the standing allocated upon receipt of the status to an off-site entity.

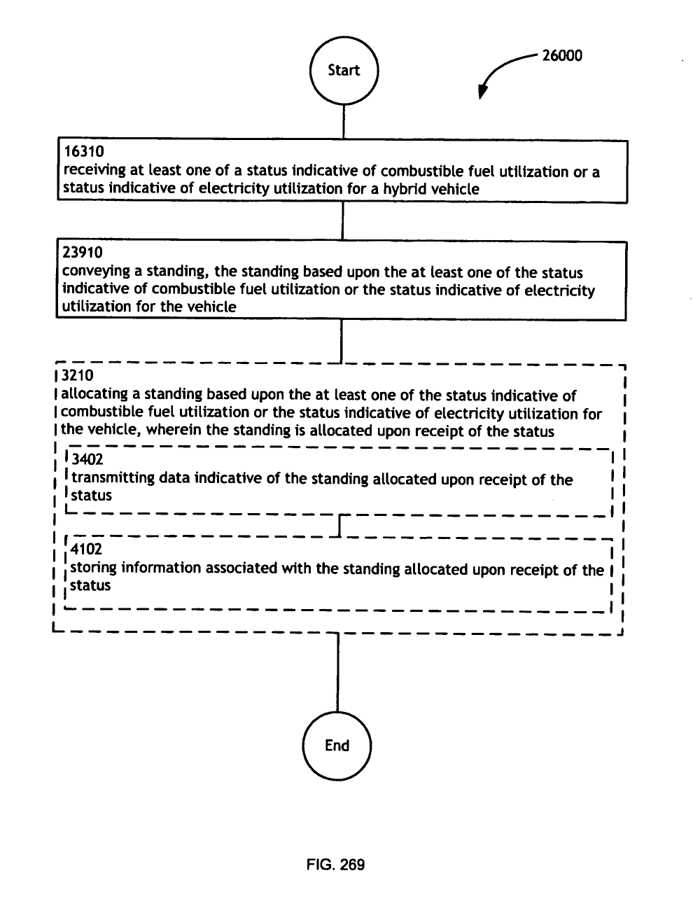

FIG. 269 illustrates alternative embodiments of the example operational flow 26000 of FIG. 260. FIG. 269 illustrates example embodiments where the operation 3210 may include at least one additional operation. Additional operations may include an operation 4102. Further, the operation 4102 illustrates storing information associated with the standing allocated upon receipt of the status.

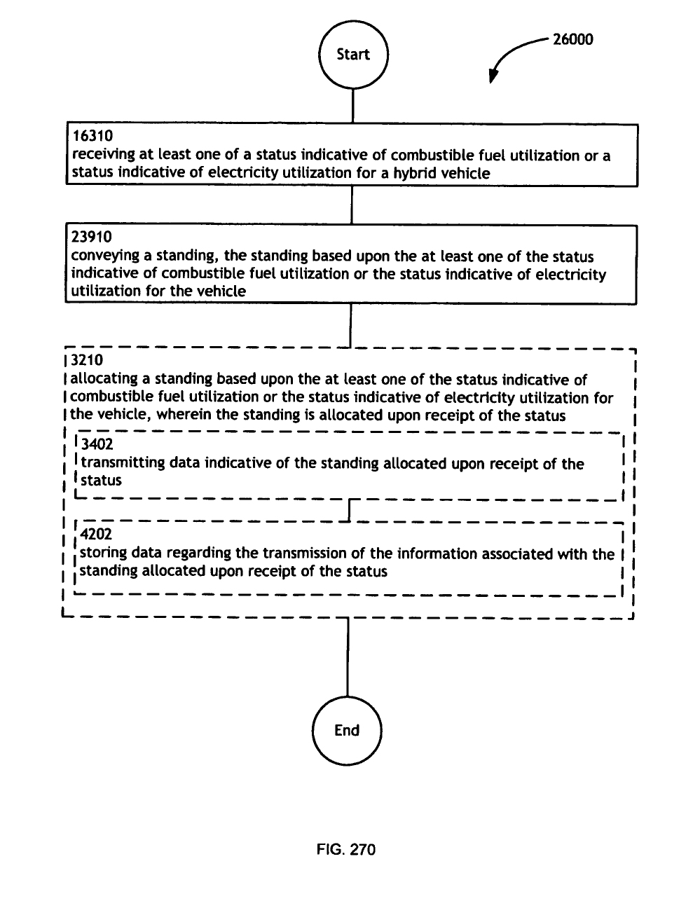

FIG. 270 illustrates alternative embodiments of the example operational flow 26000 of FIG. 260. FIG. 270 illustrates example embodiments where the operation 3210 may include at least one additional operation. Additional operations may include an operation 4202. Further, the operation 4202 illustrates storing data regarding the transmission of the information associated with the standing allocated upon receipt of the status.

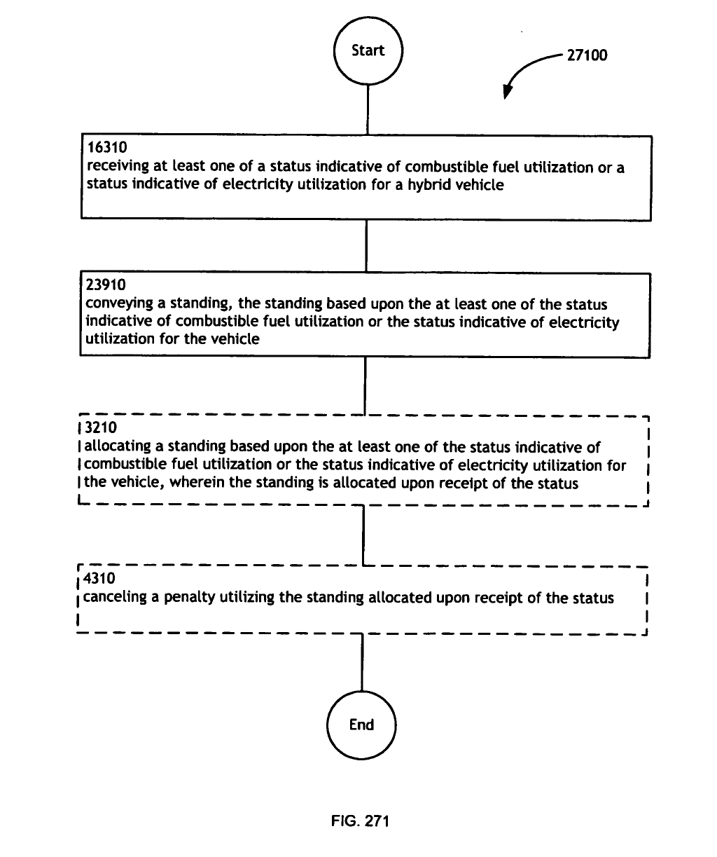

FIG. 271 illustrates an operational flow 27100 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and canceling a penalty utilizing the standing. FIG. 271 illustrates an example embodiment where the example operational flow 26000 of FIG. 260 may include at least one additional operation. Additional operations may include an operation 4310.

After a start operation, an operation 16310, an operation 23910, and an operation 3210, the operational flow 27100 moves to an operation 4310. Operation 4310 illustrates canceling a penalty utilizing the standing allocated upon receipt of the status.

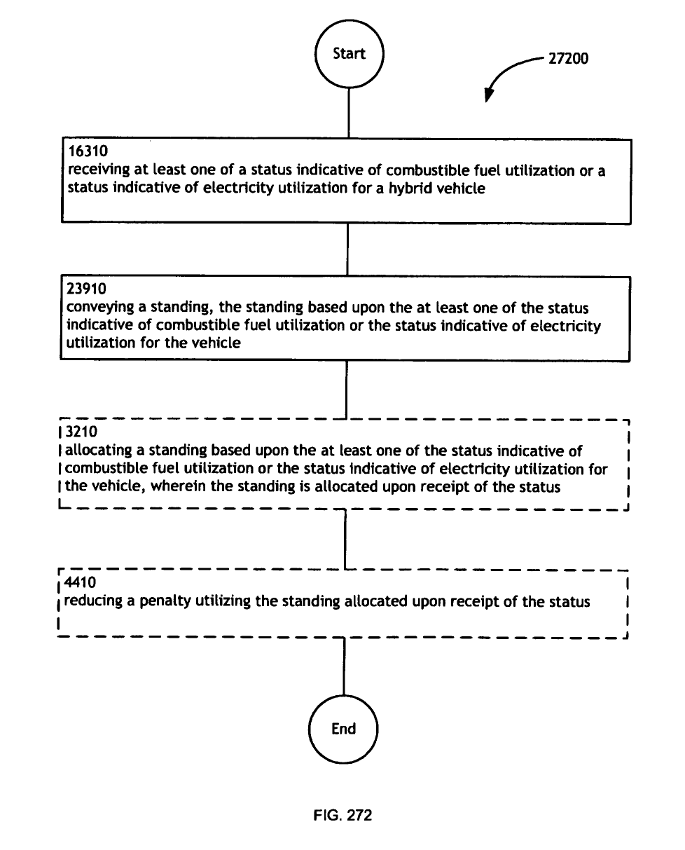

FIG. 272 illustrates an operational flow 27200 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and reducing a penalty utilizing the standing. FIG. 272 illustrates an example embodiment where the example operational flow 26000 of FIG. 260 may include at least one additional operation. Additional operations may include an operation 4410.

After a start operation, an operation 16310, an operation 23910, and an operation 3210, the operational flow 27200 moves to an operation 4410. Operation 4410 illustrates reducing a penalty utilizing the standing allocated upon receipt of the status.

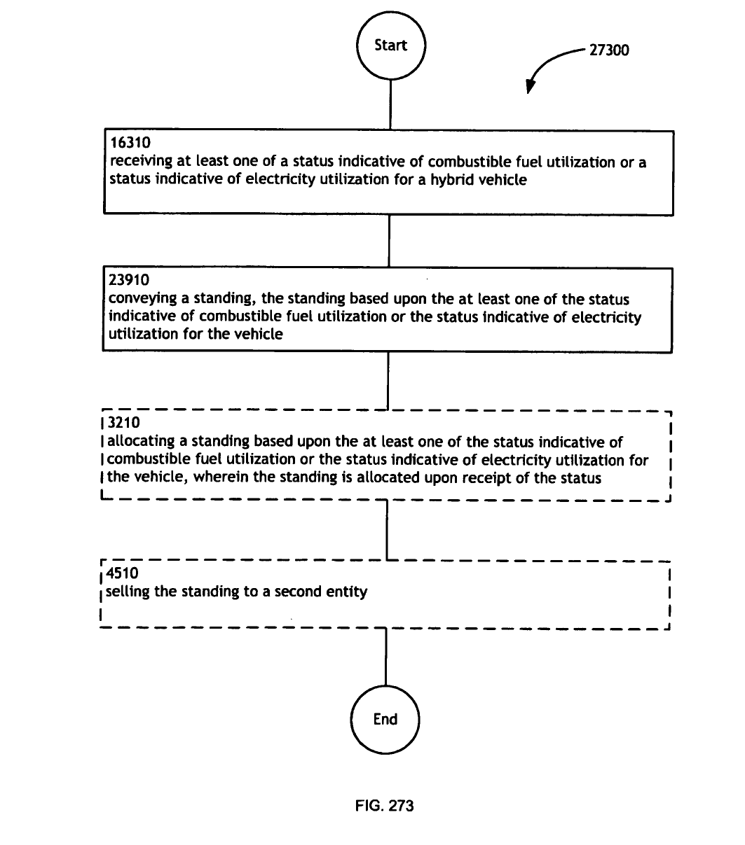

FIG. 273 illustrates an operational flow 27300 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and selling the standing to a second entity. FIG. 273 illustrates an example embodiment where the example operational flow 26000 of FIG. 260 may include at least one additional operation. Additional operations may include an operation 4510.

After a start operation, an operation 16310, an operation 23910, and an operation 3210, the operational flow 27300 moves to an operation 4510. Operation 4510 illustrates selling the standing to a second entity.

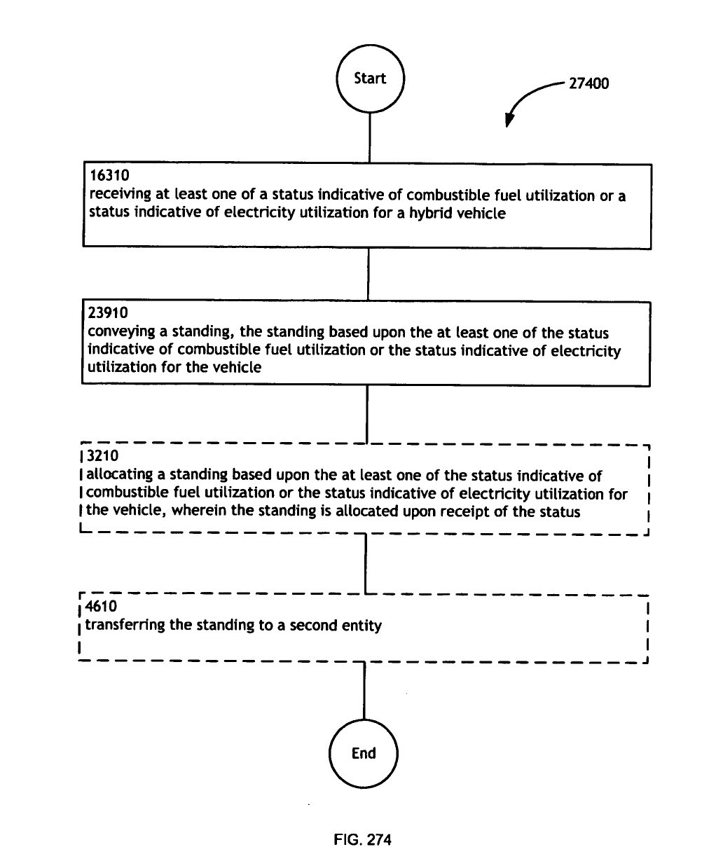

FIG. 274 illustrates an operational flow 27400 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and transferring the standing to a second entity. FIG. 274 illustrates an example embodiment where the example operational flow 26000 of FIG. 260 may include at least one additional operation. Additional operations may include an operation 4610.

After a start operation, an operation 16310, an operation 23910, and an operation 3210, the operational flow 27400 moves to an operation 4610. Operation 4610 illustrates transferring the standing to a second entity.

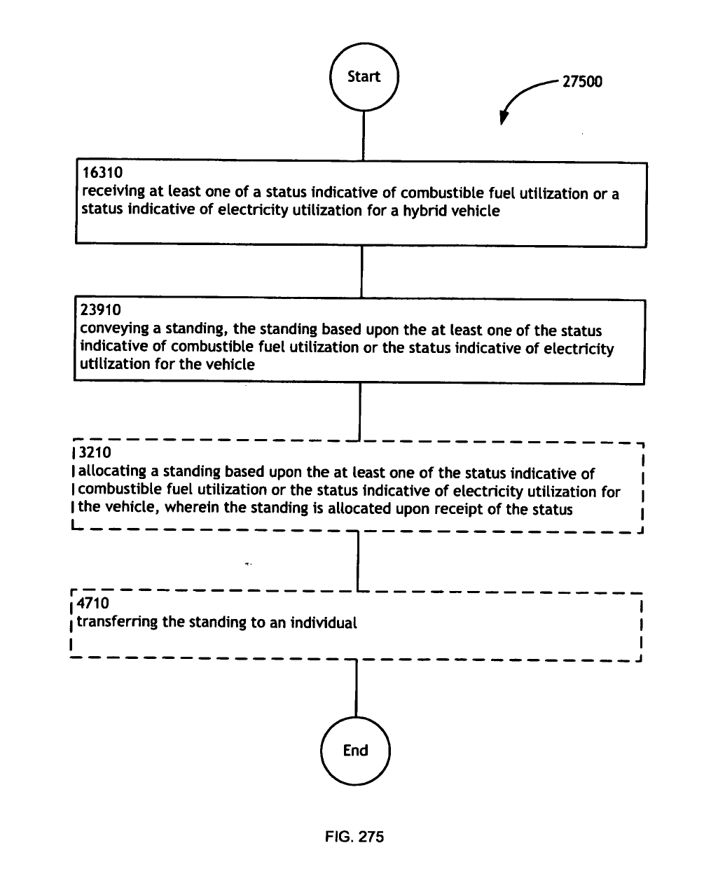

FIG. 275 illustrates an operational flow 27500 representing example operations related to receiving at least one of a status indicative of combustible fuel utilization or a status indicative of electricity utilization for a hybrid vehicle, conveying a standing, the standing based upon the at least one of the status indicative of combustible fuel utilization or the status indicative of electricity utilization for the vehicle, allocating a standing based upon the status for the vehicle, and transferring the standing to an individual. FIG. 275 illustrates an example embodiment where the example operational flow 26000 of FIG. 260 may include at least one additional operation. Additional operations may include an operation 4710.

After a start operation, an operation 16310, an operation 23910, and an operation 3210, the operational flow 27500 moves to an operation 4710. Operation 4710 illustrates transferring the standing to an individual.

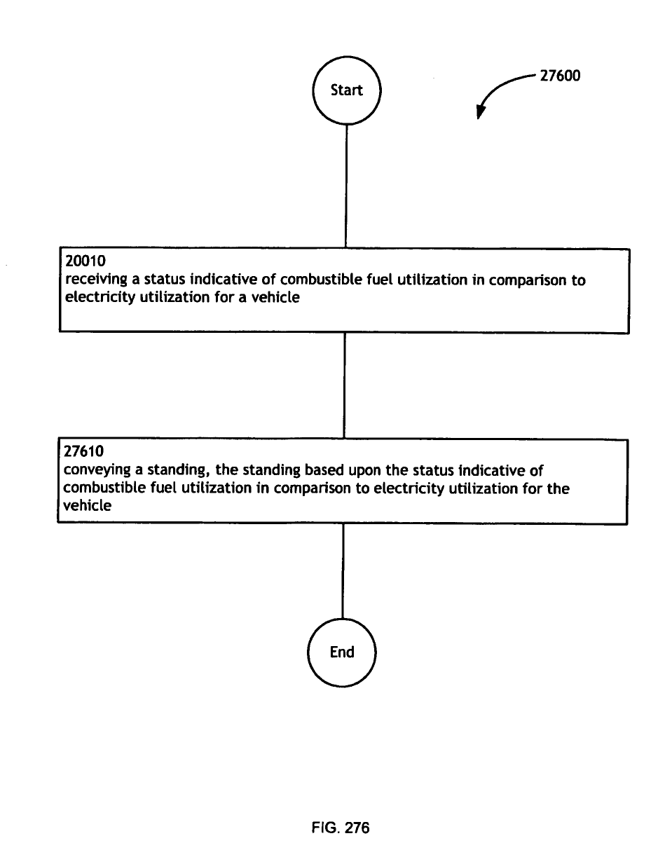

FIG. 276 illustrates an operational flow 27600 representing example operations related to receiving a status indicative of combustible fuel utilization in comparison to electricity utilization for a vehicle and conveying a standing, the standing based upon the status indicative of combustible fuel utilization in comparison to electricity utilization for the vehicle. In FIG. 276 and in following figures that include various examples of operational flows, discussion and explanation may be provided with respect to the above-described examples of FIGS. 1 through 10, and/or with respect to other examples and contexts. However, it should be understood that the operational flows may be executed in a number of other environments and contexts, and/or in modified versions of FIGS. 1 through 10. Also, although the various operational flows are presented in the sequence(s) illustrated, it should be understood that the various operations may be performed in other orders than those which are illustrated, or may be performed concurrently.

After a start operation, the operational flow 27600 moves to an operation 20010. Operation 20010 depicts receiving a status indicative of combustible fuel utilization in comparison to electricity utilization for a vehicle.

Then, operation 27610 depicts conveying a standing, the standing based upon the status indicative of combustible fuel utilization in comparison to electricity utilization for the vehicle. For example, as shown in FIGS. 1 through 10, the standing may be conveyed to another vehicle. Alternatively, the standing may be conveyed to an individual. For example, the driver may acquire the standing for transfer to another vehicle. Further, the standing may be conveyed to an authority, such as a local government, a state government, or a federal government. In an embodiment, the driver may receive some consideration for the standing (e.g., monetary consideration). In another embodiment, the driver may receive no consideration for the standing.

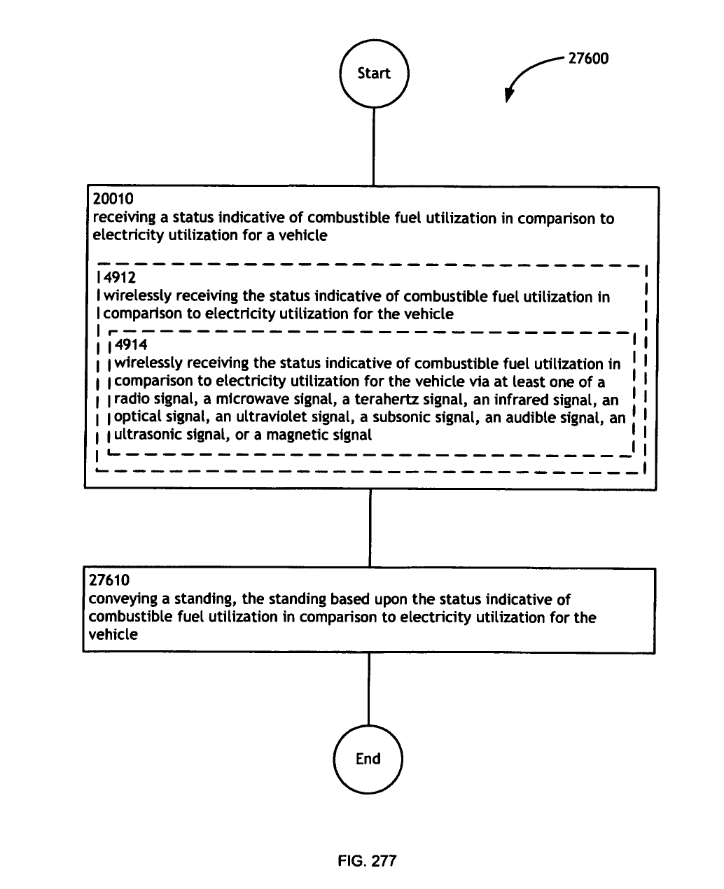

FIG. 277 illustrates alternative embodiments of the example operational flow 27600 of FIG. 276. FIG. 277 illustrates example embodiments where the operation 20010 may include at least one additional operation. Additional operations may include an operation 4912, and/or an operation 4914.

The operation 4912 illustrates wirelessly receiving the status indicative of combustible fuel utilization in comparison to electricity utilization for the vehicle. Further, the operation 4914 illustrates wirelessly receiving the status indicative of combustible fuel utilization in comparison to electricity utilization for the vehicle via at least one of a radio signal, a microwave signal, a terahertz signal, an infrared signal, an optical signal, an ultraviolet signal, a subsonic signal, an audible signal, an ultrasonic signal, or a magnetic signal.

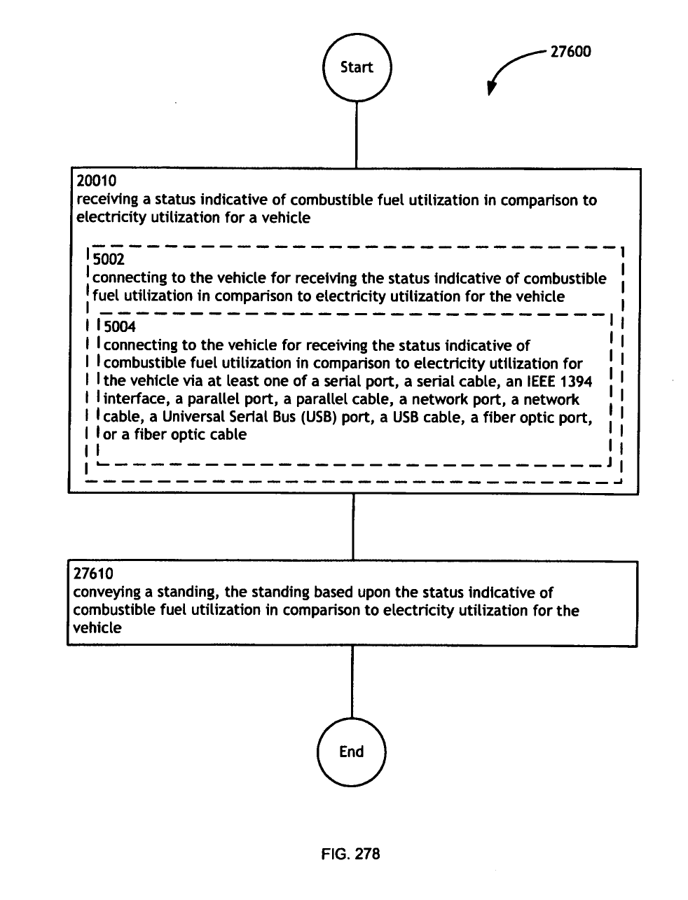

FIG. 278 illustrates alternative embodiments of the example operational flow 27600 of FIG. 276. FIG. 278 illustrates example embodiments where the operation 20010 may include at least one additional operation. Additional operations may include an operation 5002, and/or an operation 5004.

The operation 5002 illustrates connecting to the vehicle for receiving the status indicative of combustible fuel utilization in comparison to electricity utilization for the vehicle. Further, the operation 5004 illustrates connecting to the vehicle for receiving the status indicative of combustible fuel utilization in comparison to electricity utilization for the vehicle via at least one of a serial port, a serial cable, an IEEE 1394 interface, a parallel port, a parallel cable, a network port, a network cable, a Universal Serial Bus (USB) port, a USB cable, a fiber optic port, or a fiber optic cable.

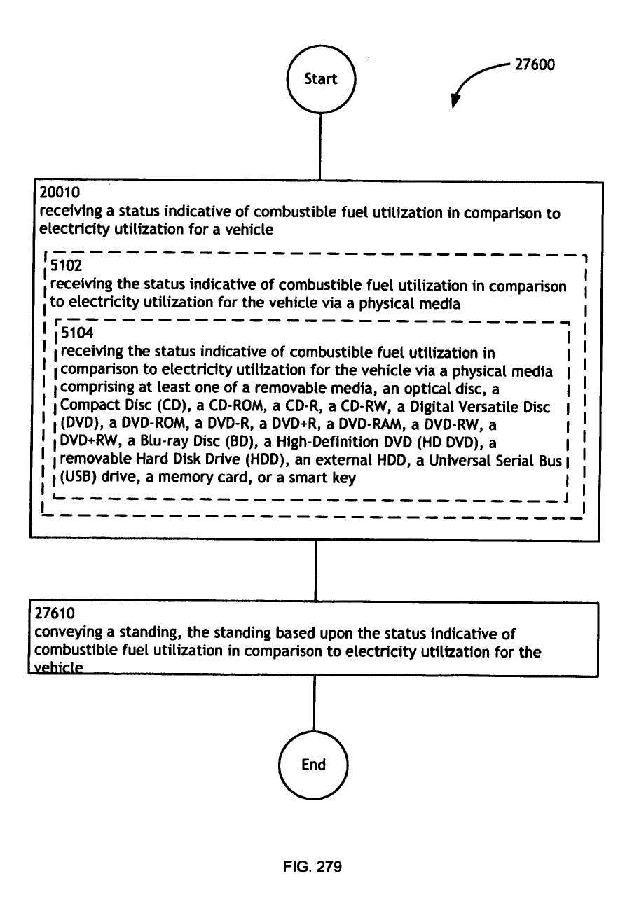

FIG. 279 illustrates alternative embodiments of the example operational flow 27600 of FIG. 276. FIG. 279 illustrates example embodiments where the operation 20010 may include at least one additional operation. Additional operations may include an operation 5102, and/or an operation 5104.

The operation 5102 illustrates receiving the status indicative of combustible fuel utilization in comparison to electricity utilization for the vehicle via a physical media. Further, the operation 5104 illustrates receiving the status indicative of combustible fuel utilization in comparison to electricity utilization for the vehicle via a physical media comprising at least one of a removable media, an optical disc, a Compact Disc (CD), a CD-ROM, a CD-R, a CD-RW, a Digital Versatile Disc (DVD), a DVD-ROM, a DVD-R, a DVD+R, a DVD-RAM, a DVD-RW, a DVD+RW, a Blu-ray Disc (BD), a High-Definition DVD (HD DVD), a removable Hard Disk Drive (HDD), an external HDD, a Universal Serial Bus (USB) drive, a memory card, or a smart key.

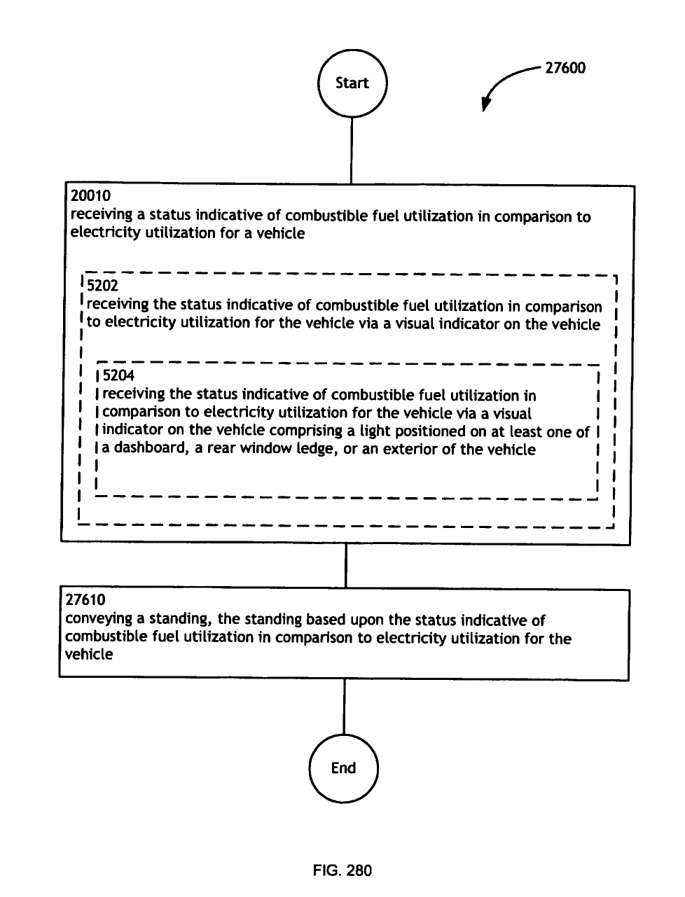

FIG. 280 illustrates alternative embodiments of the example operational flow 27600 of FIG. 276. FIG. 280 illustrates example embodiments where the operation 20010 may include at least one additional operation. Additional operations may include an operation 5202, and/or an operation 5204.

The operation 5202 illustrates receiving the status indicative of combustible fuel utilization in comparison to electricity utilization for the vehicle via a visual indicator on the vehicle. Further, the operation 5204 illustrates receiving the status indicative of combustible fuel utilization in comparison to electricity utilization for the vehicle via a visual indicator on the vehicle comprising a light positioned on at least one of a dashboard, a rear window ledge, or an exterior of the vehicle.

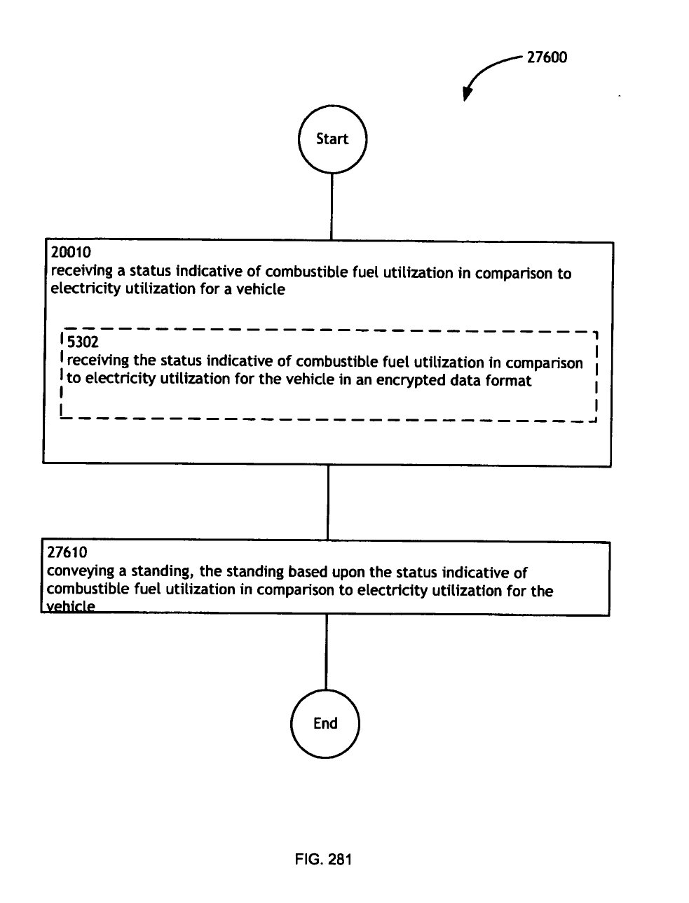

FIG. 281 illustrates alternative embodiments of the example operational flow 27600 of FIG. 276. FIG. 281 illustrates example embodiments where the operation 20010 may include at least one additional operation. Additional operations may include an operation 5302.

The operation 5302 illustrates receiving the status indicative of combustible fuel utilization in comparison to electricity utilization for the vehicle in an encrypted data format.

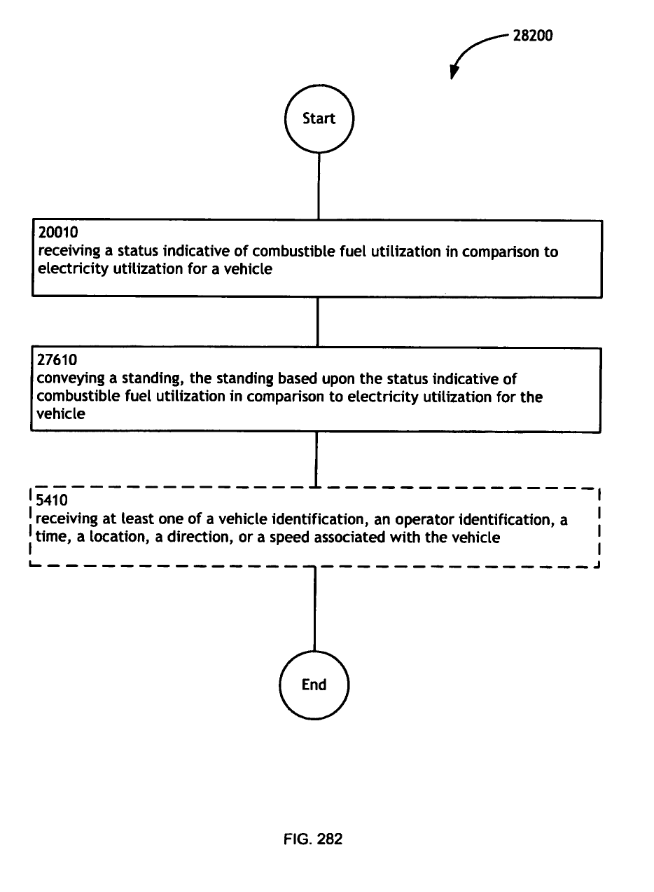

FIG. 282 illustrates an operational flow 28200 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and receiving at least one of a vehicle identification, an operator identification, a time, a location, a direction, or a speed associated with the vehicle. FIG. 282 illustrates an example embodiment where the example operational flow 27600 of FIG. 276 may include at least one additional operation. Additional operations may include an operation 5410.

After a start operation, an operation 20010, and an operation 27610, the operational flow 28200 moves to an operation 5410. Operation 5410 illustrates receiving at least one of a vehicle identification, an operator identification, a time, a location, a direction, or a speed associated with the vehicle.

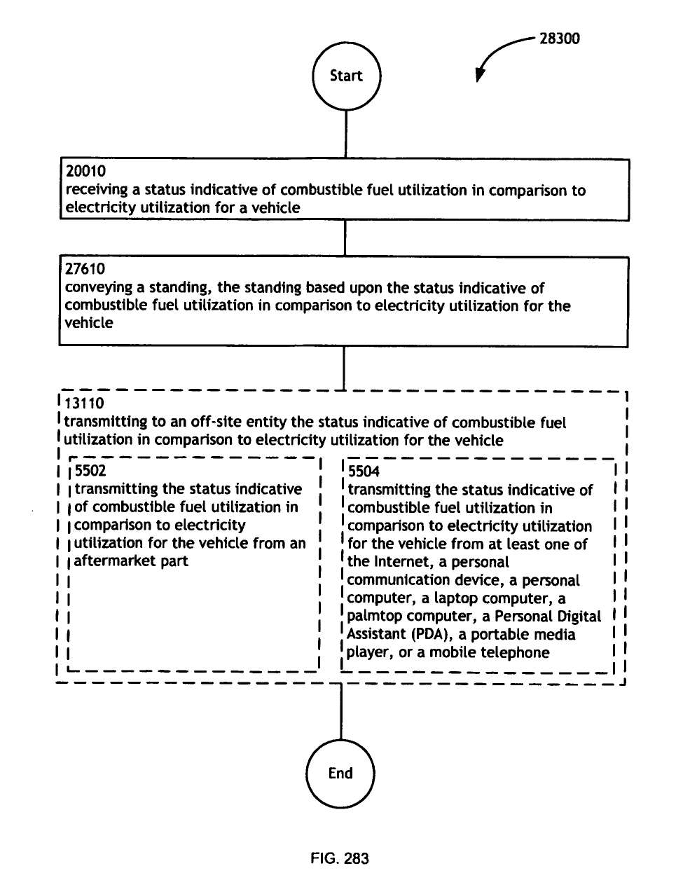

FIG. 283 illustrates an operational flow 28300 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and transmitting to an off-site entity the status indicative of combustible fuel utilization in comparison to electricity utilization for the vehicle. FIG. 283 illustrates an example embodiment where the example operational flow 27600 of FIG. 276 may include at least one additional operation. Additional operations may include an operation 13110, an operation 5502, and/or an operation 5504.

After a start operation, an operation 20010, and an operation 27610, the operational flow 28300 moves to an operation 13110. Operation 13110 illustrates transmitting to an off-site entity the status indicative of combustible fuel utilization in comparison to electricity utilization for the vehicle.

The operation 5502 illustrates transmitting the status indicative of combustible fuel utilization in comparison to electricity utilization for the vehicle from an aftermarket part.

The operation 5504 illustrates transmitting the status indicative of combustible fuel utilization in comparison to electricity utilization for the vehicle from at least one of the Internet, a personal communication device, a personal computer, a laptop computer, a palmtop computer, a Personal Digital Assistant (PDA), a portable media player, or a mobile telephone.

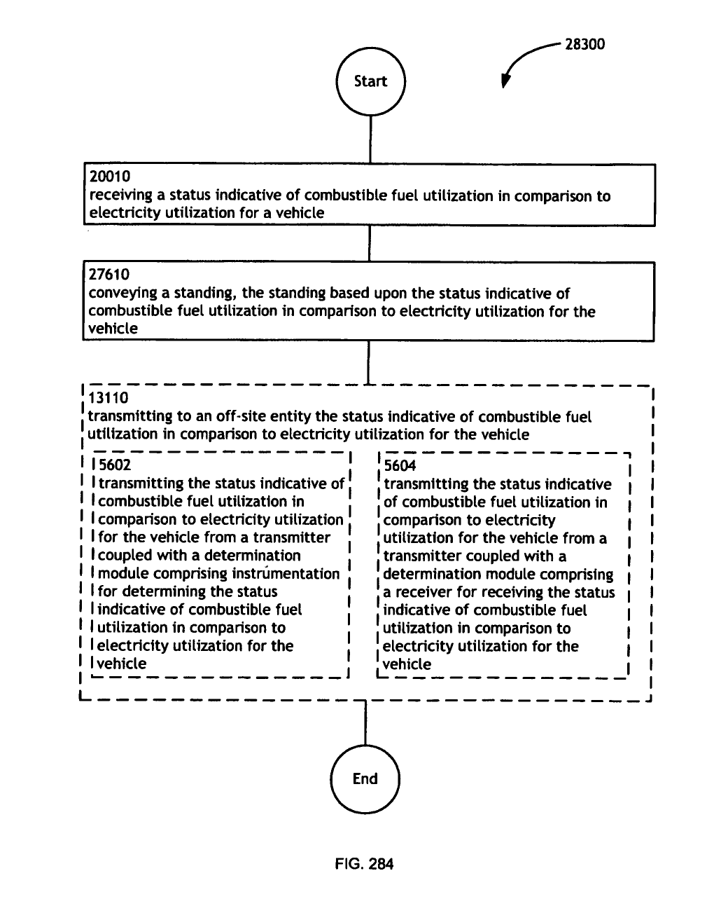

FIG. 284 illustrates alternative embodiments of the example operational flow 28300 of FIG. 283. FIG. 284 illustrates example embodiments where the operation 13110 may include at least one additional operation. Additional operations may include an operation 5602, and/or an operation 5604.

The operation 5602 illustrates transmitting the status indicative of combustible fuel utilization in comparison to electricity utilization for the vehicle from a transmitter coupled with a determination module comprising instrumentation for determining the status indicative of combustible fuel utilization in comparison to electricity utilization for the vehicle.

The operation 5604 illustrates transmitting the status indicative of combustible fuel utilization in comparison to electricity utilization for the vehicle from a transmitter coupled with a determination module comprising a receiver for receiving the status indicative of combustible fuel utilization in comparison to electricity utilization for the vehicle.

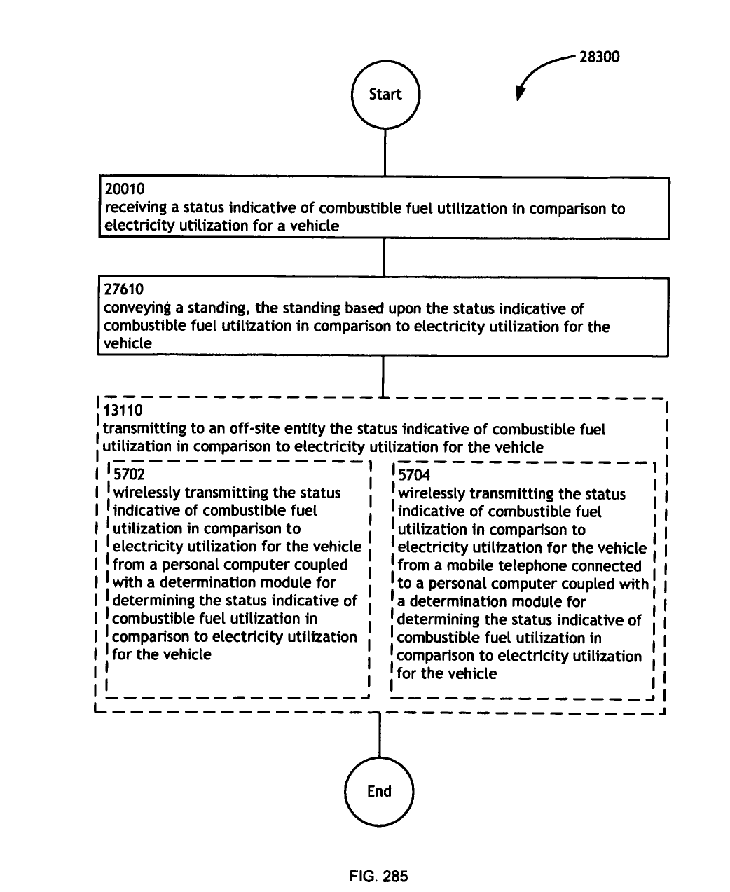

FIG. 285 illustrates alternative embodiments of the example operational flow 28300 of FIG. 283. FIG. 285 illustrates example embodiments where the operation 13110 may include at least one additional operation. Additional operations may include an operation 5702, and/or an operation 5704.

The operation 5702 illustrates wirelessly transmitting the status indicative of combustible fuel utilization in comparison to electricity utilization for the vehicle from a personal computer coupled with a determination module for determining the status indicative of combustible fuel utilization in comparison to electricity utilization for the vehicle.

The operation 5704 illustrates wirelessly transmitting the status indicative of combustible fuel utilization in comparison to electricity utilization for the vehicle from a mobile telephone connected to a personal computer coupled with a determination module for determining the status indicative of combustible fuel utilization in comparison to electricity utilization for the vehicle.

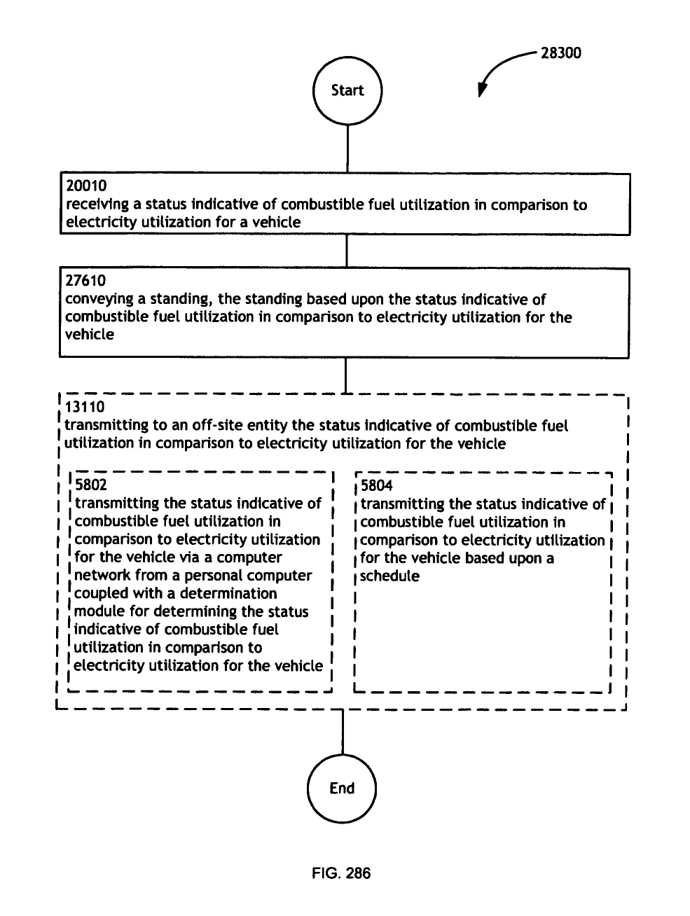

FIG. 286 illustrates alternative embodiments of the example operational flow 28300 of FIG. 283. FIG. 286 illustrates example embodiments where the operation 13110 may include at least one additional operation. Additional operations may include an operation 5802, and/or an operation 5804.

The operation 5802 illustrates transmitting the status indicative of combustible fuel utilization in comparison to electricity utilization for the vehicle via a computer network from a personal computer coupled with a determination module for determining the status indicative of combustible fuel utilization in comparison to electricity utilization for the vehicle.

The operation 5804 illustrates transmitting the status indicative of combustible fuel utilization in comparison to electricity utilization for the vehicle based upon a schedule.

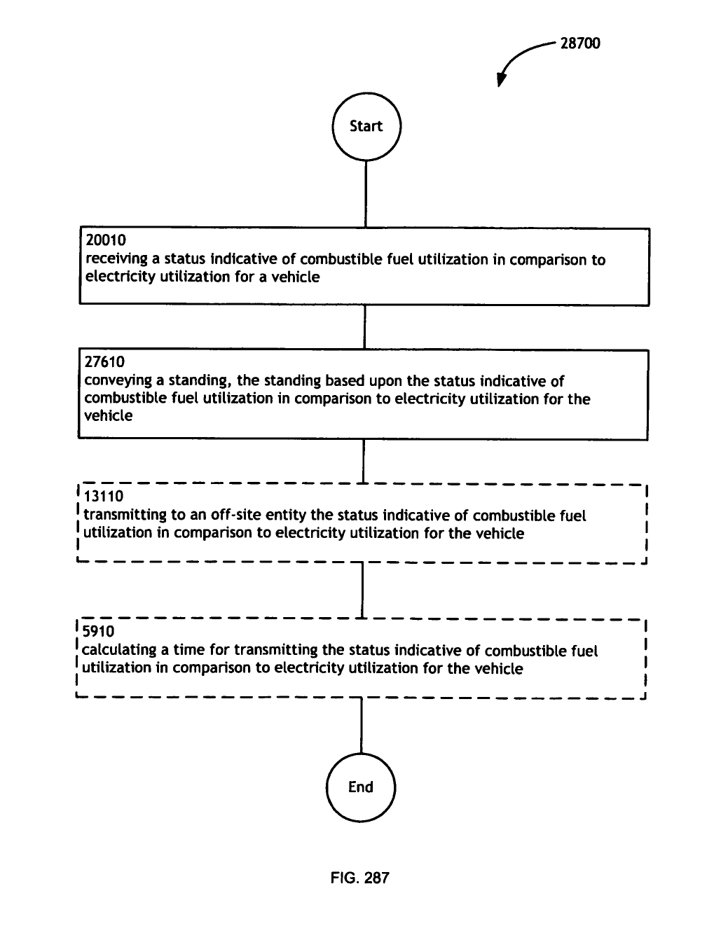

FIG. 287 illustrates an operational flow 28700 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, transmitting to an off-site entity the status indicative of combustible fuel utilization in comparison to electricity utilization for the vehicle, and calculating a time for transmitting the status. FIG. 287 illustrates an example embodiment where the example operational flow 28300 of FIG. 283 may include at least one additional operation. Additional operations may include an operation 5910.

After a start operation, an operation 20010, an operation 27610, and an operation 13110, the operational flow 28700 moves to an operation 5910. Operation 5910 illustrates calculating a time for transmitting the status indicative of combustible fuel utilization in comparison to electricity utilization for the vehicle.

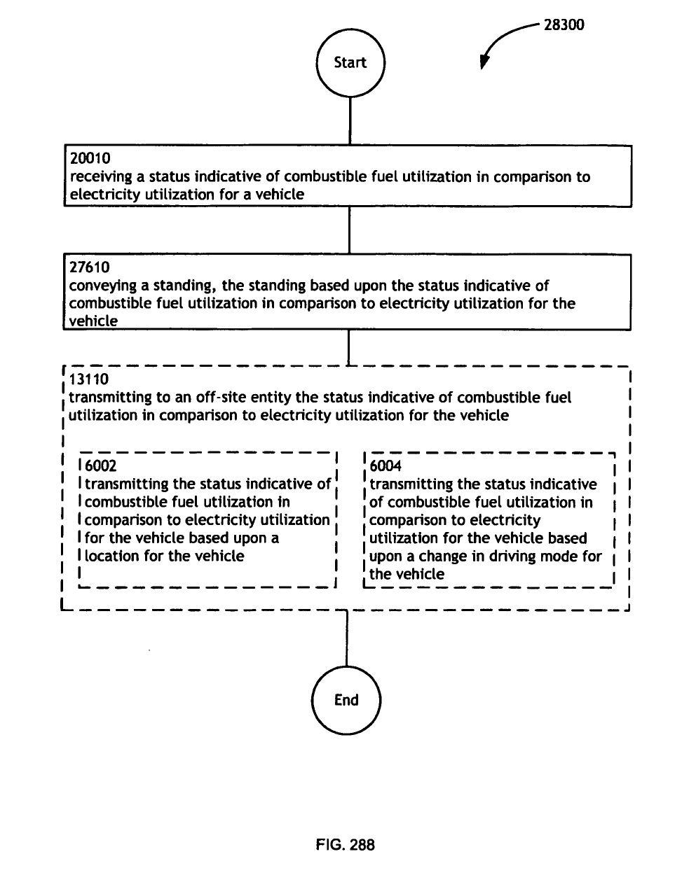

FIG. 288 illustrates alternative embodiments of the example operational flow 28300 of FIG. 283. FIG. 288 illustrates example embodiments where the operation 13110 may include at least one additional operation. Additional operations may include an operation 6002, and/or an operation 6004.

The operation 6002 illustrates transmitting the status indicative of combustible fuel utilization in comparison to electricity utilization for the vehicle based upon a location for the vehicle.

The operation 6004 illustrates transmitting the status indicative of combustible fuel utilization in comparison to electricity utilization for the vehicle based upon a change in driving mode for the vehicle.

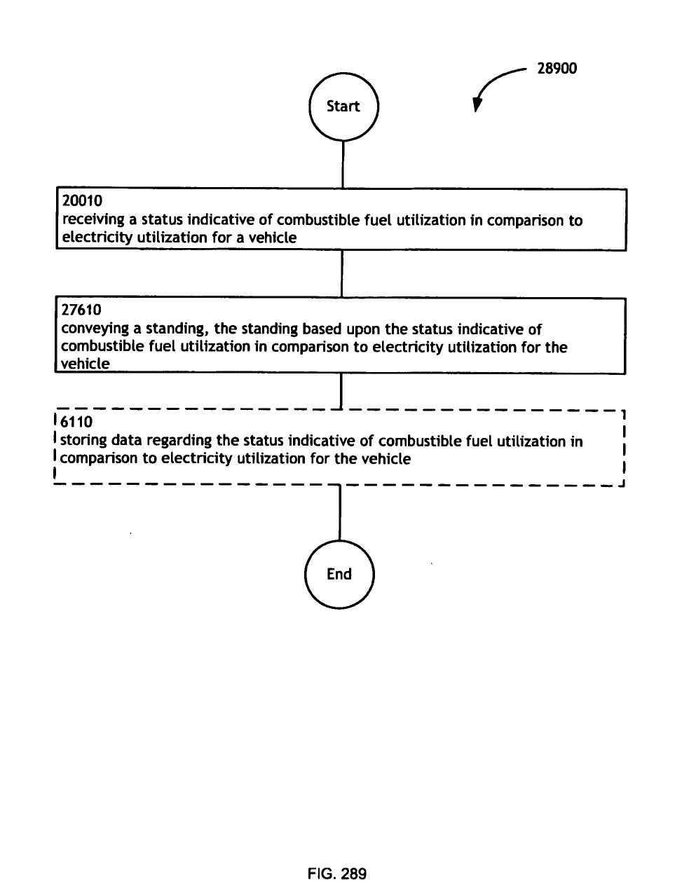

FIG. 289 illustrates an operational flow 28900 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and storing data regarding the status. FIG. 289 illustrates an example embodiment where the example operational flow 27600 of FIG. 276 may include at least one additional operation. Additional operations may include an operation 6110.

After a start operation, an operation 20010, and an operation 27610, the operational flow 28900 moves to an operation 6110. Operation 6110 illustrates storing data regarding the status indicative of combustible fuel utilization in comparison to electricity utilization for the vehicle.

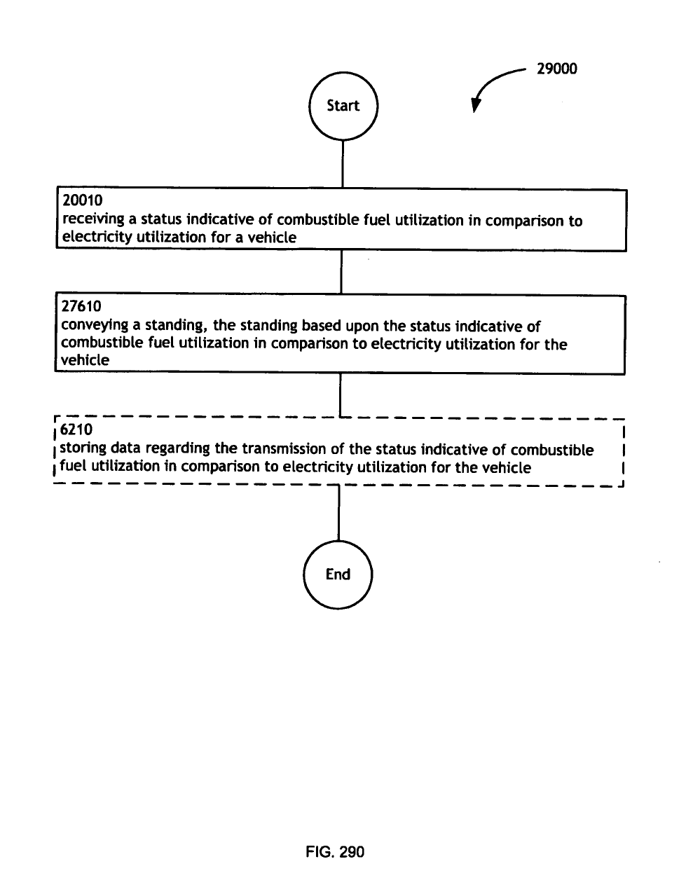

FIG. 290 illustrates an operational flow 29000 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and storing data regarding the transmission of the status. FIG. 290 illustrates an example embodiment where the example operational flow 27600 of FIG. 276 may include at least one additional operation. Additional operations may include an operation 6210.

After a start operation, an operation 20010, and an operation 27610, the operational flow 29000 moves to an operation 6210. Operation 6210 illustrates storing data regarding the transmission of the status indicative of combustible fuel utilization in comparison to electricity utilization for the vehicle.

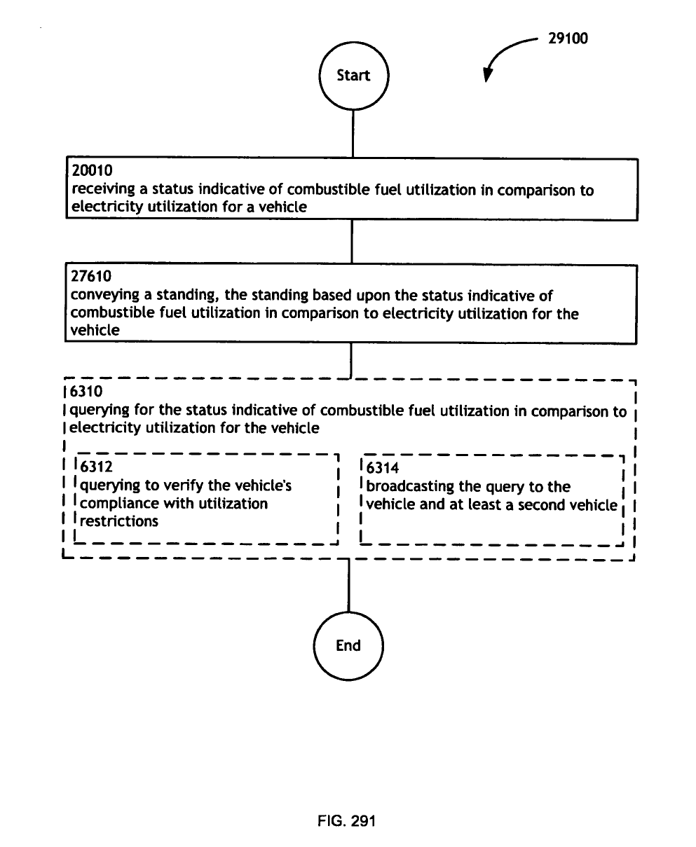

FIG. 291 illustrates an operational flow 29100 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and querying for the status. FIG. 291 illustrates an example embodiment where the example operational flow 27600 of FIG. 276 may include at least one additional operation. Additional operations may include an operation 6310, an operation 6312, and/or an operation 6314.

After a start operation, an operation 20010, and an operation 27610, the operational flow 29100 moves to an operation 6310. Operation 6310 illustrates querying for the status indicative of combustible fuel utilization in comparison to electricity utilization for the vehicle.

The operation 6312 illustrates querying to verify the vehicle's compliance with utilization restrictions.

The operation 6314 illustrates broadcasting the query to the vehicle and at least a second vehicle.

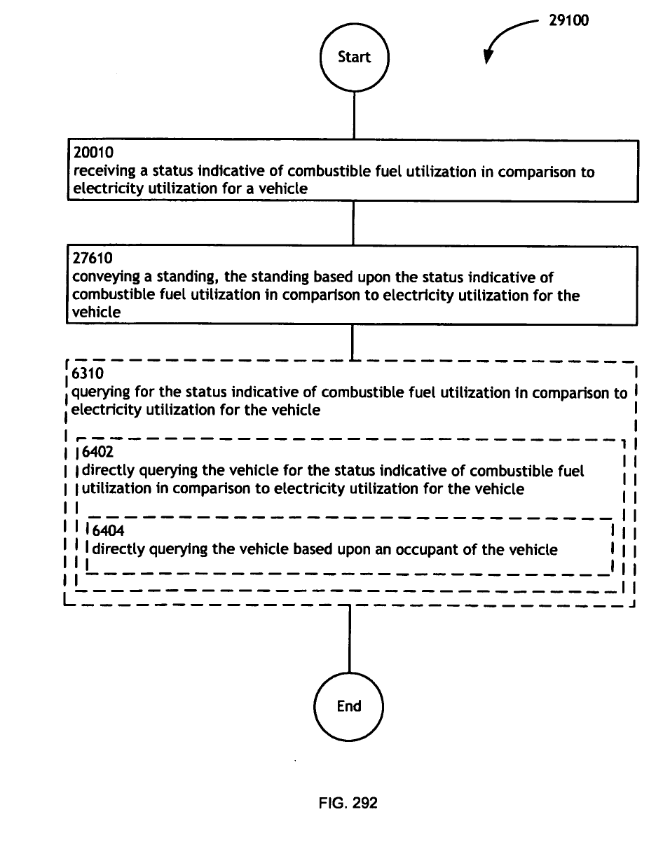

FIG. 292 illustrates alternative embodiments of the example operational flow 29100 of FIG. 291. FIG. 292 illustrates example embodiments where the operation 6310 may include at least one additional operation. Additional operations may include an operation 6402, and/or an operation 6404.

The operation 6402 illustrates directly querying the vehicle for the status indicative of combustible fuel utilization in comparison to electricity utilization for the vehicle. Further, the operation 6404 illustrates directly querying the vehicle based upon an occupant of the vehicle.

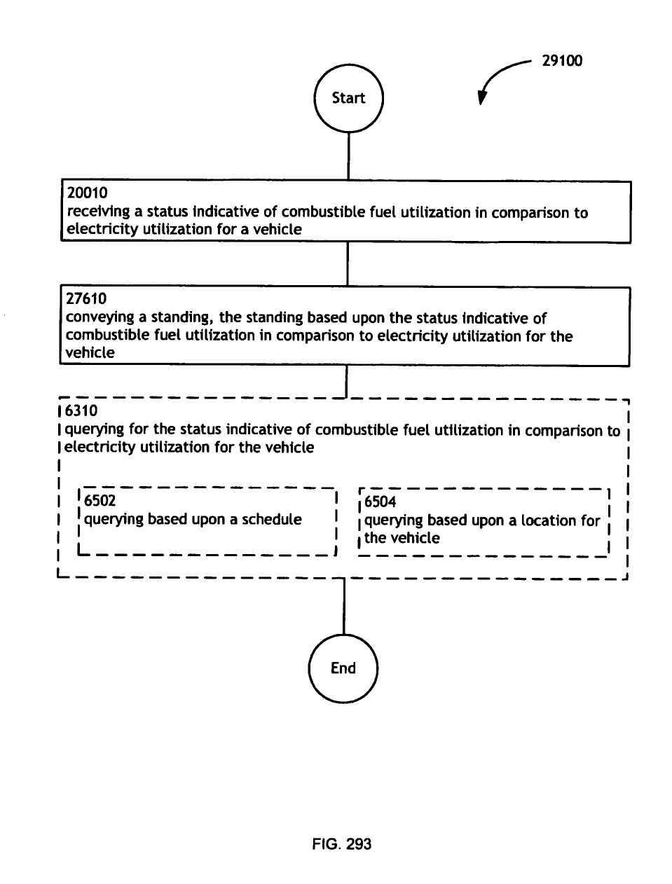

FIG. 293 illustrates alternative embodiments of the example operational flow 29100 of FIG. 291. FIG. 293 illustrates example embodiments where the operation 6310 may include at least one additional operation. Additional operations may include an operation 6502, and/or an operation 6504.

The operation 6502 illustrates querying based upon a schedule.

The operation 6504 illustrates querying based upon a location for the vehicle.

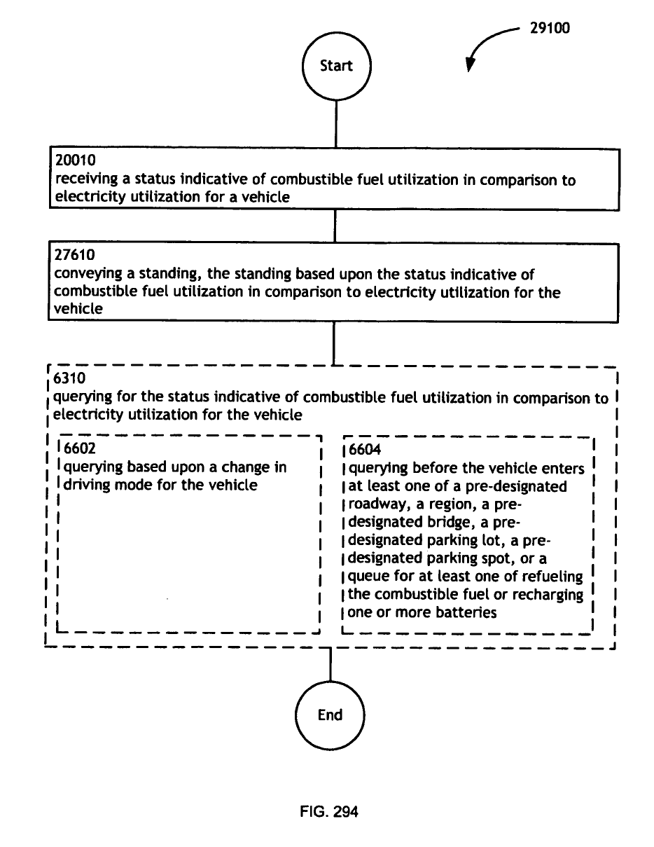

FIG. 294 illustrates alternative embodiments of the example operational flow 29100 of FIG. 291. FIG. 294 illustrates example embodiments where the operation 6310 may include at least one additional operation. Additional operations may include an operation 6602, and/or an operation 6604.

The operation 6602 illustrates querying based upon a change in driving mode for the vehicle.

The operation 6604 illustrates querying before the vehicle enters at least one of a pre-designated roadway, a region, a pre-designated bridge, a pre-designated parking lot, a pre-designated parking spot, or a queue for at least one of refueling the combustible fuel or recharging one or more batteries.

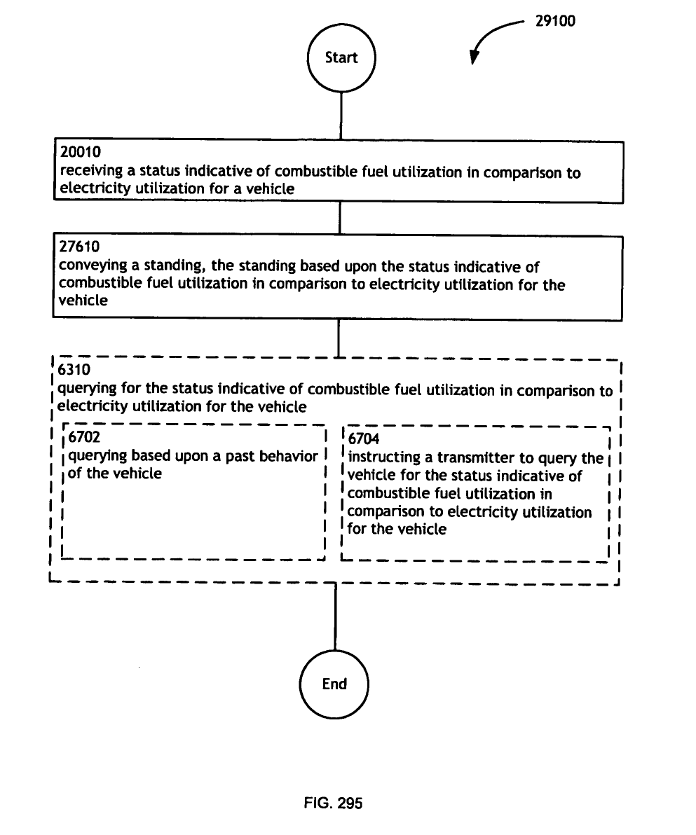

FIG. 295 illustrates alternative embodiments of the example operational flow 29100 of FIG. 291. FIG. 295 illustrates example embodiments where the operation 6310 may include at least one additional operation. Additional operations may include an operation 6702, and/or an operation 6704.

The operation 6702 illustrates querying based upon a past behavior of the vehicle.

The operation 6704 illustrates instructing a transmitter to query the vehicle for the status indicative of combustible fuel utilization in comparison to electricity utilization for the vehicle.

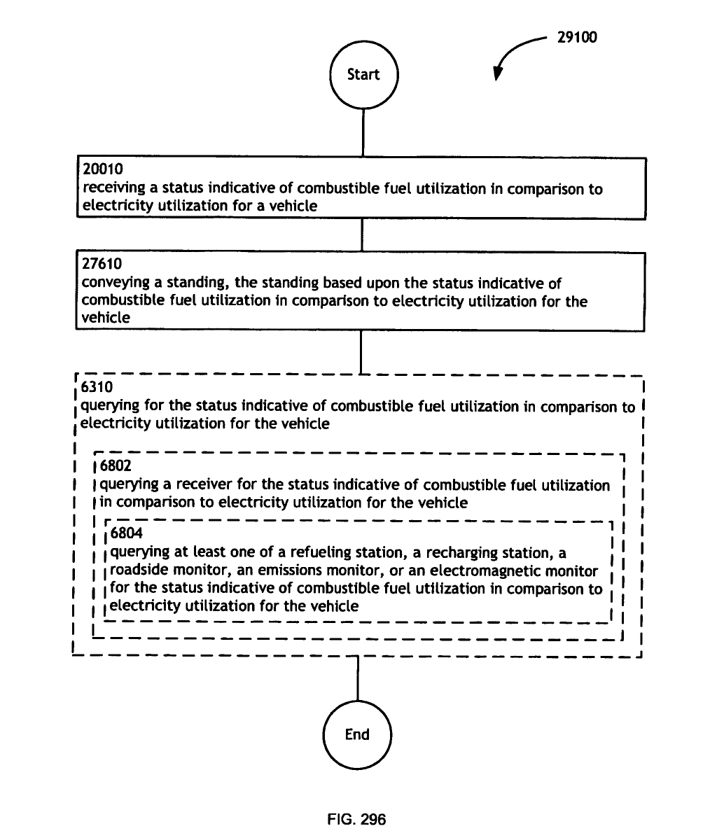

FIG. 296 illustrates alternative embodiments of the example operational flow 29100 of FIG. 291. FIG. 296 illustrates example embodiments where the operation 6310 may include at least one additional operation. Additional operations may include an operation 6802, and/or an operation 6804.

The operation 6802 illustrates querying a receiver for the status indicative of combustible fuel utilization in comparison to electricity utilization for the vehicle. Further, the operation 6804 illustrates querying at least one of a refueling station, a recharging station, a roadside monitor, an emissions monitor, or an electromagnetic monitor for the status indicative of combustible fuel utilization in comparison to electricity utilization for the vehicle.

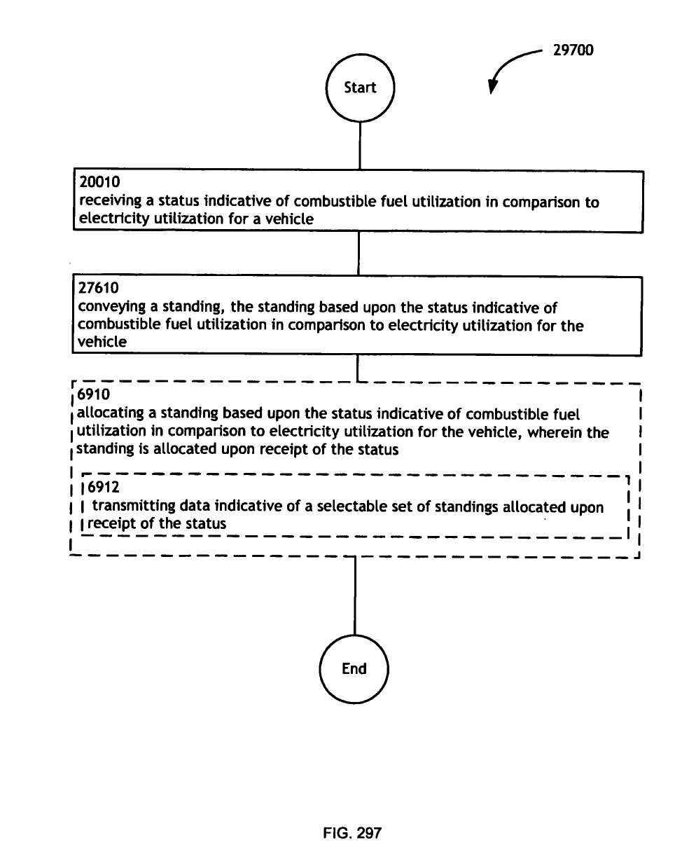

FIG. 297 illustrates an operational flow 29700 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, and allocating a standing based upon the status indicative of combustible fuel utilization in comparison to electricity utilization for the vehicle. FIG. 297 illustrates an example embodiment where the example operational flow 27600 of FIG. 276 may include at least one additional operation. Additional operations may include an operation 6910, and/or an operation 6912.

After a start operation, an operation 20010, and an operation 27610, the operational flow 29700 moves to an operation 6910. Operation 6910 illustrates allocating a standing based upon the status indicative of combustible fuel utilization in comparison to electricity utilization for the vehicle, wherein the standing is allocated upon receipt of the status.

The operation 6912 illustrates transmitting data indicative of a selectable set of standings allocated upon receipt of the status.

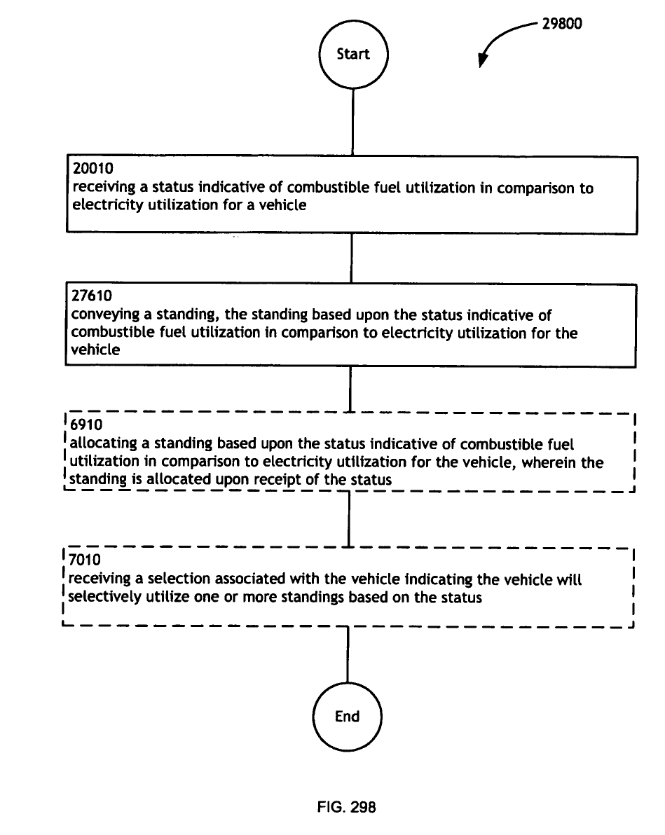

FIG. 298 illustrates an operational flow 29800 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and receiving a selection associated with the vehicle. FIG. 298 illustrates an example embodiment where the example operational flow 29700 of FIG. 297 may include at least one additional operation. Additional operations may include an operation 7010.

After a start operation, an operation 20010, an operation 27610, and an operation 6910, the operational flow 29800 moves to an operation 7010. Operation 7010 illustrates receiving a selection associated with the vehicle indicating the vehicle will selectively utilize one or more standings based on the status.

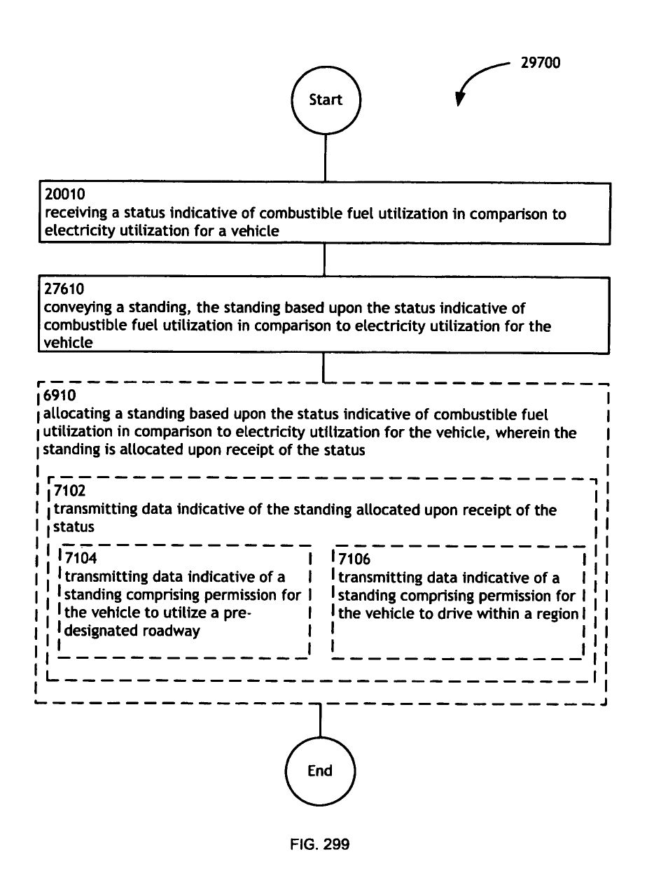

FIG. 299 illustrates alternative embodiments of the example operational flow 29700 of FIG. 297. FIG. 299 illustrates example embodiments where the operation 6910 may include at least one additional operation. Additional operations may include an operation 7102, an operation 7104, and/or an operation 7106.

The operation 7102 illustrates transmitting data indicative of the standing allocated upon receipt of the status. Further, the operation 7104 illustrates transmitting data indicative of a standing comprising permission for the vehicle to utilize a pre-designated roadway. Further, the operation 7106 illustrates transmitting data indicative of a standing comprising permission for the vehicle to drive within a region.

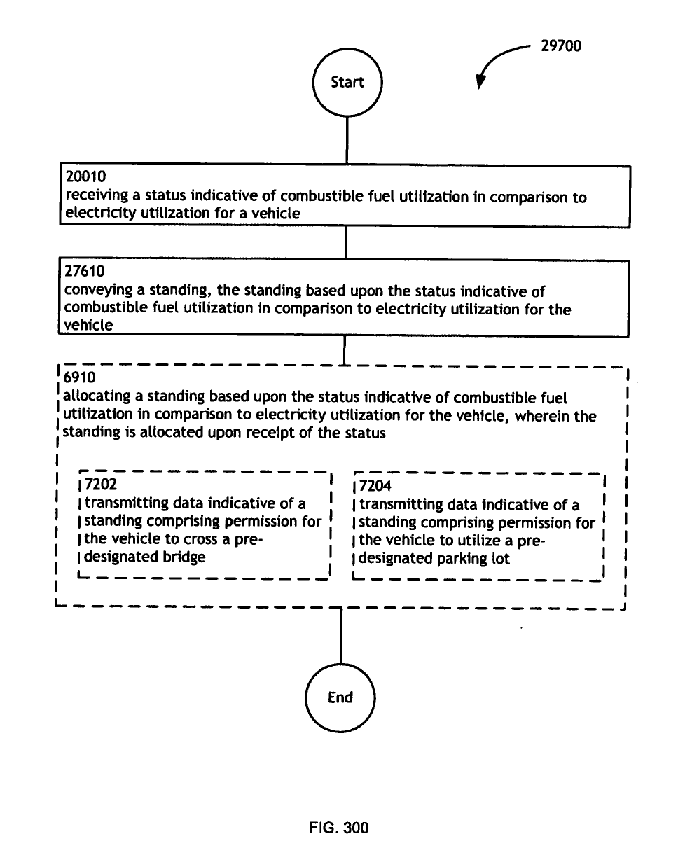

FIG. 300 illustrates alternative embodiments of the example operational flow 29700 of FIG. 297. FIG. 300 illustrates example embodiments where the operation 6910 may include at least one additional operation. Additional operations may include an operation 7202, and/or an operation 7204. Further, the operation 7202 illustrates transmitting data indicative of a standing comprising permission for the vehicle to cross a pre-designated bridge. Further, the operation 7204 illustrates transmitting data indicative of a standing comprising permission for the vehicle to utilize a pre-designated parking lot.

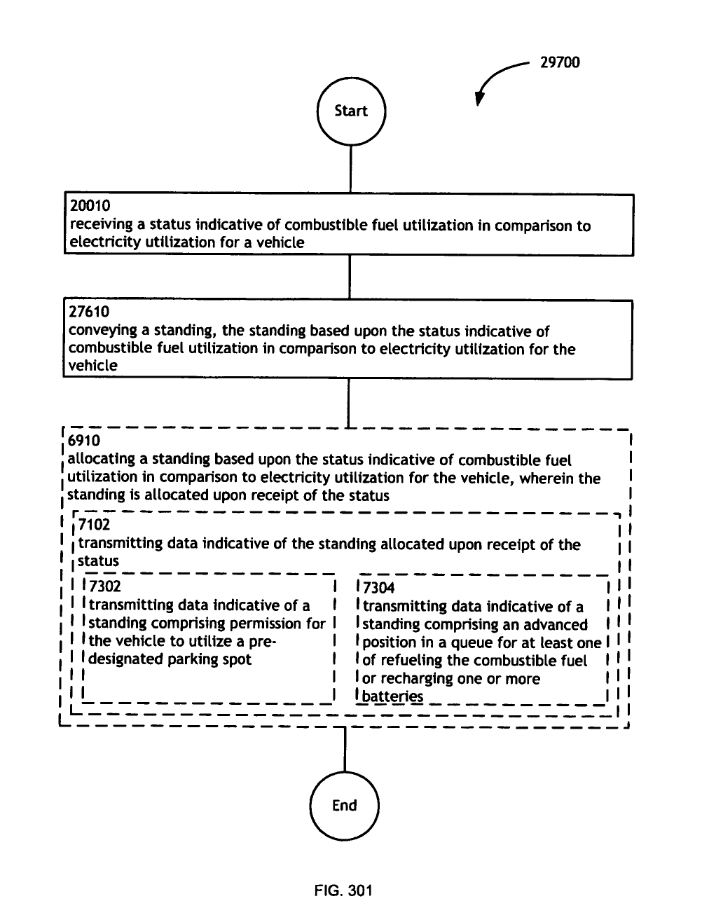

FIG. 301 illustrates alternative embodiments of the example operational flow 29700 of FIG. 297. FIG. 301 illustrates example embodiments where the operation 6910 may include at least one additional operation. Additional operations may include an operation 7302, and/or an operation 7304. Further, the operation 7302 illustrates transmitting data indicative of a standing comprising permission for the vehicle to utilize a pre-designated parking spot. Further, the operation 7304 illustrates transmitting data indicative of a standing comprising an advanced position in a queue for at least one of refueling the combustible fuel or recharging one or more batteries.

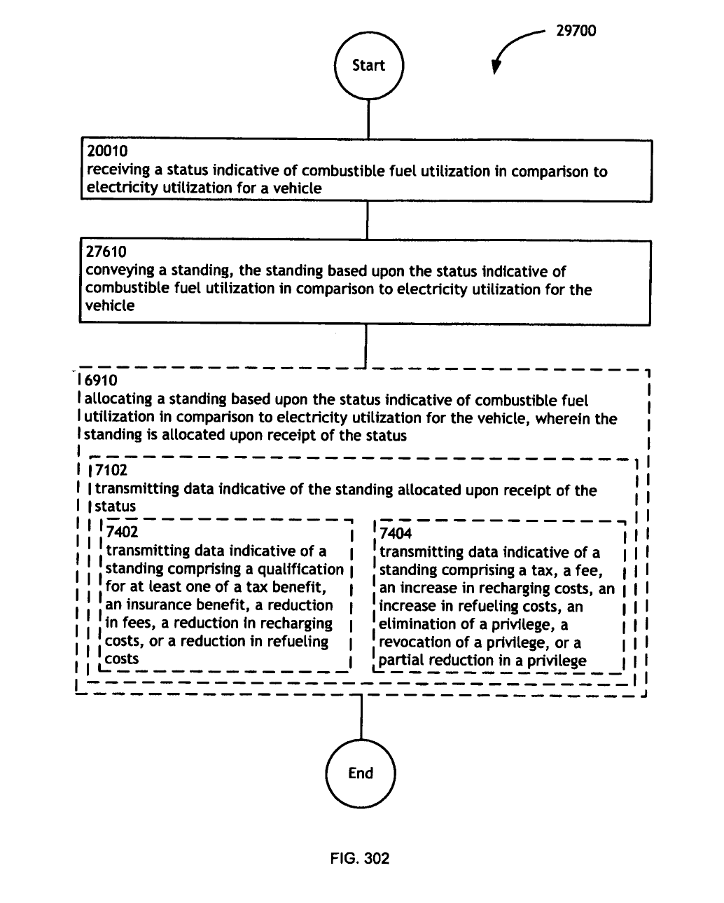

FIG. 302 illustrates alternative embodiments of the example operational flow 29700 of FIG. 297. FIG. 302 illustrates example embodiments where the operation 6910 may include at least one additional operation. Additional operations may include an operation 7402, and/or an operation 7404. Further, the operation 7402 illustrates transmitting data indicative of a standing comprising a qualification for at least one of a tax benefit, an insurance benefit, a reduction in fees, a reduction in recharging costs, or a reduction in refueling costs. Further, the operation 7404 illustrates transmitting data indicative of a standing comprising a tax, a fee, an increase in recharging costs, an increase in refueling costs, an elimination of a privilege, a revocation of a privilege, or a partial reduction in a privilege.

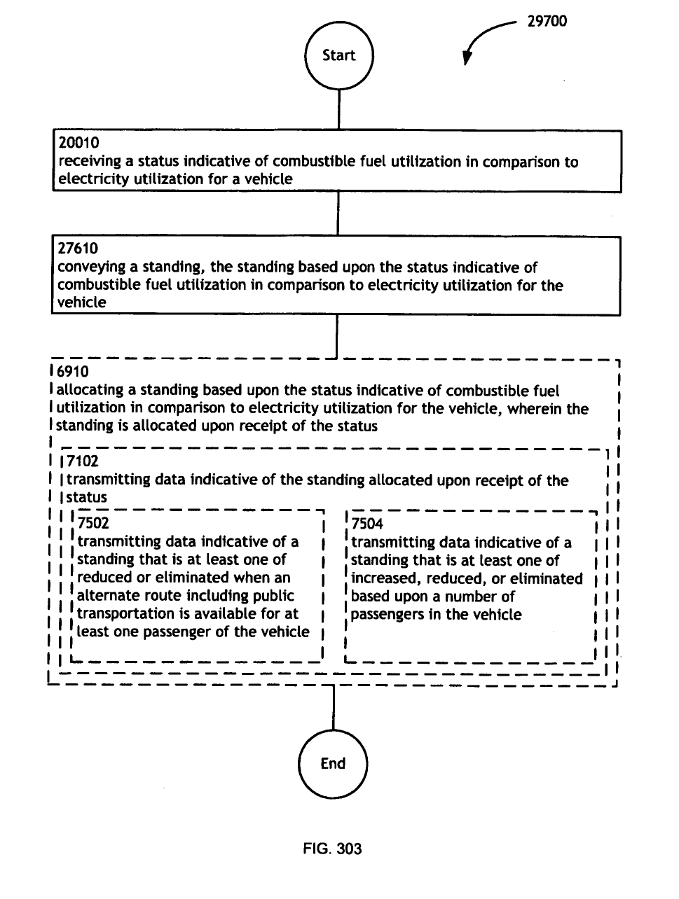

FIG. 303 illustrates alternative embodiments of the example operational flow 29700 of FIG. 297. FIG. 303 illustrates example embodiments where the operation 6910 may include at least one additional operation. Additional operations may include an operation 7502, and/or an operation 7504. Further, the operation 7502 illustrates transmitting data indicative of a standing that is at least one of reduced or eliminated when an alternate route including public transportation is available for at least one passenger of the vehicle. Further, the operation 7504 illustrates transmitting data indicative of a standing that is at least one of increased, reduced, or eliminated based upon a number of passengers in the vehicle.

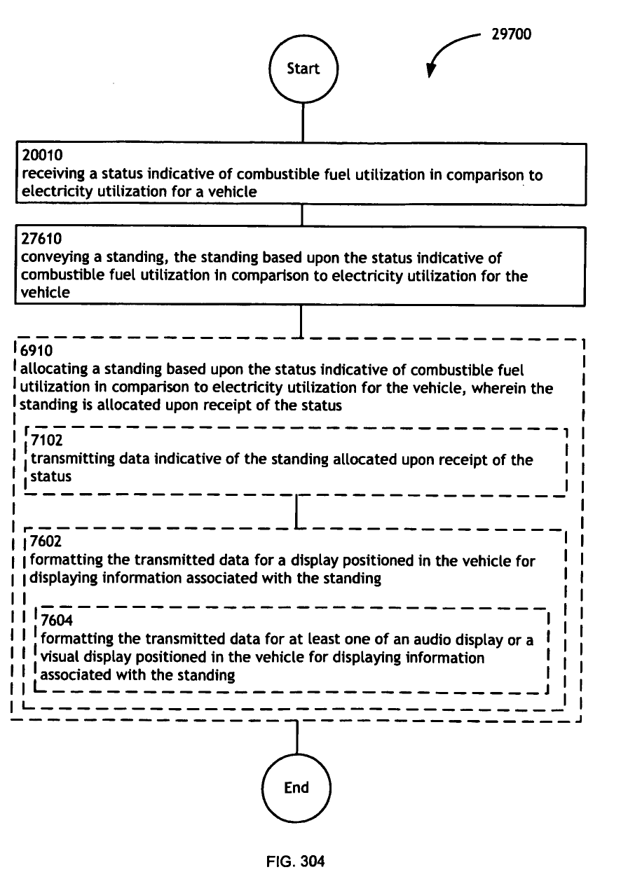

FIG. 304 illustrates alternative embodiments of the example operational flow 29700 of FIG. 297. FIG. 304 illustrates example embodiments where the operation 6910 may include at least one additional operation. Additional operations may include an operation 7602, and/or an operation 7604. Further, the operation 7602 illustrates formatting the transmitted data for a display positioned in the vehicle for displaying information associated with the standing. Further, the operation 7604 illustrates formatting the transmitted data for at least one of an audio display or a visual display positioned in the vehicle for displaying information associated with the standing.

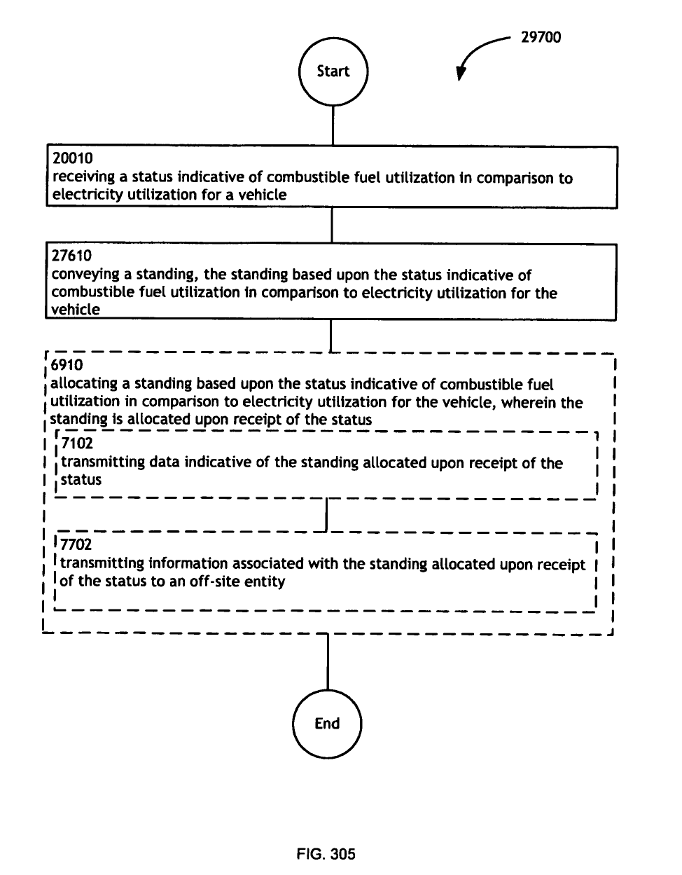

FIG. 305 illustrates alternative embodiments of the example operational flow 29700 of FIG. 297. FIG. 305 illustrates example embodiments where the operation 6910 may include at least one additional operation. Additional operations may include an operation 7702. Further, the operation 7702 illustrates transmitting information associated with the standing allocated upon receipt of the status to an off-site entity.

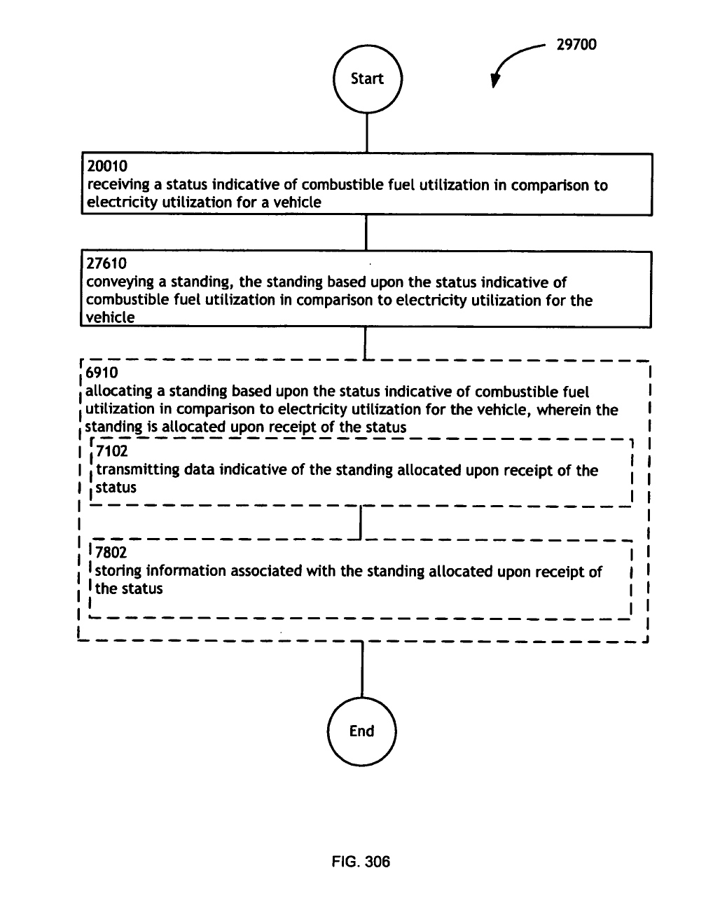

FIG. 306 illustrates alternative embodiments of the example operational flow 29700 of FIG. 297. FIG. 306 illustrates example embodiments where the operation 6910 may include at least one additional operation. Additional operations may include an operation 7802. Further, the operation 7802 illustrates storing information associated with the standing allocated upon receipt of the status.

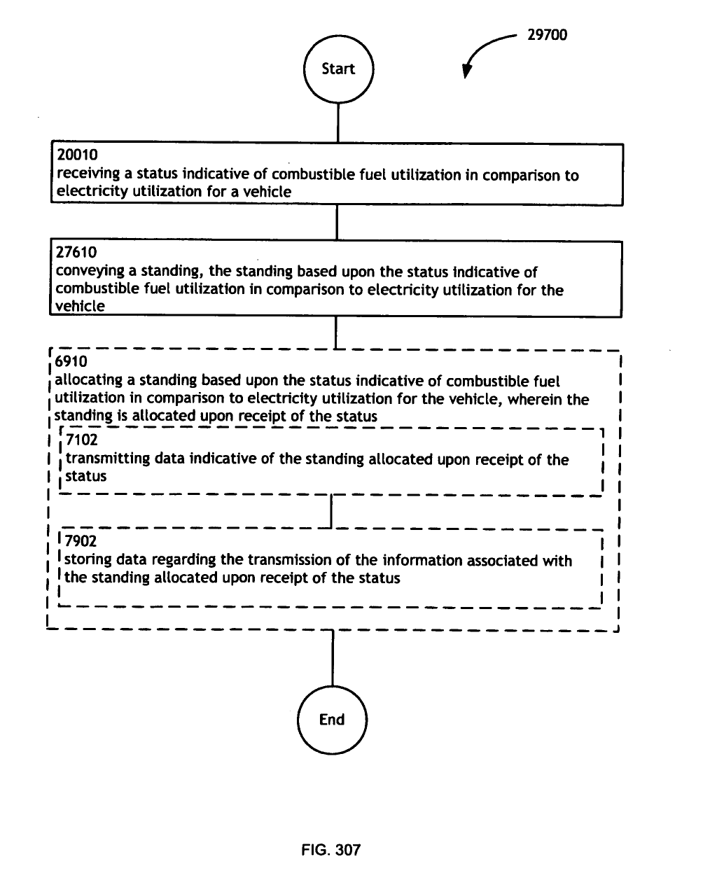

FIG. 307 illustrates alternative embodiments of the example operational flow 29700 of FIG. 297. FIG. 307 illustrates example embodiments where the operation 6910 may include at least one additional operation. Additional operations may include an operation 7902. Further, the operation 7902 illustrates storing data regarding the transmission of the information associated with the standing allocated upon receipt of the status.

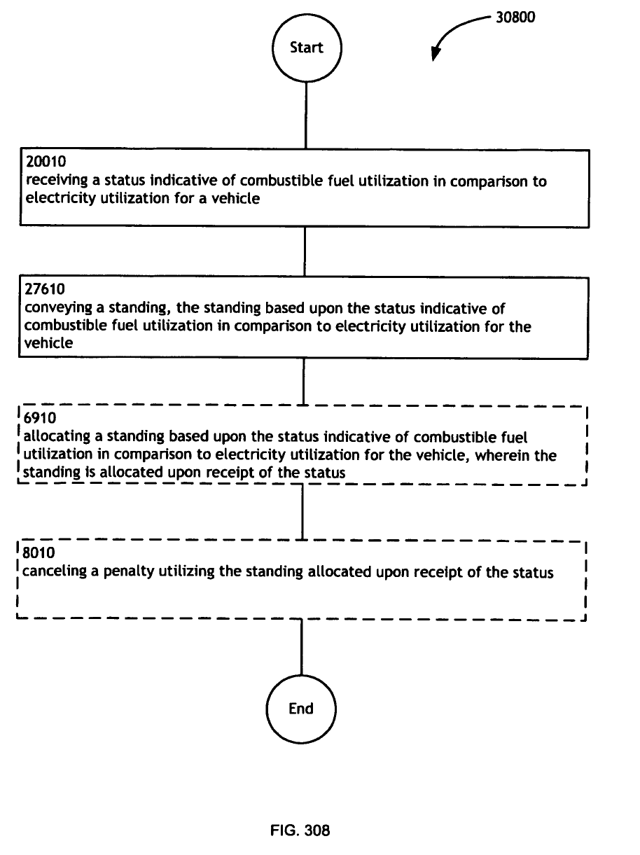

FIG. 308 illustrates an operational flow 30800 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and canceling a penalty utilizing the standing. FIG. 308 illustrates an example embodiment where the example operational flow 29700 of FIG. 297 may include at least one additional operation. Additional operations may include an operation 8010.

After a start operation, an operation 20010, an operation 27610, and an operation 6910, the operational flow 30800 moves to an operation 8010. Operation 8010 illustrates canceling a penalty utilizing the standing allocated upon receipt of the status.

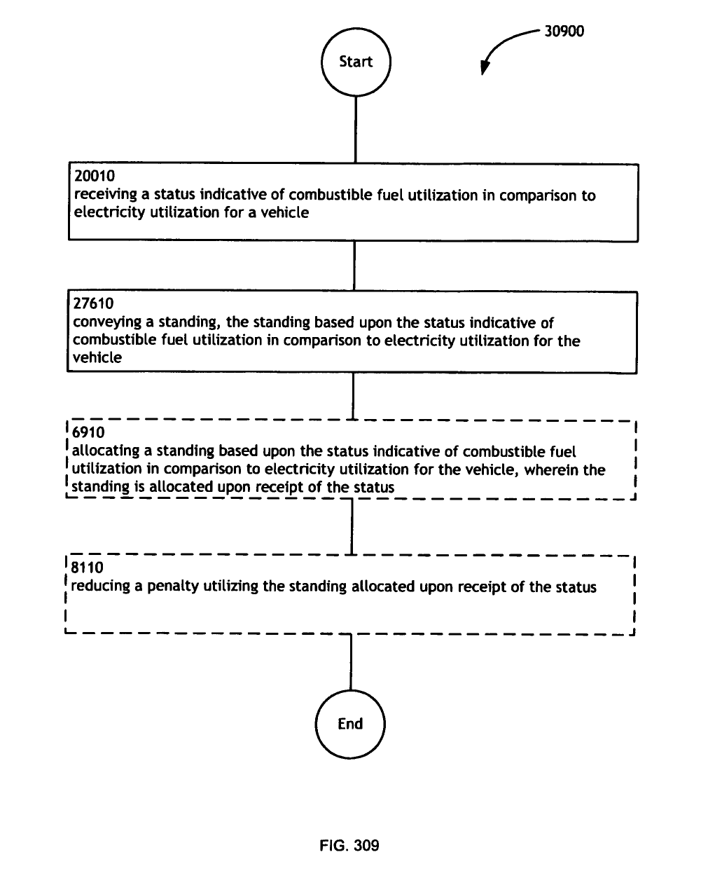

FIG. 309 illustrates an operational flow 30900 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and reducing a penalty utilizing the standing. FIG. 309 illustrates an example embodiment where the example operational flow 29700 of FIG. 297 may include at least one additional operation. Additional operations may include an operation 8110.

After a start operation, an operation 20010, an operation 27610, and an operation 6910, the operational flow 30900 moves to an operation 8110. Operation 8110 illustrates reducing a penalty utilizing the standing allocated upon receipt of the status.

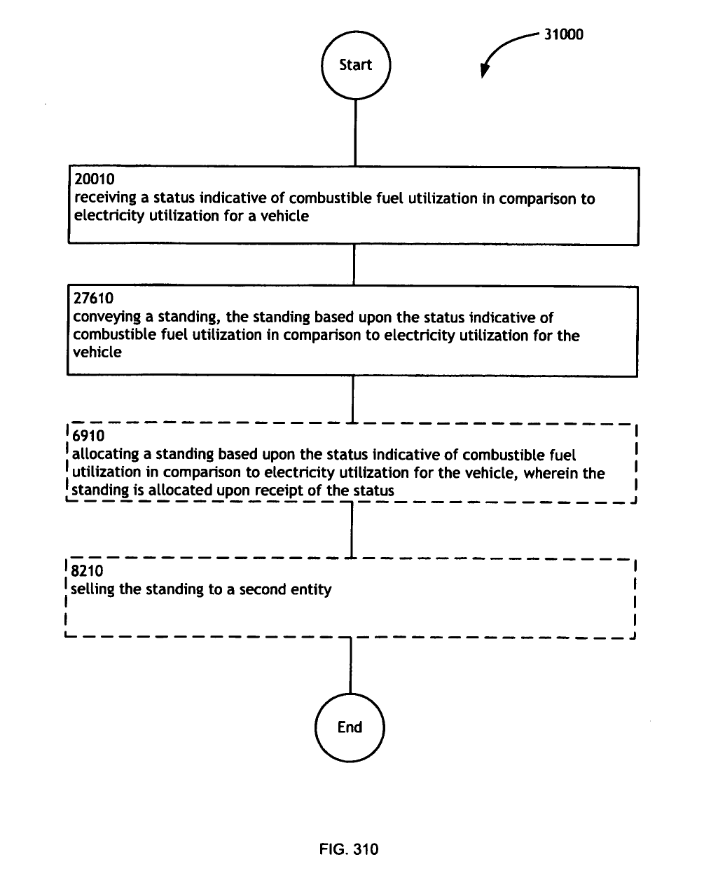

FIG. 310 illustrates an operational flow 31000 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and selling the standing to a second entity. FIG. 310 illustrates an example embodiment where the example operational flow 29700 of FIG. 297 may include at least one additional operation. Additional operations may include an operation 8210.

After a start operation, an operation 20010, an operation 27610, and an operation 6910, the operational flow 31000 moves to an operation 8210. Operation 8210 illustrates selling the standing to a second entity.

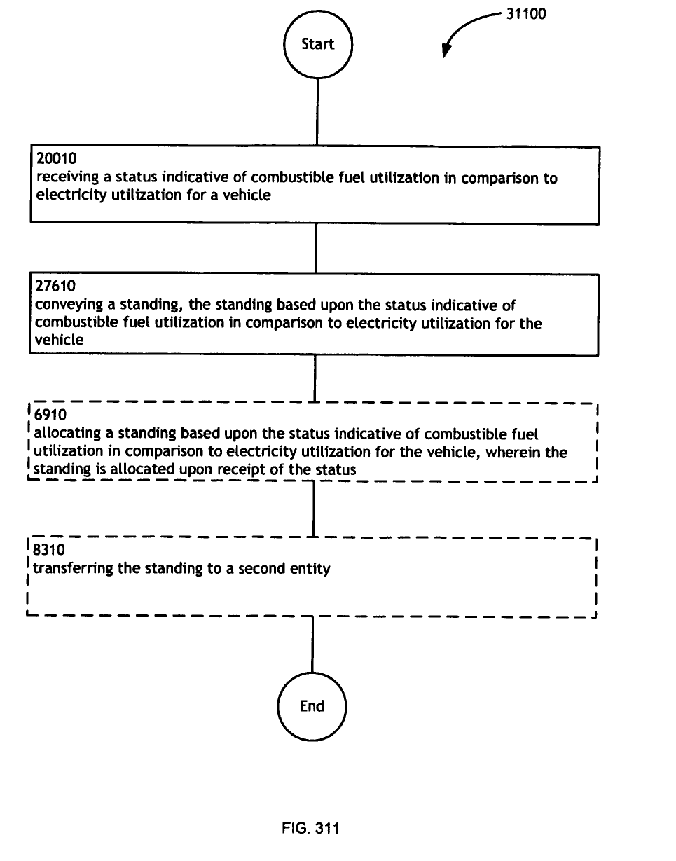

FIG. 311 illustrates an operational flow 31100 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and transferring the standing to a second entity. FIG. 311 illustrates an example embodiment where the example operational flow 29700 of FIG. 297 may include at least one additional operation. Additional operations may include an operation 8310.

After a start operation, an operation 20010, an operation 27610, and an operation 6910, the operational flow 31100 moves to an operation 8310. Operation 8310 illustrates transferring the standing to a second entity.

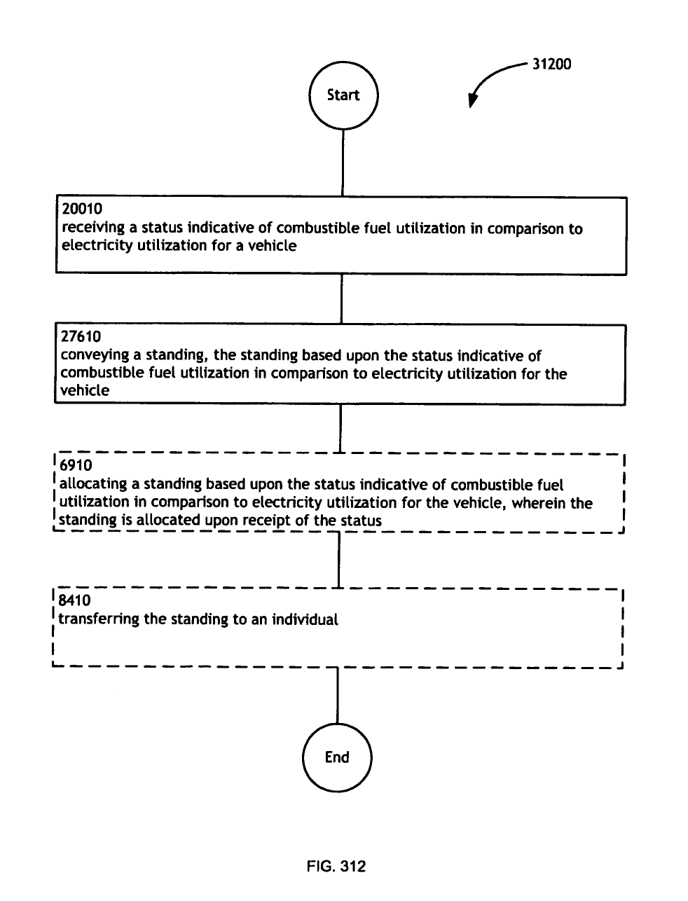

FIG. 312 illustrates an operational flow 31200 representing example operations related to receiving a status indicative of combustible fuel utilization in comparison to electricity utilization for a vehicle, conveying a standing, the standing based upon the status indicative of combustible fuel utilization in comparison to electricity utilization for the vehicle, allocating a standing based upon the status for the vehicle, and transferring the standing to an individual. FIG. 312 illustrates an example embodiment where the example operational flow 29700 of FIG. 297 may include at least one additional operation. Additional operations may include an operation 8410.

After a start operation, an operation 20010, an operation 27610, and an operation 6910, the operational flow 31200 moves to an operation 8410. Operation 8410 illustrates transferring the standing to an individual.

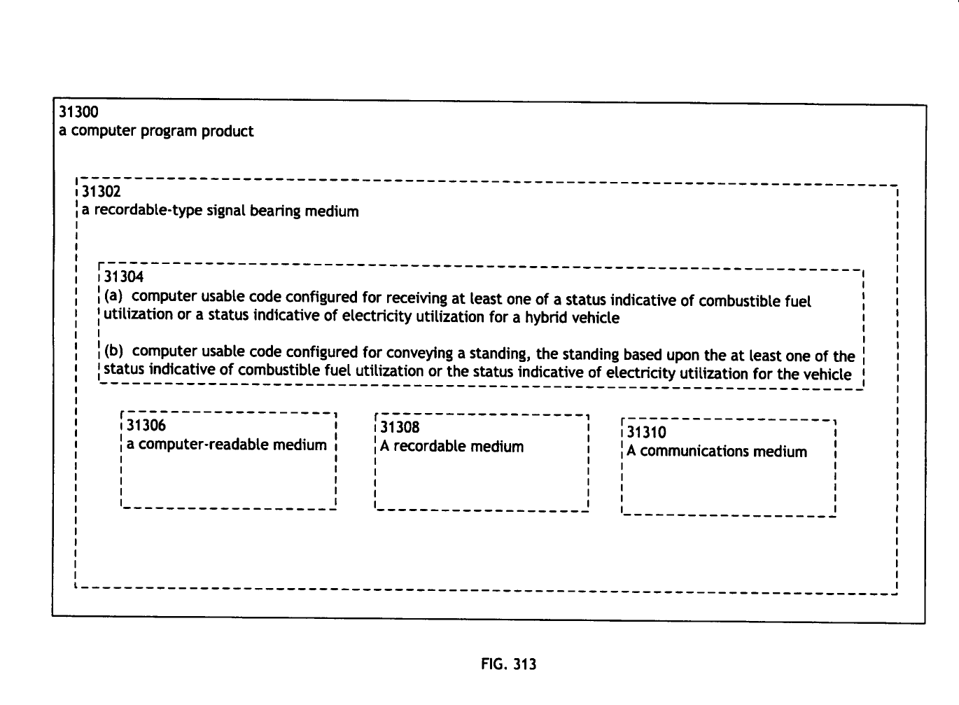

FIG. 313 illustrates a partial view of an example computer program product 31300 that includes a computer program 31304 for executing a computer process on a computing device. An embodiment of the example computer program product 31300 is provided using a recordable-type signal bearing medium 31302, and may include computer usable code configured for receiving at least one of a status indicative of combustible fuel utilization or a status indicative of electricity utilization for a hybrid vehicle and conveying a standing, the standing based upon the at least one of the status indicative of combustible fuel utilization or the status indicative of electricity utilization for the vehicle. The computer usable code may be, for example, computer executable and/or logic-implemented instructions. In one implementation, the signal-bearing medium 31302 may include a computer-readable medium 31306. In one implementation, the signal bearing medium 31302 may include a recordable medium 31308. In one implementation, the signal bearing medium 31302 may include a communications medium 31310. In an embodiment, allocating the standing based upon the at least one of the status indicative of combustible fuel utilization or the status indicative of electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

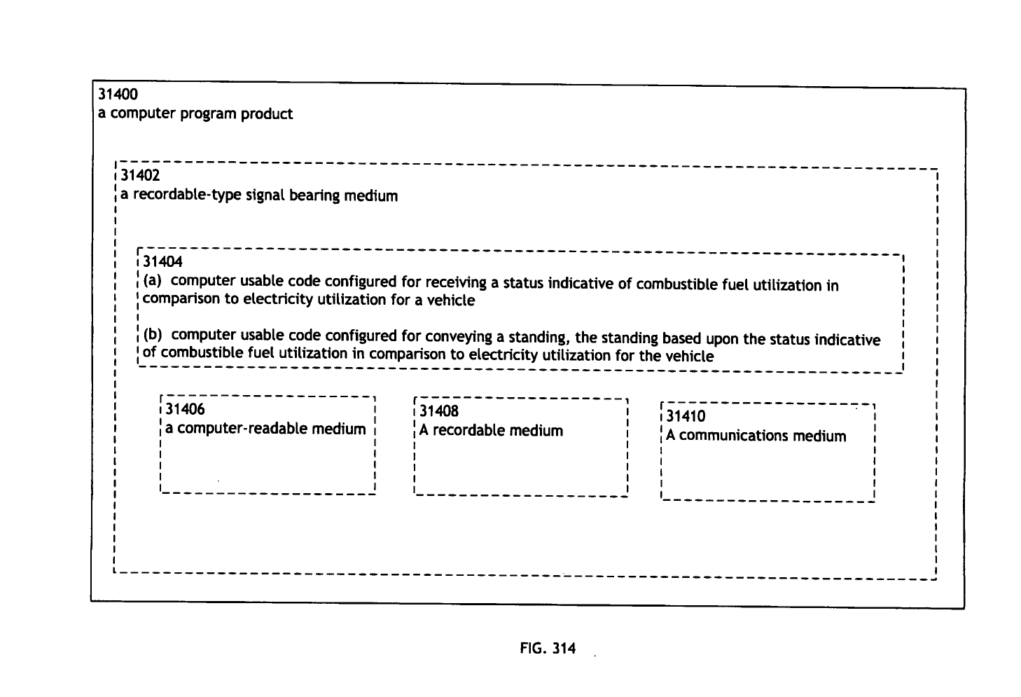

FIG. 314 illustrates a partial view of an example computer program product 31400 that includes a computer program 31404 for executing a computer process on a computing device. An embodiment of the example computer program product 31400 is provided using a recordable-type signal bearing medium 31402, and may include computer usable code configured for receiving a status indicative of combustible fuel utilization in comparison to electricity utilization for a vehicle and conveying a standing, the standing based upon the status indicative of combustible fuel utilization in comparison to electricity utilization for the vehicle. The computer usable code may be, for example, computer executable and/or logic-implemented instructions. In one implementation, the signal-bearing medium 31402 may include a computer-readable medium 31406. In one implementation, the signal bearing medium 31402 may include a recordable medium 31408. In one implementation, the signal bearing medium 31402 may include a communications medium 31410. In an embodiment, allocating the standing based upon the status indicative of combustible fuel utilization in comparison to electricity utilization for the vehicle includes communicating the standing to a user or another system. For example, the status may be communicated to the vehicle 100. In another instance, the status may be communicated to a user, such as an individual, an entity, or one or more other computer systems (e.g., as communicated via the computer network 207). Further, the standing may be communicated via the display 220, or via audio, visual, or other haptic feedback types of communication.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
transmitting to an off-site entity a status indicative of combustible fuel utilization in comparison to electricity utilization from a vehicle.

2.-83. (canceled)

84. A system, comprising:
means for transmitting to an off-site entity a status indicative of combustible fuel utilization in comparison to electricity utilization from a vehicle.

85. The system of claim 84, further comprising:
means for receiving a status indicative of combustible fuel utilization in comparison to electricity utilization for a vehicle.

86. The system of claim 85, wherein means for receiving a status indicative of combustible fuel utilization in comparison to electricity utilization for a vehicle comprises:
means for wirelessly receiving the status indicative of combustible fuel utilization in comparison to electricity utilization for the vehicle.

87. (canceled)

88. The system of claim 85, wherein means for receiving a status indicative of combustible fuel utilization in comparison to electricity utilization for a vehicle comprises:
means for connecting to the vehicle for receiving the status indicative of combustible fuel utilization in comparison to electricity utilization for the vehicle.

89. (canceled)

90. The system of claim 85, wherein means for receiving a status indicative of combustible fuel utilization in comparison to electricity utilization for a vehicle comprises:
means for receiving the status indicative of combustible fuel utilization in comparison to electricity utilization for the vehicle via a physical media.

91. (canceled)

92. The system of claim 85, wherein means for receiving a status indicative of combustible fuel utilization in comparison to electricity utilization for a vehicle comprises:
means for receiving the status indicative of combustible fuel utilization in comparison to electricity utilization for the vehicle via a visual indicator on the vehicle.

93. (canceled)

94. The system of claim 85, wherein means for receiving a status indicative of combustible fuel utilization in comparison to electricity utilization for a vehicle comprises:
means for receiving the status indicative of combustible fuel utilization in comparison to electricity utilization for the vehicle in an encrypted data format.

95. The system of claim 85, wherein the status indicative of combustible fuel utilization in comparison to electricity utilization for the vehicle represents a cumulative utilization for a geographic region.

96.-97. (canceled)

98. The system of claim 84, wherein the status indicative of combustible fuel utilization in comparison to electricity utilization for the vehicle represents a driving mode.

99.-100. (canceled)

101. The system of claim 84, wherein the status indicative of combustible fuel utilization in comparison to electricity utilization for the vehicle is related to a utilization of propulsion resources.

102.-103. (canceled)

104. The system of claim 84, wherein the status indicative of combustible fuel utilization in comparison to electricity utilization for the vehicle represents an instantaneous status.

105. The system of claim 84, wherein the status indicative of combustible fuel utilization in comparison to electricity utilization for the vehicle represents an average over a time period.

106. The system of claim 84, wherein the status indicative of combustible fuel utilization in comparison to electricity utilization for the vehicle represents a cumulative utilization for a time period.

107. The system of claim 84, further comprising:
means for receiving at least one of a vehicle identification, an operator identification, a time, a location, a direction, or a speed associated with the vehicle.

108. The system of claim 84, wherein means for transmitting to an off-site entity a status indicative of combustible fuel utilization in comparison to electricity utilization from a vehicle comprises:
means for transmitting the status indicative of combustible fuel utilization in comparison to electricity utilization for the vehicle from an aftermarket part.

109. The system of claim 84, wherein means for transmitting to an off-site entity a status indicative of combustible fuel utilization in comparison to electricity utilization from a vehicle comprises:
means for transmitting the status indicative of combustible fuel utilization in comparison to electricity utilization for the vehicle from at least one of the Internet, a personal communication device, a personal computer, a laptop computer, a palmtop computer, a Personal Digital Assistant (PDA), a portable media player, or a mobile telephone.

110. The system of claim 84, wherein means for transmitting to an off-site entity a status indicative of combustible fuel utilization in comparison to electricity utilization from a vehicle comprises:
means for transmitting the status indicative of combustible fuel utilization in comparison to electricity utilization for the vehicle from a transmitter coupled with a determination module comprising instrumentation for determining the status indicative of combustible fuel utilization in comparison to electricity utilization for the vehicle.

111. The system of claim 84, wherein means for transmitting to an off-site entity a status indicative of combustible fuel utilization in comparison to electricity utilization from a vehicle comprises:
means for transmitting the status indicative of combustible fuel utilization in comparison to electricity utilization for the vehicle from a transmitter coupled with a determination module comprising a receiver for receiving the status indicative of combustible fuel utilization in comparison to electricity utilization for the vehicle.

112. The system of claim 84, wherein means for transmitting to an off-site entity a status indicative of combustible fuel utilization in comparison to electricity utilization from a vehicle comprises:
means for wirelessly transmitting the status indicative of combustible fuel utilization in comparison to electricity utilization for the vehicle from a personal computer coupled with a determination module for determining the status indicative of combustible fuel utilization in comparison to electricity utilization for the vehicle.

113. The system of claim 84, wherein means for transmitting to an off-site entity a status indicative of combustible fuel utilization in comparison to electricity utilization from a vehicle comprises:
means for wirelessly transmitting the status indicative of combustible fuel utilization in comparison to electricity utilization for the vehicle from a mobile telephone connected to a personal computer coupled with a determination module for determining the status indicative of combustible fuel utilization in comparison to electricity utilization for the vehicle.

114. The system of claim 84, wherein means for transmitting to an off-site entity a status indicative of combustible fuel utilization in comparison to electricity utilization from a vehicle comprises:
means for transmitting the status indicative of combustible fuel utilization in comparison to electricity utilization for the vehicle via a computer network from a personal computer coupled with a determination module for determining the status indicative of combustible fuel utilization in comparison to electricity utilization for the vehicle.

115.-122. (canceled)

123. The system of claim 84, further comprising:
means for querying for the status indicative of combustible fuel utilization in comparison to electricity utilization for the vehicle.

124. The system of claim 123, wherein means for querying for the status indicative of combustible fuel utilization in comparison to electricity utilization for the vehicle comprises:
means for querying to verify the vehicle's compliance with utilization restrictions.

125. The system of claim 123, wherein means for querying for the status indicative of combustible fuel utilization in comparison to electricity utilization for the vehicle comprises:
means for broadcasting the query to the vehicle and at least a second vehicle.

126. The system of claim 123, wherein means for querying for the status indicative of combustible fuel utilization in comparison to electricity utilization for the vehicle comprises:
means for directly querying the vehicle for the status indicative of combustible fuel utilization in comparison to electricity utilization for the vehicle.

127.-135. (canceled)

136. The system of claim 84, further comprising:
means for allocating a standing based upon the status indicative of combustible fuel utilization in comparison to electricity utilization for the vehicle, wherein the standing is allocated upon receipt of the status.

137. The system of claim 136, wherein the standing comprises at least one of a privilege or a penalty.

138. The system of claim 136, wherein the standing is dependent upon at least one of a driver of the vehicle, an occupant of the vehicle, an identification for the vehicle, a time of day, a driving history for the vehicle, a history of standings for the vehicle, a number of standings accumulated for the vehicle, a user selection from a list of acceptable standings, an expiration of a standing, a time period during which a standing is valid, or a geographical region in which a standing is valid.

139. The system of claim 136, wherein means for allocating a standing based upon the status indicative of combustible fuel utilization in comparison to electricity utilization for the vehicle, wherein the standing is allocated upon receipt of the status comprises:
means for transmitting data indicative of a selectable set of standings allocated upon receipt of the status.

140. The system of claim 136, further comprising:
means for receiving a selection associated with the vehicle indicating the vehicle will selectively utilize one or more standings based on the status.

141. The system of claim 136, wherein means for allocating a standing based upon the status indicative of combustible fuel utilization in comparison to electricity utilization for the vehicle, wherein the standing is allocated upon receipt of the status comprises:
means for transmitting data indicative of the standing allocated upon receipt of the status.

142. The system of claim 141, wherein means for transmitting data indicative of the standing allocated upon receipt of the status comprises:
means for transmitting data indicative of a standing comprising permission for the vehicle to utilize a pre-designated roadway.

143.-146. (canceled)

147. The system of claim 141, wherein means for transmitting data indicative of the standing allocated upon receipt of the status comprises:
means for transmitting data indicative of a standing comprising an advanced position in a queue for at least one of refueling the combustible fuel or recharging one or more batteries.

148. The system of claim 141, wherein means for transmitting data indicative of the standing allocated upon receipt of the status comprises:
means for transmitting data indicative of a standing comprising a qualification for at least one of a tax benefit, an insurance benefit, a reduction in fees, a reduction in recharging costs, or a reduction in refueling costs.

149. The system of claim 141, wherein means for transmitting data indicative of the standing allocated upon receipt of the status comprises:
means for transmitting data indicative of a standing comprising a tax, a fee, an increase in recharging costs, an increase in refueling costs, an elimination of a privilege, a revocation of a privilege, or a partial reduction in a privilege.

150. The system of claim 141, wherein means for transmitting data indicative of the standing allocated upon receipt of the status comprises:
means for transmitting data indicative of a standing that is at least one of reduced or eliminated when an alternate route including public transportation is available for at least one passenger of the vehicle.

151.-153. (canceled)

154. The system of claim 141, further comprising:
means for transmitting information associated with the standing allocated upon receipt of the status to an off-site entity.

155.-159. (canceled)

160. The system of claim 136, wherein the standing is accumulated with at least a second standing.

161. (canceled)

162. The system of claim 136, further comprising:
means for canceling a penalty utilizing the standing allocated upon receipt of the status.

163. The system of claim 136, further comprising:
means for reducing a penalty utilizing the standing allocated upon receipt of the status.

164. The system of claim 136, further comprising:
means for selling the standing to a second entity.

165. The system of claim 136, further comprising:
means for transferring the standing to a second entity.

166. The system of claim 136, further comprising:
means for transferring the standing to an individual.

167. A computer program product, comprising:
a recordable-type signal bearing medium bearing computer usable code configured for transmitting to an off-site entity a status indicative of combustible fuel utilization in comparison to electricity utilization from a vehicle.

168.-249. (canceled)
